(19) United States
(12) Patent Application Publication
(10) Pub. No.: US 2025/0243068 A1
(43) Pub. Date: Jul. 31, 2025

(54) COMPOSITE MATERIALS AND PROCESSES FOR THE PREPARATION THEREOF

(71) Applicant: Nanocore ApS, Roskilde (DK)

(72) Inventors: Julia VILLALVA FERNÁNDEZ, Madrid (ES); Henrik PEDERSEN, Bagsværd (DK); Alejandro LÓPEZ MORENO, Madrid (ES); Marta GONZÁLEZ SÁNCHEZ, Bagsværd (DK); Emilio Manuel PÉREZ ÁLVAREZ, Las Rozas de Madrid (ES); Maria de Lourdes GONZÁLEZ-JUÁREZ, Bagsværd (DK); Marisol RIVAS CARAMÉS, Bagsværd (DK); Matthew David EATON, Madrid (ES); Ion ISASTI IRIBAR, Bagsværd (DK); Silvia MIRANDA ALCÁZAR, Bagsværd (DK); Mikkel DYBRO LUNDORF, Roskilde (DK); Alicia NARANJO CHACÓN, Bagsværd (DK); Sylwia PARZYSZEK, Bagsværd (DK); Torben KROGSDAL JACOBSEN, Bagsværd (DK)

(73) Assignee: Nanocore ApS, Roskilde (DK)

(21) Appl. No.: 18/877,922

(22) PCT Filed: Jun. 26, 2023
(86) PCT No.: PCT/EP2023/067275

§ 371 Date: Dec. 20, 2024

(30) Foreign Application Priority Data
Jun. 28, 2022 (EP) 22382606.6
Jan. 18, 2023 (EP) 23382038.0

(51) Int. Cl. C01B 32/174; C08K 3/04

(52) U.S. Cl. CPC C01B 32/174; C08K 3/041; C08K 3/042

(57) ABSTRACT

A method for preparing a composite material comprising nanotubes is described. The efficiency of dispersion and anchoring as well as processing capability of the commercially relevant carbon nanotube composites are significantly improved.

### INTRODUCTION

### Technical Field

The present invention relates to composite materials and processes for the preparation thereof.

### BACKGROUND

It has previously been described how to form rings or lassos around fillers (e.g., carbon nanotubes, boron nitride nanotubes and graphene), leading to filler derivatives and filler mixtures with good dispersion, good anchoring and little aggregation between filler units. This approach improves the characteristics of the nanocomposite materials as it has been demonstrated in several experiments.

The approach previously described is industrially inefficient due to the fact that sonication is required for dispersion and/or Ushape-filler complex formation and/or ML-filler formation.

Here, we describe an alternative process that makes use of the mechanical energy generated e.g., inside a ball mill to produce industrially relevant composite materials containing lassoed fillers an enhanced characteristics. The nature of the process is such that it allows the obtention of the composite materials in a single step in the absence of solvents. The products described here possess even superior characteristics due to the absence of residual solvents and reduced processing steps.

### SUMMARY OF THE INVENTION

### General Process

In a preferred embodiment of the invention, a SE1-precursor-ML complex is formed by the following steps:
Step X1. Provide a SE1;
Step X2. Provide a precursor-ML;
to obtain a SE1-precursor-ML complex;
where Steps X1-X2 may be performed in any order.

In a preferred embodiment of the invention, SE1 is a nanotube, carbon nanotube, graphene, SWNT, MWNT, or nanowire, and the precursor-ML is a chemical structure comprising one or two or more chemical moieties with affinity for the SE1, e.g. a Ushape or another chemical entity comprising at least one ligand moiety with affinity for the SE1.

In another preferred embodiment of the invention, a nanotube-Ushape complex is formed by the following steps:
Step Y1. Provide a SE1, where the SE1 is a nanotube;
Step Y2. Provide a precursor-ML, where the precursor-ML is a Ushape comprising two chemical moieties with affinity for the nanotube;
to obtain a nanotube-Ushape complex;
where Steps Y1-Y2 may be performed in any order.

In another preferred embodiment of the invention, a nanotube-closed ring complex is formed by the following steps:
Step Z1. Provide a SE1, where the SE1 is a nanotube;
Step Z2. Provide a precursor-ML, where the precursor-ML is a Ushape comprising two chemical moieties with affinity for the nanotube;
Step Z3. Optionally, add a catalyst or a further reagent;
where Steps Z1-Z3 may be performed in any order;
to obtain a nanotube-ML complex where the ML is a closed ring around the nanotube; In a preferred embodiment of the invention, a number of precursor-MLs are added in Step Z2, and all or some of these are converted to MLs, in the form of closed rings.

The MLs added in Step Z2 may all be the same or different.

The complex obtained following Step Z3 may comprise only MLs (e.g. closed rings), or may obtain on each nanotube one or more precursor-MLs (e.g. Ushapes) and one or more MLs (e.g. closed rings).

The presence of precursor-MLs (e.g. Ushapes) in the final complex may be attractive in cases where a high conductivity of the final composite is desired; the presence of MLs (e.g. closed rings) may be attractive where a practically irreversible mechanical bonding is desired.

Process for making CMUs and composite materials.

### General Process

In a preferred embodiment of the invention, a composite material is produced by the following steps:
Step 1a. Provide a SE1;
Step 1b. Provide a precursor-ML;
Step 1c. Optionally, provide a catalyst;
Step 1d. Provide a SE2;
to generate a SE1-ML-SE2 structure.

Steps 1a, 1b, 1c, and 1d may be performed in any order.

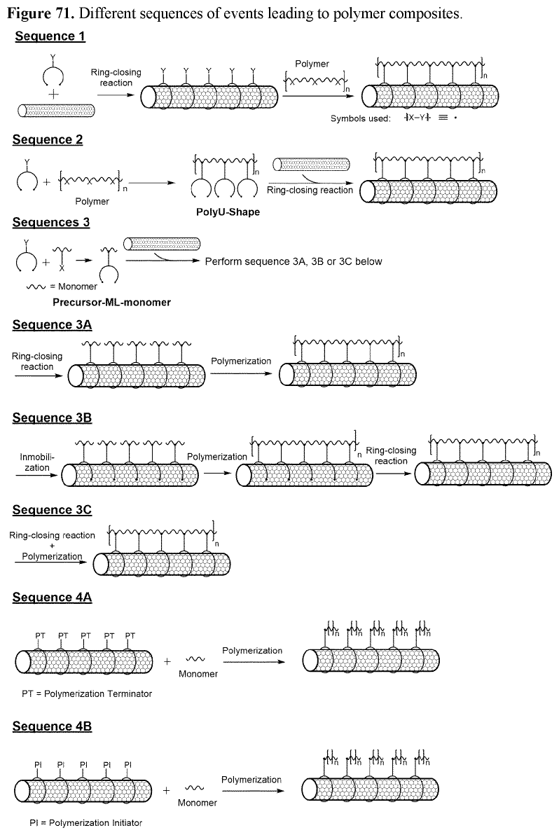

Example 0 and FIG. 71 exemplify different variations of the general process, where the individual steps are performed in different order.

In a preferred embodiment of the invention, SE1 is a nanotube, the precursor-ML comprises at least one ligand moiety with affinity for the nanotube and comprising two reactive groups that can react to allow ring-closing of the Ushape around the nanotube, thereby forming the ML, and the SE2 is a polymer that may optionally be capable of reacting with a functional group of the ML, thereby covalently linking the SE2 to the ML.

SE2 may be a small molecule (e.g. a monomer, capable of reacting with other monomers to form a polymer) or may be a larger molecule (e.g. a polymer). Thus, in the Step 1d the SE2 that is provided may be a monomer which upon the polymerization reaction with other monomers becomes a polymer. Therefore, over time the SE2 may change from being a monomer to being a polymer.

In a similar way, the SE1 provided in the Step 1a may be initially provided in the form of a building block which then upon reaction with other building blocks ends up being a larger structure (e.g. a nanotube, graphene, polymer or mineral). Therefore, over time the SE1 may change from being a smaller chemical structure (a building block) to being a larger chemical structure (an extended chemical structure like e.g. a nanotube).

In a preferred embodiment SE2 is a polymer that is covalently linked to the precursor-ML in the first reaction of the process, as indicated by the following steps:
Step 2a. Provide a precursor-ML;
Step 2b. Provide a polymer and react polymer with precursor-ML to form a covalent bond between polymer and precursor-ML;
Step 2c. Provide a SE1 and allow precursor-ML to associate with SE1;
Step 2d. Provide a catalyst that is capable of mediating reaction of two functional groups of the precursor-ML, thereby forming the ML, mechanically bound to SE1;
to generate a SE1-ML-polymer structure.

FIG. 71 describes the production of composite materials comprising nanotubes (as SE1) and polymer (as SE2). These sequences of events and the general approach of producing composite materials apply, however, to all kinds of SE1 and SE2, and therefore generally describe the production of polymer-, ceramics- and metal composites, and any other kind of composite materials. For non-polymer composites, the applicable SE2 can simply replace “polymer” in the various schemes of FIG. 71.

Moreover, the 8 different sequences of events, depicted in FIG. 71, may be combined in any way.

Sequence 1 of FIG. 71 describes the initial binding of precursor-ML (in the figure: a Ushape) to a SE1 (in the figure: a nanotube), followed by formation of the SE1-ML complex, and finally addition of SE2 (in the figure: a polymer) and reaction between SE2 and ML to form the final product, SE1-ML-SE2. Thus, in a preferred embodiment of the invention, the following steps are performed:
Step 3a. Provide a precursor-ML;
Step 3b. Provide a SE1, to form a SE1-precursor ML complex;
Step 3c. The precursor-ML is turned into a ML, mechanically bound to the SE1, optionally by the addition of catalyst and/or reagent(s);
Step 3d. Provide a SE2 and covalently or non-covalently link it to the ML, optionally by the addition of catalyst and/or reagent(s);
to form a SE1-ML-SE2 structure.

Sequence 2 of FIG. 71 describes the initial formation of a poly-precursor-ML (in the figure: poly-Ushape) by reaction of multiple precursor-MLs with one SE2 (in the figure: polymer), followed by addition of SE1 (in the figure: nanotube) and ring-closing around SE1, to form a SE1-ML-SE2 structure. Accordingly, this sequence of events can be described by the following process steps:
Step 4a. Provide a precursor-ML;
Step 4b. Provide a SE2, and attach one or more precursor-ML to SE2;
Step 4c. Provide a SE1, and allow complexation to form a SE1-precursor-ML-SE2 complex;
Step 4d. Convert the precursor-ML to a ML, mechanically bound to SE1;
to form a SE1-ML-SE2 complex.

Sequence 3A of FIG. 71 describes the initial mixing of precursor-ML (in the figure: Ushape) and a portion of SE2 (in the figure: monomer), to generate the structure precursor-ML-portion of SE2 (in the figure: Ushape-monomer structure), and then SE1 (in the figure: nanotube) is added, precursor-ML-portion of SE2 is turned into ML-portion of SE2 structure, and finally the portions of SE2 are reacted to form SE2, and thereby generating a SE1-ML-SE2 structure. In this context, “the portion of SE2” is itself a SE2, as well as the full-size SE2 that is produced upon reaction of multiple “portions of SE2”. Accordingly, the following steps are performed:
Step 5a. Provide a precursor-ML and a portion of SE2, and associate or react the two components to form a precursor-ML-portion of SE2 structure;
Step 5b. Provide a SE1 and allow SE1-precursor-ML complex formation;
Step 5c. Turn the precursor-ML into a ML, to form a SE1-ML-portion of SE2 structure;
Step 5d. Allow reaction of the portions of SE2 with each other;
to form a SE1-ML-SE2 structure.

Sequence 3B of FIG. 71 describes the initial mixing of precursor-ML (in the figure: Ushape) and a portion of SE2 (in the figure: monomer), to generate the structure precursor-ML-portion of SE2 (in the figure: Ushape-monomer structure), and then SE1 (in the figure: nanotube) is added, to form the complex SE1-precursor-ML-portion of SE2, then the portions of SE2 are reacted to form the complex SE1-precursor-ML-SE2, and finally the precursor-ML is turned into ML, thereby generating the SE1-ML-SE2 structure. In this context, “the portion of SE2” is itself a SE2, as well as the full-size SE2 that is produced upon reaction of multiple “portions of SE2”. Accordingly, the following steps are involved:
Step 6a. Provide a precursor-ML and a portion of SE2, and associate or react the two components to form a precursor-ML-portion of SE2 structure;
Step 6b. Provide a SE1 and allow SE1-precursor-ML-portion of SE2 complex formation;
Step 6c. Allow reaction between portions of SE2, attached to precursor-MLs, to form the SE1-precursor-ML-SE2 structure;
Step 6d. Convert the precursor-ML into a ML;
to form a SE1-ML-SE2 complex.

Sequence 3C of FIG. 71 describes the initial mixing of precursor-ML (in the figure: Ushape) and a portion of SE2 (in the figure: monomer), to generate the structure precursor-ML-portion of SE2 (in the figure: Ushape-monomer structure), and then SE1 (in the figure: nanotube) is added, followed by complexation, conversion of precursor-ML into ML (in the figure: ring closing) and SE2 formation (in the figure: polymerization), thereby generating the SE1-ML-SE2 structure. In this context, “the portion of SE2” is itself a SE2, as well as the full-size SE2 that is produced upon reaction of multiple “portions of SE2”. Accordingly, the following steps are performed:
Step 7a. Provide a precursor-ML and a portion of SE2, and associate or react the two components to form a precursor-ML-portion of SE2 structure;
Step 7b. Provide a SE1 and allow SE1-precursor-ML-portion of SE2 complex formation;
Step 7c. Allow conversion of the precursor-ML to a ML and formation of a SE2 from portions of SE2;
to form a SE1-ML-SE2 complex.

Sequence 4A of FIG. 71 describes how precursor-MLs (in the figure: Ushapes) carrying a polymerization terminator moiety (PT) is first complexed to a SE1 (in the figure: nanotube) and then the precursor ML is converted to a ML (in the figure: closed ring) mechanically bound to the SE1, then portions of SE2 (in the figure: monomers) are added, and following the association of the portions of SE2 (in the figure: the polymerization of the monomers to form the polymer), the SE2 is attached to the ML through the PT, by way of the last reaction of the polymerization terminating on the polymerization terminator, to form a SE1-ML-SE2 structure. In this context, “the portion of SE2” is itself a SE2, as well as the full-size SE2 that is produced upon reaction of multiple “portions of SE2”. Accordingly, Sequence 4A can be summarized by the following steps:
Step 8a. A SE1, a precursor-ML carrying a polymerization terminator (PT), and optionally a catalyst capable of mediating the conversion of precursor-ML into ML, and a monomer is provided, leading to formation of the SE1-ML complex, where the ML carries a polymerization terminator moiety (PT).
Step 8b. Optionally, a catalyst is provided;
Step 8c. Polymerization proceeds to form a polymer in solution;
Step 8d. The growing polymer eventually terminates its polymerization on the polymerization terminator, thereby forming a SE1-ML-SE2 structure in which one ML is attached to one polymer.

Sequence 4B of FIG. 71 describes how precursor-MLs (in the figure: Ushapes) carrying a reactive group (PT) is first complexed to a SE1 (in the figure: nanotube) and then the precursor ML is converted to a ML (in the figure: closed ring) mechanically bound to the SE1, and portions of SE2 (in the figure: monomers) are added, and following the association of the portions of SE2 (in the figure: the polymerization of the monomers to form the polymer, which in this case carries a reactive group capable of reaction with PT), then the SE2 is attached to the ML, through a reaction between PT and the one reactive group of the polymer, to form a SE1-ML-SE2 structure. In this context, “the portion of SE2” is itself a SE2, as well as the full-size SE2 that is produced upon reaction of multiple “portions of SE2”. Accordingly, Sequence 4A can be summarized by the following steps:
Step 9a. A SE1, a precursor-ML carrying a reactive group (PT), and optionally a catalyst capable of mediating the conversion of precursor-ML into ML, and monomers are provided, leading to formation of the SE1-ML complex, where the ML carries a reactive group (PT).
Step 9b. Optionally, a catalyst is provided;
Step 9c. Polymerization proceeds to form a polymer in solution, where the polymer carries one reactive group capable of reacting with the other reactive group (PT);
Step 9d. Optionally, a catalyst and/or reagent(s) are provided;
Step 9e. The reactive group of the polymer is brought to react with the reactive group (PT) of the ML;
to form a SE1-ML-SE2 structure.

In some instances, it is desirable to first form the SE1-ML complex, e.g. in order to disperse the SE1 more efficiently, and then dissociate the SE1-ML complex to obtain SE1 in its “free” form (not complexed to ML), as this may allow the efficient dispersion of SE1 without the ML complexed. As an example, it might increase the electrical conductivity or heat conductivity of a composite material comprising SE1-ML complexes if the ML is dissociated from the SE1. Thus, in a preferred embodiment the following steps are performed in order to obtain well-dispersed, non-ML-complexed SE1 in a composite:
Step 10a. Provide a SE1;
Step 10b. Provide a precursor-ML;
Step 10c. Provide a catalyst and/or conditions allowing the precursor-ML to become a ML, complexed to the SE1;
Step 10d. Provide a SE2;
to generate a composite material comprising a SE1-ML-SE2 structure;
Step 10e. Dissociate the SE1-ML complex into a SE1 and a ML;
to obtain a composite material comprising ML, SE2, and non-ML-complexed SE1.

In a variation of the scheme immediately above, SE1 is a carbon nanotube, the precursor-ML is a UShape carrying two reactive groups, capable of reacting with each other and thereby turn the Ushape into a closed ring around the carbon nanotube (whereby the precursor-ML becomes a ML). Thus, in a preferred embodiment of the invention, the following steps are performed:
Step 11a. Provide a carbon nanotube;
Step 11b. Provide a Ushape carrying two reactive groups, capable of reacting with each other to turn the Ushape into a closed ring structure, wrapped around the carbon nanotube, where the two reactive groups may both be double bonds, and where part of the Ushape (and hence part of the closed ring structure) comprises a cleavable moiety, such as a polypeptide;
Step 11c. Provide a catalyst, e.g. Grubb's second generation catalyst, under conditions allowing the catalyst to mediate the transformation of Ushape into closed ring around the carbon nanotube, thereby generating carbon nanotube-closed ring complexes;
Step 11d. Provide a polymer, e.g. nylon or other polyamide, polypropylene, polyethylene (HDPE or LDPE), PVC, polyurethane, polycarbonate, or polystyrene, and mix, to obtain a mixture of well-dispersed carbon nanotube-closed ring complexes in a matrix of polymer;
Step 11e. Add a cleaving agent capable of cleaving the closed ring, to open the closed ring, e.g. if the cleavable moiety of the Ushape is a polypeptide, then a protease is added capable of cleaving the polypeptide; and allow the cleaving agent to cleave the cleavable moiety, to obtain non-ML-complexed carbon nanotube in a matrix of polymer.

Depending on the efficiency with which the rings are removed from the carbon nanotube, the composite resulting from Step 11e may be more or less electrically conductive or heat conductive.

### DETAILED DESCRIPTION OF THE INVENTION

In this invention, industrially relevant nanotube composite materials and the processes required for their preparation are described. In the description section, all the processes necessary for the preparation of nanotube composite materials are detailed.

As an example, for the preparation of a polystyrene (PS) composite reinforced with covalently-attached single-walled carbon nanotubes (SWNTs) perfectly dispersed and anchored to the polymer matrix, the following steps may be followed:
Steps A.1.1 to A.1.5+A.2 for the preparation of a SWNT-ML, where the ML carries a functional group able to react with a polystyrene molecule carrying another functional group.
Steps B.1, A.2 and A.3 for reaction of the chosen PS and the prepared SWNT-ML.

Alternatively, the PS may be attached to the SWNTs at the same time of formation of the SWNT-ML, where the ML carries a functional group able to react with a styrene monomer. In that case, the next steps will be followed:
Steps A.1.1 to A.1.6 for the mixing of the styrene monomers, the SWNTs and precursor-MLs (and, alternatively, any other molecules that might be necessary)
Step A.2 for the polymerization of styrene, formation of the SWNT-ML species and reaction between SNWT-ML and reacting styrene. In this case, the SWNT-ML forming reaction will be same or similar to that of the polymerization of the polystyrene molecules.

### DESCRIPTION

This invention describes alternative and industrially relevant approaches for the dispersion and/or Ushape-structural entity (SE, i.e., a carbon nanotube) complex formation and/or ML-SE formation, as well as for other key processes involved in efficient nanotube dispersion or nanotube composite material production.

The approaches have been divided into steps, that describe the key processes contained in this patent. One step or a combination of steps leads to a product. The steps describe general processes that can be performed one or several times during an approach. In many cases—as it will be detailed—most of the steps are interchangeable, meaning that they can be performed in a different order. This will be further explained in the steps overview.

### Steps Overview:

In one embodiment of this invention, the formation of a SE1-ML involves two steps; providing a SE1 and providing a precursor-ML.

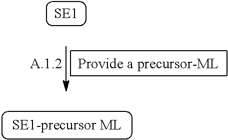

Step A.1.1. Provide a structural entity (SE1)
Step A.1.2. Provide a precursor-ML

Interchangeable steps: Steps A.1.1 and A.1.2 can be performed in any preferred order.

In another embodiment of this invention, the formation of a SE1-ML-SE2 complex involves three interchangeable steps; providing a SE1, providing a precursor-ML and providing a SE2.

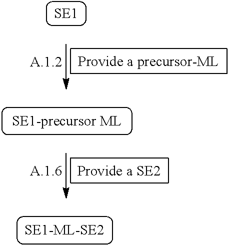

Step A.1.1. Provide a structural entity (SE1)
Step A.1.2. Provide a precursor-ML
Step A.1.6. Provide a SE2.

Interchangeable steps: Steps A.1.1, A.1.2 and A.1.6 can be performed in any preferred order.

In one embodiment of this invention, the formation of a composite containing SE1-MLs involves four main blocks divided in four steps. In the first block, an SE1 and a ML are provided in order to obtain a SE1-precursor ML. In the next block (step A.2) takes place the reactions/processes that lead to the formation of a SE1-ML. In the third block, a SE2 is provided forming a SE1-ML/SE2. In the fourth block, (step A.2) takes place the reactions/processes that lead to the formation of an SE1-ML-SE2.

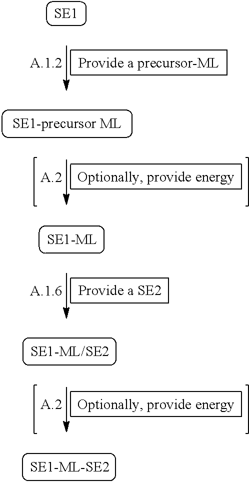

Step A.1.1. Provide a structural entity (SE1)
Step A.1.2. Provide a precursor-ML
Step A.2. Optionally, provide energy
Step A.1.6. Provide a SE2.
Step A.2. Optionally, provide energy

In a different embodiment of the invention, the formation of a SE1-ML complex involves three main blocks divided in six steps. In the first block (steps A.1.1 to A.1.5), the elements required for an SE1-ML to be formed are provided. In the second block (step A.2) takes place the reactions/processes that lead to the formation of an SE1-ML. In the third block (step A.3), an optional purification of the SE1-ML is performed.

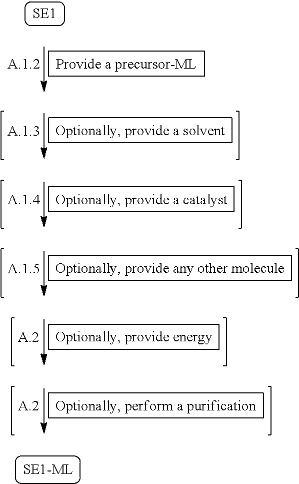

Step A.1.1. Provide a structural entity (SE1)
Step A.1.2. Provide a precursor-ML
Step A.1.3. Optionally, provide a solvent
Step A.1.4. Optionally, provide a catalyst
Step A.1.5. Optionally, provide any other molecule
Step A.2. Optionally, provide energy
Step A.3. Optionally, perform a purification process

Interchangeable steps: Steps A.1.1 to A.1.5 can be performed in any preferred order.

In a different embodiment of this invention, the formation of a SE1-ML complex involves five main blocks divided in seven steps. In the first block (steps A.1.1-A.1.2), the elements required for a SE1-precursor ML to be formed are provided. In the second block (step A.2), takes place the reactions/processes that lead to the formation of an SE1-precursor ML. In the third block (step A.1.3-A.1.5), optional elements employed in the formation of SE1-ML are added. In the fourth block (step A.2), takes place the reactions/processes that lead to the formation of an SE1-ML. In the fifth block (step A.3), an optional purification of the SE1-ML is performed.

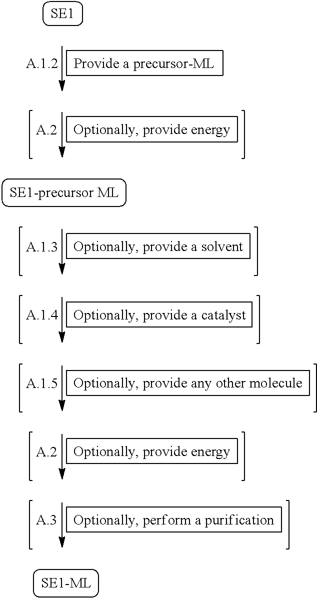

Step A.1.1. Provide a structural entity (SE1)
Step A.1.2. Provide a precursor-ML
Step A.2. Optionally, provide energy
Step A.1.3. Optionally, provide a solvent
Step A.1.4. Optionally, provide a catalyst
Step A.1.5. Optionally, provide any other molecule
Step A.2. Optionally, provide energy
Step A.3. Optionally, perform a purification process

Interchangeable steps: Steps A.1.1 and A.1.2 can be performed in any preferred order. Steps A.1.3 to A.1.5 can be performed in any preferred order.

In a different embodiment of this invention, the formation of a composite containing SE1-MLs (SE1-ML-SE2) involves three main blocks divided in six steps. In the first block (steps A.1.1 to A.1.6), the elements required for an SE1-ML-SE2 to be formed are provided. In the second block (step A.2) takes place the reactions/processes that lead to the formation of an SE1-ML-SE2. In the third block (step A.3), an optional purification of the SE1-ML-SE2 is performed.

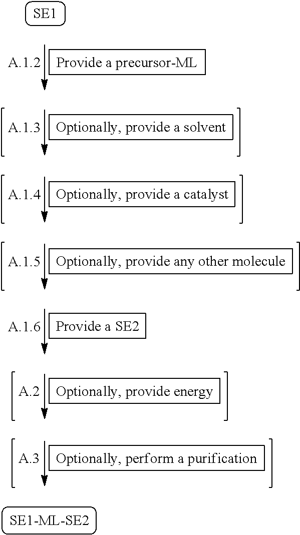

Step A.1.1. Provide a structural entity (SE1)
Step A.1.2. Provide a precursor-ML
Step A.1.3. Optionally, provide a solvent
Step A.1.4. Optionally, provide a catalyst
Step A.1.5. Optionally, provide any other molecule
Step A.1.6. Provide a SE2.
Step A.2. Optionally. provide energy
Step A.3. Optionally, perform a purification process

In a different embodiment of this invention, the formation of a composite containing SE1-MLs (SE1-ML/SE2) involves three main blocks divided in six steps. In the first block (steps A.1.1 to A.1.6), the elements required for an SE1-ML/SE2 to be formed are provided. In the second block (step A.2) takes place the reactions/processes that lead to the formation of an SE1-ML/SE2. In the third block (step A.3), an optional purification of the SE1-ML/SE2 is performed.

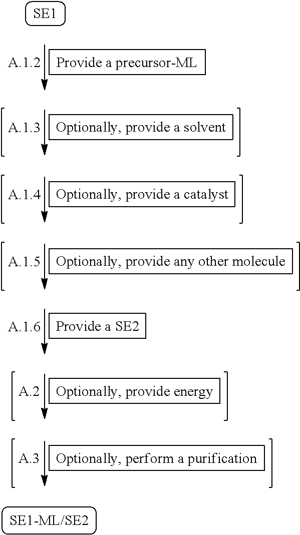

Step A.1.1. Provide a structural entity (SE1)
Step A.1.2. Provide a precursor-ML
Step A.1.3. Optionally, provide a solvent
Step A.1.4. Optionally, provide a catalyst
Step A.1.5. Optionally, provide any other molecule
Step A.1.6. Provide a SE2.
Step A.2. Optionally. provide energy
Step A.3. Optionally, perform a purification process

Interchangeable steps: Steps A.1.1 to A.1.6 can be performed in any preferred order.

In a different embodiment of this invention, the formation of a composite containing SE-MLs (SE1-ML-SE2) involves involves three main blocks divided in three steps. In the first block (step A.1.6), an SE2, required for an SE1-ML-SE2 to be formed is provided. In the second block (step A.2) takes place the reactions/processes that lead to the formation of an SE1-ML-SE2. In the third block (step A.3), an optional purification of the SE1-ML-SE2 is performed.

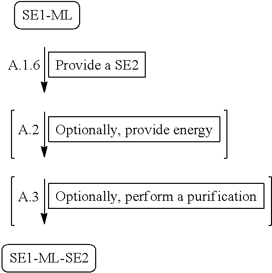

Step B.1. Provide a SE1-ML obtained following steps A.1.1-1.5+A.2 or A.1.1-1.5+A.2-3
Step A.1.6. Provide a SE2
Step A.2. Optionally, provide energy
Step A.3. Optionally, perform a purification process

In a different embodiment of this invention, the formation of a composite containing SE-MLs (SE1-ML/SE2) involves three main blocks divided in three steps. In the first block (step A.1.6), an SE2, required for an SE1-ML/SE2 to be formed is provided. In the second block (step A.2) takes place the reactions/processes that lead to the formation of an SE1-ML/SE2. In the third block (step A.3), an optional purification of the SE1-ML/SE2 is performed.

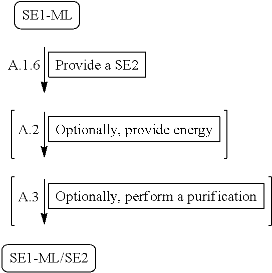

Step B.1. Provide a SE1-ML obtained following steps A.1.1-1.5+A.2 or A.1.1-1.5+A.2-3
Step A.1.6. Provide a SE2
Step A.2. Optionally, provide energy
Step A.3. Optionally, perform a purification process

Interchangeable steps: Steps B.1. and A.1.6 can be performed in any preferred order.

The embodiments described above lead to the formation of SE1-precursor ML, SE1-ML, SE1-ML-SE2 and SE1-ML/SE2, but the processes described here also allow further processing in order to obtain simplified products. Therefore, in a different embodiment of this invention, the obtention of SE1 from SE1-precursor ML involves three main blocks divided in five steps. In the first block (A.1.5 and A.2), molecules and/or energy is employed to disrupt the interactions between SE1 and precursor ML, leading to a SE1+precursor ML mixture. In the second block (steps A.1.5 and A.2), molecules and/or energy is employed to modify the structure of the precursor ML, leading to SE1+non precursor ML. In the third block (step A.3), an optional purification of the SE1 is performed.

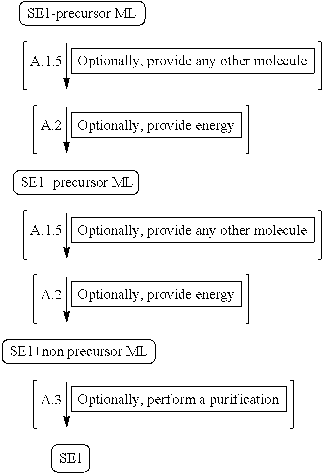

Step C.1. Provide a SE1-precursor ML
Step A.1.5. Optionally, provide any other molecule
Step A.2. Optionally, provide energy
Step A.1.5. Optionally, provide any other molecule
Step A.2. Optionally, provide energy
Step A.3. Optionally, perform a purification process

Interchangeable steps: Steps A.1.5 and A.2 can be performed in any preferred order.

In a different embodiment of this invention, the obtention of a composite containing SE1+precursor ML+SE2 from SE1-ML/SE2 involves two steps. In these two steps (A.1.5 and A.2), molecules and/or energy is employed to disrupt the interactions between SE1 and ML, leading to a SE1+precursor ML+SE2 mixture.

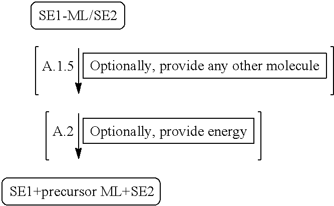

Step D.1. Provide a SE1-ML/SE2
Step A.1.5. Optionally, provide any other molecule
Step A.2. Optionally, provide energy

Interchangeable steps: Steps A.1.5 and A.2 can be performed in any preferred order.

In a different embodiment of this invention, the obtention of a composite containing SE1+non precursor ML+SE2 from SE1-ML/SE2 involves two steps. In these two steps (A.1.5 and A.2), molecules and/or energy is employed to disrupt the interactions between SE1 and ML, leading to a SE1+non precursor ML+SE2 mixture.

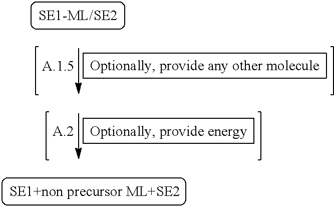

Step D.1. Provide a SE1-ML/SE2
Step A.1.5. Optionally, provide any other molecule
Step A.2. Optionally, provide energy

Interchangeable steps: Steps A.1.5 and A.2 can be performed in any preferred order.

### Detailed Steps:

Step A.1.1. Provide an SE

An SE may be a nanotube, such as a carbon nanotube. An SE may be a polymeric material.

An SE may be a [**fill this**]

An SE may be provided in solid form, in melt form, in liquid form. An SE may as well be provided in a dispersed/de-entangled form. The dispersion/de-entanglement process separates an individual SE from a group of two, three or several SEs. In some instances, the separation requires braking up the non-covalent forces that make the SEs interact with each other. Several strategies can be followed to disperse SEs:
Chemically-promoted separation: Use of solvents, covalent functionalization of the SE surface, non-covalent functionalization of the SE surface, use of surface-active agents
Physical methods:
   Mechanical methods:
   With grinding media (ball milling, paint shaker, ball collision-mill, bead mill/sand mill)
   Without grinding media (cone-mill, high shear batch disperser, thin-film spin mixer, rotor-mill)
   Cavitation methods
   Bath sonicator
   Probe sonicator
   Turbulent flow methods:
   High pressure jet-mill (water or air)
A combination of the above strategies

An SE may be a short carbon nanotube. The process of shortening or cutting carbon nanotubes consists on decreasing the length of the largest nanotube dimension. The process may be carried out by treating the nanotubes with acids or combinations of acids, by heating them in an oxidating atmosphere such as air atmosphere or by mechanically processing them (e.g., in a ball mill or sonication).

An SE may be an ultrashort carbon nanotube. An ultrashort carbon nanotube is a 20-100 nm segment of a single-walled carbon nanotubes (SWNTs).

An SE may be provided in a frozen state.

Step A.1.2. Provide one precursor-ML or ML, two precursor-MLs or MLs having different chemical structure, three precursor-MLs or MLs having different chemical structure or several precursor-MLs or MLs having different chemical structure.

Step A.1.3. Optionally, provide a solvent such as aromatic compounds (e.g., toluene or benzene), alcohols (e.g., methanol, isopropanol), esters and ethers (e.g., diethyl ether), ketones (e.g., acetone or butanone), amines and amides (e.g., 2-amino-2-methylpropanol, dimethylformamide), nitrated and halogenated hydrocarbons (e.g., tetrachloroethane, chloroform or dichloromethane), acids (e.g., formic acid or nitric acid), nitriles (e.g., acetonitrile) sulfoxides (e.g., dimethylsulfoxide) or water.

Step A.1.4. Optionally, provide a catalyst such as ruthenium-based catalysts (e.g., 1^{st} 2^{nd} or 3^{rd} generation Grubbs catalyst), group 4 metals titanium, zirconium or hafnium-based catalysts (e.g., TiCl₃ and Al(C₂H₅)₂Cl, or TiCl₄ with Al(C₂H₅)₃), acids (e.g., p-toluenesulfonic acid), bases (e.g., a tertiary amine such as triethylamine), a phase-transfer catalyst (e.g., a quaternary ammonium and sulfonium salt), copper catalysts (e.g., CuBr+bipyridine mixture or CuI+DIPEA mixture) or tin catalysts (e.g., Sn(Oct)₂), enzymes, [**fill this**]

Step A.1.5. Optionally, provide any other molecule

In some cases, a molecule or a combination of molecules may be employed to prevent SE reaggregation. Thus, another molecule may be a nonionic surfactant (e.g., Triton X, Triton X-100, Pluronic, Pluronic F-127, Igepal, aniline trimer (AT) or Brij), an ionic surfactant (e.g., sodium dodecylsulfate (SDS), sodium dodecylbenzenesulphonate (SDBS), sodium cholate (SC), sodium deoxycholate (SDC), sodium taurodeoxycholate (TDC), dodecyltrimethylammonium bromide (DTAB) or cetyltrimethylammonium bromide (CTAB)), a polymer (e.g., polystyrene, aromatic polyimides, polyfluorene copolymers (e.g., PFO-BPy)), cellulose derivatives such as regenerated cellulose, carboxymethyl cellulose or hydroxyethyl cellulose, lignin, Gum Arabic, DNA, lipids (e.g., rhamnolipids) or polypeptides.

In other cases, the molecules described above may be used to increase the efficiency of SE individualization. Different molecules also include Na⁺-montmorillonite, alkali metals (i.e., lithium or sodium), superacids (i.e., chlorosulphonic acid, anhydrous p-toluenesulfonic acid (pToS), methanesulfonic acid (MSA) or their mixtures with a small amount of fuming sulfuric acid) or solvents (e.g., N-methyl-pyrrolidone).

In other cases, the molecules may be employed to increase the thermal conductivity of the final product (i.e., for its use in EMI shielding applications), e.g., hybrid reduced-graphene-oxide/Fe₃O₄ nanoparticles.

In other cases, the molecules may be employed to hydrolyse selected bonds in the final products such as ozone,

Step A.1.6. Provide a SE2. An SE2 may be a monomer or a polymer; cement or other cementitious substance; fly ash, slag cement, silica fume, nanosilica, natural pozzolans, calcium-sulfoaluminate or calcium aluminate cements, metal particles or other type of molecule, supramolecular structure, or particle.

Step A.2. Provide energy. In this step, energy is provided in order to induce a mechanical reaction or to modify certain characteristics in the mixtures, e.g., density or homogenization. Energy may be provided in one or several forms, consecutively or simultaneously. As an example, a SE1 may be reacted with a ML and a second SE (SE2) by first providing heat to the mixture and second mechanical energy or viceversa. Energy may be provided in the form:
Mechanical energy: Under certain conditions, the application of mechanical energy may induce a mechanochemical processes. A mechanochemical process may be performed by:

Mortar grinding. Pressing and twisting a pestle against a mortar. Conditions to take into account:

Size of the mortar and pestle: Larger or smaller mortars can be employed. In a preferred embodiment, where low density SEs are employed, and therefore large reaction volumes are employed, larger mortars are preferred. This may be the case when single-walled nanotubes are employed as SE. In another preferred embodiment, small reaction quantities are employed and therefore smaller mortars are preferred.

Mortar and pestle material: Materials such as agate, porcelain, aluminium oxide, wood or may be chosen. In one embodiment, a mortar with very fine grain structure such as agate is preferred due to the use of oil-like reactives that stick to the mortar walls. In these cases, the grinded product can be cleaned out with ease.

Reaction times: The processes may be performed in short times such as 5 s or long times such as 6 h. In some cases, the precursor-MLs may decompose under mechanical treatment, therefore shorter reaction times are preferred. In other cases, the reaction rates are very low (e.g., the reaction rate for the SE1-ML formation) and longer times will be preferred.

Temperature: The processes may be performed in low temperatures such as −20° C. using a liquid-nitrogen cooled mortar or at high temperatures such as 80° C. by placing the mortar in a heat source. In a preferred embodiment, a liquid-nitrogen cooled mortar is employed in order to avoid side-reactions in the starting materials. This may be the case when using graphene oxide nanosheets as SEs, since they can undergo thermal reduction in the grinding process.

In another preferred embodiment, the mortar is placed in a heat source in order to favour the melting of a reagent. This may be the case of reaction mixtures where a polymer, e.g. PMMA is employed as SE.

### Balls in Vessel/Ball Mill/Shaker Mill

Type of the mill:
Standar ball mills or tumbling mills: hollow cylindrical chamber that is fixed to an axis. Upon operation, it rotates by its axis on a set speed and the balls occupying its chamber space collide with the materials placed inside.
Vibration mills: A tank-like type of mill containing material and milling media (e.g., balls, cylpebs or rods), either wet or dry. The milling chamber describes a three dimensional motion that involves four factors: the speed of the vibration, the horizontal amplitude, the vertical amplitude and the phase angle.
Planetary mills: The reactors describe a planet-like movement. Two centrifugal fields enhances the forces acting on the balls in relation to the conventional ball mills.
Mixer mills: The reactor containing the milling balls and sample is swung energetically back and forth several thousand times a minute. The swinging is combined with lateral movements of the end of the reactor.
Attritors (stirred ball mills): They consist on a cylindrical grinding chamber with a drive shaft having multiple impellers sticking out from the rotating shafts. The rotating shaft puts the grinding media, sample and optionally solvent into a stirring motion.
Specially designed mills: For some special cases, specially design mills may be preferred.

In a preferred embodiment, a planetary mill is employed to produce a small quantity of highly individualized single-walled carbon nanotubes by incorporating pyrene-based mechanical ligands in their structure. In another preferred embodiment, a large tumbler mill is employed to produce 1 ton polypropylene reinforced with SWNT-ML.

Reactor size: A large reactor may be preferred in order to produce several tons of final material. A small reactor may be preferred when working with small samples in order to avoid excessive empty space inside the reactor. In a preferred embodiment, 1.5 g single-walled carbon nanotubes, 630 mg pyrene precursor-ML, 61 mg Grubbs 2^{nd} generation catalyst and five 15 mm stainless steel balls are introduced in a 45 mL stainless steel planetary mill reactor to produce SE1-ML. In another embodiment, 1270.7 ton polypropylene, 1.27 ton single-walled carbon nanotubes, 0.5 ton precursor-ML, 0.05 ton 2^{nd} generation Grubbs catalyst and 80 mm stainless steel grinding balls are mixed in a 782 cubic metre horizontal ball mill to produce SE1-ML.

Reactor material: Such as stainless or hardened steel, zirconium oxide, tungsten carbide, sintered corundum, agate or teflon.

In some processes, the use of stainless steel reactors may be avoided due to cross-contamination with iron. In other cases, where corrosive substances must be employed (e.g., formic acid) tungsten carbide or zirconium oxide may be preferred due to their chemical resistance.

The reactor material can also modify the energy input given to the milling system. Denser and harder materials (e.g., tungsten carbide followed by steel) will provide high energy input to the system. Therefore, reactions that require higher activation energies to take place may be performed in heavyweight-milling materials.

In a preferred embodiment, a zirconium oxide is employed in the preparation of a UHMWPE hip prosthesis reinforced with lassoed single-walled carbon nanotubes, where the lassoed single-walled carbon nanotubes are prepared by Suzuki reaction. In another embodiment, a stainless steel ball mill is employed in the production of cements reinforced with SE1-ML—where SE1 is a single-walled carbon nanotube and ML a mechanical ligand carrying terminal acid groups—mechanically covalently to the cement structure.

Relationship inner reactor volume/sample volume: This is an important factor to consider. In reactions performed in the absence of solvent, a homogeneous mixture is not immediately obtained. If the empty volume in the reactor is too low (i.e., a low reactor volume/sample volume relationship), the balls will not be able to move everywhere and the reaction and homogenization will be uncomplete. In the opposite case, if the reactor volume/sample volume relationship is too high, longer times will be needed to homogenize the reaction mixture. In a preferred embodiment, a 10% of the reactor volume is filled with the reacting material. In another embodiment, a 75% of the reactor volume is filled with the reacting material. Thus, depending on the context, the volume of material versus volume of the reactor can be 1% to 99%.

Ball to powder weight ratio: Typical values such as 5:1, 10:1 or 15:1, 20:1, 30:1, 100:1. In a preferred embodiment, a SE1-ML is prepared by mixing 1.5 g SWNTs, 630 mg precursor-ML, 61 mg Grubbs 2^{nd} generation catalyst and five 15 mm diameter stainless steel balls, meaning a 27:1 ball to powder weight ratio.

Reaction times: Some organic transformations may require large reaction times to fully complete but at the same time, longer reaction times may lead to product decomposition. Longer reaction times also lead to the breakage/shortening of the SEs. The choice of the reaction time will thus be a compromise: for some applications, longer SEs may be preferred and reaction times will be lowered.

In a preferred embodiment, longer times such as 12 h are employed to produce SE1-ML where SE1 are ultra short carbon nanotubes. In another embodiment, short times such as 15 min are employed to produce ring-closing metathesis of a precursor-ML carrying terminal double bonds around a SE1 such as a multiwall carbon nanotube.

Rotation speed: higher rotational speeds may lead to an increase in the reaction medium temperature. In some cases, the increase may enhance the formation of the final desired products. Also, higher and more effective speeds may allow the reduction of the reaction times. In different cases, higher temperature may lead to the formation of undesired byproducts.

If the process is happening inside a tumbler ball mill the mill speed must be different to the critical speed, the speed at which the grinding media will centrifuge against the wall of the cylinder (i.e., at this speed no milling will occur). The operating speed may be a percentage of the critical speed.

In some cases, such as the formation of mechanical ligands around single-wall carbon nanotubes, the rotation speeds are low such as 400 rpm in order to reduce damage of the carbon nanotube walls. In other cases, such as the Sonogashira reaction between a SE1-ML where the ML carries a terminal alkyne group and a polystyrene chain carrying a terminal bromide, high speeds such as 1800 rpm are preferred.

Balls material, number and size: Similarly to what happens with the reactor material, the balls material must be chosen in order to avoid undesired side-reactions. In some cases, the balls material can be used to catalyse the reaction taking place inside the ball mill (e.g., In a polymer attaching reaction where a polymer containing a terminal azide is covalently linked to a ML containing a triple bond, Cu milling balls may be employed as catalysts in the click reaction).

The balls number and size may be empirically determined for each reaction. The larger the size of the balls the fewer impacts per revolution, but at the same time, the larger the size of the balls the more energetic will be each impact. Smaller balls will produce more impacts but less energetic. In a preferred embodiment, such as the preparation of SE-ML where SE is a single-walled carbon nanotube and the ML is a pyrene-based macrocycle formed by ring-closing metathesis, more than four 10 mm diameter stainless steel balls are required for the reaction to be quantitative in a 20 mL stainless steel reactor.

Atmosphere: The choice of an inert (e.g., evacuated, argon, nitrogen or helium) or air atmosphere is also an important parameter to consider. Reactions catalysed by metallic complexes carried out in air may lead to partial deactivation of the catalyst.

The presence of oxygen in the reaction mixture may enhance the formation of undesired defects in the walls of carbon nanotubes. In some cases, such as the preparation of SE-MLs where SE is a single-walled carbon nanotube, an inert atmosphere (e.g., argon or nitrogen atmospheres) is preferred. In other cases, the incorporation of acid functional groups in the walls of the carbon nanotubes due to the employment of air atmospheres is preferred in order to enhance the solubility of the final products in water, increasing their compatibility with a cementitious matrix.

Also, some atmospheres may be used to produce certain reactivities, e.g., a combination of nitrogen and ammonia may lead to the production of nitrides and hydrogen atmosphere to the production of hydrides.

Humidity (liquid-assisted grinding) during processing: In some cases, the reactivity may be enhanced or controlled towards the obtention of a certain product by the addition of a small amount of liquid such as in a Suzuki-Miyaura reaction between an aryl chloride and a boronic acid to form a mechanical ligand. In other cases, the reactivity may be enhanced by removing humidity such as in the performance of moisture-sensitive reactions (e.g., a SWNT shortening reaction where the oxidation of the SWNTs wants to be minimized). Thus, depending on the context, the liquid content in the reaction vessel is preferentially greater than [** . . . **]

Temperature: During a ball milling, a large among of the energy generated dissipates as heat. For this reason, the temperature generated inside the milling reactor is an important factor to take into account when designing the synthetic protocol. The temperature plays a key role in the evolution of the chemical reactions and processes happening inside a ball mill. In some cases, an increase in temperature is necessary to produce the reactions, e.g., the ring-closing metathesis reaction. In some other cases, the temperature may lead to side reactions or degradation of heat-sensitive formed products.

Temperature inside the milling reactor may be controlled by the integration of milling pauses in the milling cycle. Other options include: cryogenic milling that may be performed by cooling down the beaker (e.g., using liquid nitrogen) previous to the milling process or by constant cooling during the milling process (e.g., using liquid nitrogen), water cooling of the vessels, air cooling, use of heating tapes or the use of double-walled milling beakers equipped with an inlet and an outlet for a circulating liquid.

In a preferred embodiment, a cryogenic milling is employed in order to prepare SE1-ML/SE2 where SE2 is PMMA and SE1-ML a single-walled carbon nanotube carrying a pyrene-based mechanical ligand. The cryogenic conditions avoid molecular weight reduction of the PMMA.

In another embodiment, room temperature is employed to perform a ring-closing metathesis of a precursor-ML around a SE1.

Reactive extrusion: The mechanical energy is provided in the form of high shear forces generated inside the extruder barrel. For this reason, an extruder may be used to perform multi-functions in a sequential manner, e.g., an extruder may first work as a reactor for a polymerization reaction, a devolatilizer to remove residual monomer(s), a compounder to incorporate additives (e.g., SE-MLs), and a shaping device to convert the product to a desired form.

The conditions for reactive extrusion can be varied in many different ways to obtain the desired results.

Size of extruder: The length/diameter ratio is an important fact to consider when choosing the extruder size. Typical ratios go from 20:1 to 30:1 or 36:1, the last two being considered as industrial standard. Some extruders even exceed 40:1 L/D for special purposes like double venting, compounding, or high-speed processing.

For some applications it may be an advantage to use extruders with higher L/D ratio such as 35:1, e.g., in order to extrude thermoplastics or in order to perform slow reactions. In other cases, it may be desired that a smaller L/D ratio such as 12:1 is employed, e.g., for economic reasons or for the extrusion of rubber.

The volume of the extruder is an important factor as well. For some cases, such as the preparation of master batches with high concentrations of SE-MLs (e.g., the preparation of a 5 wt % SE-ML-polypropylene composite), extruders with small base capacities may be preferred such as the Xplore MC 15 twin screw microcompounder having 15 mL base capacities. For other cases, such as the large-scale preparations of composites or SE1-ML-SE2 having lower SE1-ML content, continuous extrusion in larger extruders may be employed such as the Brabender KETSE 20/40 EC.

Ultimately, the size of an extruder is determined based on the diameter of the screw used in the system. Typical screws range from to 25 to 300 mm. In some cases, such as the large scale production of polystyrene grafted to lassoed single-walled carbon nanotubes (0.1% SWNT content) from a 5 wt % master batch, screws with larger diameters such as 200 mm are preferred.

Number of screws: Typical extruders comprise one or two screws, but extruders with more than two screws such as quad screw extruders and planetary roller extruders are also available. Twin screw extruders can be corotating intermeshing, counter rotating intermeshing, counter rotating non intermeshing and coaxial. In some cases, such as the profile extrusion of a PVC tube containing a 0.1% SE1-ML (PVC being the SE2), where the SE1-ML are mixed with the PVC (SE2) during the extrusion process, a counterrotating intermeshing extruder may be preferred. In other cases, such as the recycling of HDPE (SE2) reinforced with SE1-MLs, a single screw extruder may be preferred.

Compression ratio of the screw: The compression ratio is the ratio between two depths, the feed channel depth and the metering channel depth (compression ratio=feed channel depth/metering channel depth). This ratio is typically between 1.5:1 and 4.5:1. Some polymers run better on screws with a 2.5:1 compression ratio, while other materials process better on screws with a 4:1 compression ratio. Often so-called general purpose (GP) screws with a ratio of about 2.5-3:1 are employed which are suitable for a wider range of materials. Zero-compression screws and vented screws are also an option. In a preferred embodiment, a vented screw is employed to react a precursor-ML containing two double bonds around a SE1 (e.g., a single-walled carbon nanotube) to favour the release of ethylene molecules generated during the ring-closing metathesis reaction.

In another preferred embodiment, polystyrene is mixed with SE-MLs (e.g., lassoed single-walled carbon nanotubes) in an extruder with the compression ratio of the screw being 3.3:1.

In a different embodiment, low density polypropylene (SE2) containing terminal amines is reacted with a SE-ML (lassoed single-walled carbon nanotube containing a terminal acid chloride) in an extruder with compression ratio of the screw being 3.7:1.

RPM inside the extruder: Speeds from 1 rpm to 1500 rpm can be found. An increase of the rotation speed has both an influence on the residence time and on the viscous dissipation in an extruder. In a preferred embodiment, acrylonitrile is graft polymerized onto SE1-MLs (being SE a single-walled carbon nanotube and the MLs a mechanical ligand containing a terminal alkene) in a twin screw extruder operating at 400 rpm. In another embodiment, 500 rpm extrusion is employed to improve the dispersion of SE-MLs (e.g., lassoed multi-walled carbon nanotubes) in polylactic acid polymer. In another embodiment, a HDPE composite containing lassoed SWNTs is prepared by mixing the lassoed SWNTs and the HDPE in a microcompounder operating at 190° C., screw speed at 100 rpm.

Residence time: The residence time can be controlled in some systems due to the possibility of recirculating the material (e.g., in a compounder having a bypass valve) or is determined by the depending on the L/D, type of extruder, screw design, and the operation format. The extruder residence times usually range between 5 s and 10 min. In some cases, shorter residence times are preferred in order to avoid decomposition of a polymer. As an example, a PVC composite containing a 1% lassoed single-walled carbon nanotubes is prepared in a microcompounder using a residence time of 5 min.

Temperature at each part of the extruder: Key factor to consider is the temperature of operation. This temperature can be homogeneous or adjusted along the screw length. In a preferred embodiment, high-density polyethylene is extruded in a single-screw extruder operating at different temperatures along its length: zone 1, 170° C.: zone 2: 195° C. and zone 3: 220° C. In another embodiment, a mixture of polypropylene (SE2) and lassoed single-walled carbon nanotubes (1 wt %) is extruded through a twin-screw extruder at constant 180° C.

Sequential additions/number of feeders: Screw extruders are usually starve-fed with one or several accurate feeders. Major components are usually fed to the main hopper, and minor ones, if not preblended with the major ones, can be fed through a top or a side port. Non-reacting additives (stabilizers, colorants, etc.) may need to be incorporated downstream prior to discharge of the final product, because of incompatibility with the reaction or devolatilization step. In a preferred embodiment, a mixture of polyol+diisocyanate+an aromatic diamine is fed through a first feeder to a two screw extruder. This mixture is reacted to give polyurethane through a polyaddition reaction. Lassoed SWNTs are added through a secondary feeder and incorporated to the polyurethane matrix,

Feed rate: The feed rate play an important role in extrusion processes. To achieve the highest throughput rates, feeding equipment must deliver an accurate and consistent feed to the extruder. To do this, the feed system must be designed according to the materials and throughput rates being fed. If too much material falls into the extruder, it will cause a momentary increase in load on the motor, manifesting itself as an increase in torque on the extruder control screen. These torque spikes cannot exceed 100% of the extruder's available torque or else safety interlocks will shut down the extruder to avoid an overload condition. As a result, the normal operating torque of the process must be kept lower to create room for these potential spikes.

In a preferred embodiment, ABS (SE2), a precursor-ML and SWNTs (SE1) are fed to a SLA 3D printer operating at 180° C. and 8 rpm at a rate lower than 100 mm/s (e.g., 60 mm/s).

Sliding: The mechanical energy is provided by sliding a surface on top of another or by sliding two surfaces in between which the reaction mixture is located. This produces i.e., a chemical reaction that occurs at the sliding interface of two solid materials. A key factor to take into account is the external force or load applied perpendicularly to the sliding direction. Also, the velocity at which the surfaces move with respect to one another.

Turning/spinning: The mechanical energy is supplied as elastic deformation of the material and the chemical behaviour varies producing e.g., a chemical reaction.

Compression or extension: The mechanical energy is provided in the form of compression or extension, e.g., using a carver press.

Key variables to consider are the pressure at which the mixture is compressed or extended or the heat that is applied while compressing.

Temperature: In a certain embodiment, the temperature of the compression is maintained under 300° C. in order to avoid decomposition of the ML such as in the case of pyrene-based mechanical ligands formed by ring-closing metathesis. In other cases, higher temperature than 170° C. is preferred in order to favour higher fluidity of the SE2 and therefore improved mixing with the SE1-ML such as the case of the hot pressing of PMMA. Thus, depending on the context, the temperature at which the mixtures are compressed is preferentially higher than [**add**].

Thus, depending on the context, the temperature at which the mixtures are compressed is preferentially lower than [**add**].

Pressure: In some cases, high pressure such as 1000 MPa is preferred in order to produce a chemical reaction between the two precursor-ML ends (such as a Diels Alder) and form a mechanical ligand around a SE1. In other cases, low pressure such as 5 MPa is preferred in order to avoid undesired reactions in the final SE1-ML-SE2 composite while dog-bone preparation.

Shear mixing: The mechanical energy is provided in the form of shear.

Temperature: In a certain embodiment, high temperatures such as 210° C. are employed in order to mix SE1-ML with a polymer SE2 (e.g., polyvinyl fluoride) in a melt form. In another embodiment, the sample is cooled down (e.g., to −5° C.) in order to avoid reaggregation of the SE1 after mechanical ligand cleavage in the presence of a SE2.

Speed (RPM): In some cases, high shear mixing (e.g., 10000 rpm) enhances the dispersion of the SE1 or SE1-ML in the SE2, such as the dispersion of SWNT containing mechanical ligands in a polyurethane precursor. In other cases, low shear mixing such as 500 rpm is preferred in order to disperse a SE1-ML being a single-walled carbon nanotube in a polymer matrix (SE2) in order to avoid particle reduction in the final composite.

Time: In a preferred embodiment, shear mixing for larger times such as 12 h enhances the dispersion of the SE1-ML in the SE2, being the SE2 a polymeric material such as PMMA. In another preferred embodiment, a SE1-ML is shear mixed with a SE2 for shorter times such as 30 min in order to avoid degradation of the SE1-ML.

Solvent: In a preferred embodiment, toluene is employed to disperse SWNT-ML complexes and produce SWNT-ML/poly(methyl methacrylate) after addition of poly(methyl methacrylate) to the SWNT-ML dispersion and shear mixing. In another embodiment, acetone is employed to disperse SWNT-ML complexes and produce SWNT-ML/polystyrene after addition of polystyrene to the SWNT-ML dispersion and shear mixing.
Energy in the form of heat: The chemical reactions and processes are initiated by the absorption of heat.

In a certain embodiment, methyl methacrylate is polymerized at 100° C. in the presence of a SE1-ML in order to give a SE1-ML-SE2.
Energy in the form of light: The chemical reactions and processes are initiated by the absorption of energy in the form of light.

In a certain embodiment, light is employed to cleave the mechanical ligand from the SE1 in a SE1-ML/SE2 composite. The mechanical ligand contains a light-cleavable group comprising a o-nitrobenzyl group and a triglycine that is cleaved upon irradiation with 365 nm light.

In another embodiment, a precursor-ML is reacted with a SE1 to give a SE1-ML by cycloaddition of the two terminal double bonds contained in the precursor-ML initiated by 300 nm light.
Energy in the form of microwaves

In a preferred embodiment, a mixture of SWNTs and precursor-ML containing a
Energy in the form of electricity
Energy in the form of cavitation

Step A.3. Optionally, perform a purification process

For some cases, such as the use of Ushape-nanotube complexes in the reinforcement of polymers aimed for the medical industry (e.g., PMMA reinforced composites employed as prosthetic joints) or food industry, a complete removal of the byproducts and remaining catalysts is required. This might be done following several techniques, such as:

Purification processes able to remove all impurities:
Filtration
Precipitation
Dialysis
Centrifugation

Specific purification processes:
Metallic catalyst removal:
   Extraction: Addition of a coordinating ligand (i.e., imidazole, cysteine or 2-mercaptonicotinic acid) that acts as a metal scavenger and extraction into aqueous solution (used for e.g., the removal of Grubbs catalyst).
   Adsorption: Adsorption of the metallic by-product onto activated charcoal (used for e.g., the removal of palladium-based catalysts).
U-shape removal:
   Crystallization

Step B.1. Provide an SE-ML obtained following steps A.1.1 to A.2 or A.1.1 to A.3

Step B.2. Provide a monomer or a polymer; cement or other cementitious substance; or other type of molecule, supramolecular structure, or particle

### Products of the Processing:

Structural entity 1 (SE1): A structural entity SE is a chemical or physical entity. A structural entity is typically used to modify the characteristics of the composite material, e.g. by modifying the strength or flexibility of the composite material. A structural entity may also provide alternative characteristics such as conductivity, heat absorption, energy storage, etc.

Composite material: is used interchangeably with composite. A combination of two or more materials such as a polymer combined with an additive; a metal with an additive, or a ceramic with an additive. Typically, the material in excess is called the matrix, whereas the material present in small amount is called the additive or filler. Example composites are polystyrene combined with a small amount of carbon fibers, and metal combined with a small amount of carbon nanotube.

Mechanical ligand and ML is used interchangeably and shall mean a chemical entity that is capable of forming a mechanical bond with a structural entity, or is forming a mechanical bond with a structural entity. An example mechanical ligand is a closed ring of atoms wrapped around a structural entity.

Precursor mechanical ligand (precursor-ML) shall mean a chemical entity that can be turned into a mechanical ligand (ML) by formation of a covalent bond between two different parts of said precursor-ML.

Non precursor mechanical ligand shall mean a chemical entity that was once a precursor mechanical ligand. A precursor mechanical ligand is transformed into a non precursor mechanical ligand through processing.

Structural entity 1-precursor mechanical ligand (SE1-precursor ML): is used to refer a complex where a first structural entity—structural entity 1—is physically bound to a precursor mechanical ligand.

Structural entity 1-mechanical ligand (SE1-ML): is used to refer a complex where a first structural entity—structural entity 1—is mechanically bound to a mechanical ligand.

Structural entity 1-mechanical ligand/structural entity 2 (SE1-ML/SE2): is used to refer a composite material where a structural entity 1, mechanically bound to a mechanical ligand is physically bound to a second structural entity (structural entity 2). SE1 can be identical to SE2; SE1 can be of the same type as SE2, e.g. can both be nanotubes; SE1 can be of a different type than SE2, e.g. SE1 may be a nanotube and SE2 may be a plastic polymer.

Structural entity 1-mechanical ligand-structural entity 2 (SE1-ML-SE2): is used to refer a composite material where a structural entity 1, mechanically bound to a mechanical ligand is covalently or mechanically bound to a second structural entity (structural entity 2).

Structural entity 1+precursor mechanical ligand+structural entity 2 (SE1+precursor ML+SE2): is used to refer a composite material containing a structural entity 1, a precursor mechanical ligand and a second structural entity (structural entity 2) not forming chemical bonds with each other.

This type of composite material may be obtained from the cleavage of the mechanical bond between the structural entity 1 and a mechanical ligand that will therefore be transformed into a precursor mechanical ligand.

Structural entity 1+non precursor mechanical ligand+structural entity 2 (SE1+non precursor ML+SE2): is used to refer a composite material containing a structural entity 1, a non precursor mechanical ligand and a second structural entity (structural entity 2) not forming chemical bonds with each other.

Ball milling: A mechanical process that produces physical and chemical transformations in materials. Ball milling is performed by subjecting a mixture to high-energy collision of balls contained within a mill that is shaken, rotated, submitted to vibration or swung.

### Production of Composite Fibers.

In a preferred embodiment, a polymer composite fiber is made, consisting only of any polymer and a carbon nanotube, where the stiffness and strength may be varied depending on the amount of carbon nanotube and the orientation of the nanotubes within the polymer.

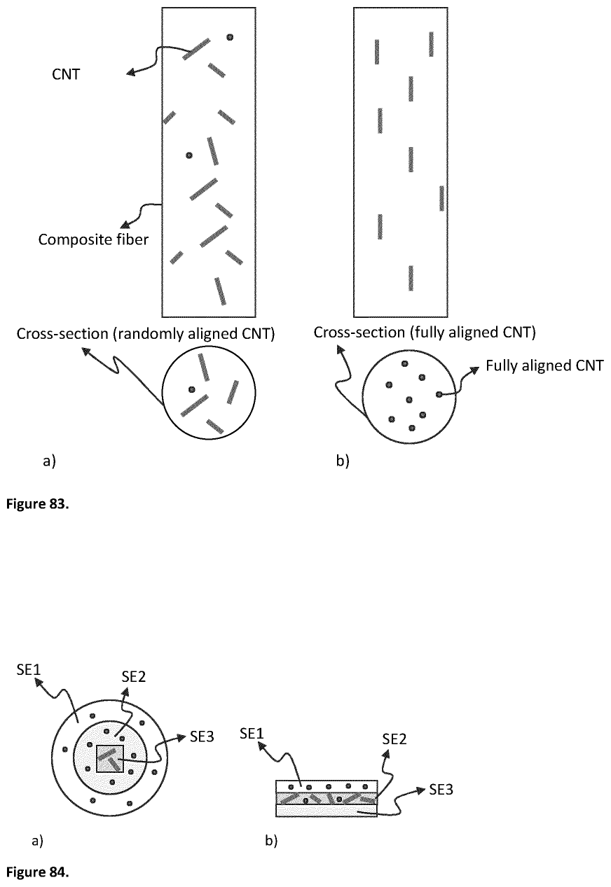

The orientation of the nanotubes may range from fully random to fully aligned in the longitudinal direction of the fiber, see FIG. 83.

The fiber may have any cross-sectional size and shape (round, rectangular, oval, triangular etc).

In a preferred way for aligning the nanotubes in the fiber, the shortest cross-sectional distance is lower than the length of the nanotube.

A fiber may consist of several layers of polymer nanotube material with different amounts, shapes, and orientation of nanotubes in each layer, see FIG. 84.

The fiber may be manufactured by fiber spinning, extrusion, pultrusion, or any other method that may produce continuous fibers of any length.

The fiber may be assembled with other fibers in yarns, bundles, weaves, fabrics, etc.

Composites may be made from consolidating the fiber assembly by heat and/or vacuum etc. The composite assembly may be made with a combination of nanotube fiber and polymer fiber. Fibers may be continuous, short, or granulated.

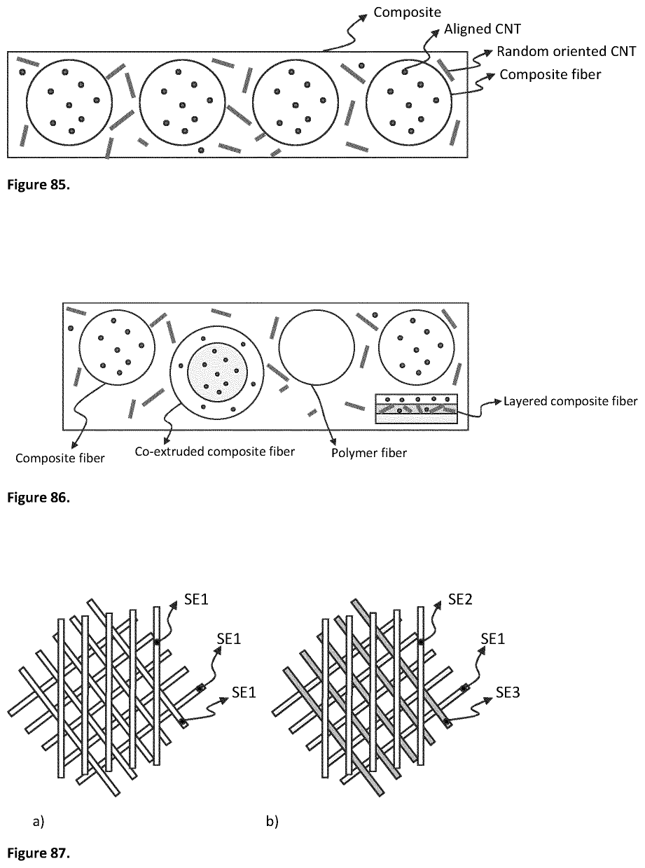

Composites may be made by impregnating the fiber assembly with a viscous resin of different or same polymer type as the polymer used for the fiber. The resin may also consist of nanotubes having a different orientation and concentration than the nanotube fiber, see FIG. 85.

In a preferred embodiment, both the resin and the fiber are made from the same polymer, which enables an easily recyclable composite, see FIG. 85. Furthermore, even more advanced composite and polymer fiber hybrid combinations can be made as shown in FIG. 86.

In a preferred embodiment, a component may be designed with the optimal stiffness and strength by using fibers of different nanotube concentration and orientation, see FIG. 87.

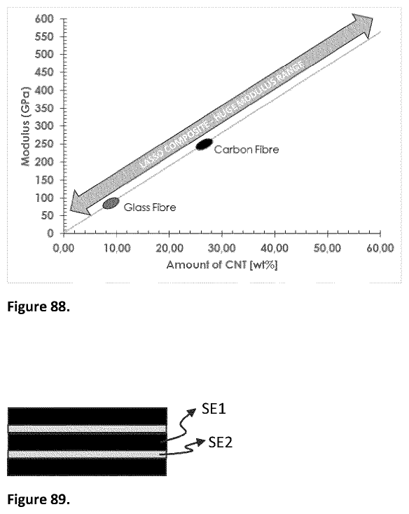

As an example, this enables the use of only one composite material and eliminates the need for using both glass and carbon composites in a rotor blade for wind turbines, FIG. 88.

In a preferred embodiment, the polymer fibers may be made larger than typical glass fiber (17-24 μm) and carbon fiber (5-8 μm), which speeds up the impregnation of a fiber assembly with resin due to a lower surface area that the resin must wet and pass through. Glass and carbon composites experience lower fatigue strength as the diameter of the fiber increases, which may not be the case for a nanotube polymer fiber.

### ITEMS

Item FF1. A composite comprising a nanotube and H2O.
Item FF2. A composite comprising a carbon nanotube and HCl.
Item FF3. A composite comprising a multi-wall nanotube and NaCl.
Item FF4. A composite comprising a multi-wall carbon nanotube and NC—C(CH3)2-C(CH3)2-CN.
Item FF5. A composite comprising a single-wall nanotube and biphenyl.
Item FF6. A composite comprising a single-wall carbon nanotube and N2.
Item FF7. A composite comprising graphene and CO2.
Item FF8. A composite comprising a carbon fibre and NC—C(CH3)(CH2-CH3)-C(CH3)(CH2-CH3)-CN.
Item FF9. A composite comprising a carbon nanofibre and NC—C(CH3)(CH2-C(CH3)2-O—CH3)-C(CH3)(CH2-C(CH3)2-O—CH3)-CN.
Item FF10. A composite comprising a carbon nanothread and NC—C(CH3)(CH2-C(CH3)2-O—CH3)-C(CH3)(CH2-C(CH3)2-O—CH3)-CN.
Item FF11. A composite comprising a ceramic material and H2O.
Item FF12. A composite comprising a fullerene and H2O.
Item FF13. A composite comprising graphane and H2O.
Item FF14. A composite comprising graphene oxide and H2O.
Item FF15. A composite comprising graphite and H2O.
Item FF16. A composite comprising graphyne and H2O.
Item FF17. A composite comprising a COOH-functionalized carbon nanotube and H2O.
Item FF18. A composite comprising a OH-functionalized carbon nanotube and H2O.
Item FF19. A composite comprising an NH2-functionalized carbon nanotube and H2O.
Item FF20. A composite comprising an SH-functionalized carbon nanotube and H2O.
Item FF21. A composite comprising COOH-functionalized graphene and H2O.
Item FF22. A composite comprising NH2-functionalized graphene and H2O.
Item FF23. A composite comprising OH-functionalized graphene and H2O.
Item FF24. A composite comprising thiol-functionalized graphene and H2O.
Item FF25. A composite comprising a glass fibre and H2O.
Item FF26. A composite comprising a nanotube and HCl.
Item FF27. A composite comprising a carbon nanotube and HCl.
Item FF28. A composite comprising a multi-wall nanotube and HCl.
Item FF29. A composite comprising a multi-wall carbon nanotube and HCl.
Item FF30. A composite comprising a single-wall nanotube and HCl.
Item FF31. A composite comprising a single-wall carbon nanotube and HCl.
Item FF32. A composite comprising graphene and HCl.
Item FF33. A composite comprising a carbon fibre and HCl.
Item FF34. A composite comprising a carbon nanofibre and HCl.
Item FF35. A composite comprising a carbon nanothread and HCl.
Item FF36. A composite comprising a ceramic material and HCl.
Item FF37. A composite comprising a fullerene and HCl.
Item FF38. A composite comprising graphane and HCl.
Item FF39. A composite comprising graphene oxide and HCl.
Item FF40. A composite comprising graphite and HCl.
Item FF41. A composite comprising graphyne and HCl.
Item FF42. A composite comprising a COOH-functionalized carbon nanotube and HCl.
Item FF43. A composite comprising a OH-functionalized carbon nanotube and HCl.
Item FF44. A composite comprising an NH2-functionalized carbon nanotube and HCl.
Item FF45. A composite comprising an SH-functionalized carbon nanotube and HCl.
Item FF46. A composite comprising COOH-functionalized graphene and HCl.
Item FF47. A composite comprising NH2-functionalized graphene and HCl.
Item FF48. A composite comprising OH-functionalized graphene and HCl.
Item FF49. A composite comprising thiol-functionalized graphene and HCl.
Item FF50. A composite comprising a glass fibre and HCl.
Item FF51. A composite comprising a nanotube and NaCl.
Item FF52. A composite comprising a carbon nanotube and NaCl.
Item FF53. A composite comprising a multi-wall nanotube and NaCl.
Item FF54. A composite comprising a multi-wall carbon nanotube and NaCl.
Item FF55. A composite comprising a single-wall nanotube and NaCl.
Item FF56. A composite comprising a single-wall carbon nanotube and NaCl.
Item FF57. A composite comprising graphene and NaCl.
Item FF58. A composite comprising a carbon fibre and NaCl.
Item FF59. A composite comprising a carbon nanofibre and NaCl.
Item FF60. A composite comprising a carbon nanothread and NaCl.
Item FF61. A composite comprising a ceramic material and NaCl.
Item FF62. A composite comprising a fullerene and NaCl.
Item FF63. A composite comprising graphane and NaCl.
Item FF64. A composite comprising graphene oxide and NaCl.
Item FF65. A composite comprising graphite and NaCl.
Item FF66. A composite comprising graphyne and NaCl.
Item FF67. A composite comprising a COOH-functionalized carbon nanotube and NaCl.
Item FF68. A composite comprising a OH-functionalized carbon nanotube and NaCl.
Item FF69. A composite comprising an NH2-functionalized carbon nanotube and NaCl.
Item FF70. A composite comprising an SH-functionalized carbon nanotube and NaCl.
Item FF71. A composite comprising COOH-functionalized graphene and NaCl.
Item FF72. A composite comprising NH2-functionalized graphene and NaCl.
Item FF73. A composite comprising OH-functionalized graphene and NaCl.
Item FF74. A composite comprising thiol-functionalized graphene and NaCl.
Item FF75. A composite comprising a glass fibre and NaCl.
Item FF76. A composite comprising a nanotube and N2.
Item FF77. A composite comprising a carbon nanotube and N2.
Item FF78. A composite comprising a multi-wall nanotube and N2.
Item FF79. A composite comprising a multi-wall carbon nanotube and N2.
Item FF80. A composite comprising a single-wall nanotube and N2.
Item FF81. A composite comprising a single-wall carbon nanotube and N2.
Item FF82. A composite comprising graphene and N2.
Item FF83. A composite comprising a carbon fibre and N2.
Item FF84. A composite comprising a carbon nanofibre and N2.
Item FF85. A composite comprising a carbon nanothread and N2.
Item FF86. A composite comprising a ceramic material and N2.
Item FF87. A composite comprising a fullerene and N2.
Item FF88. A composite comprising graphane and N2.
Item FF89. A composite comprising graphene oxide and N2.
Item FF90. A composite comprising graphite and N2.
Item FF91. A composite comprising graphyne and N2.
Item FF92. A composite comprising a COOH-functionalized carbon nanotube and N2.
Item FF93. A composite comprising a OH-functionalized carbon nanotube and N2.
Item FF94. A composite comprising an NH2-functionalized carbon nanotube and N2.
Item FF95. A composite comprising an SH-functionalized carbon nanotube and N2.
Item FF96. A composite comprising COOH-functionalized graphene and N2.
Item FF97. A composite comprising NH2-functionalized graphene and N2.
Item FF98. A composite comprising OH-functionalized graphene and N2.
Item FF99. A composite comprising thiol-functionalized graphene and N2.
Item FF100. A composite comprising a glass fibre and N2.
Item FF101. A composite comprising a nanotube and CO2.
Item FF102. A composite comprising a carbon nanotube and CO2.
Item FF103. A composite comprising a multi-wall nanotube and CO2.
Item FF104. A composite comprising a multi-wall carbon nanotube and CO2.
Item FF105. A composite comprising a single-wall nanotube and CO2.
Item FF106. A composite comprising a single-wall carbon nanotube and CO2.
Item FF107. A composite comprising graphene and CO2.
Item FF108. A composite comprising a carbon fibre and CO2.
Item FF109. A composite comprising a carbon nanofibre and CO2.
Item FF110. A composite comprising a carbon nanothread and CO2.
Item FF111. A composite comprising a ceramic material and CO2.
Item FF112. A composite comprising a fullerene and CO2.
Item FF113. A composite comprising graphane and CO2.
Item FF114. A composite comprising graphene oxide and CO2.
Item FF115. A composite comprising graphite and CO2.
Item FF116. A composite comprising graphyne and CO2.
Item FF117. A composite comprising a COOH-functionalized carbon nanotube and CO2.
Item FF118. A composite comprising a OH-functionalized carbon nanotube and CO2.
Item FF119. A composite comprising an NH2-functionalized carbon nanotube and CO2.
Item FF120. A composite comprising an SH-functionalized carbon nanotube and CO2.
Item FF121. A composite comprising COOH-functionalized graphene and CO2.
Item FF122. A composite comprising NH2-functionalized graphene and CO2.
Item FF123. A composite comprising OH-functionalized graphene and CO2.
Item FF124. A composite comprising thiol-functionalized graphene and CO2.
Item FF125. A composite comprising a glass fibre and CO2.
Item FF126. A composite comprising a nanotube and biphenyl.
Item FF127. A composite comprising a carbon nanotube and biphenyl.
Item FF128. A composite comprising a multi-wall nanotube and biphenyl.
Item FF129. A composite comprising a multi-wall carbon nanotube and biphenyl.
Item FF130. A composite comprising a single-wall nanotube and biphenyl.
Item FF131. A composite comprising a single-wall carbon nanotube and biphenyl.
Item FF132. A composite comprising graphene and biphenyl.
Item FF133. A composite comprising a carbon fibre and biphenyl.
Item FF134. A composite comprising a carbon nanofibre and biphenyl.
Item FF135. A composite comprising a carbon nanothread and biphenyl.
Item FF136. A composite comprising a ceramic material and biphenyl.
Item FF137. A composite comprising a fullerene and biphenyl.
Item FF138. A composite comprising graphane and biphenyl.
Item FF139. A composite comprising graphene oxide and biphenyl.
Item FF140. A composite comprising graphite and biphenyl.
Item FF141. A composite comprising graphyne and biphenyl.
Item FF142. A composite comprising a COOH-functionalized carbon nanotube and biphenyl.
Item FF143. A composite comprising a OH-functionalized carbon nanotube and biphenyl.
Item FF144. A composite comprising an NH2-functionalized carbon nanotube and biphenyl.
Item FF145. A composite comprising an SH-functionalized carbon nanotube and biphenyl.
Item FF146. A composite comprising COOH-functionalized graphene and biphenyl.
Item FF147. A composite comprising NH2-functionalized graphene and biphenyl.
Item FF148. A composite comprising OH-functionalized graphene and biphenyl.
Item FF149. A composite comprising thiol-functionalized graphene and biphenyl.
Item FF150. A composite comprising a glass fibre and biphenyl.
Item FF151. A composite comprising a nanotube and NC—C(CH3)2-C(CH3)2-CN.
Item FF152. A composite comprising a carbon nanotube and NC—C(CH3)2-C(CH3)2-CN.
Item FF153. A composite comprising a multi-wall nanotube and NC—C(CH3)2-C(CH3)2-CN.
Item FF154. A composite comprising a multi-wall carbon nanotube and NC—C(CH3)2-C(CH3)2-CN.
Item FF155. A composite comprising a single-wall nanotube and NC—C(CH3)2-C(CH3)2-CN Item FF156. A composite comprising a single-wall carbon nanotube and NC—C(CH3)2-C(CH3)2-CN.
Item FF157. A composite comprising graphene and NC—C(CH3)2-C(CH3)2-CN.
Item FF158. A composite comprising a carbon fibre and NC—C(CH3)2-C(CH3)2-CN.
Item FF159. A composite comprising a carbon nanofibre and NC—C(CH3)2-C(CH3)2-CN.
Item FF160. A composite comprising a carbon nanothread and NC—C(CH3)2-C(CH3)2-CN.
Item FF161. A composite comprising a ceramic material and NC—C(CH3)2-C(CH3)2-CN.
Item FF162. A composite comprising a fullerene and NC—C(CH3)2-C(CH3)2-CN.
Item FF163. A composite comprising graphane and NC—C(CH3)2-C(CH3)2-CN.
Item FF164. A composite comprising graphene oxide and NC—C(CH3)2-C(CH3)2-CN.
Item FF165. A composite comprising graphite and NC—C(CH3)2-C(CH3)2-CN.
Item FF166. A composite comprising graphyne and NC—C(CH3)2-C(CH3)2-CN.
Item FF167. A composite comprising a COOH-functionalized carbon nanotube and NC—C(CH3)2-C(CH3)2-CN.
Item FF168. A composite comprising a OH-functionalized carbon nanotube and NC—C(CH3)2-C(CH3)2-CN.
Item FF169. A composite comprising an NH2-functionalized carbon nanotube and NC—C(CH3)2-C(CH3)2-CN.
Item FF170. A composite comprising an SH-functionalized carbon nanotube and NC—C(CH3)2-C(CH3)2-CN.
Item FF171. A composite comprising COOH-functionalized graphene and NC—C(CH3)2-C(CH3)2-CN.
Item FF172. A composite comprising NH2-functionalized graphene and NC—C(CH3)2-C(CH3)2-CN.
Item FF173. A composite comprising OH-functionalized graphene and NC—C(CH3)2-C(CH3)2-CN.
Item FF174. A composite comprising thiol-functionalized graphene and NC—C(CH3)2-C(CH3)2-CN.
Item FF175. A composite comprising a glass fibre and NC—C(CH3)2-C(CH3)2-CN.
Item FF176. A composite comprising a nanotube and NC—C(CH3)(CH2-CH3)-C(CH3)(CH2-CH3)-CN.
Item FF177. A composite comprising a carbon nanotube and NC—C(CH3)(CH2-CH3)-C(CH3)(CH2-CH3)-CN.
Item FF178. A composite comprising a multi-wall nanotube and NC—C(CH3)(CH2-CH3)-C(CH3)(CH2-CH3)-CN.
Item FF179. A composite comprising a multi-wall carbon nanotube and NC—C(CH3)(CH2-CH3)-C(CH3)(CH2-CH3)-CN.
Item FF180. A composite comprising a single-wall nanotube and NC—C(CH3)(CH2-CH3)-C(CH3)(CH2-CH3)-CN.
Item FF181. A composite comprising a single-wall carbon nanotube and NC—C(CH3)(CH2-CH3)-C(CH3)(CH2-CH3)-CN.
Item FF182. A composite comprising graphene and NC—C(CH3)(CH2-CH3)-C(CH3)(CH2-CH3)-CN.
Item FF183. A composite comprising a carbon fibre and NC—C(CH3)(CH2-CH3)-C(CH3)(CH2-CH3)-CN.
Item FF184. A composite comprising a carbon nanofibre and NC—C(CH3)(CH2-CH3)-C(CH3)(CH2-CH3)-CN.
Item FF185. A composite comprising a carbon nanothread and NC—C(CH3)(CH2-CH3)-C(CH3)(CH2-CH3)-CN.
Item FF186. A composite comprising a ceramic material and NC—C(CH3)(CH2-CH3)-C(CH3)(CH2-CH3)-CN.
Item FF187. A composite comprising a fullerene and NC—C(CH3)(CH2-CH3)-C(CH3)(CH2-CH3)-CN.
Item FF188. A composite comprising graphane and NC—C(CH3)(CH2-CH3)-C(CH3)(CH2-CH3)-CN.
Item FF189. A composite comprising graphene oxide and NC—C(CH3)(CH2-CH3)-C(CH3)(CH2-CH3)-CN.
Item FF190. A composite comprising graphite and NC—C(CH3)(CH2-CH3)-C(CH3)(CH2-CH3)-CN.
Item FF191. A composite comprising graphyne and NC—C(CH3)(CH2-CH3)-C(CH3)(CH2-CH3)-CN.
Item FF192. A composite comprising a COOH-functionalized carbon nanotube and NC—C(CH3)(CH2-CH3)-C(CH3)(CH2-CH3)-CN.
Item FF193. A composite comprising a OH-functionalized carbon nanotube and NC—C(CH3)(CH2-CH3)-C(CH3)(CH2-CH3)-CN.
Item FF194. A composite comprising an NH2-functionalized carbon nanotube and NC—C(CH3)(CH2-CH3)-C(CH3)(CH2-CH3)-CN.
Item FF195. A composite comprising an SH-functionalized carbon nanotube and NC—C(CH3)(CH2-CH3)-C(CH3)(CH2-CH3)-CN.
Item FF196. A composite comprising COOH-functionalized graphene and NC—C(CH3)(CH2-CH3)-C(CH3)(CH2-CH3)-CN.
Item FF197. A composite comprising NH2-functionalized graphene and NC—C(CH3)(CH2-CH3)-C(CH3)(CH2-CH3)-CN.
Item FF198. A composite comprising OH-functionalized graphene and NC—C(CH3)(CH2-CH3)-C(CH3)(CH2-CH3)-CN.
Item FF199. A composite comprising thiol-functionalized graphene and NC—C(CH3)(CH2-CH3)-C(CH3)(CH2-CH3)-CN.
Item FF200. A composite comprising a glass fibre and NC—C(CH3)(CH2-CH3)-C(CH3)(CH2-CH3)-CN.
Item FF201. A composite comprising a nanotube and NC—C(CH3)(CH2-C(CH3)2-O—CH3)-C(CH3)(CH2-C(CH3)2-O—CH3)-CN.
Item FF202. A composite comprising a carbon nanotube and NC—C(CH3)(CH2-C(CH3)2-O—CH3)-C(CH3)(CH2-C(CH3)2-O—CH3)-CN.
Item FF203. A composite comprising a multi-wall nanotube and NC—C(CH3)(CH2-C(CH3)2-O—CH3)-C(CH3)(CH2-C(CH3)2-O—CH3)-CN.
Item FF204. A composite comprising a multi-wall carbon nanotube and NC—C(CH3)(CH2-C(CH3)2-O—CH3)-C(CH3)(CH2-C(CH3)2-O—CH3)-CN.
Item FF205. A composite comprising a single-wall nanotube and NC—C(CH3)(CH2-C(CH3)2-O—CH3)-C(CH3)(CH2-C(CH3)2-O—CH3)-CN.
Item FF206. A composite comprising a single-wall carbon nanotube and NC—C(CH3)(CH2-C(CH3)2-O—CH3)-C(CH3)(CH2-C(CH3)2-O—CH3)-CN.
Item FF207. A composite comprising graphene and NC—C(CH3)(CH2-C(CH3)2-O—CH3)-C(CH3)(CH2-C(CH3)2-O—CH3)-CN.
Item FF208. A composite comprising a carbon fibre and NC—C(CH3)(CH2-C(CH3)2-O—CH3)-C(CH3)(CH2-C(CH3)2-O—CH3)-CN.
Item FF209. A composite comprising a carbon nanofibre and NC—C(CH3)(CH2-C(CH3)2-O—CH3)-C(CH3)(CH2-C(CH3)2-O—CH3)-CN.
Item FF210. A composite comprising a carbon nanothread and NC—C(CH3)(CH2-C(CH3)2-O—CH3)-C(CH3)(CH2-C(CH3)2-O—CH3)-CN.
Item FF211. A composite comprising a ceramic material and NC—C(CH3)(CH2-C(CH3)2-O—CH3)-C(CH3)(CH2-C(CH3)2-O—CH3)-CN.
Item FF212. A composite comprising a fullerene and NC—C(CH3)(CH2-C(CH3)2-O—CH3)-C(CH3)(CH2-C(CH3)2-O—CH3)-CN.
Item FF213. A composite comprising graphane and NC—C(CH3)(CH2-C(CH3)2-O—CH3)-C(CH3)(CH2-C(CH3)2-O—CH3)-CN.
Item FF214. A composite comprising graphene oxide and NC—C(CH3)(CH2-C(CH3)2-O—CH3)-C(CH3)(CH2-C(CH3)2-O—CH3)-CN.
Item FF215. A composite comprising graphite and NC—C(CH3)(CH2-C(CH3)2-O—CH3)-C(CH3)(CH2-C(CH3)2-O—CH3)-CN.
Item FF216. A composite comprising graphyne and NC—C(CH3)(CH2-C(CH3)2-O—CH3)-C(CH3)(CH2-C(CH3)2-O—CH3)-CN.
Item FF217. A composite comprising a COOH-functionalized carbon nanotube and NC—C(CH3)(CH2-C(CH3)2-O—CH3)-C(CH3)(CH2-C(CH3)2-O—CH3)-CN.
Item FF218. A composite comprising a OH-functionalized carbon nanotube and NC—C(CH3)(CH2-C(CH3)2-O—CH3)-C(CH3)(CH2-C(CH3)2-O—CH3)-CN.
Item FF219. A composite comprising an NH2-functionalized carbon nanotube and NC—C(CH3)(CH2-C(CH3)2-O—CH3)-C(CH3)(CH2-C(CH3)2-O—CH3)-CN.
Item FF220. A composite comprising an SH-functionalized carbon nanotube and NC—C(CH3)(CH2-C(CH3)2-O—CH3)-C(CH3)(CH2-C(CH3)2-O—CH3)-CN.
Item FF221. A composite comprising COOH-functionalized graphene and NC—C(CH3)(CH2-C(CH3)2-O—CH3)-C(CH3)(CH2-C(CH3)2-O—CH3)-CN.
Item FF222. A composite comprising NH2-functionalized graphene and NC—C(CH3)(CH2-C(CH3)2-O—CH3)-C(CH3)(CH2-C(CH3)2-O—CH3)-CN.
Item FF223. A composite comprising OH-functionalized graphene and NC—C(CH3)(CH2-C(CH3)2-O—CH3)-C(CH3)(CH2-C(CH3)2-O—CH3)-CN.
Item FF224. A composite comprising thiol-functionalized graphene and NC—C(CH3)(CH2-C(CH3)2-O—CH3)-C(CH3)(CH2-C(CH3)2-O—CH3)-CN.
Item FF225. A composite comprising a glass fibre and NC—C(CH3)(CH2-C(CH3)2-O—CH3)-C(CH3)(CH2-C(CH3)2-O—CH3)-CN.
Item FFF1. A composite comprising a nanotube and polyester and H2O.
Item FFF2. A composite comprising a carbon nanotube and polyester and H2O.
Item FFF3. A composite comprising a multi-wall nanotube and polyester and H2O.
Item FFF4. A composite comprising a multi-wall carbon nanotube and polyester and H2O.
Item FFF5. A composite comprising a single-wall nanotube and polyester and H2O.
Item FFF6. A composite comprising a single-wall carbon nanotube and polyester and H2O.
Item FFF7. A composite comprising graphene and polyester and H2O.
Item FFF8. A composite comprising a carbon fibre and polyester and H2O.
Item FFF9. A composite comprising a carbon nanofibre and polyester and H2O.
Item FFF10. A composite comprising a carbon nanothread and polyester and H2O.
Item FFF11. A composite comprising a ceramic material and polyester and H2O.
Item FFF12. A composite comprising a fullerene and polyester and H2O.
Item FFF13. A composite comprising graphane and polyester and H2O.
Item FFF14. A composite comprising graphene oxide and polyester and H2O.
Item FFF15. A composite comprising graphite and polyester and H2O.
Item FFF16. A composite comprising graphyne and polyester and H2O.
Item FFF17. A composite comprising a COOH-functionalized carbon nanotube and polyester and H2O.
Item FFF18. A composite comprising a OH-functionalized carbon nanotube and polyester and H2O.
Item FFF19. A composite comprising an NH2-functionalized carbon nanotube and polyester and H2O.
Item FFF20. A composite comprising an SH-functionalized carbon nanotube and polyester and H2O.
Item FFF21. A composite comprising COOH-functionalized graphene and polyester and H2O.
Item FFF22. A composite comprising NH2-functionalized graphene and polyester and H2O.
Item FFF23. A composite comprising OH-functionalized graphene and polyester and H2O.
Item FFF24. A composite comprising thiol-functionalized graphene and polyester and H2O.
Item FFF25. A composite comprising a glass fibre and polyester and H2O.
Item FFF26. A composite comprising a nanotube and polyamide and H2O.
Item FFF27. A composite comprising a carbon nanotube and polyamide and H2O.
Item FFF28. A composite comprising a multi-wall nanotube and polyamide and H2O.
Item FFF29. A composite comprising a multi-wall carbon nanotube and polyamide and H2O.
Item FFF30. A composite comprising a single-wall nanotube and polyamide and H2O.
Item FFF31. A composite comprising a single-wall carbon nanotube and polyamide and H2O.
Item FFF32. A composite comprising graphene and polyamide and H2O.
Item FFF33. A composite comprising a carbon fibre and polyamide and H2O.
Item FFF34. A composite comprising a carbon nanofibre and polyamide and H2O.
Item FFF35. A composite comprising a carbon nanothread and polyamide and H2O.
Item FFF36. A composite comprising a ceramic material and polyamide and H2O.
Item FFF37. A composite comprising a fullerene and polyamide and H2O.
Item FFF38. A composite comprising graphane and polyamide and H2O.
Item FFF39. A composite comprising graphene oxide and polyamide and H2O.
Item FFF40. A composite comprising graphite and polyamide and H2O.
Item FFF41. A composite comprising graphyne and polyamide and H2O.
Item FFF42. A composite comprising a COOH-functionalized carbon nanotube and polyamide and H2O.
Item FFF43. A composite comprising a OH-functionalized carbon nanotube and polyamide and H2O.
Item FFF44. A composite comprising an NH2-functionalized carbon nanotube and polyamide and H2O.
Item FFF45. A composite comprising an SH-functionalized carbon nanotube and polyamide and H2O.
Item FFF46. A composite comprising COOH-functionalized graphene and polyamide and H2O.
Item FFF47. A composite comprising NH2-functionalized graphene and polyamide and H2O.
Item FFF48. A composite comprising OH-functionalized graphene and polyamide and H2O.
Item FFF49. A composite comprising thiol-functionalized graphene and polyamide and H2O.
Item FFF50. A composite comprising a glass fibre and polyamide and H2O.
Item FFF51. A composite comprising a nanotube and polyamide and HCl.
Item FFF52. A composite comprising a carbon nanotube and polyamide and HCl.
Item FFF53. A composite comprising a multi-wall nanotube and polyamide and HCl.
Item FFF54. A composite comprising a multi-wall carbon nanotube and polyamide and HCl.
Item FFF55. A composite comprising a single-wall nanotube and polyamide and HCl.
Item FFF56. A composite comprising a single-wall carbon nanotube and polyamide and HCl.
Item FFF57. A composite comprising graphene and polyamide and HCl.
Item FFF58. A composite comprising a carbon fibre and polyamide and HCl.
Item FFF59. A composite comprising a carbon nanofibre and polyamide and HCl.
Item FFF60. A composite comprising a carbon nanothread and polyamide and HCl.
Item FFF61. A composite comprising a ceramic material and polyamide and HCl.
Item FFF62. A composite comprising a fullerene and polyamide and HCl.
Item FFF63. A composite comprising graphane and polyamide and HCl.
Item FFF64. A composite comprising graphene oxide and polyamide and HCl.
Item FFF65. A composite comprising graphite and polyamide and HCl.
Item FFF66. A composite comprising graphyne and polyamide and HCl.
Item FFF67. A composite comprising a COOH-functionalized carbon nanotube and polyamide and HCl.
Item FFF68. A composite comprising a OH-functionalized carbon nanotube and polyamide and HCl.
Item FFF69. A composite comprising an NH2-functionalized carbon nanotube and polyamide and HCl.
Item FFF70. A composite comprising an SH-functionalized carbon nanotube and polyamide and HCl.
Item FFF71. A composite comprising COOH-functionalized graphene and polyamide and HCl.
Item FFF72. A composite comprising NH2-functionalized graphene and polyamide and HCl.
Item FFF73. A composite comprising OH-functionalized graphene and polyamide and HCl.
Item FFF74. A composite comprising thiol-functionalized graphene and polyamide and HCl.
Item FFF75. A composite comprising a glass fibre and polyamide and HCl.
Item FFF76. A composite comprising a nanotube and polyurethane and CO2.
Item FFF77. A composite comprising a carbon nanotube and polyurethane and CO2.
Item FFF78. A composite comprising a multi-wall nanotube and polyurethane and CO2.
Item FFF79. A composite comprising a multi-wall carbon nanotube and polyurethane and CO2.
Item FFF80. A composite comprising a single-wall nanotube and polyurethane and CO2.
Item FFF81. A composite comprising a single-wall carbon nanotube and polyurethane and CO2.
Item FFF82. A composite comprising graphene and polyurethane and CO2.
Item FFF83. A composite comprising a carbon fibre and polyurethane and CO2.
Item FFF84. A composite comprising a carbon nanofibre and polyurethane and CO2.
Item FFF85. A composite comprising a carbon nanothread and polyurethane and CO2.
Item FFF86. A composite comprising a ceramic material and polyurethane and CO2.
Item FFF87. A composite comprising a fullerene and polyurethane and CO2.
Item FFF88. A composite comprising graphane and polyurethane and CO2.
Item FFF89. A composite comprising graphene oxide and polyurethane and CO2.
Item FFF90. A composite comprising graphite and polyurethane and CO2.
Item FFF91. A composite comprising graphyne and polyurethane and CO2.
Item FFF92. A composite comprising a COOH-functionalized carbon nanotube and polyurethane and CO2.
Item FFF93. A composite comprising a OH-functionalized carbon nanotube and polyurethane and CO2.
Item FFF94. A composite comprising an NH2-functionalized carbon nanotube and polyurethane and CO2.
Item FFF95. A composite comprising an SH-functionalized carbon nanotube and polyurethane and CO2.
Item FFF96. A composite comprising COOH-functionalized graphene and polyurethane and CO2.
Item FFF97. A composite comprising NH2-functionalized graphene and polyurethane and CO2.
Item FFF98. A composite comprising OH-functionalized graphene and polyurethane and CO2.
Item FFF99. A composite comprising thiol-functionalized graphene and polyurethane and CO2.
Item FFF100. A composite comprising a glass fibre and polyurethane and CO2.
Item FFF101. A composite comprising a nanotube and polystyrene and CO2.
Item FFF102. A composite comprising a carbon nanotube and polystyrene and CO2.
Item FFF103. A composite comprising a multi-wall nanotube and polystyrene and CO2.
Item FFF104. A composite comprising a multi-wall carbon nanotube and polystyrene and CO2.
Item FFF105. A composite comprising a single-wall nanotube and polystyrene and CO2.
Item FFF106. A composite comprising a single-wall carbon nanotube and polystyrene and CO2.
Item FFF107. A composite comprising graphene and polystyrene and CO2.
Item FFF108. A composite comprising a carbon fibre and polystyrene and CO2.
Item FFF109. A composite comprising a carbon nanofibre and polystyrene and CO2.
Item FFF110. A composite comprising a carbon nanothread and polystyrene and CO2.
Item FFF111. A composite comprising a ceramic material and polystyrene and CO2.
Item FFF112. A composite comprising a fullerene and polystyrene and CO2.
Item FFF113. A composite comprising graphane and polystyrene and CO2.
Item FFF114. A composite comprising graphene oxide and polystyrene and CO2.
Item FFF115. A composite comprising graphite and polystyrene and CO2.
Item FFF116. A composite comprising graphyne and polystyrene and CO2.
Item FFF117. A composite comprising a COOH-functionalized carbon nanotube and polystyrene and CO2.
Item FFF118. A composite comprising a OH-functionalized carbon nanotube and polystyrene and CO2.
Item FFF119. A composite comprising an NH2-functionalized carbon nanotube and polystyrene and CO2.
Item FFF120. A composite comprising an SH-functionalized carbon nanotube and polystyrene and CO2.
Item FFF121. A composite comprising COOH-functionalized graphene and polystyrene and CO2.
Item FFF122. A composite comprising NH2-functionalized graphene and polystyrene and CO2.
Item FFF123. A composite comprising OH-functionalized graphene and polystyrene and CO2.
Item FFF124. A composite comprising thiol-functionalized graphene and polystyrene and CO2.
Item FFF125. A composite comprising a glass fibre and polystyrene and CO2.
Item FFF126. A composite comprising a nanotube and polystyrene linked to —C(CH3)2-CN.
Item FFF127. A composite comprising a carbon nanotube and polystyrene linked to —C(CH3)2-CN.
Item FFF128. A composite comprising a multi-wall nanotube and polystyrene linked to —C(CH3)2-CN.
Item FFF129. A composite comprising a multi-wall carbon nanotube and polystyrene linked to —C(CH3)2-CN.
Item FFF130. A composite comprising a single-wall nanotube and polystyrene linked to —C(CH3)2-CN.
Item FFF131. A composite comprising a single-wall carbon nanotube and polystyrene linked to —C(CH3)2-CN.
Item FFF132. A composite comprising graphene and polystyrene linked to —C(CH3)2-CN.
Item FFF133. A composite comprising a carbon fibre and polystyrene linked to —C(CH3)2-CN.
Item FFF134. A composite comprising a carbon nanofibre and polystyrene linked to —C(CH3)2-CN.
Item FFF135. A composite comprising a carbon nanothread and polystyrene linked to —C(CH3)2-CN.
Item FFF136. A composite comprising a ceramic material and polystyrene linked to —C(CH3)2-CN.
Item FFF137. A composite comprising a fullerene and polystyrene linked to —C(CH3)2-CN.
Item FFF138. A composite comprising graphane and polystyrene linked to —C(CH3)2-CN.
Item FFF139. A composite comprising graphene oxide and polystyrene linked to —C(CH3)2-CN.
Item FFF140. A composite comprising graphite and polystyrene linked to —C(CH3)2-CN.
Item FFF141. A composite comprising graphyne and polystyrene linked to —C(CH3)2-CN.
Item FFF142. A composite comprising a COOH-functionalized carbon nanotube and polystyrene linked to —C(CH3)2-CN.
Item FFF143. A composite comprising a OH-functionalized carbon nanotube and polystyrene linked to —C(CH3)2-CN.
Item FFF144. A composite comprising an NH2-functionalized carbon nanotube and polystyrene linked to —C(CH3)2-CN.
Item FFF145. A composite comprising an SH-functionalized carbon nanotube and polystyrene linked to —C(CH3)2-CN.
Item FFF146. A composite comprising COOH-functionalized graphene and polystyrene linked to —C(CH3)2-CN.
Item FFF147. A composite comprising NH2-functionalized graphene and polystyrene linked to —C(CH3)2-CN.
Item FFF148. A composite comprising OH-functionalized graphene and polystyrene linked to —C(CH3)2-CN.
Item FFF149. A composite comprising thiol-functionalized graphene and polystyrene linked to —C(CH3)2-CN.
Item FFF150. A composite comprising a glass fibre and polystyrene linked to —C(CH3)2-CN.
Item FFF151. A composite comprising a nanotube and polymethyl methacrylate linked to —C(CH3)(CH2-CH3)-CN.
Item FFF152. A composite comprising a carbon nanotube and polymethyl methacrylate linked to —C(CH3)(CH2-CH3)-CN.
Item FFF153. A composite comprising a multi-wall nanotube and polymethyl methacrylate linked to —C(CH3)(CH2-CH3)-CN.
Item FFF154. A composite comprising a multi-wall carbon nanotube and polymethyl methacrylate linked to —C(CH3)(CH2-CH3)-CN.
Item FFF155. A composite comprising a single-wall nanotube and polymethyl methacrylate linked to —C(CH3)(CH2-CH3)-CN.
Item FFF156. A composite comprising a single-wall carbon nanotube and polymethyl methacrylate linked to —C(CH3)(CH2-CH3)-CN.
Item FFF157. A composite comprising graphene and polymethyl methacrylate linked to —C(CH3)(CH2-CH3)-CN.
Item FFF158. A composite comprising a carbon fibre and polymethyl methacrylate linked to —C(CH3)(CH2-CH3)-CN.
Item FFF159. A composite comprising a carbon nanofibre and polymethyl methacrylate linked to —C(CH3)(CH2-CH3)-CN.
Item FFF160. A composite comprising a carbon nanothread and polymethyl methacrylate linked to —C(CH3)(CH2-CH3)-CN.
Item FFF161. A composite comprising a ceramic material and polymethyl methacrylate linked to —C(CH3)(CH2-CH3)-CN.
Item FFF162. A composite comprising a fullerene and polymethyl methacrylate linked to —C(CH3)(CH2-CH3)-CN.
Item FFF163. A composite comprising graphane and polymethyl methacrylate linked to —C(CH3)(CH2-CH3)-CN.
Item FFF164. A composite comprising graphene oxide and polymethyl methacrylate linked to —C(CH3)(CH2-CH3)-CN.
Item FFF165. A composite comprising graphite and polymethyl methacrylate linked to —C(CH3)(CH2-CH3)-CN.
Item FFF166. A composite comprising graphyne and polymethyl methacrylate linked to —C(CH3)(CH2-CH3)-CN.
Item FFF167. A composite comprising a COOH-functionalized carbon nanotube and polymethyl methacrylate linked to —C(CH3)(CH2-CH3)-CN.
Item FFF168. A composite comprising a OH-functionalized carbon nanotube and polymethyl methacrylate linked to —C(CH3)(CH2-CH3)-CN.
Item FFF169. A composite comprising an NH2-functionalized carbon nanotube and polymethyl methacrylate linked to —C(CH3)(CH2-CH3)-CN.
Item FFF170. A composite comprising an SH-functionalized carbon nanotube and polymethyl methacrylate linked to —C(CH3)(CH2-CH3)-CN.
Item FFF171. A composite comprising COOH-functionalized graphene and polymethyl methacrylate linked to —C(CH3)(CH2-CH3)-CN.
Item FFF172. A composite comprising NH2-functionalized graphene and polymethyl methacrylate linked to —C(CH3)(CH2-CH3)-CN.
Item FFF173. A composite comprising OH-functionalized graphene and polymethyl methacrylate linked to —C(CH3)(CH2-CH3)-CN.
Item FFF174. A composite comprising thiol-functionalized graphene and polymethyl methacrylate linked to —C(CH3)(CH2-CH3)-CN.
Item FFF175. A composite comprising a glass fibre and polymethyl methacrylate linked to —C(CH3)(CH2-CH3)-CN.
Item FFF176. A composite comprising a nanotube and polymethyl methacrylate linked to —C(CH3)(CH2-C(CH3)2-O—CH3)-CN.
Item FFF177. A composite comprising a carbon nanotube and polymethyl methacrylate linked to —C(CH3)(CH2-C(CH3)2-O—CH3)-CN.
Item FFF178. A composite comprising a multi-wall nanotube and polymethyl methacrylate linked to —C(CH3)(CH2-C(CH3)2-O—CH3)-CN.
Item FFF179. A composite comprising a multi-wall carbon nanotube and polymethyl methacrylate linked to —C(CH3)(CH2-C(CH3)2-O—CH3)-CN.
Item FFF180. A composite comprising a single-wall nanotube and polymethyl methacrylate linked to —C(CH3)(CH2-C(CH3)2-O—CH3)-CN.
Item FFF181. A composite comprising a single-wall carbon nanotube and polymethyl methacrylate linked to —C(CH3)(CH2-C(CH3)2-O—CH3)-CN.
Item FFF182. A composite comprising graphene and polymethyl methacrylate linked to —C(CH3)(CH2-C(CH3)2-O—CH3)-CN.
Item FFF183. A composite comprising a carbon fibre and polymethyl methacrylate linked to —C(CH3)(CH2-C(CH3)2-O—CH3)-CN.
Item FFF184. A composite comprising a carbon nanofibre and polymethyl methacrylate linked to —C(CH3)(CH2-C(CH3)2-O—CH3)-CN.
Item FFF185. A composite comprising a carbon nanothread and polymethyl methacrylate linked to —C(CH3)(CH2-C(CH3)2-O—CH3)-CN.
Item FFF186. A composite comprising a ceramic material and polymethyl methacrylate linked to —C(CH3)(CH2-C(CH3)2-O—CH3)-CN.
Item FFF187. A composite comprising a fullerene and polymethyl methacrylate linked to —C(CH3)(CH2-C(CH3)2-O—CH3)-CN.
Item FFF188. A composite comprising graphane and polymethyl methacrylate linked to —C(CH3)(CH2-C(CH3)2-O—CH3)-CN.
Item FFF189. A composite comprising graphene oxide and polymethyl methacrylate linked to —C(CH3)(CH2-C(CH3)2-O—CH3)-CN.
Item FFF190. A composite comprising graphite and polymethyl methacrylate linked to —C(CH3)(CH2-C(CH3)2-O—CH3)-CN.
Item FFF191. A composite comprising graphyne and polymethyl methacrylate linked to —C(CH3)(CH2-C(CH3)2-O—CH3)-CN.
Item FFF192. A composite comprising a COOH-functionalized carbon nanotube and polymethyl methacrylate linked to —C(CH3)(CH2-C(CH3)2-O—CH3)-CN.
Item FFF193. A composite comprising a OH-functionalized carbon nanotube and polymethyl methacrylate linked to —C(CH3)(CH2-C(CH3)2-O—CH3)-CN.
Item FFF194. A composite comprising an NH2-functionalized carbon nanotube and polymethyl methacrylate linked to —C(CH3)(CH2-C(CH3)2-O—CH3)-CN.
Item FFF195. A composite comprising an SH-functionalized carbon nanotube and polymethyl methacrylate linked to —C(CH3)(CH2-C(CH3)2-O—CH3)-CN.
Item FFF196. A composite comprising COOH-functionalized graphene and polymethyl methacrylate linked to —C(CH3)(CH2-C(CH3)2-O—CH3)-CN.
Item FFF197. A composite comprising NH2-functionalized graphene and polymethyl methacrylate linked to —C(CH3)(CH2-C(CH3)2-O—CH3)-CN.
Item FFF198. A composite comprising OH-functionalized graphene and polymethyl methacrylate linked to —C(CH3)(CH2-C(CH3)2-O—CH3)-CN.
Item FFF199. A composite comprising thiol-functionalized graphene and polymethyl methacrylate linked to —C(CH3)(CH2-C(CH3)2-O—CH3)-CN.
Item FFF200. A composite comprising a glass fibre and polymethyl methacrylate linked to —C(CH3)(CH2-C(CH3)2-O—CH3)-CN.
Item FFF201. A composite comprising a nanotube and polyacrylate linked to a phenyl group.
Item FFF202. A composite comprising a carbon nanotube and polyacrylate linked to a phenyl group.
Item FFF203. A composite comprising a multi-wall nanotube and polyacrylate linked to a phenyl group.
Item FFF204. A composite comprising a multi-wall carbon nanotube and polyacrylate linked to a phenyl group.
Item FFF205. A composite comprising a single-wall nanotube and polyacrylate linked to a phenyl group.
Item FFF206. A composite comprising a single-wall carbon nanotube and polyacrylate linked to a phenyl group.
Item FFF207. A composite comprising graphene and polyacrylate linked to a phenyl group.
Item FFF208. A composite comprising a carbon fibre and polyacrylate linked to a phenyl group.
Item FFF209. A composite comprising a carbon nanofibre and polyacrylate linked to a phenyl group.
Item FFF210. A composite comprising a carbon nanothread and polyacrylate linked to a phenyl group.
Item FFF211. A composite comprising a ceramic material and polyacrylate linked to a phenyl group.
Item FFF212. A composite comprising a fullerene and polyacrylate linked to a phenyl group.
Item FFF213. A composite comprising graphane and polyacrylate linked to a phenyl group.
Item FFF214. A composite comprising graphene oxide and polyacrylate linked to a phenyl group.
Item FFF215. A composite comprising graphite and polyacrylate linked to a phenyl group.
Item FFF216. A composite comprising graphyne and polyacrylate linked to a phenyl group.
Item FFF217. A composite comprising a COOH-functionalized carbon nanotube and polyacrylate linked to a phenyl group.
Item FFF218. A composite comprising a OH-functionalized carbon nanotube and polyacrylate linked to a phenyl group.
Item FFF219. A composite comprising an NH2-functionalized carbon nanotube and polyacrylate linked to a phenyl group.
Item FFF220. A composite comprising an SH-functionalized carbon nanotube and polyacrylate linked to a phenyl group.
Item FFF221. A composite comprising COOH-functionalized graphene and polyacrylate linked to a phenyl group.
Item FFF222. A composite comprising NH2-functionalized graphene and polyacrylate linked to a phenyl group.
Item FFF223. A composite comprising OH-functionalized graphene and polyacrylate linked to a phenyl group.
Item FFF224. A composite comprising thiol-functionalized graphene and polyacrylate linked to a phenyl group.
Item FFF225. A composite comprising a glass fibre and polyacrylate linked to a phenyl group.
Item FFF226. A composite comprising a nanotube and polyacrylate and NC—C(CH3)2-C(CH3)2-CN.
Item FFF227. A composite comprising a carbon nanotube and polyacrylate and NC—C(CH3)2-C(CH3)2-CN.
Item FFF228. A composite comprising a multi-wall nanotube and polyacrylate and NC—C(CH3)2-C(CH3)2-CN.
Item FFF229. A composite comprising a multi-wall carbon nanotube and polyacrylate and NC—C(CH3)2-C(CH3)2-CN.
Item FFF230. A composite comprising a single-wall nanotube and polyacrylate and NC—C(CH3)2-C(CH3)2-CN.
Item FFF231. A composite comprising a single-wall carbon nanotube and polyacrylate and NC—C(CH3)2-C(CH3)2-CN.
Item FFF232. A composite comprising graphene and polyacrylate and NC—C(CH3)2-C(CH3)2-CN.
Item FFF233. A composite comprising a carbon fibre and polyacrylate and NC—C(CH3)2-C(CH3)2-CN.
Item FFF234. A composite comprising a carbon nanofibre and polyacrylate and NC—C(CH3)2-C(CH3)2-CN.
Item FFF235. A composite comprising a carbon nanothread and polyacrylate and NC—C(CH3)2-C(CH3)2-CN.
Item FFF236. A composite comprising a ceramic material and polyacrylate and NC—C(CH3)2-C(CH3)2-CN.
Item FFF237. A composite comprising a fullerene and polyacrylate and NC—C(CH3)2-C(CH3)2-CN.
Item FFF238. A composite comprising graphane and polyacrylate and NC—C(CH3)2-C(CH3)2-CN.
Item FFF239. A composite comprising graphene oxide and polyacrylate and NC—C(CH3)2-C(CH3)2-CN.
Item FFF240. A composite comprising graphite and polyacrylate and NC—C(CH3)2-C(CH3)2-CN.
Item FFF241. A composite comprising graphyne and polyacrylate and NC—C(CH3)2-C(CH3)2-CN.
Item FFF242. A composite comprising a COOH-functionalized carbon nanotube and polyacrylate and NC—C(CH3)2-C(CH3)2-CN.
Item FFF243. A composite comprising a OH-functionalized carbon nanotube and polyacrylate and NC—C(CH3)2-C(CH3)2-CN.
Item FFF244. A composite comprising an NH2-functionalized carbon nanotube and polyacrylate and NC—C(CH3)2-C(CH3)2-CN.
Item FFF245. A composite comprising an SH-functionalized carbon nanotube and polyacrylate and NC—C(CH3)2-C(CH3)2-CN.
Item FFF246. A composite comprising COOH-functionalized graphene and polyacrylate and NC—C(CH3)2-C(CH3)2-CN.
Item FFF247. A composite comprising NH2-functionalized graphene and polyacrylate and NC—C(CH3)2-C(CH3)2-CN.
Item FFF248. A composite comprising OH-functionalized graphene and polyacrylate and NC—C(CH3)2-C(CH3)2-CN.
Item FFF249. A composite comprising thiol-functionalized graphene and polyacrylate and NC—C(CH3)2-C(CH3)2-CN.
Item FFF250. A composite comprising a glass fibre and polyacrylate and NC—C(CH3)2-C(CH3)2-CN.
Item FFF251. A composite comprising a nanotube and polyacrylonitrile and NC—C(CH3)(CH2-CH3)-C(CH3)(CH2-CH3)-CN.
Item FFF252. A composite comprising a carbon nanotube and polyacrylonitrile and NC—C(CH3)(CH2-CH3)-C(CH3)(CH2-CH3)-CN.
Item FFF253. A composite comprising a multi-wall nanotube and polyacrylonitrile and NC—C(CH3)(CH2-CH3)-C(CH3)(CH2-CH3)-CN.
Item FFF254. A composite comprising a multi-wall carbon nanotube and polyacrylonitrile and NC—C(CH3)(CH2-CH3)-C(CH3)(CH2-CH3)-CN.
Item FFF255. A composite comprising a single-wall nanotube and polyacrylonitrile and NC—C(CH3)(CH2-CH3)-C(CH3)(CH2-CH3)-CN.
Item FFF256. A composite comprising a single-wall carbon nanotube and polyacrylonitrile and NC—C(CH3)(CH2-CH3)-C(CH3)(CH2-CH3)-CN.
Item FFF257. A composite comprising graphene and polyacrylonitrile and NC—C(CH3)(CH2-CH3)-C(CH3)(CH2-CH3)-CN.
Item FFF258. A composite comprising a carbon fibre and polyacrylonitrile and NC—C(CH3)(CH2-CH3)-C(CH3)(CH2-CH3)-CN.
Item FFF259. A composite comprising a carbon nanofibre and polyacrylonitrile and NC—C(CH3)(CH2-CH3)-C(CH3)(CH2-CH3)-CN.
Item FFF260. A composite comprising a carbon nanothread and polyacrylonitrile and NC—C(CH3)(CH2-CH3)-C(CH3)(CH2-CH3)-CN.
Item FFF261. A composite comprising a ceramic material and polyacrylonitrile and NC—C(CH3)(CH2-CH3)-C(CH3)(CH2-CH3)-CN.
Item FFF262. A composite comprising a fullerene and polyacrylonitrile and NC—C(CH3)(CH2-CH3)-C(CH3)(CH2-CH3)-CN.
Item FFF263. A composite comprising graphane and polyacrylonitrile and NC—C(CH3)(CH2-CH3)-C(CH3)(CH2-CH3)-CN.
Item FFF264. A composite comprising graphene oxide and polyacrylonitrile and NC—C(CH3)(CH2-CH3)-C(CH3)(CH2-CH3)-CN.
Item FFF265. A composite comprising graphite and polyacrylonitrile and NC—C(CH3)(CH2-CH3)-C(CH3)(CH2-CH3)-CN.
Item FFF266. A composite comprising graphyne and polyacrylonitrile and NC—C(CH3)(CH2-CH3)-C(CH3)(CH2-CH3)-CN.
Item FFF267. A composite comprising a COOH-functionalized carbon nanotube and polyacrylonitrile and NC—C(CH3)(CH2-CH3)-C(CH3)(CH2-CH3)-CN.
Item FFF268. A composite comprising a OH-functionalized carbon nanotube and polyacrylonitrile and NC—C(CH3)(CH2-CH3)-C(CH3)(CH2-CH3)-CN.
Item FFF269. A composite comprising an NH2-functionalized carbon nanotube and polyacrylonitrile and NC—C(CH3)(CH2-CH3)-C(CH3)(CH2-CH3)-CN.
Item FFF270. A composite comprising an SH-functionalized carbon nanotube and polyacrylonitrile and NC—C(CH3)(CH2-CH3)-C(CH3)(CH2-CH3)-CN.
Item FFF271. A composite comprising COOH-functionalized graphene and polyacrylonitrile and NC—C(CH3)(CH2-CH3)-C(CH3)(CH2-CH3)-CN.
Item FFF272. A composite comprising NH2-functionalized graphene and polyacrylonitrile and NC—C(CH3)(CH2-CH3)-C(CH3)(CH2-CH3)-CN.
Item FFF273. A composite comprising OH-functionalized graphene and polyacrylonitrile and NC—C(CH3)(CH2-CH3)-C(CH3)(CH2-CH3)-CN.
Item FFF274. A composite comprising thiol-functionalized graphene and polyacrylonitrile and NC—C(CH3)(CH2-CH3)-C(CH3)(CH2-CH3)-CN.
Item FFF275. A composite comprising a glass fibre and polyacrylonitrile and NC—C(CH3)(CH2-CH3)-C(CH3)(CH2-CH3)-CN.
Item FFF276. A composite comprising a nanotube and polyacrylonitrile and NC—C(CH3)(CH2-C(CH3)2-O—CH3)-C(CH3)(CH2-C(CH3)2-O—CH3)-CN.
Item FFF277. A composite comprising a carbon nanotube and polyacrylonitrile and NC—C(CH3)(CH2-C(CH3)2-O—CH3)-C(CH3)(CH2-C(CH3)2-O—CH3)-CN.
Item FFF278. A composite comprising a multi-wall nanotube and polyacrylonitrile and NC—C(CH3)(CH2-C(CH3)2-O—CH3)-C(CH3)(CH2-C(CH3)2-O—CH3)-CN.
Item FFF279. A composite comprising a multi-wall carbon nanotube and polyacrylonitrile and NC—C(CH3)(CH2-C(CH3)2-O—CH3)-C(CH3)(CH2-C(CH3)2-O—CH3)-CN.
Item FFF280. A composite comprising a single-wall nanotube and polyacrylonitrile and NC—C(CH3)(CH2-C(CH3)2-O—CH3)-C(CH3)(CH2-C(CH3)2-O—CH3)-CN.
Item FFF281. A composite comprising a single-wall carbon nanotube and polyacrylonitrile and NC—C(CH3)(CH2-C(CH3)2-O—CH3)-C(CH3)(CH2-C(CH3)2-O—CH3)-CN.
Item FFF282. A composite comprising graphene and polyacrylonitrile and NC—C(CH3)(CH2-C(CH3)2-O—CH3)-C(CH3)(CH2-C(CH3)2-O—CH3)-CN.
Item FFF283. A composite comprising a carbon fibre and polyacrylonitrile and NC—C(CH3)(CH2-C(CH3)2-O—CH3)-C(CH3)(CH2-C(CH3)2-O—CH3)-CN.
Item FFF284. A composite comprising a carbon nanofibre and polyacrylonitrile and NC—C(CH3)(CH2-C(CH3)2-O—CH3)-C(CH3)(CH2-C(CH3)2-O—CH3)-CN.
Item FFF285. A composite comprising a carbon nanothread and polyacrylonitrile and NC—C(CH3)(CH2-C(CH3)2-O—CH3)-C(CH3)(CH2-C(CH3)2-O—CH3)-CN.
Item FFF286. A composite comprising a ceramic material and polyacrylonitrile and NC—C(CH3)(CH2-C(CH3)2-O—CH3)-C(CH3)(CH2-C(CH3)2-O—CH3)-CN.
Item FFF287. A composite comprising a fullerene and polyacrylonitrile and NC—C(CH3)(CH2-C(CH3)2-O—CH3)-C(CH3)(CH2-C(CH3)2-O—CH3)-CN.
Item FFF288. A composite comprising graphane and polyacrylonitrile and NC—C(CH3)(CH2-C(CH3)2-O—CH3)-C(CH3)(CH2-C(CH3)2-O—CH3)-CN.
Item FFF289. A composite comprising graphene oxide and polyacrylonitrile and NC—C(CH3)(CH2-C(CH3)2-O—CH3)-C(CH3)(CH2-C(CH3)2-O—CH3)-CN.
Item FFF290. A composite comprising graphite and polyacrylonitrile and NC—C(CH3)(CH2-C(CH3)2-O—CH3)-C(CH3)(CH2-C(CH3)2-O—CH3)-CN.
Item FFF291. A composite comprising graphyne and polyacrylonitrile and NC—C(CH3)(CH2-C(CH3)2-O—CH3)-C(CH3)(CH2-C(CH3)2-O—CH3)-CN.
Item FFF292. A composite comprising a COOH-functionalized carbon nanotube and polyacrylonitrile and NC—C(CH3)(CH2-C(CH3)2-O—CH3)-C(CH3)(CH2-C(CH3)2-O—CH3)-CN.
Item FFF293. A composite comprising a OH-functionalized carbon nanotube and polyacrylonitrile and NC—C(CH3)(CH2-C(CH3)2-O—CH3)-C(CH3)(CH2-C(CH3)2-O—CH3)-CN.
Item FFF294. A composite comprising an NH2-functionalized carbon nanotube and polyacrylonitrile and NC—C(CH3)(CH2-C(CH3)2-O—CH3)-C(CH3)(CH2-C(CH3)2-O—CH3)-CN.
Item FFF295. A composite comprising an SH-functionalized carbon nanotube and polyacrylonitrile and NC—C(CH3)(CH2-C(CH3)2-O—CH3)-C(CH3)(CH2-C(CH3)2-O—CH3)-CN.
Item FFF296. A composite comprising COOH-functionalized graphene and polyacrylonitrile and NC—C(CH3)(CH2-C(CH3)2-O—CH3)-C(CH3)(CH2-C(CH3)2-O—CH3)-CN.
Item FFF297. A composite comprising NH2-functionalized graphene and polyacrylonitrile and NC—C(CH3)(CH2-C(CH3)2-O—CH3)-C(CH3)(CH2-C(CH3)2-O—CH3)-CN.
Item FFF298. A composite comprising OH-functionalized graphene and polyacrylonitrile and NC—C(CH3)(CH2-C(CH3)2-O—CH3)-C(CH3)(CH2-C(CH3)2-O—CH3)-CN.
Item FFF299. A composite comprising thiol-functionalized graphene and polyacrylonitrile and NC—C(CH3)(CH2-C(CH3)2-O—CH3)-C(CH3)(CH2-C(CH3)2-O—CH3)-CN.
Item FFF300. A composite comprising a glass fibre and polyacrylonitrile and NC—C(CH3)(CH2-C(CH3)2-O—CH3)-C(CH3)(CH2-C(CH3)2-O—CH3)-CN.
Item GG 1. A method for preparing a composite material, said method comprising providing a nanotube and an acrylic polymer and using a cavitation method to form a composite material.
Item GG2. A method for preparing a composite material, said method comprising providing a nanotube and acrylonitrile-butadiene-styrene (ABS) and using a cavitation method to form a composite material.
Item GG3. A method for preparing a composite material, said method comprising providing a nanotube and an aldehyde condensation polymer and using a cavitation method to form a composite material.
Item GG4. A method for preparing a composite material, said method comprising providing a nanotube and an aliphatic polyether and using a cavitation method to form a composite material.
Item GG5. A method for preparing a composite material, said method comprising providing a nanotube and an alkyds and oil-free coating polyester and using a cavitation method to form a composite material.
Item GG6. A method for preparing a composite material, said method comprising providing a nanotube and an aramid and using a cavitation method to form a composite material.
Item GG7. A method for preparing a composite material, said method comprising providing a nanotube and butyl rubber and using a cavitation method to form a composite material.
Item GG8. A method for preparing a composite material, said method comprising providing a nanotube and cellulose acetate and using a cavitation method to form a composite material.
Item GG9. A method for preparing a composite material, said method comprising providing a nanotube and cellulose nitrate and using a cavitation method to form a composite material.
Item GG10. A method for preparing a composite material, said method comprising providing a nanotube and a cellulosic and using a cavitation method to form a composite material.
Item GG11. A method for preparing a composite material, said method comprising providing a nanotube and a cyanoacrylate polymer and using a cavitation method to form a composite material.
Item GG12. A method for preparing a composite material, said method comprising providing a nanotube and a diene polymer and using a cavitation method to form a composite material.
Item GG13. A method for preparing a composite material, said method comprising providing a nanotube and an epoxy and using a cavitation method to form a composite material.
Item GG14. A method for preparing a composite material, said method comprising providing a nanotube and an ethylene-propylene copolymer and using a cavitation method to form a composite material.
Item GG15. A method for preparing a composite material, said method comprising providing a nanotube and a fluoroelastomer and using a cavitation method to form a composite material.
Item GG16. A method for preparing a composite material, said method comprising providing a nanotube and a heterochain polymer and using a cavitation method to form a composite material.
Item GG17. A method for preparing a composite material, said method comprising providing a nanotube and a melamine-formaldehyde polymer and using a cavitation method to form a composite material.
Item GG18. A method for preparing a composite material, said method comprising providing a nanotube and a meta-aramid polymer and using a cavitation method to form a composite material.
Item GG19. A method for preparing a composite material, said method comprising providing a nanotube and nitrile rubber and using a cavitation method to form a composite material.
Item GG20. A method for preparing a composite material, said method comprising providing a nanotube and nylon and using a cavitation method to form a composite material.
Item GG21. A method for preparing a composite material, said method comprising providing a nanotube and a para-aramid and using a cavitation method to form a composite material.
Item GG22. A method for preparing a composite material, said method comprising providing a nanotube and poly 2-hydroxyethyl methacrylate (HEMA) and using a cavitation method to form a composite material.
Item GG23. A method for preparing a composite material, said method comprising providing a nanotube and poly bisphenol A carbonate (PC) and using a cavitation method to form a composite material.
Item GG24. A method for preparing a composite material, said method comprising providing a nanotube and poly butylene terephthalate (PBT) and using a cavitation method to form a composite material.
Item GG25. A method for preparing a composite material, said method comprising providing a nanotube and poly dimethylsiloxane (PDMS) and using a cavitation method to form a composite material.
Item GG26. A method for preparing a composite material, said method comprising providing a nanotube and poly dodecano-12-lactam (Nylon 12) and using a cavitation method to form a composite material.
Item GG27. A method for preparing a composite material, said method comprising providing a nanotube and poly ether ketone ketone (PEKK) and using a cavitation method to form a composite material.
Item GG28. A method for preparing a composite material, said method comprising providing a nanotube and poly ethylene terephthalate (PET) and using a cavitation method to form a composite material.
Item GG29. A method for preparing a composite material, said method comprising providing a nanotube and poly methyl acrylate (PMA) and using a cavitation method to form a composite material.
Item GG30. A method for preparing a composite material, said method comprising providing a nanotube and poly methyl methacrylate (PMMA) and using a cavitation method to form a composite material.
Item GG31. A method for preparing a composite material, said method comprising providing a nanotube and poly vinyl acetate (PVA) and using a cavitation method to form a composite material.
Item GG32. A method for preparing a composite material, said method comprising providing a nanotube and poly vinyl chloride (PVC) and using a cavitation method to form a composite material.
Item GG33. A method for preparing a composite material, said method comprising providing a nanotube and poly vinylidene chloride (PVDC) and using a cavitation method to form a composite material.
Item GG34. A method for preparing a composite material, said method comprising providing a nanotube and poly vinylidene fluoride (PVDF) and using a cavitation method to form a composite material.
Item GG35. A method for preparing a composite material, said method comprising providing a nanotube and poly(acrylic acid) and using a cavitation method to form a composite material.
Item GG36. A method for preparing a composite material, said method comprising providing a nanotube and poly(Bisphenol A isophthalate) and using a cavitation method to form a composite material.
Item GG37. A method for preparing a composite material, said method comprising providing a nanotube and poly(Bisphenol A terephthalate) and using a cavitation method to form a composite material.
Item GG38. A method for preparing a composite material, said method comprising providing a nanotube and poly(butyl acrylate) and using a cavitation method to form a composite material.
Item GG39. A method for preparing a composite material, said method comprising providing a nanotube and poly(butyl methacrylate) and using a cavitation method to form a composite material.
Item GG40. A method for preparing a composite material, said method comprising providing a nanotube and poly(butylene) and using a cavitation method to form a composite material.
Item GG41. A method for preparing a composite material, said method comprising providing a nanotube and poly(caprolactone) and using a cavitation method to form a composite material.
Item GG42. A method for preparing a composite material, said method comprising providing a nanotube and poly(chlorotrifluoroethylene) and using a cavitation method to form a composite material.
Item GG43. A method for preparing a composite material, said method comprising providing a nanotube and poly(cyclohexyl methacrylate) and using a cavitation method to form a composite material.
Item GG44. A method for preparing a composite material, said method comprising providing a nanotube and poly(ethyl acrylate) and using a cavitation method to form a composite material.
Item GG45. A method for preparing a composite material, said method comprising providing a nanotube and poly(ethylene glycol) and using a cavitation method to form a composite material.
Item GG46. A method for preparing a composite material, said method comprising providing a nanotube and poly(ethylene naphthalate) and using a cavitation method to form a composite material.
Item GG47. A method for preparing a composite material, said method comprising providing a nanotube and poly(isobutylene) and using a cavitation method to form a composite material.
Item GG48. A method for preparing a composite material, said method comprising providing a nanotube and poly(phenylsulfone) and using a cavitation method to form a composite material.
Item GG49. A method for preparing a composite material, said method comprising providing a nanotube and poly(propylene glycol) and using a cavitation method to form a composite material.
Item GG50. A method for preparing a composite material, said method comprising providing a nanotube and poly(tetrahydrofuran) and using a cavitation method to form a composite material.
Item GG51. A method for preparing a composite material, said method comprising providing a nanotube and poly(α-methylstyrene) and using a cavitation method to form a composite material.
Item GG52. A method for preparing a composite material, said method comprising providing a nanotube and polyacetal and using a cavitation method to form a composite material.
Item GG53. A method for preparing a composite material, said method comprising providing a nanotube and polyacetal (POM) and using a cavitation method to form a composite material.
Item GG54. A method for preparing a composite material, said method comprising providing a nanotube and polyacrylate elastomers and using a cavitation method to form a composite material.
Item GG55. A method for preparing a composite material, said method comprising providing a nanotube and polyacrylonitrile (PAN) and using a cavitation method to form a composite material.
Item GG56. A method for preparing a composite material, said method comprising providing a nanotube and polyamide and using a cavitation method to form a composite material.
Item GG57. A method for preparing a composite material, said method comprising providing a nanotube and polybutadiene (PBD) and using a cavitation method to form a composite material.
Item GG58. A method for preparing a composite material, said method comprising providing a nanotube and polybutadiene (butadiene rubber, BR) and using a cavitation method to form a composite material.
Item GG59. A method for preparing a composite material, said method comprising providing a nanotube and polybutylene terephthalate (PBT) and using a cavitation method to form a composite material.
Item GG60. A method for preparing a composite material, said method comprising providing a nanotube and polycaprolactam and using a cavitation method to form a composite material.
Item GG61. A method for preparing a composite material, said method comprising providing a nanotube and polycarbonate (PC) and using a cavitation method to form a composite material.
Item GG62. A method for preparing a composite material, said method comprising providing a nanotube and polychloroprene and using a cavitation method to form a composite material.
Item GG63. A method for preparing a composite material, said method comprising providing a nanotube and polychlorotrifluoroethylene (PCTFE) and using a cavitation method to form a composite material.
Item GG64. A method for preparing a composite material, said method comprising providing a nanotube and polyesters and using a cavitation method to form a composite material.
Item GG65. A method for preparing a composite material, said method comprising providing a nanotube and polyether ether ketone (PEEK) and using a cavitation method to form a composite material.
Item GG66. A method for preparing a composite material, said method comprising providing a nanotube and polyetherketone (PEK) and using a cavitation method to form a composite material.
Item GG67. A method for preparing a composite material, said method comprising providing a nanotube and polyethers and using a cavitation method to form a composite material.
Item GG68. A method for preparing a composite material, said method comprising providing a nanotube and polyethersulfone (PES) and using a cavitation method to form a composite material.
Item GG69. A method for preparing a composite material, said method comprising providing a nanotube and polyethyl acrylate and using a cavitation method to form a composite material.
Item GG70. A method for preparing a composite material, said method comprising providing a nanotube and polyethylene—cross-linked and using a cavitation method to form a composite material.
Item GG71. A method for preparing a composite material, said method comprising providing a nanotube and polyethylene—high density (HDPE) and using a cavitation method to form a composite material.
Item GG72. A method for preparing a composite material, said method comprising providing a nanotube and polyethylene—linear low density (LLDPE) and using a cavitation method to form a composite material.
Item GG73. A method for preparing a composite material, said method comprising providing a nanotube and polyethylene—low density (LDPE) and using a cavitation method to form a composite material.
Item GG74. A method for preparing a composite material, said method comprising providing a nanotube and polyethylene—medium density (MDPE) and using a cavitation method to form a composite material.
Item GG75. A method for preparing a composite material, said method comprising providing a nanotube and polyethylene—ultrahigh molecular weight (UHMWPE) and using a cavitation method to form a composite material.
Item GG76. A method for preparing a composite material, said method comprising providing a nanotube and polyethylene—very low density (VLDPE) and using a cavitation method to form a composite material.
Item GG77. A method for preparing a composite material, said method comprising providing a nanotube and polyethylene terephthalate (PET) and using a cavitation method to form a composite material.
Item GG78. A method for preparing a composite material, said method comprising providing a nanotube and polyethylene (PE) and using a cavitation method to form a composite material.
Item GG79. A method for preparing a composite material, said method comprising providing a nanotube and polyglycolide and using a cavitation method to form a composite material.
Item GG80. A method for preparing a composite material, said method comprising providing a nanotube and polyhexamethylene adipamide (PA 6,6) and using a cavitation method to form a composite material.
Item GG81. A method for preparing a composite material, said method comprising providing a nanotube and polyimides and using a cavitation method to form a composite material.
Item GG82. A method for preparing a composite material, said method comprising providing a nanotube and polyisoprene (natural rubber, NR; isoprene rubber, IR) and using a cavitation method to form a composite material.
Item GG83. A method for preparing a composite material, said method comprising providing a nanotube and polylactic acid (PLA) and using a cavitation method to form a composite material.
Item GG84. A method for preparing a composite material, said method comprising providing a nanotube and polymethyl acrylate and using a cavitation method to form a composite material.
Item GG85. A method for preparing a composite material, said method comprising providing a nanotube and polymethyl methacrylate (PMMA) and using a cavitation method to form a composite material.
Item GG86. A method for preparing a composite material, said method comprising providing a nanotube and polyphenylene oxide (PPO) and using a cavitation method to form a composite material.
Item GG87. A method for preparing a composite material, said method comprising providing a nanotube and polyphenylene sulfide (PPS) and using a cavitation method to form a composite material.
Item GG88. A method for preparing a composite material, said method comprising providing a nanotube and poly-p-phenylene-2,6-benzobisoxazole (PBO) and using a cavitation method to form a composite material.
Item GG89. A method for preparing a composite material, said method comprising providing a nanotube and polypropylene (PP) and using a cavitation method to form a composite material.
Item GG90. A method for preparing a composite material, said method comprising providing a nanotube and polysiloxanes (silicones) and using a cavitation method to form a composite material.
Item GG91. A method for preparing a composite material, said method comprising providing a nanotube and polystyrene (PS) and using a cavitation method to form a composite material.
Item GG92. A method for preparing a composite material, said method comprising providing a nanotube and polysulfide rubber and using a cavitation method to form a composite material.
Item GG93. A method for preparing a composite material, said method comprising providing a nanotube and polysulfides and using a cavitation method to form a composite material.
Item GG94. A method for preparing a composite material, said method comprising providing a nanotube and polytetrafluoroethylene (PTFE) and using a cavitation method to form a composite material.
Item GG95. A method for preparing a composite material, said method comprising providing a nanotube and polytrimethylene terephthalate (PTT) and using a cavitation method to form a composite material.
Item GG96. A method for preparing a composite material, said method comprising providing a nanotube and polyurethane and using a cavitation method to form a composite material.
Item GG97. A method for preparing a composite material, said method comprising providing a nanotube and polyvinyl acetate (PVAc) and using a cavitation method to form a composite material.
Item GG98. A method for preparing a composite material, said method comprising providing a nanotube and polyvinyl chloride (PVC) and using a cavitation method to form a composite material.
Item GG99. A method for preparing a composite material, said method comprising providing a nanotube and polyvinyl fluoride (PVF) and using a cavitation method to form a composite material.
Item GG100. A method for preparing a composite material, said method comprising providing a nanotube and polyvinylidene chloride (PVDC) and using a cavitation method to form a composite material.
Item GG101. A method for preparing a composite material, said method comprising providing a nanotube and polyvinylidene fluoride (PVDF) and using a cavitation method to form a composite material.
Item GG102. A method for preparing a composite material, said method comprising providing a nanotube and rayon and using a cavitation method to form a composite material.
Item GG103. A method for preparing a composite material, said method comprising providing a nanotube and styrene-acrylonitrile (SAN) and using a cavitation method to form a composite material.
Item GG104. A method for preparing a composite material, said method comprising providing a nanotube and styrene-butadiene and using a cavitation method to form a composite material.
Item GG105. A method for preparing a composite material, said method comprising providing a nanotube and styrene-isoprene and using a cavitation method to form a composite material.
Item GG106. A method for preparing a composite material, said method comprising providing a nanotube and a styrene-maleic anhydride copolymer and using a cavitation method to form a composite material.
Item GG107. A method for preparing a composite material, said method comprising providing a nanotube and a thermoplastic polyurethanes (TPU) and using a cavitation method to form a composite material.
Item GG108. A method for preparing a composite material, said method comprising providing a nanotube and an unsaturated polyester and using a cavitation method to form a composite material.
Item GG109. A method for preparing a composite material, said method comprising providing a nanotube and a urea-formaldehyde polymer and using a cavitation method to form a composite material.
Item GG110. A method for preparing a composite material, said method comprising providing a nanotube and a vinyl copolymer and using a cavitation method to form a composite material.
Item GG111. A method for preparing a composite material, said method comprising providing a nanotube and an acrylic polymer and using a mechanical method with a grinding medium to form a composite material.
Item GG112. A method for preparing a composite material, said method comprising providing a nanotube and acrylonitrile-butadiene-styrene (ABS) and using a mechanical method with a grinding medium to form a composite material.
Item GG113. A method for preparing a composite material, said method comprising providing a nanotube and an aldehyde condensation polymer and using a mechanical method with a grinding medium to form a composite material.
Item GG114. A method for preparing a composite material, said method comprising providing a nanotube and an aliphatic polyether and using a mechanical method with a grinding medium to form a composite material.
Item GG115. A method for preparing a composite material, said method comprising providing a nanotube and an alkyds and oil-free coating polyester and using a mechanical method with a grinding medium to form a composite material.
Item GG116. A method for preparing a composite material, said method comprising providing a nanotube and an aramid and using a mechanical method with a grinding medium to form a composite material.
Item GG117. A method for preparing a composite material, said method comprising providing a nanotube and butyl rubber and using a mechanical method with a grinding medium to form a composite material.
Item GG118. A method for preparing a composite material, said method comprising providing a nanotube and cellulose acetate and using a mechanical method with a grinding medium to form a composite material.
Item GG119. A method for preparing a composite material, said method comprising providing a nanotube and cellulose nitrate and using a mechanical method with a grinding medium to form a composite material.
Item GG120. A method for preparing a composite material, said method comprising providing a nanotube and a cellulosic and using a mechanical method with a grinding medium to form a composite material.
Item GG121. A method for preparing a composite material, said method comprising providing a nanotube and a cyanoacrylate polymer and using a mechanical method with a grinding medium to form a composite material.
Item GG122. A method for preparing a composite material, said method comprising providing a nanotube and a diene polymer and using a mechanical method with a grinding medium to form a composite material.
Item GG123. A method for preparing a composite material, said method comprising providing a nanotube and an epoxy and using a mechanical method with a grinding medium to form a composite material.
Item GG124. A method for preparing a composite material, said method comprising providing a nanotube and an ethylene-propylene copolymer and using a mechanical method with a grinding medium to form a composite material.
Item GG125. A method for preparing a composite material, said method comprising providing a nanotube and a fluoroelastomer and using a mechanical method with a grinding medium to form a composite material.
Item GG126. A method for preparing a composite material, said method comprising providing a nanotube and a heterochain polymer and using a mechanical method with a grinding medium to form a composite material.
Item GG127. A method for preparing a composite material, said method comprising providing a nanotube and a melamine-formaldehyde polymer and using a mechanical method with a grinding medium to form a composite material.
Item GG128. A method for preparing a composite material, said method comprising providing a nanotube and a meta-aramid polymer and using a mechanical method with a grinding medium to form a composite material.
Item GG129. A method for preparing a composite material, said method comprising providing a nanotube and nitrile rubber and using a mechanical method with a grinding medium to form a composite material.
Item GG130. A method for preparing a composite material, said method comprising providing a nanotube and nylon and using a mechanical method with a grinding medium to form a composite material.
Item GG131. A method for preparing a composite material, said method comprising providing a nanotube and a para-aramid and using a mechanical method with a grinding medium to form a composite material.
Item GG132. A method for preparing a composite material, said method comprising providing a nanotube and poly 2-hydroxyethyl methacrylate (HEMA) and using a mechanical method with a grinding medium to form a composite material.
Item GG133. A method for preparing a composite material, said method comprising providing a nanotube and poly bisphenol A carbonate (PC) and using a mechanical method with a grinding medium to form a composite material.
Item GG134. A method for preparing a composite material, said method comprising providing a nanotube and poly butylene terephthalate (PBT) and using a mechanical method with a grinding medium to form a composite material.
Item GG135. A method for preparing a composite material, said method comprising providing a nanotube and poly dimethylsiloxane (PDMS) and using a mechanical method with a grinding medium to form a composite material.
Item GG136. A method for preparing a composite material, said method comprising providing a nanotube and poly dodecano-12-lactam (Nylon 12) and using a mechanical method with a grinding medium to form a composite material.
Item GG137. A method for preparing a composite material, said method comprising providing a nanotube and poly ether ketone ketone (PEKK) and using a mechanical method with a grinding medium to form a composite material.
Item GG138. A method for preparing a composite material, said method comprising providing a nanotube and poly ethylene terephthalate (PET) and using a mechanical method with a grinding medium to form a composite material.
Item GG139. A method for preparing a composite material, said method comprising providing a nanotube and poly methyl acrylate (PMA) and using a mechanical method with a grinding medium to form a composite material.
Item GG140. A method for preparing a composite material, said method comprising providing a nanotube and poly methyl methacrylate (PMMA) and using a mechanical method with a grinding medium to form a composite material.
Item GG141. A method for preparing a composite material, said method comprising providing a nanotube and poly vinyl acetate (PVA) and using a mechanical method with a grinding medium to form a composite material.
Item GG142. A method for preparing a composite material, said method comprising providing a nanotube and poly vinyl chloride (PVC) and using a mechanical method with a grinding medium to form a composite material.
Item GG143. A method for preparing a composite material, said method comprising providing a nanotube and poly vinylidene chloride (PVDC) and using a mechanical method with a grinding medium to form a composite material.
Item GG144. A method for preparing a composite material, said method comprising providing a nanotube and poly vinylidene fluoride (PVDF) and using a mechanical method with a grinding medium to form a composite material.
Item GG145. A method for preparing a composite material, said method comprising providing a nanotube and poly(acrylic acid) and using a mechanical method with a grinding medium to form a composite material.
Item GG146. A method for preparing a composite material, said method comprising providing a nanotube and poly(Bisphenol A isophthalate) and using a mechanical method with a grinding medium to form a composite material.
Item GG147. A method for preparing a composite material, said method comprising providing a nanotube and poly(Bisphenol A terephthalate) and using a mechanical method with a grinding medium to form a composite material.
Item GG148. A method for preparing a composite material, said method comprising providing a nanotube and poly(butyl acrylate) and using a mechanical method with a grinding medium to form a composite material.
Item GG149. A method for preparing a composite material, said method comprising providing a nanotube and poly(butyl methacrylate) and using a mechanical method with a grinding medium to form a composite material.
Item GG150. A method for preparing a composite material, said method comprising providing a nanotube and poly(butylene) and using a mechanical method with a grinding medium to form a composite material.
Item GG151. A method for preparing a composite material, said method comprising providing a nanotube and poly(caprolactone) and using a mechanical method with a grinding medium to form a composite material.
Item GG152. A method for preparing a composite material, said method comprising providing a nanotube and poly(chlorotrifluoroethylene) and using a mechanical method with a grinding medium to form a composite material.
Item GG153. A method for preparing a composite material, said method comprising providing a nanotube and poly(cyclohexyl methacrylate) and using a mechanical method with a grinding medium to form a composite material.
Item GG154. A method for preparing a composite material, said method comprising providing a nanotube and poly(ethyl acrylate) and using a mechanical method with a grinding medium to form a composite material.
Item GG155. A method for preparing a composite material, said method comprising providing a nanotube and poly(ethylene glycol) and using a mechanical method with a grinding medium to form a composite material.
Item GG156. A method for preparing a composite material, said method comprising providing a nanotube and poly(ethylene naphthalate) and using a mechanical method with a grinding medium to form a composite material.
Item GG157. A method for preparing a composite material, said method comprising providing a nanotube and poly(isobutylene) and using a mechanical method with a grinding medium to form a composite material.
Item GG158. A method for preparing a composite material, said method comprising providing a nanotube and poly(phenylsulfone) and using a mechanical method with a grinding medium to form a composite material.
Item GG159. A method for preparing a composite material, said method comprising providing a nanotube and poly(propylene glycol) and using a mechanical method with a grinding medium to form a composite material.
Item GG160. A method for preparing a composite material, said method comprising providing a nanotube and poly(tetrahydrofuran) and using a mechanical method with a grinding medium to form a composite material.
Item GG161. A method for preparing a composite material, said method comprising providing a nanotube and poly(α-methylstyrene) and using a mechanical method with a grinding medium to form a composite material.
Item GG162. A method for preparing a composite material, said method comprising providing a nanotube and polyacetal and using a mechanical method with a grinding medium to form a composite material.
Item GG163. A method for preparing a composite material, said method comprising providing a nanotube and polyacetal (POM) and using a mechanical method with a grinding medium to form a composite material.
Item GG164. A method for preparing a composite material, said method comprising providing a nanotube and polyacrylate elastomers and using a mechanical method with a grinding medium to form a composite material.
Item GG165. A method for preparing a composite material, said method comprising providing a nanotube and polyacrylonitrile (PAN) and using a mechanical method with a grinding medium to form a composite material.
Item GG166. A method for preparing a composite material, said method comprising providing a nanotube and polyamide and using a mechanical method with a grinding medium to form a composite material.
Item GG167. A method for preparing a composite material, said method comprising providing a nanotube and polybutadiene (PBD) and using a mechanical method with a grinding medium to form a composite material.
Item GG168. A method for preparing a composite material, said method comprising providing a nanotube and polybutadiene (butadiene rubber, BR) and using a mechanical method with a grinding medium to form a composite material.
Item GG169. A method for preparing a composite material, said method comprising providing a nanotube and polybutylene terephthalate (PBT) and using a mechanical method with a grinding medium to form a composite material.
Item GG170. A method for preparing a composite material, said method comprising providing a nanotube and polycaprolactam and using a mechanical method with a grinding medium to form a composite material.
Item GG171. A method for preparing a composite material, said method comprising providing a nanotube and polycarbonate (PC) and using a mechanical method with a grinding medium to form a composite material.
Item GG172. A method for preparing a composite material, said method comprising providing a nanotube and polychloroprene and using a mechanical method with a grinding medium to form a composite material.
Item GG173. A method for preparing a composite material, said method comprising providing a nanotube and polychlorotrifluoroethylene (PCTFE) and using a mechanical method with a grinding medium to form a composite material.
Item GG174. A method for preparing a composite material, said method comprising providing a nanotube and polyesters and using a mechanical method with a grinding medium to form a composite material.
Item GG175. A method for preparing a composite material, said method comprising providing a nanotube and polyether ether ketone (PEEK) and using a mechanical method with a grinding medium to form a composite material.
Item GG176. A method for preparing a composite material, said method comprising providing a nanotube and polyetherketone (PEK) and using a mechanical method with a grinding medium to form a composite material.
Item GG177. A method for preparing a composite material, said method comprising providing a nanotube and polyethers and using a mechanical method with a grinding medium to form a composite material.
Item GG178. A method for preparing a composite material, said method comprising providing a nanotube and polyethersulfone (PES) and using a mechanical method with a grinding medium to form a composite material.
Item GG179. A method for preparing a composite material, said method comprising providing a nanotube and polyethyl acrylate and using a mechanical method with a grinding medium to form a composite material.
Item GG180. A method for preparing a composite material, said method comprising providing a nanotube and polyethylene—cross-linked and using a mechanical method with a grinding medium to form a composite material.
Item GG181. A method for preparing a composite material, said method comprising providing a nanotube and polyethylene—high density (HDPE) and using a mechanical method with a grinding medium to form a composite material.
Item GG182. A method for preparing a composite material, said method comprising providing a nanotube and polyethylene—linear low density (LLDPE) and using a mechanical method with a grinding medium to form a composite material.
Item GG183. A method for preparing a composite material, said method comprising providing a nanotube and polyethylene—low density (LDPE) and using a mechanical method with a grinding medium to form a composite material.
Item GG184. A method for preparing a composite material, said method comprising providing a nanotube and polyethylene—medium density (MDPE) and using a mechanical method with a grinding medium to form a composite material.
Item GG185. A method for preparing a composite material, said method comprising providing a nanotube and polyethylene—ultrahigh molecular weight (UHMWPE) and using a mechanical method with a grinding medium to form a composite material.
Item GG186. A method for preparing a composite material, said method comprising providing a nanotube and polyethylene—very low density (VLDPE) and using a mechanical method with a grinding medium to form a composite material.
Item GG187. A method for preparing a composite material, said method comprising providing a nanotube and polyethylene terephthalate (PET) and using a mechanical method with a grinding medium to form a composite material.
Item GG188. A method for preparing a composite material, said method comprising providing a nanotube and polyethylene (PE) and using a mechanical method with a grinding medium to form a composite material.
Item GG189. A method for preparing a composite material, said method comprising providing a nanotube and polyglycolide and using a mechanical method with a grinding medium to form a composite material.
Item GG190. A method for preparing a composite material, said method comprising providing a nanotube and polyhexamethylene adipamide (PA 6,6) and using a mechanical method with a grinding medium to form a composite material.
Item GG191. A method for preparing a composite material, said method comprising providing a nanotube and polyimides and using a mechanical method with a grinding medium to form a composite material.
Item GG192. A method for preparing a composite material, said method comprising providing a nanotube and polyisoprene (natural rubber, NR; isoprene rubber, IR) and using a mechanical method with a grinding medium to form a composite material.
Item GG193. A method for preparing a composite material, said method comprising providing a nanotube and polylactic acid (PLA) and using a mechanical method with a grinding medium to form a composite material.
Item GG194. A method for preparing a composite material, said method comprising providing a nanotube and polymethyl acrylate and using a mechanical method with a grinding medium to form a composite material.
Item GG195. A method for preparing a composite material, said method comprising providing a nanotube and polymethyl methacrylate (PMMA) and using a mechanical method with a grinding medium to form a composite material.
Item GG196. A method for preparing a composite material, said method comprising providing a nanotube and polyphenylene oxide (PPO) and using a mechanical method with a grinding medium to form a composite material.
Item GG197. A method for preparing a composite material, said method comprising providing a nanotube and polyphenylene sulfide (PPS) and using a mechanical method with a grinding medium to form a composite material.
Item GG198. A method for preparing a composite material, said method comprising providing a nanotube and poly-p-phenylene-2,6-benzobisoxazole (PBO) and using a mechanical method with a grinding medium to form a composite material.
Item GG199. A method for preparing a composite material, said method comprising providing a nanotube and polypropylene (PP) and using a mechanical method with a grinding medium to form a composite material.
Item GG200. A method for preparing a composite material, said method comprising providing a nanotube and polysiloxanes (silicones) and using a mechanical method with a grinding medium to form a composite material.
Item GG201. A method for preparing a composite material, said method comprising providing a nanotube and polystyrene (PS) and using a mechanical method with a grinding medium to form a composite material.
Item GG202. A method for preparing a composite material, said method comprising providing a nanotube and polysulfide rubber and using a mechanical method with a grinding medium to form a composite material.
Item GG203. A method for preparing a composite material, said method comprising providing a nanotube and polysulfides and using a mechanical method with a grinding medium to form a composite material.
Item GG204. A method for preparing a composite material, said method comprising providing a nanotube and polytetrafluoroethylene (PTFE) and using a mechanical method with a grinding medium to form a composite material.
Item GG205. A method for preparing a composite material, said method comprising providing a nanotube and polytrimethylene terephthalate (PTT) and using a mechanical method with a grinding medium to form a composite material.
Item GG206. A method for preparing a composite material, said method comprising providing a nanotube and polyurethane and using a mechanical method with a grinding medium to form a composite material.
Item GG207. A method for preparing a composite material, said method comprising providing a nanotube and polyvinyl acetate (PVAc) and using a mechanical method with a grinding medium to form a composite material.
Item GG208. A method for preparing a composite material, said method comprising providing a nanotube and polyvinyl chloride (PVC) and using a mechanical method with a grinding medium to form a composite material.
Item GG209. A method for preparing a composite material, said method comprising providing a nanotube and polyvinyl fluoride (PVF) and using a mechanical method with a grinding medium to form a composite material.
Item GG210. A method for preparing a composite material, said method comprising providing a nanotube and polyvinylidene chloride (PVDC) and using a mechanical method with a grinding medium to form a composite material.
Item GG211. A method for preparing a composite material, said method comprising providing a nanotube and polyvinylidene fluoride (PVDF) and using a mechanical method with a grinding medium to form a composite material.
Item GG212. A method for preparing a composite material, said method comprising providing a nanotube and rayon and using a mechanical method with a grinding medium to form a composite material.
Item GG213. A method for preparing a composite material, said method comprising providing a nanotube and styrene-acrylonitrile (SAN) and using a mechanical method with a grinding medium to form a composite material.
Item GG214. A method for preparing a composite material, said method comprising providing a nanotube and styrene-butadiene and using a mechanical method with a grinding medium to form a composite material.
Item GG215. A method for preparing a composite material, said method comprising providing a nanotube and styrene-isoprene and using a mechanical method with a grinding medium to form a composite material.
Item GG216. A method for preparing a composite material, said method comprising providing a nanotube and a styrene-maleic anhydride copolymer and using a mechanical method with a grinding medium to form a composite material.
Item GG217. A method for preparing a composite material, said method comprising providing a nanotube and a thermoplastic polyurethanes (TPU) and using a mechanical method with a grinding medium to form a composite material.
Item GG218. A method for preparing a composite material, said method comprising providing a nanotube and an unsaturated polyester and using a mechanical method with a grinding medium to form a composite material.
Item GG219. A method for preparing a composite material, said method comprising providing a nanotube and a urea-formaldehyde polymer and using a mechanical method with a grinding medium to form a composite material.
Item GG220. A method for preparing a composite material, said method comprising providing a nanotube and a vinyl copolymer and using a mechanical method with a grinding medium to form a composite material.
Item GG221. A method for preparing a composite material, said method comprising providing a nanotube and an acrylic polymer and using a mechanical method without a grinding medium to form a composite material.
Item GG222. A method for preparing a composite material, said method comprising providing a nanotube and acrylonitrile-butadiene-styrene (ABS) and using a mechanical method without a grinding medium to form a composite material.
Item GG223. A method for preparing a composite material, said method comprising providing a nanotube and an aldehyde condensation polymer and using a mechanical method without a grinding medium to form a composite material.
Item GG224. A method for preparing a composite material, said method comprising providing a nanotube and an aliphatic polyether and using a mechanical method without a grinding medium to form a composite material.
Item GG225. A method for preparing a composite material, said method comprising providing a nanotube and an alkyds and oil-free coating polyester and using a mechanical method without a grinding medium to form a composite material.
Item GG226. A method for preparing a composite material, said method comprising providing a nanotube and an aramid and using a mechanical method without a grinding medium to form a composite material.
Item GG227. A method for preparing a composite material, said method comprising providing a nanotube and butyl rubber and using a mechanical method without a grinding medium to form a composite material.
Item GG228. A method for preparing a composite material, said method comprising providing a nanotube and cellulose acetate and using a mechanical method without a grinding medium to form a composite material.
Item GG229. A method for preparing a composite material, said method comprising providing a nanotube and cellulose nitrate and using a mechanical method without a grinding medium to form a composite material.
Item GG230. A method for preparing a composite material, said method comprising providing a nanotube and a cellulosic and using a mechanical method without a grinding medium to form a composite material.
Item GG231. A method for preparing a composite material, said method comprising providing a nanotube and a cyanoacrylate polymer and using a mechanical method without a grinding medium to form a composite material.
Item GG232. A method for preparing a composite material, said method comprising providing a nanotube and a diene polymer and using a mechanical method without a grinding medium to form a composite material.
Item GG233. A method for preparing a composite material, said method comprising providing a nanotube and an epoxy and using a mechanical method without a grinding medium to form a composite material.
Item GG234. A method for preparing a composite material, said method comprising providing a nanotube and an ethylene-propylene copolymer and using a mechanical method without a grinding medium to form a composite material.
Item GG235. A method for preparing a composite material, said method comprising providing a nanotube and a fluoroelastomer and using a mechanical method without a grinding medium to form a composite material.
Item GG236. A method for preparing a composite material, said method comprising providing a nanotube and a heterochain polymer and using a mechanical method without a grinding medium to form a composite material.
Item GG237. A method for preparing a composite material, said method comprising providing a nanotube and a melamine-formaldehyde polymer and using a mechanical method without a grinding medium to form a composite material.
Item GG238. A method for preparing a composite material, said method comprising providing a nanotube and a meta-aramid polymer and using a mechanical method without a grinding medium to form a composite material.
Item GG239. A method for preparing a composite material, said method comprising providing a nanotube and nitrile rubber and using a mechanical method without a grinding medium to form a composite material.
Item GG240. A method for preparing a composite material, said method comprising providing a nanotube and nylon and using a mechanical method without a grinding medium to form a composite material.
Item GG241. A method for preparing a composite material, said method comprising providing a nanotube and a para-aramid and using a mechanical method without a grinding medium to form a composite material.
Item GG242. A method for preparing a composite material, said method comprising providing a nanotube and poly 2-hydroxyethyl methacrylate (HEMA) and using a mechanical method without a grinding medium to form a composite material.
Item GG243. A method for preparing a composite material, said method comprising providing a nanotube and poly bisphenol A carbonate (PC) and using a mechanical method without a grinding medium to form a composite material.
Item GG244. A method for preparing a composite material, said method comprising providing a nanotube and poly butylene terephthalate (PBT) and using a mechanical method without a grinding medium to form a composite material.
Item GG245. A method for preparing a composite material, said method comprising providing a nanotube and poly dimethylsiloxane (PDMS) and using a mechanical method without a grinding medium to form a composite material.
Item GG246. A method for preparing a composite material, said method comprising providing a nanotube and poly dodecano-12-lactam (Nylon 12) and using a mechanical method without a grinding medium to form a composite material.
Item GG247. A method for preparing a composite material, said method comprising providing a nanotube and poly ether ketone ketone (PEKK) and using a mechanical method without a grinding medium to form a composite material.
Item GG248. A method for preparing a composite material, said method comprising providing a nanotube and poly ethylene terephthalate (PET) and using a mechanical method without a grinding medium to form a composite material.
Item GG249. A method for preparing a composite material, said method comprising providing a nanotube and poly methyl acrylate (PMA) and using a mechanical method without a grinding medium to form a composite material.
Item GG250. A method for preparing a composite material, said method comprising providing a nanotube and poly methyl methacrylate (PMMA) and using a mechanical method without a grinding medium to form a composite material.
Item GG251. A method for preparing a composite material, said method comprising providing a nanotube and poly vinyl acetate (PVA) and using a mechanical method without a grinding medium to form a composite material.
Item GG252. A method for preparing a composite material, said method comprising providing a nanotube and poly vinyl chloride (PVC) and using a mechanical method without a grinding medium to form a composite material.
Item GG253. A method for preparing a composite material, said method comprising providing a nanotube and poly vinylidene chloride (PVDC) and using a mechanical method without a grinding medium to form a composite material.
Item GG254. A method for preparing a composite material, said method comprising providing a nanotube and poly vinylidene fluoride (PVDF) and using a mechanical method without a grinding medium to form a composite material.
Item GG255. A method for preparing a composite material, said method comprising providing a nanotube and poly(acrylic acid) and using a mechanical method without a grinding medium to form a composite material.
Item GG256. A method for preparing a composite material, said method comprising providing a nanotube and poly(Bisphenol A isophthalate) and using a mechanical method without a grinding medium to form a composite material.
Item GG257. A method for preparing a composite material, said method comprising providing a nanotube and poly(Bisphenol A terephthalate) and using a mechanical method without a grinding medium to form a composite material.
Item GG258. A method for preparing a composite material, said method comprising providing a nanotube and poly(butyl acrylate) and using a mechanical method without a grinding medium to form a composite material.
Item GG259. A method for preparing a composite material, said method comprising providing a nanotube and poly(butyl methacrylate) and using a mechanical method without a grinding medium to form a composite material.
Item GG260. A method for preparing a composite material, said method comprising providing a nanotube and poly(butylene) and using a mechanical method without a grinding medium to form a composite material.
Item GG261. A method for preparing a composite material, said method comprising providing a nanotube and poly(caprolactone) and using a mechanical method without a grinding medium to form a composite material.
Item GG262. A method for preparing a composite material, said method comprising providing a nanotube and poly(chlorotrifluoroethylene) and using a mechanical method without a grinding medium to form a composite material.
Item GG263. A method for preparing a composite material, said method comprising providing a nanotube and poly(cyclohexyl methacrylate) and using a mechanical method without a grinding medium to form a composite material.
Item GG264. A method for preparing a composite material, said method comprising providing a nanotube and poly(ethyl acrylate) and using a mechanical method without a grinding medium to form a composite material.
Item GG265. A method for preparing a composite material, said method comprising providing a nanotube and poly(ethylene glycol) and using a mechanical method without a grinding medium to form a composite material.
Item GG266. A method for preparing a composite material, said method comprising providing a nanotube and poly(ethylene naphthalate) and using a mechanical method without a grinding medium to form a composite material.
Item GG267. A method for preparing a composite material, said method comprising providing a nanotube and poly(isobutylene) and using a mechanical method without a grinding medium to form a composite material.
Item GG268. A method for preparing a composite material, said method comprising providing a nanotube and poly(phenylsulfone) and using a mechanical method without a grinding medium to form a composite material.
Item GG269. A method for preparing a composite material, said method comprising providing a nanotube and poly(propylene glycol) and using a mechanical method without a grinding medium to form a composite material.
Item GG270. A method for preparing a composite material, said method comprising providing a nanotube and poly(tetrahydrofuran) and using a mechanical method without a grinding medium to form a composite material.
Item GG271. A method for preparing a composite material, said method comprising providing a nanotube and poly(α-methylstyrene) and using a mechanical method without a grinding medium to form a composite material.
Item GG272. A method for preparing a composite material, said method comprising providing a nanotube and polyacetal and using a mechanical method without a grinding medium to form a composite material.
Item GG273. A method for preparing a composite material, said method comprising providing a nanotube and polyacetal (POM) and using a mechanical method without a grinding medium to form a composite material.
Item GG274. A method for preparing a composite material, said method comprising providing a nanotube and polyacrylate elastomers and using a mechanical method without a grinding medium to form a composite material.
Item GG275. A method for preparing a composite material, said method comprising providing a nanotube and polyacrylonitrile (PAN) and using a mechanical method without a grinding medium to form a composite material.
Item GG276. A method for preparing a composite material, said method comprising providing a nanotube and polyamide and using a mechanical method without a grinding medium to form a composite material.
Item GG277. A method for preparing a composite material, said method comprising providing a nanotube and polybutadiene (PBD) and using a mechanical method without a grinding medium to form a composite material.
Item GG278. A method for preparing a composite material, said method comprising providing a nanotube and polybutadiene (butadiene rubber, BR) and using a mechanical method without a grinding medium to form a composite material.
Item GG279. A method for preparing a composite material, said method comprising providing a nanotube and polybutylene terephthalate (PBT) and using a mechanical method without a grinding medium to form a composite material.
Item GG280. A method for preparing a composite material, said method comprising providing a nanotube and polycaprolactam and using a mechanical method without a grinding medium to form a composite material.
Item GG281. A method for preparing a composite material, said method comprising providing a nanotube and polycarbonate (PC) and using a mechanical method without a grinding medium to form a composite material.
Item GG282. A method for preparing a composite material, said method comprising providing a nanotube and polychloroprene and using a mechanical method without a grinding medium to form a composite material.
Item GG283. A method for preparing a composite material, said method comprising providing a nanotube and polychlorotrifluoroethylene (PCTFE) and using a mechanical method without a grinding medium to form a composite material.
Item GG284. A method for preparing a composite material, said method comprising providing a nanotube and polyesters and using a mechanical method without a grinding medium to form a composite material.
Item GG285. A method for preparing a composite material, said method comprising providing a nanotube and polyether ether ketone (PEEK) and using a mechanical method without a grinding medium to form a composite material.
Item GG286. A method for preparing a composite material, said method comprising providing a nanotube and polyetherketone (PEK) and using a mechanical method without a grinding medium to form a composite material.
Item GG287. A method for preparing a composite material, said method comprising providing a nanotube and polyethers and using a mechanical method without a grinding medium to form a composite material.
Item GG288. A method for preparing a composite material, said method comprising providing a nanotube and polyethersulfone (PES) and using a mechanical method without a grinding medium to form a composite material.
Item GG289. A method for preparing a composite material, said method comprising providing a nanotube and polyethyl acrylate and using a mechanical method without a grinding medium to form a composite material.
Item GG290. A method for preparing a composite material, said method comprising providing a nanotube and polyethylene—cross-linked and using a mechanical method without a grinding medium to form a composite material.
Item GG291. A method for preparing a composite material, said method comprising providing a nanotube and polyethylene—high density (HDPE) and using a mechanical method without a grinding medium to form a composite material.
Item GG292. A method for preparing a composite material, said method comprising providing a nanotube and polyethylene—linear low density (LLDPE) and using a mechanical method without a grinding medium to form a composite material.
Item GG293. A method for preparing a composite material, said method comprising providing a nanotube and polyethylene—low density (LDPE) and using a mechanical method without a grinding medium to form a composite material.
Item GG294. A method for preparing a composite material, said method comprising providing a nanotube and polyethylene—medium density (MDPE) and using a mechanical method without a grinding medium to form a composite material.
Item GG295. A method for preparing a composite material, said method comprising providing a nanotube and polyethylene—ultrahigh molecular weight (UHMWPE) and using a mechanical method without a grinding medium to form a composite material.
Item GG296. A method for preparing a composite material, said method comprising providing a nanotube and polyethylene—very low density (VLDPE) and using a mechanical method without a grinding medium to form a composite material.
Item GG297. A method for preparing a composite material, said method comprising providing a nanotube and polyethylene terephthalate (PET) and using a mechanical method without a grinding medium to form a composite material.
Item GG298. A method for preparing a composite material, said method comprising providing a nanotube and polyethylene (PE) and using a mechanical method without a grinding medium to form a composite material.
Item GG299. A method for preparing a composite material, said method comprising providing a nanotube and polyglycolide and using a mechanical method without a grinding medium to form a composite material.
Item GG300. A method for preparing a composite material, said method comprising providing a nanotube and polyhexamethylene adipamide (PA 6,6) and using a mechanical method without a grinding medium to form a composite material.
Item GG301. A method for preparing a composite material, said method comprising providing a nanotube and polyimides and using a mechanical method without a grinding medium to form a composite material.
Item GG302. A method for preparing a composite material, said method comprising providing a nanotube and polyisoprene (natural rubber, NR; isoprene rubber, IR) and using a mechanical method without a grinding medium to form a composite material.
Item GG303. A method for preparing a composite material, said method comprising providing a nanotube and polylactic acid (PLA) and using a mechanical method without a grinding medium to form a composite material.
Item GG304. A method for preparing a composite material, said method comprising providing a nanotube and polymethyl acrylate and using a mechanical method without a grinding medium to form a composite material.
Item GG305. A method for preparing a composite material, said method comprising providing a nanotube and polymethyl methacrylate (PMMA) and using a mechanical method without a grinding medium to form a composite material.
Item GG306. A method for preparing a composite material, said method comprising providing a nanotube and polyphenylene oxide (PPO) and using a mechanical method without a grinding medium to form a composite material.
Item GG307. A method for preparing a composite material, said method comprising providing a nanotube and polyphenylene sulfide (PPS) and using a mechanical method without a grinding medium to form a composite material.
Item GG308. A method for preparing a composite material, said method comprising providing a nanotube and poly-p-phenylene-2,6-benzobisoxazole (PBO) and using a mechanical method without a grinding medium to form a composite material.
Item GG309. A method for preparing a composite material, said method comprising providing a nanotube and polypropylene (PP) and using a mechanical method without a grinding medium to form a composite material.
Item GG310. A method for preparing a composite material, said method comprising providing a nanotube and polysiloxanes (silicones) and using a mechanical method without a grinding medium to form a composite material.
Item GG311. A method for preparing a composite material, said method comprising providing a nanotube and polystyrene (PS) and using a mechanical method without a grinding medium to form a composite material.
Item GG312. A method for preparing a composite material, said method comprising providing a nanotube and polysulfide rubber and using a mechanical method without a grinding medium to form a composite material.
Item GG313. A method for preparing a composite material, said method comprising providing a nanotube and polysulfides and using a mechanical method without a grinding medium to form a composite material.
Item GG314. A method for preparing a composite material, said method comprising providing a nanotube and polytetrafluoroethylene (PTFE) and using a mechanical method without a grinding medium to form a composite material.
Item GG315. A method for preparing a composite material, said method comprising providing a nanotube and polytrimethylene terephthalate (PTT) and using a mechanical method without a grinding medium to form a composite material.
Item GG316. A method for preparing a composite material, said method comprising providing a nanotube and polyurethane and using a mechanical method without a grinding medium to form a composite material.
Item GG317. A method for preparing a composite material, said method comprising providing a nanotube and polyvinyl acetate (PVAc) and using a mechanical method without a grinding medium to form a composite material.
Item GG318. A method for preparing a composite material, said method comprising providing a nanotube and polyvinyl chloride (PVC) and using a mechanical method without a grinding medium to form a composite material.
Item GG319. A method for preparing a composite material, said method comprising providing a nanotube and polyvinyl fluoride (PVF) and using a mechanical method without a grinding medium to form a composite material.
Item GG320. A method for preparing a composite material, said method comprising providing a nanotube and polyvinylidene chloride (PVDC) and using a mechanical method without a grinding medium to form a composite material.
Item GG321. A method for preparing a composite material, said method comprising providing a nanotube and polyvinylidene fluoride (PVDF) and using a mechanical method without a grinding medium to form a composite material.
Item GG322. A method for preparing a composite material, said method comprising providing a nanotube and rayon and using a mechanical method without a grinding medium to form a composite material.
Item GG323. A method for preparing a composite material, said method comprising providing a nanotube and styrene-acrylonitrile (SAN) and using a mechanical method without a grinding medium to form a composite material.
Item GG324. A method for preparing a composite material, said method comprising providing a nanotube and styrene-butadiene and using a mechanical method without a grinding medium to form a composite material.
Item GG325. A method for preparing a composite material, said method comprising providing a nanotube and styrene-isoprene and using a mechanical method without a grinding medium to form a composite material.
Item GG326. A method for preparing a composite material, said method comprising providing a nanotube and a styrene-maleic anhydride copolymer and using a mechanical method without a grinding medium to form a composite material.
Item GG327. A method for preparing a composite material, said method comprising providing a nanotube and a thermoplastic polyurethanes (TPU) and using a mechanical method without a grinding medium to form a composite material.
Item GG328. A method for preparing a composite material, said method comprising providing a nanotube and an unsaturated polyester and using a mechanical method without a grinding medium to form a composite material.
Item GG329. A method for preparing a composite material, said method comprising providing a nanotube and a urea-formaldehyde polymer and using a mechanical method without a grinding medium to form a composite material.
Item GG330. A method for preparing a composite material, said method comprising providing a nanotube and a vinyl copolymer and using a mechanical method without a grinding medium to form a composite material.
Item GG331. A method for preparing a composite material, said method comprising providing a nanotube and an acrylic polymer and using a turbulent flow method to form a composite material.
Item GG332. A method for preparing a composite material, said method comprising providing a nanotube and acrylonitrile-butadiene-styrene (ABS) and using a turbulent flow method to form a composite material.
Item GG333. A method for preparing a composite material, said method comprising providing a nanotube and an aldehyde condensation polymer and using a turbulent flow method to form a composite material.
Item GG334. A method for preparing a composite material, said method comprising providing a nanotube and an aliphatic polyether and using a turbulent flow method to form a composite material.
Item GG335. A method for preparing a composite material, said method comprising providing a nanotube and an alkyds and oil-free coating polyester and using a turbulent flow method to form a composite material.
Item GG336. A method for preparing a composite material, said method comprising providing a nanotube and an aramid and using a turbulent flow method to form a composite material.
Item GG337. A method for preparing a composite material, said method comprising providing a nanotube and butyl rubber and using a turbulent flow method to form a composite material.
Item GG338. A method for preparing a composite material, said method comprising providing a nanotube and cellulose acetate and using a turbulent flow method to form a composite material.
Item GG339. A method for preparing a composite material, said method comprising providing a nanotube and cellulose nitrate and using a turbulent flow method to form a composite material.
Item GG340. A method for preparing a composite material, said method comprising providing a nanotube and a cellulosic and using a turbulent flow method to form a composite material.
Item GG341. A method for preparing a composite material, said method comprising providing a nanotube and a cyanoacrylate polymer and using a turbulent flow method to form a composite material.
Item GG342. A method for preparing a composite material, said method comprising providing a nanotube and a diene polymer and using a turbulent flow method to form a composite material.
Item GG343. A method for preparing a composite material, said method comprising providing a nanotube and an epoxy and using a turbulent flow method to form a composite material.
Item GG344. A method for preparing a composite material, said method comprising providing a nanotube and an ethylene-propylene copolymer and using a turbulent flow method to form a composite material.
Item GG345. A method for preparing a composite material, said method comprising providing a nanotube and a fluoroelastomer and using a turbulent flow method to form a composite material.
Item GG346. A method for preparing a composite material, said method comprising providing a nanotube and a heterochain polymer and using a turbulent flow method to form a composite material.
Item GG347. A method for preparing a composite material, said method comprising providing a nanotube and a melamine-formaldehyde polymer and using a turbulent flow method to form a composite material.
Item GG348. A method for preparing a composite material, said method comprising providing a nanotube and a meta-aramid polymer and using a turbulent flow method to form a composite material.
Item GG349. A method for preparing a composite material, said method comprising providing a nanotube and nitrile rubber and using a turbulent flow method to form a composite material.
Item GG350. A method for preparing a composite material, said method comprising providing a nanotube and nylon and using a turbulent flow method to form a composite material.
Item GG351. A method for preparing a composite material, said method comprising providing a nanotube and a para-aramid and using a turbulent flow method to form a composite material.
Item GG352. A method for preparing a composite material, said method comprising providing a nanotube and poly 2-hydroxyethyl methacrylate (HEMA) and using a turbulent flow method to form a composite material.
Item GG353. A method for preparing a composite material, said method comprising providing a nanotube and poly bisphenol A carbonate (PC) and using a turbulent flow method to form a composite material.
Item GG354. A method for preparing a composite material, said method comprising providing a nanotube and poly butylene terephthalate (PBT) and using a turbulent flow method to form a composite material.
Item GG355. A method for preparing a composite material, said method comprising providing a nanotube and poly dimethylsiloxane (PDMS) and using a turbulent flow method to form a composite material.
Item GG356. A method for preparing a composite material, said method comprising providing a nanotube and poly dodecano-12-lactam (Nylon 12) and using a turbulent flow method to form a composite material.
Item GG357. A method for preparing a composite material, said method comprising providing a nanotube and poly ether ketone ketone (PEKK) and using a turbulent flow method to form a composite material.
Item GG358. A method for preparing a composite material, said method comprising providing a nanotube and poly ethylene terephthalate (PET) and using a turbulent flow method to form a composite material.
Item GG359. A method for preparing a composite material, said method comprising providing a nanotube and poly methyl acrylate (PMA) and using a turbulent flow method to form a composite material.
Item GG360. A method for preparing a composite material, said method comprising providing a nanotube and poly methyl methacrylate (PMMA) and using a turbulent flow method to form a composite material.
Item GG361. A method for preparing a composite material, said method comprising providing a nanotube and poly vinyl acetate (PVA) and using a turbulent flow method to form a composite material.
Item GG362. A method for preparing a composite material, said method comprising providing a nanotube and poly vinyl chloride (PVC) and using a turbulent flow method to form a composite material.
Item GG363. A method for preparing a composite material, said method comprising providing a nanotube and poly vinylidene chloride (PVDC) and using a turbulent flow method to form a composite material.
Item GG364. A method for preparing a composite material, said method comprising providing a nanotube and poly vinylidene fluoride (PVDF) and using a turbulent flow method to form a composite material.
Item GG365. A method for preparing a composite material, said method comprising providing a nanotube and poly(acrylic acid) and using a turbulent flow method to form a composite material.
Item GG366. A method for preparing a composite material, said method comprising providing a nanotube and poly(Bisphenol A isophthalate) and using a turbulent flow method to form a composite material.
Item GG367. A method for preparing a composite material, said method comprising providing a nanotube and poly(Bisphenol A terephthalate) and using a turbulent flow method to form a composite material.
Item GG368. A method for preparing a composite material, said method comprising providing a nanotube and poly(butyl acrylate) and using a turbulent flow method to form a composite material.
Item GG369. A method for preparing a composite material, said method comprising providing a nanotube and poly(butyl methacrylate) and using a turbulent flow method to form a composite material.
Item GG370. A method for preparing a composite material, said method comprising providing a nanotube and poly(butylene) and using a turbulent flow method to form a composite material.
Item GG371. A method for preparing a composite material, said method comprising providing a nanotube and poly(caprolactone) and using a turbulent flow method to form a composite material.
Item GG372. A method for preparing a composite material, said method comprising providing a nanotube and poly(chlorotrifluoroethylene) and using a turbulent flow method to form a composite material.
Item GG373. A method for preparing a composite material, said method comprising providing a nanotube and poly(cyclohexyl methacrylate) and using a turbulent flow method to form a composite material.
Item GG374. A method for preparing a composite material, said method comprising providing a nanotube and poly(ethyl acrylate) and using a turbulent flow method to form a composite material.
Item GG375. A method for preparing a composite material, said method comprising providing a nanotube and poly(ethylene glycol) and using a turbulent flow method to form a composite material.
Item GG376. A method for preparing a composite material, said method comprising providing a nanotube and poly(ethylene naphthalate) and using a turbulent flow method to form a composite material.
Item GG377. A method for preparing a composite material, said method comprising providing a nanotube and poly(isobutylene) and using a turbulent flow method to form a composite material.
Item GG378. A method for preparing a composite material, said method comprising providing a nanotube and poly(phenylsulfone) and using a turbulent flow method to form a composite material.
Item GG379. A method for preparing a composite material, said method comprising providing a nanotube and poly(propylene glycol) and using a turbulent flow method to form a composite material.
Item GG380. A method for preparing a composite material, said method comprising providing a nanotube and poly(tetrahydrofuran) and using a turbulent flow method to form a composite material.
Item GG381. A method for preparing a composite material, said method comprising providing a nanotube and poly(α-methylstyrene) and using a turbulent flow method to form a composite material.
Item GG382. A method for preparing a composite material, said method comprising providing a nanotube and polyacetal and using a turbulent flow method to form a composite material.
Item GG383. A method for preparing a composite material, said method comprising providing a nanotube and polyacetal (POM) and using a turbulent flow method to form a composite material.
Item GG384. A method for preparing a composite material, said method comprising providing a nanotube and polyacrylate elastomers and using a turbulent flow method to form a composite material.
Item GG385. A method for preparing a composite material, said method comprising providing a nanotube and polyacrylonitrile (PAN) and using a turbulent flow method to form a composite material.
Item GG386. A method for preparing a composite material, said method comprising providing a nanotube and polyamide and using a turbulent flow method to form a composite material.
Item GG387. A method for preparing a composite material, said method comprising providing a nanotube and polybutadiene (PBD) and using a turbulent flow method to form a composite material.
Item GG388. A method for preparing a composite material, said method comprising providing a nanotube and polybutadiene (butadiene rubber, BR) and using a turbulent flow method to form a composite material.
Item GG389. A method for preparing a composite material, said method comprising providing a nanotube and polybutylene terephthalate (PBT) and using a turbulent flow method to form a composite material.
Item GG390. A method for preparing a composite material, said method comprising providing a nanotube and polycaprolactam and using a turbulent flow method to form a composite material.
Item GG391. A method for preparing a composite material, said method comprising providing a nanotube and polycarbonate (PC) and using a turbulent flow method to form a composite material.
Item GG392. A method for preparing a composite material, said method comprising providing a nanotube and polychloroprene and using a turbulent flow method to form a composite material.
Item GG393. A method for preparing a composite material, said method comprising providing a nanotube and polychlorotrifluoroethylene (PCTFE) and using a turbulent flow method to form a composite material.
Item GG394. A method for preparing a composite material, said method comprising providing a nanotube and polyesters and using a turbulent flow method to form a composite material.
Item GG395. A method for preparing a composite material, said method comprising providing a nanotube and polyether ether ketone (PEEK) and using a turbulent flow method to form a composite material.
Item GG396. A method for preparing a composite material, said method comprising providing a nanotube and polyetherketone (PEK) and using a turbulent flow method to form a composite material.
Item GG397. A method for preparing a composite material, said method comprising providing a nanotube and polyethers and using a turbulent flow method to form a composite material.
Item GG398. A method for preparing a composite material, said method comprising providing a nanotube and polyethersulfone (PES) and using a turbulent flow method to form a composite material.
Item GG399. A method for preparing a composite material, said method comprising providing a nanotube and polyethyl acrylate and using a turbulent flow method to form a composite material.
Item GG400. A method for preparing a composite material, said method comprising providing a nanotube and polyethylene—cross-linked and using a turbulent flow method to form a composite material.
Item GG401. A method for preparing a composite material, said method comprising providing a nanotube and polyethylene—high density (HDPE) and using a turbulent flow method to form a composite material.
Item GG402. A method for preparing a composite material, said method comprising providing a nanotube and polyethylene—linear low density (LLDPE) and using a turbulent flow method to form a composite material.
Item GG403. A method for preparing a composite material, said method comprising providing a nanotube and polyethylene—low density (LDPE) and using a turbulent flow method to form a composite material.
Item GG404. A method for preparing a composite material, said method comprising providing a nanotube and polyethylene—medium density (MDPE) and using a turbulent flow method to form a composite material.
Item GG405. A method for preparing a composite material, said method comprising providing a nanotube and polyethylene—ultrahigh molecular weight (UHMWPE) and using a turbulent flow method to form a composite material.
Item GG406. A method for preparing a composite material, said method comprising providing a nanotube and polyethylene—very low density (VLDPE) and using a turbulent flow method to form a composite material.
Item GG407. A method for preparing a composite material, said method comprising providing a nanotube and polyethylene terephthalate (PET) and using a turbulent flow method to form a composite material.
Item GG408. A method for preparing a composite material, said method comprising providing a nanotube and polyethylene (PE) and using a turbulent flow method to form a composite material.
Item GG409. A method for preparing a composite material, said method comprising providing a nanotube and polyglycolide and using a turbulent flow method to form a composite material.
Item GG410. A method for preparing a composite material, said method comprising providing a nanotube and polyhexamethylene adipamide (PA 6,6) and using a turbulent flow method to form a composite material.
Item GG411. A method for preparing a composite material, said method comprising providing a nanotube and polyimides and using a turbulent flow method to form a composite material.
Item GG412. A method for preparing a composite material, said method comprising providing a nanotube and polyisoprene (natural rubber, NR; isoprene rubber, IR) and using a turbulent flow method to form a composite material.
Item GG413. A method for preparing a composite material, said method comprising providing a nanotube and polylactic acid (PLA) and using a turbulent flow method to form a composite material.
Item GG414. A method for preparing a composite material, said method comprising providing a nanotube and polymethyl acrylate and using a turbulent flow method to form a composite material.
Item GG415. A method for preparing a composite material, said method comprising providing a nanotube and polymethyl methacrylate (PMMA) and using a turbulent flow method to form a composite material.
Item GG416. A method for preparing a composite material, said method comprising providing a nanotube and polyphenylene oxide (PPO) and using a turbulent flow method to form a composite material.
Item GG417. A method for preparing a composite material, said method comprising providing a nanotube and polyphenylene sulfide (PPS) and using a turbulent flow method to form a composite material.
Item GG418. A method for preparing a composite material, said method comprising providing a nanotube and poly-p-phenylene-2,6-benzobisoxazole (PBO) and using a turbulent flow method to form a composite material.
Item GG419. A method for preparing a composite material, said method comprising providing a nanotube and polypropylene (PP) and using a turbulent flow method to form a composite material.
Item GG420. A method for preparing a composite material, said method comprising providing a nanotube and polysiloxanes (silicones) and using a turbulent flow method to form a composite material.
Item GG421. A method for preparing a composite material, said method comprising providing a nanotube and polystyrene (PS) and using a turbulent flow method to form a composite material.
Item GG422. A method for preparing a composite material, said method comprising providing a nanotube and polysulfide rubber and using a turbulent flow method to form a composite material.
Item GG423. A method for preparing a composite material, said method comprising providing a nanotube and polysulfides and using a turbulent flow method to form a composite material.
Item GG424. A method for preparing a composite material, said method comprising providing a nanotube and polytetrafluoroethylene (PTFE) and using a turbulent flow method to form a composite material.
Item GG425. A method for preparing a composite material, said method comprising providing a nanotube and polytrimethylene terephthalate (PTT) and using a turbulent flow method to form a composite material.
Item GG426. A method for preparing a composite material, said method comprising providing a nanotube and polyurethane and using a turbulent flow method to form a composite material.
Item GG427. A method for preparing a composite material, said method comprising providing a nanotube and polyvinyl acetate (PVAc) and using a turbulent flow method to form a composite material.
Item GG428. A method for preparing a composite material, said method comprising providing a nanotube and polyvinyl chloride (PVC) and using a turbulent flow method to form a composite material.
Item GG429. A method for preparing a composite material, said method comprising providing a nanotube and polyvinyl fluoride (PVF) and using a turbulent flow method to form a composite material.
Item GG430. A method for preparing a composite material, said method comprising providing a nanotube and polyvinylidene chloride (PVDC) and using a turbulent flow method to form a composite material.
Item GG431. A method for preparing a composite material, said method comprising providing a nanotube and polyvinylidene fluoride (PVDF) and using a turbulent flow method to form a composite material.
Item GG432. A method for preparing a composite material, said method comprising providing a nanotube and rayon and using a turbulent flow method to form a composite material.
Item GG433. A method for preparing a composite material, said method comprising providing a nanotube and styrene-acrylonitrile (SAN) and using a turbulent flow method to form a composite material.
Item GG434. A method for preparing a composite material, said method comprising providing a nanotube and styrene-butadiene and using a turbulent flow method to form a composite material.
Item GG435. A method for preparing a composite material, said method comprising providing a nanotube and styrene-isoprene and using a turbulent flow method to form a composite material.
Item GG436. A method for preparing a composite material, said method comprising providing a nanotube and a styrene-maleic anhydride copolymer and using a turbulent flow method to form a composite material.
Item GG437. A method for preparing a composite material, said method comprising providing a nanotube and a thermoplastic polyurethanes (TPU) and using a turbulent flow method to form a composite material.
Item GG438. A method for preparing a composite material, said method comprising providing a nanotube and an unsaturated polyester and using a turbulent flow method to form a composite material.
Item GG439. A method for preparing a composite material, said method comprising providing a nanotube and a urea-formaldehyde polymer and using a turbulent flow method to form a composite material.
Item GG440. A method for preparing a composite material, said method comprising providing a nanotube and a vinyl copolymer and using a turbulent flow method to form a composite material.
Item GG441. A method for preparing a composite material, said method comprising providing a nanotube and an acrylic polymer and using a ball collision mill to form a composite material.
Item GG442. A method for preparing a composite material, said method comprising providing a nanotube and acrylonitrile-butadiene-styrene (ABS) and using a ball collision mill to form a composite material.
Item GG443. A method for preparing a composite material, said method comprising providing a nanotube and an aldehyde condensation polymer and using a ball collision mill to form a composite material.
Item GG444. A method for preparing a composite material, said method comprising providing a nanotube and an aliphatic polyether and using a ball collision mill to form a composite material.
Item GG445. A method for preparing a composite material, said method comprising providing a nanotube and an alkyds and oil-free coating polyester and using a ball collision mill to form a composite material.
Item GG446. A method for preparing a composite material, said method comprising providing a nanotube and an aramid and using a ball collision mill to form a composite material.
Item GG447. A method for preparing a composite material, said method comprising providing a nanotube and butyl rubber and using a ball collision mill to form a composite material.
Item GG448. A method for preparing a composite material, said method comprising providing a nanotube and cellulose acetate and using a ball collision mill to form a composite material.
Item GG449. A method for preparing a composite material, said method comprising providing a nanotube and cellulose nitrate and using a ball collision mill to form a composite material.
Item GG450. A method for preparing a composite material, said method comprising providing a nanotube and a cellulosic and using a ball collision mill to form a composite material.
Item GG451. A method for preparing a composite material, said method comprising providing a nanotube and a cyanoacrylate polymer and using a ball collision mill to form a composite material.
Item GG452. A method for preparing a composite material, said method comprising providing a nanotube and a diene polymer and using a ball collision mill to form a composite material.
Item GG453. A method for preparing a composite material, said method comprising providing a nanotube and an epoxy and using a ball collision mill to form a composite material.
Item GG454. A method for preparing a composite material, said method comprising providing a nanotube and an ethylene-propylene copolymer and using a ball collision mill to form a composite material.
Item GG455. A method for preparing a composite material, said method comprising providing a nanotube and a fluoroelastomer and using a ball collision mill to form a composite material.
Item GG456. A method for preparing a composite material, said method comprising providing a nanotube and a heterochain polymer and using a ball collision mill to form a composite material.
Item GG457. A method for preparing a composite material, said method comprising providing a nanotube and a melamine-formaldehyde polymer and using a ball collision mill to form a composite material.
Item GG458. A method for preparing a composite material, said method comprising providing a nanotube and a meta-aramid polymer and using a ball collision mill to form a composite material.
Item GG459. A method for preparing a composite material, said method comprising providing a nanotube and nitrile rubber and using a ball collision mill to form a composite material.
Item GG460. A method for preparing a composite material, said method comprising providing a nanotube and nylon and using a ball collision mill to form a composite material.
Item GG461. A method for preparing a composite material, said method comprising providing a nanotube and a para-aramid and using a ball collision mill to form a composite material.
Item GG462. A method for preparing a composite material, said method comprising providing a nanotube and poly 2-hydroxyethyl methacrylate (HEMA) and using a ball collision mill to form a composite material.
Item GG463. A method for preparing a composite material, said method comprising providing a nanotube and poly bisphenol A carbonate (PC) and using a ball collision mill to form a composite material.
Item GG464. A method for preparing a composite material, said method comprising providing a nanotube and poly butylene terephthalate (PBT) and using a ball collision mill to form a composite material.
Item GG465. A method for preparing a composite material, said method comprising providing a nanotube and poly dimethylsiloxane (PDMS) and using a ball collision mill to form a composite material.
Item GG466. A method for preparing a composite material, said method comprising providing a nanotube and poly dodecano-12-lactam (Nylon 12) and using a ball collision mill to form a composite material.
Item GG467. A method for preparing a composite material, said method comprising providing a nanotube and poly ether ketone ketone (PEKK) and using a ball collision mill to form a composite material.
Item GG468. A method for preparing a composite material, said method comprising providing a nanotube and poly ethylene terephthalate (PET) and using a ball collision mill to form a composite material.
Item GG469. A method for preparing a composite material, said method comprising providing a nanotube and poly methyl acrylate (PMA) and using a ball collision mill to form a composite material.
Item GG470. A method for preparing a composite material, said method comprising providing a nanotube and poly methyl methacrylate (PMMA) and using a ball collision mill to form a composite material.
Item GG471. A method for preparing a composite material, said method comprising providing a nanotube and poly vinyl acetate (PVA) and using a ball collision mill to form a composite material.
Item GG472. A method for preparing a composite material, said method comprising providing a nanotube and poly vinyl chloride (PVC) and using a ball collision mill to form a composite material.
Item GG473. A method for preparing a composite material, said method comprising providing a nanotube and poly vinylidene chloride (PVDC) and using a ball collision mill to form a composite material.
Item GG474. A method for preparing a composite material, said method comprising providing a nanotube and poly vinylidene fluoride (PVDF) and using a ball collision mill to form a composite material.
Item GG475. A method for preparing a composite material, said method comprising providing a nanotube and poly(acrylic acid) and using a ball collision mill to form a composite material.
Item GG476. A method for preparing a composite material, said method comprising providing a nanotube and poly(Bisphenol A isophthalate) and using a ball collision mill to form a composite material.
Item GG477. A method for preparing a composite material, said method comprising providing a nanotube and poly(Bisphenol A terephthalate) and using a ball collision mill to form a composite material.
Item GG478. A method for preparing a composite material, said method comprising providing a nanotube and poly(butyl acrylate) and using a ball collision mill to form a composite material.
Item GG479. A method for preparing a composite material, said method comprising providing a nanotube and poly(butyl methacrylate) and using a ball collision mill to form a composite material.
Item GG480. A method for preparing a composite material, said method comprising providing a nanotube and poly(butylene) and using a ball collision mill to form a composite material.
Item GG481. A method for preparing a composite material, said method comprising providing a nanotube and poly(caprolactone) and using a ball collision mill to form a composite material.
Item GG482. A method for preparing a composite material, said method comprising providing a nanotube and poly(chlorotrifluoroethylene) and using a ball collision mill to form a composite material.
Item GG483. A method for preparing a composite material, said method comprising providing a nanotube and poly(cyclohexyl methacrylate) and using a ball collision mill to form a composite material.
Item GG484. A method for preparing a composite material, said method comprising providing a nanotube and poly(ethyl acrylate) and using a ball collision mill to form a composite material.
Item GG485. A method for preparing a composite material, said method comprising providing a nanotube and poly(ethylene glycol) and using a ball collision mill to form a composite material.
Item GG486. A method for preparing a composite material, said method comprising providing a nanotube and poly(ethylene naphthalate) and using a ball collision mill to form a composite material.
Item GG487. A method for preparing a composite material, said method comprising providing a nanotube and poly(isobutylene) and using a ball collision mill to form a composite material.
Item GG488. A method for preparing a composite material, said method comprising providing a nanotube and poly(phenylsulfone) and using a ball collision mill to form a composite material.
Item GG489. A method for preparing a composite material, said method comprising providing a nanotube and poly(propylene glycol) and using a ball collision mill to form a composite material.
Item GG490. A method for preparing a composite material, said method comprising providing a nanotube and poly(tetrahydrofuran) and using a ball collision mill to form a composite material.
Item GG491. A method for preparing a composite material, said method comprising providing a nanotube and poly(α-methylstyrene) and using a ball collision mill to form a composite material.
Item GG492. A method for preparing a composite material, said method comprising providing a nanotube and polyacetal and using a ball collision mill to form a composite material.
Item GG493. A method for preparing a composite material, said method comprising providing a nanotube and polyacetal (POM) and using a ball collision mill to form a composite material.
Item GG494. A method for preparing a composite material, said method comprising providing a nanotube and polyacrylate elastomers and using a ball collision mill to form a composite material.
Item GG495. A method for preparing a composite material, said method comprising providing a nanotube and polyacrylonitrile (PAN) and using a ball collision mill to form a composite material.
Item GG496. A method for preparing a composite material, said method comprising providing a nanotube and polyamide and using a ball collision mill to form a composite material.
Item GG497. A method for preparing a composite material, said method comprising providing a nanotube and polybutadiene (PBD) and using a ball collision mill to form a composite material.
Item GG498. A method for preparing a composite material, said method comprising providing a nanotube and polybutadiene (butadiene rubber, BR) and using a ball collision mill to form a composite material.
Item GG499. A method for preparing a composite material, said method comprising providing a nanotube and polybutylene terephthalate (PBT) and using a ball collision mill to form a composite material.
Item GG500. A method for preparing a composite material, said method comprising providing a nanotube and polycaprolactam and using a ball collision mill to form a composite material.
Item GG501. A method for preparing a composite material, said method comprising providing a nanotube and polycarbonate (PC) and using a ball collision mill to form a composite material.
Item GG502. A method for preparing a composite material, said method comprising providing a nanotube and polychloroprene and using a ball collision mill to form a composite material.
Item GG503. A method for preparing a composite material, said method comprising providing a nanotube and polychlorotrifluoroethylene (PCTFE) and using a ball collision mill to form a composite material.
Item GG504. A method for preparing a composite material, said method comprising providing a nanotube and polyesters and using a ball collision mill to form a composite material.
Item GG505. A method for preparing a composite material, said method comprising providing a nanotube and polyether ether ketone (PEEK) and using a ball collision mill to form a composite material.
Item GG506. A method for preparing a composite material, said method comprising providing a nanotube and polyetherketone (PEK) and using a ball collision mill to form a composite material.
Item GG507. A method for preparing a composite material, said method comprising providing a nanotube and polyethers and using a ball collision mill to form a composite material.
Item GG508. A method for preparing a composite material, said method comprising providing a nanotube and polyethersulfone (PES) and using a ball collision mill to form a composite material.
Item GG509. A method for preparing a composite material, said method comprising providing a nanotube and polyethyl acrylate and using a ball collision mill to form a composite material.
Item GG510. A method for preparing a composite material, said method comprising providing a nanotube and polyethylene—cross-linked and using a ball collision mill to form a composite material.
Item GG511. A method for preparing a composite material, said method comprising providing a nanotube and polyethylene—high density (HDPE) and using a ball collision mill to form a composite material.
Item GG512. A method for preparing a composite material, said method comprising providing a nanotube and polyethylene—linear low density (LLDPE) and using a ball collision mill to form a composite material.
Item GG513. A method for preparing a composite material, said method comprising providing a nanotube and polyethylene—low density (LDPE) and using a ball collision mill to form a composite material.
Item GG514. A method for preparing a composite material, said method comprising providing a nanotube and polyethylene—medium density (MDPE) and using a ball collision mill to form a composite material.
Item GG515. A method for preparing a composite material, said method comprising providing a nanotube and polyethylene—ultrahigh molecular weight (UHMWPE) and using a ball collision mill to form a composite material.
Item GG516. A method for preparing a composite material, said method comprising providing a nanotube and polyethylene—very low density (VLDPE) and using a ball collision mill to form a composite material.
Item GG517. A method for preparing a composite material, said method comprising providing a nanotube and polyethylene terephthalate (PET) and using a ball collision mill to form a composite material.
Item GG518. A method for preparing a composite material, said method comprising providing a nanotube and polyethylene (PE) and using a ball collision mill to form a composite material.
Item GG519. A method for preparing a composite material, said method comprising providing a nanotube and polyglycolide and using a ball collision mill to form a composite material.
Item GG520. A method for preparing a composite material, said method comprising providing a nanotube and polyhexamethylene adipamide (PA 6,6) and using a ball collision mill to form a composite material.
Item GG521. A method for preparing a composite material, said method comprising providing a nanotube and polyimides and using a ball collision mill to form a composite material.
Item GG522. A method for preparing a composite material, said method comprising providing a nanotube and polyisoprene (natural rubber, NR; isoprene rubber, IR) and using a ball collision mill to form a composite material.
Item GG523. A method for preparing a composite material, said method comprising providing a nanotube and polylactic acid (PLA) and using a ball collision mill to form a composite material.
Item GG524. A method for preparing a composite material, said method comprising providing a nanotube and polymethyl acrylate and using a ball collision mill to form a composite material.
Item GG525. A method for preparing a composite material, said method comprising providing a nanotube and polymethyl methacrylate (PMMA) and using a ball collision mill to form a composite material.
Item GG526. A method for preparing a composite material, said method comprising providing a nanotube and polyphenylene oxide (PPO) and using a ball collision mill to form a composite material.
Item GG527. A method for preparing a composite material, said method comprising providing a nanotube and polyphenylene sulfide (PPS) and using a ball collision mill to form a composite material.
Item GG528. A method for preparing a composite material, said method comprising providing a nanotube and poly-p-phenylene-2,6-benzobisoxazole (PBO) and using a ball collision mill to form a composite material.
Item GG529. A method for preparing a composite material, said method comprising providing a nanotube and polypropylene (PP) and using a ball collision mill to form a composite material.
Item GG530. A method for preparing a composite material, said method comprising providing a nanotube and polysiloxanes (silicones) and using a ball collision mill to form a composite material.
Item GG531. A method for preparing a composite material, said method comprising providing a nanotube and polystyrene (PS) and using a ball collision mill to form a composite material.
Item GG532. A method for preparing a composite material, said method comprising providing a nanotube and polysulfide rubber and using a ball collision mill to form a composite material.
Item GG533. A method for preparing a composite material, said method comprising providing a nanotube and polysulfides and using a ball collision mill to form a composite material.
Item GG534. A method for preparing a composite material, said method comprising providing a nanotube and polytetrafluoroethylene (PTFE) and using a ball collision mill to form a composite material.
Item GG535. A method for preparing a composite material, said method comprising providing a nanotube and polytrimethylene terephthalate (PTT) and using a ball collision mill to form a composite material.
Item GG536. A method for preparing a composite material, said method comprising providing a nanotube and polyurethane and using a ball collision mill to form a composite material.
Item GG537. A method for preparing a composite material, said method comprising providing a nanotube and polyvinyl acetate (PVAc) and using a ball collision mill to form a composite material.
Item GG538. A method for preparing a composite material, said method comprising providing a nanotube and polyvinyl chloride (PVC) and using a ball collision mill to form a composite material.
Item GG539. A method for preparing a composite material, said method comprising providing a nanotube and polyvinyl fluoride (PVF) and using a ball collision mill to form a composite material.
Item GG540. A method for preparing a composite material, said method comprising providing a nanotube and polyvinylidene chloride (PVDC) and using a ball collision mill to form a composite material.
Item GG541. A method for preparing a composite material, said method comprising providing a nanotube and polyvinylidene fluoride (PVDF) and using a ball collision mill to form a composite material.
Item GG542. A method for preparing a composite material, said method comprising providing a nanotube and rayon and using a ball collision mill to form a composite material.
Item GG543. A method for preparing a composite material, said method comprising providing a nanotube and styrene-acrylonitrile (SAN) and using a ball collision mill to form a composite material.
Item GG544. A method for preparing a composite material, said method comprising providing a nanotube and styrene-butadiene and using a ball collision mill to form a composite material.
Item GG545. A method for preparing a composite material, said method comprising providing a nanotube and styrene-isoprene and using a ball collision mill to form a composite material.
Item GG546. A method for preparing a composite material, said method comprising providing a nanotube and a styrene-maleic anhydride copolymer and using a ball collision mill to form a composite material.
Item GG547. A method for preparing a composite material, said method comprising providing a nanotube and a thermoplastic polyurethanes (TPU) and using a ball collision mill to form a composite material.
Item GG548. A method for preparing a composite material, said method comprising providing a nanotube and an unsaturated polyester and using a ball collision mill to form a composite material.
Item GG549. A method for preparing a composite material, said method comprising providing a nanotube and a urea-formaldehyde polymer and using a ball collision mill to form a composite material.
Item GG550. A method for preparing a composite material, said method comprising providing a nanotube and a vinyl copolymer and using a ball collision mill to form a composite material.
Item GG551. A method for preparing a composite material, said method comprising providing a nanotube and an acrylic polymer and using ball milling to form a composite material.
Item GG552. A method for preparing a composite material, said method comprising providing a nanotube and acrylonitrile-butadiene-styrene (ABS) and using ball milling to form a composite material.
Item GG553. A method for preparing a composite material, said method comprising providing a nanotube and an aldehyde condensation polymer and using ball milling to form a composite material.
Item GG554. A method for preparing a composite material, said method comprising providing a nanotube and an aliphatic polyether and using ball milling to form a composite material.
Item GG555. A method for preparing a composite material, said method comprising providing a nanotube and an alkyds and oil-free coating polyester and using ball milling to form a composite material.
Item GG556. A method for preparing a composite material, said method comprising providing a nanotube and an aramid and using ball milling to form a composite material.
Item GG557. A method for preparing a composite material, said method comprising providing a nanotube and butyl rubber and using ball milling to form a composite material.
Item GG558. A method for preparing a composite material, said method comprising providing a nanotube and cellulose acetate and using ball milling to form a composite material.
Item GG559. A method for preparing a composite material, said method comprising providing a nanotube and cellulose nitrate and using ball milling to form a composite material.
Item GG560. A method for preparing a composite material, said method comprising providing a nanotube and a cellulosic and using ball milling to form a composite material.
Item GG561. A method for preparing a composite material, said method comprising providing a nanotube and a cyanoacrylate polymer and using ball milling to form a composite material.
Item GG562. A method for preparing a composite material, said method comprising providing a nanotube and a diene polymer and using ball milling to form a composite material.
Item GG563. A method for preparing a composite material, said method comprising providing a nanotube and an epoxy and using ball milling to form a composite material.
Item GG564. A method for preparing a composite material, said method comprising providing a nanotube and an ethylene-propylene copolymer and using ball milling to form a composite material.
Item GG565. A method for preparing a composite material, said method comprising providing a nanotube and a fluoroelastomer and using ball milling to form a composite material.
Item GG566. A method for preparing a composite material, said method comprising providing a nanotube and a heterochain polymer and using ball milling to form a composite material.
Item GG567. A method for preparing a composite material, said method comprising providing a nanotube and a melamine-formaldehyde polymer and using ball milling to form a composite material.
Item GG568. A method for preparing a composite material, said method comprising providing a nanotube and a meta-aramid polymer and using ball milling to form a composite material.
Item GG569. A method for preparing a composite material, said method comprising providing a nanotube and nitrile rubber and using ball milling to form a composite material.
Item GG570. A method for preparing a composite material, said method comprising providing a nanotube and nylon and using ball milling to form a composite material.
Item GG571. A method for preparing a composite material, said method comprising providing a nanotube and a para-aramid and using ball milling to form a composite material.
Item GG572. A method for preparing a composite material, said method comprising providing a nanotube and poly 2-hydroxyethyl methacrylate (HEMA) and using ball milling to form a composite material.
Item GG573. A method for preparing a composite material, said method comprising providing a nanotube and poly bisphenol A carbonate (PC) and using ball milling to form a composite material.
Item GG574. A method for preparing a composite material, said method comprising providing a nanotube and poly butylene terephthalate (PBT) and using ball milling to form a composite material.
Item GG575. A method for preparing a composite material, said method comprising providing a nanotube and poly dimethylsiloxane (PDMS) and using ball milling to form a composite material.
Item GG576. A method for preparing a composite material, said method comprising providing a nanotube and poly dodecano-12-lactam (Nylon 12) and using ball milling to form a composite material.
Item GG577. A method for preparing a composite material, said method comprising providing a nanotube and poly ether ketone ketone (PEKK) and using ball milling to form a composite material.
Item GG578. A method for preparing a composite material, said method comprising providing a nanotube and poly ethylene terephthalate (PET) and using ball milling to form a composite material.
Item GG579. A method for preparing a composite material, said method comprising providing a nanotube and poly methyl acrylate (PMA) and using ball milling to form a composite material.
Item GG580. A method for preparing a composite material, said method comprising providing a nanotube and poly methyl methacrylate (PMMA) and using ball milling to form a composite material.
Item GG581. A method for preparing a composite material, said method comprising providing a nanotube and poly vinyl acetate (PVA) and using ball milling to form a composite material.
Item GG582. A method for preparing a composite material, said method comprising providing a nanotube and poly vinyl chloride (PVC) and using ball milling to form a composite material.
Item GG583. A method for preparing a composite material, said method comprising providing a nanotube and poly vinylidene chloride (PVDC) and using ball milling to form a composite material.
Item GG584. A method for preparing a composite material, said method comprising providing a nanotube and poly vinylidene fluoride (PVDF) and using ball milling to form a composite material.
Item GG585. A method for preparing a composite material, said method comprising providing a nanotube and poly(acrylic acid) and using ball milling to form a composite material.
Item GG586. A method for preparing a composite material, said method comprising providing a nanotube and poly(Bisphenol A isophthalate) and using ball milling to form a composite material.
Item GG587. A method for preparing a composite material, said method comprising providing a nanotube and poly(Bisphenol A terephthalate) and using ball milling to form a composite material.
Item GG588. A method for preparing a composite material, said method comprising providing a nanotube and poly(butyl acrylate) and using ball milling to form a composite material.
Item GG589. A method for preparing a composite material, said method comprising providing a nanotube and poly(butyl methacrylate) and using ball milling to form a composite material.
Item GG590. A method for preparing a composite material, said method comprising providing a nanotube and poly(butylene) and using ball milling to form a composite material.
Item GG591. A method for preparing a composite material, said method comprising providing a nanotube and poly(caprolactone) and using ball milling to form a composite material.
Item GG592. A method for preparing a composite material, said method comprising providing a nanotube and poly(chlorotrifluoroethylene) and using ball milling to form a composite material.
Item GG593. A method for preparing a composite material, said method comprising providing a nanotube and poly(cyclohexyl methacrylate) and using ball milling to form a composite material.
Item GG594. A method for preparing a composite material, said method comprising providing a nanotube and poly(ethyl acrylate) and using ball milling to form a composite material.
Item GG595. A method for preparing a composite material, said method comprising providing a nanotube and poly(ethylene glycol) and using ball milling to form a composite material.
Item GG596. A method for preparing a composite material, said method comprising providing a nanotube and poly(ethylene naphthalate) and using ball milling to form a composite material.
Item GG597. A method for preparing a composite material, said method comprising providing a nanotube and poly(isobutylene) and using ball milling to form a composite material.
Item GG598. A method for preparing a composite material, said method comprising providing a nanotube and poly(phenylsulfone) and using ball milling to form a composite material.
Item GG599. A method for preparing a composite material, said method comprising providing a nanotube and poly(propylene glycol) and using ball milling to form a composite material.
Item GG600. A method for preparing a composite material, said method comprising providing a nanotube and poly(tetrahydrofuran) and using ball milling to form a composite material.
Item GG601. A method for preparing a composite material, said method comprising providing a nanotube and poly(α-methylstyrene) and using ball milling to form a composite material.
Item GG602. A method for preparing a composite material, said method comprising providing a nanotube and polyacetal and using ball milling to form a composite material.
Item GG603. A method for preparing a composite material, said method comprising providing a nanotube and polyacetal (POM) and using ball milling to form a composite material.
Item GG604. A method for preparing a composite material, said method comprising providing a nanotube and polyacrylate elastomers and using ball milling to form a composite material.
Item GG605. A method for preparing a composite material, said method comprising providing a nanotube and polyacrylonitrile (PAN) and using ball milling to form a composite material.
Item GG606. A method for preparing a composite material, said method comprising providing a nanotube and polyamide and using ball milling to form a composite material.
Item GG607. A method for preparing a composite material, said method comprising providing a nanotube and polybutadiene (PBD) and using ball milling to form a composite material.
Item GG608. A method for preparing a composite material, said method comprising providing a nanotube and polybutadiene (butadiene rubber, BR) and using ball milling to form a composite material.
Item GG609. A method for preparing a composite material, said method comprising providing a nanotube and polybutylene terephthalate (PBT) and using ball milling to form a composite material.
Item GG610. A method for preparing a composite material, said method comprising providing a nanotube and polycaprolactam and using ball milling to form a composite material.
Item GG611. A method for preparing a composite material, said method comprising providing a nanotube and polycarbonate (PC) and using ball milling to form a composite material.
Item GG612. A method for preparing a composite material, said method comprising providing a nanotube and polychloroprene and using ball milling to form a composite material.
Item GG613. A method for preparing a composite material, said method comprising providing a nanotube and polychlorotrifluoroethylene (PCTFE) and using ball milling to form a composite material.
Item GG614. A method for preparing a composite material, said method comprising providing a nanotube and polyesters and using ball milling to form a composite material.
Item GG615. A method for preparing a composite material, said method comprising providing a nanotube and polyether ether ketone (PEEK) and using ball milling to form a composite material.
Item GG616. A method for preparing a composite material, said method comprising providing a nanotube and polyetherketone (PEK) and using ball milling to form a composite material.
Item GG617. A method for preparing a composite material, said method comprising providing a nanotube and polyethers and using ball milling to form a composite material.
Item GG618. A method for preparing a composite material, said method comprising providing a nanotube and polyethersulfone (PES) and using ball milling to form a composite material.
Item GG619. A method for preparing a composite material, said method comprising providing a nanotube and polyethyl acrylate and using ball milling to form a composite material.
Item GG620. A method for preparing a composite material, said method comprising providing a nanotube and polyethylene—cross-linked and using ball milling to form a composite material.
Item GG621. A method for preparing a composite material, said method comprising providing a nanotube and polyethylene—high density (HDPE) and using ball milling to form a composite material.
Item GG622. A method for preparing a composite material, said method comprising providing a nanotube and polyethylene—linear low density (LLDPE) and using ball milling to form a composite material.
Item GG623. A method for preparing a composite material, said method comprising providing a nanotube and polyethylene—low density (LDPE) and using ball milling to form a composite material.
Item GG624. A method for preparing a composite material, said method comprising providing a nanotube and polyethylene—medium density (MDPE) and using ball milling to form a composite material.
Item GG625. A method for preparing a composite material, said method comprising providing a nanotube and polyethylene—ultrahigh molecular weight (UHMWPE) and using ball milling to form a composite material.
Item GG626. A method for preparing a composite material, said method comprising providing a nanotube and polyethylene—very low density (VLDPE) and using ball milling to form a composite material.
Item GG627. A method for preparing a composite material, said method comprising providing a nanotube and polyethylene terephthalate (PET) and using ball milling to form a composite material.
Item GG628. A method for preparing a composite material, said method comprising providing a nanotube and polyethylene (PE) and using ball milling to form a composite material.
Item GG629. A method for preparing a composite material, said method comprising providing a nanotube and polyglycolide and using ball milling to form a composite material.
Item GG630. A method for preparing a composite material, said method comprising providing a nanotube and polyhexamethylene adipamide (PA 6,6) and using ball milling to form a composite material.
Item GG631. A method for preparing a composite material, said method comprising providing a nanotube and polyimides and using ball milling to form a composite material.
Item GG632. A method for preparing a composite material, said method comprising providing a nanotube and polyisoprene (natural rubber, NR; isoprene rubber, IR) and using ball milling to form a composite material.
Item GG633. A method for preparing a composite material, said method comprising providing a nanotube and polylactic acid (PLA) and using ball milling to form a composite material.
Item GG634. A method for preparing a composite material, said method comprising providing a nanotube and polymethyl acrylate and using ball milling to form a composite material.
Item GG635. A method for preparing a composite material, said method comprising providing a nanotube and polymethyl methacrylate (PMMA) and using ball milling to form a composite material.
Item GG636. A method for preparing a composite material, said method comprising providing a nanotube and polyphenylene oxide (PPO) and using ball milling to form a composite material.
Item GG637. A method for preparing a composite material, said method comprising providing a nanotube and polyphenylene sulfide (PPS) and using ball milling to form a composite material.
Item GG638. A method for preparing a composite material, said method comprising providing a nanotube and poly-p-phenylene-2,6-benzobisoxazole (PBO) and using ball milling to form a composite material.
Item GG639. A method for preparing a composite material, said method comprising providing a nanotube and polypropylene (PP) and using ball milling to form a composite material.
Item GG640. A method for preparing a composite material, said method comprising providing a nanotube and polysiloxanes (silicones) and using ball milling to form a composite material.
Item GG641. A method for preparing a composite material, said method comprising providing a nanotube and polystyrene (PS) and using ball milling to form a composite material.
Item GG642. A method for preparing a composite material, said method comprising providing a nanotube and polysulfide rubber and using ball milling to form a composite material.
Item GG643. A method for preparing a composite material, said method comprising providing a nanotube and polysulfides and using ball milling to form a composite material.
Item GG644. A method for preparing a composite material, said method comprising providing a nanotube and polytetrafluoroethylene (PTFE) and using ball milling to form a composite material.
Item GG645. A method for preparing a composite material, said method comprising providing a nanotube and polytrimethylene terephthalate (PTT) and using ball milling to form a composite material.
Item GG646. A method for preparing a composite material, said method comprising providing a nanotube and polyurethane and using ball milling to form a composite material.
Item GG647. A method for preparing a composite material, said method comprising providing a nanotube and polyvinyl acetate (PVAc) and using ball milling to form a composite material.
Item GG648. A method for preparing a composite material, said method comprising providing a nanotube and polyvinyl chloride (PVC) and using ball milling to form a composite material.
Item GG649. A method for preparing a composite material, said method comprising providing a nanotube and polyvinyl fluoride (PVF) and using ball milling to form a composite material.
Item GG650. A method for preparing a composite material, said method comprising providing a nanotube and polyvinylidene chloride (PVDC) and using ball milling to form a composite material.
Item GG651. A method for preparing a composite material, said method comprising providing a nanotube and polyvinylidene fluoride (PVDF) and using ball milling to form a composite material.
Item GG652. A method for preparing a composite material, said method comprising providing a nanotube and rayon and using ball milling to form a composite material.
Item GG653. A method for preparing a composite material, said method comprising providing a nanotube and styrene-acrylonitrile (SAN) and using ball milling to form a composite material.
Item GG654. A method for preparing a composite material, said method comprising providing a nanotube and styrene-butadiene and using ball milling to form a composite material.
Item GG655. A method for preparing a composite material, said method comprising providing a nanotube and styrene-isoprene and using ball milling to form a composite material.
Item GG656. A method for preparing a composite material, said method comprising providing a nanotube and a styrene-maleic anhydride copolymer and using ball milling to form a composite material.
Item GG657. A method for preparing a composite material, said method comprising providing a nanotube and a thermoplastic polyurethanes (TPU) and using ball milling to form a composite material.
Item GG658. A method for preparing a composite material, said method comprising providing a nanotube and an unsaturated polyester and using ball milling to form a composite material.
Item GG659. A method for preparing a composite material, said method comprising providing a nanotube and a urea-formaldehyde polymer and using ball milling to form a composite material.
Item GG660. A method for preparing a composite material, said method comprising providing a nanotube and a vinyl copolymer and using ball milling to form a composite material.
Item GG661. A method for preparing a composite material, said method comprising providing a nanotube and an acrylic polymer and using a bath sonicator to form a composite material.
Item GG662. A method for preparing a composite material, said method comprising providing a nanotube and acrylonitrile-butadiene-styrene (ABS) and using a bath sonicator to form a composite material.
Item GG663. A method for preparing a composite material, said method comprising providing a nanotube and an aldehyde condensation polymer and using a bath sonicator to form a composite material.
Item GG664. A method for preparing a composite material, said method comprising providing a nanotube and an aliphatic polyether and using a bath sonicator to form a composite material.
Item GG665. A method for preparing a composite material, said method comprising providing a nanotube and an alkyds and oil-free coating polyester and using a bath sonicator to form a composite material.
Item GG666. A method for preparing a composite material, said method comprising providing a nanotube and an aramid and using a bath sonicator to form a composite material.
Item GG667. A method for preparing a composite material, said method comprising providing a nanotube and butyl rubber and using a bath sonicator to form a composite material.
Item GG668. A method for preparing a composite material, said method comprising providing a nanotube and cellulose acetate and using a bath sonicator to form a composite material.
Item GG669. A method for preparing a composite material, said method comprising providing a nanotube and cellulose nitrate and using a bath sonicator to form a composite material.
Item GG670. A method for preparing a composite material, said method comprising providing a nanotube and a cellulosic and using a bath sonicator to form a composite material.
Item GG671. A method for preparing a composite material, said method comprising providing a nanotube and a cyanoacrylate polymer and using a bath sonicator to form a composite material.
Item GG672. A method for preparing a composite material, said method comprising providing a nanotube and a diene polymer and using a bath sonicator to form a composite material.
Item GG673. A method for preparing a composite material, said method comprising providing a nanotube and an epoxy and using a bath sonicator to form a composite material.
Item GG674. A method for preparing a composite material, said method comprising providing a nanotube and an ethylene-propylene copolymer and using a bath sonicator to form a composite material.
Item GG675. A method for preparing a composite material, said method comprising providing a nanotube and a fluoroelastomer and using a bath sonicator to form a composite material.
Item GG676. A method for preparing a composite material, said method comprising providing a nanotube and a heterochain polymer and using a bath sonicator to form a composite material.
Item GG677. A method for preparing a composite material, said method comprising providing a nanotube and a melamine-formaldehyde polymer and using a bath sonicator to form a composite material.
Item GG678. A method for preparing a composite material, said method comprising providing a nanotube and a meta-aramid polymer and using a bath sonicator to form a composite material.
Item GG679. A method for preparing a composite material, said method comprising providing a nanotube and nitrile rubber and using a bath sonicator to form a composite material.
Item GG680. A method for preparing a composite material, said method comprising providing a nanotube and nylon and using a bath sonicator to form a composite material.
Item GG681. A method for preparing a composite material, said method comprising providing a nanotube and a para-aramid and using a bath sonicator to form a composite material.
Item GG682. A method for preparing a composite material, said method comprising providing a nanotube and poly 2-hydroxyethyl methacrylate (HEMA) and using a bath sonicator to form a composite material.
Item GG683. A method for preparing a composite material, said method comprising providing a nanotube and poly bisphenol A carbonate (PC) and using a bath sonicator to form a composite material.
Item GG684. A method for preparing a composite material, said method comprising providing a nanotube and poly butylene terephthalate (PBT) and using a bath sonicator to form a composite material.
Item GG685. A method for preparing a composite material, said method comprising providing a nanotube and poly dimethylsiloxane (PDMS) and using a bath sonicator to form a composite material.
Item GG686. A method for preparing a composite material, said method comprising providing a nanotube and poly dodecano-12-lactam (Nylon 12) and using a bath sonicator to form a composite material.
Item GG687. A method for preparing a composite material, said method comprising providing a nanotube and poly ether ketone ketone (PEKK) and using a bath sonicator to form a composite material.
Item GG688. A method for preparing a composite material, said method comprising providing a nanotube and poly ethylene terephthalate (PET) and using a bath sonicator to form a composite material.
Item GG689. A method for preparing a composite material, said method comprising providing a nanotube and poly methyl acrylate (PMA) and using a bath sonicator to form a composite material.
Item GG690. A method for preparing a composite material, said method comprising providing a nanotube and poly methyl methacrylate (PMMA) and using a bath sonicator to form a composite material.
Item GG691. A method for preparing a composite material, said method comprising providing a nanotube and poly vinyl acetate (PVA) and using a bath sonicator to form a composite material.
Item GG692. A method for preparing a composite material, said method comprising providing a nanotube and poly vinyl chloride (PVC) and using a bath sonicator to form a composite material.
Item GG693. A method for preparing a composite material, said method comprising providing a nanotube and poly vinylidene chloride (PVDC) and using a bath sonicator to form a composite material.
Item GG694. A method for preparing a composite material, said method comprising providing a nanotube and poly vinylidene fluoride (PVDF) and using a bath sonicator to form a composite material.
Item GG695. A method for preparing a composite material, said method comprising providing a nanotube and poly(acrylic acid) and using a bath sonicator to form a composite material.
Item GG696. A method for preparing a composite material, said method comprising providing a nanotube and poly(Bisphenol A isophthalate) and using a bath sonicator to form a composite material.
Item GG697. A method for preparing a composite material, said method comprising providing a nanotube and poly(Bisphenol A terephthalate) and using a bath sonicator to form a composite material.
Item GG698. A method for preparing a composite material, said method comprising providing a nanotube and poly(butyl acrylate) and using a bath sonicator to form a composite material.
Item GG699. A method for preparing a composite material, said method comprising providing a nanotube and poly(butyl methacrylate) and using a bath sonicator to form a composite material.
Item GG700. A method for preparing a composite material, said method comprising providing a nanotube and poly(butylene) and using a bath sonicator to form a composite material.
Item GG701. A method for preparing a composite material, said method comprising providing a nanotube and poly(caprolactone) and using a bath sonicator to form a composite material.
Item GG702. A method for preparing a composite material, said method comprising providing a nanotube and poly(chlorotrifluoroethylene) and using a bath sonicator to form a composite material.
Item GG703. A method for preparing a composite material, said method comprising providing a nanotube and poly(cyclohexyl methacrylate) and using a bath sonicator to form a composite material.
Item GG704. A method for preparing a composite material, said method comprising providing a nanotube and poly(ethyl acrylate) and using a bath sonicator to form a composite material.
Item GG705. A method for preparing a composite material, said method comprising providing a nanotube and poly(ethylene glycol) and using a bath sonicator to form a composite material.
Item GG706. A method for preparing a composite material, said method comprising providing a nanotube and poly(ethylene naphthalate) and using a bath sonicator to form a composite material.
Item GG707. A method for preparing a composite material, said method comprising providing a nanotube and poly(isobutylene) and using a bath sonicator to form a composite material.
Item GG708. A method for preparing a composite material, said method comprising providing a nanotube and poly(phenylsulfone) and using a bath sonicator to form a composite material.
Item GG709. A method for preparing a composite material, said method comprising providing a nanotube and poly(propylene glycol) and using a bath sonicator to form a composite material.
Item GG710. A method for preparing a composite material, said method comprising providing a nanotube and poly(tetrahydrofuran) and using a bath sonicator to form a composite material.
Item GG711. A method for preparing a composite material, said method comprising providing a nanotube and poly(α-methylstyrene) and using a bath sonicator to form a composite material.
Item GG712. A method for preparing a composite material, said method comprising providing a nanotube and polyacetal and using a bath sonicator to form a composite material.
Item GG713. A method for preparing a composite material, said method comprising providing a nanotube and polyacetal (POM) and using a bath sonicator to form a composite material.
Item GG714. A method for preparing a composite material, said method comprising providing a nanotube and polyacrylate elastomers and using a bath sonicator to form a composite material.
Item GG715. A method for preparing a composite material, said method comprising providing a nanotube and polyacrylonitrile (PAN) and using a bath sonicator to form a composite material.
Item GG716. A method for preparing a composite material, said method comprising providing a nanotube and polyamide and using a bath sonicator to form a composite material.
Item GG717. A method for preparing a composite material, said method comprising providing a nanotube and polybutadiene (PBD) and using a bath sonicator to form a composite material.
Item GG718. A method for preparing a composite material, said method comprising providing a nanotube and polybutadiene (butadiene rubber, BR) and using a bath sonicator to form a composite material.
Item GG719. A method for preparing a composite material, said method comprising providing a nanotube and polybutylene terephthalate (PBT) and using a bath sonicator to form a composite material.
Item GG720. A method for preparing a composite material, said method comprising providing a nanotube and polycaprolactam and using a bath sonicator to form a composite material.
Item GG721. A method for preparing a composite material, said method comprising providing a nanotube and polycarbonate (PC) and using a bath sonicator to form a composite material.
Item GG722. A method for preparing a composite material, said method comprising providing a nanotube and polychloroprene and using a bath sonicator to form a composite material.
Item GG723. A method for preparing a composite material, said method comprising providing a nanotube and polychlorotrifluoroethylene (PCTFE) and using a bath sonicator to form a composite material.
Item GG724. A method for preparing a composite material, said method comprising providing a nanotube and polyesters and using a bath sonicator to form a composite material.
Item GG725. A method for preparing a composite material, said method comprising providing a nanotube and polyether ether ketone (PEEK) and using a bath sonicator to form a composite material.
Item GG726. A method for preparing a composite material, said method comprising providing a nanotube and polyetherketone (PEK) and using a bath sonicator to form a composite material.
Item GG727. A method for preparing a composite material, said method comprising providing a nanotube and polyethers and using a bath sonicator to form a composite material.
Item GG728. A method for preparing a composite material, said method comprising providing a nanotube and polyethersulfone (PES) and using a bath sonicator to form a composite material.
Item GG729. A method for preparing a composite material, said method comprising providing a nanotube and polyethyl acrylate and using a bath sonicator to form a composite material.
Item GG730. A method for preparing a composite material, said method comprising providing a nanotube and polyethylene—cross-linked and using a bath sonicator to form a composite material.
Item GG731. A method for preparing a composite material, said method comprising providing a nanotube and polyethylene—high density (HDPE) and using a bath sonicator to form a composite material.
Item GG732. A method for preparing a composite material, said method comprising providing a nanotube and polyethylene—linear low density (LLDPE) and using a bath sonicator to form a composite material.
Item GG733. A method for preparing a composite material, said method comprising providing a nanotube and polyethylene—low density (LDPE) and using a bath sonicator to form a composite material.
Item GG734. A method for preparing a composite material, said method comprising providing a nanotube and polyethylene—medium density (MDPE) and using a bath sonicator to form a composite material.
Item GG735. A method for preparing a composite material, said method comprising providing a nanotube and polyethylene—ultrahigh molecular weight (UHMWPE) and using a bath sonicator to form a composite material.
Item GG736. A method for preparing a composite material, said method comprising providing a nanotube and polyethylene—very low density (VLDPE) and using a bath sonicator to form a composite material.
Item GG737. A method for preparing a composite material, said method comprising providing a nanotube and polyethylene terephthalate (PET) and using a bath sonicator to form a composite material.
Item GG738. A method for preparing a composite material, said method comprising providing a nanotube and polyethylene (PE) and using a bath sonicator to form a composite material.
Item GG739. A method for preparing a composite material, said method comprising providing a nanotube and polyglycolide and using a bath sonicator to form a composite material.
Item GG740. A method for preparing a composite material, said method comprising providing a nanotube and polyhexamethylene adipamide (PA 6,6) and using a bath sonicator to form a composite material.
Item GG741. A method for preparing a composite material, said method comprising providing a nanotube and polyimides and using a bath sonicator to form a composite material.
Item GG742. A method for preparing a composite material, said method comprising providing a nanotube and polyisoprene (natural rubber, NR; isoprene rubber, IR) and using a bath sonicator to form a composite material.
Item GG743. A method for preparing a composite material, said method comprising providing a nanotube and polylactic acid (PLA) and using a bath sonicator to form a composite material.
Item GG744. A method for preparing a composite material, said method comprising providing a nanotube and polymethyl acrylate and using a bath sonicator to form a composite material.
Item GG745. A method for preparing a composite material, said method comprising providing a nanotube and polymethyl methacrylate (PMMA) and using a bath sonicator to form a composite material.
Item GG746. A method for preparing a composite material, said method comprising providing a nanotube and polyphenylene oxide (PPO) and using a bath sonicator to form a composite material.
Item GG747. A method for preparing a composite material, said method comprising providing a nanotube and polyphenylene sulfide (PPS) and using a bath sonicator to form a composite material.
Item GG748. A method for preparing a composite material, said method comprising providing a nanotube and poly-p-phenylene-2,6-benzobisoxazole (PBO) and using a bath sonicator to form a composite material.
Item GG749. A method for preparing a composite material, said method comprising providing a nanotube and polypropylene (PP) and using a bath sonicator to form a composite material.
Item GG750. A method for preparing a composite material, said method comprising providing a nanotube and polysiloxanes (silicones) and using a bath sonicator to form a composite material.
Item GG751. A method for preparing a composite material, said method comprising providing a nanotube and polystyrene (PS) and using a bath sonicator to form a composite material.
Item GG752. A method for preparing a composite material, said method comprising providing a nanotube and polysulfide rubber and using a bath sonicator to form a composite material.
Item GG753. A method for preparing a composite material, said method comprising providing a nanotube and polysulfides and using a bath sonicator to form a composite material.
Item GG754. A method for preparing a composite material, said method comprising providing a nanotube and polytetrafluoroethylene (PTFE) and using a bath sonicator to form a composite material.
Item GG755. A method for preparing a composite material, said method comprising providing a nanotube and polytrimethylene terephthalate (PTT) and using a bath sonicator to form a composite material.
Item GG756. A method for preparing a composite material, said method comprising providing a nanotube and polyurethane and using a bath sonicator to form a composite material.
Item GG757. A method for preparing a composite material, said method comprising providing a nanotube and polyvinyl acetate (PVAc) and using a bath sonicator to form a composite material.
Item GG758. A method for preparing a composite material, said method comprising providing a nanotube and polyvinyl chloride (PVC) and using a bath sonicator to form a composite material.
Item GG759. A method for preparing a composite material, said method comprising providing a nanotube and polyvinyl fluoride (PVF) and using a bath sonicator to form a composite material.
Item GG760. A method for preparing a composite material, said method comprising providing a nanotube and polyvinylidene chloride (PVDC) and using a bath sonicator to form a composite material.
Item GG761. A method for preparing a composite material, said method comprising providing a nanotube and polyvinylidene fluoride (PVDF) and using a bath sonicator to form a composite material.
Item GG762. A method for preparing a composite material, said method comprising providing a nanotube and rayon and using a bath sonicator to form a composite material.
Item GG763. A method for preparing a composite material, said method comprising providing a nanotube and styrene-acrylonitrile (SAN) and using a bath sonicator to form a composite material.
Item GG764. A method for preparing a composite material, said method comprising providing a nanotube and styrene-butadiene and using a bath sonicator to form a composite material.
Item GG765. A method for preparing a composite material, said method comprising providing a nanotube and styrene-isoprene and using a bath sonicator to form a composite material.
Item GG766. A method for preparing a composite material, said method comprising providing a nanotube and a styrene-maleic anhydride copolymer and using a bath sonicator to form a composite material.
Item GG767. A method for preparing a composite material, said method comprising providing a nanotube and a thermoplastic polyurethanes (TPU) and using a bath sonicator to form a composite material.
Item GG768. A method for preparing a composite material, said method comprising providing a nanotube and an unsaturated polyester and using a bath sonicator to form a composite material.
Item GG769. A method for preparing a composite material, said method comprising providing a nanotube and a urea-formaldehyde polymer and using a bath sonicator to form a composite material.
Item GG770. A method for preparing a composite material, said method comprising providing a nanotube and a vinyl copolymer and using a bath sonicator to form a composite material.
Item GG771. A method for preparing a composite material, said method comprising providing a nanotube and an acrylic polymer and using a bead mill to form a composite material.
Item GG772. A method for preparing a composite material, said method comprising providing a nanotube and acrylonitrile-butadiene-styrene (ABS) and using a bead mill to form a composite material.
Item GG773. A method for preparing a composite material, said method comprising providing a nanotube and an aldehyde condensation polymer and using a bead mill to form a composite material.
Item GG774. A method for preparing a composite material, said method comprising providing a nanotube and an aliphatic polyether and using a bead mill to form a composite material.
Item GG775. A method for preparing a composite material, said method comprising providing a nanotube and an alkyds and oil-free coating polyester and using a bead mill to form a composite material.
Item GG776. A method for preparing a composite material, said method comprising providing a nanotube and an aramid and using a bead mill to form a composite material.
Item GG777. A method for preparing a composite material, said method comprising providing a nanotube and butyl rubber and using a bead mill to form a composite material.
Item GG778. A method for preparing a composite material, said method comprising providing a nanotube and cellulose acetate and using a bead mill to form a composite material.
Item GG779. A method for preparing a composite material, said method comprising providing a nanotube and cellulose nitrate and using a bead mill to form a composite material.
Item GG780. A method for preparing a composite material, said method comprising providing a nanotube and a cellulosic and using a bead mill to form a composite material.
Item GG781. A method for preparing a composite material, said method comprising providing a nanotube and a cyanoacrylate polymer and using a bead mill to form a composite material.
Item GG782. A method for preparing a composite material, said method comprising providing a nanotube and a diene polymer and using a bead mill to form a composite material.
Item GG783. A method for preparing a composite material, said method comprising providing a nanotube and an epoxy and using a bead mill to form a composite material.
Item GG784. A method for preparing a composite material, said method comprising providing a nanotube and an ethylene-propylene copolymer and using a bead mill to form a composite material.
Item GG785. A method for preparing a composite material, said method comprising providing a nanotube and a fluoroelastomer and using a bead mill to form a composite material.
Item GG786. A method for preparing a composite material, said method comprising providing a nanotube and a heterochain polymer and using a bead mill to form a composite material.
Item GG787. A method for preparing a composite material, said method comprising providing a nanotube and a melamine-formaldehyde polymer and using a bead mill to form a composite material.
Item GG788. A method for preparing a composite material, said method comprising providing a nanotube and a meta-aramid polymer and using a bead mill to form a composite material.
Item GG789. A method for preparing a composite material, said method comprising providing a nanotube and nitrile rubber and using a bead mill to form a composite material.
Item GG790. A method for preparing a composite material, said method comprising providing a nanotube and nylon and using a bead mill to form a composite material.
Item GG791. A method for preparing a composite material, said method comprising providing a nanotube and a para-aramid and using a bead mill to form a composite material.
Item GG792. A method for preparing a composite material, said method comprising providing a nanotube and poly 2-hydroxyethyl methacrylate (HEMA) and using a bead mill to form a composite material.
Item GG793. A method for preparing a composite material, said method comprising providing a nanotube and poly bisphenol A carbonate (PC) and using a bead mill to form a composite material.
Item GG794. A method for preparing a composite material, said method comprising providing a nanotube and poly butylene terephthalate (PBT) and using a bead mill to form a composite material.
Item GG795. A method for preparing a composite material, said method comprising providing a nanotube and poly dimethylsiloxane (PDMS) and using a bead mill to form a composite material.
Item GG796. A method for preparing a composite material, said method comprising providing a nanotube and poly dodecano-12-lactam (Nylon 12) and using a bead mill to form a composite material.
Item GG797. A method for preparing a composite material, said method comprising providing a nanotube and poly ether ketone ketone (PEKK) and using a bead mill to form a composite material.
Item GG798. A method for preparing a composite material, said method comprising providing a nanotube and poly ethylene terephthalate (PET) and using a bead mill to form a composite material.
Item GG799. A method for preparing a composite material, said method comprising providing a nanotube and poly methyl acrylate (PMA) and using a bead mill to form a composite material.
Item GG800. A method for preparing a composite material, said method comprising providing a nanotube and poly methyl methacrylate (PMMA) and using a bead mill to form a composite material.
Item GG801. A method for preparing a composite material, said method comprising providing a nanotube and poly vinyl acetate (PVA) and using a bead mill to form a composite material.
Item GG802. A method for preparing a composite material, said method comprising providing a nanotube and poly vinyl chloride (PVC) and using a bead mill to form a composite material.
Item GG803. A method for preparing a composite material, said method comprising providing a nanotube and poly vinylidene chloride (PVDC) and using a bead mill to form a composite material.
Item GG804. A method for preparing a composite material, said method comprising providing a nanotube and poly vinylidene fluoride (PVDF) and using a bead mill to form a composite material.
Item GG805. A method for preparing a composite material, said method comprising providing a nanotube and poly(acrylic acid) and using a bead mill to form a composite material.
Item GG806. A method for preparing a composite material, said method comprising providing a nanotube and poly(Bisphenol A isophthalate) and using a bead mill to form a composite material.
Item GG807. A method for preparing a composite material, said method comprising providing a nanotube and poly(Bisphenol A terephthalate) and using a bead mill to form a composite material.
Item GG808. A method for preparing a composite material, said method comprising providing a nanotube and poly(butyl acrylate) and using a bead mill to form a composite material.
Item GG809. A method for preparing a composite material, said method comprising providing a nanotube and poly(butyl methacrylate) and using a bead mill to form a composite material.
Item GG810. A method for preparing a composite material, said method comprising providing a nanotube and poly(butylene) and using a bead mill to form a composite material.
Item GG811. A method for preparing a composite material, said method comprising providing a nanotube and poly(caprolactone) and using a bead mill to form a composite material.
Item GG812. A method for preparing a composite material, said method comprising providing a nanotube and poly(chlorotrifluoroethylene) and using a bead mill to form a composite material.
Item GG813. A method for preparing a composite material, said method comprising providing a nanotube and poly(cyclohexyl methacrylate) and using a bead mill to form a composite material.
Item GG814. A method for preparing a composite material, said method comprising providing a nanotube and poly(ethyl acrylate) and using a bead mill to form a composite material.
Item GG815. A method for preparing a composite material, said method comprising providing a nanotube and poly(ethylene glycol) and using a bead mill to form a composite material.
Item GG816. A method for preparing a composite material, said method comprising providing a nanotube and poly(ethylene naphthalate) and using a bead mill to form a composite material.
Item GG817. A method for preparing a composite material, said method comprising providing a nanotube and poly(isobutylene) and using a bead mill to form a composite material.
Item GG818. A method for preparing a composite material, said method comprising providing a nanotube and poly(phenylsulfone) and using a bead mill to form a composite material.
Item GG819. A method for preparing a composite material, said method comprising providing a nanotube and poly(propylene glycol) and using a bead mill to form a composite material.
Item GG820. A method for preparing a composite material, said method comprising providing a nanotube and poly(tetrahydrofuran) and using a bead mill to form a composite material.
Item GG821. A method for preparing a composite material, said method comprising providing a nanotube and poly(α-methylstyrene) and using a bead mill to form a composite material.
Item GG822. A method for preparing a composite material, said method comprising providing a nanotube and polyacetal and using a bead mill to form a composite material.
Item GG823. A method for preparing a composite material, said method comprising providing a nanotube and polyacetal (POM) and using a bead mill to form a composite material.
Item GG824. A method for preparing a composite material, said method comprising providing a nanotube and polyacrylate elastomers and using a bead mill to form a composite material.
Item GG825. A method for preparing a composite material, said method comprising providing a nanotube and polyacrylonitrile (PAN) and using a bead mill to form a composite material.
Item GG826. A method for preparing a composite material, said method comprising providing a nanotube and polyamide and using a bead mill to form a composite material.
Item GG827. A method for preparing a composite material, said method comprising providing a nanotube and polybutadiene (PBD) and using a bead mill to form a composite material.
Item GG828. A method for preparing a composite material, said method comprising providing a nanotube and polybutadiene (butadiene rubber, BR) and using a bead mill to form a composite material.
Item GG829. A method for preparing a composite material, said method comprising providing a nanotube and polybutylene terephthalate (PBT) and using a bead mill to form a composite material.
Item GG830. A method for preparing a composite material, said method comprising providing a nanotube and polycaprolactam and using a bead mill to form a composite material.
Item GG831. A method for preparing a composite material, said method comprising providing a nanotube and polycarbonate (PC) and using a bead mill to form a composite material.
Item GG832. A method for preparing a composite material, said method comprising providing a nanotube and polychloroprene and using a bead mill to form a composite material.
Item GG833. A method for preparing a composite material, said method comprising providing a nanotube and polychlorotrifluoroethylene (PCTFE) and using a bead mill to form a composite material.
Item GG834. A method for preparing a composite material, said method comprising providing a nanotube and polyesters and using a bead mill to form a composite material.
Item GG835. A method for preparing a composite material, said method comprising providing a nanotube and polyether ether ketone (PEEK) and using a bead mill to form a composite material.
Item GG836. A method for preparing a composite material, said method comprising providing a nanotube and polyetherketone (PEK) and using a bead mill to form a composite material.
Item GG837. A method for preparing a composite material, said method comprising providing a nanotube and polyethers and using a bead mill to form a composite material.
Item GG838. A method for preparing a composite material, said method comprising providing a nanotube and polyethersulfone (PES) and using a bead mill to form a composite material.
Item GG839. A method for preparing a composite material, said method comprising providing a nanotube and polyethyl acrylate and using a bead mill to form a composite material.
Item GG840. A method for preparing a composite material, said method comprising providing a nanotube and polyethylene—cross-linked and using a bead mill to form a composite material.
Item GG841. A method for preparing a composite material, said method comprising providing a nanotube and polyethylene—high density (HDPE) and using a bead mill to form a composite material.
Item GG842. A method for preparing a composite material, said method comprising providing a nanotube and polyethylene—linear low density (LLDPE) and using a bead mill to form a composite material.
Item GG843. A method for preparing a composite material, said method comprising providing a nanotube and polyethylene—low density (LDPE) and using a bead mill to form a composite material.
Item GG844. A method for preparing a composite material, said method comprising providing a nanotube and polyethylene—medium density (MDPE) and using a bead mill to form a composite material.
Item GG845. A method for preparing a composite material, said method comprising providing a nanotube and polyethylene—ultrahigh molecular weight (UHMWPE) and using a bead mill to form a composite material.
Item GG846. A method for preparing a composite material, said method comprising providing a nanotube and polyethylene—very low density (VLDPE) and using a bead mill to form a composite material.
Item GG847. A method for preparing a composite material, said method comprising providing a nanotube and polyethylene terephthalate (PET) and using a bead mill to form a composite material.
Item GG848. A method for preparing a composite material, said method comprising providing a nanotube and polyethylene (PE) and using a bead mill to form a composite material.
Item GG849. A method for preparing a composite material, said method comprising providing a nanotube and polyglycolide and using a bead mill to form a composite material.
Item GG850. A method for preparing a composite material, said method comprising providing a nanotube and polyhexamethylene adipamide (PA 6,6) and using a bead mill to form a composite material.
Item GG851. A method for preparing a composite material, said method comprising providing a nanotube and polyimides and using a bead mill to form a composite material.
Item GG852. A method for preparing a composite material, said method comprising providing a nanotube and polyisoprene (natural rubber, NR; isoprene rubber, IR) and using a bead mill to form a composite material.
Item GG853. A method for preparing a composite material, said method comprising providing a nanotube and polylactic acid (PLA) and using a bead mill to form a composite material.
Item GG854. A method for preparing a composite material, said method comprising providing a nanotube and polymethyl acrylate and using a bead mill to form a composite material.
Item GG855. A method for preparing a composite material, said method comprising providing a nanotube and polymethyl methacrylate (PMMA) and using a bead mill to form a composite material.
Item GG856. A method for preparing a composite material, said method comprising providing a nanotube and polyphenylene oxide (PPO) and using a bead mill to form a composite material.
Item GG857. A method for preparing a composite material, said method comprising providing a nanotube and polyphenylene sulfide (PPS) and using a bead mill to form a composite material.
Item GG858. A method for preparing a composite material, said method comprising providing a nanotube and poly-p-phenylene-2,6-benzobisoxazole (PBO) and using a bead mill to form a composite material.
Item GG859. A method for preparing a composite material, said method comprising providing a nanotube and polypropylene (PP) and using a bead mill to form a composite material.
Item GG860. A method for preparing a composite material, said method comprising providing a nanotube and polysiloxanes (silicones) and using a bead mill to form a composite material.
Item GG861. A method for preparing a composite material, said method comprising providing a nanotube and polystyrene (PS) and using a bead mill to form a composite material.
Item GG862. A method for preparing a composite material, said method comprising providing a nanotube and polysulfide rubber and using a bead mill to form a composite material.
Item GG863. A method for preparing a composite material, said method comprising providing a nanotube and polysulfides and using a bead mill to form a composite material.
Item GG864. A method for preparing a composite material, said method comprising providing a nanotube and polytetrafluoroethylene (PTFE) and using a bead mill to form a composite material.
Item GG865. A method for preparing a composite material, said method comprising providing a nanotube and polytrimethylene terephthalate (PTT) and using a bead mill to form a composite material.
Item GG866. A method for preparing a composite material, said method comprising providing a nanotube and polyurethane and using a bead mill to form a composite material.
Item GG867. A method for preparing a composite material, said method comprising providing a nanotube and polyvinyl acetate (PVAc) and using a bead mill to form a composite material.
Item GG868. A method for preparing a composite material, said method comprising providing a nanotube and polyvinyl chloride (PVC) and using a bead mill to form a composite material.
Item GG869. A method for preparing a composite material, said method comprising providing a nanotube and polyvinyl fluoride (PVF) and using a bead mill to form a composite material.
Item GG870. A method for preparing a composite material, said method comprising providing a nanotube and polyvinylidene chloride (PVDC) and using a bead mill to form a composite material.
Item GG871. A method for preparing a composite material, said method comprising providing a nanotube and polyvinylidene fluoride (PVDF) and using a bead mill to form a composite material.
Item GG872. A method for preparing a composite material, said method comprising providing a nanotube and rayon and using a bead mill to form a composite material.
Item GG873. A method for preparing a composite material, said method comprising providing a nanotube and styrene-acrylonitrile (SAN) and using a bead mill to form a composite material.
Item GG874. A method for preparing a composite material, said method comprising providing a nanotube and styrene-butadiene and using a bead mill to form a composite material.
Item GG875. A method for preparing a composite material, said method comprising providing a nanotube and styrene-isoprene and using a bead mill to form a composite material.
Item GG876. A method for preparing a composite material, said method comprising providing a nanotube and a styrene-maleic anhydride copolymer and using a bead mill to form a composite material.
Item GG877. A method for preparing a composite material, said method comprising providing a nanotube and a thermoplastic polyurethanes (TPU) and using a bead mill to form a composite material.
Item GG878. A method for preparing a composite material, said method comprising providing a nanotube and an unsaturated polyester and using a bead mill to form a composite material.
Item GG879. A method for preparing a composite material, said method comprising providing a nanotube and a urea-formaldehyde polymer and using a bead mill to form a composite material.
Item GG880. A method for preparing a composite material, said method comprising providing a nanotube and a vinyl copolymer and using a bead mill to form a composite material.
Item GG881. A method for preparing a composite material, said method comprising providing a nanotube and an acrylic polymer and using a cone mill to form a composite material.
Item GG882. A method for preparing a composite material, said method comprising providing a nanotube and acrylonitrile-butadiene-styrene (ABS) and using a cone mill to form a composite material.
Item GG883. A method for preparing a composite material, said method comprising providing a nanotube and an aldehyde condensation polymer and using a cone mill to form a composite material.
Item GG884. A method for preparing a composite material, said method comprising providing a nanotube and an aliphatic polyether and using a cone mill to form a composite material.
Item GG885. A method for preparing a composite material, said method comprising providing a nanotube and an alkyds and oil-free coating polyester and using a cone mill to form a composite material.
Item GG886. A method for preparing a composite material, said method comprising providing a nanotube and an aramid and using a cone mill to form a composite material.
Item GG887. A method for preparing a composite material, said method comprising providing a nanotube and butyl rubber and using a cone mill to form a composite material.
Item GG888. A method for preparing a composite material, said method comprising providing a nanotube and cellulose acetate and using a cone mill to form a composite material.
Item GG889. A method for preparing a composite material, said method comprising providing a nanotube and cellulose nitrate and using a cone mill to form a composite material.
Item GG890. A method for preparing a composite material, said method comprising providing a nanotube and a cellulosic and using a cone mill to form a composite material.
Item GG891. A method for preparing a composite material, said method comprising providing a nanotube and a cyanoacrylate polymer and using a cone mill to form a composite material.
Item GG892. A method for preparing a composite material, said method comprising providing a nanotube and a diene polymer and using a cone mill to form a composite material.
Item GG893. A method for preparing a composite material, said method comprising providing a nanotube and an epoxy and using a cone mill to form a composite material.
Item GG894. A method for preparing a composite material, said method comprising providing a nanotube and an ethylene-propylene copolymer and using a cone mill to form a composite material.
Item GG895. A method for preparing a composite material, said method comprising providing a nanotube and a fluoroelastomer and using a cone mill to form a composite material.
Item GG896. A method for preparing a composite material, said method comprising providing a nanotube and a heterochain polymer and using a cone mill to form a composite material.
Item GG897. A method for preparing a composite material, said method comprising providing a nanotube and a melamine-formaldehyde polymer and using a cone mill to form a composite material.
Item GG898. A method for preparing a composite material, said method comprising providing a nanotube and a meta-aramid polymer and using a cone mill to form a composite material.
Item GG899. A method for preparing a composite material, said method comprising providing a nanotube and nitrile rubber and using a cone mill to form a composite material.
Item GG900. A method for preparing a composite material, said method comprising providing a nanotube and nylon and using a cone mill to form a composite material.
Item GG901. A method for preparing a composite material, said method comprising providing a nanotube and a para-aramid and using a cone mill to form a composite material.
Item GG902. A method for preparing a composite material, said method comprising providing a nanotube and poly 2-hydroxyethyl methacrylate (HEMA) and using a cone mill to form a composite material.
Item GG903. A method for preparing a composite material, said method comprising providing a nanotube and poly bisphenol A carbonate (PC) and using a cone mill to form a composite material.
Item GG904. A method for preparing a composite material, said method comprising providing a nanotube and poly butylene terephthalate (PBT) and using a cone mill to form a composite material.
Item GG905. A method for preparing a composite material, said method comprising providing a nanotube and poly dimethylsiloxane (PDMS) and using a cone mill to form a composite material.
Item GG906. A method for preparing a composite material, said method comprising providing a nanotube and poly dodecano-12-lactam (Nylon 12) and using a cone mill to form a composite material.
Item GG907. A method for preparing a composite material, said method comprising providing a nanotube and poly ether ketone ketone (PEKK) and using a cone mill to form a composite material.
Item GG908. A method for preparing a composite material, said method comprising providing a nanotube and poly ethylene terephthalate (PET) and using a cone mill to form a composite material.
Item GG909. A method for preparing a composite material, said method comprising providing a nanotube and poly methyl acrylate (PMA) and using a cone mill to form a composite material.
Item GG910. A method for preparing a composite material, said method comprising providing a nanotube and poly methyl methacrylate (PMMA) and using a cone mill to form a composite material.
Item GG911. A method for preparing a composite material, said method comprising providing a nanotube and poly vinyl acetate (PVA) and using a cone mill to form a composite material.
Item GG912. A method for preparing a composite material, said method comprising providing a nanotube and poly vinyl chloride (PVC) and using a cone mill to form a composite material.
Item GG913. A method for preparing a composite material, said method comprising providing a nanotube and poly vinylidene chloride (PVDC) and using a cone mill to form a composite material.
Item GG914. A method for preparing a composite material, said method comprising providing a nanotube and poly vinylidene fluoride (PVDF) and using a cone mill to form a composite material.
Item GG915. A method for preparing a composite material, said method comprising providing a nanotube and poly(acrylic acid) and using a cone mill to form a composite material.
Item GG916. A method for preparing a composite material, said method comprising providing a nanotube and poly(Bisphenol A isophthalate) and using a cone mill to form a composite material.
Item GG917. A method for preparing a composite material, said method comprising providing a nanotube and poly(Bisphenol A terephthalate) and using a cone mill to form a composite material.
Item GG918. A method for preparing a composite material, said method comprising providing a nanotube and poly(butyl acrylate) and using a cone mill to form a composite material.
Item GG919. A method for preparing a composite material, said method comprising providing a nanotube and poly(butyl methacrylate) and using a cone mill to form a composite material.
Item GG920. A method for preparing a composite material, said method comprising providing a nanotube and poly(butylene) and using a cone mill to form a composite material.
Item GG921. A method for preparing a composite material, said method comprising providing a nanotube and poly(caprolactone) and using a cone mill to form a composite material.
Item GG922. A method for preparing a composite material, said method comprising providing a nanotube and poly(chlorotrifluoroethylene) and using a cone mill to form a composite material.
Item GG923. A method for preparing a composite material, said method comprising providing a nanotube and poly(cyclohexyl methacrylate) and using a cone mill to form a composite material.
Item GG924. A method for preparing a composite material, said method comprising providing a nanotube and poly(ethyl acrylate) and using a cone mill to form a composite material.
Item GG925. A method for preparing a composite material, said method comprising providing a nanotube and poly(ethylene glycol) and using a cone mill to form a composite material.
Item GG926. A method for preparing a composite material, said method comprising providing a nanotube and poly(ethylene naphthalate) and using a cone mill to form a composite material.
Item GG927. A method for preparing a composite material, said method comprising providing a nanotube and poly(isobutylene) and using a cone mill to form a composite material.
Item GG928. A method for preparing a composite material, said method comprising providing a nanotube and poly(phenylsulfone) and using a cone mill to form a composite material.
Item GG929. A method for preparing a composite material, said method comprising providing a nanotube and poly(propylene glycol) and using a cone mill to form a composite material.
Item GG930. A method for preparing a composite material, said method comprising providing a nanotube and poly(tetrahydrofuran) and using a cone mill to form a composite material.
Item GG931. A method for preparing a composite material, said method comprising providing a nanotube and poly(α-methylstyrene) and using a cone mill to form a composite material.
Item GG932. A method for preparing a composite material, said method comprising providing a nanotube and polyacetal and using a cone mill to form a composite material.
Item GG933. A method for preparing a composite material, said method comprising providing a nanotube and polyacetal (POM) and using a cone mill to form a composite material.
Item GG934. A method for preparing a composite material, said method comprising providing a nanotube and polyacrylate elastomers and using a cone mill to form a composite material.
Item GG935. A method for preparing a composite material, said method comprising providing a nanotube and polyacrylonitrile (PAN) and using a cone mill to form a composite material.
Item GG936. A method for preparing a composite material, said method comprising providing a nanotube and polyamide and using a cone mill to form a composite material.
Item GG937. A method for preparing a composite material, said method comprising providing a nanotube and polybutadiene (PBD) and using a cone mill to form a composite material.
Item GG938. A method for preparing a composite material, said method comprising providing a nanotube and polybutadiene (butadiene rubber, BR) and using a cone mill to form a composite material.
Item GG939. A method for preparing a composite material, said method comprising providing a nanotube and polybutylene terephthalate (PBT) and using a cone mill to form a composite material.
Item GG940. A method for preparing a composite material, said method comprising providing a nanotube and polycaprolactam and using a cone mill to form a composite material.
Item GG941. A method for preparing a composite material, said method comprising providing a nanotube and polycarbonate (PC) and using a cone mill to form a composite material.
Item GG942. A method for preparing a composite material, said method comprising providing a nanotube and polychloroprene and using a cone mill to form a composite material.
Item GG943. A method for preparing a composite material, said method comprising providing a nanotube and polychlorotrifluoroethylene (PCTFE) and using a cone mill to form a composite material.
Item GG944. A method for preparing a composite material, said method comprising providing a nanotube and polyesters and using a cone mill to form a composite material.
Item GG945. A method for preparing a composite material, said method comprising providing a nanotube and polyether ether ketone (PEEK) and using a cone mill to form a composite material.
Item GG946. A method for preparing a composite material, said method comprising providing a nanotube and polyetherketone (PEK) and using a cone mill to form a composite material.
Item GG947. A method for preparing a composite material, said method comprising providing a nanotube and polyethers and using a cone mill to form a composite material.
Item GG948. A method for preparing a composite material, said method comprising providing a nanotube and polyethersulfone (PES) and using a cone mill to form a composite material.
Item GG949. A method for preparing a composite material, said method comprising providing a nanotube and polyethyl acrylate and using a cone mill to form a composite material.
Item GG950. A method for preparing a composite material, said method comprising providing a nanotube and polyethylene—cross-linked and using a cone mill to form a composite material.
Item GG951. A method for preparing a composite material, said method comprising providing a nanotube and polyethylene—high density (HDPE) and using a cone mill to form a composite material.
Item GG952. A method for preparing a composite material, said method comprising providing a nanotube and polyethylene—linear low density (LLDPE) and using a cone mill to form a composite material.
Item GG953. A method for preparing a composite material, said method comprising providing a nanotube and polyethylene—low density (LDPE) and using a cone mill to form a composite material.
Item GG954. A method for preparing a composite material, said method comprising providing a nanotube and polyethylene—medium density (MDPE) and using a cone mill to form a composite material.
Item GG955. A method for preparing a composite material, said method comprising providing a nanotube and polyethylene—ultrahigh molecular weight (UHMWPE) and using a cone mill to form a composite material.
Item GG956. A method for preparing a composite material, said method comprising providing a nanotube and polyethylene—very low density (VLDPE) and using a cone mill to form a composite material.
Item GG957. A method for preparing a composite material, said method comprising providing a nanotube and polyethylene terephthalate (PET) and using a cone mill to form a composite material.
Item GG958. A method for preparing a composite material, said method comprising providing a nanotube and polyethylene (PE) and using a cone mill to form a composite material.
Item GG959. A method for preparing a composite material, said method comprising providing a nanotube and polyglycolide and using a cone mill to form a composite material.
Item GG960. A method for preparing a composite material, said method comprising providing a nanotube and polyhexamethylene adipamide (PA 6,6) and using a cone mill to form a composite material.
Item GG961. A method for preparing a composite material, said method comprising providing a nanotube and polyimides and using a cone mill to form a composite material.
Item GG962. A method for preparing a composite material, said method comprising providing a nanotube and polyisoprene (natural rubber, NR; isoprene rubber, IR) and using a cone mill to form a composite material.
Item GG963. A method for preparing a composite material, said method comprising providing a nanotube and polylactic acid (PLA) and using a cone mill to form a composite material.
Item GG964. A method for preparing a composite material, said method comprising providing a nanotube and polymethyl acrylate and using a cone mill to form a composite material.
Item GG965. A method for preparing a composite material, said method comprising providing a nanotube and polymethyl methacrylate (PMMA) and using a cone mill to form a composite material.
Item GG966. A method for preparing a composite material, said method comprising providing a nanotube and polyphenylene oxide (PPO) and using a cone mill to form a composite material.
Item GG967. A method for preparing a composite material, said method comprising providing a nanotube and polyphenylene sulfide (PPS) and using a cone mill to form a composite material.
Item GG968. A method for preparing a composite material, said method comprising providing a nanotube and poly-p-phenylene-2,6-benzobisoxazole (PBO) and using a cone mill to form a composite material.
Item GG969. A method for preparing a composite material, said method comprising providing a nanotube and polypropylene (PP) and using a cone mill to form a composite material.
Item GG970. A method for preparing a composite material, said method comprising providing a nanotube and polysiloxanes (silicones) and using a cone mill to form a composite material.
Item GG971. A method for preparing a composite material, said method comprising providing a nanotube and polystyrene (PS) and using a cone mill to form a composite material.
Item GG972. A method for preparing a composite material, said method comprising providing a nanotube and polysulfide rubber and using a cone mill to form a composite material.
Item GG973. A method for preparing a composite material, said method comprising providing a nanotube and polysulfides and using a cone mill to form a composite material.
Item GG974. A method for preparing a composite material, said method comprising providing a nanotube and polytetrafluoroethylene (PTFE) and using a cone mill to form a composite material.
Item GG975. A method for preparing a composite material, said method comprising providing a nanotube and polytrimethylene terephthalate (PTT) and using a cone mill to form a composite material.
Item GG976. A method for preparing a composite material, said method comprising providing a nanotube and polyurethane and using a cone mill to form a composite material.
Item GG977. A method for preparing a composite material, said method comprising providing a nanotube and polyvinyl acetate (PVAc) and using a cone mill to form a composite material.
Item GG978. A method for preparing a composite material, said method comprising providing a nanotube and polyvinyl chloride (PVC) and using a cone mill to form a composite material.
Item GG979. A method for preparing a composite material, said method comprising providing a nanotube and polyvinyl fluoride (PVF) and using a cone mill to form a composite material.
Item GG980. A method for preparing a composite material, said method comprising providing a nanotube and polyvinylidene chloride (PVDC) and using a cone mill to form a composite material.
Item GG981. A method for preparing a composite material, said method comprising providing a nanotube and polyvinylidene fluoride (PVDF) and using a cone mill to form a composite material.
Item GG982. A method for preparing a composite material, said method comprising providing a nanotube and rayon and using a cone mill to form a composite material.
Item GG983. A method for preparing a composite material, said method comprising providing a nanotube and styrene-acrylonitrile (SAN) and using a cone mill to form a composite material.
Item GG984. A method for preparing a composite material, said method comprising providing a nanotube and styrene-butadiene and using a cone mill to form a composite material.
Item GG985. A method for preparing a composite material, said method comprising providing a nanotube and styrene-isoprene and using a cone mill to form a composite material.
Item GG986. A method for preparing a composite material, said method comprising providing a nanotube and a styrene-maleic anhydride copolymer and using a cone mill to form a composite material.
Item GG987. A method for preparing a composite material, said method comprising providing a nanotube and a thermoplastic polyurethanes (TPU) and using a cone mill to form a composite material.
Item GG988. A method for preparing a composite material, said method comprising providing a nanotube and an unsaturated polyester and using a cone mill to form a composite material.
Item GG989. A method for preparing a composite material, said method comprising providing a nanotube and a urea-formaldehyde polymer and using a cone mill to form a composite material.
Item GG990. A method for preparing a composite material, said method comprising providing a nanotube and a vinyl copolymer and using a cone mill to form a composite material.
Item GG991. A method for preparing a composite material, said method comprising providing a nanotube and an acrylic polymer and using a cryogenic mill to form a composite material.
Item GG992. A method for preparing a composite material, said method comprising providing a nanotube and acrylonitrile-butadiene-styrene (ABS) and using a cryogenic mill to form a composite material.
Item GG993. A method for preparing a composite material, said method comprising providing a nanotube and an aldehyde condensation polymer and using a cryogenic mill to form a composite material.
Item GG994. A method for preparing a composite material, said method comprising providing a nanotube and an aliphatic polyether and using a cryogenic mill to form a composite material.
Item GG995. A method for preparing a composite material, said method comprising providing a nanotube and an alkyds and oil-free coating polyester and using a cryogenic mill to form a composite material.
Item GG996. A method for preparing a composite material, said method comprising providing a nanotube and an aramid and using a cryogenic mill to form a composite material.
Item GG997. A method for preparing a composite material, said method comprising providing a nanotube and butyl rubber and using a cryogenic mill to form a composite material.
Item GG998. A method for preparing a composite material, said method comprising providing a nanotube and cellulose acetate and using a cryogenic mill to form a composite material.
Item GG999. A method for preparing a composite material, said method comprising providing a nanotube and cellulose nitrate and using a cryogenic mill to form a composite material.
Item GG1000. A method for preparing a composite material, said method comprising providing a nanotube and a cellulosic and using a cryogenic mill to form a composite material.
Item GG1001. A method for preparing a composite material, said method comprising providing a nanotube and a cyanoacrylate polymer and using a cryogenic mill to form a composite material.
Item GG1002. A method for preparing a composite material, said method comprising providing a nanotube and a diene polymer and using a cryogenic mill to form a composite material.
Item GG1003. A method for preparing a composite material, said method comprising providing a nanotube and an epoxy and using a cryogenic mill to form a composite material.
Item GG1004. A method for preparing a composite material, said method comprising providing a nanotube and an ethylene-propylene copolymer and using a cryogenic mill to form a composite material.
Item GG1005. A method for preparing a composite material, said method comprising providing a nanotube and a fluoroelastomer and using a cryogenic mill to form a composite material.
Item GG1006. A method for preparing a composite material, said method comprising providing a nanotube and a heterochain polymer and using a cryogenic mill to form a composite material.
Item GG1007. A method for preparing a composite material, said method comprising providing a nanotube and a melamine-formaldehyde polymer and using a cryogenic mill to form a composite material.
Item GG1008. A method for preparing a composite material, said method comprising providing a nanotube and a meta-aramid polymer and using a cryogenic mill to form a composite material.
Item GG1009. A method for preparing a composite material, said method comprising providing a nanotube and nitrile rubber and using a cryogenic mill to form a composite material.
Item GG1010. A method for preparing a composite material, said method comprising providing a nanotube and nylon and using a cryogenic mill to form a composite material.
Item GG1011. A method for preparing a composite material, said method comprising providing a nanotube and a para-aramid and using a cryogenic mill to form a composite material.
Item GG1012. A method for preparing a composite material, said method comprising providing a nanotube and poly 2-hydroxyethyl methacrylate (HEMA) and using a cryogenic mill to form a composite material.
Item GG1013. A method for preparing a composite material, said method comprising providing a nanotube and poly bisphenol A carbonate (PC) and using a cryogenic mill to form a composite material.
Item GG1014. A method for preparing a composite material, said method comprising providing a nanotube and poly butylene terephthalate (PBT) and using a cryogenic mill to form a composite material.
Item GG1015. A method for preparing a composite material, said method comprising providing a nanotube and poly dimethylsiloxane (PDMS) and using a cryogenic mill to form a composite material.
Item GG1016. A method for preparing a composite material, said method comprising providing a nanotube and poly dodecano-12-lactam (Nylon 12) and using a cryogenic mill to form a composite material.
Item GG1017. A method for preparing a composite material, said method comprising providing a nanotube and poly ether ketone ketone (PEKK) and using a cryogenic mill to
Item GG1018. A method for preparing a composite material, said method comprising providing a nanotube and poly ethylene terephthalate (PET) and using a cryogenic mill to form a composite material.
Item GG1019. A method for preparing a composite material, said method comprising providing a nanotube and poly methyl acrylate (PMA) and using a cryogenic mill to form a composite material.
Item GG1020. A method for preparing a composite material, said method comprising providing a nanotube and poly methyl methacrylate (PMMA) and using a cryogenic mill to form a composite material.
Item GG1021. A method for preparing a composite material, said method comprising providing a nanotube and poly vinyl acetate (PVA) and using a cryogenic mill to form a composite material.
Item GG1022. A method for preparing a composite material, said method comprising providing a nanotube and poly vinyl chloride (PVC) and using a cryogenic mill to form a composite material.
Item GG1023. A method for preparing a composite material, said method comprising providing a nanotube and poly vinylidene chloride (PVDC) and using a cryogenic mill to form a composite material.
Item GG1024. A method for preparing a composite material, said method comprising providing a nanotube and poly vinylidene fluoride (PVDF) and using a cryogenic mill to form a composite material.
Item GG1025. A method for preparing a composite material, said method comprising providing a nanotube and poly(acrylic acid) and using a cryogenic mill to form a composite material.
Item GG1026. A method for preparing a composite material, said method comprising providing a nanotube and poly(Bisphenol A isophthalate) and using a cryogenic mill to form a composite material.
Item GG1027. A method for preparing a composite material, said method comprising providing a nanotube and poly(Bisphenol A terephthalate) and using a cryogenic mill to form a composite material.
Item GG1028. A method for preparing a composite material, said method comprising providing a nanotube and poly(butyl acrylate) and using a cryogenic mill to form a composite material.
Item GG1029. A method for preparing a composite material, said method comprising providing a nanotube and poly(butyl methacrylate) and using a cryogenic mill to form a composite material.
Item GG1030. A method for preparing a composite material, said method comprising providing a nanotube and poly(butylene) and using a cryogenic mill to form a composite material.
Item GG1031. A method for preparing a composite material, said method comprising providing a nanotube and poly(caprolactone) and using a cryogenic mill to form a composite material.
Item GG1032. A method for preparing a composite material, said method comprising providing a nanotube and poly(chlorotrifluoroethylene) and using a cryogenic mill to form a composite material.
Item GG1033. A method for preparing a composite material, said method comprising providing a nanotube and poly(cyclohexyl methacrylate) and using a cryogenic mill to form a composite material.
Item GG1034. A method for preparing a composite material, said method comprising providing a nanotube and poly(ethyl acrylate) and using a cryogenic mill to form a composite material.
Item GG1035. A method for preparing a composite material, said method comprising providing a nanotube and poly(ethylene glycol) and using a cryogenic mill to form a composite material.
Item GG1036. A method for preparing a composite material, said method comprising providing a nanotube and poly(ethylene naphthalate) and using a cryogenic mill to form a composite material.
Item GG1037. A method for preparing a composite material, said method comprising providing a nanotube and poly(isobutylene) and using a cryogenic mill to form a composite material.
Item GG1038. A method for preparing a composite material, said method comprising providing a nanotube and poly(phenylsulfone) and using a cryogenic mill to form a composite material.
Item GG1039. A method for preparing a composite material, said method comprising providing a nanotube and poly(propylene glycol) and using a cryogenic mill to form a composite material.
Item GG1040. A method for preparing a composite material, said method comprising providing a nanotube and poly(tetrahydrofuran) and using a cryogenic mill to form a composite material.
Item GG1041. A method for preparing a composite material, said method comprising providing a nanotube and poly(α-methylstyrene) and using a cryogenic mill to form a composite material.
Item GG1042. A method for preparing a composite material, said method comprising providing a nanotube and polyacetal and using a cryogenic mill to form a composite material.
Item GG1043. A method for preparing a composite material, said method comprising providing a nanotube and polyacetal (POM) and using a cryogenic mill to form a composite material.
Item GG1044. A method for preparing a composite material, said method comprising providing a nanotube and polyacrylate elastomers and using a cryogenic mill to form a composite material.
Item GG1045. A method for preparing a composite material, said method comprising providing a nanotube and polyacrylonitrile (PAN) and using a cryogenic mill to form a composite material.
Item GG1046. A method for preparing a composite material, said method comprising providing a nanotube and polyamide and using a cryogenic mill to form a composite material.
Item GG1047. A method for preparing a composite material, said method comprising providing a nanotube and polybutadiene (PBD) and using a cryogenic mill to form a composite material.
Item GG1048. A method for preparing a composite material, said method comprising providing a nanotube and polybutadiene (butadiene rubber, BR) and using a cryogenic mill to form a composite material.
Item GG1049. A method for preparing a composite material, said method comprising providing a nanotube and polybutylene terephthalate (PBT) and using a cryogenic mill to form a composite material.
Item GG1050. A method for preparing a composite material, said method comprising providing a nanotube and polycaprolactam and using a cryogenic mill to form a composite material.
Item GG1051. A method for preparing a composite material, said method comprising providing a nanotube and polycarbonate (PC) and using a cryogenic mill to form a composite material.
Item GG1052. A method for preparing a composite material, said method comprising providing a nanotube and polychloroprene and using a cryogenic mill to form a composite material.
Item GG1053. A method for preparing a composite material, said method comprising providing a nanotube and polychlorotrifluoroethylene (PCTFE) and using a cryogenic mill to form a composite material.
Item GG1054. A method for preparing a composite material, said method comprising providing a nanotube and polyesters and using a cryogenic mill to form a composite material.
Item GG1055. A method for preparing a composite material, said method comprising providing a nanotube and polyether ether ketone (PEEK) and using a cryogenic mill to form a composite material.
Item GG1056. A method for preparing a composite material, said method comprising providing a nanotube and polyetherketone (PEK) and using a cryogenic mill to form a composite material.
Item GG1057. A method for preparing a composite material, said method comprising providing a nanotube and polyethers and using a cryogenic mill to form a composite material.
Item GG1058. A method for preparing a composite material, said method comprising providing a nanotube and polyethersulfone (PES) and using a cryogenic mill to form a composite material.
Item GG1059. A method for preparing a composite material, said method comprising providing a nanotube and polyethyl acrylate and using a cryogenic mill to form a composite material.
Item GG1060. A method for preparing a composite material, said method comprising providing a nanotube and polyethylene—cross-linked and using a cryogenic mill to form a composite material.
Item GG1061. A method for preparing a composite material, said method comprising providing a nanotube and polyethylene—high density (HDPE) and using a cryogenic mill to form a composite material.
Item GG1062. A method for preparing a composite material, said method comprising providing a nanotube and polyethylene—linear low density (LLDPE) and using a cryogenic mill to form a composite material.
Item GG1063. A method for preparing a composite material, said method comprising providing a nanotube and polyethylene—low density (LDPE) and using a cryogenic mill to form a composite material.
Item GG1064. A method for preparing a composite material, said method comprising providing a nanotube and polyethylene—medium density (MDPE) and using a cryogenic mill to form a composite material.
Item GG1065. A method for preparing a composite material, said method comprising providing a nanotube and polyethylene—ultrahigh molecular weight (UHMWPE) and using a cryogenic mill to form a composite material.
Item GG1066. A method for preparing a composite material, said method comprising providing a nanotube and polyethylene—very low density (VLDPE) and using a cryogenic mill to form a composite material.
Item GG1067. A method for preparing a composite material, said method comprising providing a nanotube and polyethylene terephthalate (PET) and using a cryogenic mill to form a composite material.
Item GG1068. A method for preparing a composite material, said method comprising providing a nanotube and polyethylene (PE) and using a cryogenic mill to form a composite material.
Item GG1069. A method for preparing a composite material, said method comprising providing a nanotube and polyglycolide and using a cryogenic mill to form a composite material.
Item GG1070. A method for preparing a composite material, said method comprising providing a nanotube and polyhexamethylene adipamide (PA 6,6) and using a cryogenic mill to form a composite material.
Item GG1071. A method for preparing a composite material, said method comprising providing a nanotube and polyimides and using a cryogenic mill to form a composite material.
Item GG1072. A method for preparing a composite material, said method comprising providing a nanotube and polyisoprene (natural rubber, NR; isoprene rubber, IR) and using a cryogenic mill to form a composite material.
Item GG1073. A method for preparing a composite material, said method comprising providing a nanotube and polylactic acid (PLA) and using a cryogenic mill to form a composite material.
Item GG1074. A method for preparing a composite material, said method comprising providing a nanotube and polymethyl acrylate and using a cryogenic mill to form a composite material.
Item GG1075. A method for preparing a composite material, said method comprising providing a nanotube and polymethyl methacrylate (PMMA) and using a cryogenic mill to form a composite material.
Item GG1076. A method for preparing a composite material, said method comprising providing a nanotube and polyphenylene oxide (PPO) and using a cryogenic mill to form a composite material.
Item GG1077. A method for preparing a composite material, said method comprising providing a nanotube and polyphenylene sulfide (PPS) and using a cryogenic mill to form a composite material.
Item GG1078. A method for preparing a composite material, said method comprising providing a nanotube and poly-p-phenylene-2,6-benzobisoxazole (PBO) and using a cryogenic mill to form a composite material.
Item GG1079. A method for preparing a composite material, said method comprising providing a nanotube and polypropylene (PP) and using a cryogenic mill to form a composite material.
Item GG1080. A method for preparing a composite material, said method comprising providing a nanotube and polysiloxanes (silicones) and using a cryogenic mill to form a composite material.
Item GG1081. A method for preparing a composite material, said method comprising providing a nanotube and polystyrene (PS) and using a cryogenic mill to form a composite material.
Item GG1082. A method for preparing a composite material, said method comprising providing a nanotube and polysulfide rubber and using a cryogenic mill to form a composite material.
Item GG1083. A method for preparing a composite material, said method comprising providing a nanotube and polysulfides and using a cryogenic mill to form a composite material.
Item GG1084. A method for preparing a composite material, said method comprising providing a nanotube and polytetrafluoroethylene (PTFE) and using a cryogenic mill to form a composite material.
Item GG1085. A method for preparing a composite material, said method comprising providing a nanotube and polytrimethylene terephthalate (PTT) and using a cryogenic mill to form a composite material.
Item GG1086. A method for preparing a composite material, said method comprising providing a nanotube and polyurethane and using a cryogenic mill to form a composite material.
Item GG1087. A method for preparing a composite material, said method comprising providing a nanotube and polyvinyl acetate (PVAc) and using a cryogenic mill to form a composite material.
Item GG1088. A method for preparing a composite material, said method comprising providing a nanotube and polyvinyl chloride (PVC) and using a cryogenic mill to form a composite material.
Item GG1089. A method for preparing a composite material, said method comprising providing a nanotube and polyvinyl fluoride (PVF) and using a cryogenic mill to form a composite material.
Item GG1090. A method for preparing a composite material, said method comprising providing a nanotube and polyvinylidene chloride (PVDC) and using a cryogenic mill to form a composite material.
Item GG1091. A method for preparing a composite material, said method comprising providing a nanotube and polyvinylidene fluoride (PVDF) and using a cryogenic mill to form a composite material.
Item GG1092. A method for preparing a composite material, said method comprising providing a nanotube and rayon and using a cryogenic mill to form a composite material.
Item GG1093. A method for preparing a composite material, said method comprising providing a nanotube and styrene-acrylonitrile (SAN) and using a cryogenic mill to form a composite material.
Item GG1094. A method for preparing a composite material, said method comprising providing a nanotube and styrene-butadiene and using a cryogenic mill to form a composite material.
Item GG1095. A method for preparing a composite material, said method comprising providing a nanotube and styrene-isoprene and using a cryogenic mill to form a composite material.
Item GG1096. A method for preparing a composite material, said method comprising providing a nanotube and a styrene-maleic anhydride copolymer and using a cryogenic mill to form a composite material.
Item GG1097. A method for preparing a composite material, said method comprising providing a nanotube and a thermoplastic polyurethanes (TPU) and using a cryogenic mill to form a composite material.
Item GG1098. A method for preparing a composite material, said method comprising providing a nanotube and an unsaturated polyester and using a cryogenic mill to form a composite material.
Item GG1099. A method for preparing a composite material, said method comprising providing a nanotube and a urea-formaldehyde polymer and using a cryogenic mill to form a composite material.
Item GG1100. A method for preparing a composite material, said method comprising providing a nanotube and a vinyl copolymer and using a cryogenic mill to form a composite material.
Item GG1101. A method for preparing a composite material, said method comprising providing a nanotube and an acrylic polymer and using a cylpebs mill to form a composite material.
Item GG1102. A method for preparing a composite material, said method comprising providing a nanotube and acrylonitrile-butadiene-styrene (ABS) and using a cylpebs mill to form a composite material.
Item GG1103. A method for preparing a composite material, said method comprising providing a nanotube and an aldehyde condensation polymer and using a cylpebs mill to form a composite material.
Item GG1104. A method for preparing a composite material, said method comprising providing a nanotube and an aliphatic polyether and using a cylpebs mill to form a composite material.
Item GG1105. A method for preparing a composite material, said method comprising providing a nanotube and an alkyds and oil-free coating polyester and using a cylpebs mill to form a composite material.
Item GG1106. A method for preparing a composite material, said method comprising providing a nanotube and an aramid and using a cylpebs mill to form a composite material.
Item GG1107. A method for preparing a composite material, said method comprising providing a nanotube and butyl rubber and using a cylpebs mill to form a composite material.
Item GG1108. A method for preparing a composite material, said method comprising providing a nanotube and cellulose acetate and using a cylpebs mill to form a composite material.
Item GG1109. A method for preparing a composite material, said method comprising providing a nanotube and cellulose nitrate and using a cylpebs mill to form a composite material.
Item GG1110. A method for preparing a composite material, said method comprising providing a nanotube and a cellulosic and using a cylpebs mill to form a composite material.
Item GG1111. A method for preparing a composite material, said method comprising providing a nanotube and a cyanoacrylate polymer and using a cylpebs mill to form a composite material.
Item GG1112. A method for preparing a composite material, said method comprising providing a nanotube and a diene polymer and using a cylpebs mill to form a composite material.
Item GG1113. A method for preparing a composite material, said method comprising providing a nanotube and an epoxy and using a cylpebs mill to form a composite material.
Item GG1114. A method for preparing a composite material, said method comprising providing a nanotube and an ethylene-propylene copolymer and using a cylpebs mill to form a composite material.
Item GG1115. A method for preparing a composite material, said method comprising providing a nanotube and a fluoroelastomer and using a cylpebs mill to form a composite material.
Item GG1116. A method for preparing a composite material, said method comprising providing a nanotube and a heterochain polymer and using a cylpebs mill to form a composite material.
Item GG1117. A method for preparing a composite material, said method comprising providing a nanotube and a melamine-formaldehyde polymer and using a cylpebs mill to form a composite material.
Item GG1118. A method for preparing a composite material, said method comprising providing a nanotube and a meta-aramid polymer and using a cylpebs mill to form a composite material.
Item GG1119. A method for preparing a composite material, said method comprising providing a nanotube and nitrile rubber and using a cylpebs mill to form a composite material.
Item GG1120. A method for preparing a composite material, said method comprising providing a nanotube and nylon and using a cylpebs mill to form a composite material.
Item GG1121. A method for preparing a composite material, said method comprising providing a nanotube and a para-aramid and using a cylpebs mill to form a composite material.
Item GG1122. A method for preparing a composite material, said method comprising providing a nanotube and poly 2-hydroxyethyl methacrylate (HEMA) and using a cylpebs mill to form a composite material.
Item GG1123. A method for preparing a composite material, said method comprising providing a nanotube and poly bisphenol A carbonate (PC) and using a cylpebs mill to form a composite material.
Item GG1124. A method for preparing a composite material, said method comprising providing a nanotube and poly butylene terephthalate (PBT) and using a cylpebs mill to form a composite material.
Item GG1125. A method for preparing a composite material, said method comprising providing a nanotube and poly dimethylsiloxane (PDMS) and using a cylpebs mill to form a composite material.
Item GG1126. A method for preparing a composite material, said method comprising providing a nanotube and poly dodecano-12-lactam (Nylon 12) and using a cylpebs mill to form a composite material.
Item GG1127. A method for preparing a composite material, said method comprising providing a nanotube and poly ether ketone ketone (PEKK) and using a cylpebs mill to form a composite material.
Item GG1128. A method for preparing a composite material, said method comprising providing a nanotube and poly ethylene terephthalate (PET) and using a cylpebs mill to form a composite material.
Item GG1129. A method for preparing a composite material, said method comprising providing a nanotube and poly methyl acrylate (PMA) and using a cylpebs mill to form a composite material.
Item GG1130. A method for preparing a composite material, said method comprising providing a nanotube and poly methyl methacrylate (PMMA) and using a cylpebs mill to form a composite material.
Item GG1131. A method for preparing a composite material, said method comprising providing a nanotube and poly vinyl acetate (PVA) and using a cylpebs mill to form a composite material.
Item GG1132. A method for preparing a composite material, said method comprising providing a nanotube and poly vinyl chloride (PVC) and using a cylpebs mill to form a composite material.
Item GG1133. A method for preparing a composite material, said method comprising providing a nanotube and poly vinylidene chloride (PVDC) and using a cylpebs mill to form a composite material.
Item GG1134. A method for preparing a composite material, said method comprising providing a nanotube and poly vinylidene fluoride (PVDF) and using a cylpebs mill to form a composite material.
Item GG1135. A method for preparing a composite material, said method comprising providing a nanotube and poly(acrylic acid) and using a cylpebs mill to form a composite material.
Item GG1136. A method for preparing a composite material, said method comprising providing a nanotube and poly(Bisphenol A isophthalate) and using a cylpebs mill to form a composite material.
Item GG1137. A method for preparing a composite material, said method comprising providing a nanotube and poly(Bisphenol A terephthalate) and using a cylpebs mill to form a composite material.
Item GG1138. A method for preparing a composite material, said method comprising providing a nanotube and poly(butyl acrylate) and using a cylpebs mill to form a composite material.
Item GG1139. A method for preparing a composite material, said method comprising providing a nanotube and poly(butyl methacrylate) and using a cylpebs mill to form a composite material.
Item GG1140. A method for preparing a composite material, said method comprising providing a nanotube and poly(butylene) and using a cylpebs mill to form a composite material.
Item GG1141. A method for preparing a composite material, said method comprising providing a nanotube and poly(caprolactone) and using a cylpebs mill to form a composite material.
Item GG1142. A method for preparing a composite material, said method comprising providing a nanotube and poly(chlorotrifluoroethylene) and using a cylpebs mill to form a composite material.
Item GG1143. A method for preparing a composite material, said method comprising providing a nanotube and poly(cyclohexyl methacrylate) and using a cylpebs mill to form a composite material.
Item GG1144. A method for preparing a composite material, said method comprising providing a nanotube and poly(ethyl acrylate) and using a cylpebs mill to form a composite material.
Item GG1145. A method for preparing a composite material, said method comprising providing a nanotube and poly(ethylene glycol) and using a cylpebs mill to form a composite material.
Item GG1146. A method for preparing a composite material, said method comprising providing a nanotube and poly(ethylene naphthalate) and using a cylpebs mill to form a composite material.
Item GG1147. A method for preparing a composite material, said method comprising providing a nanotube and poly(isobutylene) and using a cylpebs mill to form a composite material.
Item GG1148. A method for preparing a composite material, said method comprising providing a nanotube and poly(phenylsulfone) and using a cylpebs mill to form a composite material.
Item GG1149. A method for preparing a composite material, said method comprising providing a nanotube and poly(propylene glycol) and using a cylpebs mill to form a composite material.
Item GG1150. A method for preparing a composite material, said method comprising providing a nanotube and poly(tetrahydrofuran) and using a cylpebs mill to form a composite material.
Item GG1151. A method for preparing a composite material, said method comprising providing a nanotube and poly(α-methylstyrene) and using a cylpebs mill to form a composite material.
Item GG1152. A method for preparing a composite material, said method comprising providing a nanotube and polyacetal and using a cylpebs mill to form a composite material.
Item GG1153. A method for preparing a composite material, said method comprising providing a nanotube and polyacetal (POM) and using a cylpebs mill to form a composite material.
Item GG1154. A method for preparing a composite material, said method comprising providing a nanotube and polyacrylate elastomers and using a cylpebs mill to form a composite material.
Item GG1155. A method for preparing a composite material, said method comprising providing a nanotube and polyacrylonitrile (PAN) and using a cylpebs mill to form a composite material.
Item GG1156. A method for preparing a composite material, said method comprising providing a nanotube and polyamide and using a cylpebs mill to form a composite material.
Item GG1157. A method for preparing a composite material, said method comprising providing a nanotube and polybutadiene (PBD) and using a cylpebs mill to form a composite material.
Item GG1158. A method for preparing a composite material, said method comprising providing a nanotube and polybutadiene (butadiene rubber, BR) and using a cylpebs mill to
Item GG1159. A method for preparing a composite material, said method comprising providing a nanotube and polybutylene terephthalate (PBT) and using a cylpebs mill to form a composite material.
Item GG1160. A method for preparing a composite material, said method comprising providing a nanotube and polycaprolactam and using a cylpebs mill to form a composite material.
Item GG1161. A method for preparing a composite material, said method comprising providing a nanotube and polycarbonate (PC) and using a cylpebs mill to form a composite material.
Item GG1162. A method for preparing a composite material, said method comprising providing a nanotube and polychloroprene and using a cylpebs mill to form a composite material.
Item GG1163. A method for preparing a composite material, said method comprising providing a nanotube and polychlorotrifluoroethylene (PCTFE) and using a cylpebs mill to form a composite material.
Item GG1164. A method for preparing a composite material, said method comprising providing a nanotube and polyesters and using a cylpebs mill to form a composite material.
Item GG1165. A method for preparing a composite material, said method comprising providing a nanotube and polyether ether ketone (PEEK) and using a cylpebs mill to form a composite material.
Item GG1166. A method for preparing a composite material, said method comprising providing a nanotube and polyetherketone (PEK) and using a cylpebs mill to form a composite material.
Item GG1167. A method for preparing a composite material, said method comprising providing a nanotube and polyethers and using a cylpebs mill to form a composite material.
Item GG1168. A method for preparing a composite material, said method comprising providing a nanotube and polyethersulfone (PES) and using a cylpebs mill to form a composite material.
Item GG1169. A method for preparing a composite material, said method comprising providing a nanotube and polyethyl acrylate and using a cylpebs mill to form a composite material.
Item GG1170. A method for preparing a composite material, said method comprising providing a nanotube and polyethylene—cross-linked and using a cylpebs mill to form a composite material.
Item GG1171. A method for preparing a composite material, said method comprising providing a nanotube and polyethylene—high density (HDPE) and using a cylpebs mill to form a composite material.
Item GG1172. A method for preparing a composite material, said method comprising providing a nanotube and polyethylene—linear low density (LLDPE) and using a cylpebs mill to form a composite material.
Item GG1173. A method for preparing a composite material, said method comprising providing a nanotube and polyethylene—low density (LDPE) and using a cylpebs mill to form a composite material.
Item GG1174. A method for preparing a composite material, said method comprising providing a nanotube and polyethylene—medium density (MDPE) and using a cylpebs mill to form a composite material.
Item GG1175. A method for preparing a composite material, said method comprising providing a nanotube and polyethylene—ultrahigh molecular weight (UHMWPE) and using a cylpebs mill to form a composite material.
Item GG1176. A method for preparing a composite material, said method comprising providing a nanotube and polyethylene—very low density (VLDPE) and using a cylpebs mill to form a composite material.
Item GG1177. A method for preparing a composite material, said method comprising providing a nanotube and polyethylene terephthalate (PET) and using a cylpebs mill to form a composite material.
Item GG1178. A method for preparing a composite material, said method comprising providing a nanotube and polyethylene (PE) and using a cylpebs mill to form a composite material.
Item GG1179. A method for preparing a composite material, said method comprising providing a nanotube and polyglycolide and using a cylpebs mill to form a composite material.
Item GG1180. A method for preparing a composite material, said method comprising providing a nanotube and polyhexamethylene adipamide (PA 6,6) and using a cylpebs mill to form a composite material.
Item GG1181. A method for preparing a composite material, said method comprising providing a nanotube and polyimides and using a cylpebs mill to form a composite material.
Item GG1182. A method for preparing a composite material, said method comprising providing a nanotube and polyisoprene (natural rubber, NR; isoprene rubber, IR) and using a cylpebs mill to form a composite material.
Item GG1183. A method for preparing a composite material, said method comprising providing a nanotube and polylactic acid (PLA) and using a cylpebs mill to form a composite material.
Item GG1184. A method for preparing a composite material, said method comprising providing a nanotube and polymethyl acrylate and using a cylpebs mill to form a composite material.
Item GG1185. A method for preparing a composite material, said method comprising providing a nanotube and polymethyl methacrylate (PMMA) and using a cylpebs mill to form a composite material.
Item GG1186. A method for preparing a composite material, said method comprising providing a nanotube and polyphenylene oxide (PPO) and using a cylpebs mill to form a composite material.
Item GG1187. A method for preparing a composite material, said method comprising providing a nanotube and polyphenylene sulfide (PPS) and using a cylpebs mill to form a composite material.
Item GG1188. A method for preparing a composite material, said method comprising providing a nanotube and poly-p-phenylene-2,6-benzobisoxazole (PBO) and using a cylpebs mill to form a composite material.
Item GG1189. A method for preparing a composite material, said method comprising providing a nanotube and polypropylene (PP) and using a cylpebs mill to form a composite material.
Item GG1190. A method for preparing a composite material, said method comprising providing a nanotube and polysiloxanes (silicones) and using a cylpebs mill to form a composite material.
Item GG1191. A method for preparing a composite material, said method comprising providing a nanotube and polystyrene (PS) and using a cylpebs mill to form a composite material.
Item GG1192. A method for preparing a composite material, said method comprising providing a nanotube and polysulfide rubber and using a cylpebs mill to form a composite material.
Item GG1193. A method for preparing a composite material, said method comprising providing a nanotube and polysulfides and using a cylpebs mill to form a composite material.
Item GG1194. A method for preparing a composite material, said method comprising providing a nanotube and polytetrafluoroethylene (PTFE) and using a cylpebs mill to form a composite material.
Item GG1195. A method for preparing a composite material, said method comprising providing a nanotube and polytrimethylene terephthalate (PTT) and using a cylpebs mill to form a composite material.
Item GG1196. A method for preparing a composite material, said method comprising providing a nanotube and polyurethane and using a cylpebs mill to form a composite material.
Item GG1197. A method for preparing a composite material, said method comprising providing a nanotube and polyvinyl acetate (PVAc) and using a cylpebs mill to form a composite material.
Item GG1198. A method for preparing a composite material, said method comprising providing a nanotube and polyvinyl chloride (PVC) and using a cylpebs mill to form a composite material.
Item GG1199. A method for preparing a composite material, said method comprising providing a nanotube and polyvinyl fluoride (PVF) and using a cylpebs mill to form a composite material.
Item GG1200. A method for preparing a composite material, said method comprising providing a nanotube and polyvinylidene chloride (PVDC) and using a cylpebs mill to form a composite material.
Item GG1201. A method for preparing a composite material, said method comprising providing a nanotube and polyvinylidene fluoride (PVDF) and using a cylpebs mill to form a composite material.
Item GG1202. A method for preparing a composite material, said method comprising providing a nanotube and rayon and using a cylpebs mill to form a composite material.
Item GG1203. A method for preparing a composite material, said method comprising providing a nanotube and styrene-acrylonitrile (SAN) and using a cylpebs mill to form a composite material.
Item GG1204. A method for preparing a composite material, said method comprising providing a nanotube and styrene-butadiene and using a cylpebs mill to form a composite material.
Item GG1205. A method for preparing a composite material, said method comprising providing a nanotube and styrene-isoprene and using a cylpebs mill to form a composite material.
Item GG1206. A method for preparing a composite material, said method comprising providing a nanotube and a styrene-maleic anhydride copolymer and using a cylpebs mill to form a composite material.
Item GG1207. A method for preparing a composite material, said method comprising providing a nanotube and a thermoplastic polyurethanes (TPU) and using a cylpebs mill to form a composite material.
Item GG1208. A method for preparing a composite material, said method comprising providing a nanotube and an unsaturated polyester and using a cylpebs mill to form a composite material.
Item GG1209. A method for preparing a composite material, said method comprising providing a nanotube and a urea-formaldehyde polymer and using a cylpebs mill to form a composite material.
Item GG1210. A method for preparing a composite material, said method comprising providing a nanotube and a vinyl copolymer and using a cylpebs mill to form a composite material.
Item GG1211. A method for preparing a composite material, said method comprising providing a nanotube and an acrylic polymer and using a high pressure air jet mill to form a composite material.
Item GG1212. A method for preparing a composite material, said method comprising providing a nanotube and acrylonitrile-butadiene-styrene (ABS) and using a high pressure air jet mill to form a composite material.
Item GG1213. A method for preparing a composite material, said method comprising providing a nanotube and an aldehyde condensation polymer and using a high pressure air jet mill to form a composite material.
Item GG1214. A method for preparing a composite material, said method comprising providing a nanotube and an aliphatic polyether and using a high pressure air jet mill to form a composite material.
Item GG1215. A method for preparing a composite material, said method comprising providing a nanotube and an alkyds and oil-free coating polyester and using a high pressure air jet mill to form a composite material.
Item GG1216. A method for preparing a composite material, said method comprising providing a nanotube and an aramid and using a high pressure air jet mill to form a composite material.
Item GG1217. A method for preparing a composite material, said method comprising providing a nanotube and butyl rubber and using a high pressure air jet mill to form a composite material.
Item GG1218. A method for preparing a composite material, said method comprising providing a nanotube and cellulose acetate and using a high pressure air jet mill to form a composite material.
Item GG1219. A method for preparing a composite material, said method comprising providing a nanotube and cellulose nitrate and using a high pressure air jet mill to form a composite material.
Item GG1220. A method for preparing a composite material, said method comprising providing a nanotube and a cellulosic and using a high pressure air jet mill to form a composite material.
Item GG1221. A method for preparing a composite material, said method comprising providing a nanotube and a cyanoacrylate polymer and using a high pressure air jet mill to form a composite material.
Item GG1222. A method for preparing a composite material, said method comprising providing a nanotube and a diene polymer and using a high pressure air jet mill to form a composite material.
Item GG1223. A method for preparing a composite material, said method comprising providing a nanotube and an epoxy and using a high pressure air jet mill to form a composite material.
Item GG1224. A method for preparing a composite material, said method comprising providing a nanotube and an ethylene-propylene copolymer and using a high pressure air jet mill to form a composite material.
Item GG1225. A method for preparing a composite material, said method comprising providing a nanotube and a fluoroelastomer and using a high pressure air jet mill to form a composite material.
Item GG1226. A method for preparing a composite material, said method comprising providing a nanotube and a heterochain polymer and using a high pressure air jet mill to form a composite material.
Item GG1227. A method for preparing a composite material, said method comprising providing a nanotube and a melamine-formaldehyde polymer and using a high pressure air jet mill to form a composite material.
Item GG1228. A method for preparing a composite material, said method comprising providing a nanotube and a meta-aramid polymer and using a high pressure air jet mill to
Item GG1229. A method for preparing a composite material, said method comprising providing a nanotube and nitrile rubber and using a high pressure air jet mill to form a composite material.
Item GG1230. A method for preparing a composite material, said method comprising providing a nanotube and nylon and using a high pressure air jet mill to form a composite material.
Item GG1231. A method for preparing a composite material, said method comprising providing a nanotube and a para-aramid and using a high pressure air jet mill to form a composite material.
Item GG1232. A method for preparing a composite material, said method comprising providing a nanotube and poly 2-hydroxyethyl methacrylate (HEMA) and using a high pressure air jet mill to form a composite material.
Item GG1233. A method for preparing a composite material, said method comprising providing a nanotube and poly bisphenol A carbonate (PC) and using a high pressure air jet mill to form a composite material.
Item GG1234. A method for preparing a composite material, said method comprising providing a nanotube and poly butylene terephthalate (PBT) and using a high pressure air jet mill to form a composite material.
Item GG1235. A method for preparing a composite material, said method comprising providing a nanotube and poly dimethylsiloxane (PDMS) and using a high pressure air jet mill to form a composite material.
Item GG1236. A method for preparing a composite material, said method comprising providing a nanotube and poly dodecano-12-lactam (Nylon 12) and using a high pressure air jet mill to form a composite material.
Item GG1237. A method for preparing a composite material, said method comprising providing a nanotube and poly ether ketone ketone (PEKK) and using a high pressure air jet mill to form a composite material.
Item GG1238. A method for preparing a composite material, said method comprising providing a nanotube and poly ethylene terephthalate (PET) and using a high pressure air jet mill to form a composite material.
Item GG1239. A method for preparing a composite material, said method comprising providing a nanotube and poly methyl acrylate (PMA) and using a high pressure air jet mill to form a composite material.
Item GG1240. A method for preparing a composite material, said method comprising providing a nanotube and poly methyl methacrylate (PMMA) and using a high pressure air jet mill to form a composite material.
Item GG1241. A method for preparing a composite material, said method comprising providing a nanotube and poly vinyl acetate (PVA) and using a high pressure air jet mill to form a composite material.
Item GG1242. A method for preparing a composite material, said method comprising providing a nanotube and poly vinyl chloride (PVC) and using a high pressure air jet mill to
Item GG1243. A method for preparing a composite material, said method comprising providing a nanotube and poly vinylidene chloride (PVDC) and using a high pressure air jet mill to form a composite material.
Item GG1244. A method for preparing a composite material, said method comprising providing a nanotube and poly vinylidene fluoride (PVDF) and using a high pressure air jet mill to form a composite material.
Item GG1245. A method for preparing a composite material, said method comprising providing a nanotube and poly(acrylic acid) and using a high pressure air jet mill to form a composite material.
Item GG1246. A method for preparing a composite material, said method comprising providing a nanotube and poly(Bisphenol A isophthalate) and using a high pressure air jet mill to form a composite material.
Item GG1247. A method for preparing a composite material, said method comprising providing a nanotube and poly(Bisphenol A terephthalate) and using a high pressure air jet mill to form a composite material.
Item GG1248. A method for preparing a composite material, said method comprising providing a nanotube and poly(butyl acrylate) and using a high pressure air jet mill to form a composite material.
Item GG1249. A method for preparing a composite material, said method comprising providing a nanotube and poly(butyl methacrylate) and using a high pressure air jet mill to form a composite material.
Item GG1250. A method for preparing a composite material, said method comprising providing a nanotube and poly(butylene) and using a high pressure air jet mill to form a composite material.
Item GG1251. A method for preparing a composite material, said method comprising providing a nanotube and poly(caprolactone) and using a high pressure air jet mill to form a composite material.
Item GG1252. A method for preparing a composite material, said method comprising providing a nanotube and poly(chlorotrifluoroethylene) and using a high pressure air jet mill to form a composite material.
Item GG1253. A method for preparing a composite material, said method comprising providing a nanotube and poly(cyclohexyl methacrylate) and using a high pressure air jet mill to form a composite material.
Item GG1254. A method for preparing a composite material, said method comprising providing a nanotube and poly(ethyl acrylate) and using a high pressure airjet mill to form a composite material.
Item GG1255. A method for preparing a composite material, said method comprising providing a nanotube and poly(ethylene glycol) and using a high pressure air jet mill to form a composite material.
Item GG1256. A method for preparing a composite material, said method comprising providing a nanotube and poly(ethylene naphthalate) and using a high pressure air jet mill to
Item GG1257. A method for preparing a composite material, said method comprising providing a nanotube and poly(isobutylene) and using a high pressure air jet mill to form a composite material.
Item GG1258. A method for preparing a composite material, said method comprising providing a nanotube and poly(phenylsulfone) and using a high pressure air jet mill to form a composite material.
Item GG1259. A method for preparing a composite material, said method comprising providing a nanotube and poly(propylene glycol) and using a high pressure air jet mill to form a composite material.
Item GG1260. A method for preparing a composite material, said method comprising providing a nanotube and poly(tetrahydrofuran) and using a high pressure air jet mill to form a composite material.
Item GG1261. A method for preparing a composite material, said method comprising providing a nanotube and poly(α-methylstyrene) and using a high pressure air jet mill to form a composite material.
Item GG1262. A method for preparing a composite material, said method comprising providing a nanotube and polyacetal and using a high pressure air jet mill to form a composite material.
Item GG1263. A method for preparing a composite material, said method comprising providing a nanotube and polyacetal (POM) and using a high pressure air jet mill to form a composite material.
Item GG1264. A method for preparing a composite material, said method comprising providing a nanotube and polyacrylate elastomers and using a high pressure air jet mill to form a composite material.
Item GG1265. A method for preparing a composite material, said method comprising providing a nanotube and polyacrylonitrile (PAN) and using a high pressure air jet mill to form a composite material.
Item GG1266. A method for preparing a composite material, said method comprising providing a nanotube and polyamide and using a high pressure air jet mill to form a composite material.
Item GG1267. A method for preparing a composite material, said method comprising providing a nanotube and polybutadiene (PBD) and using a high pressure air jet mill to form a composite material.
Item GG1268. A method for preparing a composite material, said method comprising providing a nanotube and polybutadiene (butadiene rubber, BR) and using a high pressure air jet mill to form a composite material.
Item GG1269. A method for preparing a composite material, said method comprising providing a nanotube and polybutylene terephthalate (PBT) and using a high pressure air jet mill to form a composite material.
Item GG1270. A method for preparing a composite material, said method comprising providing a nanotube and polycaprolactam and using a high pressure air jet mill to form a composite material.
Item GG1271. A method for preparing a composite material, said method comprising providing a nanotube and polycarbonate (PC) and using a high pressure air jet mill to form a composite material.
Item GG1272. A method for preparing a composite material, said method comprising providing a nanotube and polychloroprene and using a high pressure air jet mill to form a composite material.
Item GG1273. A method for preparing a composite material, said method comprising providing a nanotube and polychlorotrifluoroethylene (PCTFE) and using a high pressure air jet mill to form a composite material.
Item GG1274. A method for preparing a composite material, said method comprising providing a nanotube and polyesters and using a high pressure air jet mill to form a composite material.
Item GG1275. A method for preparing a composite material, said method comprising providing a nanotube and polyether ether ketone (PEEK) and using a high pressure air jet mill to form a composite material.
Item GG1276. A method for preparing a composite material, said method comprising providing a nanotube and polyetherketone (PEK) and using a high pressure air jet mill to form a composite material.
Item GG1277. A method for preparing a composite material, said method comprising providing a nanotube and polyethers and using a high pressure air jet mill to form a composite material.
Item GG1278. A method for preparing a composite material, said method comprising providing a nanotube and polyethersulfone (PES) and using a high pressure air jet mill to form a composite material.
Item GG1279. A method for preparing a composite material, said method comprising providing a nanotube and polyethyl acrylate and using a high pressure air jet mill to form a composite material.
Item GG1280. A method for preparing a composite material, said method comprising providing a nanotube and polyethylene—cross-linked and using a high pressure air jet mill to form a composite material.
Item GG1281. A method for preparing a composite material, said method comprising providing a nanotube and polyethylene—high density (HDPE) and using a high pressure air jet mill to form a composite material.
Item GG1282. A method for preparing a composite material, said method comprising providing a nanotube and polyethylene—linear low density (LLDPE) and using a high pressure air jet mill to form a composite material.
Item GG1283. A method for preparing a composite material, said method comprising providing a nanotube and polyethylene—low density (LDPE) and using a high pressure air jet mill to form a composite material.
Item GG1284. A method for preparing a composite material, said method comprising providing a nanotube and polyethylene—medium density (MDPE) and using a high pressure air jet mill to form a composite material.
Item GG1285. A method for preparing a composite material, said method comprising providing a nanotube and polyethylene—ultrahigh molecular weight (UHMWPE) and using a high pressure air jet mill to form a composite material.
Item GG1286. A method for preparing a composite material, said method comprising providing a nanotube and polyethylene—very low density (VLDPE) and using a high pressure air jet mill to form a composite material.
Item GG1287. A method for preparing a composite material, said method comprising providing a nanotube and polyethylene terephthalate (PET) and using a high pressure air jet mill to form a composite material.
Item GG1288. A method for preparing a composite material, said method comprising providing a nanotube and polyethylene (PE) and using a high pressure air jet mill to form a composite material.
Item GG1289. A method for preparing a composite material, said method comprising providing a nanotube and polyglycolide and using a high pressure air jet mill to form a composite material.
Item GG1290. A method for preparing a composite material, said method comprising providing a nanotube and polyhexamethylene adipamide (PA 6,6) and using a high pressure air jet mill to form a composite material.
Item GG1291. A method for preparing a composite material, said method comprising providing a nanotube and polyimides and using a high pressure air jet mill to form a composite material.
Item GG1292. A method for preparing a composite material, said method comprising providing a nanotube and polyisoprene (natural rubber, NR; isoprene rubber, IR) and using a high pressure air jet mill to form a composite material.
Item GG1293. A method for preparing a composite material, said method comprising providing a nanotube and polylactic acid (PLA) and using a high pressure air jet mill to form a composite material.
Item GG1294. A method for preparing a composite material, said method comprising providing a nanotube and polymethyl acrylate and using a high pressure air jet mill to form a composite material.
Item GG1295. A method for preparing a composite material, said method comprising providing a nanotube and polymethyl methacrylate (PMMA) and using a high pressure air jet mill to form a composite material.
Item GG1296. A method for preparing a composite material, said method comprising providing a nanotube and polyphenylene oxide (PPO) and using a high pressure air jet mill to form a composite material.
Item GG1297. A method for preparing a composite material, said method comprising providing a nanotube and polyphenylene sulfide (PPS) and using a high pressure air jet mill to form a composite material.
Item GG1298. A method for preparing a composite material, said method comprising providing a nanotube and poly-p-phenylene-2,6-benzobisoxazole (PBO) and using a high pressure air jet mill to form a composite material.
Item GG1299. A method for preparing a composite material, said method comprising providing a nanotube and polypropylene (PP) and using a high pressure air jet mill to form a composite material.
Item GG1300. A method for preparing a composite material, said method comprising providing a nanotube and polysiloxanes (silicones) and using a high pressure air jet mill to form a composite material.
Item GG1301. A method for preparing a composite material, said method comprising providing a nanotube and polystyrene (PS) and using a high pressure air jet mill to form a composite material.
Item GG1302. A method for preparing a composite material, said method comprising providing a nanotube and polysulfide rubber and using a high pressure air jet mill to form a composite material.
Item GG1303. A method for preparing a composite material, said method comprising providing a nanotube and polysulfides and using a high pressure air jet mill to form a composite material.
Item GG1304. A method for preparing a composite material, said method comprising providing a nanotube and polytetrafluoroethylene (PTFE) and using a high pressure air jet mill to form a composite material.
Item GG1305. A method for preparing a composite material, said method comprising providing a nanotube and polytrimethylene terephthalate (PTT) and using a high pressure air jet mill to form a composite material.
Item GG1306. A method for preparing a composite material, said method comprising providing a nanotube and polyurethane and using a high pressure air jet mill to form a composite material.
Item GG1307. A method for preparing a composite material, said method comprising providing a nanotube and polyvinyl acetate (PVAc) and using a high pressure air jet mill to form a composite material.
Item GG1308. A method for preparing a composite material, said method comprising providing a nanotube and polyvinyl chloride (PVC) and using a high pressure air jet mill to form a composite material.
Item GG1309. A method for preparing a composite material, said method comprising providing a nanotube and polyvinyl fluoride (PVF) and using a high pressure air jet mill to form a composite material.
Item GG1310. A method for preparing a composite material, said method comprising providing a nanotube and polyvinylidene chloride (PVDC) and using a high pressure air jet mill to form a composite material.
Item GG1311. A method for preparing a composite material, said method comprising providing a nanotube and polyvinylidene fluoride (PVDF) and using a high pressure air jet mill to form a composite material.
Item GG1312. A method for preparing a composite material, said method comprising providing a nanotube and rayon and using a high pressure air jet mill to form a composite material.
Item GG1313. A method for preparing a composite material, said method comprising providing a nanotube and styrene-acrylonitrile (SAN) and using a high pressure air jet mill to form a composite material.
Item GG1314. A method for preparing a composite material, said method comprising providing a nanotube and styrene-butadiene and using a high pressure air jet mill to form a composite material.
Item GG1315. A method for preparing a composite material, said method comprising providing a nanotube and styrene-isoprene and using a high pressure airjet mill to form a composite material.
Item GG1316. A method for preparing a composite material, said method comprising providing a nanotube and a styrene-maleic anhydride copolymer and using a high pressure air jet mill to form a composite material.
Item GG1317. A method for preparing a composite material, said method comprising providing a nanotube and a thermoplastic polyurethanes (TPU) and using a high pressure air jet mill to form a composite material.
Item GG1318. A method for preparing a composite material, said method comprising providing a nanotube and an unsaturated polyester and using a high pressure air jet mill to form a composite material.
Item GG1319. A method for preparing a composite material, said method comprising providing a nanotube and a urea-formaldehyde polymer and using a high pressure air jet mill to form a composite material.
Item GG1320. A method for preparing a composite material, said method comprising providing a nanotube and a vinyl copolymer and using a high pressure air jet mill to form a composite material.
Item GG1321. A method for preparing a composite material, said method comprising providing a nanotube and an acrylic polymer and using a high pressure water jet mill to form a composite material.
Item GG1322. A method for preparing a composite material, said method comprising providing a nanotube and acrylonitrile-butadiene-styrene (ABS) and using a high pressure water jet mill to form a composite material.
Item GG1323. A method for preparing a composite material, said method comprising providing a nanotube and an aldehyde condensation polymer and using a high pressure water jet mill to form a composite material.
Item GG1324. A method for preparing a composite material, said method comprising providing a nanotube and an aliphatic polyether and using a high pressure water jet mill to form a composite material.
Item GG1325. A method for preparing a composite material, said method comprising providing a nanotube and an alkyds and oil-free coating polyester and using a high pressure water jet mill to form a composite material.
Item GG1326. A method for preparing a composite material, said method comprising providing a nanotube and an aramid and using a high pressure water jet mill to form a composite material.
Item GG1327. A method for preparing a composite material, said method comprising providing a nanotube and butyl rubber and using a high pressure water jet mill to form a composite material.
Item GG1328. A method for preparing a composite material, said method comprising providing a nanotube and cellulose acetate and using a high pressure water jet mill to form a composite material.
Item GG1329. A method for preparing a composite material, said method comprising providing a nanotube and cellulose nitrate and using a high pressure water jet mill to form a composite material.
Item GG1330. A method for preparing a composite material, said method comprising providing a nanotube and a cellulosic and using a high pressure water jet mill to form a composite material.
Item GG1331. A method for preparing a composite material, said method comprising providing a nanotube and a cyanoacrylate polymer and using a high pressure water jet mill to form a composite material.
Item GG1332. A method for preparing a composite material, said method comprising providing a nanotube and a diene polymer and using a high pressure water jet mill to form a composite material.
Item GG1333. A method for preparing a composite material, said method comprising providing a nanotube and an epoxy and using a high pressure water jet mill to form a composite material.
Item GG1334. A method for preparing a composite material, said method comprising providing a nanotube and an ethylene-propylene copolymer and using a high pressure water jet mill to form a composite material.
Item GG1335. A method for preparing a composite material, said method comprising providing a nanotube and a fluoroelastomer and using a high pressure water jet mill to form a composite material.
Item GG1336. A method for preparing a composite material, said method comprising providing a nanotube and a heterochain polymer and using a high pressure water jet mill to form a composite material.
Item GG1337. A method for preparing a composite material, said method comprising providing a nanotube and a melamine-formaldehyde polymer and using a high pressure water jet mill to form a composite material.
Item GG1338. A method for preparing a composite material, said method comprising providing a nanotube and a meta-aramid polymer and using a high pressure water jet mill to form a composite material.
Item GG1339. A method for preparing a composite material, said method comprising providing a nanotube and nitrile rubber and using a high pressure water jet mill to form a composite material.
Item GG1340. A method for preparing a composite material, said method comprising providing a nanotube and nylon and using a high pressure water jet mill to form a composite material.
Item GG1341. A method for preparing a composite material, said method comprising providing a nanotube and a para-aramid and using a high pressure water jet mill to form a composite material.
Item GG1342. A method for preparing a composite material, said method comprising providing a nanotube and poly 2-hydroxyethyl methacrylate (HEMA) and using a high pressure water jet mill to form a composite material.
Item GG1343. A method for preparing a composite material, said method comprising providing a nanotube and poly bisphenol A carbonate (PC) and using a high pressure water jet mill to form a composite material.
Item GG1344. A method for preparing a composite material, said method comprising providing a nanotube and poly butylene terephthalate (PBT) and using a high pressure water jet mill to form a composite material.
Item GG1345. A method for preparing a composite material, said method comprising providing a nanotube and poly dimethylsiloxane (PDMS) and using a high pressure water jet mill to form a composite material.
Item GG1346. A method for preparing a composite material, said method comprising providing a nanotube and poly dodecano-12-lactam (Nylon 12) and using a high pressure water jet mill to form a composite material.
Item GG1347. A method for preparing a composite material, said method comprising providing a nanotube and poly ether ketone ketone (PEKK) and using a high pressure water jet mill to form a composite material.
Item GG1348. A method for preparing a composite material, said method comprising providing a nanotube and poly ethylene terephthalate (PET) and using a high pressure water jet mill to form a composite material.
Item GG1349. A method for preparing a composite material, said method comprising providing a nanotube and poly methyl acrylate (PMA) and using a high pressure water jet mill to form a composite material.
Item GG1350. A method for preparing a composite material, said method comprising providing a nanotube and poly methyl methacrylate (PMMA) and using a high pressure water jet mill to form a composite material.
Item GG1351. A method for preparing a composite material, said method comprising providing a nanotube and poly vinyl acetate (PVA) and using a high pressure water jet mill to form a composite material.
Item GG1352. A method for preparing a composite material, said method comprising providing a nanotube and poly vinyl chloride (PVC) and using a high pressure water jet mill to form a composite material.
Item GG1353. A method for preparing a composite material, said method comprising providing a nanotube and poly vinylidene chloride (PVDC) and using a high pressure water jet mill to form a composite material.
Item GG1354. A method for preparing a composite material, said method comprising providing a nanotube and poly vinylidene fluoride (PVDF) and using a high pressure water jet mill to form a composite material.
Item GG1355. A method for preparing a composite material, said method comprising providing a nanotube and poly(acrylic acid) and using a high pressure water jet mill to form a composite material.
Item GG1356. A method for preparing a composite material, said method comprising providing a nanotube and poly(Bisphenol A isophthalate) and using a high pressure water jet mill to form a composite material.
Item GG1357. A method for preparing a composite material, said method comprising providing a nanotube and poly(Bisphenol A terephthalate) and using a high pressure water jet mill to form a composite material.
Item GG1358. A method for preparing a composite material, said method comprising providing a nanotube and poly(butyl acrylate) and using a high pressure water jet mill to form a composite material.
Item GG1359. A method for preparing a composite material, said method comprising providing a nanotube and poly(butyl methacrylate) and using a high pressure water jet mill to form a composite material.
Item GG1360. A method for preparing a composite material, said method comprising providing a nanotube and poly(butylene) and using a high pressure water jet mill to form a composite material.
Item GG1361. A method for preparing a composite material, said method comprising providing a nanotube and poly(caprolactone) and using a high pressure water jet mill to form a composite material.
Item GG1362. A method for preparing a composite material, said method comprising providing a nanotube and poly(chlorotrifluoroethylene) and using a high pressure water jet mill to form a composite material.
Item GG1363. A method for preparing a composite material, said method comprising providing a nanotube and poly(cyclohexyl methacrylate) and using a high pressure water jet mill to form a composite material.
Item GG1364. A method for preparing a composite material, said method comprising providing a nanotube and poly(ethyl acrylate) and using a high pressure water jet mill to form a composite material.
Item GG1365. A method for preparing a composite material, said method comprising providing a nanotube and poly(ethylene glycol) and using a high pressure water jet mill to form a composite material.
Item GG1366. A method for preparing a composite material, said method comprising providing a nanotube and poly(ethylene naphthalate) and using a high pressure water jet mill to form a composite material.
Item GG1367. A method for preparing a composite material, said method comprising providing a nanotube and poly(isobutylene) and using a high pressure water jet mill to form a composite material.
Item GG1368. A method for preparing a composite material, said method comprising providing a nanotube and poly(phenylsulfone) and using a high pressure water jet mill to form a composite material.
Item GG1369. A method for preparing a composite material, said method comprising providing a nanotube and poly(propylene glycol) and using a high pressure water jet mill to form a composite material.
Item GG1370. A method for preparing a composite material, said method comprising providing a nanotube and poly(tetrahydrofuran) and using a high pressure water jet mill to form a composite material.
Item GG1371. A method for preparing a composite material, said method comprising providing a nanotube and poly(α-methylstyrene) and using a high pressure water jet mill to form a composite material.
Item GG1372. A method for preparing a composite material, said method comprising providing a nanotube and polyacetal and using a high pressure water jet mill to form a composite material.
Item GG1373. A method for preparing a composite material, said method comprising providing a nanotube and polyacetal (POM) and using a high pressure water jet mill to form a composite material.
Item GG1374. A method for preparing a composite material, said method comprising providing a nanotube and polyacrylate elastomers and using a high pressure water jet mill to form a composite material.
Item GG1375. A method for preparing a composite material, said method comprising providing a nanotube and polyacrylonitrile (PAN) and using a high pressure water jet mill to form a composite material.
Item GG1376. A method for preparing a composite material, said method comprising providing a nanotube and polyamide and using a high pressure water jet mill to form a composite material.
Item GG1377. A method for preparing a composite material, said method comprising providing a nanotube and polybutadiene (PBD) and using a high pressure water jet mill to form a composite material.
Item GG1378. A method for preparing a composite material, said method comprising providing a nanotube and polybutadiene (butadiene rubber, BR) and using a high pressure water jet mill to form a composite material.
Item GG1379. A method for preparing a composite material, said method comprising providing a nanotube and polybutylene terephthalate (PBT) and using a high pressure water jet mill to form a composite material.
Item GG1380. A method for preparing a composite material, said method comprising providing a nanotube and polycaprolactam and using a high pressure water jet mill to form a composite material.
Item GG1381. A method for preparing a composite material, said method comprising providing a nanotube and polycarbonate (PC) and using a high pressure water jet mill to form a composite material.
Item GG1382. A method for preparing a composite material, said method comprising providing a nanotube and polychloroprene and using a high pressure water jet mill to form a composite material.
Item GG1383. A method for preparing a composite material, said method comprising providing a nanotube and polychlorotrifluoroethylene (PCTFE) and using a high pressure water jet mill to form a composite material.
Item GG1384. A method for preparing a composite material, said method comprising providing a nanotube and polyesters and using a high pressure water jet mill to form a composite material.
Item GG1385. A method for preparing a composite material, said method comprising providing a nanotube and polyether ether ketone (PEEK) and using a high pressure water jet mill to form a composite material.
Item GG1386. A method for preparing a composite material, said method comprising providing a nanotube and polyetherketone (PEK) and using a high pressure water jet mill to form a composite material.
Item GG1387. A method for preparing a composite material, said method comprising providing a nanotube and polyethers and using a high pressure water jet mill to form a composite material.
Item GG1388. A method for preparing a composite material, said method comprising providing a nanotube and polyethersulfone (PES) and using a high pressure water jet mill to form a composite material.
Item GG1389. A method for preparing a composite material, said method comprising providing a nanotube and polyethyl acrylate and using a high pressure water jet mill to form a composite material.
Item GG1390. A method for preparing a composite material, said method comprising providing a nanotube and polyethylene—cross-linked and using a high pressure water jet mill to form a composite material.
Item GG1391. A method for preparing a composite material, said method comprising providing a nanotube and polyethylene—high density (HDPE) and using a high pressure water jet mill to form a composite material.
Item GG1392. A method for preparing a composite material, said method comprising providing a nanotube and polyethylene—linear low density (LLDPE) and using a high pressure water jet mill to form a composite material.
Item GG1393. A method for preparing a composite material, said method comprising providing a nanotube and polyethylene—low density (LDPE) and using a high pressure water jet mill to form a composite material.
Item GG1394. A method for preparing a composite material, said method comprising providing a nanotube and polyethylene—medium density (MDPE) and using a high pressure water jet mill to form a composite material.
Item GG1395. A method for preparing a composite material, said method comprising providing a nanotube and polyethylene—ultrahigh molecular weight (UHMWPE) and using a high pressure water jet mill to form a composite material.
Item GG1396. A method for preparing a composite material, said method comprising providing a nanotube and polyethylene—very low density (VLDPE) and using a high pressure water jet mill to form a composite material.
Item GG1397. A method for preparing a composite material, said method comprising providing a nanotube and polyethylene terephthalate (PET) and using a high pressure water jet mill to form a composite material.
Item GG1398. A method for preparing a composite material, said method comprising providing a nanotube and polyethylene (PE) and using a high pressure water jet mill to form a composite material.
Item GG1399. A method for preparing a composite material, said method comprising providing a nanotube and polyglycolide and using a high pressure water jet mill to form a composite material.
Item GG1400. A method for preparing a composite material, said method comprising providing a nanotube and polyhexamethylene adipamide (PA 6,6) and using a high pressure water jet mill to form a composite material.
Item GG1401. A method for preparing a composite material, said method comprising providing a nanotube and polyimides and using a high pressure water jet mill to form a composite material.
Item GG1402. A method for preparing a composite material, said method comprising providing a nanotube and polyisoprene (natural rubber, NR; isoprene rubber, IR) and using a high pressure water jet mill to form a composite material.
Item GG1403. A method for preparing a composite material, said method comprising providing a nanotube and polylactic acid (PLA) and using a high pressure water jet mill to form a composite material.
Item GG1404. A method for preparing a composite material, said method comprising providing a nanotube and polymethyl acrylate and using a high pressure water jet mill to form a composite material.
Item GG1405. A method for preparing a composite material, said method comprising providing a nanotube and polymethyl methacrylate (PMMA) and using a high pressure water jet mill to form a composite material.
Item GG1406. A method for preparing a composite material, said method comprising providing a nanotube and polyphenylene oxide (PPO) and using a high pressure water jet mill to form a composite material.
Item GG1407. A method for preparing a composite material, said method comprising providing a nanotube and polyphenylene sulfide (PPS) and using a high pressure water jet mill to form a composite material.
Item GG1408. A method for preparing a composite material, said method comprising providing a nanotube and poly-p-phenylene-2,6-benzobisoxazole (PBO) and using a high pressure water jet mill to form a composite material.
Item GG1409. A method for preparing a composite material, said method comprising providing a nanotube and polypropylene (PP) and using a high pressure water jet mill to form a composite material.
Item GG1410. A method for preparing a composite material, said method comprising providing a nanotube and polysiloxanes (silicones) and using a high pressure water jet mill to form a composite material.
Item GG1411. A method for preparing a composite material, said method comprising providing a nanotube and polystyrene (PS) and using a high pressure water jet mill to form a composite material.
Item GG1412. A method for preparing a composite material, said method comprising providing a nanotube and polysulfide rubber and using a high pressure water jet mill to form a composite material.
Item GG1413. A method for preparing a composite material, said method comprising providing a nanotube and polysulfides and using a high pressure water jet mill to form a composite material.
Item GG1414. A method for preparing a composite material, said method comprising providing a nanotube and polytetrafluoroethylene (PTFE) and using a high pressure water jet mill to form a composite material.
Item GG1415. A method for preparing a composite material, said method comprising providing a nanotube and polytrimethylene terephthalate (PTT) and using a high pressure water jet mill to form a composite material.
Item GG1416. A method for preparing a composite material, said method comprising providing a nanotube and polyurethane and using a high pressure water jet mill to form a composite material.
Item GG1417. A method for preparing a composite material, said method comprising providing a nanotube and polyvinyl acetate (PVAc) and using a high pressure water jet mill to form a composite material.
Item GG1418. A method for preparing a composite material, said method comprising providing a nanotube and polyvinyl chloride (PVC) and using a high pressure water jet mill to form a composite material.
Item GG1419. A method for preparing a composite material, said method comprising providing a nanotube and polyvinyl fluoride (PVF) and using a high pressure water jet mill to form a composite material.
Item GG1420. A method for preparing a composite material, said method comprising providing a nanotube and polyvinylidene chloride (PVDC) and using a high pressure water jet mill to form a composite material.
Item GG1421. A method for preparing a composite material, said method comprising providing a nanotube and polyvinylidene fluoride (PVDF) and using a high pressure water jet mill to form a composite material.
Item GG1422. A method for preparing a composite material, said method comprising providing a nanotube and rayon and using a high pressure water jet mill to form a composite material.
Item GG1423. A method for preparing a composite material, said method comprising providing a nanotube and styrene-acrylonitrile (SAN) and using a high pressure water jet mill to form a composite material.
Item GG1424. A method for preparing a composite material, said method comprising providing a nanotube and styrene-butadiene and using a high pressure water jet mill to form a composite material.
Item GG1425. A method for preparing a composite material, said method comprising providing a nanotube and styrene-isoprene and using a high pressure water jet mill to form a composite material.
Item GG1426. A method for preparing a composite material, said method comprising providing a nanotube and a styrene-maleic anhydride copolymer and using a high pressure water jet mill to form a composite material.
Item GG1427. A method for preparing a composite material, said method comprising providing a nanotube and a thermoplastic polyurethanes (TPU) and using a high pressure water jet mill to form a composite material.
Item GG1428. A method for preparing a composite material, said method comprising providing a nanotube and an unsaturated polyester and using a high pressure water jet mill to form a composite material.
Item GG1429. A method for preparing a composite material, said method comprising providing a nanotube and a urea-formaldehyde polymer and using a high pressure water jet mill to form a composite material.
Item GG1430. A method for preparing a composite material, said method comprising providing a nanotube and a vinyl copolymer and using a high pressure water jet mill to form a composite material.
Item GG1431. A method for preparing a composite material, said method comprising providing a nanotube and an acrylic polymer and using a high shear batch disperser to form a composite material.
Item GG1432. A method for preparing a composite material, said method comprising providing a nanotube and acrylonitrile-butadiene-styrene (ABS) and using a high shear batch disperser to form a composite material.
Item GG1433. A method for preparing a composite material, said method comprising providing a nanotube and an aldehyde condensation polymer and using a high shear batch disperser to form a composite material.
Item GG1434. A method for preparing a composite material, said method comprising providing a nanotube and an aliphatic polyether and using a high shear batch disperser to form a composite material.
Item GG1435. A method for preparing a composite material, said method comprising providing a nanotube and an alkyds and oil-free coating polyester and using a high shear batch disperser to form a composite material.
Item GG1436. A method for preparing a composite material, said method comprising providing a nanotube and an aramid and using a high shear batch disperser to form a composite material.
Item GG1437. A method for preparing a composite material, said method comprising providing a nanotube and butyl rubber and using a high shear batch disperser to form a composite material.
Item GG1438. A method for preparing a composite material, said method comprising providing a nanotube and cellulose acetate and using a high shear batch disperser to form a composite material.
Item GG1439. A method for preparing a composite material, said method comprising providing a nanotube and cellulose nitrate and using a high shear batch disperser to form a composite material.
Item GG1440. A method for preparing a composite material, said method comprising providing a nanotube and a cellulosic and using a high shear batch disperser to form a composite material.
Item GG1441. A method for preparing a composite material, said method comprising providing a nanotube and a cyanoacrylate polymer and using a high shear batch disperser to form a composite material.
Item GG1442. A method for preparing a composite material, said method comprising providing a nanotube and a diene polymer and using a high shear batch disperser to form a composite material.
Item GG1443. A method for preparing a composite material, said method comprising providing a nanotube and an epoxy and using a high shear batch disperser to form a composite material.
Item GG1444. A method for preparing a composite material, said method comprising providing a nanotube and an ethylene-propylene copolymer and using a high shear batch disperser to form a composite material.
Item GG1445. A method for preparing a composite material, said method comprising providing a nanotube and a fluoroelastomer and using a high shear batch disperser to form a composite material.
Item GG1446. A method for preparing a composite material, said method comprising providing a nanotube and a heterochain polymer and using a high shear batch disperser to form a composite material.
Item GG1447. A method for preparing a composite material, said method comprising providing a nanotube and a melamine-formaldehyde polymer and using a high shear batch disperser to form a composite material.
Item GG1448. A method for preparing a composite material, said method comprising providing a nanotube and a meta-aramid polymer and using a high shear batch disperser to form a composite material.
Item GG1449. A method for preparing a composite material, said method comprising providing a nanotube and nitrile rubber and using a high shear batch disperser to form a composite material.
Item GG1450. A method for preparing a composite material, said method comprising providing a nanotube and nylon and using a high shear batch disperser to form a composite material.
Item GG1451. A method for preparing a composite material, said method comprising providing a nanotube and a para-aramid and using a high shear batch disperser to form a composite material.
Item GG1452. A method for preparing a composite material, said method comprising providing a nanotube and poly 2-hydroxyethyl methacrylate (HEMA) and using a high shear batch disperser to form a composite material.
Item GG1453. A method for preparing a composite material, said method comprising providing a nanotube and poly bisphenol A carbonate (PC) and using a high shear batch disperser to form a composite material.
Item GG1454. A method for preparing a composite material, said method comprising providing a nanotube and poly butylene terephthalate (PBT) and using a high shear batch disperser to form a composite material.
Item GG1455. A method for preparing a composite material, said method comprising providing a nanotube and poly dimethylsiloxane (PDMS) and using a high shear batch disperser to form a composite material.
Item GG1456. A method for preparing a composite material, said method comprising providing a nanotube and poly dodecano-12-lactam (Nylon 12) and using a high shear batch disperser to form a composite material.
Item GG1457. A method for preparing a composite material, said method comprising providing a nanotube and poly ether ketone ketone (PEKK) and using a high shear batch disperser to form a composite material.
Item GG1458. A method for preparing a composite material, said method comprising providing a nanotube and poly ethylene terephthalate (PET) and using a high shear batch disperser to form a composite material.
Item GG1459. A method for preparing a composite material, said method comprising providing a nanotube and poly methyl acrylate (PMA) and using a high shear batch disperser to form a composite material.
Item GG1460. A method for preparing a composite material, said method comprising providing a nanotube and poly methyl methacrylate (PMMA) and using a high shear batch disperser to form a composite material.
Item GG1461. A method for preparing a composite material, said method comprising providing a nanotube and poly vinyl acetate (PVA) and using a high shear batch disperser to form a composite material.
Item GG1462. A method for preparing a composite material, said method comprising providing a nanotube and poly vinyl chloride (PVC) and using a high shear batch disperser to form a composite material.
Item GG1463. A method for preparing a composite material, said method comprising providing a nanotube and poly vinylidene chloride (PVDC) and using a high shear batch disperser to form a composite material.
Item GG1464. A method for preparing a composite material, said method comprising providing a nanotube and poly vinylidene fluoride (PVDF) and using a high shear batch disperser to form a composite material.
Item GG1465. A method for preparing a composite material, said method comprising providing a nanotube and poly(acrylic acid) and using a high shear batch disperser to form a composite material.
Item GG1466. A method for preparing a composite material, said method comprising providing a nanotube and poly(Bisphenol A isophthalate) and using a high shear batch disperser to form a composite material.
Item GG1467. A method for preparing a composite material, said method comprising providing a nanotube and poly(Bisphenol A terephthalate) and using a high shear batch disperser to form a composite material.
Item GG1468. A method for preparing a composite material, said method comprising providing a nanotube and poly(butyl acrylate) and using a high shear batch disperser to form a composite material.
Item GG1469. A method for preparing a composite material, said method comprising providing a nanotube and poly(butyl methacrylate) and using a high shear batch disperser to form a composite material.
Item GG1470. A method for preparing a composite material, said method comprising providing a nanotube and poly(butylene) and using a high shear batch disperser to form a composite material.
Item GG1471. A method for preparing a composite material, said method comprising providing a nanotube and poly(caprolactone) and using a high shear batch disperser to form a composite material.
Item GG1472. A method for preparing a composite material, said method comprising providing a nanotube and poly(chlorotrifluoroethylene) and using a high shear batch disperser to form a composite material.
Item GG1473. A method for preparing a composite material, said method comprising providing a nanotube and poly(cyclohexyl methacrylate) and using a high shear batch disperser to form a composite material.
Item GG1474. A method for preparing a composite material, said method comprising providing a nanotube and poly(ethyl acrylate) and using a high shear batch disperser to form a composite material.
Item GG1475. A method for preparing a composite material, said method comprising providing a nanotube and poly(ethylene glycol) and using a high shear batch disperser to form a composite material.
Item GG1476. A method for preparing a composite material, said method comprising providing a nanotube and poly(ethylene naphthalate) and using a high shear batch disperser to form a composite material.
Item GG1477. A method for preparing a composite material, said method comprising providing a nanotube and poly(isobutylene) and using a high shear batch disperser to form a composite material.
Item GG1478. A method for preparing a composite material, said method comprising providing a nanotube and poly(phenylsulfone) and using a high shear batch disperser to form a composite material.
Item GG1479. A method for preparing a composite material, said method comprising providing a nanotube and poly(propylene glycol) and using a high shear batch disperser to form a composite material.
Item GG1480. A method for preparing a composite material, said method comprising providing a nanotube and poly(tetrahydrofuran) and using a high shear batch disperser to
Item GG1481. A method for preparing a composite material, said method comprising providing a nanotube and poly(α-methylstyrene) and using a high shear batch disperser to form a composite material.
Item GG1482. A method for preparing a composite material, said method comprising providing a nanotube and polyacetal and using a high shear batch disperser to form a composite material.
Item GG1483. A method for preparing a composite material, said method comprising providing a nanotube and polyacetal (POM) and using a high shear batch disperser to form a composite material.
Item GG1484. A method for preparing a composite material, said method comprising providing a nanotube and polyacrylate elastomers and using a high shear batch disperser to form a composite material.
Item GG1485. A method for preparing a composite material, said method comprising providing a nanotube and polyacrylonitrile (PAN) and using a high shear batch disperser to form a composite material.
Item GG1486. A method for preparing a composite material, said method comprising providing a nanotube and polyamide and using a high shear batch disperser to form a composite material.
Item GG1487. A method for preparing a composite material, said method comprising providing a nanotube and polybutadiene (PBD) and using a high shear batch disperser to form a composite material.
Item GG1488. A method for preparing a composite material, said method comprising providing a nanotube and polybutadiene (butadiene rubber, BR) and using a high shear batch disperser to form a composite material.
Item GG1489. A method for preparing a composite material, said method comprising providing a nanotube and polybutylene terephthalate (PBT) and using a high shear batch disperser to form a composite material.
Item GG1490. A method for preparing a composite material, said method comprising providing a nanotube and polycaprolactam and using a high shear batch disperser to form a composite material.
Item GG1491. A method for preparing a composite material, said method comprising providing a nanotube and polycarbonate (PC) and using a high shear batch disperser to form a composite material.
Item GG1492. A method for preparing a composite material, said method comprising providing a nanotube and polychloroprene and using a high shear batch disperser to form a composite material.
Item GG1493. A method for preparing a composite material, said method comprising providing a nanotube and polychlorotrifluoroethylene (PCTFE) and using a high shear batch disperser to form a composite material.
Item GG1494. A method for preparing a composite material, said method comprising providing a nanotube and polyesters and using a high shear batch disperser to form a composite material.
Item GG1495. A method for preparing a composite material, said method comprising providing a nanotube and polyether ether ketone (PEEK) and using a high shear batch disperser to form a composite material.
Item GG1496. A method for preparing a composite material, said method comprising providing a nanotube and polyetherketone (PEK) and using a high shear batch disperser to form a composite material.
Item GG1497. A method for preparing a composite material, said method comprising providing a nanotube and polyethers and using a high shear batch disperser to form a composite material.
Item GG1498. A method for preparing a composite material, said method comprising providing a nanotube and polyethersulfone (PES) and using a high shear batch disperser to form a composite material.
Item GG1499. A method for preparing a composite material, said method comprising providing a nanotube and polyethyl acrylate and using a high shear batch disperser to form a composite material.
Item GG1500. A method for preparing a composite material, said method comprising providing a nanotube and polyethylene—cross-linked and using a high shear batch disperser to form a composite material.
Item GG1501. A method for preparing a composite material, said method comprising providing a nanotube and polyethylene—high density (HDPE) and using a high shear batch disperser to form a composite material.
Item GG1502. A method for preparing a composite material, said method comprising providing a nanotube and polyethylene—linear low density (LLDPE) and using a high shear batch disperser to form a composite material.
Item GG1503. A method for preparing a composite material, said method comprising providing a nanotube and polyethylene—low density (LDPE) and using a high shear batch disperser to form a composite material.
Item GG1504. A method for preparing a composite material, said method comprising providing a nanotube and polyethylene—medium density (MDPE) and using a high shear batch disperser to form a composite material.
Item GG1505. A method for preparing a composite material, said method comprising providing a nanotube and polyethylene—ultrahigh molecular weight (UHMWPE) and using a high shear batch disperser to form a composite material.
Item GG1506. A method for preparing a composite material, said method comprising providing a nanotube and polyethylene—very low density (VLDPE) and using a high shear batch disperser to form a composite material.
Item GG1507. A method for preparing a composite material, said method comprising providing a nanotube and polyethylene terephthalate (PET) and using a high shear batch disperser to form a composite material.
Item GG1508. A method for preparing a composite material, said method comprising providing a nanotube and polyethylene (PE) and using a high shear batch disperser to form a composite material.
Item GG1509. A method for preparing a composite material, said method comprising providing a nanotube and polyglycolide and using a high shear batch disperser to form a composite material.
Item GG1510. A method for preparing a composite material, said method comprising providing a nanotube and polyhexamethylene adipamide (PA 6,6) and using a high shear batch disperser to form a composite material.
Item GG1511. A method for preparing a composite material, said method comprising providing a nanotube and polyimides and using a high shear batch disperser to form a composite material.
Item GG1512. A method for preparing a composite material, said method comprising providing a nanotube and polyisoprene (natural rubber, NR; isoprene rubber, IR) and using a high shear batch disperser to form a composite material.
Item GG1513. A method for preparing a composite material, said method comprising providing a nanotube and polylactic acid (PLA) and using a high shear batch disperser to form a composite material.
Item GG1514. A method for preparing a composite material, said method comprising providing a nanotube and polymethyl acrylate and using a high shear batch disperser to form a composite material.
Item GG1515. A method for preparing a composite material, said method comprising providing a nanotube and polymethyl methacrylate (PMMA) and using a high shear batch disperser to form a composite material.
Item GG1516. A method for preparing a composite material, said method comprising providing a nanotube and polyphenylene oxide (PPO) and using a high shear batch disperser to form a composite material.
Item GG1517. A method for preparing a composite material, said method comprising providing a nanotube and polyphenylene sulfide (PPS) and using a high shear batch disperser to form a composite material.
Item GG1518. A method for preparing a composite material, said method comprising providing a nanotube and poly-p-phenylene-2,6-benzobisoxazole (PBO) and using a high shear batch disperser to form a composite material.
Item GG1519. A method for preparing a composite material, said method comprising providing a nanotube and polypropylene (PP) and using a high shear batch disperser to form a composite material.
Item GG1520. A method for preparing a composite material, said method comprising providing a nanotube and polysiloxanes (silicones) and using a high shear batch disperser to form a composite material.
Item GG1521. A method for preparing a composite material, said method comprising providing a nanotube and polystyrene (PS) and using a high shear batch disperser to form a composite material.
Item GG1522. A method for preparing a composite material, said method comprising providing a nanotube and polysulfide rubber and using a high shear batch disperser to form a composite material.
Item GG1523. A method for preparing a composite material, said method comprising providing a nanotube and polysulfides and using a high shear batch disperser to form a composite material.
Item GG1524. A method for preparing a composite material, said method comprising providing a nanotube and polytetrafluoroethylene (PTFE) and using a high shear batch disperser to form a composite material.
Item GG1525. A method for preparing a composite material, said method comprising providing a nanotube and polytrimethylene terephthalate (PTT) and using a high shear batch disperser to form a composite material.
Item GG1526. A method for preparing a composite material, said method comprising providing a nanotube and polyurethane and using a high shear batch disperser to form a composite material.
Item GG1527. A method for preparing a composite material, said method comprising providing a nanotube and polyvinyl acetate (PVAc) and using a high shear batch disperser to form a composite material.
Item GG1528. A method for preparing a composite material, said method comprising providing a nanotube and polyvinyl chloride (PVC) and using a high shear batch disperser to form a composite material.
Item GG1529. A method for preparing a composite material, said method comprising providing a nanotube and polyvinyl fluoride (PVF) and using a high shear batch disperser to form a composite material.
Item GG1530. A method for preparing a composite material, said method comprising providing a nanotube and polyvinylidene chloride (PVDC) and using a high shear batch disperser to form a composite material.
Item GG1531. A method for preparing a composite material, said method comprising providing a nanotube and polyvinylidene fluoride (PVDF) and using a high shear batch disperser to form a composite material.
Item GG1532. A method for preparing a composite material, said method comprising providing a nanotube and rayon and using a high shear batch disperser to form a composite material.
Item GG1533. A method for preparing a composite material, said method comprising providing a nanotube and styrene-acrylonitrile (SAN) and using a high shear batch disperser to form a composite material.
Item GG1534. A method for preparing a composite material, said method comprising providing a nanotube and styrene-butadiene and using a high shear batch disperser to form a composite material.
Item GG1535. A method for preparing a composite material, said method comprising providing a nanotube and styrene-isoprene and using a high shear batch disperser to form a composite material.
Item GG1536. A method for preparing a composite material, said method comprising providing a nanotube and a styrene-maleic anhydride copolymer and using a high shear batch disperser to form a composite material.
Item GG1537. A method for preparing a composite material, said method comprising providing a nanotube and a thermoplastic polyurethanes (TPU) and using a high shear batch disperser to form a composite material.
Item GG1538. A method for preparing a composite material, said method comprising providing a nanotube and an unsaturated polyester and using a high shear batch disperser to form a composite material.
Item GG1539. A method for preparing a composite material, said method comprising providing a nanotube and a urea-formaldehyde polymer and using a high shear batch disperser to form a composite material.
Item GG1540. A method for preparing a composite material, said method comprising providing a nanotube and a vinyl copolymer and using a high shear batch disperser to form a composite material.
Item GG1541. A method for preparing a composite material, said method comprising providing a nanotube and an acrylic polymer and using a mixer mill to form a composite material.
Item GG1542. A method for preparing a composite material, said method comprising providing a nanotube and acrylonitrile-butadiene-styrene (ABS) and using a mixer mill to form a composite material.
Item GG1543. A method for preparing a composite material, said method comprising providing a nanotube and an aldehyde condensation polymer and using a mixer mill to form a composite material.
Item GG1544. A method for preparing a composite material, said method comprising providing a nanotube and an aliphatic polyether and using a mixer mill to form a composite material.
Item GG1545. A method for preparing a composite material, said method comprising providing a nanotube and an alkyds and oil-free coating polyester and using a mixer mill to form a composite material.
Item GG1546. A method for preparing a composite material, said method comprising providing a nanotube and an aramid and using a mixer mill to form a composite material.
Item GG1547. A method for preparing a composite material, said method comprising providing a nanotube and butyl rubber and using a mixer mill to form a composite material.
Item GG1548. A method for preparing a composite material, said method comprising providing a nanotube and cellulose acetate and using a mixer mill to form a composite material.
Item GG1549. A method for preparing a composite material, said method comprising providing a nanotube and cellulose nitrate and using a mixer mill to form a composite material.
Item GG1550. A method for preparing a composite material, said method comprising providing a nanotube and a cellulosic and using a mixer mill to form a composite material.
Item GG1551. A method for preparing a composite material, said method comprising providing a nanotube and a cyanoacrylate polymer and using a mixer mill to form a composite material.
Item GG1552. A method for preparing a composite material, said method comprising providing a nanotube and a diene polymer and using a mixer mill to form a composite material.
Item GG1553. A method for preparing a composite material, said method comprising providing a nanotube and an epoxy and using a mixer mill to form a composite material.
Item GG1554. A method for preparing a composite material, said method comprising providing a nanotube and an ethylene-propylene copolymer and using a mixer mill to form a composite material.
Item GG1555. A method for preparing a composite material, said method comprising providing a nanotube and a fluoroelastomer and using a mixer mill to form a composite material.
Item GG1556. A method for preparing a composite material, said method comprising providing a nanotube and a heterochain polymer and using a mixer mill to form a composite material.
Item GG1557. A method for preparing a composite material, said method comprising providing a nanotube and a melamine-formaldehyde polymer and using a mixer mill to form a composite material.
Item GG1558. A method for preparing a composite material, said method comprising providing a nanotube and a meta-aramid polymer and using a mixer mill to form a composite material.
Item GG1559. A method for preparing a composite material, said method comprising providing a nanotube and nitrile rubber and using a mixer mill to form a composite material.
Item GG1560. A method for preparing a composite material, said method comprising providing a nanotube and nylon and using a mixer mill to form a composite material.
Item GG1561. A method for preparing a composite material, said method comprising providing a nanotube and a para-aramid and using a mixer mill to form a composite material.
Item GG1562. A method for preparing a composite material, said method comprising providing a nanotube and poly 2-hydroxyethyl methacrylate (HEMA) and using a mixer mill to form a composite material.
Item GG1563. A method for preparing a composite material, said method comprising providing a nanotube and poly bisphenol A carbonate (PC) and using a mixer mill to form a composite material.
Item GG1564. A method for preparing a composite material, said method comprising providing a nanotube and poly butylene terephthalate (PBT) and using a mixer mill to form a composite material.
Item GG1565. A method for preparing a composite material, said method comprising providing a nanotube and poly dimethylsiloxane (PDMS) and using a mixer mill to form a composite material.
Item GG1566. A method for preparing a composite material, said method comprising providing a nanotube and poly dodecano-12-lactam (Nylon 12) and using a mixer mill to
Item GG1567. A method for preparing a composite material, said method comprising providing a nanotube and poly ether ketone ketone (PEKK) and using a mixer mill to form a composite material.
Item GG1568. A method for preparing a composite material, said method comprising providing a nanotube and poly ethylene terephthalate (PET) and using a mixer mill to form a composite material.
Item GG1569. A method for preparing a composite material, said method comprising providing a nanotube and poly methyl acrylate (PMA) and using a mixer mill to form a composite material.
Item GG1570. A method for preparing a composite material, said method comprising providing a nanotube and poly methyl methacrylate (PMMA) and using a mixer mill to form a composite material.
Item GG1571. A method for preparing a composite material, said method comprising providing a nanotube and poly vinyl acetate (PVA) and using a mixer mill to form a composite material.
Item GG1572. A method for preparing a composite material, said method comprising providing a nanotube and poly vinyl chloride (PVC) and using a mixer mill to form a composite material.
Item GG1573. A method for preparing a composite material, said method comprising providing a nanotube and poly vinylidene chloride (PVDC) and using a mixer mill to form a composite material.
Item GG1574. A method for preparing a composite material, said method comprising providing a nanotube and poly vinylidene fluoride (PVDF) and using a mixer mill to form a composite material.
Item GG1575. A method for preparing a composite material, said method comprising providing a nanotube and poly(acrylic acid) and using a mixer mill to form a composite material.
Item GG1576. A method for preparing a composite material, said method comprising providing a nanotube and poly(Bisphenol A isophthalate) and using a mixer mill to form a composite material.
Item GG1577. A method for preparing a composite material, said method comprising providing a nanotube and poly(Bisphenol A terephthalate) and using a mixer mill to form a composite material.
Item GG1578. A method for preparing a composite material, said method comprising providing a nanotube and poly(butyl acrylate) and using a mixer mill to form a composite material.
Item GG1579. A method for preparing a composite material, said method comprising providing a nanotube and poly(butyl methacrylate) and using a mixer mill to form a composite material.
Item GG1580. A method for preparing a composite material, said method comprising providing a nanotube and poly(butylene) and using a mixer mill to form a composite material.
Item GG1581. A method for preparing a composite material, said method comprising providing a nanotube and poly(caprolactone) and using a mixer mill to form a composite material.
Item GG1582. A method for preparing a composite material, said method comprising providing a nanotube and poly(chlorotrifluoroethylene) and using a mixer mill to form a composite material.
Item GG1583. A method for preparing a composite material, said method comprising providing a nanotube and poly(cyclohexyl methacrylate) and using a mixer mill to form a composite material.
Item GG1584. A method for preparing a composite material, said method comprising providing a nanotube and poly(ethyl acrylate) and using a mixer mill to form a composite material.
Item GG1585. A method for preparing a composite material, said method comprising providing a nanotube and poly(ethylene glycol) and using a mixer mill to form a composite material.
Item GG1586. A method for preparing a composite material, said method comprising providing a nanotube and poly(ethylene naphthalate) and using a mixer mill to form a composite material.
Item GG1587. A method for preparing a composite material, said method comprising providing a nanotube and poly(isobutylene) and using a mixer mill to form a composite material.
Item GG1588. A method for preparing a composite material, said method comprising providing a nanotube and poly(phenylsulfone) and using a mixer mill to form a composite material.
Item GG1589. A method for preparing a composite material, said method comprising providing a nanotube and poly(propylene glycol) and using a mixer mill to form a composite material.
Item GG1590. A method for preparing a composite material, said method comprising providing a nanotube and poly(tetrahydrofuran) and using a mixer mill to form a composite material.
Item GG1591. A method for preparing a composite material, said method comprising providing a nanotube and poly(α-methylstyrene) and using a mixer mill to form a composite material.
Item GG1592. A method for preparing a composite material, said method comprising providing a nanotube and polyacetal and using a mixer mill to form a composite material.
Item GG1593. A method for preparing a composite material, said method comprising providing a nanotube and polyacetal (POM) and using a mixer mill to form a composite material.
Item GG1594. A method for preparing a composite material, said method comprising providing a nanotube and polyacrylate elastomers and using a mixer mill to form a composite material.
Item GG1595. A method for preparing a composite material, said method comprising providing a nanotube and polyacrylonitrile (PAN) and using a mixer mill to form a composite material.
Item GG1596. A method for preparing a composite material, said method comprising providing a nanotube and polyamide and using a mixer mill to form a composite material.
Item GG1597. A method for preparing a composite material, said method comprising providing a nanotube and polybutadiene (PBD) and using a mixer mill to form a composite material.
Item GG1598. A method for preparing a composite material, said method comprising providing a nanotube and polybutadiene (butadiene rubber, BR) and using a mixer mill to form a composite material.
Item GG1599. A method for preparing a composite material, said method comprising providing a nanotube and polybutylene terephthalate (PBT) and using a mixer mill to form a composite material.
Item GG1600. A method for preparing a composite material, said method comprising providing a nanotube and polycaprolactam and using a mixer mill to form a composite material.
Item GG1601. A method for preparing a composite material, said method comprising providing a nanotube and polycarbonate (PC) and using a mixer mill to form a composite material.
Item GG1602. A method for preparing a composite material, said method comprising providing a nanotube and polychloroprene and using a mixer mill to form a composite material.
Item GG1603. A method for preparing a composite material, said method comprising providing a nanotube and polychlorotrifluoroethylene (PCTFE) and using a mixer mill to form a composite material.
Item GG1604. A method for preparing a composite material, said method comprising providing a nanotube and polyesters and using a mixer mill to form a composite material.
Item GG1605. A method for preparing a composite material, said method comprising providing a nanotube and polyether ether ketone (PEEK) and using a mixer mill to form a composite material.
Item GG1606. A method for preparing a composite material, said method comprising providing a nanotube and polyetherketone (PEK) and using a mixer mill to form a composite material.
Item GG1607. A method for preparing a composite material, said method comprising providing a nanotube and polyethers and using a mixer mill to form a composite material.
Item GG1608. A method for preparing a composite material, said method comprising providing a nanotube and polyethersulfone (PES) and using a mixer mill to form a composite material.
Item GG1609. A method for preparing a composite material, said method comprising providing a nanotube and polyethyl acrylate and using a mixer mill to form a composite material.
Item GG1610. A method for preparing a composite material, said method comprising providing a nanotube and polyethylene—cross-linked and using a mixer mill to form a composite material.
Item GG1611. A method for preparing a composite material, said method comprising providing a nanotube and polyethylene—high density (HDPE) and using a mixer mill to form a composite material.
Item GG1612. A method for preparing a composite material, said method comprising providing a nanotube and polyethylene—linear low density (LLDPE) and using a mixer mill to form a composite material.
Item GG1613. A method for preparing a composite material, said method comprising providing a nanotube and polyethylene—low density (LDPE) and using a mixer mill to form a composite material.
Item GG1614. A method for preparing a composite material, said method comprising providing a nanotube and polyethylene—medium density (MDPE) and using a mixer mill to form a composite material.
Item GG1615. A method for preparing a composite material, said method comprising providing a nanotube and polyethylene—ultrahigh molecular weight (UHMWPE) and using a mixer mill to form a composite material.
Item GG1616. A method for preparing a composite material, said method comprising providing a nanotube and polyethylene—very low density (VLDPE) and using a mixer mill to form a composite material.
Item GG1617. A method for preparing a composite material, said method comprising providing a nanotube and polyethylene terephthalate (PET) and using a mixer mill to form a composite material.
Item GG1618. A method for preparing a composite material, said method comprising providing a nanotube and polyethylene (PE) and using a mixer mill to form a composite material.
Item GG1619. A method for preparing a composite material, said method comprising providing a nanotube and polyglycolide and using a mixer mill to form a composite material.
Item GG1620. A method for preparing a composite material, said method comprising providing a nanotube and polyhexamethylene adipamide (PA 6,6) and using a mixer mill to form a composite material.
Item GG1621. A method for preparing a composite material, said method comprising providing a nanotube and polyimides and using a mixer mill to form a composite material.
Item GG1622. A method for preparing a composite material, said method comprising providing a nanotube and polyisoprene (natural rubber, NR; isoprene rubber, IR) and using a mixer mill to form a composite material.
Item GG1623. A method for preparing a composite material, said method comprising providing a nanotube and polylactic acid (PLA) and using a mixer mill to form a composite material.
Item GG1624. A method for preparing a composite material, said method comprising providing a nanotube and polymethyl acrylate and using a mixer mill to form a composite material.
Item GG1625. A method for preparing a composite material, said method comprising providing a nanotube and polymethyl methacrylate (PMMA) and using a mixer mill to form a composite material.
Item GG1626. A method for preparing a composite material, said method comprising providing a nanotube and polyphenylene oxide (PPO) and using a mixer mill to form a composite material.
Item GG1627. A method for preparing a composite material, said method comprising providing a nanotube and polyphenylene sulfide (PPS) and using a mixer mill to form a composite material.
Item GG1628. A method for preparing a composite material, said method comprising providing a nanotube and poly-p-phenylene-2,6-benzobisoxazole (PBO) and using a mixer mill to form a composite material.
Item GG1629. A method for preparing a composite material, said method comprising providing a nanotube and polypropylene (PP) and using a mixer mill to form a composite material.
Item GG1630. A method for preparing a composite material, said method comprising providing a nanotube and polysiloxanes (silicones) and using a mixer mill to form a composite material.
Item GG1631. A method for preparing a composite material, said method comprising providing a nanotube and polystyrene (PS) and using a mixer mill to form a composite material.
Item GG1632. A method for preparing a composite material, said method comprising providing a nanotube and polysulfide rubber and using a mixer mill to form a composite material.
Item GG1633. A method for preparing a composite material, said method comprising providing a nanotube and polysulfides and using a mixer mill to form a composite material.
Item GG1634. A method for preparing a composite material, said method comprising providing a nanotube and polytetrafluoroethylene (PTFE) and using a mixer mill to form a composite material.
Item GG1635. A method for preparing a composite material, said method comprising providing a nanotube and polytrimethylene terephthalate (PTT) and using a mixer mill to form a composite material.
Item GG1636. A method for preparing a composite material, said method comprising providing a nanotube and polyurethane and using a mixer mill to form a composite material.
Item GG1637. A method for preparing a composite material, said method comprising providing a nanotube and polyvinyl acetate (PVAc) and using a mixer mill to form a composite material.
Item GG1638. A method for preparing a composite material, said method comprising providing a nanotube and polyvinyl chloride (PVC) and using a mixer mill to form a composite material.
Item GG1639. A method for preparing a composite material, said method comprising providing a nanotube and polyvinyl fluoride (PVF) and using a mixer mill to form a composite material.
Item GG1640. A method for preparing a composite material, said method comprising providing a nanotube and polyvinylidene chloride (PVDC) and using a mixer mill to form a composite material.
Item GG1641. A method for preparing a composite material, said method comprising providing a nanotube and polyvinylidene fluoride (PVDF) and using a mixer mill to form a composite material.
Item GG1642. A method for preparing a composite material, said method comprising providing a nanotube and rayon and using a mixer mill to form a composite material.
Item GG1643. A method for preparing a composite material, said method comprising providing a nanotube and styrene-acrylonitrile (SAN) and using a mixer mill to form a composite material.
Item GG1644. A method for preparing a composite material, said method comprising providing a nanotube and styrene-butadiene and using a mixer mill to form a composite material.
Item GG1645. A method for preparing a composite material, said method comprising providing a nanotube and styrene-isoprene and using a mixer mill to form a composite material.
Item GG1646. A method for preparing a composite material, said method comprising providing a nanotube and a styrene-maleic anhydride copolymer and using a mixer mill to form a composite material.
Item GG1647. A method for preparing a composite material, said method comprising providing a nanotube and a thermoplastic polyurethanes (TPU) and using a mixer mill to form a composite material.
Item GG1648. A method for preparing a composite material, said method comprising providing a nanotube and an unsaturated polyester and using a mixer mill to form a composite material.
Item GG1649. A method for preparing a composite material, said method comprising providing a nanotube and a urea-formaldehyde polymer and using a mixer mill to form a composite material.
Item GG1650. A method for preparing a composite material, said method comprising providing a nanotube and a vinyl copolymer and using a mixer mill to form a composite material.
Item GG1651. A method for preparing a composite material, said method comprising providing a nanotube and an acrylic polymer and using a paint shaker to form a composite material.
Item GG1652. A method for preparing a composite material, said method comprising providing a nanotube and acrylonitrile-butadiene-styrene (ABS) and using a paint shaker to form a composite material.
Item GG1653. A method for preparing a composite material, said method comprising providing a nanotube and an aldehyde condensation polymer and using a paint shaker to form a composite material.
Item GG1654. A method for preparing a composite material, said method comprising providing a nanotube and an aliphatic polyether and using a paint shaker to form a composite material.
Item GG1655. A method for preparing a composite material, said method comprising providing a nanotube and an alkyds and oil-free coating polyester and using a paint shaker to form a composite material.
Item GG1656. A method for preparing a composite material, said method comprising providing a nanotube and an aramid and using a paint shaker to form a composite material.
Item GG1657. A method for preparing a composite material, said method comprising providing a nanotube and butyl rubber and using a paint shaker to form a composite material.
Item GG1658. A method for preparing a composite material, said method comprising providing a nanotube and cellulose acetate and using a paint shaker to form a composite material.
Item GG1659. A method for preparing a composite material, said method comprising providing a nanotube and cellulose nitrate and using a paint shaker to form a composite material.
Item GG1660. A method for preparing a composite material, said method comprising providing a nanotube and a cellulosic and using a paint shaker to form a composite material.
Item GG1661. A method for preparing a composite material, said method comprising providing a nanotube and a cyanoacrylate polymer and using a paint shaker to form a composite material.
Item GG1662. A method for preparing a composite material, said method comprising providing a nanotube and a diene polymer and using a paint shaker to form a composite material.
Item GG1663. A method for preparing a composite material, said method comprising providing a nanotube and an epoxy and using a paint shaker to form a composite material.
Item GG1664. A method for preparing a composite material, said method comprising providing a nanotube and an ethylene-propylene copolymer and using a paint shaker to form a composite material.
Item GG1665. A method for preparing a composite material, said method comprising providing a nanotube and a fluoroelastomer and using a paint shaker to form a composite material.
Item GG1666. A method for preparing a composite material, said method comprising providing a nanotube and a heterochain polymer and using a paint shaker to form a composite material.
Item GG1667. A method for preparing a composite material, said method comprising providing a nanotube and a melamine-formaldehyde polymer and using a paint shaker to form a composite material.
Item GG1668. A method for preparing a composite material, said method comprising providing a nanotube and a meta-aramid polymer and using a paint shaker to form a composite material.
Item GG1669. A method for preparing a composite material, said method comprising providing a nanotube and nitrile rubber and using a paint shaker to form a composite material.
Item GG1670. A method for preparing a composite material, said method comprising providing a nanotube and nylon and using a paint shaker to form a composite material.
Item GG1671. A method for preparing a composite material, said method comprising providing a nanotube and a para-aramid and using a paint shaker to form a composite material.
Item GG1672. A method for preparing a composite material, said method comprising providing a nanotube and poly 2-hydroxyethyl methacrylate (HEMA) and using a paint shaker to form a composite material.
Item GG1673. A method for preparing a composite material, said method comprising providing a nanotube and poly bisphenol A carbonate (PC) and using a paint shaker to form a composite material.
Item GG1674. A method for preparing a composite material, said method comprising providing a nanotube and poly butylene terephthalate (PBT) and using a paint shaker to form a composite material.
Item GG1675. A method for preparing a composite material, said method comprising providing a nanotube and poly dimethylsiloxane (PDMS) and using a paint shaker to form a composite material.
Item GG1676. A method for preparing a composite material, said method comprising providing a nanotube and poly dodecano-12-lactam (Nylon 12) and using a paint shaker to form a composite material.
Item GG1677. A method for preparing a composite material, said method comprising providing a nanotube and poly ether ketone ketone (PEKK) and using a paint shaker to form a composite material.
Item GG1678. A method for preparing a composite material, said method comprising providing a nanotube and poly ethylene terephthalate (PET) and using a paint shaker to form a composite material.
Item GG1679. A method for preparing a composite material, said method comprising providing a nanotube and poly methyl acrylate (PMA) and using a paint shaker to form a composite material.
Item GG1680. A method for preparing a composite material, said method comprising providing a nanotube and poly methyl methacrylate (PMMA) and using a paint shaker to
Item GG1681. A method for preparing a composite material, said method comprising providing a nanotube and poly vinyl acetate (PVA) and using a paint shaker to form a composite material.
Item GG1682. A method for preparing a composite material, said method comprising providing a nanotube and poly vinyl chloride (PVC) and using a paint shaker to form a composite material.
Item GG1683. A method for preparing a composite material, said method comprising providing a nanotube and poly vinylidene chloride (PVDC) and using a paint shaker to form a composite material.
Item GG1684. A method for preparing a composite material, said method comprising providing a nanotube and poly vinylidene fluoride (PVDF) and using a paint shaker to form a composite material.
Item GG1685. A method for preparing a composite material, said method comprising providing a nanotube and poly(acrylic acid) and using a paint shaker to form a composite material.
Item GG1686. A method for preparing a composite material, said method comprising providing a nanotube and poly(Bisphenol A isophthalate) and using a paint shaker to form a composite material.
Item GG1687. A method for preparing a composite material, said method comprising providing a nanotube and poly(Bisphenol A terephthalate) and using a paint shaker to form a composite material.
Item GG1688. A method for preparing a composite material, said method comprising providing a nanotube and poly(butyl acrylate) and using a paint shaker to form a composite material.
Item GG1689. A method for preparing a composite material, said method comprising providing a nanotube and poly(butyl methacrylate) and using a paint shaker to form a composite material.
Item GG1690. A method for preparing a composite material, said method comprising providing a nanotube and poly(butylene) and using a paint shaker to form a composite material.
Item GG1691. A method for preparing a composite material, said method comprising providing a nanotube and poly(caprolactone) and using a paint shaker to form a composite material.
Item GG1692. A method for preparing a composite material, said method comprising providing a nanotube and poly(chlorotrifluoroethylene) and using a paint shaker to form a composite material.
Item GG1693. A method for preparing a composite material, said method comprising providing a nanotube and poly(cyclohexyl methacrylate) and using a paint shaker to form a composite material.
Item GG1694. A method for preparing a composite material, said method comprising providing a nanotube and poly(ethyl acrylate) and using a paint shaker to form a composite material.
Item GG1695. A method for preparing a composite material, said method comprising providing a nanotube and poly(ethylene glycol) and using a paint shaker to form a composite material.
Item GG1696. A method for preparing a composite material, said method comprising providing a nanotube and poly(ethylene naphthalate) and using a paint shaker to form a composite material.
Item GG1697. A method for preparing a composite material, said method comprising providing a nanotube and poly(isobutylene) and using a paint shaker to form a composite material.
Item GG1698. A method for preparing a composite material, said method comprising providing a nanotube and poly(phenylsulfone) and using a paint shaker to form a composite material.
Item GG1699. A method for preparing a composite material, said method comprising providing a nanotube and poly(propylene glycol) and using a paint shaker to form a composite material.
Item GG1700. A method for preparing a composite material, said method comprising providing a nanotube and poly(tetrahydrofuran) and using a paint shaker to form a composite material.
Item GG1701. A method for preparing a composite material, said method comprising providing a nanotube and poly(α-methylstyrene) and using a paint shaker to form a composite material.
Item GG1702. A method for preparing a composite material, said method comprising providing a nanotube and polyacetal and using a paint shaker to form a composite material.
Item GG1703. A method for preparing a composite material, said method comprising providing a nanotube and polyacetal (POM) and using a paint shaker to form a composite material.
Item GG1704. A method for preparing a composite material, said method comprising providing a nanotube and polyacrylate elastomers and using a paint shaker to form a composite material.
Item GG1705. A method for preparing a composite material, said method comprising providing a nanotube and polyacrylonitrile (PAN) and using a paint shaker to form a composite material.
Item GG1706. A method for preparing a composite material, said method comprising providing a nanotube and polyamide and using a paint shaker to form a composite material.
Item GG1707. A method for preparing a composite material, said method comprising providing a nanotube and polybutadiene (PBD) and using a paint shaker to form a composite material.
Item GG1708. A method for preparing a composite material, said method comprising providing a nanotube and polybutadiene (butadiene rubber, BR) and using a paint shaker to
Item GG1709. A method for preparing a composite material, said method comprising providing a nanotube and polybutylene terephthalate (PBT) and using a paint shaker to form a composite material.
Item GG1710. A method for preparing a composite material, said method comprising providing a nanotube and polycaprolactam and using a paint shaker to form a composite material.
Item GG1711. A method for preparing a composite material, said method comprising providing a nanotube and polycarbonate (PC) and using a paint shaker to form a composite material.
Item GG1712. A method for preparing a composite material, said method comprising providing a nanotube and polychloroprene and using a paint shaker to form a composite material.
Item GG1713. A method for preparing a composite material, said method comprising providing a nanotube and polychlorotrifluoroethylene (PCTFE) and using a paint shaker to form a composite material.
Item GG1714. A method for preparing a composite material, said method comprising providing a nanotube and polyesters and using a paint shaker to form a composite material.
Item GG1715. A method for preparing a composite material, said method comprising providing a nanotube and polyether ether ketone (PEEK) and using a paint shaker to form a composite material.
Item GG1716. A method for preparing a composite material, said method comprising providing a nanotube and polyetherketone (PEK) and using a paint shaker to form a composite material.
Item GG1717. A method for preparing a composite material, said method comprising providing a nanotube and polyethers and using a paint shaker to form a composite material.
Item GG1718. A method for preparing a composite material, said method comprising providing a nanotube and polyethersulfone (PES) and using a paint shaker to form a composite material.
Item GG1719. A method for preparing a composite material, said method comprising providing a nanotube and polyethyl acrylate and using a paint shaker to form a composite material.
Item GG1720. A method for preparing a composite material, said method comprising providing a nanotube and polyethylene—cross-linked and using a paint shaker to form a composite material.
Item GG1721. A method for preparing a composite material, said method comprising providing a nanotube and polyethylene—high density (HDPE) and using a paint shaker to form a composite material.
Item GG1722. A method for preparing a composite material, said method comprising providing a nanotube and polyethylene—linear low density (LLDPE) and using a paint shaker to form a composite material.
Item GG1723. A method for preparing a composite material, said method comprising providing a nanotube and polyethylene—low density (LDPE) and using a paint shaker to form a composite material.
Item GG1724. A method for preparing a composite material, said method comprising providing a nanotube and polyethylene—medium density (MDPE) and using a paint shaker to form a composite material.
Item GG1725. A method for preparing a composite material, said method comprising providing a nanotube and polyethylene—ultrahigh molecular weight (UHMWPE) and using a paint shaker to form a composite material.
Item GG1726. A method for preparing a composite material, said method comprising providing a nanotube and polyethylene—very low density (VLDPE) and using a paint shaker to form a composite material.
Item GG1727. A method for preparing a composite material, said method comprising providing a nanotube and polyethylene terephthalate (PET) and using a paint shaker to form a composite material.
Item GG1728. A method for preparing a composite material, said method comprising providing a nanotube and polyethylene (PE) and using a paint shaker to form a composite material.
Item GG1729. A method for preparing a composite material, said method comprising providing a nanotube and polyglycolide and using a paint shaker to form a composite material.
Item GG1730. A method for preparing a composite material, said method comprising providing a nanotube and polyhexamethylene adipamide (PA 6,6) and using a paint shaker to form a composite material.
Item GG1731. A method for preparing a composite material, said method comprising providing a nanotube and polyimides and using a paint shaker to form a composite material.
Item GG1732. A method for preparing a composite material, said method comprising providing a nanotube and polyisoprene (natural rubber, NR; isoprene rubber, IR) and using a paint shaker to form a composite material.
Item GG1733. A method for preparing a composite material, said method comprising providing a nanotube and polylactic acid (PLA) and using a paint shaker to form a composite material.
Item GG1734. A method for preparing a composite material, said method comprising providing a nanotube and polymethyl acrylate and using a paint shaker to form a composite material.
Item GG1735. A method for preparing a composite material, said method comprising providing a nanotube and polymethyl methacrylate (PMMA) and using a paint shaker to form a composite material.
Item GG1736. A method for preparing a composite material, said method comprising providing a nanotube and polyphenylene oxide (PPO) and using a paint shaker to form a composite material.
Item GG1737. A method for preparing a composite material, said method comprising providing a nanotube and polyphenylene sulfide (PPS) and using a paint shaker to form a composite material.
Item GG1738. A method for preparing a composite material, said method comprising providing a nanotube and poly-p-phenylene-2,6-benzobisoxazole (PBO) and using a paint shaker to form a composite material.
Item GG1739. A method for preparing a composite material, said method comprising providing a nanotube and polypropylene (PP) and using a paint shaker to form a composite material.
Item GG1740. A method for preparing a composite material, said method comprising providing a nanotube and polysiloxanes (silicones) and using a paint shaker to form a composite material.
Item GG1741. A method for preparing a composite material, said method comprising providing a nanotube and polystyrene (PS) and using a paint shaker to form a composite material.
Item GG1742. A method for preparing a composite material, said method comprising providing a nanotube and polysulfide rubber and using a paint shaker to form a composite material.
Item GG1743. A method for preparing a composite material, said method comprising providing a nanotube and polysulfides and using a paint shaker to form a composite material.
Item GG1744. A method for preparing a composite material, said method comprising providing a nanotube and polytetrafluoroethylene (PTFE) and using a paint shaker to form a composite material.
Item GG1745. A method for preparing a composite material, said method comprising providing a nanotube and polytrimethylene terephthalate (PTT) and using a paint shaker to form a composite material.
Item GG1746. A method for preparing a composite material, said method comprising providing a nanotube and polyurethane and using a paint shaker to form a composite material.
Item GG1747. A method for preparing a composite material, said method comprising providing a nanotube and polyvinyl acetate (PVAc) and using a paint shaker to form a composite material.
Item GG1748. A method for preparing a composite material, said method comprising providing a nanotube and polyvinyl chloride (PVC) and using a paint shaker to form a composite material.
Item GG1749. A method for preparing a composite material, said method comprising providing a nanotube and polyvinyl fluoride (PVF) and using a paint shaker to form a composite material.
Item GG1750. A method for preparing a composite material, said method comprising providing a nanotube and polyvinylidene chloride (PVDC) and using a paint shaker to form a composite material.
Item GG1751. A method for preparing a composite material, said method comprising providing a nanotube and polyvinylidene fluoride (PVDF) and using a paint shaker to form a composite material.
Item GG1752. A method for preparing a composite material, said method comprising providing a nanotube and rayon and using a paint shaker to form a composite material.
Item GG1753. A method for preparing a composite material, said method comprising providing a nanotube and styrene-acrylonitrile (SAN) and using a paint shaker to form a composite material.
Item GG1754. A method for preparing a composite material, said method comprising providing a nanotube and styrene-butadiene and using a paint shaker to form a composite material.
Item GG1755. A method for preparing a composite material, said method comprising providing a nanotube and styrene-isoprene and using a paint shaker to form a composite material.
Item GG1756. A method for preparing a composite material, said method comprising providing a nanotube and a styrene-maleic anhydride copolymer and using a paint shaker to form a composite material.
Item GG1757. A method for preparing a composite material, said method comprising providing a nanotube and a thermoplastic polyurethanes (TPU) and using a paint shaker to form a composite material.
Item GG1758. A method for preparing a composite material, said method comprising providing a nanotube and an unsaturated polyester and using a paint shaker to form a composite material.
Item GG1759. A method for preparing a composite material, said method comprising providing a nanotube and a urea-formaldehyde polymer and using a paint shaker to form a composite material.
Item GG1760. A method for preparing a composite material, said method comprising providing a nanotube and a vinyl copolymer and using a paint shaker to form a composite material.
Item GG1761. A method for preparing a composite material, said method comprising providing a nanotube and an acrylic polymer and using a planetary mill to form a composite material.
Item GG1762. A method for preparing a composite material, said method comprising providing a nanotube and acrylonitrile-butadiene-styrene (ABS) and using a planetary mill to form a composite material.
Item GG1763. A method for preparing a composite material, said method comprising providing a nanotube and an aldehyde condensation polymer and using a planetary mill to form a composite material.
Item GG1764. A method for preparing a composite material, said method comprising providing a nanotube and an aliphatic polyether and using a planetary mill to form a composite material.
Item GG1765. A method for preparing a composite material, said method comprising providing a nanotube and an alkyds and oil-free coating polyester and using a planetary mill to form a composite material.
Item GG1766. A method for preparing a composite material, said method comprising providing a nanotube and an aramid and using a planetary mill to form a composite material.
Item GG1767. A method for preparing a composite material, said method comprising providing a nanotube and butyl rubber and using a planetary mill to form a composite material.
Item GG1768. A method for preparing a composite material, said method comprising providing a nanotube and cellulose acetate and using a planetary mill to form a composite material.
Item GG1769. A method for preparing a composite material, said method comprising providing a nanotube and cellulose nitrate and using a planetary mill to form a composite material.
Item GG1770. A method for preparing a composite material, said method comprising providing a nanotube and a cellulosic and using a planetary mill to form a composite material.
Item GG1771. A method for preparing a composite material, said method comprising providing a nanotube and a cyanoacrylate polymer and using a planetary mill to form a composite material.
Item GG1772. A method for preparing a composite material, said method comprising providing a nanotube and a diene polymer and using a planetary mill to form a composite material.
Item GG1773. A method for preparing a composite material, said method comprising providing a nanotube and an epoxy and using a planetary mill to form a composite material.
Item GG1774. A method for preparing a composite material, said method comprising providing a nanotube and an ethylene-propylene copolymer and using a planetary mill to form a composite material.
Item GG1775. A method for preparing a composite material, said method comprising providing a nanotube and a fluoroelastomer and using a planetary mill to form a composite material.
Item GG1776. A method for preparing a composite material, said method comprising providing a nanotube and a heterochain polymer and using a planetary mill to form a composite material.
Item GG1777. A method for preparing a composite material, said method comprising providing a nanotube and a melamine-formaldehyde polymer and using a planetary mill to form a composite material.
Item GG1778. A method for preparing a composite material, said method comprising providing a nanotube and a meta-aramid polymer and using a planetary mill to form a composite material.
Item GG1779. A method for preparing a composite material, said method comprising providing a nanotube and nitrile rubber and using a planetary mill to form a composite material.
Item GG1780. A method for preparing a composite material, said method comprising providing a nanotube and nylon and using a planetary mill to form a composite material.
Item GG1781. A method for preparing a composite material, said method comprising providing a nanotube and a para-aramid and using a planetary mill to form a composite material.
Item GG1782. A method for preparing a composite material, said method comprising providing a nanotube and poly 2-hydroxyethyl methacrylate (HEMA) and using a planetary mill to form a composite material.
Item GG1783. A method for preparing a composite material, said method comprising providing a nanotube and poly bisphenol A carbonate (PC) and using a planetary mill to form a composite material.
Item GG1784. A method for preparing a composite material, said method comprising providing a nanotube and poly butylene terephthalate (PBT) and using a planetary mill to form a composite material.
Item GG1785. A method for preparing a composite material, said method comprising providing a nanotube and poly dimethylsiloxane (PDMS) and using a planetary mill to form a composite material.
Item GG1786. A method for preparing a composite material, said method comprising providing a nanotube and poly dodecano-12-lactam (Nylon 12) and using a planetary mill to form a composite material.
Item GG1787. A method for preparing a composite material, said method comprising providing a nanotube and poly ether ketone ketone (PEKK) and using a planetary mill to form a composite material.
Item GG1788. A method for preparing a composite material, said method comprising providing a nanotube and poly ethylene terephthalate (PET) and using a planetary mill to form a composite material.
Item GG1789. A method for preparing a composite material, said method comprising providing a nanotube and poly methyl acrylate (PMA) and using a planetary mill to form a composite material.
Item GG1790. A method for preparing a composite material, said method comprising providing a nanotube and poly methyl methacrylate (PMMA) and using a planetary mill to form a composite material.
Item GG1791. A method for preparing a composite material, said method comprising providing a nanotube and poly vinyl acetate (PVA) and using a planetary mill to form a composite material.
Item GG1792. A method for preparing a composite material, said method comprising providing a nanotube and poly vinyl chloride (PVC) and using a planetary mill to form a composite material.
Item GG1793. A method for preparing a composite material, said method comprising providing a nanotube and poly vinylidene chloride (PVDC) and using a planetary mill to form a composite material.
Item GG1794. A method for preparing a composite material, said method comprising providing a nanotube and poly vinylidene fluoride (PVDF) and using a planetary mill to form a composite material.
Item GG1795. A method for preparing a composite material, said method comprising providing a nanotube and poly(acrylic acid) and using a planetary mill to form a composite material.
Item GG1796. A method for preparing a composite material, said method comprising providing a nanotube and poly(Bisphenol A isophthalate) and using a planetary mill to form a composite material.
Item GG1797. A method for preparing a composite material, said method comprising providing a nanotube and poly(Bisphenol A terephthalate) and using a planetary mill to form a composite material.
Item GG1798. A method for preparing a composite material, said method comprising providing a nanotube and poly(butyl acrylate) and using a planetary mill to form a composite material.
Item GG1799. A method for preparing a composite material, said method comprising providing a nanotube and poly(butyl methacrylate) and using a planetary mill to form a composite material.
Item GG1800. A method for preparing a composite material, said method comprising providing a nanotube and poly(butylene) and using a planetary mill to form a composite material.
Item GG1801. A method for preparing a composite material, said method comprising providing a nanotube and poly(caprolactone) and using a planetary mill to form a composite material.
Item GG1802. A method for preparing a composite material, said method comprising providing a nanotube and poly(chlorotrifluoroethylene) and using a planetary mill to form a composite material.
Item GG1803. A method for preparing a composite material, said method comprising providing a nanotube and poly(cyclohexyl methacrylate) and using a planetary mill to form a composite material.
Item GG1804. A method for preparing a composite material, said method comprising providing a nanotube and poly(ethyl acrylate) and using a planetary mill to form a composite material.
Item GG1805. A method for preparing a composite material, said method comprising providing a nanotube and poly(ethylene glycol) and using a planetary mill to form a composite material.
Item GG1806. A method for preparing a composite material, said method comprising providing a nanotube and poly(ethylene naphthalate) and using a planetary mill to form a composite material.
Item GG1807. A method for preparing a composite material, said method comprising providing a nanotube and poly(isobutylene) and using a planetary mill to form a composite material.
Item GG1808. A method for preparing a composite material, said method comprising providing a nanotube and poly(phenylsulfone) and using a planetary mill to form a composite material.
Item GG1809. A method for preparing a composite material, said method comprising providing a nanotube and poly(propylene glycol) and using a planetary mill to form a composite material.
Item GG1810. A method for preparing a composite material, said method comprising providing a nanotube and poly(tetrahydrofuran) and using a planetary mill to form a composite material.
Item GG1811. A method for preparing a composite material, said method comprising providing a nanotube and poly(α-methylstyrene) and using a planetary mill to form a composite material.
Item GG1812. A method for preparing a composite material, said method comprising providing a nanotube and polyacetal and using a planetary mill to form a composite material.
Item GG1813. A method for preparing a composite material, said method comprising providing a nanotube and polyacetal (POM) and using a planetary mill to form a composite material.
Item GG1814. A method for preparing a composite material, said method comprising providing a nanotube and polyacrylate elastomers and using a planetary mill to form a composite material.
Item GG1815. A method for preparing a composite material, said method comprising providing a nanotube and polyacrylonitrile (PAN) and using a planetary mill to form a composite material.
Item GG1816. A method for preparing a composite material, said method comprising providing a nanotube and polyamide and using a planetary mill to form a composite material.
Item GG1817. A method for preparing a composite material, said method comprising providing a nanotube and polybutadiene (PBD) and using a planetary mill to form a composite material.
Item GG1818. A method for preparing a composite material, said method comprising providing a nanotube and polybutadiene (butadiene rubber, BR) and using a planetary mill to form a composite material.
Item GG1819. A method for preparing a composite material, said method comprising providing a nanotube and polybutylene terephthalate (PBT) and using a planetary mill to form a composite material.
Item GG1820. A method for preparing a composite material, said method comprising providing a nanotube and polycaprolactam and using a planetary mill to form a composite material.
Item GG1821. A method for preparing a composite material, said method comprising providing a nanotube and polycarbonate (PC) and using a planetary mill to form a composite material.
Item GG1822. A method for preparing a composite material, said method comprising providing a nanotube and polychloroprene and using a planetary mill to form a composite material.
Item GG1823. A method for preparing a composite material, said method comprising providing a nanotube and polychlorotrifluoroethylene (PCTFE) and using a planetary mill to form a composite material.
Item GG1824. A method for preparing a composite material, said method comprising providing a nanotube and polyesters and using a planetary mill to form a composite material.
Item GG1825. A method for preparing a composite material, said method comprising providing a nanotube and polyether ether ketone (PEEK) and using a planetary mill to form a composite material.
Item GG1826. A method for preparing a composite material, said method comprising providing a nanotube and polyetherketone (PEK) and using a planetary mill to form a composite material.
Item GG1827. A method for preparing a composite material, said method comprising providing a nanotube and polyethers and using a planetary mill to form a composite material.
Item GG1828. A method for preparing a composite material, said method comprising providing a nanotube and polyethersulfone (PES) and using a planetary mill to form a composite material.
Item GG1829. A method for preparing a composite material, said method comprising providing a nanotube and polyethyl acrylate and using a planetary mill to form a composite material.
Item GG1830. A method for preparing a composite material, said method comprising providing a nanotube and polyethylene—cross-linked and using a planetary mill to form a composite material.
Item GG1831. A method for preparing a composite material, said method comprising providing a nanotube and polyethylene—high density (HDPE) and using a planetary mill to form a composite material.
Item GG1832. A method for preparing a composite material, said method comprising providing a nanotube and polyethylene—linear low density (LLDPE) and using a planetary mill to form a composite material.
Item GG1833. A method for preparing a composite material, said method comprising providing a nanotube and polyethylene—low density (LDPE) and using a planetary mill to form a composite material.
Item GG1834. A method for preparing a composite material, said method comprising providing a nanotube and polyethylene—medium density (MDPE) and using a planetary mill to form a composite material.
Item GG1835. A method for preparing a composite material, said method comprising providing a nanotube and polyethylene—ultrahigh molecular weight (UHMWPE) and using a planetary mill to form a composite material.
Item GG1836. A method for preparing a composite material, said method comprising providing a nanotube and polyethylene—very low density (VLDPE) and using a planetary mill to form a composite material.
Item GG1837. A method for preparing a composite material, said method comprising providing a nanotube and polyethylene terephthalate (PET) and using a planetary mill to form a composite material.
Item GG1838. A method for preparing a composite material, said method comprising providing a nanotube and polyethylene (PE) and using a planetary mill to form a composite material.
Item GG1839. A method for preparing a composite material, said method comprising providing a nanotube and polyglycolide and using a planetary mill to form a composite material.
Item GG1840. A method for preparing a composite material, said method comprising providing a nanotube and polyhexamethylene adipamide (PA 6,6) and using a planetary mill to form a composite material.
Item GG1841. A method for preparing a composite material, said method comprising providing a nanotube and polyimides and using a planetary mill to form a composite material.
Item GG1842. A method for preparing a composite material, said method comprising providing a nanotube and polyisoprene (natural rubber, NR; isoprene rubber, IR) and using a planetary mill to form a composite material.
Item GG1843. A method for preparing a composite material, said method comprising providing a nanotube and polylactic acid (PLA) and using a planetary mill to form a composite material.
Item GG1844. A method for preparing a composite material, said method comprising providing a nanotube and polymethyl acrylate and using a planetary mill to form a composite material.
Item GG1845. A method for preparing a composite material, said method comprising providing a nanotube and polymethyl methacrylate (PMMA) and using a planetary mill to form a composite material.
Item GG1846. A method for preparing a composite material, said method comprising providing a nanotube and polyphenylene oxide (PPO) and using a planetary mill to form a composite material.
Item GG1847. A method for preparing a composite material, said method comprising providing a nanotube and polyphenylene sulfide (PPS) and using a planetary mill to form a composite material.
Item GG1848. A method for preparing a composite material, said method comprising providing a nanotube and poly-p-phenylene-2,6-benzobisoxazole (PBO) and using a planetary mill to form a composite material.
Item GG1849. A method for preparing a composite material, said method comprising providing a nanotube and polypropylene (PP) and using a planetary mill to form a composite material.
Item GG1850. A method for preparing a composite material, said method comprising providing a nanotube and polysiloxanes (silicones) and using a planetary mill to form a composite material.
Item GG1851. A method for preparing a composite material, said method comprising providing a nanotube and polystyrene (PS) and using a planetary mill to form a composite material.
Item GG1852. A method for preparing a composite material, said method comprising providing a nanotube and polysulfide rubber and using a planetary mill to form a composite material.
Item GG1853. A method for preparing a composite material, said method comprising providing a nanotube and polysulfides and using a planetary mill to form a composite material.
Item GG1854. A method for preparing a composite material, said method comprising providing a nanotube and polytetrafluoroethylene (PTFE) and using a planetary mill to form a composite material.
Item GG1855. A method for preparing a composite material, said method comprising providing a nanotube and polytrimethylene terephthalate (PTT) and using a planetary mill to form a composite material.
Item GG1856. A method for preparing a composite material, said method comprising providing a nanotube and polyurethane and using a planetary mill to form a composite material.
Item GG1857. A method for preparing a composite material, said method comprising providing a nanotube and polyvinyl acetate (PVAc) and using a planetary mill to form a composite material.
Item GG1858. A method for preparing a composite material, said method comprising providing a nanotube and polyvinyl chloride (PVC) and using a planetary mill to form a composite material.
Item GG1859. A method for preparing a composite material, said method comprising providing a nanotube and polyvinyl fluoride (PVF) and using a planetary mill to form a composite material.
Item GG1860. A method for preparing a composite material, said method comprising providing a nanotube and polyvinylidene chloride (PVDC) and using a planetary mill to form a composite material.
Item GG1861. A method for preparing a composite material, said method comprising providing a nanotube and polyvinylidene fluoride (PVDF) and using a planetary mill to form a composite material.
Item GG1862. A method for preparing a composite material, said method comprising providing a nanotube and rayon and using a planetary mill to form a composite material.
Item GG1863. A method for preparing a composite material, said method comprising providing a nanotube and styrene-acrylonitrile (SAN) and using a planetary mill to form a composite material.
Item GG1864. A method for preparing a composite material, said method comprising providing a nanotube and styrene-butadiene and using a planetary mill to form a composite material.
Item GG1865. A method for preparing a composite material, said method comprising providing a nanotube and styrene-isoprene and using a planetary mill to form a composite material.
Item GG1866. A method for preparing a composite material, said method comprising providing a nanotube and a styrene-maleic anhydride copolymer and using a planetary mill to form a composite material.
Item GG1867. A method for preparing a composite material, said method comprising providing a nanotube and a thermoplastic polyurethanes (TPU) and using a planetary mill to form a composite material.
Item GG1868. A method for preparing a composite material, said method comprising providing a nanotube and an unsaturated polyester and using a planetary mill to form a composite material.
Item GG1869. A method for preparing a composite material, said method comprising providing a nanotube and a urea-formaldehyde polymer and using a planetary mill to form a composite material.
Item GG1870. A method for preparing a composite material, said method comprising providing a nanotube and a vinyl copolymer and using a planetary mill to form a composite material.
Item GG1871. A method for preparing a composite material, said method comprising providing a nanotube and an acrylic polymer and using a probe sonicator to form a composite material.
Item GG1872. A method for preparing a composite material, said method comprising providing a nanotube and acrylonitrile-butadiene-styrene (ABS) and using a probe sonicator to form a composite material.
Item GG1873. A method for preparing a composite material, said method comprising providing a nanotube and an aldehyde condensation polymer and using a probe sonicator to form a composite material.
Item GG1874. A method for preparing a composite material, said method comprising providing a nanotube and an aliphatic polyether and using a probe sonicator to form a composite material.
Item GG1875. A method for preparing a composite material, said method comprising providing a nanotube and an alkyds and oil-free coating polyester and using a probe sonicator to form a composite material.
Item GG1876. A method for preparing a composite material, said method comprising providing a nanotube and an aramid and using a probe sonicator to form a composite material.
Item GG1877. A method for preparing a composite material, said method comprising providing a nanotube and butyl rubber and using a probe sonicator to form a composite material.
Item GG1878. A method for preparing a composite material, said method comprising providing a nanotube and cellulose acetate and using a probe sonicator to form a composite material.
Item GG1879. A method for preparing a composite material, said method comprising providing a nanotube and cellulose nitrate and using a probe sonicator to form a composite material.
Item GG1880. A method for preparing a composite material, said method comprising providing a nanotube and a cellulosic and using a probe sonicator to form a composite material.
Item GG1881. A method for preparing a composite material, said method comprising providing a nanotube and a cyanoacrylate polymer and using a probe sonicator to form a composite material.
Item GG1882. A method for preparing a composite material, said method comprising providing a nanotube and a diene polymer and using a probe sonicator to form a composite material.
Item GG1883. A method for preparing a composite material, said method comprising providing a nanotube and an epoxy and using a probe sonicator to form a composite material.
Item GG1884. A method for preparing a composite material, said method comprising providing a nanotube and an ethylene-propylene copolymer and using a probe sonicator to form a composite material.
Item GG1885. A method for preparing a composite material, said method comprising providing a nanotube and a fluoroelastomer and using a probe sonicator to form a composite material.
Item GG1886. A method for preparing a composite material, said method comprising providing a nanotube and a heterochain polymer and using a probe sonicator to form a composite material.
Item GG1887. A method for preparing a composite material, said method comprising providing a nanotube and a melamine-formaldehyde polymer and using a probe sonicator to form a composite material.
Item GG1888. A method for preparing a composite material, said method comprising providing a nanotube and a meta-aramid polymer and using a probe sonicator to form a composite material.
Item GG1889. A method for preparing a composite material, said method comprising providing a nanotube and nitrile rubber and using a probe sonicator to form a composite material.
Item GG1890. A method for preparing a composite material, said method comprising providing a nanotube and nylon and using a probe sonicator to form a composite material.
Item GG1891. A method for preparing a composite material, said method comprising providing a nanotube and a para-aramid and using a probe sonicator to form a composite material.
Item GG1892. A method for preparing a composite material, said method comprising providing a nanotube and poly 2-hydroxyethyl methacrylate (HEMA) and using a probe sonicator to form a composite material.
Item GG1893. A method for preparing a composite material, said method comprising providing a nanotube and poly bisphenol A carbonate (PC) and using a probe sonicator to form a composite material.
Item GG1894. A method for preparing a composite material, said method comprising providing a nanotube and poly butylene terephthalate (PBT) and using a probe sonicator to form a composite material.
Item GG1895. A method for preparing a composite material, said method comprising providing a nanotube and poly dimethylsiloxane (PDMS) and using a probe sonicator to form a composite material.
Item GG1896. A method for preparing a composite material, said method comprising providing a nanotube and poly dodecano-12-lactam (Nylon 12) and using a probe sonicator to form a composite material.
Item GG1897. A method for preparing a composite material, said method comprising providing a nanotube and poly ether ketone ketone (PEKK) and using a probe sonicator to form a composite material.
Item GG1898. A method for preparing a composite material, said method comprising providing a nanotube and poly ethylene terephthalate (PET) and using a probe sonicator to form a composite material.
Item GG1899. A method for preparing a composite material, said method comprising providing a nanotube and poly methyl acrylate (PMA) and using a probe sonicator to form a composite material.
Item GG1900. A method for preparing a composite material, said method comprising providing a nanotube and poly methyl methacrylate (PMMA) and using a probe sonicator to form a composite material.
Item GG1901. A method for preparing a composite material, said method comprising providing a nanotube and poly vinyl acetate (PVA) and using a probe sonicator to form a composite material.
Item GG1902. A method for preparing a composite material, said method comprising providing a nanotube and poly vinyl chloride (PVC) and using a probe sonicator to form a composite material.
Item GG1903. A method for preparing a composite material, said method comprising providing a nanotube and poly vinylidene chloride (PVDC) and using a probe sonicator to form a composite material.
Item GG1904. A method for preparing a composite material, said method comprising providing a nanotube and poly vinylidene fluoride (PVDF) and using a probe sonicator to form a composite material.
Item GG1905. A method for preparing a composite material, said method comprising providing a nanotube and poly(acrylic acid) and using a probe sonicator to form a composite material.
Item GG1906. A method for preparing a composite material, said method comprising providing a nanotube and poly(Bisphenol A isophthalate) and using a probe sonicator to form a composite material.
Item GG1907. A method for preparing a composite material, said method comprising providing a nanotube and poly(Bisphenol A terephthalate) and using a probe sonicator to form a composite material.
Item GG1908. A method for preparing a composite material, said method comprising providing a nanotube and poly(butyl acrylate) and using a probe sonicator to form a composite material.
Item GG1909. A method for preparing a composite material, said method comprising providing a nanotube and poly(butyl methacrylate) and using a probe sonicator to form a composite material.
Item GG1910. A method for preparing a composite material, said method comprising providing a nanotube and poly(butylene) and using a probe sonicator to form a composite material.
Item GG1911. A method for preparing a composite material, said method comprising providing a nanotube and poly(caprolactone) and using a probe sonicator to form a composite material.
Item GG1912. A method for preparing a composite material, said method comprising providing a nanotube and poly(chlorotrifluoroethylene) and using a probe sonicator to form a composite material.
Item GG1913. A method for preparing a composite material, said method comprising providing a nanotube and poly(cyclohexyl methacrylate) and using a probe sonicator to form a composite material.
Item GG1914. A method for preparing a composite material, said method comprising providing a nanotube and poly(ethyl acrylate) and using a probe sonicator to form a composite material.
Item GG1915. A method for preparing a composite material, said method comprising providing a nanotube and poly(ethylene glycol) and using a probe sonicator to form a composite material.
Item GG1916. A method for preparing a composite material, said method comprising providing a nanotube and poly(ethylene naphthalate) and using a probe sonicator to form a composite material.
Item GG1917. A method for preparing a composite material, said method comprising providing a nanotube and poly(isobutylene) and using a probe sonicator to form a composite material.
Item GG1918. A method for preparing a composite material, said method comprising providing a nanotube and poly(phenylsulfone) and using a probe sonicator to form a composite material.
Item GG1919. A method for preparing a composite material, said method comprising providing a nanotube and poly(propylene glycol) and using a probe sonicator to form a composite material.
Item GG1920. A method for preparing a composite material, said method comprising providing a nanotube and poly(tetrahydrofuran) and using a probe sonicator to form a composite material.
Item GG1921. A method for preparing a composite material, said method comprising providing a nanotube and poly(α-methylstyrene) and using a probe sonicator to form a composite material.
Item GG1922. A method for preparing a composite material, said method comprising providing a nanotube and polyacetal and using a probe sonicator to form a composite material.
Item GG1923. A method for preparing a composite material, said method comprising providing a nanotube and polyacetal (POM) and using a probe sonicator to form a composite material.
Item GG1924. A method for preparing a composite material, said method comprising providing a nanotube and polyacrylate elastomers and using a probe sonicator to form a composite material.
Item GG1925. A method for preparing a composite material, said method comprising providing a nanotube and polyacrylonitrile (PAN) and using a probe sonicator to form a composite material.
Item GG1926. A method for preparing a composite material, said method comprising providing a nanotube and polyamide and using a probe sonicator to form a composite material.
Item GG1927. A method for preparing a composite material, said method comprising providing a nanotube and polybutadiene (PBD) and using a probe sonicator to form a composite material.
Item GG1928. A method for preparing a composite material, said method comprising providing a nanotube and polybutadiene (butadiene rubber, BR) and using a probe sonicator to form a composite material.
Item GG1929. A method for preparing a composite material, said method comprising providing a nanotube and polybutylene terephthalate (PBT) and using a probe sonicator to form a composite material.
Item GG1930. A method for preparing a composite material, said method comprising providing a nanotube and polycaprolactam and using a probe sonicator to form a composite material.
Item GG1931. A method for preparing a composite material, said method comprising providing a nanotube and polycarbonate (PC) and using a probe sonicator to form a composite material.
Item GG1932. A method for preparing a composite material, said method comprising providing a nanotube and polychloroprene and using a probe sonicator to form a composite material.
Item GG1933. A method for preparing a composite material, said method comprising providing a nanotube and polychlorotrifluoroethylene (PCTFE) and using a probe sonicator to form a composite material.
Item GG1934. A method for preparing a composite material, said method comprising providing a nanotube and polyesters and using a probe sonicator to form a composite material.
Item GG1935. A method for preparing a composite material, said method comprising providing a nanotube and polyether ether ketone (PEEK) and using a probe sonicator to form a composite material.
Item GG1936. A method for preparing a composite material, said method comprising providing a nanotube and polyetherketone (PEK) and using a probe sonicator to form a composite material.
Item GG1937. A method for preparing a composite material, said method comprising providing a nanotube and polyethers and using a probe sonicator to form a composite material.
Item GG1938. A method for preparing a composite material, said method comprising providing a nanotube and polyethersulfone (PES) and using a probe sonicator to form a composite material.
Item GG1939. A method for preparing a composite material, said method comprising providing a nanotube and polyethyl acrylate and using a probe sonicator to form a composite material.
Item GG1940. A method for preparing a composite material, said method comprising providing a nanotube and polyethylene—cross-linked and using a probe sonicator to form a composite material.
Item GG1941. A method for preparing a composite material, said method comprising providing a nanotube and polyethylene—high density (HDPE) and using a probe sonicator to form a composite material.
Item GG1942. A method for preparing a composite material, said method comprising providing a nanotube and polyethylene—linear low density (LLDPE) and using a probe sonicator to form a composite material.
Item GG1943. A method for preparing a composite material, said method comprising providing a nanotube and polyethylene—low density (LDPE) and using a probe sonicator to form a composite material.
Item GG1944. A method for preparing a composite material, said method comprising providing a nanotube and polyethylene—medium density (MDPE) and using a probe sonicator to form a composite material.
Item GG1945. A method for preparing a composite material, said method comprising providing a nanotube and polyethylene—ultrahigh molecular weight (UHMWPE) and using a probe sonicator to form a composite material.
Item GG1946. A method for preparing a composite material, said method comprising providing a nanotube and polyethylene—very low density (VLDPE) and using a probe sonicator to form a composite material.
Item GG1947. A method for preparing a composite material, said method comprising providing a nanotube and polyethylene terephthalate (PET) and using a probe sonicator to form a composite material.
Item GG1948. A method for preparing a composite material, said method comprising providing a nanotube and polyethylene (PE) and using a probe sonicator to form a composite material.
Item GG1949. A method for preparing a composite material, said method comprising providing a nanotube and polyglycolide and using a probe sonicator to form a composite material.
Item GG1950. A method for preparing a composite material, said method comprising providing a nanotube and polyhexamethylene adipamide (PA 6,6) and using a probe sonicator to form a composite material.
Item GG1951. A method for preparing a composite material, said method comprising providing a nanotube and polyimides and using a probe sonicator to form a composite material.
Item GG1952. A method for preparing a composite material, said method comprising providing a nanotube and polyisoprene (natural rubber, NR; isoprene rubber, IR) and using a probe sonicator to form a composite material.
Item GG1953. A method for preparing a composite material, said method comprising providing a nanotube and polylactic acid (PLA) and using a probe sonicator to form a composite material.
Item GG1954. A method for preparing a composite material, said method comprising providing a nanotube and polymethyl acrylate and using a probe sonicator to form a composite material.
Item GG1955. A method for preparing a composite material, said method comprising providing a nanotube and polymethyl methacrylate (PMMA) and using a probe sonicator to form a composite material.
Item GG1956. A method for preparing a composite material, said method comprising providing a nanotube and polyphenylene oxide (PPO) and using a probe sonicator to form a composite material.
Item GG1957. A method for preparing a composite material, said method comprising providing a nanotube and polyphenylene sulfide (PPS) and using a probe sonicator to form a composite material.
Item GG1958. A method for preparing a composite material, said method comprising providing a nanotube and poly-p-phenylene-2,6-benzobisoxazole (PBO) and using a probe sonicator to form a composite material.
Item GG1959. A method for preparing a composite material, said method comprising providing a nanotube and polypropylene (PP) and using a probe sonicator to form a composite material.
Item GG1960. A method for preparing a composite material, said method comprising providing a nanotube and polysiloxanes (silicones) and using a probe sonicator to form a composite material.
Item GG1961. A method for preparing a composite material, said method comprising providing a nanotube and polystyrene (PS) and using a probe sonicator to form a composite material.
Item GG1962. A method for preparing a composite material, said method comprising providing a nanotube and polysulfide rubber and using a probe sonicator to form a composite material.
Item GG1963. A method for preparing a composite material, said method comprising providing a nanotube and polysulfides and using a probe sonicator to form a composite material.
Item GG1964. A method for preparing a composite material, said method comprising providing a nanotube and polytetrafluoroethylene (PTFE) and using a probe sonicator to form a composite material.
Item GG1965. A method for preparing a composite material, said method comprising providing a nanotube and polytrimethylene terephthalate (PTT) and using a probe sonicator to form a composite material.
Item GG1966. A method for preparing a composite material, said method comprising providing a nanotube and polyurethane and using a probe sonicator to form a composite material.
Item GG1967. A method for preparing a composite material, said method comprising providing a nanotube and polyvinyl acetate (PVAc) and using a probe sonicator to form a composite material.
Item GG1968. A method for preparing a composite material, said method comprising providing a nanotube and polyvinyl chloride (PVC) and using a probe sonicator to form a composite material.
Item GG1969. A method for preparing a composite material, said method comprising providing a nanotube and polyvinyl fluoride (PVF) and using a probe sonicator to form a composite material.
Item GG1970. A method for preparing a composite material, said method comprising providing a nanotube and polyvinylidene chloride (PVDC) and using a probe sonicator to form a composite material.
Item GG1971. A method for preparing a composite material, said method comprising providing a nanotube and polyvinylidene fluoride (PVDF) and using a probe sonicator to form a composite material.
Item GG1972. A method for preparing a composite material, said method comprising providing a nanotube and rayon and using a probe sonicator to form a composite material.
Item GG1973. A method for preparing a composite material, said method comprising providing a nanotube and styrene-acrylonitrile (SAN) and using a probe sonicator to form a composite material.
Item GG1974. A method for preparing a composite material, said method comprising providing a nanotube and styrene-butadiene and using a probe sonicator to form a composite material.
Item GG1975. A method for preparing a composite material, said method comprising providing a nanotube and styrene-isoprene and using a probe sonicator to form a composite material.
Item GG1976. A method for preparing a composite material, said method comprising providing a nanotube and a styrene-maleic anhydride copolymer and using a probe sonicator to form a composite material.
Item GG1977. A method for preparing a composite material, said method comprising providing a nanotube and a thermoplastic polyurethanes (TPU) and using a probe sonicator to form a composite material.
Item GG1978. A method for preparing a composite material, said method comprising providing a nanotube and an unsaturated polyester and using a probe sonicator to form a composite material.
Item GG1979. A method for preparing a composite material, said method comprising providing a nanotube and a urea-formaldehyde polymer and using a probe sonicator to form a composite material.
Item GG1980. A method for preparing a composite material, said method comprising providing a nanotube and a vinyl copolymer and using a probe sonicator to form a composite material.
Item GG1981. A method for preparing a composite material, said method comprising providing a nanotube and an acrylic polymer and using a rod mill to form a composite material.
Item GG1982. A method for preparing a composite material, said method comprising providing a nanotube and acrylonitrile-butadiene-styrene (ABS) and using a rod mill to form a composite material.
Item GG1983. A method for preparing a composite material, said method comprising providing a nanotube and an aldehyde condensation polymer and using a rod mill to form a composite material.
Item GG1984. A method for preparing a composite material, said method comprising providing a nanotube and an aliphatic polyether and using a rod mill to form a composite material.
Item GG1985. A method for preparing a composite material, said method comprising providing a nanotube and an alkyds and oil-free coating polyester and using a rod mill to form a composite material.
Item GG1986. A method for preparing a composite material, said method comprising providing a nanotube and an aramid and using a rod mill to form a composite material.
Item GG1987. A method for preparing a composite material, said method comprising providing a nanotube and butyl rubber and using a rod mill to form a composite material.
Item GG1988. A method for preparing a composite material, said method comprising providing a nanotube and cellulose acetate and using a rod mill to form a composite material.
Item GG1989. A method for preparing a composite material, said method comprising providing a nanotube and cellulose nitrate and using a rod mill to form a composite material.
Item GG1990. A method for preparing a composite material, said method comprising providing a nanotube and a cellulosic and using a rod mill to form a composite material.
Item GG1991. A method for preparing a composite material, said method comprising providing a nanotube and a cyanoacrylate polymer and using a rod mill to form a composite material.
Item GG1992. A method for preparing a composite material, said method comprising providing a nanotube and a diene polymer and using a rod mill to form a composite material.
Item GG1993. A method for preparing a composite material, said method comprising providing a nanotube and an epoxy and using a rod mill to form a composite material.
Item GG1994. A method for preparing a composite material, said method comprising providing a nanotube and an ethylene-propylene copolymer and using a rod mill to form a composite material.
Item GG1995. A method for preparing a composite material, said method comprising providing a nanotube and a fluoroelastomer and using a rod mill to form a composite material.
Item GG1996. A method for preparing a composite material, said method comprising providing a nanotube and a heterochain polymer and using a rod mill to form a composite material.
Item GG1997. A method for preparing a composite material, said method comprising providing a nanotube and a melamine-formaldehyde polymer and using a rod mill to form a composite material.
Item GG1998. A method for preparing a composite material, said method comprising providing a nanotube and a meta-aramid polymer and using a rod mill to form a composite material.
Item GG1999. A method for preparing a composite material, said method comprising providing a nanotube and nitrile rubber and using a rod mill to form a composite material.
Item GG2000. A method for preparing a composite material, said method comprising providing a nanotube and nylon and using a rod mill to form a composite material.
Item GG2001. A method for preparing a composite material, said method comprising providing a nanotube and a para-aramid and using a rod mill to form a composite material.
Item GG2002. A method for preparing a composite material, said method comprising providing a nanotube and poly 2-hydroxyethyl methacrylate (HEMA) and using a rod mill to form a composite material.
Item GG2003. A method for preparing a composite material, said method comprising providing a nanotube and poly bisphenol A carbonate (PC) and using a rod mill to form a composite material.
Item GG2004. A method for preparing a composite material, said method comprising providing a nanotube and poly butylene terephthalate (PBT) and using a rod mill to form a composite material.
Item GG2005. A method for preparing a composite material, said method comprising providing a nanotube and poly dimethylsiloxane (PDMS) and using a rod mill to form a composite material.
Item GG2006. A method for preparing a composite material, said method comprising providing a nanotube and poly dodecano-12-lactam (Nylon 12) and using a rod mill to form a composite material.
Item GG2007. A method for preparing a composite material, said method comprising providing a nanotube and poly ether ketone ketone (PEKK) and using a rod mill to form a composite material.
Item GG2008. A method for preparing a composite material, said method comprising providing a nanotube and poly ethylene terephthalate (PET) and using a rod mill to form a composite material.
Item GG2009. A method for preparing a composite material, said method comprising providing a nanotube and poly methyl acrylate (PMA) and using a rod mill to form a composite material.
Item GG2010. A method for preparing a composite material, said method comprising providing a nanotube and poly methyl methacrylate (PMMA) and using a rod mill to form a composite material.
Item GG2011. A method for preparing a composite material, said method comprising providing a nanotube and poly vinyl acetate (PVA) and using a rod mill to form a composite material.
Item GG2012. A method for preparing a composite material, said method comprising providing a nanotube and poly vinyl chloride (PVC) and using a rod mill to form a composite material.
Item GG2013. A method for preparing a composite material, said method comprising providing a nanotube and poly vinylidene chloride (PVDC) and using a rod mill to form a composite material.
Item GG2014. A method for preparing a composite material, said method comprising providing a nanotube and poly vinylidene fluoride (PVDF) and using a rod mill to form a composite material.
Item GG2015. A method for preparing a composite material, said method comprising providing a nanotube and poly(acrylic acid) and using a rod mill to form a composite material.
Item GG2016. A method for preparing a composite material, said method comprising providing a nanotube and poly(Bisphenol A isophthalate) and using a rod mill to form a composite material.
Item GG2017. A method for preparing a composite material, said method comprising providing a nanotube and poly(Bisphenol A terephthalate) and using a rod mill to form a composite material.
Item GG2018. A method for preparing a composite material, said method comprising providing a nanotube and poly(butyl acrylate) and using a rod mill to form a composite material.
Item GG2019. A method for preparing a composite material, said method comprising providing a nanotube and poly(butyl methacrylate) and using a rod mill to form a composite material.
Item GG2020. A method for preparing a composite material, said method comprising providing a nanotube and poly(butylene) and using a rod mill to form a composite material.
Item GG2021. A method for preparing a composite material, said method comprising providing a nanotube and poly(caprolactone) and using a rod mill to form a composite material.
Item GG2022. A method for preparing a composite material, said method comprising providing a nanotube and poly(chlorotrifluoroethylene) and using a rod mill to form a composite material.
Item GG2023. A method for preparing a composite material, said method comprising providing a nanotube and poly(cyclohexyl methacrylate) and using a rod mill to form a composite material.
Item GG2024. A method for preparing a composite material, said method comprising providing a nanotube and poly(ethyl acrylate) and using a rod mill to form a composite material.
Item GG2025. A method for preparing a composite material, said method comprising providing a nanotube and poly(ethylene glycol) and using a rod mill to form a composite material.
Item GG2026. A method for preparing a composite material, said method comprising providing a nanotube and poly(ethylene naphthalate) and using a rod mill to form a composite material.
Item GG2027. A method for preparing a composite material, said method comprising providing a nanotube and poly(isobutylene) and using a rod mill to form a composite material.
Item GG2028. A method for preparing a composite material, said method comprising providing a nanotube and poly(phenylsulfone) and using a rod mill to form a composite material.
Item GG2029. A method for preparing a composite material, said method comprising providing a nanotube and poly(propylene glycol) and using a rod mill to form a composite material.
Item GG2030. A method for preparing a composite material, said method comprising providing a nanotube and poly(tetrahydrofuran) and using a rod mill to form a composite material.
Item GG2031. A method for preparing a composite material, said method comprising providing a nanotube and poly(α-methylstyrene) and using a rod mill to form a composite material.
Item GG2032. A method for preparing a composite material, said method comprising providing a nanotube and polyacetal and using a rod mill to form a composite material.
Item GG2033. A method for preparing a composite material, said method comprising providing a nanotube and polyacetal (POM) and using a rod mill to form a composite material.
Item GG2034. A method for preparing a composite material, said method comprising providing a nanotube and polyacrylate elastomers and using a rod mill to form a composite material.
Item GG2035. A method for preparing a composite material, said method comprising providing a nanotube and polyacrylonitrile (PAN) and using a rod mill to form a composite material.
Item GG2036. A method for preparing a composite material, said method comprising providing a nanotube and polyamide and using a rod mill to form a composite material.
Item GG2037. A method for preparing a composite material, said method comprising providing a nanotube and polybutadiene (PBD) and using a rod mill to form a composite material.
Item GG2038. A method for preparing a composite material, said method comprising providing a nanotube and polybutadiene (butadiene rubber, BR) and using a rod mill to form a composite material.
Item GG2039. A method for preparing a composite material, said method comprising providing a nanotube and polybutylene terephthalate (PBT) and using a rod mill to form a composite material.
Item GG2040. A method for preparing a composite material, said method comprising providing a nanotube and polycaprolactam and using a rod mill to form a composite material.
Item GG2041. A method for preparing a composite material, said method comprising providing a nanotube and polycarbonate (PC) and using a rod mill to form a composite material.
Item GG2042. A method for preparing a composite material, said method comprising providing a nanotube and polychloroprene and using a rod mill to form a composite material.
Item GG2043. A method for preparing a composite material, said method comprising providing a nanotube and polychlorotrifluoroethylene (PCTFE) and using a rod mill to form a composite material.
Item GG2044. A method for preparing a composite material, said method comprising providing a nanotube and polyesters and using a rod mill to form a composite material.
Item GG2045. A method for preparing a composite material, said method comprising providing a nanotube and polyether ether ketone (PEEK) and using a rod mill to form a composite material.
Item GG2046. A method for preparing a composite material, said method comprising providing a nanotube and polyetherketone (PEK) and using a rod mill to form a composite material.
Item GG2047. A method for preparing a composite material, said method comprising providing a nanotube and polyethers and using a rod mill to form a composite material.
Item GG2048. A method for preparing a composite material, said method comprising providing a nanotube and polyethersulfone (PES) and using a rod mill to form a composite material.
Item GG2049. A method for preparing a composite material, said method comprising providing a nanotube and polyethyl acrylate and using a rod mill to form a composite material.
Item GG2050. A method for preparing a composite material, said method comprising providing a nanotube and polyethylene—cross-linked and using a rod mill to form a composite material.
Item GG2051. A method for preparing a composite material, said method comprising providing a nanotube and polyethylene—high density (HDPE) and using a rod mill to form a composite material.
Item GG2052. A method for preparing a composite material, said method comprising providing a nanotube and polyethylene—linear low density (LLDPE) and using a rod mill to form a composite material.
Item GG2053. A method for preparing a composite material, said method comprising providing a nanotube and polyethylene—low density (LDPE) and using a rod mill to form a composite material.
Item GG2054. A method for preparing a composite material, said method comprising providing a nanotube and polyethylene—medium density (MDPE) and using a rod mill to form a composite material.
Item GG2055. A method for preparing a composite material, said method comprising providing a nanotube and polyethylene—ultrahigh molecular weight (UHMWPE) and using a rod mill to form a composite material.
Item GG2056. A method for preparing a composite material, said method comprising providing a nanotube and polyethylene—very low density (VLDPE) and using a rod mill to form a composite material.
Item GG2057. A method for preparing a composite material, said method comprising providing a nanotube and polyethylene terephthalate (PET) and using a rod mill to form a composite material.
Item GG2058. A method for preparing a composite material, said method comprising providing a nanotube and polyethylene (PE) and using a rod mill to form a composite material.
Item GG2059. A method for preparing a composite material, said method comprising providing a nanotube and polyglycolide and using a rod mill to form a composite material.
Item GG2060. A method for preparing a composite material, said method comprising providing a nanotube and polyhexamethylene adipamide (PA 6,6) and using a rod mill to form a composite material.
Item GG2061. A method for preparing a composite material, said method comprising providing a nanotube and polyimides and using a rod mill to form a composite material.
Item GG2062. A method for preparing a composite material, said method comprising providing a nanotube and polyisoprene (natural rubber, NR; isoprene rubber, IR) and using a rod mill to form a composite material.
Item GG2063. A method for preparing a composite material, said method comprising providing a nanotube and polylactic acid (PLA) and using a rod mill to form a composite material.
Item GG2064. A method for preparing a composite material, said method comprising providing a nanotube and polymethyl acrylate and using a rod mill to form a composite material.
Item GG2065. A method for preparing a composite material, said method comprising providing a nanotube and polymethyl methacrylate (PMMA) and using a rod mill to form a composite material.
Item GG2066. A method for preparing a composite material, said method comprising providing a nanotube and polyphenylene oxide (PPO) and using a rod mill to form a composite material.
Item GG2067. A method for preparing a composite material, said method comprising providing a nanotube and polyphenylene sulfide (PPS) and using a rod mill to form a composite material.
Item GG2068. A method for preparing a composite material, said method comprising providing a nanotube and poly-p-phenylene-2,6-benzobisoxazole (PBO) and using a rod mill to form a composite material.
Item GG2069. A method for preparing a composite material, said method comprising providing a nanotube and polypropylene (PP) and using a rod mill to form a composite material.
Item GG2070. A method for preparing a composite material, said method comprising providing a nanotube and polysiloxanes (silicones) and using a rod mill to form a composite material.
Item GG2071. A method for preparing a composite material, said method comprising providing a nanotube and polystyrene (PS) and using a rod mill to form a composite material.
Item GG2072. A method for preparing a composite material, said method comprising providing a nanotube and polysulfide rubber and using a rod mill to form a composite material.
Item GG2073. A method for preparing a composite material, said method comprising providing a nanotube and polysulfides and using a rod mill to form a composite material.
Item GG2074. A method for preparing a composite material, said method comprising providing a nanotube and polytetrafluoroethylene (PTFE) and using a rod mill to form a composite material.
Item GG2075. A method for preparing a composite material, said method comprising providing a nanotube and polytrimethylene terephthalate (PTT) and using a rod mill to form a composite material.
Item GG2076. A method for preparing a composite material, said method comprising providing a nanotube and polyurethane and using a rod mill to form a composite material.
Item GG2077. A method for preparing a composite material, said method comprising providing a nanotube and polyvinyl acetate (PVAc) and using a rod mill to form a composite material.
Item GG2078. A method for preparing a composite material, said method comprising providing a nanotube and polyvinyl chloride (PVC) and using a rod mill to form a composite material.
Item GG2079. A method for preparing a composite material, said method comprising providing a nanotube and polyvinyl fluoride (PVF) and using a rod mill to form a composite material.
Item GG2080. A method for preparing a composite material, said method comprising providing a nanotube and polyvinylidene chloride (PVDC) and using a rod mill to form a composite material.
Item GG2081. A method for preparing a composite material, said method comprising providing a nanotube and polyvinylidene fluoride (PVDF) and using a rod mill to form a composite material.
Item GG2082. A method for preparing a composite material, said method comprising providing a nanotube and rayon and using a rod mill to form a composite material.
Item GG2083. A method for preparing a composite material, said method comprising providing a nanotube and styrene-acrylonitrile (SAN) and using a rod mill to form a composite material.
Item GG2084. A method for preparing a composite material, said method comprising providing a nanotube and styrene-butadiene and using a rod mill to form a composite material.
Item GG2085. A method for preparing a composite material, said method comprising providing a nanotube and styrene-isoprene and using a rod mill to form a composite material.
Item GG2086. A method for preparing a composite material, said method comprising providing a nanotube and a styrene-maleic anhydride copolymer and using a rod mill to form a composite material.
Item GG2087. A method for preparing a composite material, said method comprising providing a nanotube and a thermoplastic polyurethanes (TPU) and using a rod mill to form a composite material.
Item GG2088. A method for preparing a composite material, said method comprising providing a nanotube and an unsaturated polyester and using a rod mill to form a composite material.
Item GG2089. A method for preparing a composite material, said method comprising providing a nanotube and a urea-formaldehyde polymer and using a rod mill to form a composite material.
Item GG2090. A method for preparing a composite material, said method comprising providing a nanotube and a vinyl copolymer and using a rod mill to form a composite material.
Item GG2091. A method for preparing a composite material, said method comprising providing a nanotube and an acrylic polymer and using a rotor mill to form a composite material.
Item GG2092. A method for preparing a composite material, said method comprising providing a nanotube and acrylonitrile-butadiene-styrene (ABS) and using a rotor mill to form a composite material.
Item GG2093. A method for preparing a composite material, said method comprising providing a nanotube and an aldehyde condensation polymer and using a rotor mill to form a composite material.
Item GG2094. A method for preparing a composite material, said method comprising providing a nanotube and an aliphatic polyether and using a rotor mill to form a composite material.
Item GG2095. A method for preparing a composite material, said method comprising providing a nanotube and an alkyds and oil-free coating polyester and using a rotor mill to form a composite material.
Item GG2096. A method for preparing a composite material, said method comprising providing a nanotube and an aramid and using a rotor mill to form a composite material.
Item GG2097. A method for preparing a composite material, said method comprising providing a nanotube and butyl rubber and using a rotor mill to form a composite material.
Item GG2098. A method for preparing a composite material, said method comprising providing a nanotube and cellulose acetate and using a rotor mill to form a composite material.
Item GG2099. A method for preparing a composite material, said method comprising providing a nanotube and cellulose nitrate and using a rotor mill to form a composite material.
Item GG2100. A method for preparing a composite material, said method comprising providing a nanotube and a cellulosic and using a rotor mill to form a composite material.
Item GG2101. A method for preparing a composite material, said method comprising providing a nanotube and a cyanoacrylate polymer and using a rotor mill to form a composite material.
Item GG2102. A method for preparing a composite material, said method comprising providing a nanotube and a diene polymer and using a rotor mill to form a composite material.
Item GG2103. A method for preparing a composite material, said method comprising providing a nanotube and an epoxy and using a rotor mill to form a composite material.
Item GG2104. A method for preparing a composite material, said method comprising providing a nanotube and an ethylene-propylene copolymer and using a rotor mill to form a composite material.
Item GG2105. A method for preparing a composite material, said method comprising providing a nanotube and a fluoroelastomer and using a rotor mill to form a composite material.
Item GG2106. A method for preparing a composite material, said method comprising providing a nanotube and a heterochain polymer and using a rotor mill to form a composite material.
Item GG2107. A method for preparing a composite material, said method comprising providing a nanotube and a melamine-formaldehyde polymer and using a rotor mill to form a composite material.
Item GG2108. A method for preparing a composite material, said method comprising providing a nanotube and a meta-aramid polymer and using a rotor mill to form a composite material.
Item GG2109. A method for preparing a composite material, said method comprising providing a nanotube and nitrile rubber and using a rotor mill to form a composite material.
Item GG2110. A method for preparing a composite material, said method comprising providing a nanotube and nylon and using a rotor mill to form a composite material.
Item GG2111. A method for preparing a composite material, said method comprising providing a nanotube and a para-aramid and using a rotor mill to form a composite material.
Item GG2112. A method for preparing a composite material, said method comprising providing a nanotube and poly 2-hydroxyethyl methacrylate (HEMA) and using a rotor mill to form a composite material.
Item GG2113. A method for preparing a composite material, said method comprising providing a nanotube and poly bisphenol A carbonate (PC) and using a rotor mill to form a composite material.
Item GG2114. A method for preparing a composite material, said method comprising providing a nanotube and poly butylene terephthalate (PBT) and using a rotor mill to form a composite material.
Item GG2115. A method for preparing a composite material, said method comprising providing a nanotube and poly dimethylsiloxane (PDMS) and using a rotor mill to form a composite material.
Item GG2116. A method for preparing a composite material, said method comprising providing a nanotube and poly dodecano-12-lactam (Nylon 12) and using a rotor mill to form a composite material.
Item GG2117. A method for preparing a composite material, said method comprising providing a nanotube and poly ether ketone ketone (PEKK) and using a rotor mill to form a composite material.
Item GG2118. A method for preparing a composite material, said method comprising providing a nanotube and poly ethylene terephthalate (PET) and using a rotor mill to form a composite material.
Item GG2119. A method for preparing a composite material, said method comprising providing a nanotube and poly methyl acrylate (PMA) and using a rotor mill to form a composite material.
Item GG2120. A method for preparing a composite material, said method comprising providing a nanotube and poly methyl methacrylate (PMMA) and using a rotor mill to form a composite material.
Item GG2121. A method for preparing a composite material, said method comprising providing a nanotube and poly vinyl acetate (PVA) and using a rotor mill to form a composite material.
Item GG2122. A method for preparing a composite material, said method comprising providing a nanotube and poly vinyl chloride (PVC) and using a rotor mill to form a composite material.
Item GG2123. A method for preparing a composite material, said method comprising providing a nanotube and poly vinylidene chloride (PVDC) and using a rotor mill to form a composite material.
Item GG2124. A method for preparing a composite material, said method comprising providing a nanotube and poly vinylidene fluoride (PVDF) and using a rotor mill to form a composite material.
Item GG2125. A method for preparing a composite material, said method comprising providing a nanotube and poly(acrylic acid) and using a rotor mill to form a composite material.
Item GG2126. A method for preparing a composite material, said method comprising providing a nanotube and poly(Bisphenol A isophthalate) and using a rotor mill to form a composite material.
Item GG2127. A method for preparing a composite material, said method comprising providing a nanotube and poly(Bisphenol A terephthalate) and using a rotor mill to form a composite material.
Item GG2128. A method for preparing a composite material, said method comprising providing a nanotube and poly(butyl acrylate) and using a rotor mill to form a composite material.
Item GG2129. A method for preparing a composite material, said method comprising providing a nanotube and poly(butyl methacrylate) and using a rotor mill to form a composite material.
Item GG2130. A method for preparing a composite material, said method comprising providing a nanotube and poly(butylene) and using a rotor mill to form a composite material.
Item GG2131. A method for preparing a composite material, said method comprising providing a nanotube and poly(caprolactone) and using a rotor mill to form a composite material.
Item GG2132. A method for preparing a composite material, said method comprising providing a nanotube and poly(chlorotrifluoroethylene) and using a rotor mill to form a composite material.
Item GG2133. A method for preparing a composite material, said method comprising providing a nanotube and poly(cyclohexyl methacrylate) and using a rotor mill to form a composite material.
Item GG2134. A method for preparing a composite material, said method comprising providing a nanotube and poly(ethyl acrylate) and using a rotor mill to form a composite material.
Item GG2135. A method for preparing a composite material, said method comprising providing a nanotube and poly(ethylene glycol) and using a rotor mill to form a composite material.
Item GG2136. A method for preparing a composite material, said method comprising providing a nanotube and poly(ethylene naphthalate) and using a rotor mill to form a composite material.
Item GG2137. A method for preparing a composite material, said method comprising providing a nanotube and poly(isobutylene) and using a rotor mill to form a composite material.
Item GG2138. A method for preparing a composite material, said method comprising providing a nanotube and poly(phenylsulfone) and using a rotor mill to form a composite material.
Item GG2139. A method for preparing a composite material, said method comprising providing a nanotube and poly(propylene glycol) and using a rotor mill to form a composite material.
Item GG2140. A method for preparing a composite material, said method comprising providing a nanotube and poly(tetrahydrofuran) and using a rotor mill to form a composite material.
Item GG2141. A method for preparing a composite material, said method comprising providing a nanotube and poly(α-methylstyrene) and using a rotor mill to form a composite material.
Item GG2142. A method for preparing a composite material, said method comprising providing a nanotube and polyacetal and using a rotor mill to form a composite material.
Item GG2143. A method for preparing a composite material, said method comprising providing a nanotube and polyacetal (POM) and using a rotor mill to form a composite material.
Item GG2144. A method for preparing a composite material, said method comprising providing a nanotube and polyacrylate elastomers and using a rotor mill to form a composite material.
Item GG2145. A method for preparing a composite material, said method comprising providing a nanotube and polyacrylonitrile (PAN) and using a rotor mill to form a composite material.
Item GG2146. A method for preparing a composite material, said method comprising providing a nanotube and polyamide and using a rotor mill to form a composite material.
Item GG2147. A method for preparing a composite material, said method comprising providing a nanotube and polybutadiene (PBD) and using a rotor mill to form a composite material.
Item GG2148. A method for preparing a composite material, said method comprising providing a nanotube and polybutadiene (butadiene rubber, BR) and using a rotor mill to form a composite material.
Item GG2149. A method for preparing a composite material, said method comprising providing a nanotube and polybutylene terephthalate (PBT) and using a rotor mill to form a composite material.
Item GG2150. A method for preparing a composite material, said method comprising providing a nanotube and polycaprolactam and using a rotor mill to form a composite material.
Item GG2151. A method for preparing a composite material, said method comprising providing a nanotube and polycarbonate (PC) and using a rotor mill to form a composite material.
Item GG2152. A method for preparing a composite material, said method comprising providing a nanotube and polychloroprene and using a rotor mill to form a composite material.
Item GG2153. A method for preparing a composite material, said method comprising providing a nanotube and polychlorotrifluoroethylene (PCTFE) and using a rotor mill to form a composite material.
Item GG2154. A method for preparing a composite material, said method comprising providing a nanotube and polyesters and using a rotor mill to form a composite material.
Item GG2155. A method for preparing a composite material, said method comprising providing a nanotube and polyether ether ketone (PEEK) and using a rotor mill to form a composite material.
Item GG2156. A method for preparing a composite material, said method comprising providing a nanotube and polyetherketone (PEK) and using a rotor mill to form a composite material.
Item GG2157. A method for preparing a composite material, said method comprising providing a nanotube and polyethers and using a rotor mill to form a composite material.
Item GG2158. A method for preparing a composite material, said method comprising providing a nanotube and polyethersulfone (PES) and using a rotor mill to form a composite material.
Item GG2159. A method for preparing a composite material, said method comprising providing a nanotube and polyethyl acrylate and using a rotor mill to form a composite material.
Item GG2160. A method for preparing a composite material, said method comprising providing a nanotube and polyethylene—cross-linked and using a rotor mill to form a composite material.
Item GG2161. A method for preparing a composite material, said method comprising providing a nanotube and polyethylene—high density (HDPE) and using a rotor mill to form a composite material.
Item GG2162. A method for preparing a composite material, said method comprising providing a nanotube and polyethylene—linear low density (LLDPE) and using a rotor mill to form a composite material.
Item GG2163. A method for preparing a composite material, said method comprising providing a nanotube and polyethylene—low density (LDPE) and using a rotor mill to form a composite material.
Item GG2164. A method for preparing a composite material, said method comprising providing a nanotube and polyethylene—medium density (MDPE) and using a rotor mill to form a composite material.
Item GG2165. A method for preparing a composite material, said method comprising providing a nanotube and polyethylene—ultrahigh molecular weight (UHMWPE) and using a rotor mill to form a composite material.
Item GG2166. A method for preparing a composite material, said method comprising providing a nanotube and polyethylene—very low density (VLDPE) and using a rotor mill to form a composite material.
Item GG2167. A method for preparing a composite material, said method comprising providing a nanotube and polyethylene terephthalate (PET) and using a rotor mill to form a composite material.
Item GG2168. A method for preparing a composite material, said method comprising providing a nanotube and polyethylene (PE) and using a rotor mill to form a composite material.
Item GG2169. A method for preparing a composite material, said method comprising providing a nanotube and polyglycolide and using a rotor mill to form a composite material.
Item GG2170. A method for preparing a composite material, said method comprising providing a nanotube and polyhexamethylene adipamide (PA 6,6) and using a rotor mill to form a composite material.
Item GG2171. A method for preparing a composite material, said method comprising providing a nanotube and polyimides and using a rotor mill to form a composite material.
Item GG2172. A method for preparing a composite material, said method comprising providing a nanotube and polyisoprene (natural rubber, NR; isoprene rubber, IR) and using a rotor mill to form a composite material.
Item GG2173. A method for preparing a composite material, said method comprising providing a nanotube and polylactic acid (PLA) and using a rotor mill to form a composite material.
Item GG2174. A method for preparing a composite material, said method comprising providing a nanotube and polymethyl acrylate and using a rotor mill to form a composite material.
Item GG2175. A method for preparing a composite material, said method comprising providing a nanotube and polymethyl methacrylate (PMMA) and using a rotor mill to form a composite material.
Item GG2176. A method for preparing a composite material, said method comprising providing a nanotube and polyphenylene oxide (PPO) and using a rotor mill to form a composite material.
Item GG2177. A method for preparing a composite material, said method comprising providing a nanotube and polyphenylene sulfide (PPS) and using a rotor mill to form a composite material.
Item GG2178. A method for preparing a composite material, said method comprising providing a nanotube and poly-p-phenylene-2,6-benzobisoxazole (PBO) and using a rotor mill to form a composite material.
Item GG2179. A method for preparing a composite material, said method comprising providing a nanotube and polypropylene (PP) and using a rotor mill to form a composite material.
Item GG2180. A method for preparing a composite material, said method comprising providing a nanotube and polysiloxanes (silicones) and using a rotor mill to form a composite material.
Item GG2181. A method for preparing a composite material, said method comprising providing a nanotube and polystyrene (PS) and using a rotor mill to form a composite material.
Item GG2182. A method for preparing a composite material, said method comprising providing a nanotube and polysulfide rubber and using a rotor mill to form a composite material.
Item GG2183. A method for preparing a composite material, said method comprising providing a nanotube and polysulfides and using a rotor mill to form a composite material.
Item GG2184. A method for preparing a composite material, said method comprising providing a nanotube and polytetrafluoroethylene (PTFE) and using a rotor mill to form a composite material.
Item GG2185. A method for preparing a composite material, said method comprising providing a nanotube and polytrimethylene terephthalate (PTT) and using a rotor mill to form a composite material.
Item GG2186. A method for preparing a composite material, said method comprising providing a nanotube and polyurethane and using a rotor mill to form a composite material.
Item GG2187. A method for preparing a composite material, said method comprising providing a nanotube and polyvinyl acetate (PVAc) and using a rotor mill to form a composite material.
Item GG2188. A method for preparing a composite material, said method comprising providing a nanotube and polyvinyl chloride (PVC) and using a rotor mill to form a composite material.
Item GG2189. A method for preparing a composite material, said method comprising providing a nanotube and polyvinyl fluoride (PVF) and using a rotor mill to form a composite material.
Item GG2190. A method for preparing a composite material, said method comprising providing a nanotube and polyvinylidene chloride (PVDC) and using a rotor mill to form a composite material.
Item GG2191. A method for preparing a composite material, said method comprising providing a nanotube and polyvinylidene fluoride (PVDF) and using a rotor mill to form a composite material.
Item GG2192. A method for preparing a composite material, said method comprising providing a nanotube and rayon and using a rotor mill to form a composite material.
Item GG2193. A method for preparing a composite material, said method comprising providing a nanotube and styrene-acrylonitrile (SAN) and using a rotor mill to form a composite material.
Item GG2194. A method for preparing a composite material, said method comprising providing a nanotube and styrene-butadiene and using a rotor mill to form a composite material.
Item GG2195. A method for preparing a composite material, said method comprising providing a nanotube and styrene-isoprene and using a rotor mill to form a composite material.
Item GG2196. A method for preparing a composite material, said method comprising providing a nanotube and a styrene-maleic anhydride copolymer and using a rotor mill to form a composite material.
Item GG2197. A method for preparing a composite material, said method comprising providing a nanotube and a thermoplastic polyurethanes (TPU) and using a rotor mill to form a composite material.
Item GG2198. A method for preparing a composite material, said method comprising providing a nanotube and an unsaturated polyester and using a rotor mill to form a composite material.
Item GG2199. A method for preparing a composite material, said method comprising providing a nanotube and a urea-formaldehyde polymer and using a rotor mill to form a composite material.
Item GG2200. A method for preparing a composite material, said method comprising providing a nanotube and a vinyl copolymer and using a rotor mill to form a composite material.
Item GG2201. A method for preparing a composite material, said method comprising providing a nanotube and an acrylic polymer and using a sand mill to form a composite material.
Item GG2202. A method for preparing a composite material, said method comprising providing a nanotube and acrylonitrile-butadiene-styrene (ABS) and using a sand mill to form a composite material.
Item GG2203. A method for preparing a composite material, said method comprising providing a nanotube and an aldehyde condensation polymer and using a sand mill to form a composite material.
Item GG2204. A method for preparing a composite material, said method comprising providing a nanotube and an aliphatic polyether and using a sand mill to form a composite material.
Item GG2205. A method for preparing a composite material, said method comprising providing a nanotube and an alkyds and oil-free coating polyester and using a sand mill to form a composite material.
Item GG2206. A method for preparing a composite material, said method comprising providing a nanotube and an aramid and using a sand mill to form a composite material.
Item GG2207. A method for preparing a composite material, said method comprising providing a nanotube and butyl rubber and using a sand mill to form a composite material.
Item GG2208. A method for preparing a composite material, said method comprising providing a nanotube and cellulose acetate and using a sand mill to form a composite material.
Item GG2209. A method for preparing a composite material, said method comprising providing a nanotube and cellulose nitrate and using a sand mill to form a composite material.
Item GG2210. A method for preparing a composite material, said method comprising providing a nanotube and a cellulosic and using a sand mill to form a composite material.
Item GG2211. A method for preparing a composite material, said method comprising providing a nanotube and a cyanoacrylate polymer and using a sand mill to form a composite material.
Item GG2212. A method for preparing a composite material, said method comprising providing a nanotube and a diene polymer and using a sand mill to form a composite material.
Item GG2213. A method for preparing a composite material, said method comprising providing a nanotube and an epoxy and using a sand mill to form a composite material.
Item GG2214. A method for preparing a composite material, said method comprising providing a nanotube and an ethylene-propylene copolymer and using a sand mill to form a composite material.
Item GG2215. A method for preparing a composite material, said method comprising providing a nanotube and a fluoroelastomer and using a sand mill to form a composite material.
Item GG2216. A method for preparing a composite material, said method comprising providing a nanotube and a heterochain polymer and using a sand mill to form a composite material.
Item GG2217. A method for preparing a composite material, said method comprising providing a nanotube and a melamine-formaldehyde polymer and using a sand mill to form a composite material.
Item GG2218. A method for preparing a composite material, said method comprising providing a nanotube and a meta-aramid polymer and using a sand mill to form a composite material.
Item GG2219. A method for preparing a composite material, said method comprising providing a nanotube and nitrile rubber and using a sand mill to form a composite material.
Item GG2220. A method for preparing a composite material, said method comprising providing a nanotube and nylon and using a sand mill to form a composite material.
Item GG2221. A method for preparing a composite material, said method comprising providing a nanotube and a para-aramid and using a sand mill to form a composite material.
Item GG2222. A method for preparing a composite material, said method comprising providing a nanotube and poly 2-hydroxyethyl methacrylate (HEMA) and using a sand mill to form a composite material.
Item GG2223. A method for preparing a composite material, said method comprising providing a nanotube and poly bisphenol A carbonate (PC) and using a sand mill to form a composite material.
Item GG2224. A method for preparing a composite material, said method comprising providing a nanotube and poly butylene terephthalate (PBT) and using a sand mill to form a composite material.
Item GG2225. A method for preparing a composite material, said method comprising providing a nanotube and poly dimethylsiloxane (PDMS) and using a sand mill to form a composite material.
Item GG2226. A method for preparing a composite material, said method comprising providing a nanotube and poly dodecano-12-lactam (Nylon 12) and using a sand mill to form a composite material.
Item GG2227. A method for preparing a composite material, said method comprising providing a nanotube and poly ether ketone ketone (PEKK) and using a sand mill to form a composite material.
Item GG2228. A method for preparing a composite material, said method comprising providing a nanotube and poly ethylene terephthalate (PET) and using a sand mill to form a composite material.
Item GG2229. A method for preparing a composite material, said method comprising providing a nanotube and poly methyl acrylate (PMA) and using a sand mill to form a composite material.
Item GG2230. A method for preparing a composite material, said method comprising providing a nanotube and poly methyl methacrylate (PMMA) and using a sand mill to form a composite material.
Item GG2231. A method for preparing a composite material, said method comprising providing a nanotube and poly vinyl acetate (PVA) and using a sand mill to form a composite material.
Item GG2232. A method for preparing a composite material, said method comprising providing a nanotube and poly vinyl chloride (PVC) and using a sand mill to form a composite material.
Item GG2233. A method for preparing a composite material, said method comprising providing a nanotube and poly vinylidene chloride (PVDC) and using a sand mill to form a composite material.
Item GG2234. A method for preparing a composite material, said method comprising providing a nanotube and poly vinylidene fluoride (PVDF) and using a sand mill to form a composite material.
Item GG2235. A method for preparing a composite material, said method comprising providing a nanotube and poly(acrylic acid) and using a sand mill to form a composite material.
Item GG2236. A method for preparing a composite material, said method comprising providing a nanotube and poly(Bisphenol A isophthalate) and using a sand mill to form a composite material.
Item GG2237. A method for preparing a composite material, said method comprising providing a nanotube and poly(Bisphenol A terephthalate) and using a sand mill to form a composite material.
Item GG2238. A method for preparing a composite material, said method comprising providing a nanotube and poly(butyl acrylate) and using a sand mill to form a composite material.
Item GG2239. A method for preparing a composite material, said method comprising providing a nanotube and poly(butyl methacrylate) and using a sand mill to form a composite material.
Item GG2240. A method for preparing a composite material, said method comprising providing a nanotube and poly(butylene) and using a sand mill to form a composite material.
Item GG2241. A method for preparing a composite material, said method comprising providing a nanotube and poly(caprolactone) and using a sand mill to form a composite material.
Item GG2242. A method for preparing a composite material, said method comprising providing a nanotube and poly(chlorotrifluoroethylene) and using a sand mill to form a composite material.
Item GG2243. A method for preparing a composite material, said method comprising providing a nanotube and poly(cyclohexyl methacrylate) and using a sand mill to form a composite material.
Item GG2244. A method for preparing a composite material, said method comprising providing a nanotube and poly(ethyl acrylate) and using a sand mill to form a composite material.
Item GG2245. A method for preparing a composite material, said method comprising providing a nanotube and poly(ethylene glycol) and using a sand mill to form a composite material.
Item GG2246. A method for preparing a composite material, said method comprising providing a nanotube and poly(ethylene naphthalate) and using a sand mill to form a composite material.
Item GG2247. A method for preparing a composite material, said method comprising providing a nanotube and poly(isobutylene) and using a sand mill to form a composite material.
Item GG2248. A method for preparing a composite material, said method comprising providing a nanotube and poly(phenylsulfone) and using a sand mill to form a composite material.
Item GG2249. A method for preparing a composite material, said method comprising providing a nanotube and poly(propylene glycol) and using a sand mill to form a composite material.
Item GG2250. A method for preparing a composite material, said method comprising providing a nanotube and poly(tetrahydrofuran) and using a sand mill to form a composite material.
Item GG2251. A method for preparing a composite material, said method comprising providing a nanotube and poly(α-methylstyrene) and using a sand mill to form a composite material.
Item GG2252. A method for preparing a composite material, said method comprising providing a nanotube and polyacetal and using a sand mill to form a composite material.
Item GG2253. A method for preparing a composite material, said method comprising providing a nanotube and polyacetal (POM) and using a sand mill to form a composite material.
Item GG2254. A method for preparing a composite material, said method comprising providing a nanotube and polyacrylate elastomers and using a sand mill to form a composite material.
Item GG2255. A method for preparing a composite material, said method comprising providing a nanotube and polyacrylonitrile (PAN) and using a sand mill to form a composite material.
Item GG2256. A method for preparing a composite material, said method comprising providing a nanotube and polyamide and using a sand mill to form a composite material.
Item GG2257. A method for preparing a composite material, said method comprising providing a nanotube and polybutadiene (PBD) and using a sand mill to form a composite material.
Item GG2258. A method for preparing a composite material, said method comprising providing a nanotube and polybutadiene (butadiene rubber, BR) and using a sand mill to form a composite material.
Item GG2259. A method for preparing a composite material, said method comprising providing a nanotube and polybutylene terephthalate (PBT) and using a sand mill to form a composite material.
Item GG2260. A method for preparing a composite material, said method comprising providing a nanotube and polycaprolactam and using a sand mill to form a composite material.
Item GG2261. A method for preparing a composite material, said method comprising providing a nanotube and polycarbonate (PC) and using a sand mill to form a composite material.
Item GG2262. A method for preparing a composite material, said method comprising providing a nanotube and polychloroprene and using a sand mill to form a composite material.
Item GG2263. A method for preparing a composite material, said method comprising providing a nanotube and polychlorotrifluoroethylene (PCTFE) and using a sand mill to form a composite material.
Item GG2264. A method for preparing a composite material, said method comprising providing a nanotube and polyesters and using a sand mill to form a composite material.
Item GG2265. A method for preparing a composite material, said method comprising providing a nanotube and polyether ether ketone (PEEK) and using a sand mill to form a composite material.
Item GG2266. A method for preparing a composite material, said method comprising providing a nanotube and polyetherketone (PEK) and using a sand mill to form a composite material.
Item GG2267. A method for preparing a composite material, said method comprising providing a nanotube and polyethers and using a sand mill to form a composite material.
Item GG2268. A method for preparing a composite material, said method comprising providing a nanotube and polyethersulfone (PES) and using a sand mill to form a composite material.
Item GG2269. A method for preparing a composite material, said method comprising providing a nanotube and polyethyl acrylate and using a sand mill to form a composite material.
Item GG2270. A method for preparing a composite material, said method comprising providing a nanotube and polyethylene—cross-linked and using a sand mill to form a composite material.
Item GG2271. A method for preparing a composite material, said method comprising providing a nanotube and polyethylene—high density (HDPE) and using a sand mill to form a composite material.
Item GG2272. A method for preparing a composite material, said method comprising providing a nanotube and polyethylene—linear low density (LLDPE) and using a sand mill to form a composite material.
Item GG2273. A method for preparing a composite material, said method comprising providing a nanotube and polyethylene—low density (LDPE) and using a sand mill to form a composite material.
Item GG2274. A method for preparing a composite material, said method comprising providing a nanotube and polyethylene—medium density (MDPE) and using a sand mill to form a composite material.
Item GG2275. A method for preparing a composite material, said method comprising providing a nanotube and polyethylene—ultrahigh molecular weight (UHMWPE) and using a sand mill to form a composite material.
Item GG2276. A method for preparing a composite material, said method comprising providing a nanotube and polyethylene—very low density (VLDPE) and using a sand mill to form a composite material.
Item GG2277. A method for preparing a composite material, said method comprising providing a nanotube and polyethylene terephthalate (PET) and using a sand mill to form a composite material.
Item GG2278. A method for preparing a composite material, said method comprising providing a nanotube and polyethylene (PE) and using a sand mill to form a composite material.
Item GG2279. A method for preparing a composite material, said method comprising providing a nanotube and polyglycolide and using a sand mill to form a composite material.
Item GG2280. A method for preparing a composite material, said method comprising providing a nanotube and polyhexamethylene adipamide (PA 6,6) and using a sand mill to form a composite material.
Item GG2281. A method for preparing a composite material, said method comprising providing a nanotube and polyimides and using a sand mill to form a composite material.
Item GG2282. A method for preparing a composite material, said method comprising providing a nanotube and polyisoprene (natural rubber, NR; isoprene rubber, IR) and using a sand mill to form a composite material.
Item GG2283. A method for preparing a composite material, said method comprising providing a nanotube and polylactic acid (PLA) and using a sand mill to form a composite material.
Item GG2284. A method for preparing a composite material, said method comprising providing a nanotube and polymethyl acrylate and using a sand mill to form a composite material.
Item GG2285. A method for preparing a composite material, said method comprising providing a nanotube and polymethyl methacrylate (PMMA) and using a sand mill to form a composite material.
Item GG2286. A method for preparing a composite material, said method comprising providing a nanotube and polyphenylene oxide (PPO) and using a sand mill to form a composite material.
Item GG2287. A method for preparing a composite material, said method comprising providing a nanotube and polyphenylene sulfide (PPS) and using a sand mill to form a composite material.
Item GG2288. A method for preparing a composite material, said method comprising providing a nanotube and poly-p-phenylene-2,6-benzobisoxazole (PBO) and using a sand mill to form a composite material.
Item GG2289. A method for preparing a composite material, said method comprising providing a nanotube and polypropylene (PP) and using a sand mill to form a composite material.
Item GG2290. A method for preparing a composite material, said method comprising providing a nanotube and polysiloxanes (silicones) and using a sand mill to form a composite material.
Item GG2291. A method for preparing a composite material, said method comprising providing a nanotube and polystyrene (PS) and using a sand mill to form a composite material.
Item GG2292. A method for preparing a composite material, said method comprising providing a nanotube and polysulfide rubber and using a sand mill to form a composite material.
Item GG2293. A method for preparing a composite material, said method comprising providing a nanotube and polysulfides and using a sand mill to form a composite material.
Item GG2294. A method for preparing a composite material, said method comprising providing a nanotube and polytetrafluoroethylene (PTFE) and using a sand mill to form a composite material.
Item GG2295. A method for preparing a composite material, said method comprising providing a nanotube and polytrimethylene terephthalate (PTT) and using a sand mill to form a composite material.
Item GG2296. A method for preparing a composite material, said method comprising providing a nanotube and polyurethane and using a sand mill to form a composite material.
Item GG2297. A method for preparing a composite material, said method comprising providing a nanotube and polyvinyl acetate (PVAc) and using a sand mill to form a composite material.
Item GG2298. A method for preparing a composite material, said method comprising providing a nanotube and polyvinyl chloride (PVC) and using a sand mill to form a composite material.
Item GG2299. A method for preparing a composite material, said method comprising providing a nanotube and polyvinyl fluoride (PVF) and using a sand mill to form a composite material.
Item GG2300. A method for preparing a composite material, said method comprising providing a nanotube and polyvinylidene chloride (PVDC) and using a sand mill to form a composite material.
Item GG2301. A method for preparing a composite material, said method comprising providing a nanotube and polyvinylidene fluoride (PVDF) and using a sand mill to form a composite material.
Item GG2302. A method for preparing a composite material, said method comprising providing a nanotube and rayon and using a sand mill to form a composite material.
Item GG2303. A method for preparing a composite material, said method comprising providing a nanotube and styrene-acrylonitrile (SAN) and using a sand mill to form a composite material.
Item GG2304. A method for preparing a composite material, said method comprising providing a nanotube and styrene-butadiene and using a sand mill to form a composite material.
Item GG2305. A method for preparing a composite material, said method comprising providing a nanotube and styrene-isoprene and using a sand mill to form a composite material.
Item GG2306. A method for preparing a composite material, said method comprising providing a nanotube and a styrene-maleic anhydride copolymer and using a sand mill to form a composite material.
Item GG2307. A method for preparing a composite material, said method comprising providing a nanotube and a thermoplastic polyurethanes (TPU) and using a sand mill to form a composite material.
Item GG2308. A method for preparing a composite material, said method comprising providing a nanotube and an unsaturated polyester and using a sand mill to form a composite material.
Item GG2309. A method for preparing a composite material, said method comprising providing a nanotube and a urea-formaldehyde polymer and using a sand mill to form a composite material.
Item GG2310. A method for preparing a composite material, said method comprising providing a nanotube and a vinyl copolymer and using a sand mill to form a composite material.
Item GG2311. A method for preparing a composite material, said method comprising providing a nanotube and an acrylic polymer and using a shaker mill to form a composite material.
Item GG2312. A method for preparing a composite material, said method comprising providing a nanotube and acrylonitrile-butadiene-styrene (ABS) and using a shaker mill to form a composite material.
Item GG2313. A method for preparing a composite material, said method comprising providing a nanotube and an aldehyde condensation polymer and using a shaker mill to form a composite material.
Item GG2314. A method for preparing a composite material, said method comprising providing a nanotube and an aliphatic polyether and using a shaker mill to form a composite material.
Item GG2315. A method for preparing a composite material, said method comprising providing a nanotube and an alkyds and oil-free coating polyester and using a shaker mill to form a composite material.
Item GG2316. A method for preparing a composite material, said method comprising providing a nanotube and an aramid and using a shaker mill to form a composite material.
Item GG2317. A method for preparing a composite material, said method comprising providing a nanotube and butyl rubber and using a shaker mill to form a composite material.
Item GG2318. A method for preparing a composite material, said method comprising providing a nanotube and cellulose acetate and using a shaker mill to form a composite material.
Item GG2319. A method for preparing a composite material, said method comprising providing a nanotube and cellulose nitrate and using a shaker mill to form a composite material.
Item GG2320. A method for preparing a composite material, said method comprising providing a nanotube and a cellulosic and using a shaker mill to form a composite material.
Item GG2321. A method for preparing a composite material, said method comprising providing a nanotube and a cyanoacrylate polymer and using a shaker mill to form a composite material.
Item GG2322. A method for preparing a composite material, said method comprising providing a nanotube and a diene polymer and using a shaker mill to form a composite material.
Item GG2323. A method for preparing a composite material, said method comprising providing a nanotube and an epoxy and using a shaker mill to form a composite material.
Item GG2324. A method for preparing a composite material, said method comprising providing a nanotube and an ethylene-propylene copolymer and using a shaker mill to form a composite material.
Item GG2325. A method for preparing a composite material, said method comprising providing a nanotube and a fluoroelastomer and using a shaker mill to form a composite material.
Item GG2326. A method for preparing a composite material, said method comprising providing a nanotube and a heterochain polymer and using a shaker mill to form a composite material.
Item GG2327. A method for preparing a composite material, said method comprising providing a nanotube and a melamine-formaldehyde polymer and using a shaker mill to form a composite material.
Item GG2328. A method for preparing a composite material, said method comprising providing a nanotube and a meta-aramid polymer and using a shaker mill to form a composite material.
Item GG2329. A method for preparing a composite material, said method comprising providing a nanotube and nitrile rubber and using a shaker mill to form a composite material.
Item GG2330. A method for preparing a composite material, said method comprising providing a nanotube and nylon and using a shaker mill to form a composite material.
Item GG2331. A method for preparing a composite material, said method comprising providing a nanotube and a para-aramid and using a shaker mill to form a composite material.
Item GG2332. A method for preparing a composite material, said method comprising providing a nanotube and poly 2-hydroxyethyl methacrylate (HEMA) and using a shaker mill to form a composite material.
Item GG2333. A method for preparing a composite material, said method comprising providing a nanotube and poly bisphenol A carbonate (PC) and using a shaker mill to form a composite material.
Item GG2334. A method for preparing a composite material, said method comprising providing a nanotube and poly butylene terephthalate (PBT) and using a shaker mill to form a composite material.
Item GG2335. A method for preparing a composite material, said method comprising providing a nanotube and poly dimethylsiloxane (PDMS) and using a shaker mill to form a composite material.
Item GG2336. A method for preparing a composite material, said method comprising providing a nanotube and poly dodecano-12-lactam (Nylon 12) and using a shaker mill to form a composite material.
Item GG2337. A method for preparing a composite material, said method comprising providing a nanotube and poly ether ketone ketone (PEKK) and using a shaker mill to form a composite material.
Item GG2338. A method for preparing a composite material, said method comprising providing a nanotube and poly ethylene terephthalate (PET) and using a shaker mill to form a composite material.
Item GG2339. A method for preparing a composite material, said method comprising providing a nanotube and poly methyl acrylate (PMA) and using a shaker mill to form a composite material.
Item GG2340. A method for preparing a composite material, said method comprising providing a nanotube and poly methyl methacrylate (PMMA) and using a shaker mill to form a composite material.
Item GG2341. A method for preparing a composite material, said method comprising providing a nanotube and poly vinyl acetate (PVA) and using a shaker mill to form a composite material.
Item GG2342. A method for preparing a composite material, said method comprising providing a nanotube and poly vinyl chloride (PVC) and using a shaker mill to form a composite material.
Item GG2343. A method for preparing a composite material, said method comprising providing a nanotube and poly vinylidene chloride (PVDC) and using a shaker mill to form a composite material.
Item GG2344. A method for preparing a composite material, said method comprising providing a nanotube and poly vinylidene fluoride (PVDF) and using a shaker mill to form a composite material.
Item GG2345. A method for preparing a composite material, said method comprising providing a nanotube and poly(acrylic acid) and using a shaker mill to form a composite material.
Item GG2346. A method for preparing a composite material, said method comprising providing a nanotube and poly(Bisphenol A isophthalate) and using a shaker mill to form a composite material.
Item GG2347. A method for preparing a composite material, said method comprising providing a nanotube and poly(Bisphenol A terephthalate) and using a shaker mill to form a composite material.
Item GG2348. A method for preparing a composite material, said method comprising providing a nanotube and poly(butyl acrylate) and using a shaker mill to form a composite material.
Item GG2349. A method for preparing a composite material, said method comprising providing a nanotube and poly(butyl methacrylate) and using a shaker mill to form a composite material.
Item GG2350. A method for preparing a composite material, said method comprising providing a nanotube and poly(butylene) and using a shaker mill to form a composite material.
Item GG2351. A method for preparing a composite material, said method comprising providing a nanotube and poly(caprolactone) and using a shaker mill to form a composite material.
Item GG2352. A method for preparing a composite material, said method comprising providing a nanotube and poly(chlorotrifluoroethylene) and using a shaker mill to form a composite material.
Item GG2353. A method for preparing a composite material, said method comprising providing a nanotube and poly(cyclohexyl methacrylate) and using a shaker mill to form a composite material.
Item GG2354. A method for preparing a composite material, said method comprising providing a nanotube and poly(ethyl acrylate) and using a shaker mill to form a composite material.
Item GG2355. A method for preparing a composite material, said method comprising providing a nanotube and poly(ethylene glycol) and using a shaker mill to form a composite material.
Item GG2356. A method for preparing a composite material, said method comprising providing a nanotube and poly(ethylene naphthalate) and using a shaker mill to form a composite material.
Item GG2357. A method for preparing a composite material, said method comprising providing a nanotube and poly(isobutylene) and using a shaker mill to form a composite material.
Item GG2358. A method for preparing a composite material, said method comprising providing a nanotube and poly(phenylsulfone) and using a shaker mill to form a composite material.
Item GG2359. A method for preparing a composite material, said method comprising providing a nanotube and poly(propylene glycol) and using a shaker mill to form a composite material.
Item GG2360. A method for preparing a composite material, said method comprising providing a nanotube and poly(tetrahydrofuran) and using a shaker mill to form a composite material.
Item GG2361. A method for preparing a composite material, said method comprising providing a nanotube and poly(α-methylstyrene) and using a shaker mill to form a composite material.
Item GG2362. A method for preparing a composite material, said method comprising providing a nanotube and polyacetal and using a shaker mill to form a composite material.
Item GG2363. A method for preparing a composite material, said method comprising providing a nanotube and polyacetal (POM) and using a shaker mill to form a composite material.
Item GG2364. A method for preparing a composite material, said method comprising providing a nanotube and polyacrylate elastomers and using a shaker mill to form a composite material.
Item GG2365. A method for preparing a composite material, said method comprising providing a nanotube and polyacrylonitrile (PAN) and using a shaker mill to form a composite material.
Item GG2366. A method for preparing a composite material, said method comprising providing a nanotube and polyamide and using a shaker mill to form a composite material.
Item GG2367. A method for preparing a composite material, said method comprising providing a nanotube and polybutadiene (PBD) and using a shaker mill to form a composite material.
Item GG2368. A method for preparing a composite material, said method comprising providing a nanotube and polybutadiene (butadiene rubber, BR) and using a shaker mill to form a composite material.
Item GG2369. A method for preparing a composite material, said method comprising providing a nanotube and polybutylene terephthalate (PBT) and using a shaker mill to form a composite material.
Item GG2370. A method for preparing a composite material, said method comprising providing a nanotube and polycaprolactam and using a shaker mill to form a composite material.
Item GG2371. A method for preparing a composite material, said method comprising providing a nanotube and polycarbonate (PC) and using a shaker mill to form a composite material.
Item GG2372. A method for preparing a composite material, said method comprising providing a nanotube and polychloroprene and using a shaker mill to form a composite material.
Item GG2373. A method for preparing a composite material, said method comprising providing a nanotube and polychlorotrifluoroethylene (PCTFE) and using a shaker mill to form a composite material.
Item GG2374. A method for preparing a composite material, said method comprising providing a nanotube and polyesters and using a shaker mill to form a composite material.
Item GG2375. A method for preparing a composite material, said method comprising providing a nanotube and polyether ether ketone (PEEK) and using a shaker mill to form a composite material.
Item GG2376. A method for preparing a composite material, said method comprising providing a nanotube and polyetherketone (PEK) and using a shaker mill to form a composite material.
Item GG2377. A method for preparing a composite material, said method comprising providing a nanotube and polyethers and using a shaker mill to form a composite material.
Item GG2378. A method for preparing a composite material, said method comprising providing a nanotube and polyethersulfone (PES) and using a shaker mill to form a composite material.
Item GG2379. A method for preparing a composite material, said method comprising providing a nanotube and polyethyl acrylate and using a shaker mill to form a composite material.
Item GG2380. A method for preparing a composite material, said method comprising providing a nanotube and polyethylene—cross-linked and using a shaker mill to form a composite material.
Item GG2381. A method for preparing a composite material, said method comprising providing a nanotube and polyethylene—high density (HDPE) and using a shaker mill to form a composite material.
Item GG2382. A method for preparing a composite material, said method comprising providing a nanotube and polyethylene—linear low density (LLDPE) and using a shaker mill to form a composite material.
Item GG2383. A method for preparing a composite material, said method comprising providing a nanotube and polyethylene—low density (LDPE) and using a shaker mill to form a composite material.
Item GG2384. A method for preparing a composite material, said method comprising providing a nanotube and polyethylene—medium density (MDPE) and using a shaker mill to form a composite material.
Item GG2385. A method for preparing a composite material, said method comprising providing a nanotube and polyethylene—ultrahigh molecular weight (UHMWPE) and using a shaker mill to form a composite material.
Item GG2386. A method for preparing a composite material, said method comprising providing a nanotube and polyethylene—very low density (VLDPE) and using a shaker mill to form a composite material.
Item GG2387. A method for preparing a composite material, said method comprising providing a nanotube and polyethylene terephthalate (PET) and using a shaker mill to form a composite material.
Item GG2388. A method for preparing a composite material, said method comprising providing a nanotube and polyethylene (PE) and using a shaker mill to form a composite material.
Item GG2389. A method for preparing a composite material, said method comprising providing a nanotube and polyglycolide and using a shaker mill to form a composite material.
Item GG2390. A method for preparing a composite material, said method comprising providing a nanotube and polyhexamethylene adipamide (PA 6,6) and using a shaker mill to form a composite material.
Item GG2391. A method for preparing a composite material, said method comprising providing a nanotube and polyimides and using a shaker mill to form a composite material.
Item GG2392. A method for preparing a composite material, said method comprising providing a nanotube and polyisoprene (natural rubber, NR; isoprene rubber, IR) and using a shaker mill to form a composite material.
Item GG2393. A method for preparing a composite material, said method comprising providing a nanotube and polylactic acid (PLA) and using a shaker mill to form a composite material.
Item GG2394. A method for preparing a composite material, said method comprising providing a nanotube and polymethyl acrylate and using a shaker mill to form a composite material.
Item GG2395. A method for preparing a composite material, said method comprising providing a nanotube and polymethyl methacrylate (PMMA) and using a shaker mill to form a composite material.
Item GG2396. A method for preparing a composite material, said method comprising providing a nanotube and polyphenylene oxide (PPO) and using a shaker mill to form a composite material.
Item GG2397. A method for preparing a composite material, said method comprising providing a nanotube and polyphenylene sulfide (PPS) and using a shaker mill to form a composite material.
Item GG2398. A method for preparing a composite material, said method comprising providing a nanotube and poly-p-phenylene-2,6-benzobisoxazole (PBO) and using a shaker mill to form a composite material.
Item GG2399. A method for preparing a composite material, said method comprising providing a nanotube and polypropylene (PP) and using a shaker mill to form a composite material.
Item GG2400. A method for preparing a composite material, said method comprising providing a nanotube and polysiloxanes (silicones) and using a shaker mill to form a composite material.
Item GG2401. A method for preparing a composite material, said method comprising providing a nanotube and polystyrene (PS) and using a shaker mill to form a composite material.
Item GG2402. A method for preparing a composite material, said method comprising providing a nanotube and polysulfide rubber and using a shaker mill to form a composite material.
Item GG2403. A method for preparing a composite material, said method comprising providing a nanotube and polysulfides and using a shaker mill to form a composite material.
Item GG2404. A method for preparing a composite material, said method comprising providing a nanotube and polytetrafluoroethylene (PTFE) and using a shaker mill to form a composite material.
Item GG2405. A method for preparing a composite material, said method comprising providing a nanotube and polytrimethylene terephthalate (PTT) and using a shaker mill to
Item GG2406. A method for preparing a composite material, said method comprising providing a nanotube and polyurethane and using a shaker mill to form a composite material.
Item GG2407. A method for preparing a composite material, said method comprising providing a nanotube and polyvinyl acetate (PVAc) and using a shaker mill to form a composite material.
Item GG2408. A method for preparing a composite material, said method comprising providing a nanotube and polyvinyl chloride (PVC) and using a shaker mill to form a composite material.
Item GG2409. A method for preparing a composite material, said method comprising providing a nanotube and polyvinyl fluoride (PVF) and using a shaker mill to form a composite material.
Item GG2410. A method for preparing a composite material, said method comprising providing a nanotube and polyvinylidene chloride (PVDC) and using a shaker mill to form a composite material.
Item GG2411. A method for preparing a composite material, said method comprising providing a nanotube and polyvinylidene fluoride (PVDF) and using a shaker mill to form a composite material.
Item GG2412. A method for preparing a composite material, said method comprising providing a nanotube and rayon and using a shaker mill to form a composite material.
Item GG2413. A method for preparing a composite material, said method comprising providing a nanotube and styrene-acrylonitrile (SAN) and using a shaker mill to form a composite material.
Item GG2414. A method for preparing a composite material, said method comprising providing a nanotube and styrene-butadiene and using a shaker mill to form a composite material.
Item GG2415. A method for preparing a composite material, said method comprising providing a nanotube and styrene-isoprene and using a shaker mill to form a composite material.
Item GG2416. A method for preparing a composite material, said method comprising providing a nanotube and a styrene-maleic anhydride copolymer and using a shaker mill to form a composite material.
Item GG2417. A method for preparing a composite material, said method comprising providing a nanotube and a thermoplastic polyurethanes (TPU) and using a shaker mill to form a composite material.
Item GG2418. A method for preparing a composite material, said method comprising providing a nanotube and an unsaturated polyester and using a shaker mill to form a composite material.
Item GG2419. A method for preparing a composite material, said method comprising providing a nanotube and a urea-formaldehyde polymer and using a shaker mill to form a composite material.
Item GG2420. A method for preparing a composite material, said method comprising providing a nanotube and a vinyl copolymer and using a shaker mill to form a composite material.
Item GG2421. A method for preparing a composite material, said method comprising providing a nanotube and an acrylic polymer and using a stirred ball mill to form a composite material.
Item GG2422. A method for preparing a composite material, said method comprising providing a nanotube and acrylonitrile-butadiene-styrene (ABS) and using a stirred ball mill to form a composite material.
Item GG2423. A method for preparing a composite material, said method comprising providing a nanotube and an aldehyde condensation polymer and using a stirred ball mill to form a composite material.
Item GG2424. A method for preparing a composite material, said method comprising providing a nanotube and an aliphatic polyether and using a stirred ball mill to form a composite material.
Item GG2425. A method for preparing a composite material, said method comprising providing a nanotube and an alkyds and oil-free coating polyester and using a stirred ball mill to form a composite material.
Item GG2426. A method for preparing a composite material, said method comprising providing a nanotube and an aramid and using a stirred ball mill to form a composite material.
Item GG2427. A method for preparing a composite material, said method comprising providing a nanotube and butyl rubber and using a stirred ball mill to form a composite material.
Item GG2428. A method for preparing a composite material, said method comprising providing a nanotube and cellulose acetate and using a stirred ball mill to form a composite material.
Item GG2429. A method for preparing a composite material, said method comprising providing a nanotube and cellulose nitrate and using a stirred ball mill to form a composite material.
Item GG2430. A method for preparing a composite material, said method comprising providing a nanotube and a cellulosic and using a stirred ball mill to form a composite material.
Item GG2431. A method for preparing a composite material, said method comprising providing a nanotube and a cyanoacrylate polymer and using a stirred ball mill to form a composite material.
Item GG2432. A method for preparing a composite material, said method comprising providing a nanotube and a diene polymer and using a stirred ball mill to form a composite material.
Item GG2433. A method for preparing a composite material, said method comprising providing a nanotube and an epoxy and using a stirred ball mill to form a composite material.
Item GG2434. A method for preparing a composite material, said method comprising providing a nanotube and an ethylene-propylene copolymer and using a stirred ball mill to form a composite material.
Item GG2435. A method for preparing a composite material, said method comprising providing a nanotube and a fluoroelastomer and using a stirred ball mill to form a composite material.
Item GG2436. A method for preparing a composite material, said method comprising providing a nanotube and a heterochain polymer and using a stirred ball mill to form a composite material.
Item GG2437. A method for preparing a composite material, said method comprising providing a nanotube and a melamine-formaldehyde polymer and using a stirred ball mill to form a composite material.
Item GG2438. A method for preparing a composite material, said method comprising providing a nanotube and a meta-aramid polymer and using a stirred ball mill to form a composite material.
Item GG2439. A method for preparing a composite material, said method comprising providing a nanotube and nitrile rubber and using a stirred ball mill to form a composite material.
Item GG2440. A method for preparing a composite material, said method comprising providing a nanotube and nylon and using a stirred ball mill to form a composite material.
Item GG2441. A method for preparing a composite material, said method comprising providing a nanotube and a para-aramid and using a stirred ball mill to form a composite material.
Item GG2442. A method for preparing a composite material, said method comprising providing a nanotube and poly 2-hydroxyethyl methacrylate (HEMA) and using a stirred ball mill to form a composite material.
Item GG2443. A method for preparing a composite material, said method comprising providing a nanotube and poly bisphenol A carbonate (PC) and using a stirred ball mill to form a composite material.
Item GG2444. A method for preparing a composite material, said method comprising providing a nanotube and poly butylene terephthalate (PBT) and using a stirred ball mill to form a composite material.
Item GG2445. A method for preparing a composite material, said method comprising providing a nanotube and poly dimethylsiloxane (PDMS) and using a stirred ball mill to form a composite material.
Item GG2446. A method for preparing a composite material, said method comprising providing a nanotube and poly dodecano-12-lactam (Nylon 12) and using a stirred ball mill to form a composite material.
Item GG2447. A method for preparing a composite material, said method comprising providing a nanotube and poly ether ketone ketone (PEKK) and using a stirred ball mill to
Item GG2448. A method for preparing a composite material, said method comprising providing a nanotube and poly ethylene terephthalate (PET) and using a stirred ball mill to form a composite material.
Item GG2449. A method for preparing a composite material, said method comprising providing a nanotube and poly methyl acrylate (PMA) and using a stirred ball mill to form a composite material.
Item GG2450. A method for preparing a composite material, said method comprising providing a nanotube and poly methyl methacrylate (PMMA) and using a stirred ball mill to form a composite material.
Item GG2451. A method for preparing a composite material, said method comprising providing a nanotube and poly vinyl acetate (PVA) and using a stirred ball mill to form a composite material.
Item GG2452. A method for preparing a composite material, said method comprising providing a nanotube and poly vinyl chloride (PVC) and using a stirred ball mill to form a composite material.
Item GG2453. A method for preparing a composite material, said method comprising providing a nanotube and poly vinylidene chloride (PVDC) and using a stirred ball mill to form a composite material.
Item GG2454. A method for preparing a composite material, said method comprising providing a nanotube and poly vinylidene fluoride (PVDF) and using a stirred ball mill to form a composite material.
Item GG2455. A method for preparing a composite material, said method comprising providing a nanotube and poly(acrylic acid) and using a stirred ball mill to form a composite material.
Item GG2456. A method for preparing a composite material, said method comprising providing a nanotube and poly(Bisphenol A isophthalate) and using a stirred ball mill to form a composite material.
Item GG2457. A method for preparing a composite material, said method comprising providing a nanotube and poly(Bisphenol A terephthalate) and using a stirred ball mill to form a composite material.
Item GG2458. A method for preparing a composite material, said method comprising providing a nanotube and poly(butyl acrylate) and using a stirred ball mill to form a composite material.
Item GG2459. A method for preparing a composite material, said method comprising providing a nanotube and poly(butyl methacrylate) and using a stirred ball mill to form a composite material.
Item GG2460. A method for preparing a composite material, said method comprising providing a nanotube and poly(butylene) and using a stirred ball mill to form a composite material.
Item GG2461. A method for preparing a composite material, said method comprising providing a nanotube and poly(caprolactone) and using a stirred ball mill to form a composite material.
Item GG2462. A method for preparing a composite material, said method comprising providing a nanotube and poly(chlorotrifluoroethylene) and using a stirred ball mill to form a composite material.
Item GG2463. A method for preparing a composite material, said method comprising providing a nanotube and poly(cyclohexyl methacrylate) and using a stirred ball mill to form a composite material.
Item GG2464. A method for preparing a composite material, said method comprising providing a nanotube and poly(ethyl acrylate) and using a stirred ball mill to form a composite material.
Item GG2465. A method for preparing a composite material, said method comprising providing a nanotube and poly(ethylene glycol) and using a stirred ball mill to form a composite material.
Item GG2466. A method for preparing a composite material, said method comprising providing a nanotube and poly(ethylene naphthalate) and using a stirred ball mill to form a composite material.
Item GG2467. A method for preparing a composite material, said method comprising providing a nanotube and poly(isobutylene) and using a stirred ball mill to form a composite material.
Item GG2468. A method for preparing a composite material, said method comprising providing a nanotube and poly(phenylsulfone) and using a stirred ball mill to form a composite material.
Item GG2469. A method for preparing a composite material, said method comprising providing a nanotube and poly(propylene glycol) and using a stirred ball mill to form a composite material.
Item GG2470. A method for preparing a composite material, said method comprising providing a nanotube and poly(tetrahydrofuran) and using a stirred ball mill to form a composite material.
Item GG2471. A method for preparing a composite material, said method comprising providing a nanotube and poly(α-methylstyrene) and using a stirred ball mill to form a composite material.
Item GG2472. A method for preparing a composite material, said method comprising providing a nanotube and polyacetal and using a stirred ball mill to form a composite material.
Item GG2473. A method for preparing a composite material, said method comprising providing a nanotube and polyacetal (POM) and using a stirred ball mill to form a composite material.
Item GG2474. A method for preparing a composite material, said method comprising providing a nanotube and polyacrylate elastomers and using a stirred ball mill to form a composite material.
Item GG2475. A method for preparing a composite material, said method comprising providing a nanotube and polyacrylonitrile (PAN) and using a stirred ball mill to form a composite material.
Item GG2476. A method for preparing a composite material, said method comprising providing a nanotube and polyamide and using a stirred ball mill to form a composite material.
Item GG2477. A method for preparing a composite material, said method comprising providing a nanotube and polybutadiene (PBD) and using a stirred ball mill to form a composite material.
Item GG2478. A method for preparing a composite material, said method comprising providing a nanotube and polybutadiene (butadiene rubber, BR) and using a stirred ball mill to form a composite material.
Item GG2479. A method for preparing a composite material, said method comprising providing a nanotube and polybutylene terephthalate (PBT) and using a stirred ball mill to form a composite material.
Item GG2480. A method for preparing a composite material, said method comprising providing a nanotube and polycaprolactam and using a stirred ball mill to form a composite material.
Item GG2481. A method for preparing a composite material, said method comprising providing a nanotube and polycarbonate (PC) and using a stirred ball mill to form a composite material.
Item GG2482. A method for preparing a composite material, said method comprising providing a nanotube and polychloroprene and using a stirred ball mill to form a composite material.
Item GG2483. A method for preparing a composite material, said method comprising providing a nanotube and polychlorotrifluoroethylene (PCTFE) and using a stirred ball mill to form a composite material.
Item GG2484. A method for preparing a composite material, said method comprising providing a nanotube and polyesters and using a stirred ball mill to form a composite material.
Item GG2485. A method for preparing a composite material, said method comprising providing a nanotube and polyether ether ketone (PEEK) and using a stirred ball mill to form a composite material.
Item GG2486. A method for preparing a composite material, said method comprising providing a nanotube and polyetherketone (PEK) and using a stirred ball mill to form a composite material.
Item GG2487. A method for preparing a composite material, said method comprising providing a nanotube and polyethers and using a stirred ball mill to form a composite material.
Item GG2488. A method for preparing a composite material, said method comprising providing a nanotube and polyethersulfone (PES) and using a stirred ball mill to form a composite material.
Item GG2489. A method for preparing a composite material, said method comprising providing a nanotube and polyethyl acrylate and using a stirred ball mill to form a composite material.
Item GG2490. A method for preparing a composite material, said method comprising providing a nanotube and polyethylene—cross-linked and using a stirred ball mill to form a composite material.
Item GG2491. A method for preparing a composite material, said method comprising providing a nanotube and polyethylene—high density (HDPE) and using a stirred ball mill to form a composite material.
Item GG2492. A method for preparing a composite material, said method comprising providing a nanotube and polyethylene—linear low density (LLDPE) and using a stirred ball mill to form a composite material.
Item GG2493. A method for preparing a composite material, said method comprising providing a nanotube and polyethylene—low density (LDPE) and using a stirred ball mill to form a composite material.
Item GG2494. A method for preparing a composite material, said method comprising providing a nanotube and polyethylene—medium density (MDPE) and using a stirred ball mill to form a composite material.
Item GG2495. A method for preparing a composite material, said method comprising providing a nanotube and polyethylene—ultrahigh molecular weight (UHMWPE) and using a stirred ball mill to form a composite material.
Item GG2496. A method for preparing a composite material, said method comprising providing a nanotube and polyethylene—very low density (VLDPE) and using a stirred ball mill to form a composite material.
Item GG2497. A method for preparing a composite material, said method comprising providing a nanotube and polyethylene terephthalate (PET) and using a stirred ball mill to form a composite material.
Item GG2498. A method for preparing a composite material, said method comprising providing a nanotube and polyethylene (PE) and using a stirred ball mill to form a composite material.
Item GG2499. A method for preparing a composite material, said method comprising providing a nanotube and polyglycolide and using a stirred ball mill to form a composite material.
Item GG2500. A method for preparing a composite material, said method comprising providing a nanotube and polyhexamethylene adipamide (PA 6,6) and using a stirred ball mill to form a composite material.
Item GG2501. A method for preparing a composite material, said method comprising providing a nanotube and polyimides and using a stirred ball mill to form a composite material.
Item GG2502. A method for preparing a composite material, said method comprising providing a nanotube and polyisoprene (natural rubber, NR; isoprene rubber, IR) and using a stirred ball mill to form a composite material.
Item GG2503. A method for preparing a composite material, said method comprising providing a nanotube and polylactic acid (PLA) and using a stirred ball mill to form a composite material.
Item GG2504. A method for preparing a composite material, said method comprising providing a nanotube and polymethyl acrylate and using a stirred ball mill to form a composite material.
Item GG2505. A method for preparing a composite material, said method comprising providing a nanotube and polymethyl methacrylate (PMMA) and using a stirred ball mill to form a composite material.
Item GG2506. A method for preparing a composite material, said method comprising providing a nanotube and polyphenylene oxide (PPO) and using a stirred ball mill to form a composite material.
Item GG2507. A method for preparing a composite material, said method comprising providing a nanotube and polyphenylene sulfide (PPS) and using a stirred ball mill to form a composite material.
Item GG2508. A method for preparing a composite material, said method comprising providing a nanotube and poly-p-phenylene-2,6-benzobisoxazole (PBO) and using a stirred ball mill to form a composite material.
Item GG2509. A method for preparing a composite material, said method comprising providing a nanotube and polypropylene (PP) and using a stirred ball mill to form a composite material.
Item GG2510. A method for preparing a composite material, said method comprising providing a nanotube and polysiloxanes (silicones) and using a stirred ball mill to form a composite material.
Item GG2511. A method for preparing a composite material, said method comprising providing a nanotube and polystyrene (PS) and using a stirred ball mill to form a composite material.
Item GG2512. A method for preparing a composite material, said method comprising providing a nanotube and polysulfide rubber and using a stirred ball mill to form a composite material.
Item GG2513. A method for preparing a composite material, said method comprising providing a nanotube and polysulfides and using a stirred ball mill to form a composite material.
Item GG2514. A method for preparing a composite material, said method comprising providing a nanotube and polytetrafluoroethylene (PTFE) and using a stirred ball mill to form a composite material.
Item GG2515. A method for preparing a composite material, said method comprising providing a nanotube and polytrimethylene terephthalate (PTT) and using a stirred ball mill to form a composite material.
Item GG2516. A method for preparing a composite material, said method comprising providing a nanotube and polyurethane and using a stirred ball mill to form a composite material.
Item GG2517. A method for preparing a composite material, said method comprising providing a nanotube and polyvinyl acetate (PVAc) and using a stirred ball mill to form a composite material.
Item GG2518. A method for preparing a composite material, said method comprising providing a nanotube and polyvinyl chloride (PVC) and using a stirred ball mill to form a composite material.
Item GG2519. A method for preparing a composite material, said method comprising providing a nanotube and polyvinyl fluoride (PVF) and using a stirred ball mill to form a composite material.
Item GG2520. A method for preparing a composite material, said method comprising providing a nanotube and polyvinylidene chloride (PVDC) and using a stirred ball mill to form a composite material.
Item GG2521. A method for preparing a composite material, said method comprising providing a nanotube and polyvinylidene fluoride (PVDF) and using a stirred ball mill to form a composite material.
Item GG2522. A method for preparing a composite material, said method comprising providing a nanotube and rayon and using a stirred ball mill to form a composite material.
Item GG2523. A method for preparing a composite material, said method comprising providing a nanotube and styrene-acrylonitrile (SAN) and using a stirred ball mill to form a composite material.
Item GG2524. A method for preparing a composite material, said method comprising providing a nanotube and styrene-butadiene and using a stirred ball mill to form a composite material.
Item GG2525. A method for preparing a composite material, said method comprising providing a nanotube and styrene-isoprene and using a stirred ball mill to form a composite material.
Item GG2526. A method for preparing a composite material, said method comprising providing a nanotube and a styrene-maleic anhydride copolymer and using a stirred ball mill to form a composite material.
Item GG2527. A method for preparing a composite material, said method comprising providing a nanotube and a thermoplastic polyurethanes (TPU) and using a stirred ball mill to form a composite material.
Item GG2528. A method for preparing a composite material, said method comprising providing a nanotube and an unsaturated polyester and using a stirred ball mill to form a composite material.
Item GG2529. A method for preparing a composite material, said method comprising providing a nanotube and a urea-formaldehyde polymer and using a stirred ball mill to form a composite material.
Item GG2530. A method for preparing a composite material, said method comprising providing a nanotube and a vinyl copolymer and using a stirred ball mill to form a composite material.
Item GG2531. A method for preparing a composite material, said method comprising providing a nanotube and an acrylic polymer and using a thin-film spin mixer to form a composite material.
Item GG2532. A method for preparing a composite material, said method comprising providing a nanotube and acrylonitrile-butadiene-styrene (ABS) and using a thin-film spin mixer to form a composite material.
Item GG2533. A method for preparing a composite material, said method comprising providing a nanotube and an aldehyde condensation polymer and using a thin-film spin mixer to form a composite material.
Item GG2534. A method for preparing a composite material, said method comprising providing a nanotube and an aliphatic polyether and using a thin-film spin mixer to form a composite material.
Item GG2535. A method for preparing a composite material, said method comprising providing a nanotube and an alkyds and oil-free coating polyester and using a thin-film spin mixer to form a composite material.
Item GG2536. A method for preparing a composite material, said method comprising providing a nanotube and an aramid and using a thin-film spin mixer to form a composite material.
Item GG2537. A method for preparing a composite material, said method comprising providing a nanotube and butyl rubber and using a thin-film spin mixer to form a composite material.
Item GG2538. A method for preparing a composite material, said method comprising providing a nanotube and cellulose acetate and using a thin-film spin mixer to form a composite material.
Item GG2539. A method for preparing a composite material, said method comprising providing a nanotube and cellulose nitrate and using a thin-film spin mixer to form a composite material.
Item GG2540. A method for preparing a composite material, said method comprising providing a nanotube and a cellulosic and using a thin-film spin mixer to form a composite material.
Item GG2541. A method for preparing a composite material, said method comprising providing a nanotube and a cyanoacrylate polymer and using a thin-film spin mixer to form a composite material.
Item GG2542. A method for preparing a composite material, said method comprising providing a nanotube and a diene polymer and using a thin-film spin mixer to form a composite material.
Item GG2543. A method for preparing a composite material, said method comprising providing a nanotube and an epoxy and using a thin-film spin mixer to form a composite material.
Item GG2544. A method for preparing a composite material, said method comprising providing a nanotube and an ethylene-propylene copolymer and using a thin-film spin mixer to form a composite material.
Item GG2545. A method for preparing a composite material, said method comprising providing a nanotube and a fluoroelastomer and using a thin-film spin mixer to form a composite material.
Item GG2546. A method for preparing a composite material, said method comprising providing a nanotube and a heterochain polymer and using a thin-film spin mixer to form a composite material.
Item GG2547. A method for preparing a composite material, said method comprising providing a nanotube and a melamine-formaldehyde polymer and using a thin-film spin mixer to form a composite material.
Item GG2548. A method for preparing a composite material, said method comprising providing a nanotube and a meta-aramid polymer and using a thin-film spin mixer to form a composite material.
Item GG2549. A method for preparing a composite material, said method comprising providing a nanotube and nitrile rubber and using a thin-film spin mixer to form a composite material.
Item GG2550. A method for preparing a composite material, said method comprising providing a nanotube and nylon and using a thin-film spin mixer to form a composite material.
Item GG2551. A method for preparing a composite material, said method comprising providing a nanotube and a para-aramid and using a thin-film spin mixer to form a composite material.
Item GG2552. A method for preparing a composite material, said method comprising providing a nanotube and poly 2-hydroxyethyl methacrylate (HEMA) and using a thin-film spin mixer to form a composite material.
Item GG2553. A method for preparing a composite material, said method comprising providing a nanotube and poly bisphenol A carbonate (PC) and using a thin-film spin mixer to form a composite material.
Item GG2554. A method for preparing a composite material, said method comprising providing a nanotube and poly butylene terephthalate (PBT) and using a thin-film spin mixer to form a composite material.
Item GG2555. A method for preparing a composite material, said method comprising providing a nanotube and poly dimethylsiloxane (PDMS) and using a thin-film spin mixer to form a composite material.
Item GG2556. A method for preparing a composite material, said method comprising providing a nanotube and poly dodecano-12-lactam (Nylon 12) and using a thin-film spin mixer to form a composite material.
Item GG2557. A method for preparing a composite material, said method comprising providing a nanotube and poly ether ketone ketone (PEKK) and using a thin-film spin mixer to form a composite material.
Item GG2558. A method for preparing a composite material, said method comprising providing a nanotube and poly ethylene terephthalate (PET) and using a thin-film spin mixer to form a composite material.
Item GG2559. A method for preparing a composite material, said method comprising providing a nanotube and poly methyl acrylate (PMA) and using a thin-film spin mixer to form a composite material.
Item GG2560. A method for preparing a composite material, said method comprising providing a nanotube and poly methyl methacrylate (PMMA) and using a thin-film spin mixer to form a composite material.
Item GG2561. A method for preparing a composite material, said method comprising providing a nanotube and poly vinyl acetate (PVA) and using a thin-film spin mixer to form a composite material.
Item GG2562. A method for preparing a composite material, said method comprising providing a nanotube and poly vinyl chloride (PVC) and using a thin-film spin mixer to form a composite material.
Item GG2563. A method for preparing a composite material, said method comprising providing a nanotube and poly vinylidene chloride (PVDC) and using a thin-film spin mixer to form a composite material.
Item GG2564. A method for preparing a composite material, said method comprising providing a nanotube and poly vinylidene fluoride (PVDF) and using a thin-film spin mixer to form a composite material.
Item GG2565. A method for preparing a composite material, said method comprising providing a nanotube and poly(acrylic acid) and using a thin-film spin mixer to form a composite material.
Item GG2566. A method for preparing a composite material, said method comprising providing a nanotube and poly(Bisphenol A isophthalate) and using a thin-film spin mixer to form a composite material.
Item GG2567. A method for preparing a composite material, said method comprising providing a nanotube and poly(Bisphenol A terephthalate) and using a thin-film spin mixer to form a composite material.
Item GG2568. A method for preparing a composite material, said method comprising providing a nanotube and poly(butyl acrylate) and using a thin-film spin mixer to form a composite material.
Item GG2569. A method for preparing a composite material, said method comprising providing a nanotube and poly(butyl methacrylate) and using a thin-film spin mixer to form a composite material.
Item GG2570. A method for preparing a composite material, said method comprising providing a nanotube and poly(butylene) and using a thin-film spin mixer to form a composite material.
Item GG2571. A method for preparing a composite material, said method comprising providing a nanotube and poly(caprolactone) and using a thin-film spin mixer to form a composite material.
Item GG2572. A method for preparing a composite material, said method comprising providing a nanotube and poly(chlorotrifluoroethylene) and using a thin-film spin mixer to form a composite material.
Item GG2573. A method for preparing a composite material, said method comprising providing a nanotube and poly(cyclohexyl methacrylate) and using a thin-film spin mixer to
Item GG2574. A method for preparing a composite material, said method comprising providing a nanotube and poly(ethyl acrylate) and using a thin-film spin mixer to form a composite material.
Item GG2575. A method for preparing a composite material, said method comprising providing a nanotube and poly(ethylene glycol) and using a thin-film spin mixer to form a composite material.
Item GG2576. A method for preparing a composite material, said method comprising providing a nanotube and poly(ethylene naphthalate) and using a thin-film spin mixer to form a composite material.
Item GG2577. A method for preparing a composite material, said method comprising providing a nanotube and poly(isobutylene) and using a thin-film spin mixer to form a composite material.
Item GG2578. A method for preparing a composite material, said method comprising providing a nanotube and poly(phenylsulfone) and using a thin-film spin mixer to form a composite material.
Item GG2579. A method for preparing a composite material, said method comprising providing a nanotube and poly(propylene glycol) and using a thin-film spin mixer to form a composite material.
Item GG2580. A method for preparing a composite material, said method comprising providing a nanotube and poly(tetrahydrofuran) and using a thin-film spin mixer to form a composite material.
Item GG2581. A method for preparing a composite material, said method comprising providing a nanotube and poly(α-methylstyrene) and using a thin-film spin mixer to form a composite material.
Item GG2582. A method for preparing a composite material, said method comprising providing a nanotube and polyacetal and using a thin-film spin mixer to form a composite material.
Item GG2583. A method for preparing a composite material, said method comprising providing a nanotube and polyacetal (POM) and using a thin-film spin mixer to form a composite material.
Item GG2584. A method for preparing a composite material, said method comprising providing a nanotube and polyacrylate elastomers and using a thin-film spin mixer to form a composite material.
Item GG2585. A method for preparing a composite material, said method comprising providing a nanotube and polyacrylonitrile (PAN) and using a thin-film spin mixer to form a composite material.
Item GG2586. A method for preparing a composite material, said method comprising providing a nanotube and polyamide and using a thin-film spin mixer to form a composite material.
Item GG2587. A method for preparing a composite material, said method comprising providing a nanotube and polybutadiene (PBD) and using a thin-film spin mixer to form a composite material.
Item GG2588. A method for preparing a composite material, said method comprising providing a nanotube and polybutadiene (butadiene rubber, BR) and using a thin-film spin mixer to form a composite material.
Item GG2589. A method for preparing a composite material, said method comprising providing a nanotube and polybutylene terephthalate (PBT) and using a thin-film spin mixer to form a composite material.
Item GG2590. A method for preparing a composite material, said method comprising providing a nanotube and polycaprolactam and using a thin-film spin mixer to form a composite material.
Item GG2591. A method for preparing a composite material, said method comprising providing a nanotube and polycarbonate (PC) and using a thin-film spin mixer to form a composite material.
Item GG2592. A method for preparing a composite material, said method comprising providing a nanotube and polychloroprene and using a thin-film spin mixer to form a composite material.
Item GG2593. A method for preparing a composite material, said method comprising providing a nanotube and polychlorotrifluoroethylene (PCTFE) and using a thin-film spin mixer to form a composite material.
Item GG2594. A method for preparing a composite material, said method comprising providing a nanotube and polyesters and using a thin-film spin mixer to form a composite material.
Item GG2595. A method for preparing a composite material, said method comprising providing a nanotube and polyether ether ketone (PEEK) and using a thin-film spin mixer to form a composite material.
Item GG2596. A method for preparing a composite material, said method comprising providing a nanotube and polyetherketone (PEK) and using a thin-film spin mixer to form a composite material.
Item GG2597. A method for preparing a composite material, said method comprising providing a nanotube and polyethers and using a thin-film spin mixer to form a composite material.
Item GG2598. A method for preparing a composite material, said method comprising providing a nanotube and polyethersulfone (PES) and using a thin-film spin mixer to form a composite material.
Item GG2599. A method for preparing a composite material, said method comprising providing a nanotube and polyethyl acrylate and using a thin-film spin mixer to form a composite material.
Item GG2600. A method for preparing a composite material, said method comprising providing a nanotube and polyethylene—cross-linked and using a thin-film spin mixer to form a composite material.
Item GG2601. A method for preparing a composite material, said method comprising providing a nanotube and polyethylene—high density (HDPE) and using a thin-film spin mixer to form a composite material.
Item GG2602. A method for preparing a composite material, said method comprising providing a nanotube and polyethylene—linear low density (LLDPE) and using a thin-film spin mixer to form a composite material.
Item GG2603. A method for preparing a composite material, said method comprising providing a nanotube and polyethylene—low density (LDPE) and using a thin-film spin mixer to form a composite material.
Item GG2604. A method for preparing a composite material, said method comprising providing a nanotube and polyethylene—medium density (MDPE) and using a thin-film spin mixer to form a composite material.
Item GG2605. A method for preparing a composite material, said method comprising providing a nanotube and polyethylene—ultrahigh molecular weight (UHMWPE) and using a thin-film spin mixer to form a composite material.
Item GG2606. A method for preparing a composite material, said method comprising providing a nanotube and polyethylene—very low density (VLDPE) and using a thin-film spin mixer to form a composite material.
Item GG2607. A method for preparing a composite material, said method comprising providing a nanotube and polyethylene terephthalate (PET) and using a thin-film spin mixer to form a composite material.
Item GG2608. A method for preparing a composite material, said method comprising providing a nanotube and polyethylene (PE) and using a thin-film spin mixer to form a composite material.
Item GG2609. A method for preparing a composite material, said method comprising providing a nanotube and polyglycolide and using a thin-film spin mixer to form a composite material.
Item GG2610. A method for preparing a composite material, said method comprising providing a nanotube and polyhexamethylene adipamide (PA 6,6) and using a thin-film spin mixer to form a composite material.
Item GG2611. A method for preparing a composite material, said method comprising providing a nanotube and polyimides and using a thin-film spin mixer to form a composite material.
Item GG2612. A method for preparing a composite material, said method comprising providing a nanotube and polyisoprene (natural rubber, NR; isoprene rubber, IR) and using a thin-film spin mixer to form a composite material.
Item GG2613. A method for preparing a composite material, said method comprising providing a nanotube and polylactic acid (PLA) and using a thin-film spin mixer to form a composite material.
Item GG2614. A method for preparing a composite material, said method comprising providing a nanotube and polymethyl acrylate and using a thin-film spin mixer to form a composite material.
Item GG2615. A method for preparing a composite material, said method comprising providing a nanotube and polymethyl methacrylate (PMMA) and using a thin-film spin mixer to form a composite material.
Item GG2616. A method for preparing a composite material, said method comprising providing a nanotube and polyphenylene oxide (PPO) and using a thin-film spin mixer to form a composite material.
Item GG2617. A method for preparing a composite material, said method comprising providing a nanotube and polyphenylene sulfide (PPS) and using a thin-film spin mixer to form a composite material.
Item GG2618. A method for preparing a composite material, said method comprising providing a nanotube and poly-p-phenylene-2,6-benzobisoxazole (PBO) and using a thin-film spin mixer to form a composite material.
Item GG2619. A method for preparing a composite material, said method comprising providing a nanotube and polypropylene (PP) and using a thin-film spin mixer to form a composite material.
Item GG2620. A method for preparing a composite material, said method comprising providing a nanotube and polysiloxanes (silicones) and using a thin-film spin mixer to form a composite material.
Item GG2621. A method for preparing a composite material, said method comprising providing a nanotube and polystyrene (PS) and using a thin-film spin mixer to form a composite material.
Item GG2622. A method for preparing a composite material, said method comprising providing a nanotube and polysulfide rubber and using a thin-film spin mixer to form a composite material.
Item GG2623. A method for preparing a composite material, said method comprising providing a nanotube and polysulfides and using a thin-film spin mixer to form a composite material.
Item GG2624. A method for preparing a composite material, said method comprising providing a nanotube and polytetrafluoroethylene (PTFE) and using a thin-film spin mixer to form a composite material.
Item GG2625. A method for preparing a composite material, said method comprising providing a nanotube and polytrimethylene terephthalate (PTT) and using a thin-film spin mixer to form a composite material.
Item GG2626. A method for preparing a composite material, said method comprising providing a nanotube and polyurethane and using a thin-film spin mixer to form a composite material.
Item GG2627. A method for preparing a composite material, said method comprising providing a nanotube and polyvinyl acetate (PVAc) and using a thin-film spin mixer to form a composite material.
Item GG2628. A method for preparing a composite material, said method comprising providing a nanotube and polyvinyl chloride (PVC) and using a thin-film spin mixer to form a composite material.
Item GG2629. A method for preparing a composite material, said method comprising providing a nanotube and polyvinyl fluoride (PVF) and using a thin-film spin mixer to form a composite material.
Item GG2630. A method for preparing a composite material, said method comprising providing a nanotube and polyvinylidene chloride (PVDC) and using a thin-film spin mixer to form a composite material.
Item GG2631. A method for preparing a composite material, said method comprising providing a nanotube and polyvinylidene fluoride (PVDF) and using a thin-film spin mixer to form a composite material.
Item GG2632. A method for preparing a composite material, said method comprising providing a nanotube and rayon and using a thin-film spin mixer to form a composite material.
Item GG2633. A method for preparing a composite material, said method comprising providing a nanotube and styrene-acrylonitrile (SAN) and using a thin-film spin mixer to form a composite material.
Item GG2634. A method for preparing a composite material, said method comprising providing a nanotube and styrene-butadiene and using a thin-film spin mixer to form a composite material.
Item GG2635. A method for preparing a composite material, said method comprising providing a nanotube and styrene-isoprene and using a thin-film spin mixer to form a composite material.
Item GG2636. A method for preparing a composite material, said method comprising providing a nanotube and a styrene-maleic anhydride copolymer and using a thin-film spin mixer to form a composite material.
Item GG2637. A method for preparing a composite material, said method comprising providing a nanotube and a thermoplastic polyurethanes (TPU) and using a thin-film spin mixer to form a composite material.
Item GG2638. A method for preparing a composite material, said method comprising providing a nanotube and an unsaturated polyester and using a thin-film spin mixer to form a composite material.
Item GG2639. A method for preparing a composite material, said method comprising providing a nanotube and a urea-formaldehyde polymer and using a thin-film spin mixer to form a composite material.
Item GG2640. A method for preparing a composite material, said method comprising providing a nanotube and a vinyl copolymer and using a thin-film spin mixer to form a composite material.
Item GG2641. A method for preparing a composite material, said method comprising providing a nanotube and an acrylic polymer and using a tumbling mill to form a composite material.
Item GG2642. A method for preparing a composite material, said method comprising providing a nanotube and acrylonitrile-butadiene-styrene (ABS) and using a tumbling mill to form a composite material.
Item GG2643. A method for preparing a composite material, said method comprising providing a nanotube and an aldehyde condensation polymer and using a tumbling mill to
Item GG2644. A method for preparing a composite material, said method comprising providing a nanotube and an aliphatic polyether and using a tumbling mill to form a composite material.
Item GG2645. A method for preparing a composite material, said method comprising providing a nanotube and an alkyds and oil-free coating polyester and using a tumbling mill to form a composite material.
Item GG2646. A method for preparing a composite material, said method comprising providing a nanotube and an aramid and using a tumbling mill to form a composite material.
Item GG2647. A method for preparing a composite material, said method comprising providing a nanotube and butyl rubber and using a tumbling mill to form a composite material.
Item GG2648. A method for preparing a composite material, said method comprising providing a nanotube and cellulose acetate and using a tumbling mill to form a composite material.
Item GG2649. A method for preparing a composite material, said method comprising providing a nanotube and cellulose nitrate and using a tumbling mill to form a composite material.
Item GG2650. A method for preparing a composite material, said method comprising providing a nanotube and a cellulosic and using a tumbling mill to form a composite material.
Item GG2651. A method for preparing a composite material, said method comprising providing a nanotube and a cyanoacrylate polymer and using a tumbling mill to form a composite material.
Item GG2652. A method for preparing a composite material, said method comprising providing a nanotube and a diene polymer and using a tumbling mill to form a composite material.
Item GG2653. A method for preparing a composite material, said method comprising providing a nanotube and an epoxy and using a tumbling mill to form a composite material.
Item GG2654. A method for preparing a composite material, said method comprising providing a nanotube and an ethylene-propylene copolymer and using a tumbling mill to form a composite material.
Item GG2655. A method for preparing a composite material, said method comprising providing a nanotube and a fluoroelastomer and using a tumbling mill to form a composite material.
Item GG2656. A method for preparing a composite material, said method comprising providing a nanotube and a heterochain polymer and using a tumbling mill to form a composite material.
Item GG2657. A method for preparing a composite material, said method comprising providing a nanotube and a melamine-formaldehyde polymer and using a tumbling mill to form a composite material.
Item GG2658. A method for preparing a composite material, said method comprising providing a nanotube and a meta-aramid polymer and using a tumbling mill to form a composite material.
Item GG2659. A method for preparing a composite material, said method comprising providing a nanotube and nitrile rubber and using a tumbling mill to form a composite material.
Item GG2660. A method for preparing a composite material, said method comprising providing a nanotube and nylon and using a tumbling mill to form a composite material.
Item GG2661. A method for preparing a composite material, said method comprising providing a nanotube and a para-aramid and using a tumbling mill to form a composite material.
Item GG2662. A method for preparing a composite material, said method comprising providing a nanotube and poly 2-hydroxyethyl methacrylate (HEMA) and using a tumbling mill to form a composite material.
Item GG2663. A method for preparing a composite material, said method comprising providing a nanotube and poly bisphenol A carbonate (PC) and using a tumbling mill to form a composite material.
Item GG2664. A method for preparing a composite material, said method comprising providing a nanotube and poly butylene terephthalate (PBT) and using a tumbling mill to form a composite material.
Item GG2665. A method for preparing a composite material, said method comprising providing a nanotube and poly dimethylsiloxane (PDMS) and using a tumbling mill to form a composite material.
Item GG2666. A method for preparing a composite material, said method comprising providing a nanotube and poly dodecano-12-lactam (Nylon 12) and using a tumbling mill to form a composite material.
Item GG2667. A method for preparing a composite material, said method comprising providing a nanotube and poly ether ketone ketone (PEKK) and using a tumbling mill to form a composite material.
Item GG2668. A method for preparing a composite material, said method comprising providing a nanotube and poly ethylene terephthalate (PET) and using a tumbling mill to form a composite material.
Item GG2669. A method for preparing a composite material, said method comprising providing a nanotube and poly methyl acrylate (PMA) and using a tumbling mill to form a composite material.
Item GG2670. A method for preparing a composite material, said method comprising providing a nanotube and poly methyl methacrylate (PMMA) and using a tumbling mill to form a composite material.
Item GG2671. A method for preparing a composite material, said method comprising providing a nanotube and poly vinyl acetate (PVA) and using a tumbling mill to form a composite material.
Item GG2672. A method for preparing a composite material, said method comprising providing a nanotube and poly vinyl chloride (PVC) and using a tumbling mill to form a composite material.
Item GG2673. A method for preparing a composite material, said method comprising providing a nanotube and poly vinylidene chloride (PVDC) and using a tumbling mill to form a composite material.
Item GG2674. A method for preparing a composite material, said method comprising providing a nanotube and poly vinylidene fluoride (PVDF) and using a tumbling mill to form a composite material.
Item GG2675. A method for preparing a composite material, said method comprising providing a nanotube and poly(acrylic acid) and using a tumbling mill to form a composite material.
Item GG2676. A method for preparing a composite material, said method comprising providing a nanotube and poly(Bisphenol A isophthalate) and using a tumbling mill to form a composite material.
Item GG2677. A method for preparing a composite material, said method comprising providing a nanotube and poly(Bisphenol A terephthalate) and using a tumbling mill to form a composite material.
Item GG2678. A method for preparing a composite material, said method comprising providing a nanotube and poly(butyl acrylate) and using a tumbling mill to form a composite material.
Item GG2679. A method for preparing a composite material, said method comprising providing a nanotube and poly(butyl methacrylate) and using a tumbling mill to form a composite material.
Item GG2680. A method for preparing a composite material, said method comprising providing a nanotube and poly(butylene) and using a tumbling mill to form a composite material.
Item GG2681. A method for preparing a composite material, said method comprising providing a nanotube and poly(caprolactone) and using a tumbling mill to form a composite material.
Item GG2682. A method for preparing a composite material, said method comprising providing a nanotube and poly(chlorotrifluoroethylene) and using a tumbling mill to form a composite material.
Item GG2683. A method for preparing a composite material, said method comprising providing a nanotube and poly(cyclohexyl methacrylate) and using a tumbling mill to form a composite material.
Item GG2684. A method for preparing a composite material, said method comprising providing a nanotube and poly(ethyl acrylate) and using a tumbling mill to form a composite material.
Item GG2685. A method for preparing a composite material, said method comprising providing a nanotube and poly(ethylene glycol) and using a tumbling mill to form a composite material.
Item GG2686. A method for preparing a composite material, said method comprising providing a nanotube and poly(ethylene naphthalate) and using a tumbling mill to form a composite material.
Item GG2687. A method for preparing a composite material, said method comprising providing a nanotube and poly(isobutylene) and using a tumbling mill to form a composite material.
Item GG2688. A method for preparing a composite material, said method comprising providing a nanotube and poly(phenylsulfone) and using a tumbling mill to form a composite material.
Item GG2689. A method for preparing a composite material, said method comprising providing a nanotube and poly(propylene glycol) and using a tumbling mill to form a composite material.
Item GG2690. A method for preparing a composite material, said method comprising providing a nanotube and poly(tetrahydrofuran) and using a tumbling mill to form a composite material.
Item GG2691. A method for preparing a composite material, said method comprising providing a nanotube and poly(α-methylstyrene) and using a tumbling mill to form a composite material.
Item GG2692. A method for preparing a composite material, said method comprising providing a nanotube and polyacetal and using a tumbling mill to form a composite material.
Item GG2693. A method for preparing a composite material, said method comprising providing a nanotube and polyacetal (POM) and using a tumbling mill to form a composite material.
Item GG2694. A method for preparing a composite material, said method comprising providing a nanotube and polyacrylate elastomers and using a tumbling mill to form a composite material.
Item GG2695. A method for preparing a composite material, said method comprising providing a nanotube and polyacrylonitrile (PAN) and using a tumbling mill to form a composite material.
Item GG2696. A method for preparing a composite material, said method comprising providing a nanotube and polyamide and using a tumbling mill to form a composite material.
Item GG2697. A method for preparing a composite material, said method comprising providing a nanotube and polybutadiene (PBD) and using a tumbling mill to form a composite material.
Item GG2698. A method for preparing a composite material, said method comprising providing a nanotube and polybutadiene (butadiene rubber, BR) and using a tumbling mill to form a composite material.
Item GG2699. A method for preparing a composite material, said method comprising providing a nanotube and polybutylene terephthalate (PBT) and using a tumbling mill to form a composite material.
Item GG2700. A method for preparing a composite material, said method comprising providing a nanotube and polycaprolactam and using a tumbling mill to form a composite material.
Item GG2701. A method for preparing a composite material, said method comprising providing a nanotube and polycarbonate (PC) and using a tumbling mill to form a composite material.
Item GG2702. A method for preparing a composite material, said method comprising providing a nanotube and polychloroprene and using a tumbling mill to form a composite material.
Item GG2703. A method for preparing a composite material, said method comprising providing a nanotube and polychlorotrifluoroethylene (PCTFE) and using a tumbling mill to form a composite material.
Item GG2704. A method for preparing a composite material, said method comprising providing a nanotube and polyesters and using a tumbling mill to form a composite material.
Item GG2705. A method for preparing a composite material, said method comprising providing a nanotube and polyether ether ketone (PEEK) and using a tumbling mill to form a composite material.
Item GG2706. A method for preparing a composite material, said method comprising providing a nanotube and polyetherketone (PEK) and using a tumbling mill to form a composite material.
Item GG2707. A method for preparing a composite material, said method comprising providing a nanotube and polyethers and using a tumbling mill to form a composite material.
Item GG2708. A method for preparing a composite material, said method comprising providing a nanotube and polyethersulfone (PES) and using a tumbling mill to form a composite material.
Item GG2709. A method for preparing a composite material, said method comprising providing a nanotube and polyethyl acrylate and using a tumbling mill to form a composite material.
Item GG2710. A method for preparing a composite material, said method comprising providing a nanotube and polyethylene—cross-linked and using a tumbling mill to form a composite material.
Item GG2711. A method for preparing a composite material, said method comprising providing a nanotube and polyethylene—high density (HDPE) and using a tumbling mill to form a composite material.
Item GG2712. A method for preparing a composite material, said method comprising providing a nanotube and polyethylene—linear low density (LLDPE) and using a tumbling mill to form a composite material.
Item GG2713. A method for preparing a composite material, said method comprising providing a nanotube and polyethylene—low density (LDPE) and using a tumbling mill to form a composite material.
Item GG2714. A method for preparing a composite material, said method comprising providing a nanotube and polyethylene—medium density (MDPE) and using a tumbling mill to form a composite material.
Item GG2715. A method for preparing a composite material, said method comprising providing a nanotube and polyethylene—ultrahigh molecular weight (UHMWPE) and using a tumbling mill to form a composite material.
Item GG2716. A method for preparing a composite material, said method comprising providing a nanotube and polyethylene—very low density (VLDPE) and using a tumbling mill to form a composite material.
Item GG2717. A method for preparing a composite material, said method comprising providing a nanotube and polyethylene terephthalate (PET) and using a tumbling mill to form a composite material.
Item GG2718. A method for preparing a composite material, said method comprising providing a nanotube and polyethylene (PE) and using a tumbling mill to form a composite material.
Item GG2719. A method for preparing a composite material, said method comprising providing a nanotube and polyglycolide and using a tumbling mill to form a composite material.
Item GG2720. A method for preparing a composite material, said method comprising providing a nanotube and polyhexamethylene adipamide (PA 6,6) and using a tumbling mill to form a composite material.
Item GG2721. A method for preparing a composite material, said method comprising providing a nanotube and polyimides and using a tumbling mill to form a composite material.
Item GG2722. A method for preparing a composite material, said method comprising providing a nanotube and polyisoprene (natural rubber, NR; isoprene rubber, IR) and using a tumbling mill to form a composite material.
Item GG2723. A method for preparing a composite material, said method comprising providing a nanotube and polylactic acid (PLA) and using a tumbling mill to form a composite material.
Item GG2724. A method for preparing a composite material, said method comprising providing a nanotube and polymethyl acrylate and using a tumbling mill to form a composite material.
Item GG2725. A method for preparing a composite material, said method comprising providing a nanotube and polymethyl methacrylate (PMMA) and using a tumbling mill to form a composite material.
Item GG2726. A method for preparing a composite material, said method comprising providing a nanotube and polyphenylene oxide (PPO) and using a tumbling mill to form a composite material.
Item GG2727. A method for preparing a composite material, said method comprising providing a nanotube and polyphenylene sulfide (PPS) and using a tumbling mill to form a composite material.
Item GG2728. A method for preparing a composite material, said method comprising providing a nanotube and poly-p-phenylene-2,6-benzobisoxazole (PBO) and using a tumbling mill to form a composite material.
Item GG2729. A method for preparing a composite material, said method comprising providing a nanotube and polypropylene (PP) and using a tumbling mill to form a composite material.
Item GG2730. A method for preparing a composite material, said method comprising providing a nanotube and polysiloxanes (silicones) and using a tumbling mill to form a composite material.
Item GG2731. A method for preparing a composite material, said method comprising providing a nanotube and polystyrene (PS) and using a tumbling mill to form a composite material.
Item GG2732. A method for preparing a composite material, said method comprising providing a nanotube and polysulfide rubber and using a tumbling mill to form a composite material.
Item GG2733. A method for preparing a composite material, said method comprising providing a nanotube and polysulfides and using a tumbling mill to form a composite material.
Item GG2734. A method for preparing a composite material, said method comprising providing a nanotube and polytetrafluoroethylene (PTFE) and using a tumbling mill to form a composite material.
Item GG2735. A method for preparing a composite material, said method comprising providing a nanotube and polytrimethylene terephthalate (PTT) and using a tumbling mill to form a composite material.
Item GG2736. A method for preparing a composite material, said method comprising providing a nanotube and polyurethane and using a tumbling mill to form a composite material.
Item GG2737. A method for preparing a composite material, said method comprising providing a nanotube and polyvinyl acetate (PVAc) and using a tumbling mill to form a composite material.
Item GG2738. A method for preparing a composite material, said method comprising providing a nanotube and polyvinyl chloride (PVC) and using a tumbling mill to form a composite material.
Item GG2739. A method for preparing a composite material, said method comprising providing a nanotube and polyvinyl fluoride (PVF) and using a tumbling mill to form a composite material.
Item GG2740. A method for preparing a composite material, said method comprising providing a nanotube and polyvinylidene chloride (PVDC) and using a tumbling mill to form a composite material.
Item GG2741. A method for preparing a composite material, said method comprising providing a nanotube and polyvinylidene fluoride (PVDF) and using a tumbling mill to form a composite material.
Item GG2742. A method for preparing a composite material, said method comprising providing a nanotube and rayon and using a tumbling mill to form a composite material.
Item GG2743. A method for preparing a composite material, said method comprising providing a nanotube and styrene-acrylonitrile (SAN) and using a tumbling mill to form a composite material.
Item GG2744. A method for preparing a composite material, said method comprising providing a nanotube and styrene-butadiene and using a tumbling mill to form a composite material.
Item GG2745. A method for preparing a composite material, said method comprising providing a nanotube and styrene-isoprene and using a tumbling mill to form a composite material.
Item GG2746. A method for preparing a composite material, said method comprising providing a nanotube and a styrene-maleic anhydride copolymer and using a tumbling mill to form a composite material.
Item GG2747. A method for preparing a composite material, said method comprising providing a nanotube and a thermoplastic polyurethanes (TPU) and using a tumbling mill to form a composite material.
Item GG2748. A method for preparing a composite material, said method comprising providing a nanotube and an unsaturated polyester and using a tumbling mill to form a composite material.
Item GG2749. A method for preparing a composite material, said method comprising providing a nanotube and a urea-formaldehyde polymer and using a tumbling mill to form a composite material.
Item GG2750. A method for preparing a composite material, said method comprising providing a nanotube and a vinyl copolymer and using a tumbling mill to form a composite material.
Item GG2751. A method for preparing a composite material, said method comprising providing a nanotube and an acrylic polymer and using a vibration mill to form a composite material.
Item GG2752. A method for preparing a composite material, said method comprising providing a nanotube and acrylonitrile-butadiene-styrene (ABS) and using a vibration mill to form a composite material.
Item GG2753. A method for preparing a composite material, said method comprising providing a nanotube and an aldehyde condensation polymer and using a vibration mill to form a composite material.
Item GG2754. A method for preparing a composite material, said method comprising providing a nanotube and an aliphatic polyether and using a vibration mill to form a composite material.
Item GG2755. A method for preparing a composite material, said method comprising providing a nanotube and an alkyds and oil-free coating polyester and using a vibration mill to form a composite material.
Item GG2756. A method for preparing a composite material, said method comprising providing a nanotube and an aramid and using a vibration mill to form a composite material.
Item GG2757. A method for preparing a composite material, said method comprising providing a nanotube and butyl rubber and using a vibration mill to form a composite material.
Item GG2758. A method for preparing a composite material, said method comprising providing a nanotube and cellulose acetate and using a vibration mill to form a composite material.
Item GG2759. A method for preparing a composite material, said method comprising providing a nanotube and cellulose nitrate and using a vibration mill to form a composite material.
Item GG2760. A method for preparing a composite material, said method comprising providing a nanotube and a cellulosic and using a vibration mill to form a composite material.
Item GG2761. A method for preparing a composite material, said method comprising providing a nanotube and a cyanoacrylate polymer and using a vibration mill to form a composite material.
Item GG2762. A method for preparing a composite material, said method comprising providing a nanotube and a diene polymer and using a vibration mill to form a composite material.
Item GG2763. A method for preparing a composite material, said method comprising providing a nanotube and an epoxy and using a vibration mill to form a composite material.
Item GG2764. A method for preparing a composite material, said method comprising providing a nanotube and an ethylene-propylene copolymer and using a vibration mill to form a composite material.
Item GG2765. A method for preparing a composite material, said method comprising providing a nanotube and a fluoroelastomer and using a vibration mill to form a composite material.
Item GG2766. A method for preparing a composite material, said method comprising providing a nanotube and a heterochain polymer and using a vibration mill to form a composite material.
Item GG2767. A method for preparing a composite material, said method comprising providing a nanotube and a melamine-formaldehyde polymer and using a vibration mill to form a composite material.
Item GG2768. A method for preparing a composite material, said method comprising providing a nanotube and a meta-aramid polymer and using a vibration mill to form a composite material.
Item GG2769. A method for preparing a composite material, said method comprising providing a nanotube and nitrile rubber and using a vibration mill to form a composite material.
Item GG2770. A method for preparing a composite material, said method comprising providing a nanotube and nylon and using a vibration mill to form a composite material.
Item GG2771. A method for preparing a composite material, said method comprising providing a nanotube and a para-aramid and using a vibration mill to form a composite material.
Item GG2772. A method for preparing a composite material, said method comprising providing a nanotube and poly 2-hydroxyethyl methacrylate (HEMA) and using a vibration mill to form a composite material.
Item GG2773. A method for preparing a composite material, said method comprising providing a nanotube and poly bisphenol A carbonate (PC) and using a vibration mill to form a composite material.
Item GG2774. A method for preparing a composite material, said method comprising providing a nanotube and poly butylene terephthalate (PBT) and using a vibration mill to form a composite material.
Item GG2775. A method for preparing a composite material, said method comprising providing a nanotube and poly dimethylsiloxane (PDMS) and using a vibration mill to form a composite material.
Item GG2776. A method for preparing a composite material, said method comprising providing a nanotube and poly dodecano-12-lactam (Nylon 12) and using a vibration mill to form a composite material.
Item GG2777. A method for preparing a composite material, said method comprising providing a nanotube and poly ether ketone ketone (PEKK) and using a vibration mill to form a composite material.
Item GG2778. A method for preparing a composite material, said method comprising providing a nanotube and poly ethylene terephthalate (PET) and using a vibration mill to form a composite material.
Item GG2779. A method for preparing a composite material, said method comprising providing a nanotube and poly methyl acrylate (PMA) and using a vibration mill to form a composite material.
Item GG2780. A method for preparing a composite material, said method comprising providing a nanotube and poly methyl methacrylate (PMMA) and using a vibration mill to form a composite material.
Item GG2781. A method for preparing a composite material, said method comprising providing a nanotube and poly vinyl acetate (PVA) and using a vibration mill to form a composite material.
Item GG2782. A method for preparing a composite material, said method comprising providing a nanotube and poly vinyl chloride (PVC) and using a vibration mill to form a composite material.
Item GG2783. A method for preparing a composite material, said method comprising providing a nanotube and poly vinylidene chloride (PVDC) and using a vibration mill to form a composite material.
Item GG2784. A method for preparing a composite material, said method comprising providing a nanotube and poly vinylidene fluoride (PVDF) and using a vibration mill to form a composite material.
Item GG2785. A method for preparing a composite material, said method comprising providing a nanotube and poly(acrylic acid) and using a vibration mill to form a composite material.
Item GG2786. A method for preparing a composite material, said method comprising providing a nanotube and poly(Bisphenol A isophthalate) and using a vibration mill to form a composite material.
Item GG2787. A method for preparing a composite material, said method comprising providing a nanotube and poly(Bisphenol A terephthalate) and using a vibration mill to form a composite material.
Item GG2788. A method for preparing a composite material, said method comprising providing a nanotube and poly(butyl acrylate) and using a vibration mill to form a composite material.
Item GG2789. A method for preparing a composite material, said method comprising providing a nanotube and poly(butyl methacrylate) and using a vibration mill to form a composite material.
Item GG2790. A method for preparing a composite material, said method comprising providing a nanotube and poly(butylene) and using a vibration mill to form a composite material.
Item GG2791. A method for preparing a composite material, said method comprising providing a nanotube and poly(caprolactone) and using a vibration mill to form a composite material.
Item GG2792. A method for preparing a composite material, said method comprising providing a nanotube and poly(chlorotrifluoroethylene) and using a vibration mill to form a composite material.
Item GG2793. A method for preparing a composite material, said method comprising providing a nanotube and poly(cyclohexyl methacrylate) and using a vibration mill to form a composite material.
Item GG2794. A method for preparing a composite material, said method comprising providing a nanotube and poly(ethyl acrylate) and using a vibration mill to form a composite material.
Item GG2795. A method for preparing a composite material, said method comprising providing a nanotube and poly(ethylene glycol) and using a vibration mill to form a composite material.
Item GG2796. A method for preparing a composite material, said method comprising providing a nanotube and poly(ethylene naphthalate) and using a vibration mill to form a composite material.
Item GG2797. A method for preparing a composite material, said method comprising providing a nanotube and poly(isobutylene) and using a vibration mill to form a composite material.
Item GG2798. A method for preparing a composite material, said method comprising providing a nanotube and poly(phenylsulfone) and using a vibration mill to form a composite material.
Item GG2799. A method for preparing a composite material, said method comprising providing a nanotube and poly(propylene glycol) and using a vibration mill to form a composite material.
Item GG2800. A method for preparing a composite material, said method comprising providing a nanotube and poly(tetrahydrofuran) and using a vibration mill to form a composite material.
Item GG2801. A method for preparing a composite material, said method comprising providing a nanotube and poly(α-methylstyrene) and using a vibration mill to form a composite material.
Item GG2802. A method for preparing a composite material, said method comprising providing a nanotube and polyacetal and using a vibration mill to form a composite material.
Item GG2803. A method for preparing a composite material, said method comprising providing a nanotube and polyacetal (POM) and using a vibration mill to form a composite material.
Item GG2804. A method for preparing a composite material, said method comprising providing a nanotube and polyacrylate elastomers and using a vibration mill to form a composite material.
Item GG2805. A method for preparing a composite material, said method comprising providing a nanotube and polyacrylonitrile (PAN) and using a vibration mill to form a composite material.
Item GG2806. A method for preparing a composite material, said method comprising providing a nanotube and polyamide and using a vibration mill to form a composite material.
Item GG2807. A method for preparing a composite material, said method comprising providing a nanotube and polybutadiene (PBD) and using a vibration mill to form a composite material.
Item GG2808. A method for preparing a composite material, said method comprising providing a nanotube and polybutadiene (butadiene rubber, BR) and using a vibration mill to form a composite material.
Item GG2809. A method for preparing a composite material, said method comprising providing a nanotube and polybutylene terephthalate (PBT) and using a vibration mill to form a composite material.
Item GG2810. A method for preparing a composite material, said method comprising providing a nanotube and polycaprolactam and using a vibration mill to form a composite material.
Item GG2811. A method for preparing a composite material, said method comprising providing a nanotube and polycarbonate (PC) and using a vibration mill to form a composite material.
Item GG2812. A method for preparing a composite material, said method comprising providing a nanotube and polychloroprene and using a vibration mill to form a composite material.
Item GG2813. A method for preparing a composite material, said method comprising providing a nanotube and polychlorotrifluoroethylene (PCTFE) and using a vibration mill to form a composite material.
Item GG2814. A method for preparing a composite material, said method comprising providing a nanotube and polyesters and using a vibration mill to form a composite material.
Item GG2815. A method for preparing a composite material, said method comprising providing a nanotube and polyether ether ketone (PEEK) and using a vibration mill to form a composite material.
Item GG2816. A method for preparing a composite material, said method comprising providing a nanotube and polyetherketone (PEK) and using a vibration mill to form a composite material.
Item GG2817. A method for preparing a composite material, said method comprising providing a nanotube and polyethers and using a vibration mill to form a composite material.
Item GG2818. A method for preparing a composite material, said method comprising providing a nanotube and polyethersulfone (PES) and using a vibration mill to form a composite material.
Item GG2819. A method for preparing a composite material, said method comprising providing a nanotube and polyethyl acrylate and using a vibration mill to form a composite material.
Item GG2820. A method for preparing a composite material, said method comprising providing a nanotube and polyethylene—cross-linked and using a vibration mill to form a composite material.
Item GG2821. A method for preparing a composite material, said method comprising providing a nanotube and polyethylene—high density (HDPE) and using a vibration mill to form a composite material.
Item GG2822. A method for preparing a composite material, said method comprising providing a nanotube and polyethylene—linear low density (LLDPE) and using a vibration mill to form a composite material.
Item GG2823. A method for preparing a composite material, said method comprising providing a nanotube and polyethylene—low density (LDPE) and using a vibration mill to form a composite material.
Item GG2824. A method for preparing a composite material, said method comprising providing a nanotube and polyethylene—medium density (MDPE) and using a vibration mill to form a composite material.
Item GG2825. A method for preparing a composite material, said method comprising providing a nanotube and polyethylene—ultrahigh molecular weight (UHMWPE) and using a vibration mill to form a composite material.
Item GG2826. A method for preparing a composite material, said method comprising providing a nanotube and polyethylene—very low density (VLDPE) and using a vibration mill to form a composite material.
Item GG2827. A method for preparing a composite material, said method comprising providing a nanotube and polyethylene terephthalate (PET) and using a vibration mill to form a composite material.
Item GG2828. A method for preparing a composite material, said method comprising providing a nanotube and polyethylene (PE) and using a vibration mill to form a composite material.
Item GG2829. A method for preparing a composite material, said method comprising providing a nanotube and polyglycolide and using a vibration mill to form a composite material.
Item GG2830. A method for preparing a composite material, said method comprising providing a nanotube and polyhexamethylene adipamide (PA 6,6) and using a vibration mill to form a composite material.
Item GG2831. A method for preparing a composite material, said method comprising providing a nanotube and polyimides and using a vibration mill to form a composite material.
Item GG2832. A method for preparing a composite material, said method comprising providing a nanotube and polyisoprene (natural rubber, NR; isoprene rubber, IR) and using a vibration mill to form a composite material.
Item GG2833. A method for preparing a composite material, said method comprising providing a nanotube and polylactic acid (PLA) and using a vibration mill to form a composite material.
Item GG2834. A method for preparing a composite material, said method comprising providing a nanotube and polymethyl acrylate and using a vibration mill to form a composite material.
Item GG2835. A method for preparing a composite material, said method comprising providing a nanotube and polymethyl methacrylate (PMMA) and using a vibration mill to form a composite material.
Item GG2836. A method for preparing a composite material, said method comprising providing a nanotube and polyphenylene oxide (PPO) and using a vibration mill to form a composite material.
Item GG2837. A method for preparing a composite material, said method comprising providing a nanotube and polyphenylene sulfide (PPS) and using a vibration mill to form a composite material.
Item GG2838. A method for preparing a composite material, said method comprising providing a nanotube and poly-p-phenylene-2,6-benzobisoxazole (PBO) and using a vibration mill to form a composite material.
Item GG2839. A method for preparing a composite material, said method comprising providing a nanotube and polypropylene (PP) and using a vibration mill to form a composite material.
Item GG2840. A method for preparing a composite material, said method comprising providing a nanotube and polysiloxanes (silicones) and using a vibration mill to form a composite material.
Item GG2841. A method for preparing a composite material, said method comprising providing a nanotube and polystyrene (PS) and using a vibration mill to form a composite material.
Item GG2842. A method for preparing a composite material, said method comprising providing a nanotube and polysulfide rubber and using a vibration mill to form a composite material.
Item GG2843. A method for preparing a composite material, said method comprising providing a nanotube and polysulfides and using a vibration mill to form a composite material.
Item GG2844. A method for preparing a composite material, said method comprising providing a nanotube and polytetrafluoroethylene (PTFE) and using a vibration mill to form a composite material.
Item GG2845. A method for preparing a composite material, said method comprising providing a nanotube and polytrimethylene terephthalate (PTT) and using a vibration mill to form a composite material.
Item GG2846. A method for preparing a composite material, said method comprising providing a nanotube and polyurethane and using a vibration mill to form a composite material.
Item GG2847. A method for preparing a composite material, said method comprising providing a nanotube and polyvinyl acetate (PVAc) and using a vibration mill to form a composite material.
Item GG2848. A method for preparing a composite material, said method comprising providing a nanotube and polyvinyl chloride (PVC) and using a vibration mill to form a composite material.
Item GG2849. A method for preparing a composite material, said method comprising providing a nanotube and polyvinyl fluoride (PVF) and using a vibration mill to form a composite material.
Item GG2850. A method for preparing a composite material, said method comprising providing a nanotube and polyvinylidene chloride (PVDC) and using a vibration mill to form a composite material.
Item GG2851. A method for preparing a composite material, said method comprising providing a nanotube and polyvinylidene fluoride (PVDF) and using a vibration mill to form a composite material.
Item GG2852. A method for preparing a composite material, said method comprising providing a nanotube and rayon and using a vibration mill to form a composite material.
Item GG2853. A method for preparing a composite material, said method comprising providing a nanotube and styrene-acrylonitrile (SAN) and using a vibration mill to form a composite material.
Item GG2854. A method for preparing a composite material, said method comprising providing a nanotube and styrene-butadiene and using a vibration mill to form a composite material.
Item GG2855. A method for preparing a composite material, said method comprising providing a nanotube and styrene-isoprene and using a vibration mill to form a composite material.
Item GG2856. A method for preparing a composite material, said method comprising providing a nanotube and a styrene-maleic anhydride copolymer and using a vibration mill to
Item GG2857. A method for preparing a composite material, said method comprising providing a nanotube and a thermoplastic polyurethanes (TPU) and using a vibration mill to form a composite material.
Item GG2858. A method for preparing a composite material, said method comprising providing a nanotube and an unsaturated polyester and using a vibration mill to form a composite material.
Item GG2859. A method for preparing a composite material, said method comprising providing a nanotube and a urea-formaldehyde polymer and using a vibration mill to form a composite material.
Item GG2860. A method for preparing a composite material, said method comprising providing a nanotube and a vinyl copolymer and using a vibration mill to form a composite material.

### Definitions

MINT is short for Molecular Interlocked NanoTubes. It is used interchangeably with “coated nanotubes” or “ML-nanotube complexes”. MINTs are nanotubes complexed with one or more covalently closed ring(s).

Tuballs are SWNTs purchased from OCSiAl.

Dog bone is a small piece of material in the form of a dog bone and convenient for tensile strength and Young Modulus measurements in the INSTRON instrument.

U-shape is used interchangeably with Ushape, and is a precursor-ML, capable of forming a ML around a nanotube upon fusion of two reactive groups carried by the U-shape, to form a covalently closed ring around the Nanotube.

### EXAMPLES

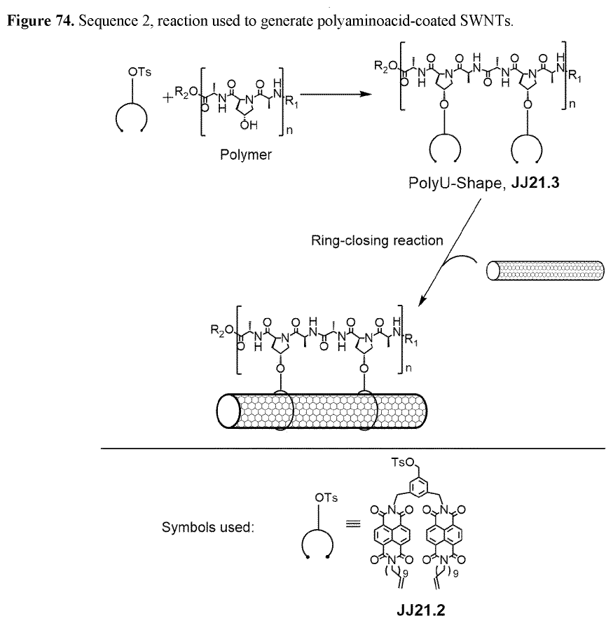

Example 0. Different sequences of events leading to composite material. As depicted in FIGS. 71-77, there are several principally different sequences of events leading to the formation of a nanotube-polymer composite material, comprising polymer-coated nanotubes: Sequence 1 (ring closing, then attach polymer): The nanotube and the precursor-ML (also termed the Ushape) is first mixed, and the Ushape is closed around the nanotube to form a ring around it. Then the polymer is added and attached to the rings. The final result is a nanotube with rings around it, where the rings are attached to polymer. This is the nanotube-polymer composite material, comprising polymer-coated nanotubes.

Sequence 2 (poly-Ushape formation, then ring-closing): The Ushapes are attached to a preformed polymer, to make poly-Ushape. Then nanotubes are added to the polyUshape, and the Ushapes are closed around the nanotube to form rings. This is the nanotube-polymer composite material, comprising polymer-coated nanotubes.

Sequence 3 (monomer-Ushape formation, then ring-closing and polymerization): The Ushape and the monomeric unit are first attached to each other, to form a Ushape-monomer molecule. Nanotubes are added and the Ushapes bind to the nanotube. The final polymerization of the monomer units into polymer and the closing of the Ushapes to form rings around the nanotubes, can be performed in different ways, i.e. (A) first the Ushapes are closed around the nanotube to form rings, and then the monomer units polymerize while immobilized on the nanotube, or (B) first the monomer units polymerize while immobilized on the nanotube, and then the Ushapes are closed around the nanotube to form rings, or (C) polymerization of the monomer units and ring-closing of the Ushapes happens simultaneously.

Sequence 4 (ring closing, then attach reacting polymer): Similar to Sequence 1, the nanotube and the precursor-ML is first mixed, and the Ushape is closed around the nanotube to form a ring around it. The ring carries a polymerization termination functionality.

The growing polymer is added and it attaches to the rings through the polymerization termination functionalities. The final result is a nanotube with rings around it, where the rings are each attached to different polymer chains. This is the nanotube-polymer composite material, comprising polymer-coated nanotubes.

### Example AA1. Synthesis of Pyrene U-Shape

Compound AA1 termed “Pyrene U-Shape of the Example AA1” was synthesized by following the procedure described for “Pyrene U-Shape of the Example DD6”.

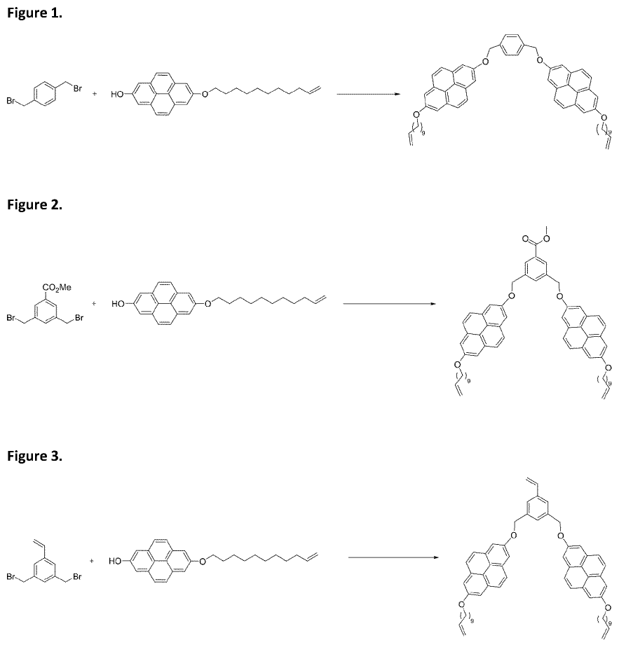

Synthetic scheme showed in FIG. 1.

### Example AA2. Synthesis of Alkene U-Shape

Compound AA2 termed “Alkene U-Shape of the Example AA2” was synthesized by following the procedure described for “Alkene U-Shape of the Example EE1”.

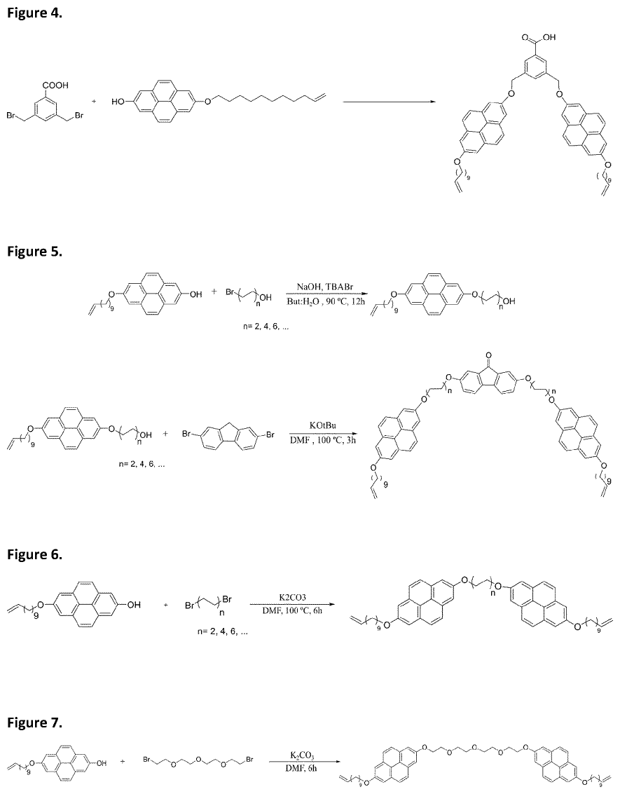

Synthetic scheme showed in FIG. 2.

### Example AA3. Synthesis of Ester U-Shape

Compound AA3 termed “Ester U-Shape of the Example AA3” was synthesized by following the procedure described for “Ester U-Shape of the Example EE2”.

Synthetic scheme showed in FIG. 3.

### Example AA4. Synthesis of Acid U-Shape

Compound AA4 termed “Acid U-Shape of the Example AA4” was synthesized by following the procedure described for “Acid U-Shape of the Example EE3”.

Synthetic scheme showed in FIG. 4.

### Example AA5. Synthesis of Fluorenone U-Shape

The procedure consists of a first synthesis of the pyrene leg and a second step, where the U-Shape is prepared by reaction between leg and commercial spacer.
Step 1: To a round bottom flask containing 7-(undec-10-en-1-yloxy)pyren-2-ol (2.59 mmol, 1 eq), sodium hydroxide (5.18 mmol, 2 eq) and tetrabutylammonium bromide (0.259 mmol, 0.1 eq) 200 mL of methyl ethyl ketone:H₂O (1:1) was added.
Step 2: The mixture was heated and stirred at 50° C. for 20 minutes.
Step 3: Then, 6-bromohexan-1-ol (12.95 mmol, 5 eq) was added.
Step 4: Reaction takes place at 90° C. and overnight.
Step 5: Methyl ethyl ketone was evaporated and precipitate was washed several times with hexane.

Compound AA5 was named as “pyr-60H of Example AA5”.
Step 6: “Pyr-60H of Example AA5”. (0.82 mmol, 2.2 eq) and potassium tert-butoxide (0.82 mmol, 2.2 eq) were dissolved in 20 mL of DMF while heating.
Step 7: 2,7-dibromo-9H-fluorene (0.37 mmol, 1 eq) was added, and mixture was stirred at 100° C.
Step 8: After 3 h, reaction was stopped and cooled down to room temperature.
Step 9: Crude was precipitated in cold methanol, obtaining a yellow solid (87% of yield).
Final product (compound AA6) was termed “Fluorenone U-Shape of the Example AA5”.
   As a variation of the procedure, in step 3 different lengths of the alkylation moieties for the synthesis of the pyrene leg could be used, for example, 2-bromoethan-1-ol instead of 6-bromohexan-1-ol.

Synthetic scheme showed in FIG. 5.

### Example AA6. Synthesis of Chain U-Shape

Step 1: In a round bottom flask set-up under anhydrous conditions, 7-(undec-10-en-1-yloxy)pyren-2-ol (5.18 mmol, 2.2 eq) and dried potassium carbonate, (20.71 mmol, 8.8 eq) were dissolved in 20 mL of anhydrous DMF and heated at 100° C. while stirring.
Step 2: After 30 minutes, 1, 6-dibromohexane was added slowly, (2.35 mmol, 1 eq).
Step 3: Reaction was cooled down to room temperature after 6 hours.
Step 4: Solution was poured into cold 1M HCl and a brown precipitate was obtained.
Step 5: Precipitated was filtered and washed with methanol several times (64% yield).

Final product (compound AA7) was termed “Chain U-Shape of Example AA6”.
As a variation of the procedure, in step 2 different lengths of the alkylation moieties for the synthesis of the pyrene leg could be used, for example, 1, 2-dibromoethane instead of 1, 6-dibromohexane.

Synthetic scheme showed in FIG. 6.

### Example AA7. Synthesis of Glycol U-Shape

Step 1: In a round bottom flask set-up under anhydrous conditions, 7-(undec-10-en-1-yloxy)pyren-2-ol (5.18 mmol, 2.2 eq) and dried potassium carbonate, (20.71 mmol, 8.8 eq) were dissolved in 20 mL of anhydrous DMF and heated at 100° C. while stirring.
Step 2: After 30 minutes, was added dropwise, (2.35 mmol, 1 eq).
Step 3: Reaction was cooled down to room temperature after 6 hours.
Step 4: Solution was poured into cold 1M HCl.
Step 5: Precipitated was filtered and washed with methanol several times (63% yield).

Final product (compound AA8) was termed “Glycol U-Shape of the Example AA7”.

Synthetic scheme showed in FIG. 7.

### Example AA8. Synthesis of Fully Glycol U-Shape

The procedure consists of a first step of modification of the alkylated moiety, (step 1), which is used in the second step for the synthesis of polyethoxy pyrene leg, (step 2), and a third step, where the U-Shape was prepared by reaction between polyethoxy pyrene leg and commercial spacer, (step 3 to 9).
Step 1: “3-(2-(2-(2-chloroethoxy) ethoxy) ethoxy) prop-1-ene of Example DD3” was obtained following the procedure described in Example DD3, (compound AA9).
Step 2: “Polyethoxy monoalkylated of Example DD4” was obtained following the procedure described in Example DD4, (compound AA10).
Step 3: “Polyethoxy monoalkylated of Example DD4” (0.54 mmol, 2.2 eq) and potassium carbonate (2.16 mmol, 8.8 eq) were dissolved in dried DMF into a round bottom flask.
Step 4: The mixture was stirred at 100° C. for 2 h.
Step 5: Then, 1-Bromo-2-(2-(2-(2-bromoethoxy) ethoxy) ethoxy) ethane (0.25 mmol, 1 eq) and a catalytic amount of KI were also added to the round bottom flask.
Step 6: Reaction takes place for 3 h and 30 minutes.
Step 7: Reaction was cold down to room temperature and poured into 1M HCl (cold).
Step 8: Aqueous solutions was extracted with CHCl3, and solvent was evaporated.
Step 9: Product was columned in Hexane:Ethyl acetate 1:3.

Final product, (compound AA11) was termed “Fully glycol U-Shape of the Example AA8”.

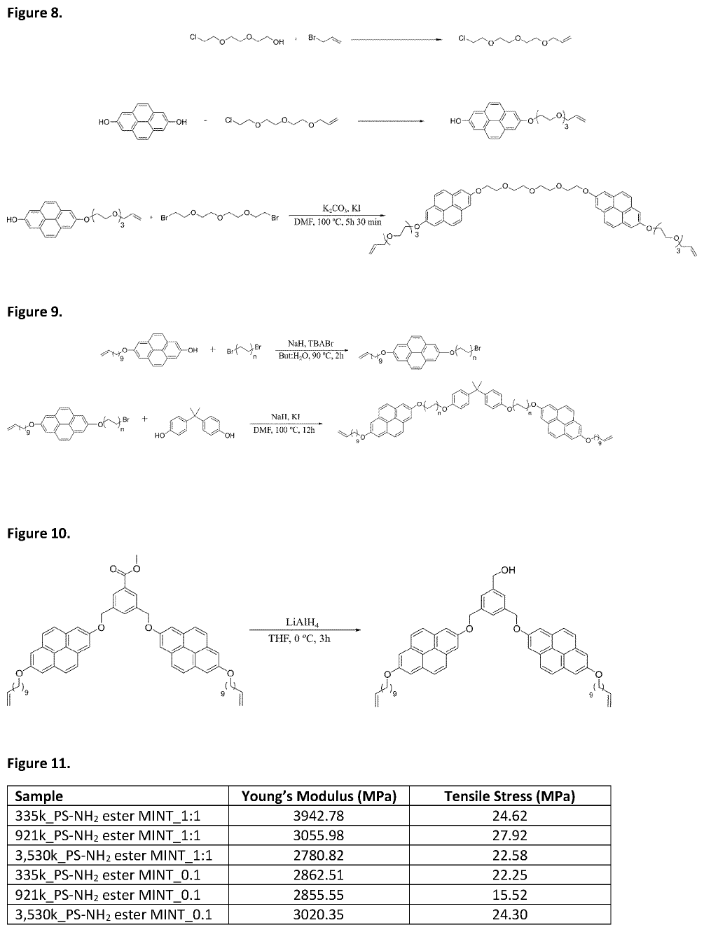

Synthetic scheme showed in FIG. 8.

### Example AA9. Synthesis of DER U-Shape

The procedure consists of a first synthesis of pyrene leg and a second step, where U-Shape was prepared by reaction between pyrene leg and commercial spacer.
Step 1: To a round bottom flask containing 7-(undec-10-en-1-yloxy)pyren-2-ol (2.59 mmol, 1 eq), sodium hydroxide (5.18 mmol, 2 eq) and tetrabutylammonium bromide (0.259 mmol, 0.1 eq) 200 mL of methyl ethyl ketone:H₂O (1:1) was added.
Step 2: The mixture is heated and stirring at 50° C. for 20 minutes.
Step 3: Solution is warm-up to 90° C. and then, 1, 6-dibromohexane (25.9 mmol, 5 eq) was added dropwise.
Step 4: Reaction takes place at 90° C. for 2 hours.
Step 5: Methyl ethyl ketone was evaporated and a brown precipitate appeared.
Step 6: Precipitated was filtrated and washed several times with hexane.

Compound AA12 was termed “pyr-6Br of Example AA9”.
Step 7: Anhydrous conditions were fixed in a round bottom flask.
Step 8: Sodium hydride (1.94 mmol, 2.2 eq) was dissolved in anhydrous DMF while heating at 100° C. for 2 hours.
Step 9. 4, 4′-(propane-2, 2-diyl) diphenol (0.88 mmol, 1 eq) was added to the solution, and mixture was stirred for 2 h while heating at 100° C.
Step 10: “Pyr-6Br of Example AA9” (2.19 mmol, 2.5 eq) and a catalytic amount of potassium 50 iodide were added, and mixture was stirred at 100° C., overnight.
Step 11: Reaction was stopped and cooled down to room temperature.
Step 12: Crude was poured into 1M cold HCl and precipitate was filtered and columned: Hexane >Hex:AcOEt (8:2)>AcOEt.

Final product, (compound AA13) was termed “DER U-Shape of Example AA9”.
As a variation of the procedure, in step 3 different lengths of the alkylation moieties for the synthesis of the pyrene leg could be used, for example, 1, 2-dibromoethane instead of 1, 6-dibromohexane.

Synthetic scheme showed in FIG. 9.

### Example AA10. Synthesis of the Methyl Alcohol U-Shape

Step 1: In a round bottom flask “Ester U-Shape of Example AA3” (5.54 mmol, 1 eq) was dissolved in THF, at 0° C.
Step 2: Lithium aluminium hydride (11.09 mmol, 2 eq) was added dropwise.
Step 3: Reaction was stopped after 3 h at room temperature.
Step 4: H₂O was added and a brown precipitate appears.
Step 5: Precipitate was filtered and washed with water three times, and two times with hexane.

Final product, (compound AA14), was termed “Methyl alcohol U-Shape of Example AA10”.

Synthetic scheme showed in FIG. 10.
[2] In these examples, the preparation of several MINTs was described through ring closing metathesis using 2^{nd} generation Grubbs catalyst.

### Example AA11. Preparation of MINTs

### Example AA11a. Wet Method

Step 1: In a round bottom flask containing 750 mL of TCE, SWNTs (0.75 g, Tuball from OCSiAl) were added.
Step 2: The SWNTs were dispersed by bath sonication for 10 min
Step 3: “Pyrene U-Shape of Example AA1” (0.75 mmol, 1 eq) was added.
Step 4: The suspension was bubbled with nitrogen for 15 minutes
Step 5: 2^{nd} generation Grubbs catalyst (0.75 mmol, 1 eq, purchased from BLD) was added and the suspension was stirred for 72 h at room temperature.
Step 6: After this time, the reaction mixture was filtered through a 47 mm diameter PTFE membrane of 0.2 μm pore size.
Step 7: The filter cake was collected and was re-dispersed in 200 mL dichloromethane in a round-bottom flask by bath sonication for 3 min.
Step 8: The sample was filtered again through a 47 mm diameter PTFE membrane of 0.2 μm pore size.
Step 9: Steps 7 and 8 were repeated two times
Step 10: Approximately 50 mL Et₂O was added to the filter cake.
Step 11: The coated tubes were collected in a vial under vacuum and dried overnight at room temperature. The final product (Compound AA15) was termed “Pyrene MINT of Example AA11a”.

The product “Pyrene MINT of Example AA11b” was analyzed by TGA. The degree of functionalization (the ratio organic material/SWNT) was determined to be 24%.

### Example AA11b. Mechanochemical Method

The method made use of the mechanical energy generated in a ball mill to disperse the SWNTs, and/or bind the U-Shape molecule to SWNTs, and/or mediate the ring-closing metathesis.
Step 1: In a 80 mL-size stainless steel ball mill reactor, SWNTs (Tuball from OCSiAl, 2.5 g), Pyrene U-shape of Example AA1 (0.72 mmol, 1 eq) and 2^{nd} gen. Grubbs catalyst (0.07 mmol, 0.1 eq, purchased from BLD) were added.
Step 2: The reactor was charged with five 15 mm diameter stainless steel balls.
Step 3: The powders were milled for 10 min at 500 rpm in an air atmosphere.
Step 4: After this time, the reactor content was recovered. Dichloromethane (50 mL) was added and the reaction mixture was filtered through a 47 mm diameter PTFE membrane of 0.2 μm pore size.
Step 5: The filter cake was collected and was re-dispersed in 100 mL dichloromethane in a round-bottom flask by bath sonication for 15 seconds.
Step 6: The sample was filtered again through a 47 mm diameter PTFE membrane of 0.2 μm pore size.
Step 7: Steps 5 and 6 were repeated three times.
Step 8: Approximately 50 mL Et₂O was added to the filter cake.
Step 9: The coated tubes were collected in a vial and dried under vacuum overnight at room temperature. The product (compound AA16) was termed “Pyrene MINT of Example AA11b”.

The above mentioned protocol was used for compounds AA1 to AA4, AA6 to AA8, AA11, AA13 and AA14, to produce the products listed immediately below. The produced products were termed:

The product “Alkene MINT of Example AA11b”, (also termed compound AA17) was prepared using the protocol “Example AA11b. Mechanochemical method”, and in step 1 using “Alkene U-Shape of the Example AA2” (also termed compound AA2) instead of “Pyrene U-Shape of Example AA1” (also termed compound AA1). The product “Alkene MINT of Example AA11b” was analyzed by TGA. The degree of functionalization (the ratio organic material/SWNT) was determined to be 22%. “Alkene MINT of Example AA11b” (also termed compound AA17) was used in Example AA17 for the preparation of dog bones.

The product “Ester MINT of Example AA11b”, (also termed compound AA18) was prepared using the protocol “Example AA11b. Mechanochemical method”, and in step 1 using “Ester U-Shape of the Example AA3” (also termed compound AA3) instead of “Pyrene U-Shape of Example AA1” (also termed compound AA1). The product “Ester MINT of Example AA11b” was analyzed by TGA. The degree of functionalization (the ratio organic material/SWNT) was determined to be 25%.

The product “Acid MINT of Example AA11b”, (also termed compound AA19) was prepared using the protocol “Example AA11b. Mechanochemical method”, and in step 1 using “Acid U-Shape of the Example AA4” (also termed compound AA4) instead of “Pyrene U-Shape of Example AA1” (also termed compound AA1). The product “Acid MINT of Example AA11b” was analyzed by TGA. The degree of functionalization (the ratio organic material/SWNT) was determined to be 23%.

The product “Fluorenone MINT of Example AA11b”, (also termed compound AA20) was prepared using the protocol “Example AA11b. Mechanochemical method”, and in step 1 using “Fluorenone U-Shape of the Example AA5” (also termed compound AA6) instead of “Pyrene U-Shape of Example AA1” (also termed compound AA1). The product “Fluorenone MINT of Example AA11b” was analyzed by TGA. The degree of functionalization (the ratio organic material/SWNT) was determined to be 21%.

The product “Chain MINT of Example AA11b”, (also termed compound AA21) was prepared using the protocol “Example AA11b. Mechanochemical method”, and in step 1 using “Chain U-Shape of the Example AA6” (also termed compound AA7) instead of “Pyrene U-Shape of Example AA1” (also termed compound AA1). The product “Chain MINT of Example AA11b” was analyzed by TGA. The degree of functionalization (the ratio organic material/SWNT) was determined to be 22%. “Chain MINT of Example AA11b” (also termed compound AA21) was used in Example AA17 for the preparation of dog bones.

The product “Glycol MINT of Example AA11b”, (also termed compound AA22) was prepared using the protocol “Example AA11b. Mechanochemical method”, and in step 1 using “Glycol U-Shape of the Example AA7” (also termed compound AA8) instead of “Pyrene U-Shape of Example AA1” (also termed compound AA1). The product “Glycol MINT of Example AA11b” was analyzed by TGA. The degree of functionalization (the ratio organic material/SWNT) was determined to be 19%. “Glycol MINT of Example AA11b” (also termed compound AA22) was used in Example AA17 for the preparation of dog bones.

The product “Fully glycol MINT of Example AA11b”, (also termed compound AA23) was prepared using the protocol “Example AA11b. Mechanochemical method”, and in step 1 using “Fully glycol U-Shape of the Example AA8” (also termed compound AA11) instead of “Pyrene U-Shape of Example AA1” (also termed compound AA1). The product “Fully glycol MINT of Example AA11b” was analyzed by TGA. The degree of functionalization (the ratio organic material/SWNT) was determined to be 17%.

The product “DER MINT of Example AA11b”, (also termed compound AA24) was prepared using the protocol “Example AA11b. Mechanochemical method”, and in step 1 using “DER U-Shape of the Example AA9” (also termed compound AA13) instead of “Pyrene U-Shape of Example AA1” (also termed compound AA1). The product “DER MINT of Example AA11b” was analyzed by TGA. The degree of functionalization (the ratio organic material/SWNT) was determined to be 18%.

The product “Methyl alcohol MINT of Example AA11b”, (also termed compound AA25) was prepared using the protocol “Example AA11b. Mechanochemical method”, and in step 1 using “Methyl alcohol U-Shape of the Example AA10” (also termed compound AA14) instead of “Pyrene U-Shape of Example AA1” (also termed compound AA1). The product “Methyl alcohol MINT of Example AA11b” was analyzed by TGA. The degree of functionalization (the ratio organic material/SWNT) was determined to be 22%.

### Example AA11c. Hand-Made Mortar Method

This procedure was a variation of the protocol “Example AA11b. Mechanochemical method”, using an only step of 30 minutes of hand-made mortar instead of steps 1 to 4 of the “Example AA11b. Mechanochemical method” as it is described below.
Step 1: In an Agatha mortar, SWNTs (Tuball from OCSiAl, 2.5 g), Pyrene U-shape of Example AA1 (0.72 mmol, 1 eq) and 2^{nd} gen. Grubbs catalyst (0.07 mmol, 0.1 eq, purchased from BLD) were added.
Step 2: 30 minutes hand-made mortar reaction was made.
Step 3: After this time, the mortar content was recovered. Dichloromethane (50 mL) was added and the reaction mixture was filtered through a 47 mm diameter PTFE membrane of 0.2 μm pore size.
Step 4: The filter cake was collected and was re-dispersed in 100 mL dichloromethane in a round-bottom flask by bath sonication for 15 seconds.
Step 5: The sample was filtered again through a 47 mm diameter PTFE membrane of 0.2 μm pore size.
Step 6: Steps 5 and 6 were repeated three times.
Step 7: Approximately 50 mL Et₂O was added to the filter cake.
Step 8: The coated tubes were collected in a vial and dried under vacuum overnight at room temperature. The product (compound AA26) was termed “Pyrene MINT of Example AA11c”.

The above mentioned protocol “Example AA11c. Hand-made mortar method” was 50 performed using in step 1 compound “Pyrene U-Shape of the Example AA1” (also termed compound AA1) or “Fluorenone U-Shape of the Example AA5” (also termed compound AA6), to produce the products listed immediately below. The produced products were termed:

The product “Pyrene MINT of Example AA11c”, (also termed compound AA26) was prepared using the protocol “Example AA11c. Hand-made mortar method”, and in step 1 using “Pyrene U-Shape of Example AA1” (also termed compound AA1). The product “Pyrene MINT of Example AA11b” was analyzed by TGA. The degree of functionalization (the ratio organic material/SWNT) was determined to be 22%.

The product “Fluorenone MINT of Example AA11c”, (also termed compound AA27) was prepared using the protocol “Example AA11c. Hand-made mortar method”, and in step 1 using “Fluorenone U-Shape of the Example AA5” (also termed compound AA6) instead of “Pyrene U-Shape of Example AA1” (also termed compound AA1). The product “Fluorenone MINT of Example AA11b” was analyzed by TGA. The degree of functionalization (the ratio organic material/SWNT) was determined to be 19%.
[3] In these examples, the preparation of several composites was described.

### Example AA12. Preparation of PS-NH₂+Ester MINT

In this example, polystyrene molecules carrying an amino group at one end is reacted with SWNT displaying a methyl ester, thereby forming an amide bond that covalently links the PS polymer to the mechanical ligand complexed to the SWNT.

### Example AA12a. 1:1 Equivalent

Step 1: 5k_PS-NH₂ (polystyrene amino terminated, purchased from Aldrich, MW=5,000 g/mol and PCode: 1003322665) was dried in the oven, at 80° C., for 2 h.
Step 2: In a 45 mL-size stainless steel ball mill reactor, 0.8 g of dried 5k PS—NH₂ (1 eq) and 0.5 g of compound “Ester MINT of Example AA11b” (also termed compound AA18) were added.
Step 3. The reactor was charged with five 15 mm diameter stainless steel balls.
Step 4: The powder was milled for 10 min at 500 rpm in an air atmosphere.
Step 5: After this time, the reactor content was recovered and dried at 200° C. during 2 h.
Step 6: The powder was then dissolved in CHCl3 and sonicated for 30 minutes at room temperature, being 0.5 mg/mL.
Step 7: Then, CHCl3 was evaporated. The resulting product was termed “5k PS—NH₂ ester MINT_1:1 of Example AA12a”, (compound AA26).

In a separated process, steps 1 to 7 were carried out again, except 10k_PS-NH2 (polystyrene amino terminated, purchased from Aldrich, MW=10,000 g/mol and PCode: 1003442380) was used instead of 5k_PS-NH2, thereby obtaining the sample termed 10k_PS-NH2 ester MINT (also termed compound AA27).

### Variations on the Above-Mentioned Protocol:

A large collection of PS—NH₂ with different molecular weights (purchased form Polymer Source) were used to compare the properties of the new composites with the samples obtained in Example AA12.

For that purpose, step 1 defined the molecular weight for each experiment. The produced products were listed immediately below. The products were termed:

The product “6,5k_PS-NH₂ ester MINT_1:1 of Example AA12a” (also termed compound AA30) was prepared using the protocol “Example AA12a. 1:1 equivalent” and in step 1 using 6,5k PS—NH2 (polystyrene amino terminated, purchased from Polymer Source, MW=6,500 g/mol and Sample number: P40055-SNH2) instead of 5k PS—NH2. “6,5k_PS-NH₂ ester MINT_1:1 of Example AA12a” was used in Example AA17 for the preparation of dog bones.

The product “335k_PS-NH₂ ester MINT_1:1 of Example AA12a” (also termed compound AA31) was prepared using the protocol “Example AA12a. 1:1 equivalent” and in step 1 using 335k PS—NH2 (polystyrene amino terminated, purchased from Polymer Source, MW=335,000 g/mol and sample number: P3736-SNH2) instead of 5k PS—NH2. “335k_PS-NH₂ ester MINT_1:1 of Example AA12a” was used in Example AA17 for the preparation of dog bones.

The product “921k_PS-NH₂ ester MINT_1:1 of Example AA12a” (also termed compound AA32) was prepared using the protocol “Example AA12a. 1:1 equivalent” and in step 1 using 921k PS—NH2 (polystyrene amino terminated, purchased from Polymer Source, MW=921,000 g/mol and sample number: P11124A-SNH2) instead of 5k PS—NH2. “921k_PS-NH₂ ester MINT_1:1 of Example AA12a” was used in Example AA17 for the preparation of dog bones.

The product “3,530k_PS-NH₂ ester MINT_1:1 of Example AA12a” (also termed compound AA33) was prepared using the protocol “Example AA12a. 1:1 equivalent” and in step 1 using 921k PS—NH2 (polystyrene amino terminated, purchased from Polymer Source, MW=3,530,000 g/mol and sample number: P4029-SNH2) instead of 5k PS—NH2. “3,530k_PS-NH₂ ester MINT_1:1 of Example AA12a” was used in Example AA17 for the preparation of dog bones.

### Example AA12b. 0.1% Tuball Content

Same PS—NH2 collection was used to prepare 0.1% tuball content samples. For that reason, [6×10⁻⁴ g] of “Ester MINT of Example AA11b” were used instead of [0.5 g] of which were used in “Example AA12a. 1:1 equivalent”.

Steps 3-7 of Example AA12a were repeated for each specimen to produce the products listed immediately below. The products produced were termed:

The product “6,5k_PS-NH₂ ester MINT_0.1 of Example AA12b” (also termed compound AA34) was prepared using the protocol “Example AA12b. 0.1% tuball content” and in step 1 using 6,5k PS—NH2 (polystyrene amino terminated, purchased from Polymer Source, MW=6,500 g/mol and Sample number: P40055-SNH2) instead of 5k PS—NH2. “6,5k_PS-NH₂ ester MINT_0.1 of Example AA12b” was used in Example AA17 for the preparation of dog bones.

The product “335k_PS-NH₂ ester MINT_0.1 of Example AA12b” (also termed compound AA35) was prepared using the protocol “Example AA12b. 0.1% tuball content” and in step 1 using 335k PS—NH2 (polystyrene amino terminated, purchased from Polymer Source, 50 MW=335,000 g/mol and sample number: P3736-SNH2) instead of 5k PS—NH2. “335k_PS-NH₂ ester MINT_0.1 of Example AA12b” was used in Example AA17 for the preparation of dog bones.

The product “921k_PS-NH₂ ester MINT_0.1 of Example AA12b” (also termed compound AA36) was prepared using the protocol “Example AA12b. 0.1% tuball content” and in step 1 using 921k PS—NH2 (polystyrene amino terminated, purchased from Polymer Source, MW=921,000 g/mol and sample number: P11124A-SNH2) instead of 5k PS—NH2. “921k_PS-NH₂ ester MINT_0.1 of Example AA12b” was used in Example AA17 for the preparation of dog bones.

The product “3,530k_PS-NH₂ ester MINT_0.1 of Example AA12b” (also termed compound AA37) was prepared using the protocol “Example AA12b. 0.1% tuball content” and in step 1 using 921k PS—NH2 (polystyrene amino terminated, purchased from Polymer Source, MW=3,530,000 g/mol and sample number: P4029-SNH2) instead of 5k PS—NH2. “3,530k_PS-NH₂ ester MINT_0.1 of Example AA12b” was used in Example AA17 for the preparation of dog bones.

### Example AA12c. 0% Tuball Content

In a separate process, steps 1 to 7 were carried out again, except that in step 2 no tuball were used, thereby obtaining the samples listed immediately below. The produced products were termed:

The product “6,5k_PS-NH2_neat of Example AA12c” (also termed compound AA38) was prepared using the protocol “Example AA12c. 0% tuball content” and in step 1 using 6,5k PS—NH2 (polystyrene amino terminated, purchased from Polymer Source, MW=6,500 g/mol and Sample number: P40055-SNH2) instead of 5k PS—NH2. “6,5k_PS-NH2_neat of Example AA12c” was used in Example AA17 for the preparation of dog bones.

The product “335k_PS-NH₂_neat of Example AA12c” (also termed compound AA39) was prepared using the protocol “Example AA12c. 0% tuball content” and in step 1 using 335k PS—NH2 (polystyrene amino terminated, purchased from Polymer Source, MW=335,000 g/mol and sample number: P3736-SNH2) instead of 5k PS—NH2. “335k_PS-NH2_neat of Example AA12c” was used in Example AA17 for the preparation of dog bones.

The product “921k_PS-NH2_neat of Example AA12c” (also termed compound AA40) was prepared using the protocol “Example AA12c. 0% tuball content” and in step 1 using 921k PS—NH2 (polystyrene amino terminated, purchased from Polymer Source, MW=921,000 g/mol and sample number: P11124A-SNH2) instead of 5k PS—NH2. “921k_PS-NH2_neat of Example AA12c” was used in Example AA17 for the preparation of dog bones.

The product “3,530k_PS-NH2_neat of Example AA12c” (also termed compound AA41) was prepared using the protocol “Example AA12c. 0% tuball content” and in step 1 using 921k PS—NH2 (polystyrene amino terminated, purchased from Polymer Source, MW=3,530,000 g/mol and sample number: P4029-SNH2) instead of 5k PS—NH2. “3,530k_PS-NH2_neat of Example AA12c” was used in Example AA17 for the preparation of dog bones.

### Example AA13. PMMA Composites

### AA13a. Neat Polymer

Step 1: In a 100 mL round bottom flask, 10 g of PMMA polymer were dissolved in 40 mL of toluene and stirred vigorously overnight, at room temperature.
Step 2: After stirring, a precipitation process was carried out by pouring the solution into 300 mL of methanol.
Step 3: Finally, Neat-Polymer sample was dried in the oven at 60° C. and overnight.

Final product was termed “PMMA_Neat of Example AA13”, (also termed compound AA42).

### AA13b. PMMA/MINT Composites

SWNTs (Tuball from OCSiAl), “Chain MINTs of Example AA11b” and “Glycol MINTs of Example AA11b” were used for preparing different PMMA composites.
Step 1: In a 100 mL round bottom flask, 13 mg of “Chain MINTs of Example AA11b” were dispersed in 40 mL of toluene, by 5 minutes of sonication.
Step 2: 10 g of PMMA polymer were added and mixture was stirred vigorously overnight, at room temperature.
Step 3: After stirring, a precipitation process was carried out by pouring the solution into 300 mL of methanol.
Step 4: Finally, MINT-Polymer sample was dried in the oven at 60° C. and overnight.

Final product was termed “PMMA_Chain_0.1 of Example AA13b”, (compound AA43).

In a separate process, steps 1 to 4 were carried out again, except that in step 1 137 mg (instead of 13 mg) of “Chain MINTs of Example AA11b”, thereby obtaining the sample termed “PMMA_Chain_1.0 of Example AA13b”, (compound AA44).

In another separate process, steps 1 to 4 were carried out again, except that “Glycol MINTs of Example AA11b” was used instead of “Chain MINTs of Example AA11b”. In that way, compounds AA45 and AA46 were obtained, termed “PMMA_Glycol_0.1 of Example AA13b” and “PMMA_Glycol_1.0 of Example AA13b”, respectively.

Finally, same procedure was followed using SWNTs (Tuball from OCSiAl) instead of “Chain MINTs of Example AA11b”. In that way, compounds AA47 and AA48 were obtained, termed “PMMA_Tuball_0.1 of Example AA13b” and “PMMA_Tuball_1.0 of Example AA13b”, respectively.

### Example AA14. PVC Composites

In this example PVC/CNT composites were generated.

### AA14a. Neat Polymer

Step 1: In a 100 mL round bottom flask, 10 g of PVC polymer were dissolved in 40 mL of tetrahydrofuran and stirred vigorously overnight, at 60° C.
Step 2: After stirring, a precipitation process was carried out by pouring the solution into 300 mL of methanol.
Step 3: Finally, Neat-Polymer sample was dried in the oven at 60° C. and overnight.

Final product was termed “PVC_Neat of Example AA14a”, (compound AA49).

### AA14b. PVC/MINT Composites

SWNTs (Tuball from OCSiAl), “Chain MINTs of Example AA11b” and “Glycol MINTs of Example AA1 b” were used for preparing different PVC composites.
Step 1: In a 100 mL round bottom flask, 13 mg of “Chain MINTs of Example AA11b” were dispersed in 40 mL of tetrahydrofuran, by 5 minutes of sonication.
Step 2: 10 g of PVC polymer were added and mixture was stirred vigorously overnight, at 60° C.
Step 3: After stirring, a precipitation process was carried out by pouring MINT-PVC solution into 300 mL of methanol.
Step 4: Finally, MINT-Polymer was dried in the oven at 60° C. and overnight.

Final product was termed “PVC_Chain_0.1 of Example AA14b”, (compound AA50).

In a separate process, steps 1 to 4 were carried out again, except that in step 1 137 mg (instead of 13 mg) of “Chain MINTs of Example AA11b”, thereby obtaining the sample termed “PVC_Chain_1.0 of Example AA14b”, (compound AA51).

In another separate process, steps 1 to 4 were carried out again, except that “Glycol MINTs of Example AA11b” was used instead of “Chain MINTs of Example AA11b”. In that way, compounds AA52 and AA53 were obtained, termed “PVC_Glycol_0.1 of Example AA14b” and “PVC_Glycol_1.0 of Example AA14b”, respectively.

Finally, same procedure was followed using SWNTs (Tuball from OCSiAl). In that way, compounds AA54 and AA55 were obtained, termed “PVC_Tuball_0.1 of Example AA14b” and “PVC_Tuball_1.0 of Example AA14b”, respectively.

### Example AA15. LDPE Composites

In this example LDPE/CNT composites were generated.

### AA15a. Neat Polymer

Step 1: In a 100 mL round bottom flask, 10 g of LDPE polymer were dissolved in 40 mL of toluene and stirred vigorously overnight, at 110° C.
Step 2: After stirring, a precipitation process was carried out by pouring the solution into 300 mL of methanol. Polymer powder-like was obtained.
Step 3: Polymer was filtered under vacuum.
Step 4: Finally, Neat-Polymer sample was dried in the oven at 60° C. and overnight.

Final product was termed “LDPE_Neat of Example AA15a”, (compound AA56).

### AA15b. LDPE/MINT Composites

SWNTs (Tuball from OCSiAl), “Chain MINTs of Example AA11b” and “Glycol MINTs of Example AA11b” were used for preparing different LDPE composites.
Step 1: In a 100 mL round bottom flask, 13 mg of “Chain MINTs of Example AA11b” were dispersed in 40 mL of toluene, by 5 minutes of sonication.
Step 2: 10 g of LDPE polymer were added and mixture was stirred vigorously overnight at 110° C.
Step 3: After stirring, precipitation process was carried out by pouring the solution into 300 mL of methanol. Polymer powder-like was obtained.
Step 4: Polymer was filtered under vacuum.
Step 5: Finally, MINT-Polymer was dried in the oven at 60° C. and overnight.

Final product was termed “LDPE_Chain_0.1 of Example AA15b), (compound AA57).

In a separate process, steps 1 to 4 were carried out again, except that in step 1 137 mg (instead of 13 mg) of “Chain MINTs of Example AA11b”, thereby obtaining the sample termed “LDPE_Chain_1.0 of Example AA15b”, (compound AA58).

In another separate process, steps 1 to 4 were carried out again, except that “Glycol MINTs of Example AA11b” was used instead of “Chain MINTs of Example AA11b”. In that way, compounds AA59 and AA60 were obtained, termed “LDPE_Glycol_0.1 of Example AA15b” and “LDPE_Glycol_1.0 of Example AA15b”, respectively.

Finally, same procedure was followed using SWNTs (Tuball from OCSiAl). In that way, compounds AA61 and AA62 were obtained, termed “LDPE_Tuball_0.1 of Example AA15b” and “LDPE_Tuball_1.0 of Example AA15b”, respectively.

### Example AA16. Nylon 6 Composites

In this example Nylon 6/MINT composites were generated.

### AA16a. Neat Polymer

Step 1: In a 100 mL round bottom flask, 10 g of PVC polymer were dissolved in 40 mL of toluene and stirred vigorously overnight, at 60° C.
Step 2: After stirring, a precipitation process was carried out by pouring the solution into 300 mL of methanol.
Step 3: Finally, Neat-Polymer was dried in the oven at 60° C. and overnight.

Final product was named as “Nylon 6_Neat of Example AA16a”, (compound AA63).

### AA16b. Nylon 6/MINT Composites

SWNTs (Tuball from OCSiAl), “Chain MINTs of Example AA11b” and “Glycol MINTs of Example AA1 b” were used for preparing different Nylon 6 composites.
Step 1: In a 100 mL round bottom flask, 13 mg of “Chain MINTs of Example AA11b” were dispersed in 40 mL of formic acid, by 5 minutes of sonication.
Step 2: 10 g of Nylon 6 polymer were added and mixture was stirred vigorously overnight at 110° C.
Step 3: After stirring, a precipitation process was carried out by pouring the solution into 300 mL of water.
Step 4: Finally, MINT-Polymer was dried in the oven at 60° C. and overnight.

Final product was termed “Nylon 6_Chain_0.1 of Example AA15b), (compound AA64).

In a separate process, steps 1 to 4 were carried out again, except that in step 1 137 mg (instead of 13 mg) of “Chain MINTs of Example AA11b”, thereby obtaining the sample termed “Nylon 6_Chain_1.0 of Example AA15b”, (compound AA65).

In another separate process, steps 1 to 4 were carried out again, except that “Glycol MINTs of Example AA11b” was used instead of “Chain MINTs of Example AA11b”. In that way, compounds AA66 and AA67 were obtained, termed “Nylon 6_Glycol_0.1 of Example AA16b” and “Nylon 6_Glycol_1.0 of Example AA16b”, respectively.

Finally, same procedure was followed using SWNTs (Tuball from OCSiAl). In that way, compounds AA68 and AA69 were obtained, termed “Nylon 6_Tuball_0.1 of Example AA16b” and “Nylon 6_Tuball_1.0 of Example AA16b”, respectively.

### Example AA17. Dogbones

The preparation of dog bone-shape tensile testing specimens were made following the protocol described in “Example FF4”. This protocol was used for the composites obtained in examples from “Example AA12” to “Example AA16”.

For Tensile tests, an Instron 34-TM tensile testing machine was used with a 10 kN load cell, following the procedure described in “Example FF5”.

Results obtained in tensile test involving “Example AA12. Preparation of PS-NH2+Ester MINT” compounds AA31 to AA37 are shown in FIG. 11.

The mechanical data obtained in tensile test show no significant changes.

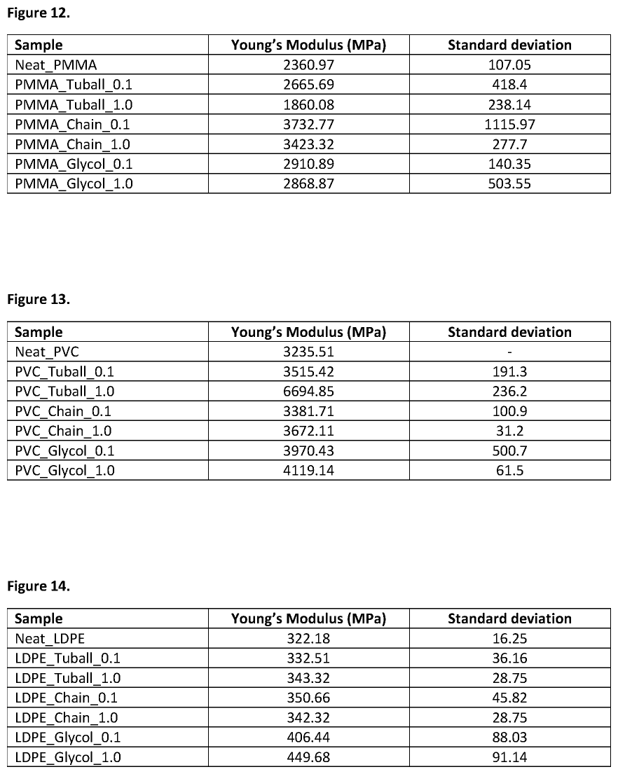

Results obtained in tensile test involving “Example AA13. PMMA composites” (compounds AA42 to AA48) are shown in FIG. 12.

The mechanical data obtained in tensile test show no significant changes.

Results obtained in tensile test involving “Example AA14. PVC composites” (compounds AA49 to AA55) are shown in FIG. 13.

The mechanical data obtained in tensile test show no significant changes.

Results obtained in tensile test involving “Example AA15. LDPE composites” compounds AA56 to AA62 are shown in FIG. 14.

The mechanical data obtained in tensile test show no significant changes.

Dogbones for specimens obtained in “Example AA16. Nylon 6 composites” were too difficult to extract from the stainless molds, and they were not measured.

Dogbones for compound AA63 to AA69 were impossible to form.

Mechanical measurements for compounds AA56-AA59 and AA61-AA63 of “Example AA12a” and “Example AA12b” respectively, had no standard deviation as only one specimen could be formed.

### Example BB1. Preparation of 12 Different SWNT-ML Complexes Via Ball Milling

In this example, SWNTs were coated separately with pyrene U-shapes, diamine U-shapes, pyridine U-shapes, anthraflavic U-shapes, fluorenone U-shapes, amine U-shapes, acid U-shapes, methyl ester U-shapes, methyl alcohol U-shapes, polyethoxy U-shapes, chain U-shapes or glycol U-shapes to yield 12 different preparations of coated nanotubes.

### Preparation A: Pyrene MINT

Step 1: 250 mg of Tuball, 148 mg of pyrene U-shape (“Pyrene U-shape of Example DD6”) and 5 mg of Grubbs 2^{nd} generation catalyst were placed in a 20 mL ball milling reactor with 5 stainless steel balls (10 mm diameter).
Step 2: Ball milling was performed at 500 rpm for 10 minutes.
Step 3: The resultant mixture was placed in a round bottom flask containing about 50 mL of dichloromethane and bath sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was transferred to a glass vial and placed in the furnace at 150° C. for 3 hr.
Step 7. The final product of Step 6 was analyzed by TGA. From the TGA the degree of functionalization (amount of U-shape relative to amount of SWNT) was determined to be 28%. Thus, the final product was called “Prep A: 28% pyrene MINT of Example BB1”.

### Preparation B: Diamine MINT

Step 1: 250 mg of Tuball, 148 mg of BOC-diamine U-shape (Diamino-boc U-shape of Example GG4a) and 5 mg of Grubbs 2^{nd} generation catalyst were placed in a 20 mL reactor with 5 stainless steel balls (10 mm diameter).
Step 2: Ball milling was performed at 500 rpm for 10 minutes.
Step 3: The resultant mixture was placed in a round bottom flask containing about 50 mL of dichloromethane and bath sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 220° C. for 24 hr to remove tert-butyloxycarbonyl (BOC) protecting groups.
Step 7. The final product of Step 6 was analyzed by TGA. From the TGA the degree of functionalization (amount of U-shape relative to amount of SWNT) was determined to be 28%. Thus, the final product was called “Prep B: 28% diamine MINT of Example BB1”.

### Preparation C: Pyridine MINT

Step 1: 140 mg of Tuball, 140 mg of pyridine U-shape (Pyridine U-shape of Example GG4a) and 73 mg of Grubbs 2^{nd} generation catalyst were placed in a 20 mL ball milling reactor with 5 stainless steel balls (10 mm diameter).
Step 2: Ball milling was performed at 500 rpm for 5 minutes.
Step 3: The resultant mixture was placed in a round bottom flask containing about 50 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 28%. Thus, the final product was called “Prep C: 28% Pyridine MINT of Example BB1”.

### Preparation D: Anthraflavic MINT

Step 1: 500 mg of Tuball, 300 mg of anthraflavic U-shape (anthraflavic U-shape of Example EE5) and 250 mg of Grubbs 2^{nd} generation catalyst were placed in a 45 mL ball milling reactor with 5 stainless steel balls (10 mm diameter).
Step 2: Ball milling was performed at 500 rpm for 10 minutes.
Step 3: The resultant mixture was placed in a round bottom flask containing about 100 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 23%. Thus, the final product was called “Prep D: 26% anthraflavic MINT of Example BB1”.

### Preparation E: Fluorenone MINT

Step 1: 250 mg of Tuball, 148 mg of fluorenone U-shape (fluorenone U-shape of Example AA4) and 5 mg of Grubbs 2^{nd} generation catalyst were placed in a 20 mL ball milling reactor with 5 stainless steel balls (10 mm diameter).
Step 2: Ball milling was performed at 500 rpm for 10 minutes.
Step 3: The resultant mixture was placed in a round bottom flask containing about 50 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 28%. Thus, the final product was called “Prep E: 28% fluorenone MINT of Example BB1”.

### Preparation F: Amine MINT

Step 1: 85 mg of Tuball, 50 mg of amine U-shape (Pyreneamides U-shape of Example EE7) and 3.5 mg of Grubbs 2^{nd} generation catalyst were placed in a 20 mL ball milling reactor with 5 stainless steel balls (10 mm diameter).
Step 2: Ball milling was performed at 500 rpm for 10 minutes.
Step 3: The resultant mixture was placed in a round bottom flask containing about 50 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 25%. Thus, the final product was called “Prep F: 25% amine MINT of Example BB1”.

### Preparation G: Acid MINT

Step 1: 1.5 g of Tuball, 662 mg of Acid U-shape (acid U-shape of Example EE3) and 61 mg of Grubbs 2^{nd} generation catalyst were placed in a 45 mL reactor with 5 stainless steel balls (10 mm diameter).
Step 2: Ball milling was performed at 500 rpm for 10 minutes.
Step 3: The resultant mixture was placed in a round bottom flask containing about 150 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 15%. Thus, the final product was called “Prep G: 15% Acid MINT of Example BB1”.

### Preparation H: Ester MINT

Step 1: 1.1 g of Tuball, 500 mg of ester U-shape (ester U-shape of Example EE2) and 46 mg of Grubbs 2^{nd} generation catalyst were placed in a 80 mL reactor with 5 stainless steel balls (10 mm diameter).
Step 2: The ball miller was set to operate at 500 rpm for 10 minutes.
Step 3: The resultant mixture was placed in a round bottom flask containing about 150 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 28%. Thus, the final product was called “Prep H: 28% ester MINT of Example BB1”.

### Preparation I: Methyl Alcohol MINT

Step 1: 920 mg g of Tuball, 400 mg of methyl alcohol U-shape (methyl alcohol U-shape of Example EE4) and 37.5 mg of Grubss 2^{nd} generation catalyst were placed in a 45 mL reactor with 5 stainless steel balls.
Step 2: The ball miller was set to operate at 500 rpm for 10 minutes.
Step 3: The resultant mixture was placed in a round bottom flask containing about 100 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 22%. Thus, the final product was called “Prep I: 23% Methyl Alcohol MINT of Example BB1”.

### Preparation J: Polyethoxy MINT

Step 1: 304 g of Tuball, 133 mg of polyethoxy U-shape (Polyethoxy U-shape of Example DD5) and 6.2 mg of Grubss 2^{nd} generation catalyst were placed in a 45 mL ball milling reactor with 5 stainless steel balls (10 mm diameter).
Step 2: Ball milling was performed at 500 rpm for 10 minutes.
Step 3: The resultant mixture was placed in a round bottom flask containing about 50 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 25%. Thus, the final product was called “Prep J: 25% polyethoxy MINT of Example BB1”.

### Preparation K: Chain MINT

Step 1: 1.25 g of Tuball, 600 mg of chain U-shape (chain U-shape of Example AA6) and 60 mg of Grubbs 2^{nd} generation catalyst were placed in a 45 mL reactor with 5 stainless steel balls (10 mm diameter).
Step 2: Ball milling was performed at 500 rpm for 10 minutes.
Step 3: The resultant mixture was placed in a round bottom flask containing about 150 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 28%. Thus, the final product was called “Prep K: 28% chain MINT of Example BB1”.

### Preparation L: Glycol MINT

Step 1: 1.35 g of Tuball, 600 mg of glycol U-shape (glycol U-shape of Example AA7) and 55 mg of Grubbs 2^{nd} generation catalyst were placed in a 45 mL reactor with 5 stainless steel balls (10 mm diameter).
Step 2: The ball miller was set to operate at 500 rpm for 10 minutes.
Step 3: The resultant mixture was placed in a round bottom flask containing about 150 mL of dichloromethane and sonicated for five minutes.
Step 4. The mixture was vacuum filtrated using a 0.2 μm pore size polytetrafluoroethylene (PFTE) membrane.
Step 5. The steps 3 and 4 were repeated three times. Diethyl ether was added in the final washing step and the sample was vacuum filtrated.
Step 6. The product was placed in the furnace at 150° C. for 3 hr.
Step 7. The final product of Step 6 was analyzed by TGA. From the TGA the degree of functionalization (amount of U-shape relative to amount of SWNT) was determined to be 24%. Thus, the final product was called “Prep L: 24% glycol MINT of Example BB1”.

### Example BB2. Protocol for Preparation of SWNT-ML/Polymer Composites, in the Shape of “Dog Bones” or Rectangles

This example provides the protocol for making the dog bone- and rectangle-shaped SWNT-ML/polymer composites by hot pressing.

The preparation of dog bone- and rectangle-shaped composites is conducted by the following steps.
Step 1. The SWNT-ML/polymer composite is placed onto polyimide foil and subsequently between two steel plates.
Step 2. The ‘sandwiched’ SWNT-ML composite is hot pressed at 180° C. with a load of 5 ton for 10 minutes using a hydraulic press with heating plates to yield composite films. Then, pressure is released and the composite film is cut into pieces and hot pressed again at the same conditions. This step is repeated five times to remove any remnant solvent in the composite.
Step 3. The SWNT-ML film is cut into small pieces. A mold in the form of a stainless steel plate with dog bone-shaped or rectangle-shaped orifices is coated with releasing agent. The mold is filled up with the SWNT-ML film pieces and subsequently hot pressed at 180° C. with a load of 10 ton.
Step 4. Dog bone- or rectangle-shaped SWNT-ML/polymer composite samples are retrieved by cooling down the hot press and demolding the samples manually.

### Example BB3. Composites Comprising Commercial PMMA and SWNT-ML Complexes Prepared Via Solvent Mixing

This example describes the preparation of PMMA-nanotube composites by solvent mixing employing different SWNT-ML complexes.

Commercial polymethylmethacrylate, abbreviated PMMA (Sigma-Aldrich, SKU 182265) was used as host polymer matrix.

10 different SWNT-ML/PMMA composites were prepared by the following steps.
Step 1. An appropriate amount (see specific amount hereunder) of SWNT-ML complexes were dispersed in 50 mL of toluene by mechanical stirring at 1500 rpm for 24 hrs.
Step 2. 19.7 g of commercial PMMA in powder form was added to the dispersion of Step 1 and the mixture was heated up at 60° C. with continuous mechanical stirring at 1500 rpm for 24 hr.
Step 3. The SWNT-ML/PMMA composite was retrieved by pouring out the mixture into a Teflon container, and subsequently the composite was placed in the oven at 80° C. overnight to evaporate the solvent.
Step 4. SWNT-ML/PMMA composites were shaped into dog bone form following the protocol described in Example BB2.

The 10 different SWNT-ML/PMMA composites (composites BB3.1-BB3.10) and the Neat PMMA control (Neat PMMA BB3.11) were prepared following the protocol mentioned immediately above (Steps 1-4), with the following changes:
Composite BB3.1 In Step 1, 347 mg of “Prep A: 28% pyrene MINT of Example BB1” were added. The resulting composite material (dog bones) obtained from Step 4 was called “28% pyrene SWNT/PMMA of Example BB3”.
Composite BB3.2 In Step 1, 347 mg of “Prep B: 28% diamine MINT of Example BB1” were added. The resulting composite material (dog bones) obtained from Step 4 was called “28% diamine SWNT/PMMA of Example BB3”.
Composite BB3.3 In Step 1, 333 mg of “Prep C: 25% pyridine MINT of Example B1E” were added. The resulting composite material (dog bones) obtained from Step 4 was called “25% pyridine SWNT/PMMA of Example BB3”.
Composite BB3.4 In Step 1, 337 mg of “Prep D: 26% antraflavic acid MINT of Example BB1” were added. The resulting composite material (dog bones) obtained from Step 4 was called “26% anthraflavic SWNT/PMMA of Example BB3”.
Composite BB3.5 In Step 1, 173 mg of “Prep A: 28% pyrene MINT of Example BB1” and 173 mg of “Prep B: 28% diamine MINT of Example BB1” were added. The resulting composite material (dog bones) obtained from Step 4 was called “28% pyrene/25% diamine SWNT/PMMA of Example BB3”.
Composite BB3.6 In Step 1, 173 mg of “Prep A: 28% pyrene MINT of Example BB1” and 166 mg of Prep C: 25% pyridine MINT of Example BB1” were added. The resulting composite material (dog bones) obtained from Step 4 was called “28% pyrene/25% pyridine SWNT/PMMA of Example BB3”.
Composite BB3.7 In Step 1, 173 mg of “Prep B: 28% diamine MINT of Example BB1” and 166 mg of Prep C: 25% pyridine MINT of Example BB1” were added. The resulting composite material (dog bones) obtained from Step 4 was called “28% diamine/25% pyridine SWNT/PMMA of Example BB3”.
Composite BB3.8 In Step 1, 115.6 mg of “Prep A: 28% pyrene MINT of Example BB1”, 115.6 mg of Prep C: 28% diamine MINT of Example BB1” and 111 mg of “Prep C: 25% pyridine MINT of Example BB1” were added. The resulting composite material (dog bones) obtained from Step 4 was called “28% pyrene/28% diamine/25% pyridine SWNT/PMMA of Example BB3”.
Composite BB3.9 In Step 1, 115.6 mg of “Prep A: 28% pyrene MINT of Example BB1”, 115.6 mg of Prep C: 28% diamine MINT of Example BB1” and 112.3 mg of “Prep D: 26% antraflavic acid MINT of Example BB1” were added. The resulting composite material (dog bones) obtained from Step 4 was called “28% pyrene/28% diamine/26% anthraflavic SWNT/PMMA of Example BB3”.
Composite BB3.10 In step 1, 250 mg of Tuball (from OCSiAl) was added instead of the SWNT-ML complexes. The resulting composite material (dog bones) obtained from Step 4 was called “Tuball SWNT/PMMA of Example BB3”.
Neat PMMA BB3.11 In step 1, no SWNT-ML complexes were added. The resulting material (dog bones) obtained from Step 4, was called “neat PMMA of Example BB3”.

Mechanical characterization of SWNT-ML/PMMA was conducted by tensile test measurements. Summary of Young's modulus and tensile strength data and their respective calculated load transfer is shown in the Table below.

| | | Maximum |
|---|---|---|
| | Young's | tensile |
| | Modulus | strength |
| Composite | (MPa) | (MPa) |
| neat PMMA | 2476 | 48.35 |
| 28% pyrene SWNT/PMMA | 3405.22 | 50.62 |
| 28% diamine SWNT/PMMA | 3364.84 | 46.59 |
| 25% pyridine SWNT/PMMA | 3871.69 | 50.61 |
| 26% anthraflavic SWNT/PMMA | 3266.18 | 56 |
| 28% pyrene/25% diamine SWNT/PMMA | 4107.72 | 43.118 |
| 28% pyrene/25% pyridine SWNT/PMMA | 3530.88 | 62.28 |
| 28% diamine/25% pyridine SWNT/PMMA | 3559 | 61.75 |
| 28% pyrene/28% diamine/25% pyridine | 3426.76 | 61.87 |
| SWNT/PMMA | | |
| 28% pyrene/28% diamine/26% | 3112.14 | 43.36 |
| anthraflavic SWNT/PMMA | | |
| Tuball SWNT/PMMA | 3419.89 | 56.57 |

The total concentration of the filler in all composites is 1%. The percentage shown corresponds to the functionalization of the SWNT-ML.

PMMA composites prepared with the combination of pyrene, pyridine and diamine U-shapes exhibit higher tensile strength compared to the values when their respective single U-shapes are employed. On the other hand, the highest Young's modulus is observed for the composite prepared with the combination of pyrene and diamine U-shapes.

### Example BB4. Composites Comprising Commercial PMMA and SWNT-ML Complexes Prepared Via Shear Mixing

This example describes the preparation of PMMA-nanotube composites with different SWNTs-ML via shear mixing employing the dispersion tool ULTRA-TURRAX T 25.

Commercial polymethyl methacrylate, abbreviated PMMA (Sigma-Aldrich, SKU 182265) was used as host polymer matrix.
Step 1. An appropriate amount (see specific amount hereunder) of SWNT-ML complex and 6.990 g of commercial PMMA were placed into a 50 mL glass jacketed cell.
Step 2. The glass jacketed cell was connected with tubing to water supply to cool the cell, in order to avoid the evaporation of the solvent in the cell.
Step 3. 50 mL of chloroform were added to the mixture and the dispersion tool was operated at 7,000 rpm for 7 hr.
Step 4. The SWNT-ML/PMMA composite was retrieved by pouring out the mixture into a 500 mL beaker containing 300 mL of isopropanol.
Step 5. The precipitated composite was placed in a Teflon container and dried in the oven at 80° C. overnight to evaporate the solvent.

Then the SWNT-ML/PMMA composites were shaped into dog bones following the procedure described in Example BB2.

Dog bones from 9 different SWNT-ML/PMMA composites (composites BB4.1-BB4.10) and a Neat PMMA control (neat PMMA BB4.10) were prepared following the protocol described immediately above (Steps 1-5), with the following specifications:
Composite BB4.1 In Step 1, 9 mg of “Prep F: 22% amine MINT of Example BB1” were added. The resulting composite material (dog bones) obtained from Step 5 was called “22% amine SWNT/PMMA_ShMx of Example BB4”.
Composite BB4.2 In Step 1, 8.2 mg of “Prep G: 15% Acid MINT of Example BB1” were added. The resulting composite material (dog bones) obtained from Step 5 was called “15% Acid SWNT/PMMA_ShMx of Example BB4”.
Composite BB4.3 In Step 1, 9.7 mg of “Prep H: 28% ester MINT of Example BB1” were added. The resulting composite material (dog bones) obtained from Step 5 was called “28% ester SWNT/PMMA_ShMx of Example BB4”.
Composite BB4.4 In Step 1, 9.3 mg of “Prep C: 25% pyridine MINT of Example BB1” were added. The resulting composite material (dog bones) obtained from Step 5 was called “25% pyridine SWNT/PMMA_ShMx of Example BB4”.
Composite BB4.5 In Step 1, 9.1 mg of “Prep I: 23% methyl alcohol MINT of Example BB1” were added. The resulting composite material (dog bones) obtained from Step 5 was called “23% methyl alcohol SWNT/PMMA of Example BB4”.
Composite BB4.6 In Step 1, 9.3 mg of “Prep J: 25% polyethoxy MINT of Example BB1” were added. The resulting composite material (dog bones) obtained from Step 5 was called “25% polyethoxy SWNT/PMMA of Example BB4”.
Composite BB4.7 In Step 1, 9.7 mg of “Prep K: 28% chain MINT of Example BB1” were added. The resulting composite material (dog bones) obtained from Step 5 was called “28% chain SWNT/PMMA_ShMx of Example BB4”.
Composite BB4.8 In Step 1, 9.2 mg of “Prep L: 24% glycol MINT of Example BB1” added. The resulting composite material (dog bones) obtained from Step 5 was called “24% glycol SWNT/PMMA_ShMx of Example BB4”.
Composite BB4.9 In step 1, 7 mg of Tuball (from OCSiAl) was added instead of the SWNT-ML complexes. The resulting composite material (dog bones) obtained from Step 5 was called “Tuball SWNT/PMMA_ShMx of Example BB4”.
Neat PMMA BB 4.10. In step 1, no SWNT-ML complex was added. The resulting polymer material (dog bones) obtained from step 5 was called “Neat PMMA of Example BB4”.

Mechanical characterisation of SWNT-ML/PMMA was conducted by tensile test measurements. Summary of Young's modulus and tensile strength data and their respective calculated load transfer values is shown in the table below

| | | Maximum |
|---|---|---|
| | Young's | tensile |
| | Modulus | strength |
| Composite | (MPa) | (MPa) |
| neat PMMA_ShMx | 2476 | 48.35 |
| 22% amine SWNT/PMMA_ShMx | 3315.4 | 79.44 |
| 15% acid SWNT/PMMA_ShMx | 3247.38 | 80.85 |
| 28% ester SWNT/PMMA_ShMx | 3596.42 | 78.97 |
| 25% pyridine SWNT/PMMA_ShMx | 3256.15 | 68.21 |
| 23% methyl alcohol SWNT/PMMA_ShMx | 3586.63 | 66.04 |
| 25% polyethoxy SWNT/PMMA_ShMx | 3330.77 | 69.41 |
| 28% chain SWNT/PMMA_ShMx | 3071.18 | 67.07 |
| 24% glycol SWNT/PMMA_ShMx | 3611.84 | 75.64 |
| Tuball SWNT/PMMA_ShMx | 3447.04 | 77.17 |

The total concentration of the filler in all composites is 0.1%. The percentage shown corresponds to the functionalization of the SWNT-ML.

All of the U-shapes at 0.1% filler loading exhibit higher Young's modulus and tensile strength than the neat PMMA polymer and even higher than pristine SWNNT. For instance, Young's Modulus of composites prepared with ester, methyl alcohol and glycol U-shapes are higher than that of Tuball. On the other hand, the tensile strength data of such composites are close to that of Tuball with the exception of the methyl alcohol U-shape.

### Example BB5. Composites Comprising Commercial Polystyrene (PS) and SWNT-ML Complexes were Prepared Via Solution Mixing

This example describes the preparation of PS-nanotube composites via solvent mixing employing different SWNTs-ML.

Commercial polystyrene, abbreviated PS (average Mn˜192,000 Sigma-Aldrich, SKU 430102) was used as host polymer matrix.

SWNT-ML/PS composites were prepared by the following protocol.
Step 1. An appropriate amount (see specific amount hereunder) of SWNT-ML complexes were dispersed in 50 mL of acetone via ultrasonication for 1 hr.
Step 2. 3 g of commercial PS in pellet form was added to the SWNT-ML dispersion from step 1 and the mixture was heated up at 60° C. with continuous mechanical stirring for 24 hr at 1500 rpm.
Step 3. The SWNT-ML/PS composite was retrieved by pouring out the mixture into a Teflon container, and subsequently the composite was placed in the oven at 80° C. overnight to evaporate the solvent.
Step 4. SWNT-ML/PS composites were shaped into rectangle form following the procedure described in Example BB2.

6 different SWNT-ML/PS composites (composites BB5.1-BB5.6) and a Neat PS control sample (Neat PS BB5.7) were prepared following the protocol mentioned immediately above (Steps 1-4), with the following changes:
Composite BB5.1 In Step 1, 41.6 mg of “Prep A: 28% pyrene MINT of Example BB1” was added. The resulting composite material (rectangles) obtained from step 4 was called “28% pyrene SWNT/PS of Example BB5”.
Composite BB5.2 In Step 1, 41.6 mg of “Prep B: 28% diamine MINT of Example B1E” was added. The resulting composite material (rectangles) obtained from step 4 was called “28% diamine SWNT/PS of Example BB5”.
Composite BB5.3 In Step 1, 40 mg of “Prep C: 25% pyridine MINT of Example BB1” was added. The resulting composite material (rectangles) obtained from step 4 was called “25% pyridine SWNT/PS of Example BB5.
Composite BB5.4 In Step 1, 20.8 mg of “Prep A: 28% pyrene MINT of Example B1E” and 20.8 mg of “Prep B: 28% diamine MINT of Example BB1” were added. The resulting composite material (rectangles) obtained from step 4 was called “28% pyrene/25% diamine SWNT/PS of Example BB5”.
Composite BB5.5 In Step 1, 20.8 mg of “Prep A: 28% pyrene MINT of Example BB1” and 20 mg of Prep C: 25% pyridine MINT of Example BB1” were added. The resulting composite material (rectangles) obtained from step 4 was called “28% pyrene/25% pyridine SWNT/PS of Example BB5.
Composite BB5.6 In Step 1, 20.8 mg of “Prep B: 28% diamine MINT of Example BB1” and 20 mg of Prep C: 25% pyridine MINT of Example BB1” were added. The resulting composite material (rectangles) obtained from step 4 was called “28% diamine/25% pyridine SWNT/PS of Example BB5”.
Neat PS BB5.7 In step 1, no SWNT-ML complex was added. The resulting composite material (rectangles) obtained from step 4 was called “Neat polystyrene of Example BB5”.

Mechanical characterization of SWNT-ML/PS composites was conducted by dynamic mechanical analysis (DMA). Summary of storage moduli and transition glass temperature, Tg, data is shown in the table below.

| | | Glass |
|---|---|---|
| | Storage | transition |
| | Modulus | temperature |
| Composite | (MPa) | (° C.) |
| neat PS | 2037 | 112 |
| 28% pyrene SWNT/PS | 2505.34 | 114 |
| 28% diamine SWNT/PS | 2550.11 | 113 |
| 25% pyridine SWNT/PS | 2589.17 | 115 |
| 28% pyrene/25% diamine SWNT/PS | 2736.36 | 114 |
| 28% pyrene/25% pyridine SWNT/PS | 2534.76 | 121 |
| 28% diamine/25% pyridine SWNT/PS | 2800.25 | 119 |

The total concentration of the filler in all composites is 1%. The percentage shown corresponds to the functionalization of the SWNT-ML.

PS composites prepared by mixing pyrene/diamine and diamine/pyridine U-shapes result in higher storage modulus than their respective single U-shapes. The combined pyrene/pyridine U-shapes composite exhibits an important increase of 9° C. in the glass transition temperature with respect to that of the neat polymer.

### Example BB6. Composites Comprising Commercial LDPE and SWNT-ML Complexes, Prepared Via Shear Mixing

This example describes the preparation of LDPE-nanotube composites with different SWNTs-ML via shear mixing employing the dispersion tool ULTRA-TURRAX T 25.

Commercial low density polyethylene in powder form, abbreviated LDPE (Alfa Aesar, SKU A10239.36) was used as host polymer matrix.

SWNT-ML/LDPE composites were prepared by the following steps.
Step 1. An appropriate amount (see specific amount hereunder) of SWNT-ML complexes and 6.990 g of commercial LDPE were placed into a 50 mL glass jacketed cell.
Step 2. The glass jacketed cell was connected with tubing to water supply for its recirculation to avoid the evaporation of the solvent in the glass cell.
Step 3. 50 mL of chloroform were added to the mixture and the dispersion tool was operated at 14,000 rpm for 3 hr.
Step 4. The SWNT-ML/LDPE composite was retrieved by pouring out the mixture into a glass Petri dish container, and subsequently the composite was placed in the oven at 80° C. overnight to evaporate the solvent.
Step 5. SWNT-ML/LDPE_ShMx composites were shaped into dog bone shape following the procedure described in Example BB2.

8 different SWNT-ML/LDPE_ShMx composites (composites BB6.1-BB6.8) and a Neat LDPE control sample (Neat LDPE BB6.9) were prepared following the a protocol mentioned immediately above (Steps 1-5), with the following changes:
Composite BB6.1 In Step 1, 9.7 mg of “Prep A: 28% pyrene MINT of Example BB1” were added. The resulting composite material (dog bones) obtained from step step 5 were called “28% pyrene SWNT/LDPE_ShMx of Example BB6”.
Composite BB6.2 In Step 1, 9.3 mg of “Prep C: 25% pyridine MINT of Example B1E” were added. The resulting composite material (dog bones) obtained from step step 5 was called “25% pyridine SWNT/LDPE_ShMx of Example BB6”.
Composite BB6.3 In Step 1, 9.2 mg of “Prep L: 24% glycol MINT of Example BB1” added.

The resulting composite material (dog bones) obtained from step step 5 was called “24% glycol SWNT/LDPE_ShMx of Example BB6”.
Composite EE6.4 In Step 1, 8.2 mg of “Prep G: 15% Acid MINT of Example BB1” were added. The resulting composite material (dog bones) obtained from step step 5 was called “15% Acid SWNT/LDPE_ShMx of Example BB6”.
Composite EE6.5 In Step 1, 9.7 mg of “Prep K: 28% chain MINT of Example BB1” were added. The resulting composite material (dog bones) obtained from step step 5 was called “28% chain SWNT/LDPE_ShMx of Example BB6”.
Composite EE6.6 In Step 1, 9.7 mg of “Prep E: 28% fluorenone MINT of Example BB1” were added. The resulting composite material (dog bones) obtained from step step 5 was called “28% fluorenone SWNT/LDPE_ShMx of Example BB6”.
Composite EE6.7 In Step 1, 9.3 mg of “Prep J: 25% polyethoxy MINT of Example BB1” were added. The resulting composite material (dog bones) obtained from step step 5 was called “25% polyethoxy SWNT/LDPE_ShMx of Example BB6”.
Composite EE6.8 In step 1.7 mg of Tuball (from OCSiAl) was added instead of the SWNT-ML complexes. The resulting composite material (dog bones) obtained from step 5 was called “Tuball SWNT/LDPE_ShMx of Example BB6”.
Neat LDPE BB6.9 In step 1, no SWNT-ML was added. The resulting polymer material (dog bones) obtained from step step 5 was called “Neat LDPE_ShMx of Example BB6”.

Mechanical characterization of SWNT-ML/LDPE was conducted by tensile test measurements. Summary of Young's modulus and tensile strength data with their respective calculated load transfer values is shown in the table below.

| | | Maximum |
|---|---|---|
| | Young's | tensile |
| | Modulus | strength |
| Composite | (MPa) | (MPa) |
| neat LDPE_ShMx | 155.2 | 14.92 |
| 28% pyrene SWNT/LDPE_ShMx | 169.9 | 12.67 |
| 25% pyridine SWNT/LDPE_ShMx | 158.16 | 13.41 |
| 24% glycol SWNT/LDPE_ShMx | 156.01 | 11.55 |
| 15% Acid SWNT/LDPE_ShMx | 136.78 | 8.3 |
| 28% chain SWNT/LDPE_ShMx | 165.65 | 15.06 |
| 28% fluorenone SWNT/LDPE_ShMx | 148.31 | 16.29 |
| 25% polyethoxy SWNT/LDPE_ShMx | 154.63 | 16.35 |
| Tuball SWNT/LDPE_ShMx | 168.43 | 13.99 |

The total concentration of the filler in all composites is 0.1%. The percentage shown corresponds to the functionalization of the SWNT-ML.

LDPE composites prepared with pristine Tuball, Pyrene and Chain U-shapes possess higher Young's Moduli, however, this is not the case in terms of tensile strength where the polyethoxy U-shape shows the highest value.

### Example BB7. Composites Comprising Commercial PVDF and SWNT-ML Complexes Prepared Via Shear Mixing

This example describes the preparation of PVDF-nanotube composites via solvent mixing employing different SWNT-ML complexes.

Commercial polyvinylidene fluoride, abbreviated PVDF (Alfa Aesar, SKU 44080.36) was used as host polymer matrix.

SWNT-ML/PVDF composites were prepared by the following steps.
Step 1. An appropriate amount (see specific amount hereunder) of SWNT-ML was added to 7 g of PVDF and mixed in 50 mL of acetone using a dispersion instrument T25 digital ULTRA-TURRAX at a speed of 7000 rpm for 3 hr.
Step 2. The composite was retrieved by pouring out the mixture in 300 mL deionized water under constant stirring leading to its precipitation.
Step 3. The precipitated composite was placed into a Teflon container and dried in isothermal oven at 80° C. overnight.

The 7 different nanotube composites (composites BB4.1-BB4.7) and a Neat PVDF control sample (Neat PVDF BB7.8) were prepared following the the protocol mentioned immediately above (Steps 1-3), with the following changes:
Composite BB7.1 In Step 1, 9.7 mg of “Prep A: 28% pyrene MINT of Example BB1” were added. The resulting composite material (dog bones) obtained from step 3 was called “28% pyrene SWNT/PVDF_ShMx of Example BB7”.
Composite BB7.2 In Step 1, 8.2 mg of “Prep G: 15% Acid MINT of Example BB1” were added. The resulting composite material (dog bones) obtained from step 3 was called “15% Acid SWNT/PVDF_ShMx of Example BB7”.
Composite BB7.3 In Step 1, 9.7 mg of “Prep E: 28% fluorenone MINT of Example B1E” were added. The resulting composite material (dog bones) obtained from step 3 was called “28% fluorenone SWNT/PVDF_ShMx of Example BB7”.
Composite BB7.4 In Step 1, 9.2 mg of “Prep L: 24% glycol MINT of Example BB1” added. The resulting composite material (dog bones) obtained from step 3 was called “24% glycol SWNT/PVDF_ShMx of Example BB7”.
Composite BB7.5 In Step 1, 9.3 mg of “Prep C: 25% pyridine MINT of Example BB1” were added. The resulting composite material (dog bones) obtained from step 3 was called “25% pyridine SWNT/PVDF_ShMx of Example BB7”.
Composite BB7.6 In Step 1, 9.7 mg of “Prep K: 28% chain MINT of Example BB1” were added. The resulting composite material (dog bones) obtained from step 3 was called “28% chain SWNT/PVDF_ShMx of Example BB7”.
Composite BB7.7 In step 1, 7 mg of Tuball (from OCSiAl) was added instead of the SWNT-ML complexes. The resulting composite material (dog bones) obtained from step 3 was called “Tuball SWNT/PVDF_ShMx of Example BB7”.
Neat PVDF BB7.8 In step 1, no SWNT-ML complexes were added. The resulting polymer material (dog bones) obtained from step 3 was called “Neat PVDF_ShMx of Example BB7”.

Mechanical characterization of SWNT-ML/PVDF was conducted by tensile test measurements. Summary of Young's modulus and tensile strength data is shown in the table below.

| | | Maximum |
|---|---|---|
| | Young's | tensile |
| | Modulus | strength |
| Composite | (MPa) | (MPa) |
| neat PVDF_ShMx | 1206.12 | 42.94 |
| 28% pyrene SWNT/PVDF ShMx | 1388.17 | 41.92 |
| 15% Acid SWNT/PVDF ShMx | 1505.51 | 46.74 |
| 28% fluorenone SWNT/PVDF_ShMx | 1475.48 | 47.26 |
| 24% glycol SWNT/PVDF_ShMx | 1147.35 | 42.22 |
| 25% pyridine SWNT/PVDF_ShMx | 1473.66 | 47.28 |
| 28% chain SWNT/PVDF_ShMx | 1304.25 | 43.67 |
| Tuball SWNT/PVDF_ShMx | 1557.23 | 46.57 |

The total concentration of the filler in all composites is 0.1%. The percentage shown corresponds to the functionalization of the SWNT-ML.

PVDF composite comprising Tuball exhibits the highest Young's Modulus compared to the neat polymer, this is followed by the acid U-shape. On the other hand, the tensile strength is slightly improved by the incorporation of fluorenone and pyridine U-shapes.

### Example BB8. Composites Comprising Commercial PS and SWNT-ML Complexes Prepared Via Shear Mixing

This example describes the preparation of PS-nanotube composites via solvent mixing employing different SWNTs-ML.

Commercial polystyrene, abbreviated PS (average Mn 192000 Sigma-Aldrich, SKU 430102) was used as host polymer matrix.

SWNT-ML/PS composites were prepared by the following steps.
Step 1. An appropriate amount (see specific amount hereunder) of SWNTs-ML complexes was added to 7 g of PS and mixed in 50 mL of chloroform using a dispersion instrument T25 digital ULTRA-TURRAX at a speed of 9000 rpm for 2 hr.
Step 2. The composite was retrieved by pouring out the mixture into a 500 mL beaker containing 300 mL of isopropanol.
Step 3. The precipitated composite was placed in a Teflon container and dried in isothermal oven at 80° C. overnight.

8 different nanotube composites (composites BB8.1-BB8.8) and a neat PS control sample (Neat PS BB8.9) were prepared following the protocol mentioned immediately above (Steps 1-3), with the following changes:
Composite BB8.1 In Step 1, 9.7 mg of “Prep A: 28% pyrene MINT of Example BB1” were added. The resulting composite material (dog bones) was called “28% pyrene SWNT/PS_ShMx of Example BB8”.
Composite BB8.2 In Step 1, 9.3 mg of “Prep C: 25% pyridine MINT of Example B1E” were added. The resulting composite material (dog bones) obtained from step 3 was called “25% pyridine SWNT/PS_ShMx of Example BB8”.
Composite BB8.3 In Step 1, 9.2 mg of “Prep L: 24% glycol MINT of Example BB1” added. The resulting composite material (dog bones) obtained from step 3 was called “24% glycol SWNT/PS_ShMx of Example BB8”.
Composite BB8.4 In Step 1, 8.2 mg of “Prep G: 15% Acid MINT of Example BB1” were added. The resulting composite material (dog bones) obtained from step 3 was called “15% Acid SWNT/PS_ShMx of Example BB8”.
Composite EE8.5 In Step 1, 9.7 mg of “Prep K: 28% chain MINT of Example BB1” were added. The resulting composite material (dog bones) obtained from step 3 was called “28% chain SWNT/PS_ShMx of Example BB8”.
Composite EE8.6 In Step 1, 9.3 mg of “Prep J: 25% polyethoxy MINT of Example BB1” were added. The resulting composite material (dog bones) obtained from step 3 was called “25% polyethoxy SWNT/PS_ShMx of Example BB8”.
Composite EE8.7 In Step 1, 9.3 mg of “Prep F: 22% amine MINT of Example BB1” were added. The resulting composite material (dog bones) obtained from step 3 was called “22% amine SWNT/PS_ShMx of Example BB8”.
Composite BB8.8 In step 1, 7 mg of Tuball was added instead of the SWNT-ML complexes. The resulting composite material (dog bones) obtained from step 3 was called “Tuball SWNT/PS_ShMx of Example BB8”.
Neat PS BB8.9 In step 1, no SWNT-ML complex was added. The resulting composite material (dog bones) obtained from step 3 was called “Neat PS_ShMx of Example BB8”.

Mechanical characterization of SWNT-ML/PMMA was conducted by tensile test measurements. Summary of Young's modulus and tensile strength data is shown in the table below.

| | | Maximu |
|---|---|---|
| | Young's | m tensile |
| | Modulus | strength |
| Composite | (MPa) | (MPa) |
| neat PS_ShMx | 2983 | 34.14 |
| 28% pyrene SWNT/PS_ShMx | 3305.06 | 40.99 |
| 25% pyridine SWNT/PS_ShMx | 3263.65 | 43.61 |
| 24% glycol SWNT/PS_ShMx | 3410.4 | 26.3 |
| 15% Acid SWNT/PS_ShMx | 3243.74 | 50.94 |
| 28% chain SWNT/PS_ShMx | 2877.58 | 35.45 |
| 25% polyethoxy SWNT/PS_ShMx | 3288.54 | 47.47 |
| 22% amine SWNT/PS_ShMx | 2806.47 | 40.31 |
| Tuball/PS_ShMx | 3480.57 | 45.16 |

The total concentration of the filler in all composites is 0.1%. The percentage shown corresponds to the functionalisation of the SWNT-ML.

Tuball and glycol U-shape composites show high Young's Moduli. However, an important increase in tensile strength of the composite is obtained with the incorporation of acid and polyethoxy U-shapes.

### Example BB9. Composites Comprising Commercial PC and SWNT-ML Complexes Prepared Via Shear Mixing

This example describes the preparation of PC-nanotube composites via solvent mixing employing different SWNTs-ML.

Commercial polycarbonate, abbreviated PC (Good Fellow, SKU CT30-GL-000110) was used as host polymer matrix.

SWNT-ML/PC composites were prepared by the following steps.
Step 1. An appropriate amount (see specific amount hereunder) of SWNTs-ML complexes was added to 3.495 g of PC and mixed in 40 mL of chloroform using a dispersion instrument T25 digital ULTRA-TURRAX at a speed of 10000 rpm for 1 hr.
Step 2. The composite was retrieved by pouring out the mixture into a 500 mL beaker containing 150 mL of isopropanol.
Step 3. The precipitated composite was placed in a Teflon container and dried in isothermal oven at 80° C. overnight.

9 different nanotube composites (composites BB9.1-BB8.9) a neat PC control sample (Neat PC BB9.10) were prepared following the protocol mentioned immediately above (Steps 1-3), with the following changes:
Composite BB9.1 In Step 1, 4.86 mg of “Prep A: 28% pyrene MINT of Example BB1” were added. The resulting composite material (dog bones) was called “28% pyrene SWNT/PC_ShMx of Example BB9”.
Composite BB9.2 In Step 1, 4.66 mg of “Prep C: 25% pyridine MINT of Example B1E” were added. The resulting composite material (dog bones) obtained from step 3 was called “25% pyridine SWNT/PC_ShMx of Example BB9”.
Composite BB9.3 In Step 1, 4.60 mg of “Prep L: 24% glycol MINT of Example BB1” added.

The resulting composite material (dog bones) obtained from step 3 was called “24% glycol SWNT/PC_ShMx of Example BB9”.
Composite EE9.4 In Step 1, 4.11 mg of “Prep G: 15% Acid MINT of Example BB1” were added. The resulting composite material (dog bones) obtained from step 3 was called “15% Acid SWNT/PC_ShMx of Example BB9”.
Composite EE9.5 In Step 1, 4.86 mg of “Prep K: 28% chain MINT of Example BB1” were added. The resulting composite material (dog bones) obtained from step 3 was called “28% chain SWNT/PC_ShMx of Example BB9”.
Composite EE9.6 In Step 1, 4.66 mg of “Prep J: 25% polyethoxy MINT of Example BB1” were added. The resulting composite material (dog bones) obtained from step 3 was called “25% polyethoxy SWNT/PC_ShMx of Example BB9”.
Composite EE9.7 In Step 1, 4.86 mg of “Prep E: 28% fluorenone MINT of Example BB1” were added. The resulting composite material (dog bones) obtained from step 3 was called “28% fluorenone SWNT/PC_ShMx of Example BB9”.
Composite EE9.8 In Step 1, 4.86 mg of “Prep H: 28% ester MINT of Example BB1” were added. The resulting composite material (dog bones) obtained from step 3 was called “28% ester SWNT/PC_ShMx of Example BB9”.
Composite EE9.9 In step 1, 3.5 mg of Tuball was added instead of the SWNT-ML complexes. The resulting composite material (dog bones) obtained from step 3 was called “Tuball SWNT/PC_ShMx of Example BB9”.
Neat PC BB9.10 In step 1, no SWNT-ML complex was added. The resulting composite material (dog bones) obtained from step 3 was called “Neat PC_ShMx of Example BB9”.

Mechanical characterization of SWNT-ML/PC was conducted by tensile test measurements. Summary of Young's modulus and tensile strength data is shown in the table below.

| | | Maximum |
|---|---|---|
| | Young's | tensile |
| | Modulus | strength |
| Composite | (MPa) | (MPa) |
| neat PC | 2249 | 70.43 |
| 28% pyrene SWNT/PC_ShMx | 2298.92 | 76.9 |
| 25% pyridine SWNT/PC_ShMx | 2189.59 | 79.16 |
| 24% glycol SWNT/PC_ShMx | 2231.35 | 65.16 |
| 15% Acid SWNT/PC_ShMx | 2256.05 | 73.06 |
| 28% chain SWNT/PC_ShMx | 2233.01 | 75.83 |
| 25% polyethoxy SWNT/PC_ShMx | 2399.65 | 67.1 |
| 28% fluorenone SWNT/PC_ShMx | 2284.5 | 75.15 |
| 28% ester SWNT/PC_ShMx | 2227.37 | 73.4 |
| Tuball SWNT/PC_ShMx | 2332.02 | 78.71 |

The total concentration of the filler in all composites is 0.1%. The percentage shown corresponds to the functionalization of the SWNT-ML.

The incorporation of polyethoxy U-shape results in the highest Young's Modulus compared to that of the neat polymer. However, no improvement is observed in the tensile strength for this composite. A similar result is that for pyridine U-shape which exhibits the highest tensile strength but the Young's Modulus is well below the neat polymer.

### Example BB10. Composites Comprising Commercial HDPE and SWNT-ML Complexes Prepared Via Solvent Mixing

This example describes the preparation of HDPE-nanotube composites by solvent mixing employing pyrene SWNT-ML complexes.

Commercial high-density polyethylene, abbreviated HDPE (Sigma-Aldrich, SKU GF80517078-1EA) was used as host polymer matrix.

Two SWNT-ML/PMMA composites with different filler concentrations were prepared by the following steps.
Step 1. An appropriate amount (see specific amount hereunder) of SWNT-ML complexes were dispersed in a round bottom flask containing 80 mL of toluene by mechanical stirring at 500 rpm for 24 hrs.
Step 2. The SWNT-ML dispersion was heated up at 110° C. using a hot plate and a condenser was put in place.
Step 3. 19.7 g of commercial HDPE in pellet form was split in three portions (about 6.5 g) and added separately to the dispersion of Step 2 every hour to give sufficient time to dissolve the polymer. The mixture was kept under continuous mechanical stirring at 1500 rpm for 24 hr.
Step 3. The pyrene SWNT-ML/PMMA composite was retrieved by pouring out the mixture into a Teflon container, and subsequently the composite was placed in the oven at 80° C. overnight to evaporate the solvent.
Step 4. SWNT-ML/PMMA composites were shaped into rectangle form following the protocol described in Example BB2.

The 2 different pyrene SWNT-ML/PMMA composites (composites BB10.1-BB10.2) and the neat HDPE (Neat HDPE E1E0.3) were prepared following the the protocol mentioned immediately above (Steps 1-4):
Composite BB10.1 In Step 1, 278 mg of “Prep A: 28% pyrene MINT of Example BB1” were added. The resulting composite material (ractangles) obtained from Step 4 was called “28% pyrene SWNT/HDPE of Example BB10”.
Composite BB3.2 In Step 1, 556 mg of “Prep A: 28% pyrene MINT of Example BB1” were added. The resulting composite material (dog bones) obtained from Step 4 was called “28% pyrene SWNT/HDPE of Example BB10”.
Neat HDPE BB10.3 In step 1, no SWNT-ML complex was added. The resulting composite material (rectangles) obtained from step 4 was called “Neat HDPE of Example BB10”.

Mechanical characterization of SWNT-ML/HDPE composites was conducted by dynamic mechanical analysis (DMA). Summary of storage moduli with their respective calculated load transfer is shown in the table below.

| | Filler | Storage Modulus |
|---|---|---|
| | concentration | @−100° C. |
| Composite | (%) | (MPa) |
| neat HDPE | — | 2446 |
| 28% pyrene SWNT/HDPE | 1 | 3669 |
| 28% pyrene SWNT/HDPE | 2 | 5043 |

The incorporation of pyrene U-shape results in a 1.5-fold and 2-fold increase in storage modulus at cryogenic temperatures with 1% and 2% filler loading, respectively.

### Example BB11. Composites Comprising Commercial PMMA and SWNT-ML Complexes Prepared Via Extrusion

This example describes the preparation of PMMA-nanotube composites using a custom-made extruder and employing different SWNT-ML complexes.

Commercial polymethylmethacrylate, abbreviated PMMA (Sigma-Aldrich, SKU 182265) was used as host polymer matrix.

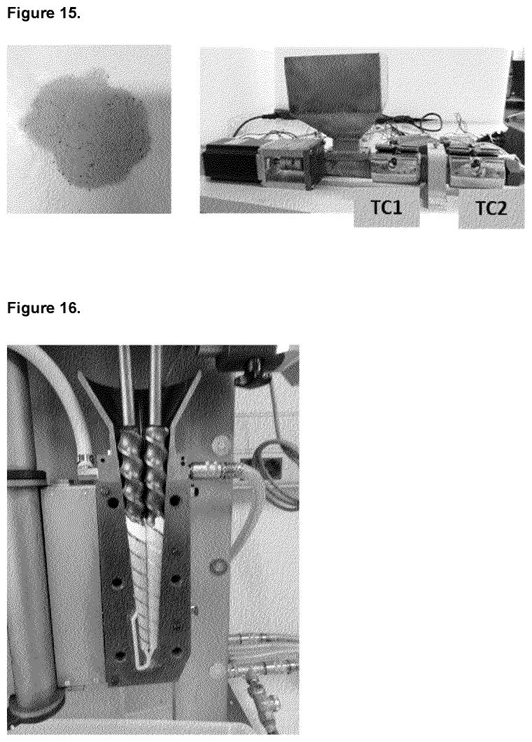

Two different SWNT-ML/PMMA composites were prepared by the following steps.
Step 1. 7 g of commercial PMMA in powder form was dried in the oven at 80° C. overnight.
Step 2. An appropriate amount (see specific amount hereunder) of SWNT-ML complexes and the dried PMMA powder from Step 1 were placed in a 20 mL ball miller reactor with 5 stainless steel balls (10 mm diameter).
Step 3. The SWNT-ML and PMMA mixture was ball milled at 500 rpm for 10 minutes (FIG. 15)
Step 4. A custom-made single-screw extruder with two controlled heating zones was pre-heated at 190° C. for 1 hr (FIG. 15).
Step 5. The resultant mixture from step 3 was taken from the reactor as is and passed through the extruder at a screw speed of 8 rpm.
Step 6. The extruder SWNT-ML/PMMA composite filament was collected and shaped into dog bones form following the protocol described in Example BB2.

The 2 different SWNT-ML/PMMA composites (composites BB11.1-BB11.2) and the neat PMMA (Neat PMMA BB11.3) were prepared following the the protocol mentioned immediately above (Steps 1-6) with the following changes:
Composite BB11.1 In Step 1, 9.7 mg of “Prep H: 28% ester MINT of Example BB1” were added. The resulting composite material (dog bones) obtained from Step 6 was called “28% ester SWNT/PMMA_Ext of Example BB11”.
Composite BB11.2 In step 1, 7 mg of Tuball was added as a control sample. The resulting composite material (dog bones) obtained from step 6 was called “Tuball SWNT/PC_Ext of Example BB11”.

Neat PMMA BB11.3 In step 1, no SWNT-ML complex was added. The resulting composite material (dog bones) obtained from step 6 was called “Neat PMMA of Example BB11”.

Mechanical characterization of extruded SWNT-ML/PMMA composites was conducted by tensile test measurements. Summary of Young's modulus and tensile strength data is shown

| | Young's | Maximum |
|---|---|---|
| | Modulus | tensile strength |
| Composite | (MPa) | (MPa) |
| neat PMMA_Ext | 3170 | 48.35 |
| 28% ester SWNT/PMMA_Ext | 3266 | 69.59 |
| Tuball SWNT/PMMA_Ext | 2729 | 58.91 |

The total concentration of the filler in the composites is 0.1%. The percentage shown corresponds to the functionalization of the SWNT-ML.

An increase of almost 100 MPa in Young's modulus is obtained at very low loading for the ester SWNT/PMMA composite with respect to the neat polymer, whereas a detrimental effect is observed for Tuball.

### Example BB12 Composites Comprising Polycarbonate/Polymethylmethacrylate Blends and SWNT-ML Complexes Prepared Via Shear Mixing

This example describes the preparation of PC/PMMA blend nanotube composites with methylalcohol SWNTs-ML via shear mixing employing the dispersion tool ULTRA-TURRAX T 25.

Commercial polycarbonate, abbreviated PC (Good Fellow, SKU CT30-GL-000110) and polymethylmethacrylate, abbreviated PMMA (Sigma-Aldrich, SKU 182265) were used as host polymer matrixes.

SWNT-ML/PC composites were prepared by the following steps.
Step 1. An appropriate amount (see specific amount hereunder) of SWNT-ML complex and different % weight/% weight ratios (see specific amount hereunder) of commercial PC and PMMA were placed into a 50 mL glass jacketed cell.
Step 2. The glass jacketed cell was connected with tubing to water supply to cool the cell, in order to avoid the evaporation of the solvent in the cell.
Step 3. 25 mL of chloroform and 3 mg of SnCl₃ were added to the mixture and the dispersion tool was operated at 3,000 rpm for 2 hr.
Step 4. The SWNT-ML/PMMA composite was retrieved by pouring out the mixture into a 500 mL beaker containing 300 mL of isopropanol.
Step 5. The precipitated composite was placed in a Teflon container and dried in the oven at 80° C. overnight to evaporate the solvent.

Then the SWNT-ML/PMMA composites were shaped into rectangles following the procedure described in Example BB2.

14 different methylalcohol SWNT-ML composites with different % weight ratios of PC/PMMA (composites BB12.1-BB12.12) and 4 PC/PMMA control samples with different % weight ratios (neat PC/PMMA composites B12.13-B12.16) were prepared following the protocol mentioned immediately above (Steps 1-5), with the following changes:
Composite BB12.1 In Step 1, 3.89 mg of “Prep 1: 23% Methyl Alcohol MINT of Example BB1” were added to a mixture of 2700 g of PC and 300 mg of PMMA. The resulting composite material (rectangles) obtained from Step 4 was called “23% methyl alcohol C0.1 SWNT-PC/PMMA90/10 of Example BB12”.
Composite BB12.2 In Step 1, 19.48 mg of “Prep 1: 23% Methyl Alcohol MINT of Example B1E” were added to a mixture of 2700 g of PC and 300 mg of PMMA. The resulting composite material (rectangles) obtained from Step 4 was called “23% methyl alcohol C0.5 SWNT-PC/PMMA90/10 of Example BB12”.
Composite BB12.3 In Step 1, 38.96 mg of “Prep 1: 23% Methyl Alcohol MINT of Example E1E” were added to a mixture of 2700 g of PC and 300 mg of PMMA. The resulting composite material (rectangles) obtained from Step 4 was called “23% methyl alcohol C1.0 SWNT-PC/PMMA90/10 of Example BB12”.
Composite BB12.4 In Step 1, 3.89 mg of “Prep 1: 23% Methyl Alcohol MINT of Example E1E” were added to a mixture of 2400 g of PC and 600 mg of PMMA. The resulting composite material (rectangles) obtained from Step 4 was called “23% methyl alcohol C0.1 SWNT-PC/PMMA80/20 of Example BB12”.
Composite BB12.5 In Step 1, 19.48 mg of “Prep 1: 23% Methyl Alcohol MINT of Example E1E” were added to a mixture of 2400 g of PC and 600 mg of PMMA. The resulting composite material (rectangles) obtained from Step 4 was called “23% methyl alcohol C0.5 SWNT-PC/PMMA80/20 of Example BB12”.
Composite BB12.6 In Step 1, 38.96 mg of “Prep 1: 23% Methyl Alcohol MINT of Example E1E” were added to a mixture of 2400 g of PC and 600 mg of PMMA. The resulting composite material (rectangles) obtained from Step 4 was called “23% methyl alcohol C1.0 SWNT-PC/PMMA80/20 of Example BB12”.
Composite BB12.7 In Step 1, 3.89 mg of “Prep 1: 23% Methyl Alcohol MINT of Example E1E” were added to a mixture of 2100 g of PC and 900 mg of PMMA. The resulting composite material (rectangles) obtained from Step 4 was called “23% methyl alcohol C0.1 SWNT-PC/PMMA70/30 of Example BB12”.
Composite BB12.8 In Step 1, 19.48 mg of “Prep 1: 23% Methyl Alcohol MINT of Example BB1” were added to a mixture of 2100 g of PC and 900 mg of PMMA. The resulting composite material (rectangles) obtained from Step 4 was called “23% methyl alcohol C0.5 SWNT-PC/PMMA70/30 of Example BB12”.
Composite BB12.9 In Step 1, 38.96 mg of “Prep 1: 23% Methyl Alcohol MINT of Example B1E” were added to a mixture of 2100 g of PC and 900 mg of PMMA. The resulting composite material (rectangles) obtained from Step 4 was called “23% methyl alcohol C1.0 SWNT-PC/PMMA70/30 of Example BB12”.
Composite BB12.10 In Step 1, 3.89 mg of “Prep 1: 23% Methyl Alcohol MINT of Example E1E” were added to a mixture of 1500 g of PC and 1500 mg of PMMA. The resulting composite material (rectangles) obtained from Step 4 was called “23% methyl alcohol C0.1 SWNT-PC/PMMA50/50 of Example BB12”.
Composite BB12.11 In Step 1, 19.48 mg of “Prep 1: 23% Methyl Alcohol MINT of Example E1E” were added to a mixture of 1500 g of PC and 1500 mg of PMMA. The resulting composite material (rectangles) obtained from Step 4 was called “23% methyl alcohol C0.5 SWNT-PC/PMMA50/50 of Example BB12”.
Composite BB12.12 In Step 1, 38.96 mg of “Prep 1: 23% Methyl Alcohol MINT of Example E1E” were added to a mixture of 1500 g of PC and 1500 mg of PMMA. The resulting composite material (rectangles) obtained from Step 4 was called “23% methyl alcohol C1.0 SWNT-PC/PMMA50/50 of Example BB12”.
Neat PC/PMMA composite BB12.13 In step 1, no SWNT-ML was added and the polymer mixture comprised 2700 g of PC and 300 mg of PMMA. The resulting polymer material (rectangles) obtained from step step 5 was called “Neat PC/PMMA90/10 of Example BB12”.
Neat PC/PMMA composite BB12.14 In step 1, no SWNT-ML was added and the polymer mixture comprised 2400 g of PC and 600 mg of PMMA. The resulting polymer material (rectangles) obtained from step step 5 was called “Neat PC/PMMA80/20 of Example BB12”.
Neat PC/PMMA composite BB12.15 In step 1, no SWNT-ML was added and the polymer mixture comprised 2100 g of PC and 900 mg of PMMA. The resulting polymer material (rectangles) obtained from step step 5 was called “Neat PC/PMMA70/30 of Example BB12”.
Neat PC/PMMA composite BB12.16 In step 1, no SWNT-ML was added and the polymer mixture comprised 1500 g of PC and 1500 mg of PMMA. The resulting polymer material (rectangles) obtained from step step 5 was called “Neat PC/PMMA50/50 of Example BB12”.

Mechanical characterization of SWNT-ML/PC/PMMA was conducted by dynamic mechanical analysis (DMA) measurements. Summary of storage moduli as a function of SWNT-ML concentration is shown in the table below.

| | SWNT-ML | Storage |
|---|---|---|
| Composite | concentration | Modulus |
| (% wt/% wt) | (%) | (MPa) |
| PC/PMMA 90/10 | 0 | 2365.13 |
| | 0.1 | 2091.24 |
| | 0.5 | 2253.66 |
| | 1 | 2200.87 |
| PC/PMMA 80/20 | 0 | 2236.39 |
| | 0.1 | 2138.89 |
| | 0.5 | 2082.13 |
| | 1 | 2499.48 |
| PC/PMMA 70/30 | 0 | 2435.61 |
| | 0.1 | 2429.20 |
| | 0.5 | 2451.09 |
| | 1 | 2723.34 |
| PC/PMMA 50/50 | 0 | 2457.91 |
| | 0.1 | 2591.09 |
| | 0.5 | 2666.77 |
| | 1 | 2684.34 |

All composites were prepared with methyl alcohol SWNT-ML as filler.

The addition of methyl alcohol SWNT-ML in polymer blends with PC/PMMA % wt ratios of 90/10 and 80/20 does not improve the storage modulus of the composite, but only at a moderate 1% loading for the 80/20 showing an increase of 135 MPa. On the other hand, for the blend prepared at equal ratios of 50/50 PC/PMMA, a storage modulus 2591 MPa with only 0.1% filler concentration.

### Example BB13 Composites Comprising Nylon 6,6 and SWNT-ML Complexes Prepared Via Microcompounding

This example describes the preparation of Nylon 6,6 composites with different SWNTs-ML mixed in the melt state using a Xplore MC 15 twin screw microcompounder (FIG. 16).

Commercial Nylon 6,6 pellets (Sigma-Aldrich, SKU 429201) was used as host polymer matrix.

SWNT-ML/Nylon 6,6 composites were prepared by the following steps.
Step 1. An appropriate amount (see specific amount hereunder) of SWNT-ML complex and 5 g of Nylon 6,6 were placed in a sample holder.
Step 2. The microcompounder chamber was heated up at 290° C. with a twin screw rotational speed of 100 rpm and a maximum torque of 10 N-m. Once the chamber reached the set temperature, the Nylon 6,6 pellets and SWNT-ML mixture was introduced into the chamber and left to mix for 5 min.
Step 3. The chamber was opened and the Nylon 6,6/SWNT-ML composite was extruded from the microcompounder nozzle and collected.
Step 4. The extruded SWNT-ML/Nylon 6,6 composites were shaped into dogbones following the procedure described in Example BB2.

8 Nylon 6,6/SWNT-ML composites (composites B13.1-B13.8) and a neat Nylon 6,6 control sample (neat Nylon 6,6 B13.9) were prepared following the protocol mentioned immediately above (Steps 1-4), with the following changes:
Composite BB13.1 In Step 1, 6.94 mg of “Prep A: 28% pyrene MINT of Example BB1” were added. The resulting composite material (dog bones) was called “28% pyrene SWNT/Nylon 6,6 of Example BB13”.
Composite BB13.2 In Step 1, 5.88 mg of “Prep G: 15% Acid MINT of Example BB1” were added. The resulting composite material (dog bones) obtained from step 3 was called “15% Acid SWNT/Nylon 6,6 of Example BB13”.
Composite BB13.3 In Step 1, 6.94 mg of “Prep K: 28% chain MINT of Example B1E” were added. The resulting composite material (dog bones) obtained from step 3 was called “28% chain SWNT/Nylon 6,6 of Example BB13”.
Composite BB13.4 In Step 1, 6.57 mg of “Prep L: 24% glycol MINT of Example BB1” added.

The resulting composite material (dog bones) obtained from step 3 was called “24% glycol SWNT/Nylon 6,6 of Example BB13”.
Composite BB13.5 In Step 1, 6.94 mg of “Prep E: 28% fluorenone MINT of Example BB1” were added. The resulting composite material (dog bones) obtained from step 3 was called “28% fluorenone SWNT/Nylon 6,6 of Example BB13”.
Composite BB13.6 In Step 1, 6.94 mg of “Prep H: 28% ester MINT of Example BB1” were added. The resulting composite material (dog bones) obtained from Step 5 was called “28% ester SWNT/Nylon 6,6 of Example BB13”.
Composite BB13.7 In Step 1, 6.49 mg of “Prep I: 23% Methyl Alcohol MINT of Example E1E” were added. The resulting composite material (dog bones) obtained from Step 5 was called “23% methyl alcohol SWNT/Nylon 6,6 of Example BB13”.
Composite BB13.8 In step 1, 5 mg of Tuball (from OCSiAl) was added instead of the SWNT-ML complexes. The resulting composite material (dog bones) obtained from Step 5 was called “Tuball SWNT/Nylon 6,6 of Example BB13”.
Neat Nylon 6,6 BB13.9 In step 1, no SWNT-ML complex was added. The resulting polymer material (dog bones) obtained from step 5 was called “Neat Nylon 6,6 of Example BB13”.

Mechanical characterization of extruded SWNT-ML/Nylon 6,6 composites was conducted by tensile test measurements. Summary of Young's modulus and tensile strength data is shown in the table below.

| | | | Maximum |
|---|---|---|---|
| | SWNT-ML | Young's | tensile |
| | concentration | Modulus | strength |
| Composite | (%) | (MPa) | (MPa) |
| Neat Nylon 6,6 | 0.1 | 2879.42 | 81.11 |
| Tuball/Nylon 6,6 | 0.1 | 2659.22 | 72.56 |
| Pyrene/Nylon 6,6 | 0.1 | 2498.38 | 74.64 |
| Acid/Nylon 6,6 | 0.1 | 2403.58 | 78.89 |
| Chain/Nylon 6,6 | 0.1 | 2486.09 | 67.82 |
| Glycol/Nylon 6,6 | 0.1 | 2539.88 | 79.21 |
| Fluorenone/Nylon 6,6 | 0.1 | 2400.46 | 65.68 |
| Ester/Nylon 6,6 | 0.1 | 2810.45 | 87.32 |
| Methylalcohol/Nylon 6,6 | 0.1 | 2644.53 | 81.21 |

The Young's moduli Nylon 6,6 composites containing SWNT-ML are lower compared to the neat polymer, however the tensile strength of the composite prepared with ester SWNT-ML exhibits the highest value.

### Example BB14 Composites Comprising Nylon 6 and SWNT-ML Complexes Prepared Via Microcompounding

This example describes the preparation of Nylon 6 composites with SWNTs-ML mixed in the melt state using a Xplore MC 15 twin screw microcompounder.

Commercial Nylon 6 pellets (Sigma-Aldrich, SKU 181110) was used as host polymer matrix.

Nylon 6/SWNT-ML composites were prepared by the following steps.
Step 1. An appropriate amount (see specific amount hereunder) of SWNT-ML complex and 5 g of Nylon 6 were placed in a sample holder.
Step 2. The microcompounder chamber was heated up at 255° C. with a twin screw rotational speed of 100 rpm and a maximum torque of 10 N-m. Once the chamber reached the set temperature, the Nylon 6 pellets and SWNT-ML mixture was introduced into the chamber and left to mix for 5 min.
Step 3. The chamber was opened and the Nylon 6/SWNT-ML composite was extruded from the microcompounder nozzle and collected.
Step 4. The extruded SWNT-ML/Nylon 6 composites were shaped into dogbones following the procedure described in Example BB2.

10 Nylon 6/SWNT-ML composites (composites B14.1-B14.10) and a neat Nylon 6 control sample (neat Nylon 6 B14.11) were prepared following the protocol mentioned immediately above (Steps 1-4), with the following changes:
Composite BB14.1 In Step 1, 6.49 mg of “Prep I: 23% Methyl Alcohol MINT of Example BB1” were added. The resulting composite material (dog bones) obtained from Step 5 was called “23% methyl alcohol SWNT C0.1/Nylon 6 of Example BB14”.
Composite BB14.2 In Step 1, 32.45 mg of “Prep 1: 23% Methyl Alcohol MINT of Example B1E” were added. The resulting composite material (dog bones) obtained from Step 5 was called “23% methyl alcohol SWNT C0.5/Nylon 6 of Example BB14”.
Composite BB14.3 In Step 1, 64.9 mg of “Prep I: 23% Methyl Alcohol MINT of Example E1E” were added. The resulting composite material (dog bones) obtained from Step 5 was called “23% methyl alcohol SWNT C1.0/Nylon 6 of Example BB14”.
Composite BB14.4 In Step 1, 129.8 mg of “Prep 1: 23% Methyl Alcohol MINT of Example E1E” were added. The resulting composite material (dog bones) obtained from Step 5 was called “23% methyl alcohol SWNT C2.0/Nylon 6 of Example BB14”.
Composite BB14.5 In Step 1, 324.5 mg of “Prep 1: 23% Methyl Alcohol MINT of Example E1E” were added. The resulting composite material (dog bones) obtained from Step 5 was called “23% methyl alcohol SWNT C5.0/Nylon 6 of Example BB14”.
Composite BB14.6 In step 1, 5 mg of Tuball (from OCSiAl) was added instead of the SWNT-ML complexes. The resulting composite material (dog bones) obtained from Step 5 was called “Tuball SWNT C0.1/Nylon 6 of Example BB14”.
Composite BB14.7 In step 1, 25 mg of Tuball (from OCSiAl) was added instead of the SWNT-ML complexes. The resulting composite material (dog bones) obtained from Step 5 was called “Tuball SWNT C0.5/Nylon 6 of Example BB14”.
Composite BB14.8 In step 1, 50 mg of Tuball (from OCSiAl) was instead of the SWNT-ML complexes. The resulting composite material (dog bones) obtained from Step 5 was called “Tuball SWNT C1.0/Nylon 6 of Example BB14”.
Composite BB14.9 In step 1, 100 mg of Tuball (from OCSiAl) was added instead of the SWNT-ML complexes. The resulting composite material (dog bones) obtained from Step 5 was called “Tuball SWNT C2.0/Nylon 6 of Example BB14”.
Composite BB14.10 In step 1, 250 mg of Tuball (from OCSiAl) was added instead of the SWNT-ML complexes. The resulting composite material (dog bones) obtained from Step 5 was called “Tuball SWNT C5.0/Nylon 6 of Example BB14”.

Neat Nylon 6 BB14.11 In step 1, no SWNT-ML complex was added. The resulting polymer material (dog bones) obtained from step 5 as called “Neat Nylon 6 of Example BB14”.

Mechanical characterization of extruded SWNT-ML/Nylon 6 composites was conducted by tensile test measurements. Summary of Young's modulus and tensile strength data is shown in the table below.

| | SWNT-ML | Young's | Maximum |
|---|---|---|---|
| | concentration | Modulus | tensile strength |
| Composite | (%) | (MPa) | (MPa) |
| Neat Nylon 6 | 0 | 2380.86 | 57.17 |
| Tuball/Nylon 6 | 0.1 | 2400.47 | 62.87 |
| | 0.5 | 2615.15 | 72.2 |
| | 1 | 2850.63 | 68.16 |
| | 2 | 2817.12 | 72.13 |
| | 5 | 2819.78 | 61.57 |
| Methylalcohol/Nylon 6 | 0.1 | 2681.63 | 61.79 |
| | 0.5 | 2508.95 | 63.45 |
| | 1 | 2811.96 | 69.1 |
| | 2 | 2669.92 | 62.99 |
| | 5 | 2353.76 | 47.8 |

Nylon 6 composites prepared with methyl alcohol SWNT-ML at a concentration of 0.1% exhibits a Young's modulus 281 MPa higher than that for Tuball at the same concentration. The tensile strength of Tuball and methylalcohol composites at such low loading remain around 62 MPa which is slightly higher than the neat polymer. At higher loadings, Tuball composites show better reinforcement compared to the methyl alcohol ones.

### Example BB15 Composites Comprising PP/PPgMA and SWNT-ML Complexes Prepared Via Microcompounding

This example describes the preparation of PP/PPgMA composites with SWNTs-ML mixed in the melt state using a Xplore MC 15 twin screw microcompounder.

Commercial polypropylene pellets (abbreviated PP, Lyondellbasell) and polypropylene-graft-maleic anhydride pellets (abbreviated PPgMA, Sigma-Aldrich, SKU 427845) were used as host polymer matrixes.

SWNT-ML/PP/PPgMA composites were prepared by the following steps.
Step 1. An appropriate amount (see specific amount hereunder) of SWNT-ML complex was added to a mixture containing 2.5 g of PP, 2.5 g of PPgMA and 10 mg of 4-dimethylaminopyridine, and placed in a sample holder.
Step 2. The microcompounder chamber was heated up at 190° C. with a twin screw rotational speed of 100 rpm and a maximum torque of 15 N-m. Once the chamber reached the set temperature, the PP/PPgMA pellets and SWNT-ML mixture was introduced into the chamber and left to mix for 5 min.
Step 3. The chamber was opened and the PP/PPgMA/SWNT-ML composite was extruded from the microcompounder nozzle and collected.
Step 4. The extruded PP/PPgMA/SWNT-ML/composites were shaped into dogbones following the procedure described in Example BB2.

6 PP/PPgMA/SWNT-ML composites (composites B15.1-B15.6) and a neat PP/PPgMA control sample (neat PP/PPgMA B15.7) were prepared following the protocol mentioned immediately above (Steps 1-4), with the following changes:
Composite BB15.1 In Step 1, 6.49 mg of “Prep I: 23% Methyl Alcohol MINT of Example BB1” were added. The resulting composite material (dog bones) obtained from Step 5 was called “23% methyl alcohol SWNT C0.1/PP/PPgMA of Example BB15”.
Composite BB15.2 In Step 1, 32.45 mg of “Prep 1: 23% Methyl Alcohol MINT of Example B1E” were added. The resulting composite material (dog bones) obtained from Step 5 was called “23% methyl alcohol SWNT C0.5/PP/PPgMA of Example BB15”.
Composite BB15.3 In Step 1, 64.9 mg of “Prep I: 23% Methyl Alcohol MINT of Example E1E” were added. The resulting composite material (dog bones) obtained from Step 5 was called “23% methyl alcohol SWNT C1.0/PP/PPgMA of Example BB15”.
Composite BB15.4 In step 1, 5 mg of Tuball (from OCSiAl) was added as a control sample.

The resulting composite material (dog bones) obtained from Step 5 was called “Tuball SWNT C0.1/PP/PPgMA of Example BB15”.

Composite BB5.5 In step 1, 25 mg of Tuball (from OCSiAl) was added as a control sample.

The resulting composite material (dog bones) obtained from Step 5 was called “Tuball SWNT C0.5/PP/PPgMA of Example BB15”.
Composite BB15.6 In step 1, 50 mg of Tuball (from OCSiAl) was instead of the SWNT-ML complexes. The resulting composite material (dog bones) obtained from Step 5 was called “Tuball SWNT C1.0/PP/PPgMA of Example BB15”.
Neat PP/PPgMA BB15.7 In step 1, no SWNT-ML complex was added. The resulting polymer material (dog bones) obtained from step 5 was called “Neat PP/PPgMA of Example BB15”.

Mechanical characterization of extruded SWNT-ML/PP/PPgMA composites was conducted by tensile test measurements. Summary of Young's modulus and tensile strength data is shown in the table below.

Composite

| | SWNT-ML | Young's | Maximum |
|---|---|---|---|
| | concentration | Modulus | tensile strength |
| | (%) | (MPa) | (MPa) |
| Neat PP/PPgMA | 0 | 1465.78 | 19.02 |
| Tuball/PP/PPgMA | 0.1 | 1445.55 | 14.40 |
| | 0.5 | 1485.58 | 13.11 |
| | 1 | 1426.38 | 14.64 |
| Methylalcohol/PP/PPgMA | 0.1 | 1452.80 | 21.92 |
| | 0.5 | 1366.92 | 11.43 |
| | 1 | 1419.69 | 10.62 |

The Young's moduli of Tuball and methylalcohol composites remain in the same range as that for the neat polymer. In terms of tensile strength, the composite prepared at a 0.1% concentration of methylalcohol SWNT-ML shows an increase of 1.15%.

### Example BB16 Composites Comprising PVDF and SWNT-ML Complexes Prepared Via Microcompounding

This example describes the preparation of PVDF composites with SWNTs-ML mixed in the melt state using a Xplore MC 15 twin screw microcompounder.

Commercial polyvinylidene fluoride powder, abbreviated PVDF (Alfa Aesar, SKU 44080.36) was used as host polymer matrix.

PVDF/SWNT-ML composites were prepared by the following steps.
Step 1. An appropriate amount (see specific amount hereunder) of SWNT-ML complex and 5 g of PVDF were placed in a sample holder.
Step 2. The microcompounder chamber was heated up at 185° C. with a twin screw rotational speed of 100 rpm and a maximum torque of 15 N-m. Once the chamber reached the set temperature, the PVDF and SWNT-ML mixture was introduced into the chamber and left to mix for 5 min.
Step 3. The chamber was opened and the PVDF/SWNT-ML composite was extruded from the microcompounder nozzle and collected.
Step 4. The extruded PVDF/SWNT-ML composites were shaped into dogbones following the procedure described in Example BB2.

12 PVDF/SWNT-ML composites (composites B16.1-B16.12) and a neat PVDF control sample (neat PVDF B16.13) were prepared following the protocol mentioned immediately above (Steps 1-4), with the following changes:
Composite BB16.1 In Step 1, 6.94 mg of “Prep A: 28% pyrene MINT of Example BB1” were added. The resulting composite material (dog bones) was called “28% pyrene SWNT C0.1/PVDF of Example BB16”.
Composite BB16.2 In Step 1, 34.7 mg of “Prep A: 28% pyrene MINT of Example B1E” were added. The resulting composite material (dog bones) was called “28% pyrene SWNT C0.5/PVDF of Example BB16”.
Composite BB16.3 In Step 1, 69.40 mg of “Prep A: 28% pyrene MINT of Example BB1” were added. The resulting composite material (dog bones) was called “28% pyrene SWNT C1.0/PVDF of Example BB16”.
Composite BB16.4 In Step 1, 6.49 mg of “Prep I: 23% Methyl Alcohol MINT of Example B1E” were added. The resulting composite material (dog bones) obtained from Step 5 was called “23% methyl alcohol SWNT C0.1/PVDF of Example BB16”.
Composite BB16.5 In Step 1, 32.45 mg of “Prep 1: 23% Methyl Alcohol MINT of Example B1E” were added. The resulting composite material (dog bones) obtained from Step 5 was called “23% methyl alcohol SWNT C0.5/PVDF of Example BB16”.
Composite BB16.6 In Step 1, 64.9 mg of “Prep I: 23% Methyl Alcohol MINT of Example E1E” were added. The resulting composite material (dog bones) obtained from Step 5 was called “23% methyl alcohol SWNT C1.0/PVDF of Example BB16”.
Composite BB16.7 In Step 1, 6.57 mg of “Prep L: 24% glycol MINT of Example BB1” added.

The resulting composite material (dog bones) obtained from step 3 was called “24% glycol SWNT C0.1/PVDF of Example BB16”.
Composite BB16.8 In Step 1, 32.85 mg of “Prep L: 24% glycol MINT of Example BB1” added. The resulting composite material (dog bones) obtained from step 3 was called “24% glycol SWNT C0.5/PVDF of Example BB16”.
Composite BB16.9 In Step 1, 65.7 mg of “Prep L: 24% glycol MINT of Example BB1” added.

The resulting composite material (dog bones) obtained from step 3 was called “24% glycol SWNT C1.0/PVDF of Example BB16”.
Composite BB16.10 In step 1, 5 mg of Tuball (from OCSiAl) was added instead of the SWNT-ML complexes. The resulting composite material (dog bones) obtained from Step 5 was called “Tuball SWNT C0.1/PVDF of Example BB16”.
Composite BB16.11 In step 1, 25 mg of Tuball (from OCSiAl) was added instead of the SWNT-ML complexes. The resulting composite material (dog bones) obtained from Step 5 was called “Tuball SWNT C0.5/PVDF of Example BB16”.
Composite BB16.12 In step 1, 50 mg of Tuball (from OCSiAl) was added instead of the SWNT-ML complexes. The resulting composite material (dog bones) obtained from Step 5 was called “Tuball SWNT C1.0/PVDF of Example BB16”.
Neat PVDF BB16.13 In step 1, no SWNT-ML complex was added. The resulting polymer material (dog bones) obtained from step 5 was called “Neat PVDF of Example BB16”.

Mechanical characterization of extruded SWNT-ML/PVDF composites was conducted by tensile test measurements. Summary of Young's modulus and tensile strength data is shown in the table below.

| | SWNT-ML | Young's | Maximum |
|---|---|---|---|
| | concentration | Modulus | tensile strength |
| Composite | (%) | (MPa) | (MPa) |
| neat PVDF | 0 | 1176.58 | 43.48 |
| Tuball/PVDF | 0.1 | 1273.40 | 46.67 |
| | 0.5 | 1276.00 | 44.50 |
| | 1 | 1446.82 | 45.19 |
| Pyrene/PVDF | 0.1 | 1134.80 | 43.34 |
| | 0.5 | 1384.45 | 45.21 |
| | 1 | 1480.83 | 46.50 |
| Methylalcohol/PVDF | 0.1 | 1182.95 | 43.82 |
| | 0.5 | 1245.64 | 46.07 |
| | 1 | 1429.02 | 45.61 |
| Glycol/PVDF | 0.1 | 1193.56 | 43.53 |
| | 0.5 | 1320.13 | 44.29 |
| | 1 | 1336.08 | 44.88 |

The highest Young's modulus at a 0.1% loading is that for the Tuball composite showing an increase of about 100 MPa with respect to the neat polymer. However, the lowest reinforcement at such low concentration is for the methylalcohol SWNT-ML composite showing only a −7 MPa increase. On the other hand, at filler concentrations of 0.5% and 1%, the pyrene/PVDF composites exhibit the best reinforcement in Young's moduli among composites. The tensile strength properties of the SWNT-ML composites remain similar to that of the neat polymer.

### Example BB17 Composites Comprising ABS and SWNT-ML Complexes Prepared Via Microcompounding

This example describes the preparation of ABS composites with SWNTs-ML mixed in the melt state using a Xplore MC 15 twin screw microcompounder.

Commercial acrylonitrile butadiene styrene 3D printing filament, abbreviated ABS (3DXTech, SKU ABS1011000WT1) was used as host polymer matrix.

ABS/SWNT-ML composites were prepared by the following steps.
Step 1. An appropriate amount (see specific amount hereunder) of SWNT-ML complex and 5 g of ABS were placed in a sample holder.
Step 2. The microcompounder chamber was heated up at 240° C. with a twin screw rotational speed of 100 rpm and a maximum torque of 15 N-m. Once the chamber reached the set temperature, the PVDF and SWNT-ML mixture was introduced into the chamber and left to mix for 5 min.
Step 3. The chamber was opened and the ABS/SWNT-ML composite was extruded from the microcompounder nozzle and collected.
Step 4. The extruded ABS/SWNT-ML composites were shaped into dogbones following the procedure described in Example BB2.

15 ABS/SWNT-ML composites (composites B17.1-B17.15) and a neat ABS control sample (neat ABS B17.16) were prepared following the protocol mentioned immediately above (Steps 1-4), with the following changes:
Composite BB17.1 In Step 1, 6.94 mg of “Prep A: 28% pyrene MINT of Example BB1” were added. The resulting composite material (dog bones) was called “28% pyrene SWNT C0.1/ABS of Example BB17”.
Composite BB7.2 In Step 1, 34.7 mg of “Prep A: 28% pyrene MINT of Example BB1” were added. The resulting composite material (dog bones) was called “28% pyrene SWNT C0.5/ABS of Example BB17”.
Composite BB7.3 In Step 1, 69.40 mg of “Prep A: 28% pyrene MINT of Example BB1” were added. The resulting composite material (dog bones) was called “28% pyrene SWNT C1.0/ABS of Example BB17”.
Composite BB17.4 In Step 1, 6.49 mg of “Prep I: 23% Methyl Alcohol MINT of Example E1E” were added. The resulting composite material (dog bones) obtained from Step 5 was called “23% methyl alcohol SWNT C0.1/ABS of Example BB17”.
Composite BB17.5 In Step 1, 32.45 mg of “Prep 1: 23% Methyl Alcohol MINT of Example E1E” were added. The resulting composite material (dog bones) obtained from Step 5 was called “23% methyl alcohol SWNT C0.5/ABS of Example BB17”.
Composite BB17.6 In Step 1, 64.9 mg of “Prep 1: 23% Methyl Alcohol MINT of Example E1E” were added. The resulting composite material (dog bones) obtained from Step 5 was called “23% methyl alcohol SWNT C1.0/ABS of Example BB17”.
Composite BB17.7 In Step 1, 6.57 mg of “Prep L: 24% glycol MINT of Example BB1” added.

The resulting composite material (dog bones) obtained from step 3 was called “24% glycol SWNT C0.1/ABS of Example BB17”.
Composite BB17.8 In Step 1, 32.85 mg of “Prep L: 24% glycol MINT of Example BB1” added. The resulting composite material (dog bones) obtained from step 3 was called “24% glycol SWNT C0.5/ABS of Example BB17”.
Composite BB17.9 In Step 1, 65.7 mg of “Prep L: 24% glycol MINT of Example BB1” added.

The resulting composite material (dog bones) obtained from step 3 was called “24% glycol SWNT C1.0/ABS of Example BB17”.
Composite BB17.10 In Step 1, 6.94 mg of “Prep K: 28% chain MINT of Example BB1” were added. The resulting composite material (dog bones) obtained from step 3 was called “28% chain SWNT C0.1/ABS of Example BB17”.
Composite BB17.11 In Step 1, 34.72 mg of “Prep K: 28% chain MINT of Example BB1” were added. The resulting composite material (dog bones) obtained from step 3 was called “28% chain SWNT C0.5/ABS of Example BB7”.
Composite BB7.12 In Step 1, 69.44 mg of “Prep K: 28% chain MINT of Example BB1” were added. The resulting composite material (dog bones) obtained from step 3 was called “28% chain SWNT C1.0/ABS of Example BB7”.
Composite BB7.13 In step 1, 5 mg of Tuball (from OCSiAl) was added instead of the SWNT-ML complexes. The resulting composite material (dog bones) obtained from Step 5 was called “Tuball SWNT C0.1/ABS of Example BB17”.
Composite BB17.14 In step 1, 25 mg of Tuball (from OCSiAl) was added instead of the SWNT-ML complexes. The resulting composite material (dog bones) obtained from Step 5 was called “Tuball SWNT C0.5/ABS of Example BB17”.
Composite BB17.15 In step 1, 50 mg of Tuball (from OCSiAl) was added instead of the SWNT-ML complexes. The resulting composite material (dog bones) obtained from Step 5 was called “Tuball SWNT C1.0/ABS of Example BB17”.
Neat PVDF BB17.16 In step 1, no SWNT-ML complex was added. The resulting polymer material (dog bones) obtained from step 5 was called “Neat ABS of Example BB17”.

Mechanical characterization of extruded SWNT-ML/ABS composites was conducted by tensile test measurements. Summary of Young's modulus and tensile strength data is shown in the table below.

| | SWNT-ML | Young's | Maximum |
|---|---|---|---|
| | concentration | Modulus | tensile strength |
| Composite | (%) | (MPa) | (MPa) |
| neat ABS | 0 | 1706.82 | 34.92 |
| Tuball/ABS | 0.1 | 1663.66 | 35.30 |
| | 0.5 | 1689.12 | 44.38 |
| | 1 | 1928.57 | 42.74 |
| Pyrene/ABS | 0.1 | 1752.00 | 37.09 |
| | 0.5 | 1578.91 | 42.57 |
| | 1 | 1854.35 | 39.22 |
| Methylalcohol/ABS | 0.1 | 1666.34 | 32.81 |
| | 0.5 | 1661.92 | 43.18 |
| | 1 | 1878.02 | 42.24 |
| Glycol/ABS | 0.1 | 1757.63 | 35.43 |
| | 0.5 | 1606.42 | 39.84 |
| | 1 | 1809.10 | 44.61 |
| Chain/ABS | 0.1 | 1570.29 | 40.92 |
| | 0.5 | 1668.54 | 43.62 |
| | 1 | 1788.80 | 42.15 |

In terms of tensile strength, the Chain/ABS composite exhibits the best reinforcement with an increase of ˜6 MPa with respect to the neat polymer at 0.1% loading in both cases. In addition, Pyrene and Glycol composites show an increase of 50 MPa in Young's modulus with respect to the pristine polymer. On the other hand, Tuball, Methylalcohol and Chain composites show a detrimental effect in Young's modulus at 0.1 and 0.5% filler loadings. The best reinforcement at 1% loading is that for the Tuball composite.

### Example CC 1. No Grafting; In Situ Polymerization; CNT Composites by Using Free Radical In Situ Polymerization of Polymethyl Methacrylate (PMMA)

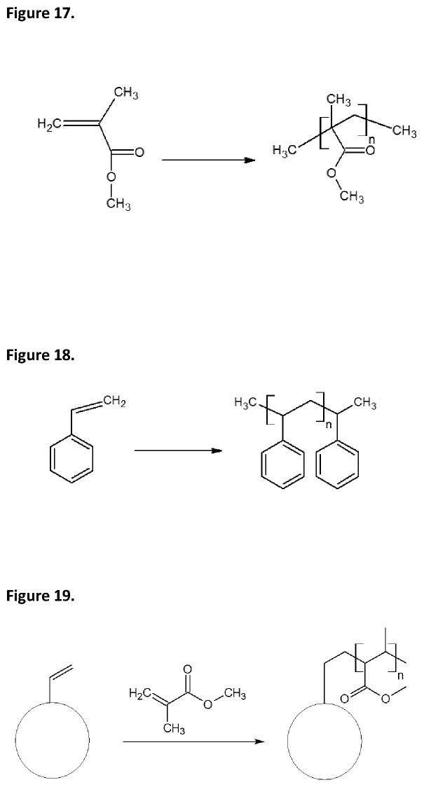

This example describes the preparation of PMMA/CNT composites. The free radical polymerization takes place in a dispersion of either pristine CNT or coated CNT. See FIG. 17.

Methyl methacrylate, abbreviated MMA (Mw=100.12 g/mol, Sigma-Aldrich), was used as monomer. 2,2-Azobis(2-methylpropionitrile), abbreviated AlBN (Mw=164.21/mol, Sigma-Aldrich), was used as free radical initiator.

The composites were prepared by the following steps.
Step 1. For the preparation of the composites comprising ˜0%, ˜0.1%, ˜0.5%, ˜1%, ˜2%, ˜5%, ˜10%, and ˜20% of SWNT, 0 g, 0.02 g, 0.1 g, 0.2 g, 0.4 g, 1 g, 2 g, and 4 g, respectively, of either pristine SWNT (Tuballs, from OCSiAl) or MINTs (pyrene MINTs of Example EE9) were dispersed in 40 mL toluene, using bath sonicator (or magnetic stirrer) at 25° C. for 30 minutes.

The following CNT preparations were added to 40 mL toluene:
Suspension 1: No CNT.
Suspension 2: 0.02 g pristine SWNT (Tuballs)
Suspension 3: 0.1 g pristine SWNT (Tuballs)
Suspension 4: 0.2 g pristine SWNT (Tuballs)
Suspension 5: 0.4 g pristine SWNT (Tuballs)
Suspension 6: 1 g pristine SWNT (Tuballs)
Suspension 7: 2 g pristine SWNT (Tuballs)
Suspension 8: 4 g pristine SWNT (Tuballs)
Suspension 9: The corresponding amount of “pyrene MINTs of Example EE9” to have 0.02 g of SWNT.
Suspension 10: The corresponding amount of “pyrene MINTs of Example EE9” to have 0.1 g of SWNT.
Suspension 11: The corresponding amount of “pyrene MINTs of Example EE9” to have 0.2 g of SWNT.
Suspension 12: The corresponding amount of “pyrene MINTs of Example EE9” to have 0.4 g of SWNT.
Suspension 13: The corresponding amount of “pyrene MINTs of Example EE9” to have 1 g of SWNT.
Suspension 14: The corresponding amount of “pyrene MINTs of Example EE9” to have 2 g of SWNT.
Suspension 15: The corresponding amount of “pyrene MINTs of Example EE9” to have 4 g of SWNT.
Step 2. 20 g of MMA was added, and the mixture was stirred for 30 min more.
Step 3. 200 mg of AlBN was added to the mixture. The mixture was degassed for 25 min by bubbling nitrogen through it.
Step 4. The polymerization was carried out at 65° C. for 20 hours under stirring and nitrogen atmosphere.
Step 5. After the polymerization process, the final composite was precipitated by adding 400 mL isopropanol. After that, the composite was filtered on a cellulose filter, washed with isopropanol and dried.

The resulting composites of the reactions were termed:
“Neat PMMA of Example CC1” (product resulting from suspension 1)
“0.1% Tuballs/PMMA composite of Example CC1” (product resulting from suspension 2)
“0.5% Tuballs/PMMA composite of Example CC1” (product resulting from suspension 3)
“1% Tuballs/PMMA composite of Example CC1” (product resulting from suspension 4)
“2% Tuballs/PMMA composite of Example CC1” (product resulting from suspension 5)
“5% Tuballs/PMMA composite of Example CC1” (product resulting from suspension 6)
“10% Tuballs/PMMA composite of Example CC1” (product resulting from suspension 7)
“20% Tuballs/PMMA composite of Example CC1” (product resulting from suspension 8)
“0.1% pyrene MINT/PMMA composite of Example CC1” (product resulting from suspension 9)
“0.5% pyrene MINT/PMMA composite of Example CC1” (product resulting from suspension 10)
“1% pyrene MINT/PMMA composite of Example CC1” (product resulting from suspension 11)
“2% pyrene MINT/PMMA composite of Example CC1” (product resulting from suspension 12)
“5% pyrene MINT/PMMA composite of Example CC1” (product resulting from suspension 13)
“10% pyrene MINT/PMMA composite of Example CC1” (product resulting from suspension 14)
“20% pyrene MINT/PMMA composite of Example CC1” (product resulting from suspension 15)

The mechanical data obtained are shown in the table immediately below. As may be seen, the addition of pyrene MINTs to PMMA improves both Young's modulus, tensile strength, flexural modulus and storage modulus.

TABLE

| | Young's | | Tensile | | Flexural | | Storage Modulus | |
|---|---|---|---|---|---|---|---|---|
| | Modulus, MPa | | Strength, MPa | | Modulus, MPa | | (25° C.), MPa | |
| | | Pyrene | | Pyrene | | Pyrene | | Pyrene |
| | Tuball | MINTs | Tuball | MINTs | Tuball | MINTs | Tuball | MINTs |
| 0% | 2551 MPa | | 34.2 MPa | | 2230.5 MPa | | 2170.8 MPa | |
| 0.1% | 2592.9 | 2902.7 | 34.0 | 37.3 | 2097.0 | 2596.0 | 2415.28 | 2470.84 |
| 0.5% | 2699.0 | 3190.4 | 38.1 | 51.6 | 2585.9 | 3078.4 | 2848.11 | 3158.47 |
| 1% | 3097.1 | 3355.2 | 40.0 | 49.6 | 2916.5 | 3924.4 | 3202.3 | 3777.48 |
| 2% | 3267.1 | 3870.4 | 28.1 | 47.1 | 3567.2 | 4561.6 | 3311.53 | 3510.50 |
| 5% | 5332.3 | 4878.8 | 40.1 | 38.7 | 4982.6 | 4824.6 | 4778.0 | 3712.5 |
| 10% | 7470.1 | 7276.4 | 44.0 | 31.1 | 5827.9 | 5261.9 | 5840.1 | 5722.7 |
| 20% | 9669.9 | 7608.4 | 54.5 | 33.3 | 6194.6 | 5964.5 | 7985.9 | 5446.4 |

### Example CC 2. No Grafting; In Situ Polymerization; MINTs Composites by Using Free Radical In Situ Polymerization of Polystyrene (PS)

This example describes the preparation of PS/CNT composites. The free radical polymerization takes place in a dispersion of either pristine CNT or coated CNT. See FIG. 18.

Styrene, abbreviated Sty (Mw=104.15 g/mol, Sigma-Aldrich), was used as monomer. 2,2-Azobis(2-methylpropionitrile), abbreviated AlBN (Mw=164.21/mol, Sigma-Aldrich), was used as free radical initiator.

The composites were prepared by the following steps.
Step 1. For the preparation of the composites comprising 470 g of alkene MINT of Example EE9A (22% functionalization) were dispersed in 40 mL toluene, using bath sonicator (or magnetic stirrer) at 25° C. for 30 minutes.
Step 2. 20 g of Sty was added, and the mixture was stirred for 30 min more.
Step 3. 200 mg of AlBN was added to the mixture. The mixture was degassed for 25 min by bubbling nitrogen through it.
Step 4. The polymerization was carried out at 80° C. for 20 hours under stirring and nitrogen atmosphere.
Step 5. After the polymerization process, the final composite was precipitated by adding 400 mL isopropanol. After that, the composite was filtered on a cellulose filter, washed with isopropanol and dried.

The final homogeneous black solid precipitate was called **no grafting 2 wt % alkene MINT-in situ PS composite of example CC 2**.

### Variations to the Above Protocol:

In step 1, Different amounts of alkene MINT of Example EE9A can be used to make composites of different CNT content.

### Example CC 3. Grafting from; Crosslinking; In Situ Polymerization; Alkene MINTs Composites by Using Free Radical In Situ Polymerization of Polymethyl Methacrylate (PMMA)

This example describes the preparation of PMMA/alkene MINTs composites. The free radical polymerization takes place in a dispersion of alkene Mints. The radical formation begins at the alkene group of the U-shape, so the growth of polymer chains begins at the MINT—i.e. this is a grafting from structure. See FIG. 19.

Methyl methacrylate, abbreviated MMA (Mw=100.12 g/mol, Sigma-Aldrich), was used as monomer. 2,2-Azobis(2-methylpropionitrile), abbreviated AlBN (Mw=164.21/mol, Sigma-Aldrich), was used as free radical initiator.

The composites were prepared by the following steps.
Step 1. 0.235 g of alkene MINT of Example EE9A (22% functionalization) were dispersed in 20 mL toluene, using bath sonicator (or magnetic stirrer) at 25° C. for 30 minutes.
Step 2. 200 mg of AlBN was added to the mixture. The temperature is set at 65° C.
Step 3. The mixture was magnetic stirred at 65° C. under N₂ atmosphere for 30 minutes.
Step 4. 10 g of MMA was added, and the mixture was stirred for 30 min more.
Step 5. The polymerization was carried out at 65° C. for 20 hours under stirring and nitrogen atmosphere.
Step 6. After the polymerization process, the final composite was precipitated by adding 200 mL isopropanol. After that, the composite was filtered on a cellulose filter, washed with isopropanol and dried.

The final homogeneous black solid precipitate was called **grafting from 2 wt % alkene MINT-in situ PMMA composite of example CC 3**.

### Variations to the Above Protocol:

In step 1, Different amounts of alkene MINT of Example EE9A can be used to make composites of different CNT content.

### Example CC 4. Grafting from. Crosslinking. In Situ Polymerization. Alkene MINTs Composites by Using Free Radical In Situ Polymerization of Polystyrene (PS)

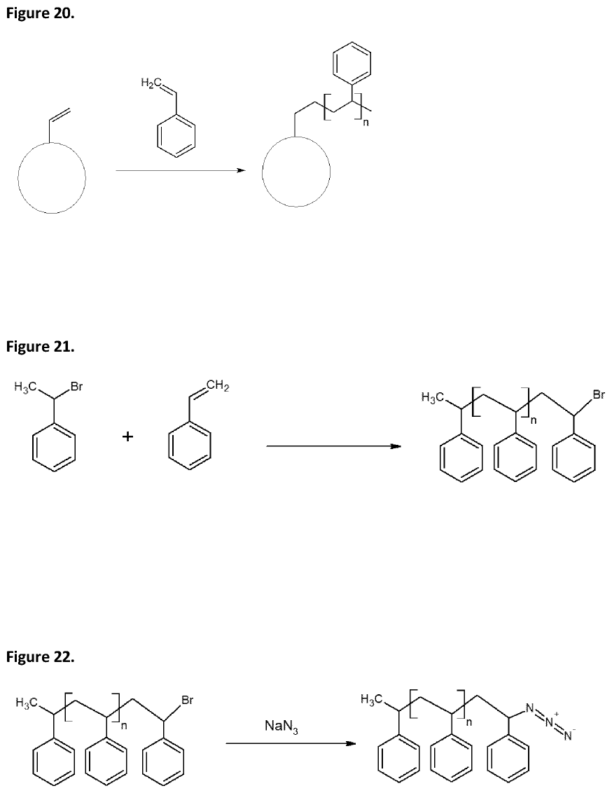

This example describes the preparation of PS/alkene MINTs composites. The free radical polymerization takes place in a dispersion of alkene Mints. The radical formation begins at the alkene group of the U-shape, so the growth of polymer chains begins at the MINT. See FIG. 20.

Styrene, abbreviated Sty (Mw=104.15 g/mol, Sigma-Aldrich), was used as monomer. 2,2-Azobis(2-methylpropionitrile), abbreviated AlBN (Mw=164.21/mol, Sigma-Aldrich), was used as free radical initiator.

The composites were prepared by the following steps.
Step 1. For the preparation of the composites comprising 235 g of alkene MINT of Example EE9A (22% functionalization) were dispersed in 20 mL toluene, using bath sonicator (or magnetic stirrer) at 25° C. for 30 minutes.
Step 2. 200 mg of AlBN was added to the mixture. The temperature is set at 65° C.
Step 3. The mixture was magnetic stirred at 65° C. under N₂ atmosphere for 30 minutes.
Step 4.10 g of Sty was added and the mixture was stirred for 30 min more.
Step 5. The polymerization was carried out at 65° C. for 20 hours under stirring and nitrogen atmosphere.
Step 6. After the polymerization process, the final composite was precipitated by adding 200 mL isopropanol. After that, the composite was filtered on a cellulose filter, washed with isopropanol and dried.

The final homogeneous black solid precipitate was called **grafting from 2 wt % alkene MINT-in situ PS composite of example CC 4**.

### Variations to the Above Protocol:

In step 1, Different amounts of alkene MINT of Example EE9A can be used to make composites of different CNT content.

### Example CC 5. No Grafting. In Situ Polymerization. MINTs Composites by Using In Situ Polycondensation of Polyamide 6 (PA6)

This example describes the preparation of 2 wt % MINT/in situ PA6 composites using different MINTs (Pyrene MINTs, Polyethoxy MINTs, and Acid MINTs). The polycondensation takes place in a dispersion of coated CNT.

ε-caprolactam, (Mw=113.16 g/mol, Sigma-Aldrich), was used as monomer. Aminocaproic acid (Mw=131.17 g/mol, Sigma-Aldrich), was used as initiator.

The composites were prepared by the following steps.
Step 1. 9 g of ε-caprolactam (80 mmol) was melted at 80° C. for one hour under magnetic stirring.
Step 2. For the preparation of the composites comprising 2 wt % of SWNT, 273 mg of “Pyrene MINTs of Example EE9” (26% functionalization) were added to ε-caprolactam solution and the mixture was magnetic stirred at 80° C. for one hour.
Step 3. 1 g of aminocaproic acid was added to the previous mixture. The dispersion was purged with N₂ for 30 minutes under magnetic stirring.
Step 4. The flask was placed in an oil bath set at a temperature of 180° C. for one hour and, after that, 250° C. for 9 hours.
Step 5. The reaction was stopped by cooling the reaction down to room temperature and opening the flask to air.
Step 6. The resultant solid was washed in boiling water to remove remaining monomers.
Step 7. The obtained composites were dried at 80° C. overnight in a vacuum oven. The resulting composite was called no grafting 2% Pyrene MINT-in situ-PA6 composites of Example CC5.
Step 8. The resulting composite was pressed into a film using Atlas™ Series Heated Platens with the 4000 Series High Stability Temperature Controller were used together with the Atlas™ Manual 15 Ton (15 T) Hydraulic Press, all from Specac, Ltd. at 270° C. using minimal pressure. After cooling, a homogenously black film of approximately 0.3 mm was collected.
Step 9. At least three doqbones were cut out from the film in the shape of Type V dogbones as described by ASTM D638.
Step 10. Tensile mechanical properties of Young's Modulus and Tensile strength were collected according to a similar process to that described in Example FF5, except no extensometer was used. The resulting mechanical property measurements are shown in the table below.
Step 11. Steps 1-10 were repeated with no filler (without any Pyrene MINTs of Example EE9) to produce neat in situ-PA6 of Example CC5.
Step 12. Steps 1-10 were repeated with 256 mg of 22% functionalization MINTs made following the procedure outlined in example DD7 replacing Pyrene U-Shape of Example DD6 with Polyethoxy U-Shape of Example DD5 to produce no grafting 2% Polyethoxy MINT-in situ-PA6 composites of Example CC5.
Step 13. Steps 1-10 were repeated with 256 mg acid MINT of Example EE9A (20% functionalization) to produce no grafting 2% Acid MINT-in situ-PA6 composites of Example CC5.
   Young's modulus and tensile strength data from tensile testing experiments for no grafting in situ PA-6-MINT Composite dogbones prepared in Example CC5. Also shows relative increase in modulus and tensile strength for each composite compared to the neat

| | Young's | Relative | | |
|---|---|---|---|---|
| | Modulus | Modulus | Tensile | Relative Tensile |
| Sample | (MPa) | Increase | Strength (Mpa) | Strength Increase |
| Neat in-situ PA6 | 1500 ± 127 | — | 60 ± 8 | — |
| 2 wt % Pyrene | 1548 ± 166 | 3.2 ± 11% | 46 ± 7 | −23.2 ± 11.6% |
| MINT- in-situ PA6 - | | | | |
| no grafting | | | | |
| 2 wt % Polyethoxy | 1810 ± 541 | 20.7 ± 36% | 49 ± 9.5 | −18.3 ± 15.8% |
| MINT- in-situ PA6- | | | | |
| no grafting | | | | |
| 2 wt % Acid MINT- | 2397 ± 293 | 59.8 ± 19.5% | 58 ± 10 | −0.56 ± 16.7% |
| in-situ PA6- no | | | | |
| grafting | | | | |

### Variations to the Above Protocol:

In step 2, Different amounts of Pyrene MINTs of Example EE9 can be used to make composites of different CNT content.
In step 2, Different MINTs using different Ushape chemistries can be used in place of Pyrene MINTs of Example EE9 to make different PA6-MINT composites.

### Example CC 6. Grafting to. Bromine End-Functional Polystyrene

This example describes the preparation of bromine end-functional polystyrene by Atom Transfer Radical Polymerization (ATRP). Styrene, abbreviated Sty (Mw=104.15 g/mol, Sigma-Aldrich), was used as monomer. 2,2′-Bipyridyl, abbreviated bipy (Mw=156.19 g/mol, TCI) was used as ligand. Copper (I) bromide, CuBr, (Mw=143.45 g/mol, Sigma-Aldrich), was used as catalyst. 1-phenyl ethylbromide, abbreviated 1-PEBr (Mw=185.06/mol, Sigma-Aldrich), was used as initiator. See FIG. 21.

The polymer was preparing by the following steps:
Step 1. 15 mL of commercial Sty was passed through basic alumina column to remove inhibitors.
Step 2. 0.144 g of CuBr (1 mmol) and 0.468 g of bipy (3 mmol) were added to a round bottom flask. The flask was sealed with a rubber septum, degassed and backfilled with N₂ 3 times.
Step 3. 11.5 mL of deoxygenated Sty (100 mmol) was added via syringe. The flask was degassed and backfilled with N₂ 3 times.
Step 4. The mixture was magnetic stirred for 20 minutes at room temperature, to form the catalyst complex.
Step 5. The flask was placed in an oil bath set at a temperature of 90° C.
Step 6. 0.14 mL of 1-PEBr was injected into the flask to start the reaction.
Step 7. The reaction was kept under magnetic stirring at 90° C. for 20 hours.
Step 8. The reaction was stopped by cooling the reaction down to room temperature and opening the flask to air.
Step 9. 50 mL of acetone was added to the mixture to dissolve the obtained polymer. The mixture was magnetically stirred for 20 minutes.
Step 10. The mixture was filtered to remove insoluble salts and catalyst remains.
Step 11. The polymer was precipitated by addition of the solution to a large amount (around 300 mL) of cold methanol.
Step 12. The precipitated polymer was filtered and washed with more methanol. Dissolution and precipitation (Steps 9 and 11) were repeated until a white powder was obtained.
Step 13. The precipitated polymer was dried in a vacuum oven at 40° C. until a constant weight was reached.

The conversion of the reaction was 63%. Gel Permeation Chromatography (GPC) results of the obtained polymer estimated that the polymer had a molecular weight in number (Mn) of 6785, and a polydispersity (Mw/Mn) of 1.6.

The resulting dried powder was called “PS—Br of Example CC 6”.

### Variations to the Protocol.

In step 6 different initiators can be used depending on the final structure that is required.
E.g., 1-PEBr can be used as an initiator to obtain monofunctional polystyrene.
To obtain α,ω-difunctional polymers, the following initiators can be used (Coessens, Pintauer, & Matyjaszewski, 2001):
   2-Bromopropionitrile, abbreviated BrPN (Mw=133.97/mol, Sigma-Aldrich)
   ethyl 2-bromoisobutyrate, abbreviated BriB (Mw=195.05/mol, Sigma-Aldrich)
   ethyl 2-bromopropionate, abbreviated EBrP (Mw=181.03/mol, Sigma-Aldrich)

In another experiment, Step 7 was modified to obtain polymers with different molecular weights, by changing the polymerization time:
Polymerization time: 4 h
   (GPC results: Mw=2102 g/mol, Mn=1528 g/mol, Polydispersity=1.4; 1H NMR results: Mw=1832 g/mol). This product was termed “4 h polymerization ATPR polystyrene of Example CC6”
Polymerization time: 20 h
   (GPC results: Mw=10959 g/mol, Mn=6785 g/mol, Polydispersity=1.6; ¹H NMR results: Mw=8765 g/mol). This product was termed “20 h polymerization ATPR polystyrene of Example CC6”

### Example CC 7. Grafting to; Azide End-Functional Polystyrene

This example describes the preparation of azide end-functional polystyrene. Sodium azide, NaN₃ (Mw=65.01 g/mol, Sigma-Aldrich) was used as azidation agent. Dry dimethylformamide (DMF) was used as solvent. See FIG. 22.
Step 1. 1 g of “PS—Br of Example CC 6” (0.149 mmol) was dissolved in 10 mL of dry DMF under magnetic stirring until completely dissolved (around 15 minutes).
Step 2. 19.1 mg of NaN₃ (0.294 mmol) was added little by little.
Step 3. The reaction was maintained under magnetic stirring for 20 hours at room temperature.
Step 4. The resultant solution was poured into 300 mL of cold methanol under rapid magnetic stirring to precipitate the polymer.
Step 5. The obtained polymer was filtered and washed with more methanol to remove DMF remains.
Step 6. The precipitated polymer was dried in a vacuum oven at 40° C. until a constant weight was reached.

The yield of the reaction was close to 100%. FTIR and ¹H NMR confirmed the change of bromine by azide. The resulting dried powder was called “PS—N₃ of Example CC 7”.

### Example CC 8. Grafting to; Amine End-Functional Polystyrene

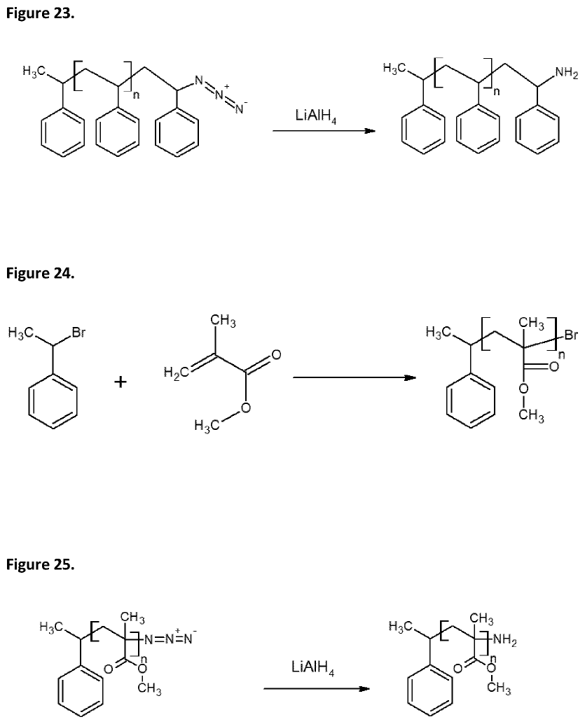

This example describes the preparation of amine end-functional polystyrene by PS—N₃ of Example CC 7. Lithium aluminum hydride (LiAlH₄) solution (1M, in THF) (Mw=37.95 g/mol, Sigma-Aldrich) was used as reduction agent. Dry tetrahydrofuran (THF) was used as solvent. See FIG. 23.
Step 1. 0.488 g of “PS—N₃ of Example CC 7” were dissolved in 5 mL of dry THF. The solution was purged with N₂ for 30 minutes.
Step 2. 0.74 mL of LiAlH₄ solution (0.72 mmol of LiALH₄) was added to a cold round bottom flask (ice bath).
Step 3. The resultant solution of Step 1 was added drop by drop to the prepared solution in the step 2.
Step 4. The reaction was magnetic stirred at 75° C. (reflux) for five hours under N₂ atmosphere.
Step 5. The solution was cooled to room temperature.
Step 6. The reaction was quenched with 10 mL of water and 1 mL of NaOH solution (1M).

After that, the flask was opened to air.
Step 7. 50 mL of water was added to the solution under magnetic stirring to precipitate the polymer.
Step 8. The obtained polymer was filtered and washed with more water to remove salts remains.
Step 9. The precipitated polymer was dried in a vacuum oven at 40° C. until a constant weight was reached.

The yield of the reaction was close to 100%. FTIR and ¹H NMR confirmed the change of azide by amine. The resulting dried powder was called “PS—NH₂ of Example CC 8”.

### Example CC 9. Grafting to. Bromine End-Functional Polymethyl Methacrylate

This example describes the preparation of bromine end-functional polymethyl methacrylate by Atom Transfer Radical Polymerization (ATRP). Methyl methacrylate, abbreviated MMA (Mw=100.12 g/mol, Sigma-Aldrich), was used as monomer. 2,2′-Bipyridyl, abbreviated bipy (Mw=156.19 g/mol, TCI) was used as ligand. Copper (1) bromide, CuBr, (Mw=143.45 g/mol, Sigma-Aldrich), was used as catalyst. (1-Bromoethyl) benzene (Mw=185.06/mol, Sigma-Aldrich), was used as initiator. See FIG. 24.

The polymer was preparing by the following steps:
Step 1. 15 mL of commercial MMA was passed through basic alumina column to remove inhibitors.
Step 2. 0.144 g of CuBr (1 mmol) and 0.468 g of bipy (3 mmol) were added to a round bottom flask. The flask was sealed with a rubber septum, degassed and backfilled with N₂ 3 times.
Step 3. 10.6 g of deoxygenated MMA (100 mmol) was added via syringe. The flask was degassed and backfilled with N₂ 3 times.
Step 4. The mixture was magnetic stirred for 20 minutes at room temperature, to form the catalyst complex.
Step 5. The flask was placed in an oil bath set at a temperature of 90° C.
Step 6. 0.14 mL of deoxygenated (1-Bromoethyl)benzene was injected into the flask to start the reaction.
Step 7. The reaction was kept under magnetic stirring at 90° C. for 2 hours.
Step 8. The reaction was stopped by cooling the reaction down to room temperature and opening the flask to air.
Step 9. 50 mL of acetone was added to the mixture to dissolve the obtained polymer. The mixture was magnetically stirred for 1 hour.
Step 10. The mixture was filtered to remove insoluble salts and catalyst remains.
Step 11. The polymer was precipitated by addition of the solution to a large amount (around 300 mL) of cold methanol.
Step 12. The precipitated polymer was filtered and washed with more methanol. Dissolution and precipitation (Steps 9 and 11) were repeated until a white powder was obtained.
Step 13. The precipitated polymer was dried in a vacuum oven at 40° C. until a constant weight was reached.

The conversion of the reaction was 38%. Gel Permeation Chromatography (GPC) results of the obtained polymer estimated that the polymer had a molecular weight in number (Mn) of 22089, and a polydispersity (Mw/Mn) of 1.3.

The resulting dried powder was called “PMMA-Br of Example CC 9”.

### Example CC 10. Grafting to; Azide End-Functional PMMA

This example describes the preparation of azide end-functional polymethylmethacrylate by PMMA-Br of Example CC 9. Sodium azide, NaN₃ (Mw=65.01 g/mol, Sigma-Aldrich) was used as azidation agent. Dry dimethylformamide (DMF) was used as solvent. See FIG. 25.
Step 1. 0.149 mmol of “PMMA-Br of Example CC 9” was dissolved in 10 mL of dry DMF under magnetic stirring until completely dissolved (around 15 minutes).
Step 2. 191.0 mg of NaN₃ (2.94 mmol) was added little by little.
Step 3. The reaction was maintained under magnetic stirring for 120 hours at room temperature.
Step 4. The resultant solution was poured into 300 mL of cold methanol under rapid magnetic stirring to precipitate the polymer.
Step 5. The obtained polymer was filtered and washed with more methanol to remove DMF remains.
Step 6. The precipitated polymer was dried in a vacuum oven at 40° C. until a constant weight was reached.

The yield of the reaction was close to 100%. FTIR and ¹H NMR confirmed the change of bromine by azide. The resulting dried powder was called “PMMA-N₃ of Example CC 10”.

### Example CC 11. Grafting to; Amine End-Functional PMMA

This example describes the preparation of amine end-functional polystyrene by PMMA-N₃ of Example CC 10. Lithium aluminum hydride (LiAlH₄) solution (1M, in THF) (Mw=37.95 g/mol, Sigma-Aldrich) was used as reduction agent. Dry tetrahydrofuran (THF) was used as solvent.
Step 1. 0.488 g of “PMMA-N₃ of Example CC 10” were dissolved in 5 mL of dry THF. The solution was purged with N₂ for 30 minutes.
Step 2. 0.74 mL of LiAlH₄ solution (0.72 mmol of LiALH₄) was added to a cold round bottom flask (ice bath).
Step 3. The resultant solution of Step 1 was added drop by drop to the prepared solution in the step 2.
Step 4. The reaction was magnetic stirred at 75° C. (reflux) for five hours under N₂ atmosphere.
Step 5. The solution was cooled to room temperature.
Step 6. The reaction was quenched with 10 mL of water and 1 mL of NaOH solution (1M).

After that, the flask was opened to air.
Step 7. 50 mL of water was added to the solution under magnetic stirring to precipitate the polymer.
Step 8. The obtained polymer was filtered and washed with more water to remove salts remains.
Step 9. The precipitated polymer was dried in a vacuum oven at 40° C. until a constant weight was reached.

The yield of the reaction was close to 100%. FTIR confirmed the change of azide by amine. The resulting dried powder was called “PMMA-NH₂ of Example CC 11”.

### Example CC 12. “Click” Chemistry Between Azide End-Functional Polystyrene and Alkyne U-Shapes

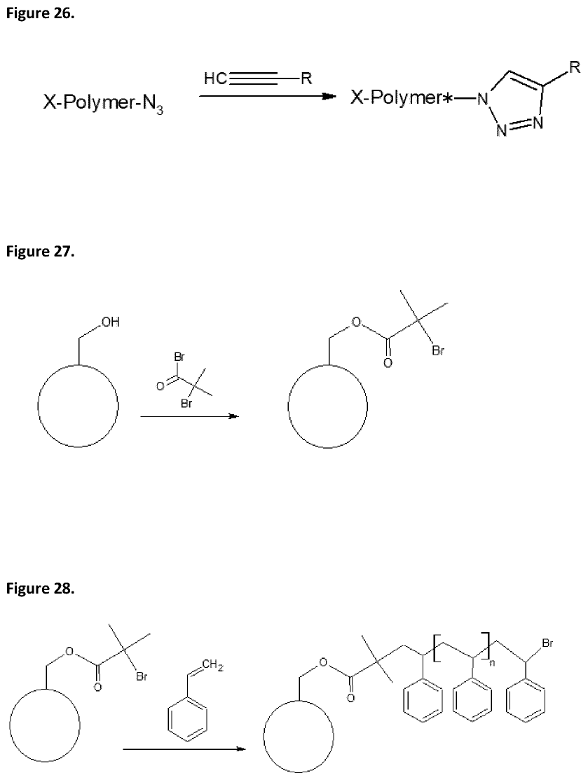

This example describes the reaction between the “PS—N₃ of Example CC 7” and the alkyne U-shapes (Mw=899.23 g/mol) using “Click chemistry”. N,N-Diisopropylethylamine, DIPEA, (Mw=129.24/mol, Sigma-Aldrich), was used as initiator. Copper (1) iodide, CuI, (Mw=190.45/mol, Sigma-Aldrich), was used as catalyst. DMF was used as solvent. See FIG. 26.
Step 1. 2 g of “PS—N₃ of Example CC 7” (0.22 mmol) and 197 mg of alkyne U-shapes were dissolved in 20 mL of DMF by magnetic stirring for 30 minutes. The flask was purged with N₂ for 15 minutes.
Step 2. 38 μL of DIPEA (0.22 mmol) and 42 mg of CuI (0.22 mmol) were added to the solution. The flask was degassed and backfilled with N₂ 3 times.
Step 3. The reaction was magnetic stirred at 60° C. for 20 hours under N₂ atmosphere.
Step 4. The reaction was stopped by cooling the reaction down to room temperature and opening the flask to air.
Step 5. 16 mL of dichloromethane, 10 mL of saturated NaCl deionized water and 1.66 mL of ammonia was added to the solution under magnetic stirring.
Step 6. The resultant product was precipitated in cold water under rapid magnetic stirring.
Step 7. The precipitated solid was filtered washed with water and dried at 60° C. for 24 hours.
Step 8. The dried solid was dissolved in 100 mL of acetone under magnetic stirring for 30 minutes.
Step 9. The solution was filtered to remove the insoluble free U-shapes.
Step 10. The purified product was precipitated by addition of the solution to a large amount (around 300 mL) of cold methanol.
Step 11. The precipitated polymer was filtered and washed with more methanol. Dissolution and precipitation (Steps 8 and 10) were repeated until a white powder was obtained.
Step 12. The precipitated polymer was dried in a vacuum oven at 60° C. until a constant weight was reached.

The resulting dried powder was called “Click PS_U-shape of Example CC 12”.

### Example CC 13. “Click” Chemistry Between Azide End-Functional PMMA and Alkyne U-Shapes

This example describes the reaction between the “PMMA-N₃ of Example CC 10” and the alkyne U-shapes (Mw=899.23 g/mol) using “Click chemistry”. N,N-Diisopropylethylamine, DIPEA, (Mw=129.24/mol, Sigma-Aldrich), was used as initiator. Copper (1) iodide, CuI, (Mw=190.45/mol, Sigma-Aldrich), was used as catalyst. DMF was used as solvent. See FIG. 26.
Step 1. 2 g of “PMMA-N₃ of Example CC 10” (0.22 mmol) and 197 mg of alkyne U-shapes were dissolved in 20 mL of DMF by magnetic stirring for 30 minutes. The flask was purged with N₂ for 15 minutes.
Step 2. 38 μL of DIPEA (0.22 mmol) and 42 mg of CuI (0.22 mmol) were added to the solution. The flask was degassed and backfilled with N₂ 3 times.
Step 3. The reaction was magnetic stirred at 60° C. for 20 hours under N₂ atmosphere.
Step 4. The reaction was stopped by cooling the reaction down to room temperature and opening the flask to air.
Step 5. 16 mL of dichloromethane, 10 mL of saturated NaCl deionized water and 1.66 mL of ammonia was added to the solution under magnetic stirring.
Step 6. The resultant product was precipitated in cold water under rapid magnetic stirring.
Step 7. The precipitated solid was filtered washed with water and dried at 60° C. for 24 hours.
Step 8. The dried solid was dissolved in 100 mL of acetone under magnetic stirring for 30 minutes.
Step 9. The solution was filtered to remove the insoluble free U-shapes.
Step 10. The purified product was precipitated by addition of the solution to a large amount (around 300 mL) of cold methanol.
Step 11. The precipitated polymer was filtered and washed with more methanol. Dissolution and precipitation (Steps 8 and 10) were repeated until a white powder was obtained.
Step 12. The precipitated polymer was dried in a vacuum oven at 60° C. until a constant weight was reached.

The resulting dried powder was called “Click PMMA_U-shape of Example CC 13”.

### Example CC 14. No Grafting; Solution Process; CNT Composites by Using Commercial Polymethyl Methacrylate (PMMA)

This example describes the formation of 1 w % SWNT MINT composites by using commercial PMMA.

Polymethyl methacrylate, abbreviated PMMA was used as polymer.
Step 1234.4 mg of “Pyrene MINTs of Example EE9” (19% functionalization) were dispersed in 40 mL of Toluene under magnetic stirring for 30 minutes at room temperature.
Step 2. 20 g of PMMA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 80° C. for 24 hours. The resulting composite was called no grafting 1% Pyrene MINT-PMMA composites of Example CC14.
Step 6. Dogbone tensile test specimens were prepared using the protocol outlined in Example FF4, with the temperature of the hot press being 180° C.
Step 7. Dogbone tensile test specimens were tested per the protocol outlined in Example FF5.

The resulting mechanical property measurements are shown in the table below.
Step 6. Steps 1-7 were repeated without using any Pyrene MINTs of Example EE9 to make neat PMMA of Example CC14.
   Young's modulus and tensile strength data from tensile testing experiments for no grafting PMMA-Pyrene MINT Composite dogbones prepared in Example CC14. Also shows relative increase in modulus and tensile strength for each composite compared to the neat

| | Young's | Relative | | |
|---|---|---|---|---|
| | Modulus | Modulus | Tensile | Relative Tensile |
| Sample | (MPa) | Increase | Strength (Mpa) | Strength Increase |
| Neat PMMA | 2380 ± 20 | — | 45.3 ± 3.0 | — |
| no grafting 1% | 2985 ± 330 | 25.4 ± 13.9% | 56.2 ± 7.6 | 24.1 ± 16.7% |
| Pyrene MINT - | | | | |
| PMMA | | | | |

### Variations to the Above Protocol:

In step 1, Different amounts of Pyrene MINTs of Example EE9 can be used to make composites of different CNT content.
In step 1, Different MINTs using different Ushape chemistries can be used in place of Pyrene MINTs of Example EE9 to make different PMMA-MINT composites.

### Example CC 15. No Grafting; Solution Process; CNT Composites by Using Commercial Polystyrene (PS)

This example describes the formation of 1 wt % SWNT ester MINTs composites by using commercial PS without grafting.

Polystyrene, abbreviated PS (MW ˜192,000, Sigma-Aldrich) was used as polymer.
Step 1. 65.28 mg of ester MINTs of Example EE9B (28% functionalization) were dispersed in 40 mL of Toluene under magnetic stirring for 30 minutes at room temperature.
Step 2. 10 g of PS were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 80° C. for 24 hours. The resulting composite was called no grafting 1% ester MINT—PS composites of Example CC15.
Step 6. Dogbone tensile test specimens were prepared using the protocol outlined in Example FF4, with the temperature of the hot press being 180° C.
Step 7. Dogbone tensile test specimens were tested per the protocol outlined in Example FF5.

The resulting mechanical property measurements are shown in the table below.
Step 8. Steps 1-7 were repeated without using any ester MINTs of Example EE9B to make neat PS of Example CC15.
   Young's modulus and tensile strength data from tensile testing experiments for no grafting PS-ester MINT Composite dogbones prepared in Example CC15. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (Mpa) | Strength Increase |
| Neat PS | 2688 ± 183 | — | 39.6 ± 2.7 | — |
| no grafting 1% | 2930 ± 11 | 9.0 ± 0.4% | 36.7 ± 4.5 | −7.3 ± 11.4% |
| ester MINT -PS | | | | |

### Variations to the Above Protocol:

In step 1, Different amounts of ester MINTs of Example EE9B can be used to make composites of different CNT content.
In step 1, Different MINTs using different Ushape chemistries can be used in place of ester MINTs of Example EE9B to make different PS-MINT composites.

### Example CC 16. No Grafting; Solution Process; CNT Composites by Using Commercial Low-Density Polyethylene (LDPE)

This example describes the formation of composites commercial LDPE with Glycol MINT of Example AA11b and Chain MINT of Example AA11b.

Low density polyethylene, abbreviated LDPE (Sigma-Aldrich) was used as polymer.
Step 1. 134.6 mg of “Glycol MINT of Example AA11b” (25% functionalization) were dispersed in 40 mL of Toluene under magnetic stirring for 30 minutes at room temperature.
Step 2. 20 g of LDPE were added to the previous dispersion.
Step 3. The mixture was stirred under magnetic stirring for 24 hours at 110° C. (reflux).
Step 4. The mixture was poured into 300 mL of methanol under rapid stirring to precipitate the composite.
Step 5. The composite was dried at 60° C. for 24 hours. The resulting composite was called no grafting 1% glycol MINT-LDPE composites of Example CC16.
Step 6. Dogbone tensile test specimens were prepared using the protocol outlined in Example FF4, with the temperature of the hot press being 150° C.
Step 7. Dogbone tensile test specimens were tested per the protocol outlined in Example FF5.

The resulting mechanical property measurements are shown in the table below.
Step 8. Steps 1-7 were repeated without using any Glycol MINT of Example AA11b to make neat LDPE of Example CC16.
Step 9. Steps 1-7 were repeated with 134.6 mg Chain MINT of Example AA11b (25% functionalization) to make no grafting 1% chain MINT-LDPE composites of Example CC16.
   Young's modulus and tensile strength data from tensile testing experiments for no grafting LDPE-MINT Composite dogbones prepared in Example CC16. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (Mpa) | Strength Increase |
| Neat LDPE | 249.2 ± 1.6 | — | 10.6 ± 0.9 | — |
| no graft 1% glycol | 292.6 ± 9.5 | 17.4 ± 3.8% | 11.7 ± 0.5 | 10.4 ± 4.7% |
| MINT -LDPE | | | | |
| no graft 1% chain | 265.3 ± 16.5 | 6.5 ± 6.6% | 9.4 ± 1.0 | −−11.3 ± 9.4% |
| MINT -LDPE | | | | |

### Variations to the Above Protocol:

In step 1, Different amounts of Glycol MINT of Example AA11b can be used to make composites of different CNT content.
In step 1, Different MINTs using different Ushape chemistries can be used in place of Glycol MINT of Example AA11b to make different LDPE-MINT composites.

### Example CC 17. No Grafting; Solution Process; CNT Composites by Using Commercial Poly Vinyl Chloride (PVC)

This example describes the formation of composites of commercial PVC with 0.1 wt % and 1 wt % Methyl Alcohol MINTs.

Poly vinyl chloride, abbreviated PVC (Sigma-Aldrich) was used as polymer.
Step 1 13.1 mg of Methyl alcohol MINT of Example AA11b (23% functionalization) were dispersed in 30 mL of THF under magnetic stirring for 30 minutes at room temperature.
Step 2. 20 g of PVC were dissolved in 50 mL of THF under magnetic stirring for 1 hour at 55° C.
Step 3. The MINTs dispersion was poured into the PVC solution.
Step 3. The mixture was stirred under magnetic stirring for 24 hours at 55° C.
Step 4. The mixture was poured into 300 mL of water under rapid stirring to precipitate the composite.
Step 5. The composite was dried at 60° C. for 24 hours. The resulting composite was called no grafting 0.1% methyl alcohol MINT-PVA composite of Example CC17.
Step 6. Dogbone tensile test specimens were prepared using the protocol outlined in Example FF4, with the temperature of the hot press being 210° C.
Step 7. Dogbone tensile test specimens were tested per the protocol outlined in Example FF5.

The resulting mechanical property measurements are shown in the table below.
Step 8. Steps 1-7 were repeated without using any Methyl alcohol MINT of Example AA11b of Example AA11b to make neat PVC of Example CC17.
Step 9. Steps 1-7 were repeated with 131.2 mg Methyl alcohol MINT (23% functionalization) to make no grafting 1% methyl alcohol MINT-PVA composite of Example CC17.
   Young's modulus and tensile strength data from tensile testing experiments for no grafting PVC-Methyl Alcohol MINT Composite dogbones prepared in Example CC17. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (Mpa) | Strength Increase |
| Neat PVC | 2200 ± 216 | — | 22.9 ± 2.3 | — |
| no graft 0.1% | 2508 ± 135 | 14.0 ± 6.1% | 25.8 ± 10.6 | 12.7 ± 46.2% |
| methyl alcohol | | | | |
| MINT-PVC | | | | |
| no graft 1% methyl | 3069 ± 229 | 39.5 ± 10.4% | 40.29 ± 0.19 | 75.9 ± 0.8% |
| alcohol MINT-PVC | | | | |

### Variations to the Above Protocol:

In step 1, Different amounts of Methyl alcohol MINT of Example AA11b can be used to make composites of different CNT content.
In step 1, Different MINTs using different Ushape chemistries can be used in place of Methyl alcohol MINT of Example AA11b to make different PVC-MINT composites.

### Example CC 18. No Grafting; Solution Process; CNT Composites by Using Commercial Polyamide 6 (PA6)

This example describes the preparation of 2 wt % MINT/commercial PA6 composites using different MINTs (Pyrene MINTs, Polyethoxy MINTs, and Acid MINTs). Polyamide 6, abbreviated PA6 (Sigma-Aldrich) was used as polymer.
Step 1. 307.4 mg of “Pyrene MINTs of Example EE9” (33.6% functionalization) were dispersed in 40 mL of formic acid under magnetic stirring for 30 minutes at room temperature.
Step 2. 10 g of PA were added to the previous dispersion.
Step 3. The mixture was stirred under magnetic stirring for 24 hours at room temperature.
Step 4. The mixture was poured into 300 mL of water under rapid stirring to precipitate the composite.
Step 5. The composite was dried at 60° C. for 24 hours. The resulting composite was called no grafting 2% Pyrene MINT-PA6 composites of Example CC18.
Step 6. The resulting composite was pressed into a film using Atlas™ Series Heated Platens with the 4000 Series High Stability Temperature Controller were used together with the Atlas™ Manual 15 Ton (15 T) Hydraulic Press, all from Specac, Ltd. at 270° C. using minimal pressure.

After cooling, a homogenously black film of approximately 0.3 mm was collected.
Step 7. At least three doqbones were cut out from the film in the shape of Type V dogbones as described by ASTM D638.
Step 8. Tensile mechanical properties of Young's Modulus and Tensile strength were collected according to a similar process to that described in Example FF5, except no extensometer was used. The resulting mechanical property measurements are shown in the table below.
Step 9. Steps 1-8 were repeated with no filler (without any Pyrene MINTs of Example EE9) to produce neat PA6 of Example CC18.
Step 10. Steps 1-8 were repeated with 250 mg of 33% functionalization MINTs made following the procedure outlined in example DD7 replacing Pyrene U-Shape of Example DD6 with Polyethoxy U-Shape of Example DD5 to produce no grafting 2% Polyethoxy MINT-PA6 composites of Example CC18.
Step 11. Steps 1-8 were repeated with 250 mg acid MINT of Example EE9A (16% functionalization) to produce no grafting 2% Acid MINT-PA6 composites of Example CC18.
   Young's modulus and tensile strength data from tensile testing experiments for no grafting commercial PA-6-MINT Composite dogbones prepared in Example CC18. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (Mpa) | Strength Increase |
| Neat PA6 | 2034 ± 541 | — | 70 ± 11 | — |
| no graft 2 wt % | 2002 ± 482 | −1.6 ± 23.6% | 31 ± 15 | −55.7 ± 21.4% |
| Pyrene MINT- PA6 | | | | |
| no graft 2 wt % | 2163 ± 692 | 6.3 ± 34.0% | 46 ± 13 | −34.3 ± 18.5% |
| Polyethoxy MINT- | | | | |
| PA6 | | | | |
| no graft 2 wt % | 2839 ± 325 | 39.6 ± 16.0% | 67 ± 21 | −4.3 ± 30% |
| Acid MINT- PA6 | | | | |

### Variations to the Above Protocol:

In step 2, Different amounts of Pyrene MINTs of Example EE9 can be used to make composites of different CNT content.
In step 2, Different MINTs using different Ushape chemistries can be used in place of Pyrene MINTs of Example EE9 to make different PA6-MINT composites.

### Example CC19. Grafting from. Polymers Prepared by ATRP Using MINTs as Initiators

This example describes the formation of MINTs-polymer composites using Atom transfer radical polymerization. The functional group of the macrocycle is used as initiator in the polymerization, so the polymers chains grow from the macrocycle. See FIGS. 27 and 28.

α-Bromoisobutyryl bromide, abbreviated BIBB (Mw=229.90 g/mol, Sigma Aldrich) was used as initiator. 4-(Dimethylamino)pyridine, abbreviated DMAP (Mw=122.27 g/mol, Sigma Aldrich), tryethylamine (Mw=101.19/mol, Sigma Aldrich) and anhydrous chloroform (Mw=119.38/mol, Sigma Aldrich) were also used in the reaction.
Step 1. 0.4025 g of Methyl alcohol MINT of Example AA11b, 0.0292 g (0.2390 mmol) of DMAP and 0.3031 g (1.667 mmol) of tryethylamine were placed in 10 mL of anhydrous CHCl₃ under nitrogen atmosphere.
Step 2. 0.3832 g (1.667 mmol) of BIBB were dissolved in 5 mL of anhydrous CHCl₃.
Step 3. the BIBB solution was added dropwise to the first solution (0° C.).
Step 4. The mixture was magnetically stirred for 3 hours at 0° C. followed by stirring at room temperature for 48 hours.
Step 5. The solid was filtrated and washed with 100 mL of CHCl₃ for 5 times.
Step 6. The solid was dried overnight under vacuum at 40° C.

The resulting dried powder was called “ATRP's initiator MINTs of Example CC 19”.

The composite was preparing by the following steps:
Step 1. 15 mL of commercial Sty/or MMA was passed through basic alumina column to remove inhibitors.
Step 2. 0.144 g of CuBr (1 mmol) and 0.468 g of bipy (3 mmol) were added to a round bottom flask. The flask was sealed with a rubber septum, degassed and backfilled with N₂ 3 times.
Step 3. 11.5 mL of deoxygenated Sty (100 mmol) was added via syringe. The flask was degassed and backfilled with N₂ 3 times.
Step 4. The mixture was magnetic stirred for 20 minutes at room temperature, to form the catalyst complex.
Step 5. The flask was placed in an oil bath set at a temperature of 90° C.
Step 6. 0.1898 g of “ATRP's initiator MINTs of Example CC 19” was added to the flask to start the reaction.
Step 7. The reaction was kept under magnetic stirring at 90° C. for 20 hours.
Step 8. The reaction was stopped by cooling the reaction down to room temperature and opening the flask to air.
Step 9. 50 mL of acetone was added to the mixture to dissolve the obtained polymer. The mixture was magnetically stirred for 20 minutes.
Step 10. The mixture was filtered to remove insoluble salts and catalyst remains.
Step 11. The polymer was precipitated by addition of the solution to a large amount (around 300 mL) of cold methanol.
Step 12. The precipitated polymer was filtered and washed with more methanol. Dissolution and precipitation (Steps 9 and 11) were repeated until a white powder was obtained.
Step 13. The precipitated polymer was dried in a vacuum oven at 40° C. until a constant weight was reached.

The composites obtained were called “ATRP PS grafting from of example CC 19” and “ATRP PMMA grafting from of example CC 19”

### Example CC20. Polymers Prepared by ATRP Using MINTs as Initiators (Baskaran, Mays, & Bratcher, 2004)

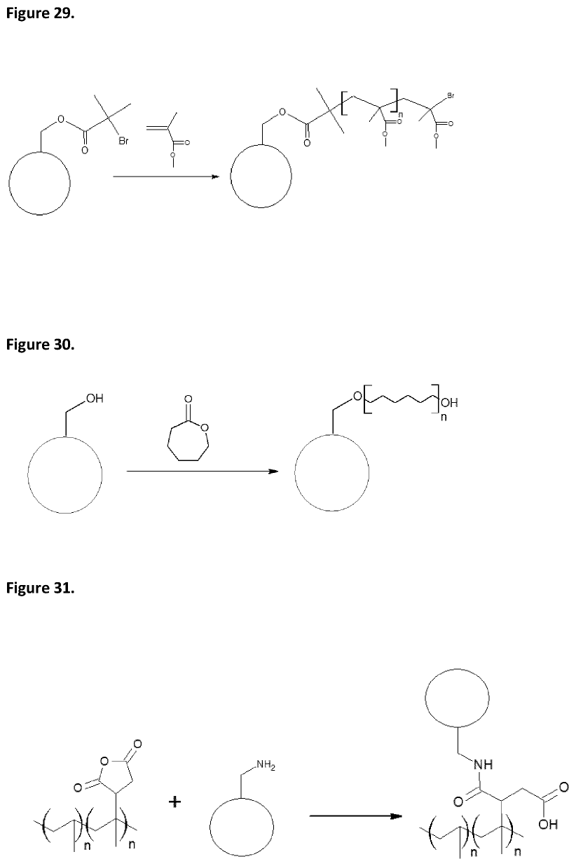

This example describes the formation of MINTs-polymer composites using Atom transfer radical polymerization. The functional group of the macrocycle is used as initiator in the polymerization, so the polymers chains grow from the macrocycle. See FIG. 29.

2-Hydroxyethyl 2-bromoisobutyrate, abbreviated HEBIB (Mw=211.05 g/mol, Sigma Aldrich) was used as initiator. Toluene was used as solvent.
Step 1. 200 mg of COCl-MINTs, 2.4 mL of HEBIB and 5 mL of toluene were introduced in a round bottom flask under N₂ atmosphere.
Step 2. The mixture was magnetically stirred for 24 hours at 100° C.
Step 3. The mixture was cooled to room temperature.
Step 4. The solvent was completely removed under vacuum.
Step 5. The solid was washed with ethanol and filtered. This step was repeated for 3 times.
Step 6. The solid was dried overnight under vacuum at 40° C.

The resulting dried powder was called “ATRP's initiator MINTs of Example CC 20”.
Step 1. 15 mL of commercial Sty/or MMA was passed through basic alumina column to remove inhibitors.
Step 2. 0.144 g of CuBr (1 mmol) and 0.468 g of bipy (3 mmol) were added to a round bottom flask. The flask was sealed with a rubber septum, degassed and backfilled with N₂ 3 times.
Step 3. 11.5 mL of deoxygenated Sty (100 mmol) was added via syringe. The flask was degassed and backfilled with N₂ 3 times.
Step 4. The mixture was magnetic stirred for 20 minutes at room temperature, to form the catalyst complex.
Step 5. The flask was placed in an oil bath set at a temperature of 90° C.
Step 6. 0.1898 g of “ATRP's initiator MINTs of Example CC 20” was added to the flask to start the reaction.
Step 7. The reaction was kept under magnetic stirring at 90° C. for 20 hours.
Step 8. The reaction was stopped by cooling the reaction down to room temperature and opening the flask to air.
Step 9. 50 mL of acetone was added to the mixture to dissolve the obtained polymer. The mixture was magnetically stirred for 20 minutes.
Step 10. The mixture was filtered to remove insoluble salts and catalyst remains.
Step 11. The polymer was precipitated by addition of the solution to a large amount (around 300 mL) of cold methanol.
Step 12. The precipitated polymer was filtered and washed with more methanol. Dissolution and precipitation (Steps 9 and 11) were repeated until a white powder was obtained.
Step 13. The precipitated polymer was dried in a vacuum oven at 40° C. until a constant weight was reached.

The grey/black composites obtained were called “ATRP PS grafting from of example CC 20” (for the composite where Sty was added in step 1) and “ATRP PMMA grafting from of example CC 20” (for the composite where MMA was added in step 1).

### Example CC 21. Grafting from; Ring Opening Polymerization of ε-Caprolactone (Buffa, Hu, & Resasco, 2005)

This example describes the formation of methylalcohol MINTs-Polycaprolactone (PCL) composite using a grafting from method. The —OH group from the methoxyalcohol MINTs was used to start the ring opening polymerization (ROP) of ε-caprolactone. See FIG. 30.

ε-caprolactone (Mw=114.14 g/mol, Sigma-Aldrich) was used as monomer. tin(II) 2-ethylhexanoate, abbreviated Sn(Oct)₂ (Mw=405.12 g/mol, Sigma-Aldrich) was used as catalyst.
Step 1. 0.83 mmol of Methyl alcohol MINT of Example AA11b (prepared by examples EE4 and EE8) was suspended in 15 mL of o-dichlorobenzene by sonicating (tip, 35% amplitude) for 30 min.
Step 2. the suspension was transferred to a two-neck vessel (absolutely dry) and mixed with 2 mL (18.66 mmol) of ε-caprolactone.
Step 3. 0.1866 mmol of Sn(Oct)₂ was added into the mixture.
Step 4. The ROP reaction was carried out under nitrogen constantly bubbling, for 24 h at 130° C. (reflux).
Step 5. The hot liquid was transferred from the vessel into a beaker containing cold n-hexane, which caused the precipitation of the polymeric material.
Step 6. The solid was filtered through a PTFE membrane and abundantly washed with n-hexane.
Step 7. The solid was transferred to a glass containing 10 mL of chloroform. The mixture was magnetically stirred for 30 min at room temperature to eliminate the free polymer.
Step 8. The final solid was dried overnight under vacuum at room temperature.

The obtained grey/black composite was called “ROP PCL-MINTs composite of Example CC21”.

### Example CC22. Attachment Between Amino MINTs and Polypropylene-Graft-Maleic Anhydride

This example describes the formation of a covalent bond between the amino group of the amino MINTs and the maleic anhydride of the copolymer polypropylene-graft-maleic anhydride. The final concentration of nanotubes in the composite was 10 wt. % Polypropylene-graft-maleic anhydride, abbreviated PP-g-MA (Mw=9100 g/mol, Sigma-Aldrich) was used as polymer. Methanesulfonic acid (Sigma-Aldrich) was used as ring opening reactant. See FIG. 31.
Step 1. 2.71 g of Amino MINTs (Example EE8.C1) (2.22 g of NTs assuming 25% functionalization) were dispersed in 200 of Toluene by magnetic stirring for 30 minutes at room temperature in a 500 mL round bottom flask.
Step 2. 20 g of PP-g-MA were added to the mixture ant the temperature was increased to 110° C. (reflux).
Step 3. Methanesulfonic acid was added slowly via syringe.
Step 4. The mixture was maintained to reflux for 2.5 h.
Step 5. The mixture was cooled to room temperature.
Step 6. The mixture was poured into 1000 mL of water under rapid stirring to precipitate the polymer.
Step 7. The final composite was filtered using cellulose filter, wash with water and dry in a vacuum oven (70° C., 12 h). The obtained composite was a homogenous black material called “Amino-PP-g-MA” of Example CC22.
Step 8. In each of 2 containers, 13.5 g of neat polypropylene (Moplen HP400R from Lyondellbasell) was mixed with 1.5 g of “Amino-PP-g-MA” of Example CC22.
Step 9. The Xplore MC 15 twin screw microcompounder was prepared for mixing at 200° C. with a twin screw rotational speed of 100 rpm. One of the 15 g batches prepared in step 8 was introduced into the chamber, and left to mix for 5 min.
Step 10. The chamber was opened and the PP—Amino-PP-g-MA composite was extruded from the nozzle and collected.
Step 11. Steps 9-10 were repeated for the remaining container.
Step 12. The extruded material of the 2 containers was combined. The resulting composite is hereby referred to as “1% Amino MINT/PP-g-MA/PP Composite of Example CC22”
Step 13. Dogbone tensile test specimens were prepared using the protocol outlined in Example FF4, with the temperature of the hot press being 210° C.
Step 14. Dogbone tensile test specimens were tested per the protocol outlined in Example FF5. The resulting mechanical property measurements are shown in the table below. For comparison, the samples were compared to neat polypropylene dogbones of Example FF4.
Steps 15. Step 8-12 was repeated except for a single container of 7.5 g neat polypropylene and 7.5 g of Amino-PP-g-MA” of Example CC22. The resulting composite is hereby referred to as “5% Amino MINT/PP-g-MA/PP Composite of Example CC22”
   Young's modulus and tensile strength data from tensile testing experiments Amino MINT/PP-g-MA/PP Composite dogbones prepared in Example CC22. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (Mpa) | Strength Increase |
| Neat PP | 1691 ± 210 | — | 36 ± 11 | — |
| 1% Amino MINT/ | 2250 ± 174 | 33.0 ± 10.3% | 35 ± 15 | −2.1 ± 2.9% |
| PP-g-MA/PP | | | | |
| 5% Amino MINT/ | 3439 ± 233 | 103.4 ± 13.7% | 28 ± 13 | −23.3 ± 9.7% |
| PP-g-MA/PP | | | | |

### Variations on the Above-Mentioned Protocol:

Polyethylene-graft-maleic anhydride, abbreviated PE-g-MA (Sigma-Aldrich) can be used instead of PP-g-MA following the same experimental procedure.

Methyl Alcohol MINTS (Example EE4) can be used instead of Amino MINTs following the same experimental procedure.

### Example DD1. Synthesis of 2,7-diBpinpyrene

Step 1. Commercial pyrene (8 g, 1 eq.; Acros, CAS: 129-00-0), bis (pinacolato) diboron (21.2 g, 2.11 eq.; Cymit, CAS: 73183-34-3) and 4,4′-Di-tert-butyl-2,2′-dipyridyl (dtbpy; 212.6 mg, 0.02 eq.; Aldrich, CAS: 72914-19-3) were poured into a 250 mL flask under inner atmosphere.
Step 2. Cyclohexane was added (1.66 mL/pyrene mmol).
Step 3. (1,5-Cyclooctadiene)(methoxy) iridium (I) dimer (Sigma Aldrich, CAS: 12148-71-9) was added at reflux temperature (80° C.).
Step 4. After 20 hours of stirring, the reaction was cooled until room temperature.
Step 5. The mixture was filtered onto a filter pad with silica-celite and it was washed with DCM. Solvent was removed by vacuum and a brown solid appeared.
Step 6. The solid was washed with acetone and it turned white. The final white product was termed “2,7-diBpinpyrene of Example DD1”. The final structure was checked by ¹H-NMR.

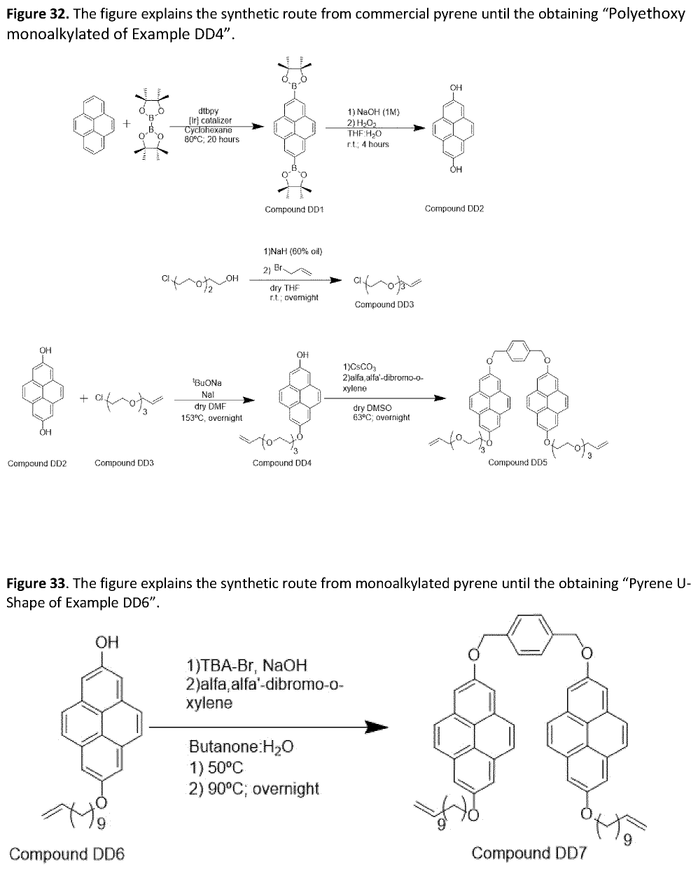

The scheme of this reaction is shown in FIG. 32.

### Example DD2. Synthesis of 2,7-Dihidroxypyrene

Step 1. “2,7-diBpinpyrene of Example DD1” (14.6 g, 1 eq.) was dissolved in THF:H₂O (10:1, 45.5 mL/mmol).
Step 2. NaOH 1M (6,6 g, 6 eq.; Scharlau, CAS: 1310-73-2) was added to the solution.
Step 3. H₂0230% (6,6 g; 6 eq.) was added dropwise.
Step 4. The mixture was stirred at room temperature for 4 hours.
Step 5. After completing Step 4, HCl 1M was added to the solution until pH˜1-2 and stirred 1 hour.
Step 6. Solvent was removed by vacuum and a brown solid appeared.
Step 7. The brown solid was isolated by filtration. The final product was called “2,7-Dihidroxypyrene of Example DD2”. The final structure was checked by ¹H-NMR.

The scheme of this reaction is shown in FIG. 32.

### Example DD3. Synthesis of 3-(2-(2-(2-chloroethoxy) ethoxy) ethoxy) prop-1-ene

Step 1. NaH (60% oil, 213.5 mg, 1.3 eq.; Sigma Aldrich, CAS: 7646-69-7) was suspended in THF (7 mL, 1 mL/mmol) under inner atmosphere at 0° C.
Step 2. After that, 2-(2-(2-chloroethoxy) ethoxy) ethanol (1.2 g, 1 eq.; Sigma Aldrich, CAS: 5197-62-6) was added dropwise at 0° C. This mixture was stirred at 0° C. for 10 minutes.
Step 3. Allyl bromide (1.5 eq.; Acros, CAS: 106-95-6) was added dropwise at 0° C.
Step 4. The reaction was stirred overnight at room temperature.
Step 5. After the reaction was completed, the pH was adjusted at 7.
Step 6. Then, the crude was washed three times DCM and once with brine.
Step 7. The organic phase was dried with MgSO₄ (Scharlau, CAS: 7487-88-9) and the solvent was removed by vacuum.
Step 8. The product was purified by a chromatographic column (Silica, eluents: Hexane/Ethyl acetate 8/2). The final product was termed “3-(2-(2-(2-chloroethoxy) ethoxy) ethoxy) prop-1-ene of Example DD3”. The final structure was checked by ¹H-NMR.

The scheme of this reaction is shown in FIG. 32.

### Example DD4. Synthesis of Polyethoxy Monoalkylated

Step 1. “2,7-Dihidroxypyrene of Example DD2” (5 g, 1 eq.) and sodium tert-butoxide (^{t}BuONa; 5.9 g, 3 eq.; TCI, CAS: 865-48-5) were dissolved in dry DMF (12 mL, 12 mL/mmol) under inner atmosphere.
Step 2. Then, sodium iodide (NaI; catalytic amount; Sigma Aldrich, CAS: 7681-82-5) was added, and the mixture was stirred 3 hours at room temperature.
Step 3. After the 3 hours, “3-(2-(2-(2-chloroethoxy) ethoxy) ethoxy) prop-1-ene of Example DD3” (4.2 g, 1 eq.) was added, and the reaction was stirred overnight at 153° C.
Step 4. The next day, pH of the crude was adjusted to 1-2 with HCl.
Step 5. The crude was extracted three times with Ethyl Acetate.
Step 6. The organic phase was dried with MgSO₄ (Scharlau, CAS: 7487-88-9) and the solvent was removed by vacuum.
Step 7. The product was purified using a chromatographic column (silica, eluents: Eter/Hexane 7/3 to 9/1). The final product was termed “Polyethoxy monoalkylated of Example 25 DD4”. The final structure was checked by ¹H-NMR.

The scheme of this reaction is shown in FIG. 32.

Variations of this reactions could be using K₂CO₃ instead of ^{t}BuONa in Step 1 and change the eluents of the Step 7 for Hexane/Ethyl Acetate from 8/2 to 7/3.

### Example DD5. Synthesis of Polyethoxy U-Shape

Step 1. “Polyethoxy monoalkylated of Example DD4” (353 mg, 2.2 eq.) and cesium carbonate (CsCO₃; 232 mg, 3 eq.; Sigma Aldrich, CAS: 534-17-8) were dissolved in dry DMSO under inner atmosphere.
Step 2. This mixture was stirred 30 minutes at 63° C.
Step 3. α,α′-dibromo-o-xylene (106 mg, 1 eq.; ACROS, CAS: 623-24-5) was added and the reaction was stirred overnight at 63° C.
Step 4. After the night, a few drops of HCl 1M were added to the crude and a light brown solid appeared.
Step 5. The solid was filtrated and washed with water. The product was termed “Polyethoxy U-Shape of Example DD5”. The final structure was checked by ¹H-NMR.

The scheme of this reaction is shown in FIG. 32.

### Example DD6. Synthesis of Pyrene U-Shape

Step 1. “Monoalkylated pyrene of Example GG1c” (15 g, 2.2 eq.) and tetrabutylammonium bromide (TBA-Br; 567 mg, 0.1 eq.; Sigma Aldrich, CAS: 1643-19-2) were dissolved in Butanone/Water (1:1, 40 mL/mmol).
Step 2. NaOH (1.6 g, 2.2 eq.; Scharlau, CAS: 1310-73-2) was added. The mixture was heated at 50° C.
Step 3. Then, α,α′-dibromo-o-xylene (4.6 g, 1 eq.; ACROS, CAS: 623-24-5) was added and the reaction was set at 90° C. and stirred overnight.
Step 4. After the night, the reaction was cooled until room temperature.
Step 5. The butanone was removed by vacuum and a light brown solid appeared.
Step 6. The solid was filtrated and washed with cold acetone. The product was named “Pyrene U-Shape of Example DD6”. The final structure was checked by ¹H-NMR.

The scheme of this reaction is shown in FIG. 33.

The following examples show the different approaches for the synthesis of mechanical interlocked nanotubes (MINTs):

### Example DD7. Synthesis of Pyrene MINTs (Solvent Method)

Step 1. Single Wall Carbon Nanotubes from OCSiAl (SWNTs; 2 g) were dispersed in TCE (2 L, 1 mL/mg of SWNTs) using 15 minutes of sonication.
Step 2. After that, Pyrene U-Shape from “Pyrene U-Shape of Example DD6” (1.75 g, 1 μmol U-Shape/mg SWNTs) was added.
Step 3. N₂ was bubbled trough the sample for 20 minutes.
Step 4. Then, Grubbs catalyst 2^{nd} generation (1.7 g, 1 eq./eq. of U-Shape; Cymit, CAS: 246047-72-3) was added.
Step 5. Stirring the reaction for 72 hours at room temperature.
Step 6. After Step 5, Dichloromethane (50 mL) was added and the reaction mixture was filtered through a PTFE membrane of 0.2 μm pore size.
Step 7. The filter cake was collected and was re-dispersed in 100 mL dichloromethane in a round-bottom flask by bath sonication for 3 min.
Step 8. The sample was filtered again through a PTFE membrane of 0.2 μm pore size.
Step 9. Steps 7 and 8 were repeated Step 10. Approximately 50 mL Et₂O was added to the filter cake.
Step 11. MINTs were collected in a vial and dried overnight at room temperature. The final product was called “Pyrene MINTs of example DD7”.

This product was analysed by Thermogravimetric analysis (TGA) resulting with 22% of SWNTs were coated by Pyrene U-Shape from “Pyrene U-Shape of Example DD6”.

Pyrene U-Shape from “Pyrene U-Shape of Example DD6” used in this example could be changed by “Polyethoxy U-Shape of Example DD5”, keeping the relationship

### Example DD8. Synthesis of Pyrene MINTs (Mortar Method)

Step 1. SWNTs from OCSiAl (10 mg), pyrene U-Shape from “Pyrene U-Shape of Example DD6” (4.2 mg, 0.48 μmol U-Shape/mg SWNTs) and Grubbs catalyst 2^{nd} generation (4.1 mg, 1 eq. of Grubbs/eq. of pyrene U-Shape from “Pyrene U-Shape of Example DD6”; Cymit, CAS: 246047-72-3) were poured into an agate mortar.
Step 2. Step 1 reactants were grinded 30 minutes. Then, Step 7, 8, 9 and 10 from “Pyrene MINTs of example DD7” were repeated.

The product obtained by this method was called “Pyrene MINTs of example DD8” and it was characterised by TGA with a 25% of functionalization.

“Pyrene MINTs of example DD8” conditions were optimised before the right conditions were found. Table DD8a shows a summary of all the test:

| U-Shape | Grubbs 2^{nd} generation | Functionalization |
|---|---|---|
| (μmol/SWNTs' mg) | (Grubbs' eq./U-Shape eq.′) | (%) |
| 1 | 1 | 34 |
| 0.48 | 1 | 30 |
| 0.24 | 1 | 24 |
| 0.12 | 1 | 14.5 |
| 0.48 | 0.5 | 25.5 |
| 0.48 | 0.25 | 25 |
| 0.48 | 0.05 | 21 |

Table DD8a: In this table it is presented the different conditions that were used in the Mortar method to the synthesis of MINTs. In the first column, it is represented the variation in the amount of the U-Shape. In the second column, it is the catalyst variation that is presented. In the final column, it is the degree of functionalization that the different tests achieve.

### Example DD9. Synthesis of Pyrene MINTs in the 20 mL Reactor (Ball Mill Method)

Step 1. SWNTs from OCSiAl (250 mg), “Pyrene U-Shape of Example DD6” (105 mg, 0.48 μmol U-Shape/mg SWNTs) and Grubbs 2^{nd} (10 mg, 0.1 eq. of Grubbs/eq. of “Pyrene U-Shape of Example DD6”; Cymit, CAS: 246047-72-3) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs of example DD9” and it was characterised by TGA with a functionalization of 26%.

“Pyrene MINTs of example DD9” conditions were optimised before the right conditions were found. Table DD9a shows a summary of all the test:

| | | | | | Grubbs 2^{nd} | |
|---|---|---|---|---|---|---|
| | | | | U-Shape | generation | |
| Time | | Balls | Balls | (μmol/SWNTs' | (Grubbs' eq./ | Functionalization |
| (min) | RPMs | (number) | (diameter) | mg) | U-Shape's eq.) | (%) |
| 5 | 100 | 1 | 10 | 0.48 | 0.5 | 6.2 |
| 5 | 100 | 2 | 10 | 0.48 | 0.5 | 12.5 |
| 5 | 500 | 1 | 10 | 0.48 | 0.5 | 18.3 |
| 5 | 500 | 2 | 10 | 0.48 | 0.5 | 19.4 |
| 5 | 500 | 4 | 10 | 0.48 | 0.5 | 25 |
| 5 | 500 | 5 | 10 | 0.48 | 0.5 | 26 |
| 5 | 500 | 5 | 5 | 0.48 | 0.5 | 24 |
| | | 4 | 10 | | | |
| 5 | 500 | 5 | 5 | 0.48 | 0.5 | 26 |
| | | 5 | 10 | | | |
| 10 | 500 | 5 | 10 | 0.48 | 0.5 | 26 |
| 10 | 500 | 5 | 10 | 0.48 | 0.25 | 26 |
| 10 | 500 | 5 | 10 | 0.48 | 0.05 | 22 |

Table DD9a: In this table it is presented the different conditions that were used in the Ball Mill method with the 20 mL reactor to the synthesis of MINTs. In the first column, it is represented the variation in the time that it is used. In the second column, RPMs variations are presented. The next two columns are the variations in the number of the balls and/or the variation in the size of them. Then, the amount of the reagents is presented in the two following columns, there is not any variation in the U-Shape amount but there is some variation in the catalyst. Finally, the las t column tells the different percentage of functionalization that the MINTs reach.

### Example DD10. Synthesis of Pyrene MINTs in the 45 mL Reactor (Ball Mill Method)

Step 1. SWNTs from OCSiAl (1.5 g), “Pyrene U-Shape of Example DD6” (630 mg, 0.48 μmol U-Shape/mg SWNTs) and Grubbs 2^{nd} (61.1 mg, 0.1 eq. of Grubbs/eq. of “Pyrene U-Shape of Example DD6”; Cymit, CAS: 246047-72-3) were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs of example DD10” and it was characterised by TGA with a functionalization of 28%.

### Example DD11. Synthesis of Pyrene MINTs in the 80 mL Reactor (Ball Mill Method)

Step 1. SWNTs from OCSiAl (2.75 g), “Pyrene U-Shape of Example DD6” (1.15 g, 0.48 μmol U-Shape/mg SWNTs) and Grubbs 2^{nd} (111.5 mg, 0.1 eq. of Grubbs/eq. of “Pyrene U-Shape of Example DD6”; Cymit, CAS: 246047-72-3) were poured into a 80 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs of example DD11” and it was characterised by TGA with a functionalization of 25%.

### Example DD12. Synthesis of Pyrene MINTs without Grubbs (Ball Mill Method)

Step 1. SWNTs from OCSiAl(1.5 g), “Pyrene U-Shape of Example DD6” (630 mg, 0.48 μmol U-Shape/mg SWNTs) and no Grubbs 2^{nd} (0 mg, 0 eq. of Grubbs/eq. of “Pyrene U-Shape of Example DD6”; Cymit, CAS: 246047-72-3) were poured into a 45 mL stainless steel reactor with 5 balls of stainless steel 15 mm of diameter.
Step 2. Reactants were grinded in the ball mill 10 minutes at 500 RPMs.
Step 3. Then, the sample “Pyrene MINTs without Grubbs of example DD12” was split in half. On one half, Steps 7, 8, 9 and 10 from “Pyrene MINTs of example DD7” were repeated. On the second half, no wash step was applied.

Two black powdery products were obtained by this method: one was named “Pyrene MINTs without Grubbs wash of example DD12” and it was characterised by TGA with a functionalization of 9% and the other was called “Pyrene MINTs without Grubbs no wash of example DD12” and it was characterised by TGA with a functionalization of 8%

### Example DD13. Synthesis of Pyrene MINTs with 0.1 Equivalents of Grubbs (Ball Mill Method)

Step 1. SWNTs from OCsiAl (1.5 g), “Pyrene U-Shape of Example DD6” (630 mg, 0.48 μmol U-Shape/mg SWNTs) and Grubbs 2^{nd} (61.1 mg, 0.1 eq. of Grubbs/eq. of “Pyrene U-Shape of Example DD6”; Cymit, CAS: 246047-72-3) were poured into a 45 mL stainless steel reactor with 5 balls of stainless steel 15 mm of diameter.
Step 2. Reactants were grinded in the ball mill 10 minutes at 500 RPMs.
Step 3. Then, the sample “Pyrene MINTs with 0.1 eq. Grubbs of example DD13” was split in half. On one half, Steps 7, 8, 9 and 10 from “Pyrene MINTs of example DD7” were repeated. On the second half, no wash step was applied.

Two black powdery products were obtained by this method: one was named “Pyrene MINTs with 0.1 eq. Grubbs wash of example DD13” and it was characterised by TGA with a functionalization of 22% and the other was called “Pyrene MINTs with 0.1 eq. Grubbs no wash of example DD13” and it was characterised by TGA with a functionalization of 35.5%.

### Example DD14. Synthesis of Pyrene MINTs with 1 Equivalent of Grubbs (Ball Mill Method)

Step 1. SWNTs from OCSiAl (1.5 g), “Pyrene U-Shape of Example DD6” (630 mg, 0.48 μmol U-Shape/mg SWNTs) and Grubbs 2^{nd} (611.3 mg, 1 eq. of Grubbs/eq. of “Pyrene U-Shape of Example DD6”; Cymit, CAS: 246047-72-3) were poured into a 45 mL stainless steel reactor with 5 balls of stainless steel 15 mm of diameter.
Step 2. Reactants were grinded in the ball mill 10 minutes at 500 RPMs.
Step 3. Then, the sample “Pyrene MINTs with 1 eq. Grubbs of example DD12” was split in half. On one half, Steps 7, 8, 9 and 10 from “Pyrene MINTs of example DD7” were repeated. On the second half, no wash step was applied.

Two black powdery products were obtained by this method: one was named “Pyrene MINTs with 1 eq. Grubbs wash of example DD14” and it was characterised by TGA with a functionalization of 34% and the other was called “Pyrene MINTs with 1 eq. Grubbs no wash of example DD14” and it was characterised by TGA with a functionalization of 39%.

### Example DD15. Synthesis of Pyrene MINTs with 10 Equivalent of Grubbs (Ball Mill Method)

Step 1. SWNTs from OCSiAl (1.5 g), “Pyrene U-Shape of Example DD6” (630 mg, 0.48 μmol U-Shape/mg SWNTs) and Grubbs 2^{nd} (6.11 g, 10 eq. of Grubbs/eq. of “Pyrene U-Shape of Example DD6”; Cymit, CAS: 246047-72-3) were poured into a 45 mL stainless steel reactor with 5 balls of stainless steel 15 mm of diameter.
Step 2. Reactants were grinded in the ball mill 10 minutes at 500 RPMs.
Step 3. Then, the sample “Pyrene MINTs with 10 eq. Grubbs of example DD15” was split in half. On one half, Steps 7, 8, 9 and 10 from “Pyrene MINTs of example DD7” were repeated. On the second half, no wash step was applied.

Two black powdery products were obtained by this method: one was named “Pyrene MINTs with 10 eq. Grubbs wash of example DD15” and it was characterised by TGA with a functionalization of 31% and the other was called “Pyrene MINTs with 10 eq. Grubbs no wash of example DD15” and it was characterised by TGA with a functionalization of 80%.

### Example DD16. Synthesis of Pyrene MINTs with 4 mL of Toluene (Ball Mill Method)

Step 1. SWNTs from OCSiAl (1.5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”; Cymit, CAS: 246047-72-3) and 4 mL of toluene were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black product obtained by this method was named “Pyrene MINTs with 4 mL of toluene of example DD16” and it was characterised by TGA with a functionalization of 26%.

### Example DD17. Synthesis of Pyrene MINTs with 8 mL of Toluene (Ball Mill Method)

Step 1. SWNTs from OCSiAl (1.5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”; Cymit, CAS: 246047-72-3) and 8 mL of toluene were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black product obtained by this method was named “Pyrene MINTs with 8 mL of toluene of example DD17” and it was characterised by TGA with a functionalization of 28%.

### Example DD18. Synthesis of Pyrene MINTs with 16 mL of Toluene (Ball Mill Method)

Step 1. SWNTs from OCSiAl (1.5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”; Cymit, CAS: 246047-72-3) and 16 mL of toluene were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black product obtained by this method was named “Pyrene MINTs with 4 mL of toluene of example DD18” and it was characterised by TGA with a functionalization of 27%.

### Example DD19. Synthesis of Pyrene MINTs with 4 mL of Tetrachloroethane (TCE) (Ball Mill Method)

Step 1. SWNTs from OCSiAl (1.5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”; Cymit, CAS: 246047-72-3) and 4 mL of tetrachloroethane (TCE) were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black product obtained by this method was named “Pyrene MINTs with 4 mL of tetrachloroethane (TCE) of example DD19” and it was characterised by TGA with a functionalization of 20%.

### Example DD20. Synthesis of Pyrene MINTs with 8 mL of Tetrachloroethane (TCE) (Ball Mill Method)

Step 1. SWNTs from OCSiAl (1.5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”; Cymit, CAS: 246047-72-3) and 8 mL of tetrachloroethane (TCE) were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black product obtained by this method was named “Pyrene MINTs with 4 mL of tetrachloroethane (TCE) of example DD20” and it was characterised by TGA with a functionalization of 22%.

### Example DD21. Synthesis of Pyrene MINTs with 16 mL of Tetrachloroethane (TCE) (Ball Mill Method)

Step 1. SWNTs from OCSiAl (1.5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”; Cymit, CAS: 246047-72-3) and 4 mL of tetrachloroethane (TCE) were poured into a 45 mL stainless steel reactor with 5 balls of stainless steel 15 mm of diameter.
Step 2. Reactants were grinded in the ball mill 10 minutes at 500 RPMs. Then, Steps 7, 8, 9 and 10 from “Pyrene MINTs of example DD7” were repeated.

The black product obtained by this method was named “Pyrene MINTs with 4 mL of tetrachloroethane (TCE) of example DD21” and it was characterised by TGA with a functionalization of 22%.

These examples describe the formation of MINTs composites by using commercial polymethyl methacrylate, abbreviated PMMA was used as polymer.

### Example DD22. No Grafting. Solution Process. CNT Composites by Using Commercial Polymethyl Methacrylate (PMMA)

Step 1. For the preparation of the 0.1%, 1% and 2% SWNTs content compounds “Pyrene MINTs without Grubbs of example DD12” were used. They were dispersed in 30 mL of Toluene under sonication for 30 minutes at room temperature.

Amounts of “Pyrene MINTs without Grubbs wash of example DD12” and “Pyrene MINTs without Grubbs no wash of example DD12” were detail in the table DD22-1:

| SWNTs | | Amount of | |
|---|---|---|---|
| amount (%) | MINTs sample | MINTs | |
| 0.1% | “Pyrene MINTs without Grubbs | 10.8 | mg |
| | wash of example DD12” | | |
| | “Pyrene MINTs without Grubbs | 11 | mg |
| | no wash of example DD12” | | |
| 1% | “Pyrene MINTs without Grubbs | 111 | mg |
| | wash of example DD12” | | |
| | “Pyrene MINTs without Grubbs | 109.8 | mg |
| | no wash of example DD12” | | |
| 2% | “Pyrene MINTs without Grubbs | 224.3 | mg |
| | wash of example DD12” | | |
| | “Pyrene MINTs without Grubbs | 221.8 | mg |
| | no wash of example DD12” | | |

Step 2. 10 g of PM MA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 8000 for 24 hours.

The final composites “Pyrene MINTs without Grubbs and PMMA of Example DD22” were summarize in the Table DD22-2:

| | | Young's | | | |
|---|---|---|---|---|---|
| | SWNTs | Modulus | Standard | Tensile | Standard |
| MINT sample | loading | (MPa) | Deviation | Strength(MPa) | Deviation |
| “Pyrene MINTs without Grubbs | 0.1% | 2953.13 | 231.68 | 67.05 | 10.19 |
| wash of example DD12” | | | | | |
| “Pyrene MINTs without Grubbs | 0.1% | 2751.38 | 234.19 | 53.85 | 1.95 |
| no wash of example DD12” | | | | | |
| “Pyrene MINTs without Grubbs | 1% | 3106.88 | 136.82 | 50.07 | 5.61 |
| wash of example DD12” | | | | | |
| “Pyrene MINTs without Grubbs | 1% | 3209.89 | 300.38 | 50.01 | 11.73 |
| no wash of example DD12” | | | | | |
| “Pyrene MINTs without Grubbs | 2% | 3567.01 | 52.75 | 51.78 | 2.05 |
| wash of example DD12” | | | | | |
| “Pyrene MINTs without Grubbs | 2% | 3143.44 | 274.93 | 54.56 | 4.31 |
| no wash of example DD12” | | | | | |

The data shows that there is not any big difference between the samples wash and no wash. Neither their Young's Modulus nor in their Tensile Strength.

### Example DD23. No Grafting. Solution Process. CNT Composites by Using Commercial Polymethyl Methacrylate (PMMA)

Step 1. For the preparation of the 0.1%, 1% and 2% SWNTs content compounds “Pyrene MINTs with 0.1 eq. Grubbs of example DD13” were used. They were dispersed in 30 mL of Toluene under sonication for 30 minutes at room temperature.

Amounts of “Pyrene MINTs with 0.1 eq. Grubbs wash of example DD13” and “Pyrene MINTs with 0.1 eq. Grubbs no wash of example DD13” were detail in the table DD23-1:

| SWNTs | | Amount of | |
|---|---|---|---|
| amount (%) | MINTs sample | MINTs | |
| 0.1% | “Pyrene MINTs with 0.1 eq. | 12.83 | mg |
| | Grubbs wash of example DD13” | | |
| | “Pyrene MINTs with 0.1 eq. | 15.52 | mg |
| | Grubbs no wash of example DD13” | | |
| 1% | “Pyrene MINTs with 0.1 eq. | 129.5 | mg |
| | Grubbs wash of example DD13” | | |
| | “Pyrene MINTs with 0.1 eq. | 156.6 | mg |
| | Grubbs no wash of example DD13” | | |
| 2% | “Pyrene MINTs with 0.1 eq. | 261.6 | mg |
| | Grubbs wash of example DD13” | | |
| | “Pyrene MINTs with 0.1 eq. | 316.4 | mg |
| | Grubbs no wash of example DD13” | | |

Step 2. 10 g of PM MA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 801 for 24 hours.

The mechanical characteristics of the final composites were summarized in the Table DD23-2:

| | | Young's | | Tensile | |
|---|---|---|---|---|---|
| | SWNTs | Modulus | Standard | StrengthStrength | Standard |
| MINT sample | loading | (MPa) | Deviation | (MPa) | Deviation |
| “Pyrene MINTs with 0.1 eq. | 0.1% | 2957.88 | 255.80 | 52.42 | 6.80 |
| Grubbs wash of example DD13” | | | | | |
| “Pyrene MINTs with 0.1 eq. | 0.1% | 3163.07 | 274.83 | 39.88 | 0.50 |
| Grubbs no wash of example DD13” | | | | | |
| “Pyrene MINTs with 0.1 eq. | 1% | 3824.75 | — | 37.88 | 2.05 |
| Grubbs wash of example DD13” | | | | | |
| “Pyrene MINTs with 0.1 eq. | 1% | 3162.42 | 236.22 | 42.01 | 2.48 |
| Grubbs no wash of example DD13” | | | | | |
| “Pyrene MINTs with 0.1 eq. | 2% | 3915.55 | 94.43 | 42.43 | 5.15 |
| Grubbs wash of example DD13” | | | | | |
| “Pyrene MINTs with 0.1 eq. | 2% | 3758.81 | 351.22 | 55.67 | 4.35 |
| Grubbs no wash of example DD13” | | | | | |

The data shows that there is not any big difference between the samples wash and no wash. Neither in the Young Modulus nor in the Tensile Strength.

### Example DD24. No Grafting. Solution Process. CNT Composites by Using Commercial Polymethyl Methacrylate (PMMA)

Step 1. For the preparation of the 0.1%, 1% and 2% SWNTs content compounds “Pyrene MINTs with 1 eq. Grubbs of example DD14” “Pyrene MINTs without Grubbs of example 0012” were used. They were dispersed in 30 mL of Toluene under sonication for 30 minutes at room temperature.

Amounts of “Pyrene MINTs with 1 eq. Grubbs wash of example DD14” and “Pyrene MINTs with 1 eq. Grubbs no wash of example DD14” were detail in the table DD24-1:

| SWNTs | | Amount of | |
|---|---|---|---|
| amount (%) | MINTs sample | MINTs | |
| 0.1% | “Pyrene MINTs with 1 eq. | 15.2 | mg |
| | Grubbs wash of example DD14” | | |
| | “Pyrene MINTs with 1 eq. | 16.41 | mg |
| | Grubbs no wash of example DD14” | | |
| 1% | “Pyrene MINTs with 1 eq. | 151.5 | mg |
| | Grubbs wash of example DD14” | | |
| | “Pyrene MINTs with 1 eq. | 164.1 | mg |
| | Grubbs no wash of example DD14” | | |
| 2% | “Pyrene MINTs with 1 eq. | 303.3 | mg |
| | Grubbs wash of example DD14” | | |
| | “Pyrene MINTs with 1 eq. | 328.2 | mg |
| | Grubbs no wash of example DD14” | | |

Step 2. 10 g of PM MA were added to the previous dispersion.
Step 3. The mixture was stirred under magnetic stirring for 24 hours at room temperature.
Step 4. The mixture was poured into 300 ml of methanol under rapid stirring to precipitate the composite.
Step 5. The composite was dried at 8000 for 24 hours.

The final composites “Pyrene MINTs with eq. Grubbs and PMMA of Example DD24” were summarize in the Table DD24-2:

| | | Young's | | | |
|---|---|---|---|---|---|
| | SWNTs | Modulus | Standard | Tensile | Standard |
| MINT sample | loading | (MPa) | Deviation | Strength(MPa) | Deviation |
| “Pyrene MINTs with 1 eq. | 0.1% | 2731.52 | 328.02 | 52.15 | 5.24 |
| Grubbs wash of example DD14” | | | | | |
| “Pyrene MINTs with 1 eq. | 0.1% | 3259.51 | 124.74 | 59.47 | 1.73 |
| Grubbs no wash of example DD14” | | | | | |
| “Pyrene MINTs with 1 eq. | 1% | 3069.13 | 128.49 | 32.36 | 1.53 |
| Grubbs wash of example DD14” | | | | | |
| “Pyrene MINTs with 1 eq. | 1% | 3033.34 | 151.20 | 32.45 | 2.64 |
| Grubbs no wash of example DD14” | | | | | |
| “Pyrene MINTs with 1 eq. | 2% | 3475.41 | 426.14 | 54.08 | 5.79 |
| Grubbs wash of example DD14” | | | | | |
| “Pyrene MINTs with 1 eq. | 2% | 3911.31 | 352.55 | 41.34 | 9.37 |
| Grubbs no wash of example DD14” | | | | | |

The data shows that there is not any big difference between the samples wash and no wash. Neither in the Young Modulus nor in the Tensile Strength.

### Example DD25. No Grafting. Solution Process. CNT Composites by Using Commercial Polymethyl Methacrylate (PMMA)

Step 1. For the preparation of the 0.1%, 1% and 2% SWNTs content compounds “Pyrene MINTs with 10 eq. Grubbs of example DD15” were used. They were dispersed in 30 mL of Toluene under sonication for 30 minutes at room temperature.

Amounts of “Pyrene MINTs with 10 eq. Grubbs wash of example DD15” and “Pyrene MINTs with 10 eq. Grubbs no wash of example DD15” were detail in the table DD25-1:

| SWNTs | | Amount of | |
|---|---|---|---|
| amount (%) | MINTs sample | MINTs | |
| 0.1% | “Pyrene MINTs with 10 eq. | 14.51 | mg |
| | Grubbs wash of example DD15” | | |
| | “Pyrene MINTs with 10 eq. | 50 | mg |
| | Grubbs no wash of example DD15” | | |
| 1% | “Pyrene MINTs with 10 eq. | 146.4 | mg |
| | Grubbs wash of example DD15” | | |
| | “Pyrene MINTs with 10 eq. | 505 | mg |
| | Grubbs no wash of example DD15” | | |
| 2% | “Pyrene MINTs with 10 eq. | 295.8 | mg |
| | Grubbs wash of example DD15” | | |
| | “Pyrene MINTs with 10 eq. | 1.02 | g |
| | Grubbs no wash of example DD15” | | |

Step 2. 10 g of PM MA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 80° C. for 24 hours.

The final composites “Pyrene MINTs with 10 eq. Grubbs and PMMA of Example DD25” were summarize in the Table DD25-2:

| | | Young's | | Tensile | |
|---|---|---|---|---|---|
| | SWNTs | Modulus | Standard | Strength | Standard |
| MINT sample | loading | (MPa) | Deviation | (MPa) | Deviation |
| “Pyrene MINTs with 10 eq. | 0.1% | 3346.11 | 4.76 | 65.77 | 3.55 |
| Grubbs wash of example DD15” | | | | | |
| “Pyrene MINTs with 10 eq. | 0.1% | 2968.64 | 324.54 | 42.31 | 4.25 |
| Grubbs no wash of example | | | | | |
| DD15” | | | | | |
| “Pyrene MINTs with 10 eq. | 1% | 3920.80 | 196.48 | 56.62 | 1.40 |
| Grubbs wash of example DD15” | | | | | |
| “Pyrene MINTs with 10 eq. | 1% | 2952.50 | 403.92 | 40.52 | 3.86 |
| Grubbs no wash of example | | | | | |
| DD15” | | | | | |
| “Pyrene MINTs with 10 eq. | 2% | 3425.97 | 150.36 | 48.45 | 3.82 |
| Grubbs wash of example DD15” | | | | | |
| “Pyrene MINTs with 10 eq. | 2% | 3404.27 | — | 51.13 | — |
| Grubbs no wash of example | | | | | |
| DD15” | | | | | |

The data shows that there is not any big difference between the samples wash and no wash. Neither in the Young Modulus nor in the Tensile Strength.

### Example DD26. No Grafting. Solution Process. Grubbs 2^{nd} Generation Composites by Using Commercial Polymethyl Methacrylate (PMMA)

Step 1. For the preparation of the composites of 0%, 0.1%, 1% and 2% of Grubbs 2^{nd} generation content 0 mg, 122.2 mg, 1,223 g and 12,225 g were respectively used. They were dispersed in 30 mL of Toluene under sonication for 30 minutes at room temperature.
Step 2. 10 g of PMMA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 80° C. for 24 hours.

The final composites “Grubbs and PMMA composites of Example DD22” were summarize in the Table DD27-1:

| | Young's | | Tensile | |
|---|---|---|---|---|
| Grubbs | Modulus | Standard | Strength | Standard |
| percentage | (MPa) | Deviation | (MPa) | Deviation |
| 0% | 2639.57 | 203.85 | 45.96 | 7.40 |
| 0.1% | 3247.60 | 185.44 | 64.23 | 0.03 |
| 1% | 3075.19 | 321.85 | 52.22 | 1.73 |
| 2% | — | — | — | — |

The data shows that there is a big difference between the samples. More amount of Grubbs 2^{nd} generation means a higher Young Modulus and a lower Tensile Strength. In the case of the sample with 2% of Grubbs 2^{nd} generation, it was more difficult than usual to take it out of the mould.

### Example DD27. Synthesis of Pyrene MINTs with PMMA in the 20 mL Reactor

Step 1. SWNTs (300 mg), “Pyrene U-Shape of Example DD6” (126 mg, 0.48 μmol U-Shape/mg SWNTs), Grubbs 2^{nd} (12.2 mg, 0.1 eq. of Grubbs/eq. of “Pyrene U-Shape of Example DD6”; Cymit, CAS: 246047-72-3) and 6 g of commercial PMMA were poured into a 20 mL stainless steel reactor with 5 balls of stainless steel 10 mm of diameter.
Step 2. Reactants were grinded in the ball mill 10 minutes at 500 RPMs.

The black powdery product obtained by this method was named “Pyrene MINTs with PMMA of example DD27” and it was characterised by TGA with a functionalization of 26%.

These examples describe the formation of MINTs composites by using commercial low density polyethylene, abbreviated LDPE was used as polymer.

### Example DD28. No Grafting. Solution Process. Grubbs 2^{nd} Generation Composites by Using Commercial Low Density Polyethylene (LDPE)

Step 1. For the preparation of the composites of 0%, 0.1%, 1% and 2% of Grubbs 2^{nd} generation content 0 mg, 122.2 mg, 1,223 g and 12,225 were respectively used. They were dispersed in 50 mL of Toluene under sonication for 30 minutes at room temperature.
Step 2. 10 g of LDPE were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 60° C. for 24 hours.

The final composites “Grubbs and LDPE composites of Example DD28” were summarize in the Table DD28-1:

| | Young's | | Tensile | |
|---|---|---|---|---|
| Grubbs | Modulus | Standard | StrengthStrength | Standard |
| percentage | (MPa) | Deviation | (MPa) | Deviation |
| 0% | 196.42 | 20.43 | 13.63 | 0.72 |
| 0.1% | 203.91 | 11.43 | 13.42 | 0.55 |
| 1% | 190.12 | 3.14 | 12.79 | 0.31 |
| 2% | 251.77 | 23.43 | 11.09 | 1.69 |

The data shows that there is not any big difference between the Young Modulus of the samples. Meanwhile, more amount of Grubbs 2^{nd} generation means lower Tensile Strength.

### Example DD29. No Grafting. Solution Process. CNT Composites by Using Commercial Low Density Polyethylene (LDPE)

Step 1. For the preparation of the 0.1%, 1% and 2% SWNTs content compounds “Pyrene MINTs without Grubbs of example DD12” were used. They were dispersed in 50 mL of Toluene under sonication for 30 minutes at room temperature.

Amounts of “Pyrene MINTs without Grubbs wash of example DD12” and “Pyrene MINTs without Grubbs no wash of example DD12” were detail in the table DD29-1:

| SWNTs amount (%) | MINTs sample | Amount of MINTs | |
|---|---|---|---|
| 0.1% | “Pyrene MINTs without | 10.8 | mg |
| | Grubbs wash of example | | |
| | DD12” | | |
| | “Pyrene MINTs without | 11 | mg |
| | Grubbs no wash of | | |
| | example DD12” | | |
| 1% | “Pyrene MINTs without | 111 | mg |
| | Grubbs wash of example | | |
| | DD12” | | |
| | “Pyrene MINTs without | 109.8 | mg |
| | Grubbs no wash of | | |
| | example DD12” | | |
| 2% | “Pyrene MINTs without | 224.3 | mg |
| | Grubbs wash of example | | |
| | DD12” | | |
| | “Pyrene MINTs without | 221.8 | mg |
| | Grubbs no wash of | | |
| | example DD12” | | |

Step 2. 10 g of LDPE were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 6000 for 24 hours.

The final composites “Pyrene MINTs without Grubbs and LOPE of Example DD29” were summarize in the Table DD29-2:

| | | Young's | | Tensile | |
|---|---|---|---|---|---|
| | SWNTs | Modulus | Standard | StrengthStrength | Standard |
| MINT sample | loading | (MPa) | Deviation | (MPa) | Deviation |
| “Pyrene MINTs without Grubbs | 0.1% | 153.78 | 6.87 | 12.56 | 0.78 |
| wash of example DD12” | | | | | |
| “Pyrene MINTs without Grubbs | 0.1% | 157.84 | 21.35 | 12.46 | 0.25 |
| no wash of example DD12” | | | | | |
| “Pyrene MINTs without Grubbs | 1% | 176.53 | 13.17 | 13.15 | 0.54 |
| wash of example DD12' | | | | | |
| “Pyrene MINTs without Grubbs | 1% | 189.02 | 15.30 | 8.50 | 2.06 |
| no wash of example DD12” | | | | | |
| “Pyrene MINTs without Grubbs | 2% | 212.77 | 12.08 | 13.38 | 0.14 |
| wash of example DD12' | | | | | |
| “Pyrene MINTs without Grubbs | 2% | 226.98 | 25.21 | 13.15 | 0.37 |
| no wash of example DD12” | | | | | |

The data shows that there is not any big difference between the samples wash and no wash for the Tensile Strength. Meanwhile, the Young Modulus increases with the percentage of SWNTs and Grubbs 2^{nd} generation in the sample.

### Example DD30. No Grafting. Solution Process. CNT Composites by Using Commercial Low Density Polyethylene (LOPE)

Step 1. For the preparation of the 0.1%, 1% and 2% SWNTs content compounds “Pyrene MINTs with 0.1 eq. Grubbs of example DD13” were used. They were dispersed in 50 mL of Toluene under sonication for 30 minutes at room temperature.

Amounts of “Pyrene MINTs with 0.1 eq. Grubbs wash of example DD13” and “Pyrene MINTs with 0.1 eq. Grubbs no wash of example DD13” were detail in the table DD30-1:

| SWNTs amount (%) | MINTs sample | Amount of MINTs | |
|---|---|---|---|
| 0.1% | “Pyrene MINTs with 0.1 | 10.8 | mg |
| | eq. Grubbs wash of | | |
| | example DD13” | | |
| | “Pyrene MINTs with 0.1 | 11 | mg |
| | eq. Grubbs no wash of | | |
| | example DD13” | | |
| 1% | “Pyrene MINTs with 0.1 | 111 | mg |
| | eq. Grubbs wash of | | |
| | example DD13” | | |
| | “Pyrene MINTs with 0.1 | 109.8 | mg |
| | eq. Grubbs no wash of | | |
| | example DD13” | | |
| 2% | “Pyrene MINTs with 0.1 | 224.3 | mg |
| | eq. Grubbs wash of | | |
| | example DD13” | | |
| | “Pyrene MINTs with 0.1 | 221.8 | mg |
| | eq. Grubbs no wash of | | |
| | example DD13” | | |

Step 2. 10 g of LOPE were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 60° C. for 24 hours.

The final composites “Pyrene MINTs with 0.1 eq. Grubbs and LDPE of Example DD30” were summarize in the Table DD30-2:

| | | Young's | | Tensile | |
|---|---|---|---|---|---|
| | SWNTs | Modulus | Standard | Strength | Standard |
| MINT sample | loading | (MPa) | Deviation | (MPa) | Deviation |
| “Pyrene MINTs with 0.1 eq. | 0.1% | 151.95 | 1.80 | 11.26 | 0.04 |
| Grubbs wash of example DD13” | | | | | |
| “Pyrene MINTs with 0.1 eq. | 0.1% | 155.13 | 5.94 | 11.26 | 0.39 |
| Grubbs no wash of example | | | | | |
| DD13” | | | | | |
| “Pyrene MINTs with 0.1 eq. | 1% | 153.45 | 2.81 | 12.31 | 0.17 |
| Grubbs wash of example DD13” | | | | | |
| “Pyrene MINTs with 0.1 eq. | 1% | 206.55 | 19.72 | 12.74 | 0.11 |
| Grubbs no wash of example | | | | | |
| DD13” | | | | | |
| “Pyrene MINTs with 0.1 eq. | 2% | 201.12 | 16.48 | 12.69 | 0.42 |
| Grubbs wash of example DD13” | | | | | |
| “Pyrene MINTs with 0.1 eq. | 2% | 206.98 | 8.83 | 12.92 | 0.86 |
| Grubbs no wash of example | | | | | |
| DD13” | | | | | |

The data shows no big difference in the Tensile Strength values but there is a slightly increase in the Young Modulus between the wash and no washes samples.

### Example DD31. No Grafting. Solution Process. CNT Composites by Using Commercial Low Density Polyethylene (LOPE)

Step 1. For the preparation of the 0.1%, 1% and 2% SWNTs content compounds “Pyrene MINTs with 1 eq. Grubbs of example DD14” were used. They were dispersed in 30 mL of Toluene under sonication for 30 minutes at room temperature.

Amounts of “Pyrene MINTs with 1 eq. Grubbs wash of example DD14” and “Pyrene MINTs with G eq. Grubbs no wash of example DD14” were detail in the table DD31-1:

| SWNTs amount (%) | MINTs sample | Amount of MINTs | |
|---|---|---|---|
| 0.1% | “Pyrene MINTs with 1 eq. | 12.83 | mg |
| | Grubbs wash of example | | |
| | DD14” | | |
| | “Pyrene MINTs with 1 eq. | 15.52 | mg |
| | Grubbs no wash of | | |
| | example DD14” | | |
| 1% | “Pyrene MINTs with 1 eq. | 129.5 | mg |
| | Grubbs wash of example | | |
| | DD14” | | |
| | “Pyrene MINTs with 1 eq. | 156.6 | mg |
| | Grubbs no wash of | | |
| | example DD14” | | |
| 2% | “Pyrene MINTs with 1 eq. | 261.6 | mg |
| | Grubbs wash of example | | |
| | DD14” | | |
| | “Pyrene MINTs with 1 eq. | 316.4 | mg |
| | Grubbs no wash of | | |
| | example DD14” | | |

Step 2. 10 g of LOPE were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 8000 for 24 hours.

The final composites “Pyrene MINTs with 1 eq. Grubbs and LOPE of Example DD31” were summarize in the Table DD31-2:

| | | Young's | | Tensile | |
|---|---|---|---|---|---|
| | SWNTs | Modulus | Standard | Strength | Standard |
| MINT sample | loading | (MPa) | Deviation | (MPa) | Deviation |
| “Pyrene MINTs with 1 eq. | 0.1% | 167.46 | 11.70 | 12.25 | 0.85 |
| Grubbs wash of example DD14” | | | | | |
| “Pyrene MINTs with 1 eq. | 0.1% | 158.20 | 25.17 | 12.23 | 0.58 |
| Grubbs no wash of example | | | | | |
| DD14” | | | | | |
| 'Pyrene MINTs with 1 eq. | 1% | 182.30 | 26.49 | 9.25 | 1.38 |
| Grubbs wash of example DD14” | | | | | |
| 'Pyrene MINTs with 1 eq. | 1% | 194.26 | 25.93 | 12.26 | 0.23 |
| Grubbs no wash of example | | | | | |
| DD14” | | | | | |
| “Pyrene MINTs with 1 eq. | 2% | 197.35 | 15.58 | 12.38 | 0.19 |
| Grubbs wash of example DD14” | | | | | |
| “Pyrene MINTs with 1 eq. | 2% | 208.45 | 23.42 | 13.01 | 0.41 |
| Grubbs no wash of example | | | | | |
| DD14” | | | | | |

The data shows a slightly increase in the values both for Young Modulus and Tensile Strength as you increase the percentage of the SWNTs in the samples. There is, also, an increase in the values between wash and no wash samples.

### Example DD32. No Grafting. Solution Process. CNT Composites by Using Commercial Low Density Polyethylene (LOPE)

Step 1. For the preparation of the 0.1%, 1% and 2% SWNTs content compounds “Pyrene MINTs with 10 eq. Grubbs of example DD15” were used. They were dispersed in 30 mL of Toluene under sonication for 30 minutes at room temperature.

Amounts of “Pyrene MINTs with 10 eq. Grubbs wash of example DD15” and “Pyrene MINTs with 10 eq. Grubbs no wash of example DD15” were detail in the table DD32-1:

| SWNTs amount (%) | MINTs sample | Amount of MINTs | |
|---|---|---|---|
| 0.1% | “Pyrene MINTs with 10 eq. | 15.2 | mg |
| | Grubbs wash of example | | |
| | DD15” | | |
| | “Pyrene MINTs with 10 eq. | 16.41 | mg |
| | Grubbs no wash of | | |
| | example DD15” | | |
| 1% | “Pyrene MINTs with 10 eq. | 151.5 | mg |
| | Grubbs wash of example | | |
| | DD15” | | |
| | “Pyrene MINTs with 10 eq. | 164.1 | mg |
| | Grubbs no wash of | | |
| | example DD15” | | |
| 2% | “Pyrene MINTs with 10 eq. | 303.3 | mg |
| | Grubbs wash of example | | |
| | DD15” | | |
| | “Pyrene MINTs with 10 eq. | 328.2 | mg |
| | Grubbs no wash of | | |
| | example DD15” | | |

Step 2. 10 g of LOPE were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 60° C. for 24 hours.

The final composites “Pyrene MINTs with 10 eq. Grubbs and LOPE of Example DD32” were summarize in the Table DD32-2:

| | | Young's | | Tensile | |
|---|---|---|---|---|---|
| | SWNTs | Modulus | Standard | Strength | Standard |
| MINT sample | loading | (MPa) | Deviation | (MPa) | Deviation |
| “Pyrene MINTs with 10 eq. | 0.1% | 142.16 | 12.67 | 12.02 | 0.11 |
| Grubbs wash of example DD15” | | | | | |
| “Pyrene MINTs with 10 eq. | 0.1% | 170.40 | 20.79 | 9.39 | 1.46 |
| Grubbs no wash of example | | | | | |
| DD15” | | | | | |
| “Pyrene MINTs with 10 eq. | 1% | 178.21 | 21.24 | 11.82 | 0.91 |
| Grubbs wash of example DD15” | | | | | |
| “Pyrene MINTs with 10 eq. | 1% | 168.89 | 18.34 | 12.47 | 0.43 |
| Grubbs no wash of example | | | | | |
| DD15” | | | | | |
| “Pyrene MINTs with 10 eq. | 2% | 214.81 | 2.57 | 12.75 | 0.16 |
| Grubbs wash of example DD15” | | | | | |
| “Pyrene MINTs with 10 eq. | 2% | 212.48 | 17.30 | 12.51 | 0.89 |
| Grubbs no wash of example | | | | | |
| DD15” | | | | | |

The data shows that in the case of “Pyrene MINTs with 10 eq. Grubbs and LDPE of Example DD32” there is not difference between the wash and no wash samples. Meanwhile, the Young Modulus increase as there are more SWNTs in the sample. Tensile SStrength remains stable among the changes.

### Example DD33. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 30 minutes at 500 RPMs.
Step 3. Then, the sample “Shortening SWNTs 30 minutes at 500 RPMs of Example DD33” was analysed by Raman spectroscopy, TGA and AFM.

From AFM was measured the mean length of the SWNTs treated by this method. Using 30 minutes of grinding at 500 RPM, SWNTs of 1.97±1.18 μm were obtained. Raman did not show big differences between pristine and treated SWNTs.

### Example DD34. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 30 minutes at 100 RPMs.
Step 3. Then, the sample “Shortening SWNTs 30 minutes at 100 RPMs of Example DD34” was analysed by Raman spectroscopy, TGA and AFM.

From AFM was measured the mean length of the SWNTs treated by this method. Using 30 minutes of grinding at 100 RPM, SWNTs of 3.87±1.62 μm were obtained. Raman did not show big differences between pristine and treated SWNTs.

### Example DD35. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 30 minutes at 250 RPMs.
Step 3. Then, the sample “Shortening SWNTs 30 minutes at 250 RPMs of Example DD35” was analysed by Raman spectroscopy, TGA and AFM.

From AFM was measured the mean length of the SWNTs treated by this method. Using 30 minutes of grinding at 250 RPM, SWNTs of 0.48±2.54 μm were obtained. Raman did not show big differences between pristine and treated SWNTs.

### Example DD36. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 120 minutes at 250 RPMs.
Step 3. Then, the sample “Shortening SWNTs 120 minutes at 250 RPMs of Example DD36” was analysed by Raman spectroscopy, TGA and AFM.

From AFM was measured the mean length of the SWNTs treated by this method. Using 120 minutes of grinding at 250 RPM, SWNTs of 2.31±1.34 μm were obtained. Raman did not show big differences between pristine and treated SWNTs.

### Example DD37. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 240 minutes at 250 RPMs.
Step 3. Then, the sample “Shortening SWNTs 240 minutes at 250 RPMs of Example DD37” was analysed by Raman spectroscopy, TGA and AFM.

From AFM was measured the mean length of the SWNTs treated by this method. Using 240 minutes of grinding at 250 RPM, SWNTs of 1.92±1.07 μm were obtained. Raman did not show big differences between pristine and treated SWNTs.

### Example DD38. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 120 minutes at 500 RPMs.
Step 3. Then, the sample “Shortening SWNTs 120 minutes at 500 RPMs of Example DD38” was analysed by Raman spectroscopy, TGA and AFM.

From AFM was measured the mean length of the SWNTs treated by this method. Using 120 minutes of grinding at 500 RPM, SWNTs of 0.95±0.67 μm were obtained. Raman did not show big differences between pristine and treated SWNTs.

### Example DD39. Shortening SWNTs (Ball Mill Method)

Step 1. SWNTs from OCSiAl (30 mg) were poured into a 20 mL stainless steel reactor with 8 balls of stainless steel 10 mm of diameter.
Step 2. Reactants were grinded in the ball mill 180 minutes at 250 RPMs.
Step 3. Then, the sample “Shortening SWNTs 180 minutes at 250 RPMs of Example DD39” was analysed by Raman spectroscopy, TGA and AFM.

From AFM was measured the mean length of the SWNTs treated by this method. Using 180 minutes of grinding at 250 RPM, SWNTs of 2.05±1.70 μm were obtained. Raman did not show big differences between pristine and treated SWNTs.

### Example DD40. Synthesis of Pyrene MINTs with Shorten SWNTs (Ball Mill Method)

Step 1. SWNTs from “Shortening SWNTs 30 minutes at 250 RPMs of Example DD35” (50 mg), “Pyrene U-Shape of Example DD6” (21 mg, 0.48 μmol U-Shape/mg SWNTs) and Grubbs 2^{nd} (2.05 mg, 0.1 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs with SWNTs of 4.48 μm of example DD40” and it was characterised by TGA with a functionalization of 28%.

### Example DD41. Synthesis of Pyrene MINTs with Shorten SWNTs (Ball Mill Method)

Step 1. SWNTs from “Shortening SWNTs 120 minutes at 250 RPMs of Example DD36” (50 mg), “Pyrene U-Shape of Example DD6” (21 mg, 0.48 μmol U-Shape/mg SWNTs) and Grubbs 2^{nd} (2.05 mg, 0.1 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs with SWNTs of 2.31 μm of example DD41” and it was characterised by TGA with a functionalization of 37%.

### Example DD42. Synthesis of Pyrene MINTs with Shorten SWNTs (Ball Mill Method)

Step 1. SWNTs from “Shortening SWNTs 180 minutes at 250 RPMs of Example DD39” (50 mg), “Pyrene U-Shape of Example DD6” (21 mg, 0.48 μmol U-Shape/mg SWNTs) and Grubbs 2^{nd} (2.05 mg, 0.1 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs with SWNTs of 2.05 μm of example DD42” and it was characterised by TGA with a functionalization of 39%.

### Example DD43. Synthesis of Pyrene MINTs with 6,5 SWNTs (Ball Mill Method)

Step 1. 6,5 SWNTs from Sigma-Aldrich (250 mg), “Pyrene U-Shape of Example DD6” (105 mg, 0.48 μmol U-Shape/mg SWNTs) and Grubbs 2^{nd} (10 mg, 0.1 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs with 6,5 SWNTs with 0.1 eq. Grubbs of example DD43” and it was characterised by TGA with a functionalization of 30%.

### Example DD44. Synthesis of Pyrene MINTs with 6,5 SWNTs (Ball Mill method)

Step 1. 6,5 SWNTs from Sigma-Aldrich (250 mg), “Pyrene U-Shape of Example DD6” (105 mg, 0.48 μmol U-Shape/mg SWNTs) and Grubbs 2^{nd} (51 mg, 0.5 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs with 6,5 SWNTs with 0.5 eq. Grubbs of example DD44” and it was characterised by TGA with a functionalization of 33%.

### Example DD45. Shortening SWNTs Under Nitrogen Atmosphere (Ball Mill Method)

Step 1. SWNTs from OCSiAl were left under inner atmosphere (nitrogen) one week
Step 2. SWNTs from Step 1 (30 mg) were poured into a 20 mL stainless steel reactor with 8 balls of stainless steel 10 mm of diameter.
Step 3. Reactants were grinded in the ball mill 120 minutes at 250 RPMs.
Step 4. Then, the sample “Shortening SWNTs under inner atm. 120 minutes at 250 RPMs of Example DD45” was analysed by Raman spectroscopy, TGA and AFM.

From AFM was measured the mean length of the SWNTs treated by this method. Using 120 minutes of grinding at 250 RPM, SWNTs of 0.75±0.66 μm were obtained. Raman did not show big differences between pristine and treated SWNTs.

### Example DD46. Shortening SWNTs Under Nitrogen Atmosphere (Ball Mill Method)

Step 1. SWNTs from OCSiAl were left under inner atmosphere (nitrogen) two weeks.
Step 2. SWNTs from Step 1 (30 mg) were poured into a 20 mL stainless steel reactor with 8 balls of stainless steel 10 mm of diameter.
Step 3. Reactants were grinded in the ball mill 120 minutes at 250 RPMs.
Step 4. Then, the sample “Shortening SWNTs under inner atm. 2 weeks 120 minutes at 250 RPMs of Example DD46” was analysed by Raman spectroscopy, TGA and AFM.

### Example DD47. Synthesis of Pyrene MINTs with Shorter SWNTs (Ball Mill Method)

Step 1. SWNTs from “Shortening SWNTs under inner atm. 120 minutes at 250 RPMs of Example DD45” (43 mg), “Pyrene U-Shape of Example DD6” (18.06 mg, 0.48 μmol U-Shape/mg SWNTs) and Grubbs 2^{nd} (1.75 mg, 0.1 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Pyrene MINTs with SWNTs of 0.75 μm of example DD47” and it was characterised by TGA with a functionalization of 39%.

### Example DD48. No Grafting. Solution Process. Shorter SWNTs Composites by Using Commercial Polymethyl Methacrylate (PMMA)

Step 1. For the preparation of the composites of 0.1% of shorter SWNTs 14.3 mg of “Pyrene MINTs with SWNTs of 0.75 μm of example DD47” were used. They were dispersed in 30 mL of Toluene under sonication for 30 minutes at room temperature.
Step 2. 10 g of PMMA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 80° C. for 24 hours.

The final composites “PMMA+shorter SWNTs MINTs composites” mechanical properties were summarize in the Table DD48-1:

| | | Young's | | Tensile | |
|---|---|---|---|---|---|
| | SWNTs | Modulus | Standard | Strength | Standard |
| MINT sample | loading | (MPa) | Deviation | (MPa) | Deviation |
| “Pyrene MINTs with | 0.1% | 2657.29 | 268.06 | 66.37 | 0.53 |
| SWNTs of 0.75 μm | | | | | |
| of example DD47” | | | | | |

### Example DD49. No Grafting. Solution Process. Shorter SWNTs Composites by Using Commercial Polymethyl Methacrylate (PMMA)

Step 1. For the preparation of the composites of 0.1% of shorter SWNTs 10 mg of “Shortening SWNTs under inner atm. 120 minutes at 250 RPMs of Example DD45” were used. They were dispersed in 30 mL of Toluene under sonication for 30 minutes at room temperature.
Step 2. 10 g of PMMA were added to the previous dispersion.
Step 3. The mixture was stirred under magnetic stirring for 24 hours at room temperature.
Step 4. The mixture was poured into 300 mL of methanol under rapid stirring to precipitate the composite.
Step 5. The composite was dried at 80° C. for 24 hours.

The final composites “PMMA+shorter SWNTs composites” mechanical properties were summarize in the Table DD48-2:

| | | Young's | | Tensile | |
|---|---|---|---|---|---|
| | SWNTs | Modulus | Standard | Strength | Standard |
| SWNTs sample | loading | (MPa) | Deviation | (MPa) | Deviation |
| “Shortening SWNTs | 0.1% | 2953.13 | 231.68 | 67.05 | 10.19 |
| under inner atm. 120 | | | | | |
| minutes at 250 RPMs | | | | | |
| of Example DD45” | | | | | |

### Example DD50. Synthesis of Diamino-Boc MINTs with Shorter SWNTs (Ball Mill Method)

Step 1. SWNTs from “Shortening SWNTs under inner atm. 120 minutes at 250 RPMs of Example DD45” (34.4 mg), “Example GG2. Synthesis of Diamino-Boc U-Shape” (20.4 mg, 0.48 μmol U-Shape/mg SWNTs) and Grubbs 2^{nd} (1.4 mg, 0.1 eq. of Grubbs/eq. of “Pyrene U-Shape of Example DD6”) were poured into a 20 mL stainless steel reactor with 5 balls of stainless steel 10 mm of diameter.
Step 2. Reactants were grinded in the ball mill 10 minutes at 500 RPMs. Then, Steps 7, 8, 9 and 10 from “Pyrene MINTs of example DD7” were repeated.

The black powdery product obtained by this method was named “Diamino-Boc MINTs with SWNTs of 0.75 μm of example DD50” and it was characterised by TGA with a functionalization of 20.2%.

### Example DD51. Shorter SWNTs MINTs Composites by Using ALEXIT® BladeRep LEP 9

ALEXIT® BladeRep LEP 9 is a commercial two-component, solvent free polyurethane. The most viscous component is going to be called “Hardener”. The second part is going to be called “Paint”.
Step 1. For the preparation of the composites of 0.1% of shorter SWNTs MINTs 37.5 mg of “Diamino-Boc MINTs with SWNTs of 0.75 μm of example DD50” were used. They were dispersed in 10 g of the “Hardener” using a Shear Mixer at 12000 RPMs during 3 hours.
Step 2. The mixture was degassed stirring at vacuum during 3 h.
Step 3. This degas mix was mixture with 20 g of “Paint”.
Step 4. The mixture was mixed by hand and poured into a glass slide. To get a uniform layer of ALEXIT® BladeRep LEP 9, this is dispersed along the slide using a Meyer Bar of 100 μm of thickness.
Step 5. The composite was dried at room temperature for 24 hours.

The final composites “ALEXIT+Diamino-Boc MINTs with Shorter SWNTs” mechanical properties were summarize in the Table DD51-1:

| | | Young's | | Tensile | |
|---|---|---|---|---|---|
| | SWNTs | Modulus | Standard | Strength | Standard |
| SWNTs sample | loading | (Pa) | Deviation | (MPa) | Deviation |
| “Diamino-Boc | 0.1% | 2321.3 | 229.7 | 22.29 | 2.13 |
| MINTs with SWNTs of | | | | | |
| 0.75 μm of example | | | | | |
| DD50” | | | | | |

### Example DD52. MINTs Composites by Using Commercial Recycled Polyethylene Terephtalato (rPET)

Step 1. Table DD52-1 summarize the origin of the MINTs for the composites of 0.1% SWNTs with rPET.

| SWNTs amount (%) | MINTs sample | Amount of MINTs | |
|---|---|---|---|
| 0.1% | “Pyrene MINTs of | 14.14 | mg |
| | example DD9” | | |
| | “Acid MINT of Example | 13.45 | mg |
| | AA11b” | | |
| | “Ester MINT of Example | 13.9 | mg |
| | AA11b” | | |
| | “Methyl alcohol MINT of | 14.3 | mg |
| | Example AA11b” | | |
| | 'pyreneamides MINT of | 12.5 | mg |
| | Example EE9B” | | |
| | “Alkene MINT of Example | 12.83 | mg |
| | AA11b” | | |
| | “Chain MINT of Example | 13.17 | mg |
| | AA11b” | | |

Step 2. 10 g of rPET were mixed with the previous MINTs using a twin-extruder.
Step 3. The mixtures were extruded at 275° C., with a recirculation time of 5 minutes.
Step 4. The composites were Hot-pressed to obtain the dog-bones. It was very difficult to take out the dog bones out of the mould. These composites were called: “rPET+0.1% SWNTs”.

### Example DD53. MINTs Composites by Using Commercial Fiber Glass Reinforced Polyethylene Terephtalato (fgPET)

Step 1. Table DD53-1 summarize the origin of the MINTs for the composites of 0.1% SWNTs with fgPET.

| SWNTs amount (%) | MINTs sample | Amount of MINTs | |
|---|---|---|---|
| 0.1% | “SWNTs from OCSiAl” | 10 | mg |
| | “Pyrene MINTs of | 14.14 | mg |
| | example DD9” | | |
| | “Acid MINT of Example | 13.45 | mg |
| | AA11b” | | |
| | “Ester MINT of Example | 13.9 | mg |
| | AA11b” | | |
| | “Methyl alcohol MINT of | 14.3 | mg |
| | Example AA11b” | | |
| | “pyreneamides MINT of | 12.5 | mg |
| | Example EE9B” | | |
| | “Alkene MINT of Example | 12.83 | mg |
| | AA11b” | | |
| | “Chain MINT of Example | 13.17 | mg |

AA11b”

Step 2. 10 g of fgPET were mixed with the previous MINTs using a twin-extruder.
Step 3. The mixtures were extruded at 275° C., with a recirculation time of 5 minutes.
Step 4. The composites were Hot-pressed at 260° C. to obtain the dog-bones. These came out very easily.

The final composites “fgPET composites with 0.1% of SWNTs” were summarize in the Table DD53-2:

| | | Young's | | Tensile | |
|---|---|---|---|---|---|
| | SWNTs | Modulus | Standard | Strength | Standard |
| MINT sample | loading | (MPa) | Deviation | (MPa) | Deviation |
| “fgPET without Twin-extruder | 0% | 12981.95 | 1374.47 | 45.53 | 3.46 |
| treatment” | | | | | |
| “fgPET extruded” | 0% | 9726.5 | 370.22 | 18.68 | 2.55 |
| “SWNTs from OCSiAl” | 0.1% | 9861.71 | 436.11 | 24.11 | 7.16 |
| “Pyrene MINTs of example | 0.1% | 8911.93 | 1423.49 | 25.62 | 6.47 |
| DD9” | | | | | |
| “Acid MINT of Example AA11b” | 0.1% | 11739.45 | 352.4 | 46.36 | 6.85 |
| “Ester MINT of Example AA11b” | 0.1% | 11213.91 | 528 | 39.42 | 4.83 |
| “Methyl alcohol MINT of | 0.1% | 10905.62 | 978.63 | 36.35 | 6.06 |
| Example AA11b” | | | | | |
| “pyreneamides MINT of | 0.1% | 11245.92 | 340.05 | 33.26 | 10.86 |
| Example EE9B” | | | | | |
| “Alkene MINT of Example | 0.1% | 13013.08 | 2295.66 | 26.06 | 22.32 |
| AA11b” | | | | | |
| “Chain MINT of Example | 0.1% | 10288.12 | 646.09 | 36.37 | 5.62 |
| AA11b” | | | | | |

The data shows that comparing the composites with the extruded fgPET there is an improvement in the mechanical properties.

### Example DD54. 1% MINTs Composites by Using Commercial Polylactic Acid (PLA)

Table DD54-1 summarize the amount and the origin of the different MINTs used on the composites with PLA.

| SWNTs amount (%) | MINTs sample | Amount of MINTs | |
|---|---|---|---|
| 1% | “SWNTs from OCSiAl” | 101 | mg |
| | “Pyrene MINTs of example | 142.1 | mg |
| | DD9” | | |
| | “Acid MINT of Example | 135.8 | mg |
| | AA11b” | | |
| | “Ester MINT of Example | 135.8 | mg |
| | AA11b” | | |
| | 'Methyl alcohol MINT of | 131.8 | mg |
| | Example AA11b” | | |
| | “Glycol MINT of Example | 132.45 | mg |
| | AA11b” | | |
| | “Alkene MINT of Example | 129.5 | mg |
| | AA11b” | | |
| | “Chain MINT of Example | 132.9 | mg |

AA11b”

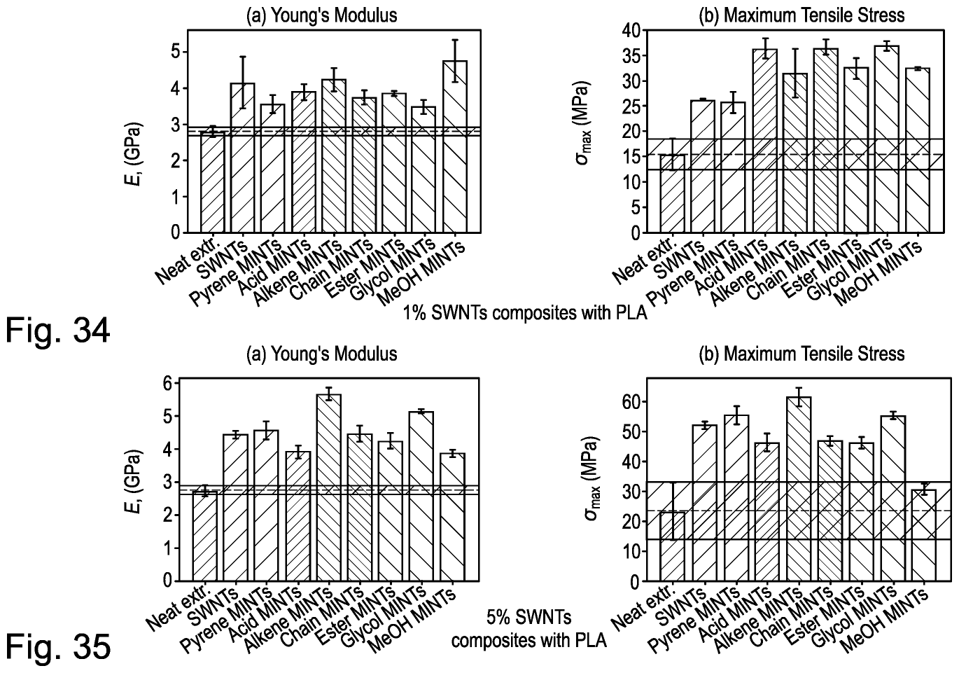

Step 1. Ng of PLA were mixed with the MINTs amounts specified in Table DD54-1 using a twin-extruder.
Step 2. The composites were extruded at 200° C. and a recirculation time of 5 minutes.
Step 3. Then, the mixtures were hot-pressed at 195° C. using 6 Tons of pressure. The dog-bones were demoulded at 95° C. very easily.
Step 4. These dog bones were analysed using an INSTRON. The mechanical results were summarized in the FIG. 34.

Mechanical data of FIG. 34 let it to conclude that the properties of the neat PLA were improved with all the MINTs that were used in the Example DD54. The higher improvement in the Young's Modulus came from the Methyl Alcohol MINTs of example AA7,b and from the Glycol MINTs from example AA11b in the case of the Tensile Strength.

### Example DD55. 5% MINTs Composites by Using Commercial Polylactic Acid (PLA)

Table DD55-1 summarize the amount and the origin of the different MINTs used on the composites with PLA.

| SWNTs amount (%) | MINTs sample | Amount of MINTs |
|---|---|---|
| 5% | “SWNTs from OCSiAl” | 526.3 mg |
| | “Pyrene MINTs of example | 740.2 mg |
| | DD9” | |
| | “Acid MINT of Example | 707.4 mg |
| | AA11b” | |
| | “Ester MINT of Example | 707.4 mg |
| | AA11b” | |
| | “Methyl alcohol MINT of | 698.6 mg |
| | Example AA11b” | |
| | “Glycol MINT of Example | 690.2 mg |
| | AA11b” | |
| | “Alkene MINT of Example | 674.8 mg |
| | AA11b” | |
| | “Chain MINT of Example | 692.5 mg |
| | AA11b” | |

Step 1. 10 g of PLA were mixed with the MINTs amounts summarize in Table DD55-1 using a twin-extruder.
Step 2. The composites were extruded at 200° C. and a recirculation time of 5 minutes.
Step 3. Then, the mixtures were hot-pressed at 195° C. using 6 Tons of pressure. The dog-bones were demoulded at 95° C. very easily.
Step 4. These dog bones were analysed using an INSTRON. The mechanical results were summarized in the FIG. 35.

Mechanical data of FIG. 35 let it to conclude that the properties of the neat PLA were improved with all the MINTs that were used in this example. The higher improvement came from the Alkene MINTs of example AA11b.

### Example DD56. 10% MINTs Composites by Using Commercial Polylactic Acid (PLA)

Table DD56-1 summarize the amount and the origin of the different MINTs used on the composites with PLA.

| SWNTs amount (%) | MINTs sample | Amount of MINTs |
|---|---|---|
| 10% | “SWNTs from OCSiAl” | 1.11 g |
| | “Pyrene MINTs of example | 1.56 g |
| | DD9” | |
| | “Acid MINT of Example | 1.49 g |
| | AA11b” | |
| | “Ester MINT of Example | 1.49 g |
| | AA11b” | |
| | “Methyl alcohol MINT of | 1.48 g |
| | Example AA11b” | |
| | “Glycol MINT of Example | 1.46 g |
| | AA11b” | |
| | “Alkene MINT of Example | 1.42 g |
| | AA11b” | |

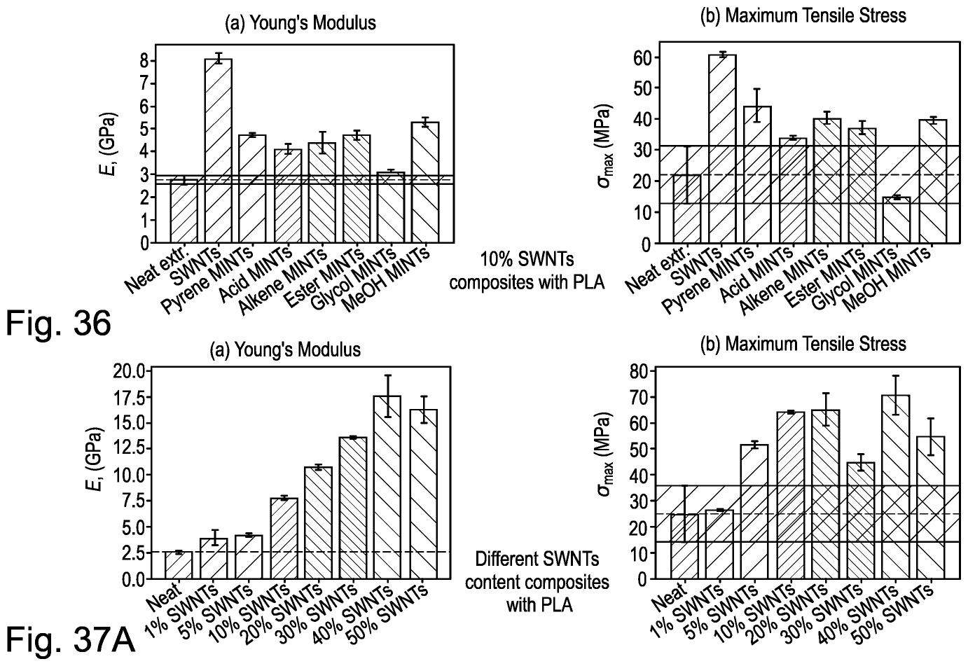

Step 1. 10 g of PLA were mixed with the MINTs amounts summarize in Table DD56-1 using a twin-extruder.
Step 2. The composites were extruded at 200° C. and a recirculation time of 5 minutes.
Step 3. Then, the mixtures were hot-pressed at 195° C. using 6 Tons of pressure. The dog-bones were demoulded at 95° C. very easily.
Step 4. These dog bones were analyse using an INSTRON. The mechanical results were summarized in the FIG. 36.

Mechanical data of FIG. 36 let it to conclude that the properties of the neat PLA were improved with all the MINTs that were used in this example. The higher improvement came from the SWNTs from OCSiAl.

### Example DD57. Higher SWNTs Loading Composites by Using Commercial Polylactic Acid (PLA)

Table DD57-1 summarize the amount of SWNTs used on the composites with PLA.

| SWNTs amount (%) | MINTs sample | Amount of MINTs |
|---|---|---|
| 20% | “SWNTs from OCSiAl” | 2.5 g |
| 30% | “SWNTs from OCSiAl” | 4.3 g |
| 40% | “SWNTs from OCSiAl” | 6.7 g |
| 50% | “SWNTs from OCSiAl” | 10 g |

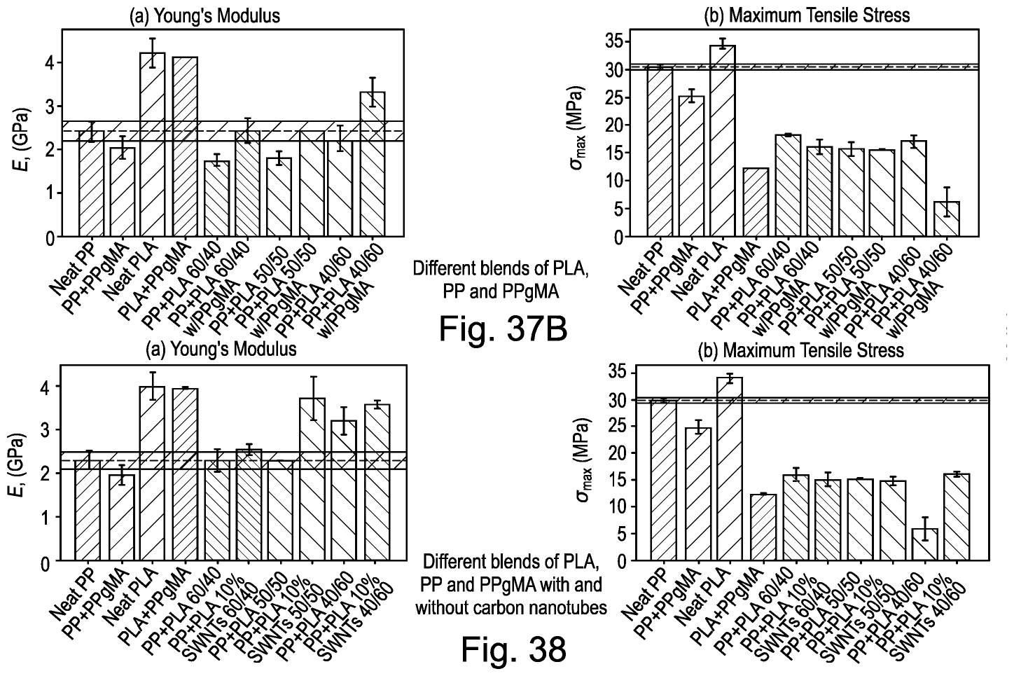

Step 1. 10 g of PLA were mixed with the SWNTs amounts summarize in Table DD57-1 using a twin-extruder.
Step 2. The composites were extruded at 20° C. and a recirculation time of 5 minutes.
Step 3. Then, the mixtures were hot-pressed at 195° C. using 6 Tons of pressure. The dog-bones were demoulded at 95° C. very easily.
Step 4. These dog bones were analyse using an INSTRON. The mechanical results were summarized in the FIG. 37, A.

Mechanical data of FIG. 37, A let it to conclude that higher the content of carbon nanotubes on the sample resulted in higher mechanical properties.

### Example DD58. Thermal Degradation Study of Carbon Nanotubes and Commercial Polylactic Acid (PLA) Composites

Step 1. Composites used on Example DD56 (1%, 5%, 10%, 20% and 30% carbon nanotubes amount) were heated at 195° C. in dog bone moulds. Then they were cooled to 95° C. under 6 Tons of pressure.
Step 2. These dog bones were tested in an INSTRON to know their mechanical properties.

The results of these mechanical's tests were summarized in the Table DD58-1.

| | | Young's | | Tensile | |
|---|---|---|---|---|---|
| | SWNTs | Modulus | Standard | Strength | Standard |
| Sample | loading | (MPa) | Deviation | (MPa) | Deviation |
| Neat PLA (1^{st} press) | 0% | 2737.5 | 173.4 | 24.56 | 10.51 |
| Neat PLA (2^{nd} press) | 0% | 3086.24 | 314.07 | 21.57 | 3.611 |
| Neat PLA (3^{rd} press) | 0% | 2881.82 | 183.52 | 12.80 | 0.84 |
| 1% CNT content (1^{st} press) | 1% | 4169.23 | 731.7 | 26.60 | 0.19 |
| 1% CNT content (2^{nd} press) | 1% | 4453.08 | 530.95 | 11.99 | 0.99 |
| 1% CNT content (3^{rd} press) | 1% | 3212.64 | 0 | 4.31 | 0 |
| 5% CNT content (1^{st} press) | 5% | 4429.06 | 136.32 | 51.93 | 1.01 |
| 5% CNT content (2^{nd} press) | 5% | 4275.83 | 322.36 | 41.17 | 1.55 |
| 5% CNT content (3^{rd} press) | 5% | 4098.38 | 158.52 | 33.02 | 2.90 |
| 10% CNT content (1^{st} press) | 10% | 8041.23 | 250.15 | 63.82 | 0.46 |
| 10% CNT content (2^{nd} press) | 10% | 6712.31 | 151.35 | 51.35 | 4.26 |
| 10% CNT content (3^{rd} press) | 10% | 6213.76 | 203.22 | 45.04 | 2.63 |
| 20% CNT content (1^{st} press) | 20% | 11062.74 | 311.31 | 64.79 | 6.07 |
| 20% CNT content (2^{nd} press) | 20% | 13741.55 | 527.95 | 62.29 | 6.67 |
| 20% CNT content (3^{rd} press) | 20% | 11472.02 | 598.58 | 47.06 | 4.39 |
| 30% CNT content (1^{st} press) | 30% | 14018.18 | 53.76 | 44.65 | 3.28 |
| 30% CNT content (2^{nd} press) | 30% | 14734.52 | 1685.99 | 45.07 | 0.62 |
| 30% CNT content (3^{rd} press) | 30% | 13765.76 | 2062.56 | 31.23 | 6.33 |

### Example DD59. Commercial Polypropylene (PP) and Commercial Polylactic Acid (PLA) Blends

In this example, composites were prepared using different mixes of PP and PLA. PPgMA (polypropylene grafted with maleic anhydride) was used as an agent to help the mixing. Ratios of these composites were summarized in Table DD59-1.

| Sample | PP (%) | PLA (%) | PPgMA (%) |
|---|---|---|---|
| PP | 100 | 0 | — |
| PP/PPgMA | 100 | 0 | 3 |
| PLA | 0 | 100 | — |
| PLAgMA | 0 | 100 | 3 |
| 6/4 PP/PLA | 60 | 40 | — |
| 5/5 PP/PLA | 50 | 50 | — |
| 4/6 PP/PLA | 40 | 60 | — |
| 6/4 PP/PLA | 60 | 40 | 3 |
| with PPgMA | | | |
| 5/5 PP/PLA | 50 | 50 | 3 |
| with PPgMA | | | |
| 4/6 PP/PLA | 40 | 60 | 3 |
| with PPgMa | | | |

Step 1. First, the different samples were extruded with a melting temperature of 200° C. and 5 minutes of recirculation.
Step 2. The samples were hot pressed at 195° C. using 6 Tons of pressure and cooled until 95° C.
Step 3. The dog bones were mechanically analysed at the INSTRON. The results of these mechanical's tests were summarized in the FIG. 37, B.

In FIG. 37, B mechanical data had revealed that the samples that had the PPgMA had better Young's Modulus than the ones without them. In the Young's Modulus region we also could observe a small improvement regards the neat PP, but there wasn't any improvement of the properties regards the neat PLA.

### Example DD60. Commercial Polypropylene (PP) and Polylactic (PLA) Composites Blends

In this example, composites were prepared using different mixes of PP and PLA composites. These PLA composites were explain at Example DD56. Only “PLA+10% SWNTs from Example DD56 were used in Example DD60. It was used PPgMA (polypropylene grafted with maleic anhydride) as an agent to help the mixture. Ratios of these composites were summarized in Table DD60-1.

| Sample | PP (%) | PLA (%) | PPgMA (%) |
|---|---|---|---|
| PP | 100 | 0 | — |
| PP/PPgMA | 100 | 0 | 3 |
| PLA | 0 | 100 | — |
| PLAgMA | 0 | 100 | 3 |
| 6/4 PP/PLA + | 60 | 40 | 3 |
| 10% | | | |
| SWNTs with | | | |
| PPgMA | | | |
| 5/5 PP/PLA + | 50 | 50 | 3 |
| 10% | | | |
| SWNTs with | | | |
| PPgMA | | | |
| 4/6 PP/PLA + | 40 | 60 | 3 |
| 10% | | | |
| SWNTs with | | | |
| PPgMa | | | |

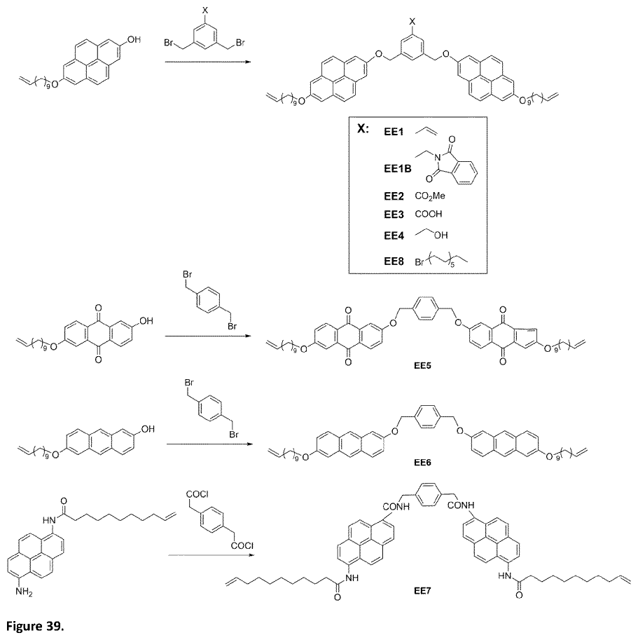

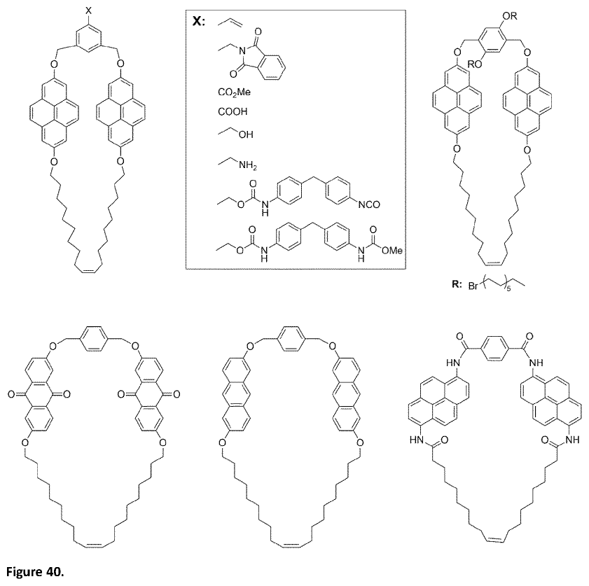

Step 1. First, the different samples were extruded with a melting temperature of 200° C. and 5 minutes of recirculation.
Step 2. The samples were hot pressed at 195° C. using 6 Tons of pressure and cooled until 95° C.
Step 3. The dog bones were mechanically analysed at the INSTRON. The results of these mechanical's tests were summarized in the FIG. 38.

In FIG. 38 mechanical data had revealed that the samples that were made with PLA+10% SWNTs from Example DD56 had higher Young's Modulus than the ones with only neat PLA on them. In the Young's Modulus region we also could appreciated a high improvement regards the neat PP, but there wasn't any improvement of the properties regards the neat PLA.

### Example EE1. Synthesis of Alkene U-Shape

The procedure consists of a first synthesis of the spacer and a second step, where the Ushape is prepared by reaction between the monoalkylated pyrene and the spacer. See FIG. 39.
Step 1: To a flask containing 1,3,5-tris(bromomethyl)benzene (1 g, 2.8 mmol, 1 eq) was added tetrahydrofuran (14 mL).
Step 2: PPh3 (844 mg, 3.2 mmol, 1.15 eq) was added to the flask.
Step 3: The mixture was stirred at 60° C. for 12 h.
Step 4: After cooling at room temperature, the precipitate was recovered by filtration and washed with THF.
Step 5: The solid was dissolved in dichloromethane.
Step 6: Paraformaldehyde (168 mg, 5.6 mmol, 2 eq) and KOH aqueous solution (50%, 3 mL) were then added.
Step 7: Reaction was stirred at room temperature for 1 h.
Step 8: The target product was extracted three times with dichloromethane and then solvent was evaporated.
Step 9: Alkene spacer was obtained after purification by chromatographic column (Hexane: Dichloromethane 9:1) in a 65% yield (520 mg). The product was termed “alkene spacer of Example EE1
Step 10: The synthetized spacer was added to a flask containing 15 mL of N,N′-dimethylformamide.
Step 11: Monoalkylated pyrene (1.5 g, 3.9 mmol, 2.2 eq), K2CO3 (1.1 g, 7.8 mmol, 4.4 eq) and catalytic amount of KI were added to the flask.
Step 12: The mixture was stirred at 80° C. for 6 h.
Step 13: Mixture was cooled and poured over 200 mL of 1M HCl solution at 0° C.
Step 14: Alkene U-shape was recovered by filtration and washed with cold methanol (1.6 g, 99% yield). The structure of the synthesized compound was verified by HR-MS, ¹H NMR and ¹³C NMR. The product was termed “alkene Ushape of Example EE1”.

### Variations on the Above Mentioned Protocol:

In step 2, instead of PPh3, potassium phtalimide (520 mg, 2.8 mmol, 1 eq) was used for the preparation of Phtalimide-spacer. After heating at 80° C. for 12 h, water (200 mL) was added and the product was extracted with ethyl acetate. After chromatographic column in hexane:ethyl acetate 4:1 phtalimide spacer was obtained in a 40% yield (470 mg). The product was termed “Phthalimide spacer of Example EE1B” Phtalimide Ushape was synthetized following Steps 11-14. The structure of the synthesized compound was verified by HR-MS, ¹H NMR and ¹³C NMR. The product was termed “Phthalimide Ushape of Example EE1B”

### Example EE2. Synthesis of Ester U-Shape

The Ushape is prepared by reaction between the monoalkylated pyrene and the commercial ester spacer. See FIG. 40.
Step 1: Methyl 2-(3,5-bis(bromomethyl)phenyl)acetate (5 g, 15.5 mmol, 1 eq) was added to a flask containing 150 mL of N,N′-dimethylformamide
Step 2: Monoalkylated pyrene (12 g, 31 mmol, 2.2 eq), K2CO3 (9.5 g, 68.2 mmol, 4.4 eq) and catalytic amount of KI were added to the flask.
Step 3: The mixture was stirred at 80° C. for 6 h.
Step 4: Mixture was cooled and poured over 500 mL of 1M HCl solution at 0° C.
Step 5: Ester U-shape was recovered by filtration and washed with cold methanol (14 g, 97%). The structure of the synthesized compound was verified by HR-MS, ¹H NMR and ¹³C NMR. The product was termed “ester Ushape of Example EE2”.

### Variations on the Above Mentioned Protocol:

In step 3, instead heating at 80° C. the mixture can be refluxed to obtain acid U-shape in a quantitative yield. The structure of the synthesized compound was verified by HR-MS, ¹H NMR and ¹³C NMR. The product was termed “acid Ushape of Example EE2”.

### Example EE3. Synthesis of Acid U-Shape

The acid Ushape is prepared from ester Ushape (example EE2).
Step 1: ester Ushape of Example EE2 (1.3 g, 1.4 mmol, 1 eq) was added to a flask containing 25 mL of tetrahydrofuran
Step 2: Potassium tertbutoxide (430 mg, 3.8 mmol, 2.7 eq) was added to the solution.
Step 3: The mixture was stirred at for 24 h at room temperature
Step 4. 1M HCl solution (100 mL) was added.
Step 5: Acid U-shape was recovered by filtration and washed with methanol (1.25 g, 97%). The structure of the synthesized compound was verified by HR-MS, ¹H NMR and ¹³C NMR. The product was termed “acid Ushape of Example EE3”.

### Example EE4. Synthesis of Methylalcohol U-Shape

The methylalcohol Ushape is prepared from ester Ushape (example EE2).
Step 1: ester Ushape of Example EE2 (500 mg, 0.57 mmol, 1 eq) was added to a flask containing 10 mL of tetrahydrofuran at 0° C.
Step 2: 1M solution of Lithium Aluminium Hydride in THF (1.14 mL, 1.14 mmol, 2 eq) was added dropwise to the solution.
Step 3: The mixture was stirred at room temperature for 12 h.
Step 4. Water (30 mL) was added.
Step 5: Methylalcohol U-shape was recovered by filtration (500 mg, 99%). The structure of the synthesized compound was verified by HR-MS, ¹H NMR and ¹³C NMR. The product was termed “methylalcohol Ushape of Example EE4”.

### Example EE5. Synthesis of Anthraflavic U-Shape

The anthraflavic Ushape is prepared from commercial anthraflavic acid
Step 1: Anthraflavic acid (1.6 g, 6.67 mmol, 1 eq) was added to a flask containing 93 mL of N,N′-dimethylformamide.
Step 2: Bromoundecene (1.55 g, 6.67 mmol, 1 eq), K2CO3 (926 mg, 6.67 mmol, 1 eq) and catalytic amount of KI were added to the solution.
Step 3: The mixture was refluxed for 24 h.
Step 4: After cooling, the reaction was poured over 300 mL of 1M HCl solution
Step 5: The solid recovered by filtration was purified by chromatographic column in dichloromethane to obtain Monoalkylated anthraflavic acid (500 mg, 30%). The structure of the synthesized compound was verified by HR-MS, ¹H NMR and ¹³C NMR. The product was termed “Monoalkylated anthraflavic acid of Example EE5”.
Step 6: Monoalkylated anthraflavic acid (1.47 g, 3.75 mmol, 1 eq) was dissolved in 50 mL of N,N′-dimethylformamide.
Step 7: p-dibromoxylene (489 mg, 1.88 mmol, 0.5 eq), K2CO3 (563 mg, 4.05 mmol, 1.08 eq) and catalytic amount of NaI were added to the flask.
Step 8: Reaction was stirred at 60° C. for 6 h
Step 9: 100 mL of 1M HCl solution was added
Step 10: anthraflavic ushape was recovered by filtration and washed with methanol (1 g, 60%). The structure of the synthesized compound was verified by HR-MS, ¹H NMR and ¹³C NMR. The product was termed “anthraflavic Ushape of Example EE5”.

### Variations on the Above Mentioned Protocol:

In step 2, instead of bromoundecene, bromotriethyleneglycol can be used for the preparation of Glycol derivated of anthraflavic ushape. The structure of the synthesized compound was verified by HR-MS, ¹H NMR and ¹³C NMR. The product was termed “Glycol derivated of anthraflavic Ushape of Example EE5”

### Example EE6. Synthesis of Anthracene U-Shape

The anthracene Ushape is prepared from commercial anthraflavic acid
Step 1: Anthraflavic acid (3 g, 12.5 mmol, 1 eq) was added to a flask containing of Sodium borohydride (7.13 g, 187.5 mmol, 15 eq) in 1M Na2CO3 aqueous solution (150 mL)
Step 2: The mixture was stirred at room temperature until gas evolution stopped
Step 3: Then, the mixture was stirred 30 min at 80° C.
Step 4: The reaction was acidified with 3M HCl solution
Step 5: Anthracenediol was recovered by filtration and dried (2.5 g, 96%). The structure of the synthesized compound was verified by HR-MS, ¹H NMR and ¹³C NMR. The product was termed “anthracenediol of Example EE6”.
Step 6: anthracene diol (2.5 g, 11.9 mmol, 1 eq) was added to a flask containing 50 mL of acetone
Step 7: Bromoundecene (3.1 g, 13.1 mmol, 1.1 eq), K2CO3 (2.3 g, 16.6 mmol, 1.4 eq) were added to the solution.
Step 8: The mixture was stirred at 60° C. for 16 h.
Step 9: 200 mL of 1M HCl solution was added
Step 10: The solid recovered by filtration was purified by chromatographic column in dichloromethane to obtain Monoalkylated anthracene (500 mg, 32%). The structure of the synthesized compound was verified by HR-MS, ¹H NMR and ¹³C NMR. The product was termed “Monoalkylated anthracene of Example EE6”.
Step 11: Monoalkylated anthracene (500 mg, 1.38 mmol, 2.1 eq) was dissolved in 18 mL of N,N′-dimethylformamide.
Step 12: p-dibromoxylene (175 mg, 0.65 mmol, 1 eq), K2CO3 (200 mg, 1.44 mmol, 2.2 eq) and catalytic amount of NaI were added to the flask.
Step 13: Reaction was stirred at 60° C. for 6 h
Step 14: 100 mL of 1M HCl solution was added
Step 15: Anthracene ushape was recovered by filtration and washed with methanol (230 mg, 44%). The structure of the synthesized compound was verified by HR-MS, ¹H NMR and ¹³C NMR. The product was termed “anthracene Ushape of Example EE6”.

### Example EE7. Synthesis of Pyreneamides U-Shape

The pyreneamides Ushape is prepared from commercial pyrene
Step 1: pyrene (4 g, 20 mmol, 1 eq) was added to a flask containing 40 mL of acetic acid
Step 2: The mixture was heated to 90° C.
Step 3: Concentrated Nitric acid 3.54 mL) was added to the solution dropwise
Step 4: The mixture was stirred 30 min at 90° C.
Step 5: Reaction was cooled to room temperature
Step 6: Mixture of nitropyrenes was recovered by filtration (5.29 g)
Step 7: Mixture of nitropyrenes (5.29 g) were added to a flask containing 31 mL of ethanol and 15 mL mL of tetrahydrofuran
Step 8: Palladium on carbon (110 mg) was added to the mixture and refluxed.
Step 9: Hydrazine monohydrate (7.5 mL) was then added and refluxed for 12 h.
Step 10: After this time, reaction was filtered through paper to remove Palladium
Step 11: The solvent from filtrates was removed and the 1,6-diaminopyrene was obtained by chromatographic column (Dichloromethane: Ethyl acetate 9:1) in a 25% yield (1.2 g). The structure of the synthesized compound was verified by HR-MS, ¹H NMR and ¹³C NMR. The product was termed “1,6-diaminopyrene of Example EE7”.
Step 12: 1,6-diaminopyrene (232 mg, 1 mmol, 1 eq) and triethylamine (131 mg, 1.3 mmol, 1.3 eq) were dissolved in 25 mL of anhydrous tetrahydrofuran
Step 13: undec-10-enoyl chloride (183 mg, 0.9 mmol, 0.9 eq) in 5 mL of tetrahydrofuran was added over the solution at 0° C.
Step 14: The reaction was stirred for 12 h at room temperature
Step 15: Water (100 mL) was added to the reaction
Step 16: The product was extracted with dichloromethane and purified by chromatographic column in dichloromethane (150 mg, 39%). The structure of the synthesized compound was verified by HR-MS, ¹H NMR and ¹³C NMR. The product was termed “Monoamide pyrene of Example EE7”.
Step 17: Monoamide pyrene (150 mg, 0.39 mmol, 2.1 eq) and pyridine (40 mg, 0.19 mmol, 1 eq) were dissolved in 10 mL of tetrahydrofuran.
Step 18: terephthaloyl chloride (38 mg, 0.19 mmol, 1 eq) was added to the mixture.
Step 19: The reaction was stirred for 8 h at room temperature
Step 20: Water (50 mL) was added
Step 21: pyreneamides Ushape was recovered by filtration and washed with acetone (100 mg, 70%). The structure of the synthesized compound was verified by HR-MS, ¹H NMR and ¹³C NMR. The product was termed “Pyreneamides Ushape of Example EE7”.

### Example EE8. Synthesis of Alkyl Substituted Spacer U-Shape

The alkyl substituted spacer U-shape is prepared from commercial hydroquinone
Step 1: hydroquinone (1 g, 9.1 mmol, 1 eq) was added to a flask containing 8 mL of DMSO
Step 2: 1-Bromododecane (4.98 g, 20 mmol, 2.2 eq) was added to the solution.
Step 3: The mixture was stirred at 80° C. for 15 minutes.
Step 4: KOH (2.55 g, 45.5 mmol, 5 eq) was added to the flask
Step 5: Reaction was stirred at 90° C. for 12 hours.
Step 6: After this time, reaction was poured in water and extracted with DCM.
Step 7: Solvent was removed under vacuum obtaining 3 g of product.
Step 8: The product was dissolved in glacial acetic acid (15 mL) at 90° C.
Step 9: Formaldehyde (1 g, 33.5 mmol, 5 eq) and 4.5 mL of HBr in acetic acid (48%) were added to the solution.
Step 10: The mixture was stirred at 80° C. for 8 h.
Step 11: Reaction was poured in water and extracted with DCM.
Step 12: After removing the solvent, the solid was washed with methanol, obtaining pure product (4.1 g, 99%). The structure of the synthesized compound was verified by HR-MS, ¹H NMR and ¹³C NMR. The product was termed “alkyl substituted spacer of Example EE8”.
Step 13: 1.5 g (2.5 mmol, 1 eq) of dibromo spacer was added to a flask containing dry DMF (30 mL)
Step 14: Monoalkylated pyrene (2.02 g, 5.23 mmol, 2.1 eq), K2CO3 (1.45 g, 10.4 mmol, 4.2 eq) and catalytic amount of KI were added to the solution
Step 15: The mixture was stirred at 80° C. for 12 h.
Step 16: Reaction was poured in HCl 1M and filtered.
Step 17: The solid was washed with methanol and dried
Step 18: Dodecane substituted spacer Ushape was obtained. (2.5 g, 82%). The structure of the synthesized compound was verified by HR-MS, ¹H NMR and ¹³C NMR. The product was termed “alkyl substituted spacer U-shape of Example EE8”.

### Variations on the Above Mentioned Protocol:

In step 2, instead of bromododecane, any linear or ramified bromo alkyl chain can be used following the same procedure.

### Example EE9. Preparation of MINTs

In this example, different procedures for the preparation of MINTs through ring closing metathesis using 2^{nd} generation Grubbs catalyst. See FIG. 41.

### Example EE9, A. Wet Method

Step 1: In a round bottom flask containing 1000 mL of TCE, SWNTs (1 g) were added.
Step 2: The SWNTs were dispersed by bath sonication for 5 min
Step 3: 2^{nd} gen. Grubbs catalyst (100 mg, 10 mol %) was added.
Step 4: The suspension was bubbled with argon for 15 minutes
Step 5: Ester U-shape of Example EE2 (1 g, 1.07 mmol) was added and the suspension was stirred for 72 h at room temperature.
Step 6: After this time, the reaction mixture was filtered through a PTFE membrane of 0.2 μm pore size.
Step 7: The filter cake was collected and was re-dispersed in 250 mL dichloromethane in a round-bottom flask by bath sonication for 3 min.
Step 8: The sample was filtered again through a PTFE membrane of 0.2 μm pore size.
Step 9: Steps 7 and 8 were repeated two times
Step 10: Approximately 50 mL Et₂O was added to the filter cake.
Step 11: The Ester MINTs were collected in a vial and dried overnight at room temperature. TGA analysis showed that the functionalization was 28%. The product was termed “ester MINT of Example EE9A”.

The above mentioned protocol was used to make the EE1-EE8 products.

The above mentioned protocol were used with “alkene U-shape of Example EE1”, “Phtalimide U-shape of Example EE1B”, “acid U-shape of Example EE3”, “methylalcohol U-shape of Example EE4”, “anthraflavic acid U-shape of Example EE5”, “anthracene U-shape of Example EE6”, “pyreneamides U-shape of Example 7” and “alkyl substituted spacer U-shape of Example EE8”

The products prepared using the wet method were termed “alkene MINT of Example EE9A” (TGA analysis showed that the functionalization was 28%), “Phtalimide MINT of Example EE9A” (TGA analysis showed that the functionalization was 32%), “acid MINT of Example EE9A” (TGA analysis showed that the functionalization was 27%), “methylalcohol MINT of Example EE9A” (TGA analysis showed that the functionalization was 26%), “anthraflavic acid MINT of Example EE9A” (TGA analysis showed that the functionalization was 36%), “anthracene MINT of Example EE9A” (TGA analysis showed that the functionalization was 32%), “pyreneamides MINT of Example EE9A” (TGA analysis showed that the functionalization was 24%) and “alkyl substituted spacer MINT of Example EE9A” (TGA analysis showed that the functionalization was 28%)

### Example EE9, B. Mechanochemical Method

The method makes use of the mechanical energy generated in a ball mill to disperse the CNTs, and/or bind the Ushape molecule to SWNTs, and/or mediate the ring-closing metathesis.
Step 1: In a 80 mL-size stainless steel ball mill reactor, SWNTs (2.5 g), Ester U-shape of Example EE2 (1.2 g, 1.23 mmol) and 2^{nd} gen. Grubbs catalyst (110 mg, 10 mol %) were added.
Step 2: The reactor was charged with five 15 mm diameter stainless steel balls.
Step 3: The powders were milled for 10 min at 500 rpm in an air atmosphere.
Step 4: After this time, the reactor content was recovered. Dichloromethane (50 mL) was added and the reaction mixture was filtered through a PTFE membrane of 0.2 μm pore size.
Step 5: The filter cake was collected and was re-dispersed in 100 mL dichloromethane in a round-bottom flask by bath sonication for 3 min.
Step 6: The sample was filtered again through a PTFE membrane of 0.2 μm pore size.
Step 7: Steps 5 and 6 were repeated
Step 8: Approximately 50 mL Et₂O was added to the filter cake.
Step 9: The Ester MINTs were collected in a vial and dried overnight at room temperature. The product was termed “ester MINTs of Example EE9B”.

The above mentioned protocol were used with “alkene U-shape of Example EE1”, “Phtalimide U-shape of Example EE1B”, “acid U-shape of Example EE3”, “methylalcohol U-shape of Example EE4”, “anthraflavic acid U-shape of Example EE5”, “anthracene U-shape of Example EE6”, “pyreneamides U-shape of Example 7” and “alkyl substituted spacer U-shape of Example EE8”

The products prepared using the mechanochemical method were termed “alkene MINT of Example EE9B” (TGA analysis showed that the functionalization was 28%), “Phtalimide MINT of Example EE9B” (TGA analysis showed that the functionalization was 34%), “acid MINT of Example EE9B” (TGA analysis showed that the functionalization was 22%), “methylalcohol MINT of Example EE9B” (TGA analysis showed that the functionalization was 27%), “anthraflavic acid MINT of Example EE9B” (TGA analysis showed that the functionalization was 34%), “anthracene MINT of Example EE9B” (TGA analysis showed that the functionalization was 34%), “pyreneamides MINT of Example EE9B” (TGA analysis showed that the functionalization was 26%) and “alkyl substituted spacer MINT of Example EE9B” (TGA analysis showed that the functionalization was 25%)

### Variations on the Above Mentioned Protocol:

In step 1-4, ball mill can be replaced by mortar milling.

### Example EE9, C. Chemical Modification of MINTs

### Example EE10. Methylamine MINTs

Step 1: Phtalimide MINTs of Example EE9A or Example EE9B (650 mg) prepared by mechanochemical or wet method were placed in a flask containing 130 mL of ethanol.
Step 2: The MINTs were dispersed by bath sonication for 5 min.
Step 3: Hydrazine monohydrate (6.5 mL) was added to the suspension.
Step 4: The suspension was then magnetically stirred for 1 h at 80° C.
Step 5: The reaction mixture was filtered through a PTFE membrane of 0.2 μm pore size.
Step 6: The filter cake was collected and was re-dispersed in 100 mL of 1M NaOH solution in a round-bottom flask by bath sonication for 3 min.
Step 7: The sample was filtered again through a PTFE membrane of 0.2 μm pore size.
Step 8: The filter cake was collected and was re-dispersed in 100 mL of dichloromethane in a round-bottom flask by bath sonication for 3 min.
Step 9: The sample was filtered again through a PTFE membrane of 0.2 μm pore size.
Step 10: Steps 9 and 10 were repeated
Step 11: The Methylamine MINTs were collected in a vial and dried overnight at room temperature. The product was termed “Methylamine MINTs of Example EE10”. TGA analysis showed that the functionalization was 30%

### Example EE11. Acid Chloride MINTs

Step 1: “Acid MINTs of Example EE9A” or “Acid MINTs of Example EE9B” (250 mg) (prepared by mechanochemical or wet method) were placed in a flask containing 50 mL of dichloromethane
Step 2: The MINTs were dispersed by bath sonication for 5 min.
Step 3: Oxalyl chloride (100 μL) was added to the suspension at 0° C.
Step 4: The suspension was then magnetically stirred for 3 h at room temperature.
Step 5: The reaction mixture was filtered through a PTFE membrane of 0.2 μm pore size.
Step 6: The filter cake was washed with 50 mL of dichloromethane
Step 7: The acid chloride MINTs were collected in a vial. The product was termed “Acid chloride MINTs of Example EE11”. TGA analysis showed that the functionalization was 26%

### Example EE12. MDI (NCO) MINTs

Step 1: Methylalcohol MINTs of Example EE9A or Example EE9B (250 mg) prepared by mechanochemical or wet method were placed in a flask containing 50 mL of toluene
Step 2: The MINTs were dispersed by bath sonication for 5 min.
Step 3: 1,1′-Methylenebis(4-isocyanatobenzene) (150 mg) was added to the suspension.
Step 4: The suspension was then magnetically stirred for 2 h at 80° C.
Step 5: The reaction mixture was filtered through a PTFE membrane of 0.2 μm pore size.
Step 6: The filter cake was washed with 100 mL of toluene
Step 7: The MDI(NCO) MINTs were collected in a vial. The product was termed “MDI(NCO) MINTs of Example EE12”. TGA analysis showed that the functionalization was 36%

### Example EE13. MDI (OMe) MINTs

Step 1: Methylalcohol MINTs of Example EE9A or Example EE9B (250 mg) prepared by mechanochemical or wet method were placed in a flask containing 50 mL of toluene
Step 2: The MINTs were dispersed by bath sonication for 5 min.
Step 3: 1,1′-Methylenebis(4-isocyanatobenzene) (150 mg) was added to the suspension.
Step 4: The suspension was then magnetically stirred for 2 h at 80° C.
Step 5: Methanol (50 mL) was added to the mixture and refluxed for 2 h.
Step 6: The reaction mixture was filtered through a PTFE membrane of 0.2 μm pore size.
Step 7: The filter cake was washed with 50 mL of toluene and 50 mL of methanol.
Step 8: The MDI(OMe) MINTs were collected in a vial. The product was termed “MDI(OMe) MINTs of Example EE13”. TGA analysis showed that the functionalization was 29%

In this examples, the preparation of covalent bonded MINTs to functionalized polymers is described.

TGA analysis showed that the functionalization was 25%

### Variations on the Above Mentioned Protocol:

In step 1-4, ball milling can be replaced by mortar milling,

In step 5 sonication were omitted.

### Example EE14. Synthesis of Polystyrene Amide-MINT (A)

The procedure consists of a mechanochemical reaction between ester MINTs and amine terminated polystyrene
Step 1: In a 20 mL-size stainless steel ball mill reactor, ester MINTs of Example EE9A or Example EE9B (500 mg), and amine-terminated polystyrene (Mw 5000 g/mol, 800 mg) were added.
Step 2: The reactor was charged with five 5 mm diameter stainless steel balls.
Step 3: The powders were milled for 15 min at 500 rpm in an air atmosphere.
Step 4: After this time, the reactor content was recovered.
Step 5: The blackish solid was placed in an oven at 200° C. for 2 hours.
Step 6: The black solid (5 mg) was placed in a vial containing 20 mL of chloroform.
Step 7: The mixture was bath sonicated for 30 min
Step 8: The suspension was centrifuged for 5 min at 14000 g.
Step 9: The precipitated was removed and the supernatant was concentrated under vacuum.
Step 10: A black solid was obtained containing 15% of carbon nanotubes, approximately, as estimated from TGA. The product was termed “PS-AMIDE-MINTs of Example EE14A”.

### Variations on the Above Mentioned Protocol:

In Step 1, different amine-terminated polystyrene were used: Mw 600 g/mol, 6500 g/mol, 10000 g/mol, 335000 g/mol, 692000 g/mol and, 3530000 g/mol.

### Example EE14. Synthesis of Polystyrene Amide-MINT (B)

Step 1: In a 20 mL-size stainless steel ball mill reactor, Ester MINTs of Example EE9A and Example EE9B (500 mg), and amine-terminated polystyrene (Mw 5000 g/mol, 800 mg) were added.
Step 2: The reactor was charged with five 5 mm diameter stainless steel balls.
Step 3: The powders were milled for 15 min at 500 rpm in an air atmosphere.
Step 4: After this time, the reactor content was recovered.
Step 5: The blackish solid was placed in an oven at 200° C. for 2 hours.
Step 6: The black solid was placed in a 20 mL-size stainless steel ball mill reactor, SWNTs (500 mg), and 2^{nd} gen. Grubbs catalyst (50 mg, 10 mol %)
Step 7: The reactor was charged with five 5 mm diameter stainless steel balls.
Step 8: The powders were milled for 15 min at 500 rpm in an air atmosphere.
Step 9: After this time, the reactor content was recovered.
Step 10: The black solid (5 mg) was placed in a vial containing 20 mL of chloroform.
Step 11: The mixture was bath sonicated for 30 min
Step 12: The suspension was centrifuged for 5 min at 14000 g.
Step 13: The precipitated was removed and the supernatant was concentrated under vacuum.
Step 14: A black solid was obtained containing 15% of carbon nanotubes, approximately, as estimated from TGA. The product was termed “PS-AMIDE-MINTs of Example EE15B”.

In Step 1, different amine-terminated polystyrene were used: Mw 600 g/mol, 6500 g/mol, 10000 g/mol, 335000 g/mol, 692000 g/mol and 3530000 g/mol.

### Example EE14. Synthesis of Polystyrene Amide-MINT (C)

Step 1: In a 40 mL-size stainless steel ball mill reactor, Ester Ushape of Example EE2 (500 mg), amine-terminated polystyrene (Mw 5000 g/mol, 800 mg), SWNTs (500 mg), and and 2^{nd} gen. Grubbs catalyst (50 mg, 10 mol %) were added.
Step 2: The reactor was charged with five 10 mm diameter stainless steel balls.
Step 3: The powders were milled for 15 min at 500 rpm in an air atmosphere.
Step 4: After this time, the reactor content was recovered.
Step 5: The blackish solid was placed in an oven at 200° C. for 2 hours.
Step 6: After this time, the reactor content was recovered.
Step 7: The black solid (5 mg) was placed in a vial containing 20 mL of chloroform.
Step 8: The mixture was bath sonicated for 30 min
Step 9: The suspension was centrifuged for 5 min at 14000 g.
Step 10: The precipitated was removed and the supernatant was concentrated under vacuum.
Step 11: A black solid was obtained containing 15% of carbon nanotubes, approximately, as estimated from TGA. The product was termed “PS-AMIDE-MINTs of Example EE15C”.

In Step 1, different amine-terminated polystyrene were used: Mw 6500 g/mol, 10000 g/mol, 335000 g/mol, 692000 g/mol and 3530000 g/mol.

### Variations on the Above Mentioned Protocol:

Instead of amine terminated polystyrene, different polymers containing a terminal amino group were used (PMMA-NH₂, PEG-NH₂, Poly(N-isopropyl acrylamide)-NH₂)

Instead of ester mints, acid mints were used for the reaction with amine terminated polymers.

Instead of ester Mints, methyl alcohol MINTs can be used for the reaction with isocyanate, bromo or carboxylic acid terminated polymers.

### Example EE14. Synthesis of Polystyrene Amide-MINT (D)

Step 1: In a 50 mL-round bottom flask, acid Ushape of Example EE3 (150 mg), 10 mL of dichloromethane, 100 μL of oxalyl chloride and two drops of N,N′-dimethylformamide were added.
Step 2: Reaction was magnetically stirred at room temperature for 2 hours Step 3: Solvent was removed.
Step 4: amine-terminated polystyrene (Mw 5000 g/mol, 1 equivalent) was dissolved in 20 mL of dichloromethane was added to the flask.
Step 5: 5 drops of triethylamine was added to the solution and the reaction was magnetically stirred for 6 hours.
Step 6: After this time, solvent was removed to obtain “PS-Amide-Ushape of Example EE15D”
Step 7: In a 45 mL-size stainless steel ball mill reactor, 250 mg of PS-Amide-Ushape of Example EE15D, SWNTs (50 mg), and 2^{nd} gen. Grubbs catalyst (10 mol %) were added.
Step 8: The reactor was charged with five 15 mm diameter stainless steel balls.
Step 9: The powders were milled for 10 min at 500 rpm in an air atmosphere.
Step 10: After this time, the reactor content was recovered. Dichloromethane (50 mL) was added, and the reaction mixture was filtered through a PTFE membrane of 0.2 μm pore size.
Step 11: The filter cake was collected and was re-dispersed in 100 mL dichloromethane in a round-bottom flask by bath sonication for 3 min.
Step 12: The sample was filtered again through a PTFE membrane of 0.2 μm pore size.
Step 13: Steps 11 and 12 were repeated Step 14: Approximately 50 mL Et2O was added to the filter cake.
Step 15: The MINTs were collected in a vial and dried overnight at room temperature. The product was termed “PS-AMIDE-MINTs of Example EE15D”.

### Variations on the Above Mentioned Protocol:

In Step 1, different amine-terminated polystyrene were used: Mw 6500 g/mol, 10000 g/mol, 335000 g/mol, 692000 g/mol and 3530000 g/mol.

Instead of amine terminated polystyrene, any polymer containing a terminal amino group can be used (PMMA-NH₂, PEG-NH₂, Poly(N-isopropyl acrylamide)-NH₂, etc)

Instead of acid ushape, ester ushape were used for the reaction with amine terminated polymers.

Instead of acid ushape, methyl alcohol ushape can be used for the reaction with isocyanate, bromo or carboxylic acid terminated polymers.

In these examples, the preparation of several composites samples using 3D printing is described. Depending on the type of polymer and their properties, the 3D printing technique should be selected for optimum results.

### Example FF1. Preparation of Single Walled Carbon Nanotube-Mechanical Ligand Complexes for their Use in Thermoplastic Polymer Reinforcement

In this example, the preparation of single walled carbon nanotube-mechanical ligand complexes (SWNT-ML) is described. The mechanical ligand contains pyrene units as recognition motifs for SWNT.

The obtained SWNT-ML complexes were used in subsequent examples to make polypropylene-SWNT-ML composites using twin-screw microcompounding.
Step 1. 1 g Tuball CNTs (from OCSiAl; diameters ranging from 1.3-2.3 nm) were dispersed in tetrachloroethane (TCE, 1 L, 1 g/L) by sonication in a bath sonicator (10 min).
Step 2. To this dispersion, the Pyrene U-Shape of Example AA1. (0.55 g, 0.65 mmol) was added.
Step 3. The mixture was degassed with N₂ for 20 min and Grubbs' second-generation catalyst was added (0.55 g, 0.65 mmol, 1 equiv. with respect to Pyrene U-Shape of Example AA1).
Step 4. The reaction was maintained for 72 h at room temperature, allowing the ring-closing metathesis reaction to take place.
Step 5. After this time, the suspension was filtered through a 0.2 μm-pore size polytetrafluoroethylene (PTFE) membrane. The solid obtained was removed from the filter and washed with 300 mL dichloromethane employing 10 min sonication. This cleaning procedure was repeated three times, until the filtration solvent was completely colorless. A final wash with Et₂O was performed and the product was dried at 100° C. for 15 min. Approximately, 1.39 g of solid was collected.
Step 6. Steps 1-5 were repeated 9 more times, until approximately 13.89 g of dry product were collected.

The resulting product, SWNTs with covalently closed ring structures around them was termed “Pyrene SWNT-ML of Example FF1.”

A TGA analysis showed that the functionalization was **28%**

### Variations on the Above Mentioned Protocol:

The pyrene Ushape added in Step 1 may be replaced by any other Ushape mentioned in this patent application.

### Example FF2. Preparing a “Master Batch” of 5 wt % Pyrene SWNT-ML—Polypropylene Composite

In this and subsequent examples, two different shear mixers were used.

For small quantities, an Xplore MC 15 twin screw microcompounder was used to mix the composites. It has a base capacity of 15 mL. and a maximum torque value is 9000 N-m. It is equipped with co-rotating and counter-rotating screws and the chamber can be closed to control mixing time, in addition to temperature (up to 450° C.) and mixing speed. However, the raw materials can only be mixed in batches of about 10-15 g at a time. For larger quantities (>400 g), a larger, Brabender KETSE 20/40 EC co-rotating twin screw extruder can be used. It has an integrated drive with a power of 11 kW and reaches speed up to max. 1200 rpm. Output is 0.5-9 kg/h. This allows for continuous mixing of large amount of composite at once. However, the chamber cannot be closed, leaving the only controllable parameters as temperature and screw rotational speed.

In some of the examples below, a ‘master batch’ with a high concentration of CNT is first made, and then diluted with neat polymer to make composites with lower concentrations of CNT.

The size of the Xplore MC 15 twin screw microcompounder chamber limits the amount of composite made at one time to 15 mL. As such, the polypropylene and coated tubes can only be mixed in quantities of about 10 g-15 g.

The polypropylene (PP) used in these composites were Moplen HP400R from Lyondellbasell.
Step 1: In each of 12 containers, 11.167 g of PP and 0.833 g of “Pyrene SWNT-ML of Example FF1” were weighed out and collected.
Step 2: The microcompounder was prepared for mixing at 210° C. with a twin screw rotational speed of 100 rpm. One of the 12 g batches prepared in step 1 was introduced into the chamber, and left to mix for 5 min.
Step 3. The chamber was opened and the PP—Pyrene SWNT-ML composite was extruded from the nozzle and collected.
Step 4. Steps 2-3 were repeated for the remaining 11 containers.
Step 5. The extruded material of the 12 containers was combined and cut up into pellets using a pelletizer for subsequent processing. The resulting composite is hereby referred to as “5% Pyrene SWNT-ML Composite of Example FF2”

The mechanical characteristics were tested by **Tensile Mechanical Testing**. The data are shown in **Example FF5 for compression molded samples and Example FF20 for injection molded samples.**

### Variations on the Above Mentioned Protocol:

In step 1, different thermoplastic polymers, or SWNT-MLs using different Ushape chemistries can be used in place of polypropylene and the Pyrene SWNT-ML to make different polymer-SWNT-ML composites.
Different amounts of SWNT-ML can be used to make composites of different CNT content.
In step 2, different temperatures and twins screw rotational speeds, and mixing times can be employed which may improve the dispersion of the MINTs in the polymer matrix. Additionally, the temperature used will always be dependent on the choice of the polymer matrix.

### Example FF3. Diluting a “Master Batch” to Make Lower Concentration Composites with the Brabender KETSE 20/40 EC

For quantities of material greater than 400 g, the Brabender KETSE 20/40 EC can be used to mix the material much faster and continuously, instead of separating the mixture into smaller batches. We will describe how to dilute the 5% Pyrene SWNT-ML Composite of Example FF2 into 600 g of 1 wt %, 0.1 wt %, and 0.01 wt % Pyrene SWNT-ML-PP composites using the Brabender KETSE 20/40 EC.
Step 1: 120 g of the “5% Pyrene SWNT-ML Composite of Example FF2” and 480 g of PP were thoroughly mixed in a bag to evenly spread out the “5% Pyrene SWNT-ML Composite of Example FF2” pellets among the neat PP polymer.
Step 2: The extruder was prepared for mixing at 180° C. with a twin screw rotational speed of 50 rpm. Lower temperature was used compared to Example FF2 since the concentration of CNTs was lower and overall viscosity of the mixture was also lower. Neat PP was passed through the extruder. As the polymer was poured, careful attention was paid to the torque as to not overload the system (80 Nm torque limit). The polymer was poured into the extruder at a rate that kept the torque at around 50 Nm.
Step 3: The neat PP was extruded from the extruder. Careful attention was made to make sure it came out clear to make sure that there were no contaminates in the extruder. Once it was certain that the polymer was coming out clear, the extruder was allowed to empty as 50 much as it could. Once it stopped extruding, Step 4 was performed
Step 4. The “5% Pyrene SWNT-ML Composite of Example FF2”/PP mixture prepared in step 1 was slowly added to the extruder at a rate that kept the torque around 50 Nm. The residual neat PP is allowed to exit the extruder. Once there was a noticeable color change to black of the filament, the filament was placed on a cooling conveyor belt where it cooled down and then entered the pelletizer to cut into pellets.
Step 5. Once the batch was finished, the end of the filament was cut from the extruder and allowed to cool and pelletize. The pelletized composite was collected and saved. The resulting composite was named “1% Diluted Pyrene SWNT-ML Composite of Example FF3.”
Step 6: Neat polymer was then passed through the extruder until the color of the filament was completely clear again.

Comment: If the next sample is the same polymer and filler, but at a higher concentration of filler, the extruded material does not have to be completely clear, only light enough to notice the change in color when the new composite mixture is added and mixed. However, if the next composite to be mixed is of lower concentration or a different filler, it must be completely clear before mixing the composite.
Step 7: Steps 1-6 were repeated using 12.0 g of the “5% Pyrene SWNT-ML Composite of Example FF2” and 588 g of neat PP to create a 0.1 wt % composite hereby referred to as “0.1% Diluted Pyrene SWNT-ML Composite of Example FF3.”
Step 8: Steps 1-6 were repeated using 1.20 g of the “5% Pyrene SWNT-ML Composite of Example FF2 and 598.8 g of neat PP to create a 0.01 wt % composite hereby referred to as “0.01% Diluted Pyrene SWNT-ML Composite of Example FF3.”

### Variations on the Above Mentioned Protocol:

In step 2, different temperatures and twins screw rotational speeds can be employed to help improve the dispersion of the MINTs in the polymer matrix.
In step 5, the extruded composite can be mixed for a second time to improve dispersion and concentration uniformity. Since the chamber cannot be closed, the mixing time can only be controlled by slowing the screw rotational speed. But a second mixing will increase the total mixing time.

The mechanical characteristics were tested using the tensile mechanical analysis procedure in Example FF4 and The data are shown in Example FF5.

### Example FF4. Sample Preparation of Dog Bones for Tensile Mechanical Testing Analysis

This example describes the procedure for the preparation of dogbone-shaped tensile testing specimen for the “Diluted Pyrene SWNT-ML Composites of Example FF3.”

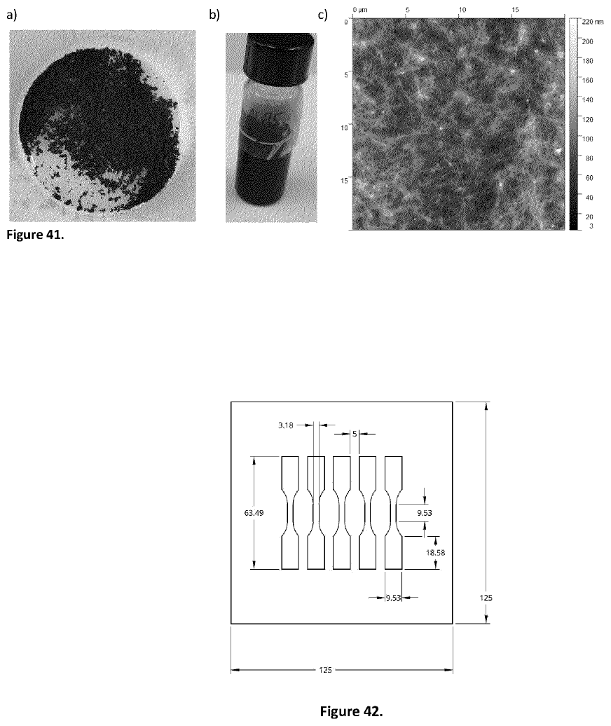

A mold of five dogbones was prepared from a 3 mm thick sheet of aluminum, shown in FIG. 42. The shape of the dogbone was taken as the Type V dogbone as described by ASTM D638.

For sample preparation, Atlas™ Series Heated Platens with the 4000 Series High Stability Temperature Controller were used together with the Atlas™ Manual 15 Ton (15 T) Hydraulic Press, all from Specac, Ltd.
Step 1. On top of a 3 mm thick 125 mm×125 mm square of stainless steel, a 125 mm×125 mm sheet of Kapton film was placed. The mold (FIG. 42) was placed on top of the Kapton film.
Step 2. The mold was filled with pellets of “1% Diluted Pyrene SWNT-ML Composite of Example FF3.” Another 125 mm×125 mm of Kapton film was placed on top, and then another 125 mm×125 mm stainless steel plate.
Step 3. The heated platens were preheated to 180° C. Then the steel-Kapton-mold-Kapton-steel sandwich from step 2 was placed between the two platens. Then allowed to sit for about 5 minutes without adding pressure.
Step 4. Pressure between the platens was increased pressure to 10 ton by 2.5 ton increments with the pressure released between each increment to allow the mold to “breathe.” (2.5 tons, release, 5 tons, release, 7.5 tons, release, 10 tons, release. Then to 10 tons again).
Step 5. Temperature was held at 180° C. at 10 tons for 10 minutes.
Step 6. Temperature controller was set to 60° C. Pressure was kept at 10 tons as sample cooled. Once at 60° C., pressure was released.
Step 7. Samples were removed from mold. These samples were known as 1% Diluted Pyrene SWNT-ML Composite Dogbones of Example FF4.
Step 8. Steps 1-7 were repeated with both 0.1% Diluted Pyrene SWNT-ML Composite of Example FF3 and 0.01% Diluted Pyrene SWNT-ML Composite of Example FF3 to make 0.1% Diluted Pyrene SWNT-ML Composite Dogbones of Example FF4 and 0.01% Diluted Pyrene SWNT-ML Composite Dogbones of Example FF4, respectively. Additionally, dogbones were also prepared for neat polypropylene using the same process as a control, to make neat polypropylene dogbones of Example FF4.

### Example FF5. Tensile Mechanical Testing of Pyrene SWNT-ML-Polypropylene Composite Dogbones

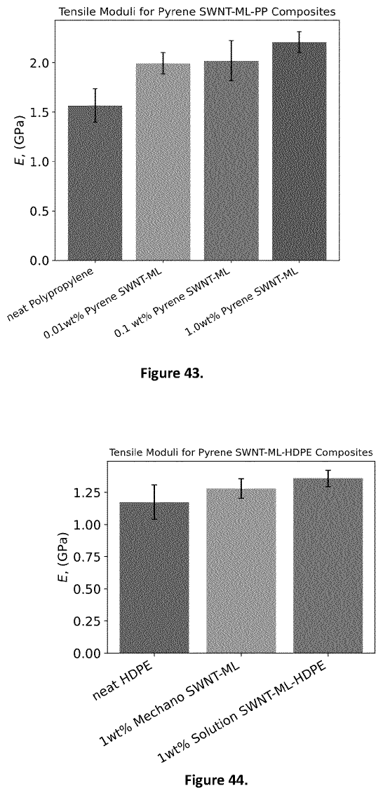

For Tensile tests, an Instron 34-TM tensile testing machine was used with a 10 kN load cell.
Step. 1. The mechanical wedge tensile testing grips of the Instron 34-TM tensile testing machine were separated at a distance of 25 mm. A dogbone of 1% Diluted Pyrene SWNT-ML Composite Dogbones of Example FF4 was place between the grips and the grips were tightened. A tensile strain gauge extensometer with a 10 mm gauge length was then placed around the narrow region of the dogbone.
Step 2. The dogbone was strained at a rate of 1 mm/min until the sample broke.
Step 3. The Young's Modulus of the sample was calculated based on ASTM D638 from the slope of the stress strain curve, listed in the table below and plotted in FIG. 43
   Young's modulus data as measured from tensile testing experiments for Pyrene SWNT-ML-PP dogbones prepared in Example FF4. Also shows relative increase in modulus for each composite compared to the neat polymer.

| | Young's Modulus | Relative Modulus |
|---|---|---|
| Sample | (GPa) | Increase |
| neat polypropylene | 1.57 ± 0.17 | — |
| 0.01 wt % Pyrene | 1.99 ± 0.11 | 27.1 ± 6.9% |
| SWNT-ML-PP | | |
| 0.1 wt % Pyrene SWNT-ML-PP | 2.02 ± 0.20 | 28.9 ± 13.0% |
| 1.0 wt % Pyrene SWNT-ML-PP | 2.21 ± 0.11 | 40.9% ± 6.8% |

### Example FF 6. Preparation of SWNT-ML by Mechanical Grinding for Thermoplastic Polymer Composite Using Twin Screw Microcompounding

This example employs manual grinding, to produce SWNT-ML complexes, which are then used to make high-density polyethylene (HDPE)-SWNT-ML composites. We use a twin screw microcompounder to produce carbon nanotube thermoplastic nanocomposite.
Step 1: 1.0 g Tuball CNTs (OCSiAl S.a.r.l.) were mixed with 0.420 mg pyrene Ushape, 0.48 μmol Ushape/mg CNT) and 203.8 mg of Grubb's catalyst (2 mol Ushape/1 mol Grubb's Catalyst) and placed in a mortar.
Step 2: CNTs, Ushape, and Grubbs catalyst were grinded with mortar and pestle for 30 min, creating coated SWNT-ML complexes.
Step 3: The coated CNTs were placed in about −300 mL of chloroform and vacuum filtrated using a 0.2 μm pore filter
Step 4: The filter cake (approximately 1.4 g) was placed in another 300 mL of chloroform and bath sonicated 10 min, and then filtered again via vacuum filtration
Step 5: Step 4 was repeated 2 more times
Step 6: Step 4 was repeated once using 300 mL of diethyl ether instead of chloroform
Step 7: The filter cake was dried for 24 hr at 150° C. The resulting product was called “Mechano synthesized pyrene SWNT-ML of Example FF6.”
Step 8:
The final product of Step 7 was analyzed by TGA. From the TGA the degree of functionalization (amount of Ushape relative to amount of SWNT) was determined to be 27.5%.

### Variations to the Above Protocol:

The pyrene Ushape added in Step 1 may be replaced by any of the Ushapes mentioned in this patent application.

### Example FF7. Preparing 1% Concentration High Density Polyethylene Composites with the Xplore MC 15 Twin Screw Microcompounder

We will describe how to make 1 wt % Pyrene SWNT-ML-high density polyethylene (HDPE) using the Mechano synthesized pyrene SWNT-ML of Example FF6. Additionally, we will make 1% pyrene SWNT-ML composites using solution processed pyrene SWNT-ML as made via the procedure in Example FF1 for comparison.
Step 1: In each of 5 containers, 14.79 g of HDPE (Sigma-Aldrich, melt index 12 g/10 min, 90° C./2.16 kg) and 0.206 g of Mechano synthesized pyrene SWNT-ML of Example FF6 were weighed out and collected.
Step 2: The microcompounder was prepared for mixing at 190° C. with a twin screw rotational speed of 100 rpm. The 12 g batch prepared in step 1 was introduced into the chamber, and left to mix for 5 min.
Step 3. The chamber was opened and the HDPE-Pyrene SWNT-ML composite was extruded from the nozzle and collected.
Step 4. Steps 2-3 were repeated for the remaining 4 containers.
Step 5. The extruded material of the 5 containers was combined and cut up into pellets using a pelletizer for subsequent processing. The resulting composite is hereby referred to as 1% Mechano Pyrene SWNT-ML HDPE Composite of Example FF7.
Step 6. After cleaning, Steps 1-5 were repeated with 14.8 g HDPE and 0.1974 g of solution synthesized pyrene SWNT-ML that were made following the procedure outlined in Example FF1. These SWNT-ML had a functionalization of 24%. The resulting composite is hereby referred to as 1% Mechano Pyrene SWNT-ML HDPE Composite of Example FF7
Step 7. After cleaning, Steps 1-5 were also repeated with 15 g HDPE for a neat control sample. This produces neat extruded HDPE of Example FF7.

### Variations to the Above Protocol:

In step 1, different thermoplastic polymers, or SWNT-MLs using different Ushape chemistries can be used in place of polypropylene and the Pyrene SWNT-ML to make different polymer-SWNT-ML composites.
Different amounts of SWNT-ML can be used to make composites of different CNT content.
In step 2, different temperatures and twins screw rotational speeds, and mixing times can be employed which may improve the dispersion of the MINTs in the polymer matrix. Additionally, the temperature used will always be dependent on the choice of the polymer matrix.

### Example FF8. Sample Preparation of HDPE Composite Dogbones for Tensile Mechanical Testing Analysis

Step 1. The procedure outlined in Example FF4 is followed to prepared dogbone tensile testing samples for 1) 1% Mechano Pyrene SWNT-ML HDPE Composite of Example FF7, 1% Mechano Pyrene SWNT-ML HDPE Composite of Example FF7, and neat extruded HDPE of Example FF7. Only changes are to Step 3 and Step 5, where the temperature used is 150° C.
Step 2. The procedure outlined in Example FF5 was followed for mechanical property testing of the dogbones. The resulting measurements are shown in FIG. 44 and listed in the table below.
   Young's modulus data as measured from tensile testing experiments for Pyrene SWNT-ML-PP dogbones prepared in Example FF4. Also shows relative increase in modulus for each composite compared to the neat polymer

| | Young's Modulus | Relative Modulus |
|---|---|---|
| Sample | (GPa) | Increase |
| neat HDPE | 1.17 ± 0.13 | — |
| 1 wt % Mechano Pyrene | 1.28 ± 0.08 | 9.02 ± 6.40% |
| SWNT-ML-HDPE | | |
| 1 wt % Solution Pyrene | 1.36 ± 0.06 | 15.7 ± 5.41% |
| SWNT-ML-HDPE | | |

### Example FF9. Preparing Low Density Polyethylene Composites by Melt Mixing

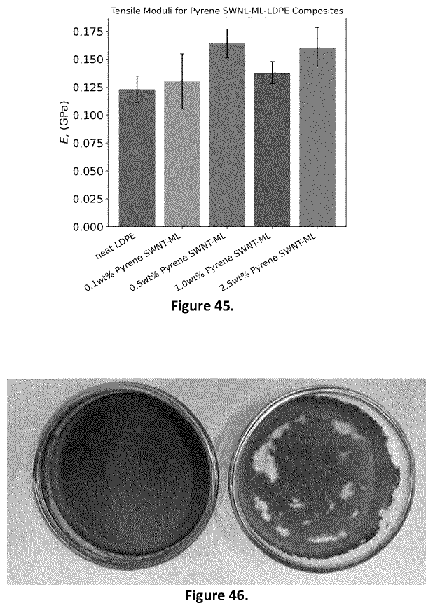

Low density polyethylene (LDPE, Sigma Aldrich, melt index 25 g/10 min (190° C./2.16 kg))-SWNT-ML composites made using previously described methods are described.
Step 1. The procedure outlined in Example FF2 was adapted with the following changes:
   1) SWNT-ML were prepared using mechanosynthesized SWNT-ML as described in Example FF6. They had a functionalization of 23.5%
   2) The desired concentration of the master batch was 2.5 wt % SWNT-ML. 7 batches of 13 g per batch were prepared with 12.58 g LDPE and 424 mg SWNT-ML.
   3) Each batch was mixed at 190° C. at 125 rpm for 5 min
This produced “2.5% Pyrene SWNT-ML LDPE Composite of Example FF9.”
Step 2. The procedure outlined in Example FF2 was adapted to the following changes.
   Using batches of 11 g, consisting of 0.44 g 2.5% Pyrene SWNT-ML LDPE Composite of Example FF9 and 10.56 g neat LDPE were mixed together at 190° C. at 125 rpm for 5 min. 4 batches in total were mixed. The collected composite was called “0.1 wt % Diluted Pyrene SWNT-ML LDPE Composite of Example FF9”
Step 3. Step 2 was repeated with batches of 2.2 g of 2.5% Pyrene SWNT-ML LDPE Composite of Example FF9 and 8.80 g of neat LDPE. 4 batches in total were mixed. The collected composite was called “0.5 wt % Diluted Pyrene SWNT-ML LDPE Composite of Example FF9”
Step 4. Step 2 was repeated with batches of 4.4 g of 2.5% Pyrene SWNT-ML LDPE Composite of Example FF9 and 6.60 g of neat LDPE. 4 batches in total were mixed. The collected composite was called “1.0 wt % Diluted Pyrene SWNT-ML LDPE Composite of Example FF9”
Step 5. After cleaning, The procedure outlined in Example FF2 was also also repeated with 4 batches of 11 g/batch LDPE for a neat control sample. This produces neat extruded LDPE of Example FF9.
Step 6. The procedure outlined in Example FF4 is followed to prepared dogbone tensile testing samples for 1) 2.5% Pyrene SWNT-ML LDPE Composite of Example FF9, 0.1 wt % Diluted Pyrene SWNT-ML LDPE Composite of Example FF9, 0.5 wt % Diluted Pyrene SWNT-ML LDPE Composite of Example FF9, 1.0 wt % Diluted Pyrene SWNT-ML LDPE Composite of Example FF9, and neat extruded LDPE of Example FF9. Only changes are to Step 3 and Step 5, where the temperature used is 150° C.
Step 7. The procedure outlined in Example FF5 was followed for mechanical property testing of the dogbones. The resulting measurements are shown in FIG. 45 and listed in the table below.

| | Young's Modulus | Relative Modulus |
|---|---|---|
| Sample | (MPa) | Increase |
| neat LDPE | 122.99 ± 11.79 | — |
| 0.1 wt % Diluted Pyrene | 130.08 ± 24.65 | 5.76 ± 20.04% |
| SWNT-ML-LDPE | | |
| 0.5 wt % Diluted Pyrene | 164.07 ± 12.94 | 33.33 ± 10.52% |
| SWNT-ML-LDPE | | |
| 1.0 wt % Diluted Pyrene | 138.08 ± 10.04 | 12.27 ± 8.16% |
| SWNT-ML-LDPE | | |
| 2.5wt % Pyrene SWNT-ML-LDPE | 160.64 ± 17.53 | 30.61 ± 14.25% |

### Example FF10. Preparation of Single Walled Nanotube-ML-PVA Complexes

The preparation of water-dispersible polyvinyl alcohol (PVA)-SWNT-ML complexes comprising 50 wt % CNT are described in this example.
Step 1. Example EE9, B was followed using “Acid Ushape of Example EE3” to make “Carboxylic Acid SWNT-ML complexes of Example FF10”,
Step 2: In a glass vial 164 mg of PVA (Sigma-Aldrich, M,: 89,000-98,000, 99+% hydrolyzed) was mixed with 336 mg “Carboxylic Acid SWNT-ML complexes of Example FF10”, 88.7 mg 4-(dimethylamino)pyridine (DMAP, Sigma-Aldrich), 171 mg 1-hydroxybenzotriazole hydrate (HOBT, Sigma-Aldrich) and 517 mg N,N′-Dicyclohexylcarbodiimide (DCC) with 15 mL of dimethyl sulfoxide (DMSO).
Step 3. Vial was heated to 120° C. under magnetic stirring for 1 hr.
Step 4. Mixture was stirred overnight at 60° C.
Step 5. Bath sonicated for 2 hr Step 6. The next day, sample was precipitated in an acetone bath under magnetic stirring.
Step 7. Precipitate was collected, filtered using vacuum filtration, and washed twice with about 300 mL of acetone per wash.
Step 8. Washed precipitate was dried at 100° C. overnight. The resulting material is referred to as “50% Carboxylic Acid SWNT-ML-PVA Composite of Example FF10.”
Step 9. For comparison, Steps 1-8 was performed in parallel using 250 mg of as-purchased carbon nanotubes (Tuball, OCSiAl) instead of “Acid Ushape of Example EE3” and 250 mg of PVA. Same amounts of DMAP, HOBT, and DCC were used. Note, at steps 5-6, resulting precipitate was more gel like and more difficult to filter than the sample made with carboxylic acid SWNT-ML. The resulting material is referred to as “50% SWNT-PVA Composite of Example FF10.”

### Variations on the Above Mentioned Protocol:

In step 2, Different amounts of Carboxylic Acid SWNT-ML can be used to make composites of different CNT content.
In step 2, may be desirable to use smaller amounts or larger amounts of DCC, HOBT, and DMAP.
Different amounts of heating and sonication times in steps 2-4 may be used to help improve tube dispersion.
In step 2, more DMSO may be used to help facilitate tube dispersion as well.

### Example FF11. Preparation of Single Walled Carbon Nanotube-Mechanical Ligand-PVA Films from Aqueous Dispersions

Step 1. 50 mg of “50% Carboxylic Acid SWNT-ML-PVA Composite of Example FF10” was mixed with 5 mL of deionized water. The mixture was stirred overnight at 90° C.
Step 2. Mixture was bath sonicated for 1 hr.
Step 3. Mixture was poured into a 3 cm diameter glass petri dish. Film was dried at 80° C. overnight. The resulting film is referred to as “50% Carboxylic Acid SWNT-ML-PVA Film of Example FF11.”
Step 4. Steps 1-3 were repeated in parallel with 50% SWNT-PVA Composite of Example FF10 to make “50% SWNT-PVA Film of Example FF11.”
Step 5. The thickness of each of the films is measured using a Dektak Profilometer and the sheet resistance was measured using the Van der Pauw method on a four-probe station. The results are listed in Table. FF11.1. Given the quality of the films shown in FIG. 46 it is no surprise the
50% Carboxylic Acid SWNT-ML-PVA film of Example FF11 is much thicker and much more conductive than the 50% SWNT-PVA film.

TABLE FF11.1
Thickness and Conductivity data for the SWNT-PVA Films

| | | 50% Carboxylic Acid |
|---|---|---|
| | 50% SWNT-PVA | SWNT-ML-PVA |
| Thickness (μm) | 6.41 ± 1.57 | 91.33 ± 2.56 |
| Conductivity | 0.031 ± 0.008 | 0.514 ± 0.052 |
| (S/cm) | | |

### Variations to the Above Protocol:

In step 1, different amounts of water or PVA composite can be used to try different CNT concentrations.
In steps 1-2 different mixing times, temperature of mixing, and sonication times can be used to help improve dispersion
In step 4, different size substrates can be used to cast the film onto. Additionally, other casting methods, such as spin coating, can also be explored.

Each of the four films can be seen in FIG. 46. Three of the four films visually homogeneous, black, and opaque. Only 50% SWNT-PVA Film of Example FF11 had a poor, non-uniform film quality, leading to its poor conductivity.

### Example FF12. Protocol for SWNT-ML Carbon Nanotube—Epoxy Nanotube Composite Sample Preparation Using Shear Mixing

In this example, we use a combination of shear mixing and compression molding to produce a high carbon nanotube content epoxy nanocomposite using mechanically interlocked carbon nanotubes (MINTs).

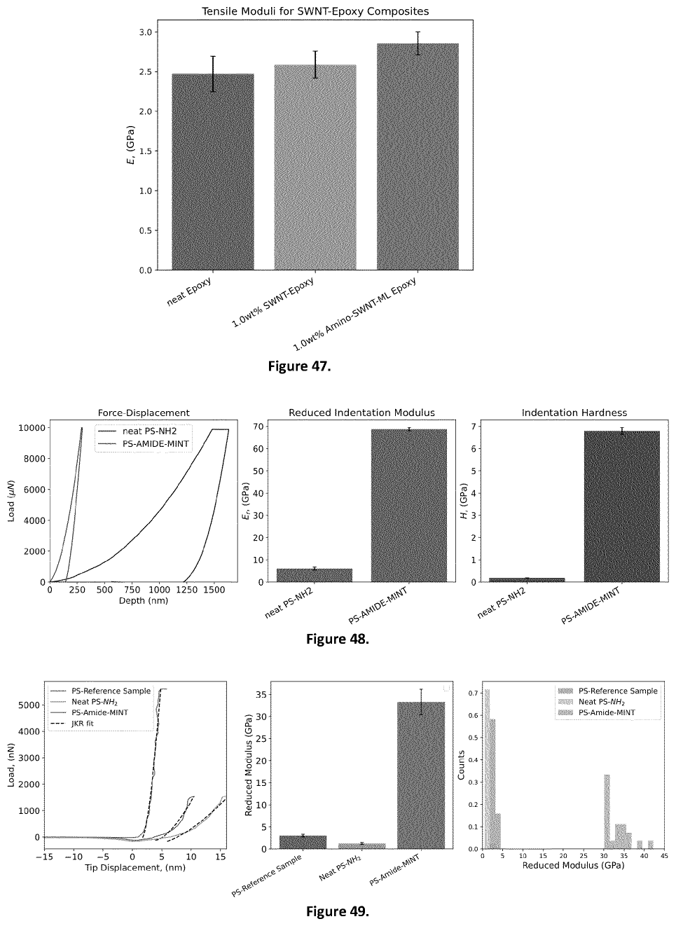

The experiment describes the making of a 1 wt % carbon-nanotube epoxy composite, but concentration and chemical composition can be adjusted accordingly. In the example, the mechanical ligands (rings) of the sized CNT becomes covalently linked to the epoxy polymer.
Step 1: 20.0 g diglycidyl ether of bisphenol A (DGEBA, Sigma-Aldrich), monomer is heated in an oven to ˜60° C. to reduce the monomer viscosity and the desired amount is weighed in a glass beaker. 392.67 mg “Methylamine MINTs of Example EE10” were added to the glass beaker.
Step 2: The DGEBA-Mint mixture was placed under the IKA T 25 digital ULTRA-TURRAX with S 25 N-18 G mixer and shear mixed at the maximum 10,000 rpm for 3 hr.
Step 3: The rotation speed of the mixture was reduced to 100 rpm for 5 min to promote degassing.
Step 4: After the mixing, the DGEBA-MINT mixture was placed in a vacuum oven at 80 C. A vacuum is pulled for 30 min to remove trapped gases as much as possible.
Step 5: The stoichiometric amount of hardener, Poly(propylene glycol) bis(2-aminopropyl ether) (MW: 230 g/mol, Sigma-Aldrich, also known as Jeffamine D-230) is added to the DGEBA-MINT mixture (with about 5% excess). For Jeffamine-D230 in the system described in step 3, that was 7.09 g. This mixture was then mixed by hand for approximately 1 min to avoid introducing more bubbles.
Step 6: After mixing, the mixture was then brought to the hot press, which was heated to 80° C. A 2 mm thick steel mold of a 70 mm×70 mm rectangle was placed on top of a Teflon sheet and another steel plate. The uncured mixed resin was then poured in the mold in slight excess. Another Teflon sheet and steel plate was then placed on top.
Step 7: 5,000 kg of Pressure was placed on the sample. This pressure was then released to help remove trapped gas. Repeat 3-4 more cycles of 5,000 kg of pressure and release.
Step 8: After cycling, 10,000 kg of pressure was applied on the sample. The sample was then cured at 80° C. for overnight.
Step 9: The sample was removed from press and mold. Fourier transform infrared spectroscopy was used to check the cure by monitoring epoxide peaks at 770 cm⁻¹ and 914 cm⁻¹. If these peaks are still present, place sample back in hot press, add 10,000 kg press, increase cure to 200° C. and check cure with FTIR every hour until fully cured. The resulting composite is from here referred to as the “1.0 wt % Amino SWNT-ML-Epoxy Composite of Example FF12.”
Step 10. Steps 1-9 were repeated twice, once without any fillers (no SWNT-MT) to produce a “neat Epoxy Composite of Example FF12” control sample, and again with 273.68 mg of as-purchased carbon nanotubes (Tuball, OCSiAl) to make “1.0 wt % SWNT-Epoxy Composite of Example FF12.”
Step 11: The cured epoxy rectangles were then cut into dogbone shapes (see FIG. 42.) using a high-velocity water jet cutter. These samples are measured on a tensile tester per Example FF5. The resulting tensile moduli are reported in FIG. 47 and the table below, showing an increase in modulus for the Amino SWNT-ML-Epoxy that is outside the standard deviation, and larger in magnitude than that of the SWNT-ML-Epoxy.
   Young's modulus data as measured from tensile testing experiments for Amino SWNT-ML-Epoxy dogbones prepared in Example FF12. Also shows relative increase in modulus for each composite compared to the neat polymer.

| | Young's Modulus | Relative Modulus |
|---|---|---|
| Sample | (GPa) | Increase |
| neat polypropylene | 2.47 ± 0.22 | — |
| 1.0 wt % SWNT-Epoxy | 2.59 ± 0.17 | 4.7 ± 6.9% |
| 1.0 wt % Pyrene SWNT-ML-PP | 2.86 ± 0.15 | 15.6% ± 5.9% |

### Variations to the Above Protocol:

In step 1. The chemistry of the mechanically interlocked ring around the CNTs can be modified to experiment with the effect of this functionalization on the dispersion and mechanical dispersion. Namely, amine derivatives of the ring can react with the epoxy backbone to covalently bond the MINTs to the epoxy matrix. However, the quantity of hardener needs to be reduced ensure stoichiometry.
In step 1, the chemistry of the epoxy can be modified to experiment with the effect different hardeners and epoxy backbones to see the effect on MINT dispersion and mechanical reinforcement
In step 2, the speed and mixing time can be modified to improve dispersion.
Before shear mixing, probe sonication can be used for a short amount of time to help break up large initial MINT agglomeration. However, as MINTs increase the viscosity of the mixture, sonication will become less effective.
Before step 1, the MINTs, which can start out as large agglomerated chunks, and be mechanically broken up to help reduce the initial size of the MINTs. Using a blade mixer/blender to start out with smaller mints could help.
Different cure temperatures and times can be experimented in Step 9.

### Example FF13. Nanoindentation of PS-AMIDE-MINTs

In this example, we test the mechanical properties of PS-AMIDE-MINTs of Example EE15C using nanoindentation. See FIG. 48.
Step 1. PS-AMIDE-MINTs of Example EE15C was dried on a flat surface to create a smooth flat film of approximately 200 μm in thickness. This sample was glued to a magnetic disc
Step 2. Using a diamond Berkovich tip on a Bruker Hysitron TS 77 Select, 9 indents were performed on the surface of the composite in a 3×3 array. The maximum force was set to 10 mN. The surface was indented at an indentation displacement rate of 0.1 s⁻¹ until reaching the max force of 10 mN where the maximum force was held for 30 sec. The force was then unloaded over the course of 2 seconds.
Step 3. The slope of the unloading curve was used to calculate the reduced elastic modulus and indentation hardness using the Oliver-Pharr model. The results are shown in FIG. 48 and listed in the table below.
Step 4. Steps 1-3 were repeated with neat amine-terminated polystyrene (neat PS—NH₂) (Mw 5000) as a control, prepared the same way as PS-AMIDE-MINTs of Example EE15C, except without any MINTs. We will refer to this sample as neat PS—NH₂ of Example FF13.

| | Reduced Modulus | |
|---|---|---|
| Sample | (GPa) | Hardness (GPa) |
| neat PS-NH₂ | 6.06 ± 0.70 | 0.182 ± 0.005 |
| PS-AMIDE-MINT | 68.67 ± 0.77 | 6.79 ± 0.16 |

### Example FF14. AFM Nanoindentation of PS-AMIDE-MINTs

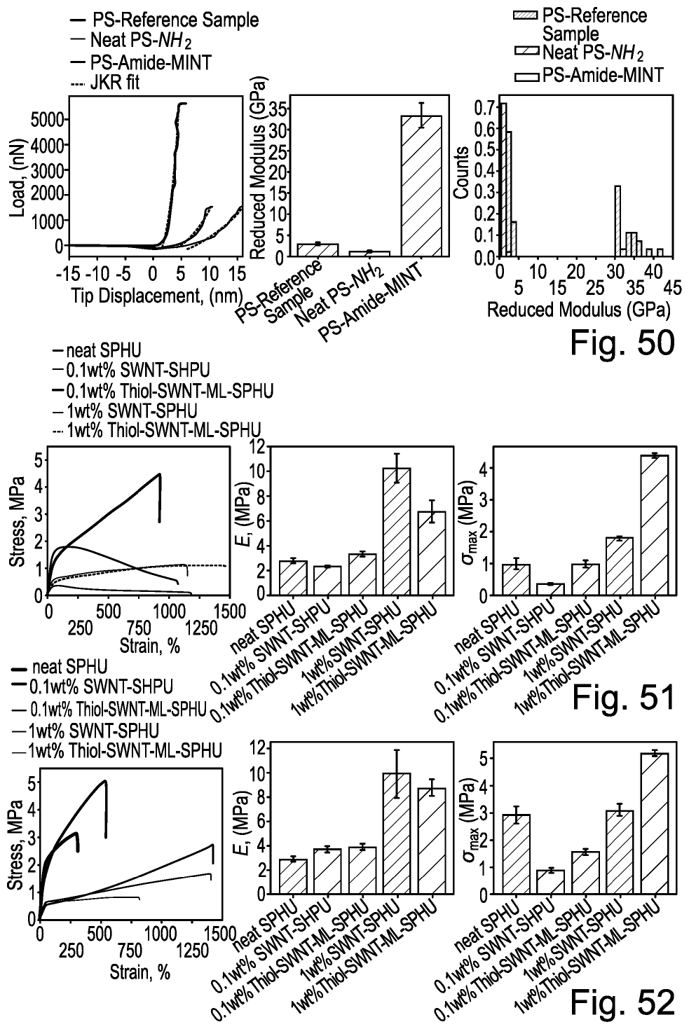

In this example, we test the mechanical properties of PS-AMIDE-MINTs of Example EE15C using Atomic force microscopy (AFM) nanoindentation. The AFM used in this example was a JPK Nanowizard II AFM. See FIG. 50.
Step 1. Hemispherical cone shape tips (HSC60-250, Nano-tec, Inc.) with a nominal spring constant of 250 N/m were calibrated using the Sader Method to measure a real cantilever stiffness of 128 N/m.
Step 2. The deflection sensitivity of the AFM tip was measured using a sapphire reference sample and measured to be 28.3 nm/V.
Step 3. A reference polystyrene sample (PS-Film, Bruker) with a measured modulus of 2.7 GPa was then indented at maximum applied force of 4V at 64 different points in an 8×8 array. 10 indentations were taken at every point for a total 640 force displacement curves.
Step 4. Step 3 was repeated for neat PS—NH₂ of Example FF13
Step 5. Step 3 was repeated for PS-AMIDE-MINTs of Example EE15C. Except the applied force was increased to 1.5V.
Step 6. Using the Johnson-Kendall-Roberts Contact mechanical model, and the fact that the nominal modulus of the PS-reference sample was 2.7 GPa, the tip radius was determined to be 609 nm
Step 7. Using the Johnson-Kendall-Roberts Contact mechanical model and a tip radius of 609 nm, the reduced elastic modulus (Eᵣ) was measured for each force-displacement curve for each sample. Fitted curves with R² values below 0.95 were removed from the average calculation. The data is presented in FIG. 49 and shown in the table below. The fact that the reference PS sample gives a value close to 2.7 GPa tells us we can have good confidence in the other modulus measurements.

| Sample | Reduced Modulus (GPa) |
|---|---|
| Reference PS | 3.02 ± 0.307 |
| neat PS-NH₂ | 1.27 ± 0.23 |
| PS-AMIDE-MINT | 33.28 ± 2.88 |

### Example FF15. Preparation of Self-Healable Polyurethane-Thiol MINT Composites with 0.1 wt % CNT Content

In this example, the preparation of 0.1 wt % Thiol SWNT-ML-self-healing isophorone based polyurethane using Hand-Mechanosynthesized Thiol SWNT-ML of Example GG7-e1.

Additionally, we describe how we made 0.1 wt % SWNT—self-healing isophorone based polyurethane composites and neat-self-healing isophorone based polyurethane used as a control to show the improvement in properties of the Thiol SWNT-ML composites.
Step 1: 14.50 g of poly(tetrahydrofuran) (pTHF, from Sigma-Aldrich) melted at 80° C. for 10 minutes.
Step 2: 14.50 g melted poly(tetrahydrofuran) mixed with 32 mg of deprotected Hand—Mechanosynthesized Thiol SWNT-ML of Example GG7-e1 with 14.5% functionalization in a 100 mL round bottom flash with two necks.
Step 3. pTHF+Thiol SWNT-ML mixture was stirred at 100° C. for 2 hr under vacuum.
Step 4. The temperature was reduced to 70° C., and the reaction mixture was placed under N₂ atmosphere.
Step 5. 6.77 g Isophorone Diisocyanate (Sigma-Aldrich) and 0.05 g dibutyltin dilaurate (Sigma-Aldrich) were mixed with 5 mL N,N-dimethylacetamide (Sigma-Aldrich). This mixture was then added dropwise to the pTHF-Thiol SWNT-ML mixture under N₂.
Step 6. Mixture was stirred for 2 hr at 70° C. under N₂ atmosphere.
Step 7. The temperature of the mixture was reduced to 60° C.
Step 8. 3.63 g bis(4-hydroxyphenyl)disulfide (Tokyo Chemical Industry) and 10 mL N,N-dimethylacetamide added dropwise to mixture.
Step 9. Mixture was stirred for overnight at 60° C. under N₂ atmosphere.
Step 10. An additional 43 mL N,N-dimethylacetamide was added to mixture, and the cured polyurethane composite was completely dissolved in the additional solvent.
Step 11. The temperature was reduced to 40° C. The completion of polymerization was confirmed by the disappearance of the diisocyanate peak at 2260 cm⁻¹ in the FTIR spectrum.
Step 12. Mixture poured into Teflon petri dish and placed in oven set at 40° C. under slight vacuum.
Step 13. Oven heated from 40° C. to 140° C. at a rate of 4.167° C./hr over the course of 24 hr.
Step 14. Samples placed in 80° C. oven for 3 nights. The resulting composite was named “0.1% Thiol SWNT-ML-Selfhealing Polyurethane Composite of Example FF15.”
Step 15. Steps 1-15 were repeated with 25 mg of as-purchased carbon nanotubes (Tuball, OCSiAl) instead of Hand-Mechanosynthesized Thiol SWNT-ML of Example GG7-e1. The resulting composite was named “0.1% SWNT-Selfhealing Polyurethane Composite of Example FF15.”
Step 16. Steps 1-15 were repeated with NO carbon nanotubes instead of Hand-Mechanosynthesized Thiol SWNT-ML of Example GG7-e1. The material was named “neat Selfhealing Polyurethane Polymer of Example FF15.”

### Variations on the Above Mentioned Protocol:

In step 2, SWNT-MLs using different Ushape chemistries can be used in place of the Pyrene SWNT-ML to make different self healing polyurethane-SWNT-ML composites.
In step 2, different amount of SWNT-ML can be added to mixture to explore the effect of different concentrations.
In step 5, different diisocyanates can be used instead of isophorone diisocyanate to explore different polyurethane chemistries.
In step 8, different disulfides can be used instead of bis(4-hydroxyphenyl)disulfide to explore different self-healing polyurethane chemistries.
In step 3, the amount of time mixing SWNT-ML in pTHF can be reduced to speed up the preparation, or increased to try to improve dispersion.
In steps 14, the temperature and time in oven can be adjusted (increase of decreased), as long as all the solvent has been removed.

### Example FF16. Preparation of Self-Healable Polyurethane-Thiol MINT Composites with 1.0 wt % CNT Content

In this example, the preparation of 1.0 wt % Thiol SWNT-ML-self-healing isophorone based polyurethane using Hand-Mechanosynthesized Thiol SWNT-ML of Example GG7-e1. The procedure from Example FF15 was adjusted slightly to account for higher SWNT-ML content.

Additionally, we describe how we made 1.0 wt % SWNT—self-healing isophorone based polyurethane composites used as a control to show the improvement in properties of the Thiol SWNT-ML composites.
Step 1: 7.25 g of poly(tetrahydrofuran) (pTHF, from Sigma-Aldrich) melted at 80° C. for 10 minutes.
Step 2: 7.25 g melted poly(tetrahydrofuran) mixed with 149.4 mg of deprotected Hand-Mechanosynthesized Thiol SWNT-ML of Example GG7-e1 with 15.5% functionalization in a 100 mL round bottom flash with two necks.
Step 3. pTHF+Thiol SWNT-ML mixture was stirred at 100° C. overnight under vacuum.
Step 4. Next day, the temperature was reduced to 70° C., and the reaction mixture was placed under N₂ atmosphere.
Step 5. 3.385 g Isophorone Diisocyanate (Sigma-Aldrich) and 0.025 g dibutyltin dilaurate (Sigma-Aldrich) were mixed with 5 mL N,N-dimethylacetamide (Sigma-Aldrich). This mixture was then added dropwise to the pTHF-Thiol SWNT-ML mixture under N₂.
Step 6. Mixture was stirred for 2 hr at 70° C. under N₂ atmosphere.
Step 7. The temperature of the mixture was reduced to 60° C.
Step 8. 1.815 g bis(4-hydroxyphenyl)disulfide (Tokyo Chemical Industry) and 10 mL N,N-dimethylacetamide added dropwise to mixture.
Step 9. Mixture was stirred for 2 hr at 60° C. under N₂ atmosphere.
Step 10. An additional 43 mL N,N-dimethylacetamide was added to mixture.
Step 11. Mixture was stirred overnight at 60° C. under N₂ atmosphere.
Step 12. The temperature was reduced to 40° C. The completion of polymerization was confirmed by the disappearance of the diisocyanate peak at 2260 cm⁻¹ in the FTIR spectrum.
Step 13. Mixture poured into Teflon petri dish and placed in oven set at 40° C. under slight vacuum.
Step 14. Oven heated from 40° C. to 140° C. at a rate of 4.167° C./hr over the course of 24 hr.
Step 15. Samples placed in 80° C. oven for 3 nights. The resulting composite was named “1.0% Thiol SWNT-ML-Selfhealing Polyurethane Composite of Example FF16.”
Step 16. Steps 1-15 were repeated with 125 mg of as-purchased carbon nanotubes (Tuball, OCSiAl) instead of Hand-Mechanosynthesized Thiol SWNT-ML of Example GG7-e1. The resulting composite was named “1.0% SWNT-Selfhealing Polyurethane Composite of Example FF16.”

### Variations on the Above Mentioned Protocol:

In step 2, SWNT-MLs using different Ushape chemistries can be used in place of the Pyrene SWNT-ML to make different self healing polyurethane-SWNT-ML composites.
In step 2, different amount of SWNT-ML can be added to mixture to explore the effect of different concentrations.
In step 5, different diisocyanates can be used instead of isophorone diisocyanate to explore different polyurethane chemistries.
In step 8, different disulfides can be used instead of bis(4-hydroxyphenyl)disulfide to explore different self-healing polyurethane chemistries.
In step 3, the amount of time mixing SWNT-ML in pTHF can be reduced to speed up the preparation, or increased to try to improve dispersion.
In steps 15, the temperature and time in oven can be adjusted (increase of decreased), as long as all the solvent has been removed.

### Example FF17. Preparation of Self-Healable Polyurethane-Thiol MINT Composite Dogbones for Tensile Mechanical Testing Analysis

Step 1. The procedure outlined in Example FF4 is followed to prepared dogbone tensile testing samples for neat Selfhealing Polyurethane Polymer of Example FF15, 0.1% SWNT-Selfhealing Polyurethane Composite of Example FF15, 0.1% Thiol SWNT-ML-Selfhealing Polyurethane Composite of Example FF15, 1.0% SWNT-Selfhealing Polyurethane Composite of Example FF16, and 1.0% Thiol SWNT-ML-Selfhealing Polyurethane Composite of Example FF16. Only changes are to Step 3 and Step 5, where the temperature used is 50° C.
Step 2. The procedure outlined in Example FF5 was followed for mechanical property testing of the dogbones. However, due to the soft nature of the materials, a 10ON load cell was used instead of a 10 kN load cell. Additionally, 250N pneumatic tensile testing grips were used to hold the sample. The grips were still separated by a distance of 25 mm, and no extensometer was used. Strain was measured by the change in displacement divided by the initial gauge length (25 mm). Additionally, the rate of displacement outlined in Step 2 of Example FF2 was changed to 100 mm/min. The resulting modulus and tensile strength measurements are shown in FIG. 51 and listed in the table below.
   Young's modulus and tensile strength data as measured from tensile testing experiments for Thiol SWNT-ML-self healing polyurethane (SHPU) dogbones prepared in Example FF17. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (MPa) | Strength Increase |
| neat SHPU | 2.82 ± 0.18 | — | 0.99 ± 0.17 | — |
| 0.1 wt % | 2.40 ± 0.06 | −14.8 ± 2.1% | 0.37 ± 0.02 | −62.7 ± 2.4% |
| SWNT-SHPU | | | | |
| 0.1 wt % Thiol | 3.37 ± 0.23 | 19.5 ± 8.1% | 0.99 ± 0.11 | −0.2 ± 11.5% |
| SWNT-ML-SHPU | | | | |
| 1.0 wt % | 10.32 ± 1.18 | 266.2 ± 41.8% | 1.80 ± 0.06 | 81.1 ± 5.6% |
| SWNT-SHPU | | | | |
| 1.0 wt % Thiol | 6.79 ± 0.91 | 140.8 ± 41.8% | 4.42 ± 0.06 | 344.2 ± 6.2% |
| SWNT-ML-SHPU | | | | |

Step 3 After initial mechanical tests, samples were heated at 80° C. for an additional two weeks. Then, steps 1-2 were repeated. The resulting modulus and tensile strength measurements are shown in FIG. 52 and listed in the table below.
   Young's modulus and tensile strength data as measured from tensile testing experiments for Thiol SWNT-ML-self healing polyurethane (SHPU) dogbones prepared in Example FF17 after 2 weeks at 80° C. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (GPa) | Increase | Strength (MPa) | Strength Increase |
| neat SHPU | 3.01 ± 0.05 | — | 2.94 ± 0.31 | — |
| 0.1 wt % | 3.73 ± 0.31 | 23.7 ± 1.7% | 0.89 ± 0.09 | −69.6 ± 3.0% |
| SWNT-SHPU | | | | |
| 0.1 wt % Thiol | 3.92 ± 0.27 | 30.3 ± 10.2% | 1.57 ± 0.11 | −46.5 ± 3.7% |
| SWNT-ML-SHPU | | | | |
| 1.0 wt % | 9.93 ± 1.98 | 230.0 ± 65.6% | 3.11 ± 0.23 | 6.0 ± 7.7% |
| SWNT-SHPU | | | | |
| 1.0 wt % Thiol | 8.77 ± 0.68 | 191.3 ± 22.6% | 5.21 ± 0.11 | 77.4 ± 3.9% |
| SWNT-ML-SHPU | | | | |

### Example FF18. Preparing 0.1 wt % SWNT-ML Commercial Thermoplastic Polyurethane Composites with the Xplore MC 15 Twin Screw Microcompounder

We will describe how to make 0.1 wt % Diamino-boc SWNT-ML-commercial thermoplastic polyurethane composites using the diamino-boc MINTs of Example GG7a. Additional 0.1 wt % SWNT-commercial thermoplastic polyurethane composites will be compared as a control.

For the commercial thermoplastic polyurethane, Elastollan BCF 35A12P TSG from BASF was used.
Step 1: In each of 2 containers, 11.9842 g of Elastollan BCF 35A12P TSG (BASF) and 0.0158 g of diamino-boc MINTs of Example GG7a (24% functionalization) were weighed out and collected.
Step 2: The microcompounder was prepared for mixing at 150° C. with a twin screw rotational speed of 100 rpm. The 12 g batch prepared in step 1 was introduced into the chamber, and left to mix for 5 min.
Step 3. The chamber was opened and the TPU-Diamino-boc SWNT-ML composite was extruded from the nozzle and collected.
Step 4. Steps 2-3 were repeated for the second containers.
Step 5. The extruded material of the 2 containers was combined. The resulting composite is hereby referred to as 0.1% Diamino-boc SWNT-ML-TPU Composite of Example FF18.
Step 6. After cleaning, Steps 1-5 were repeated with 2 containers of 11.988 g HDPE and 0.012 g of as-purchased carbon nanotubes (Tuball, OCSiAl). The resulting composite is hereby referred to as 0.1% SWNT-TPU Composite of Example FF18.
Step 7. After cleaning, Steps 1-5 were also repeated with 2×12 g Elastollan BCF 35A12P TSG for a neat control sample. This produces neat extruded TPU of Example FF18.

### Variations to the Above Protocol:

In step 1, different thermoplastic polyurethane formulations, or SWNT-MLs using different Ushape chemistries can be used in place of Elastollan BCF 35A12P TSG and the Diamino-boc SWNT-ML to make different polymer-SWNT-ML composites.
Different amounts of SWNT-ML can be used to make composites of different CNT content.
In step 2, different temperatures and twins screw rotational speeds, and mixing times can be employed which may improve the dispersion of the MINTs in the polymer matrix. Additionally, the temperature used will always be dependent on the choice of the polymer matrix.

### Example FF19. Sample Preparation of HDPE Composite Dogbones for Tensile Mechanical Testing Analysis

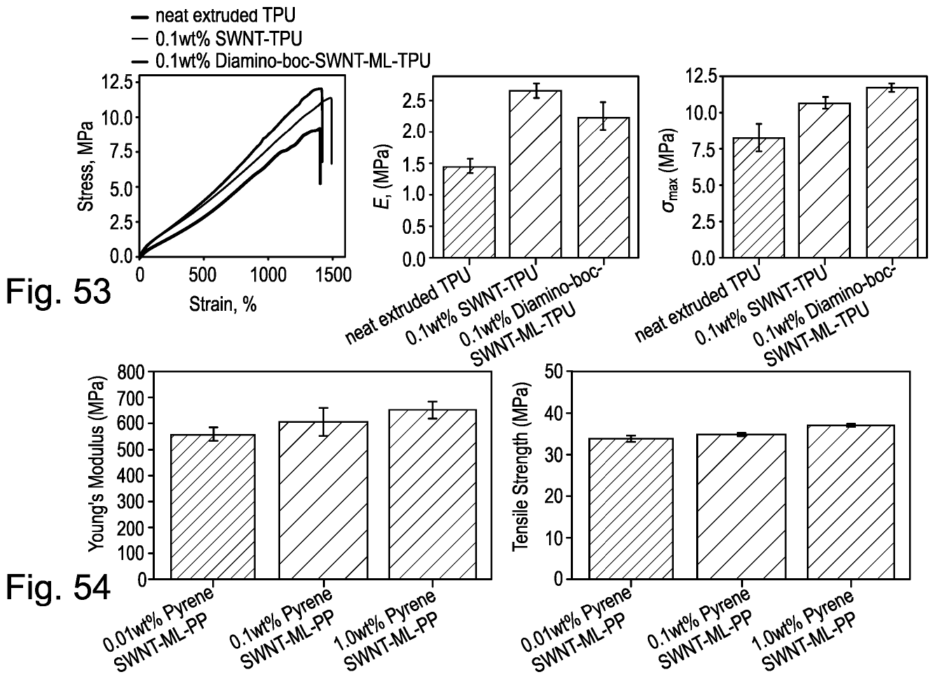

Step 1. The procedure outlined in Example FF4 is followed to prepared dogbone tensile testing samples for neat extruded TPU of Example FF18, 0.1% SWNT-TPU Composite of Example FF18, and 0.1% Diamino-boc SWNT-ML-TPU Composite of Example FF18. Only changes are to Step 3 and Step 5, where the temperature used is 150° C.
Step 2. The procedure outlined in Example FF5 was followed for mechanical property testing of the dogbones. The resulting measurements are shown in FIG. 53 and listed in the table below.
   Young's modulus and tensile strength data as measured from tensile testing experiments for TPU Composite dogbones prepared in Example FF19. Also shows relative increase in modulus and tensile strength for each composite compared to the neat polymer.

| | Young's | Relative | | |
|---|---|---|---|---|
| | Modulus | Modulus | Tensile | Relative Tensile |
| Sample | (MPa) | Increase | Strength (MPa) | Strength Increase |
| neat extruded | 1.45 ± 0.12 | — | 8.35 ± 0.93 | — |
| TPU | | | | |
| 0.1 wt % | 2.65 ± 0.11 | 82.3 ± 7.5% | 10.75 ± 0.40 | 28.6 ± 4.7% |
| SWNT-TPU | | | | |
| 0.1 wt % Diamino- | 2.24 ± 0.21 | 54.6 ± 14.8% | 11.80 ± 0.27 | 41.2 ± 3.2% |
| boc-SWNT-ML-TPU | | | | |

### FF20. Injection Molding of Pyrene-SWNT-ML-Polypropylene Composites

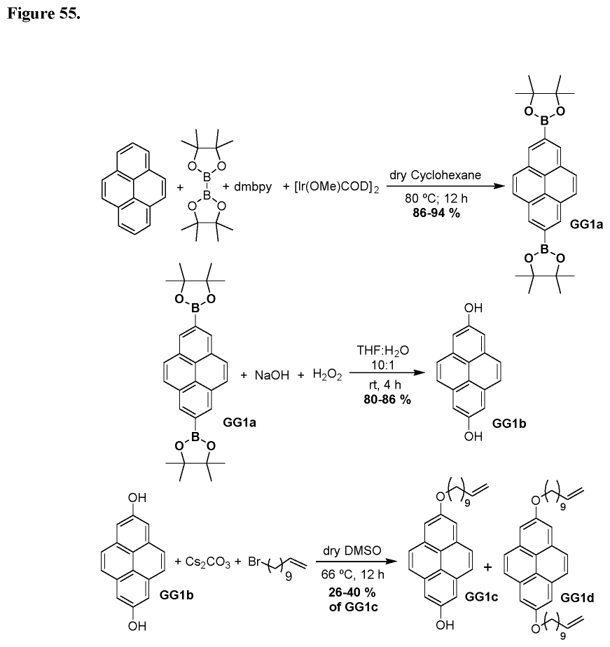

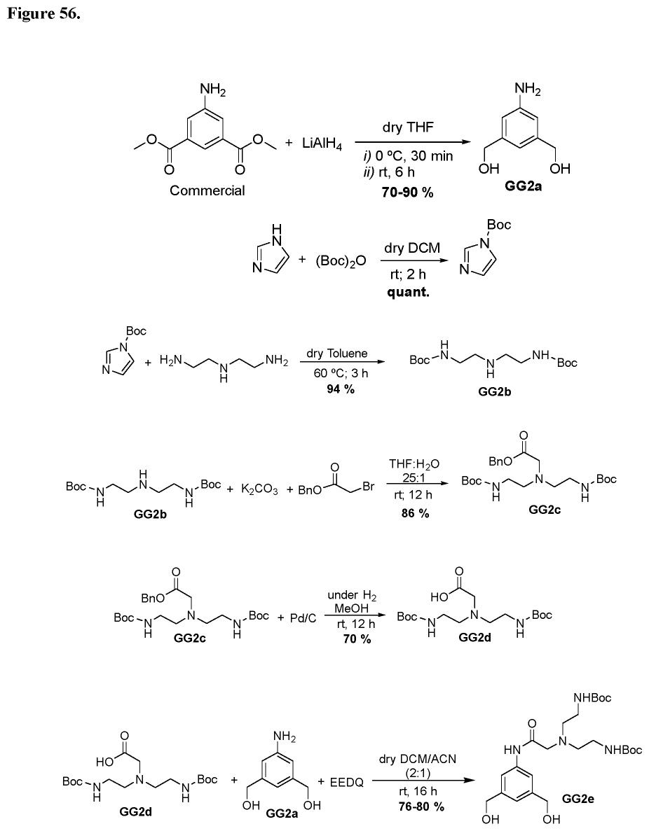

The following procedure outlines the mechanical characterization of injection molded dogbone samples of the 0.01 wt %, 0.1 wt %, and 1.0 wt % Diluted Pyrene-SWNT-ML-Polypropylene Composites of Example FF3. This example shows that the composites can be injection molded, and that increasing SWNT-ML concentration also increases the Young's Modulus and Tensile Strength of the SWNT-ML composites.
Step 1. Six dogbone samples were compression molded using 0.01 wt % Diluted Pyrene-SWNT-ML-Polypropylene Composite of Example FF3. [CONDITIONS?Necessary or no?]
Step 2. Each dogbone was pulled under tension using a tensile mechanical tester at 50 mm/min until fracture. Young's Modulus and Maximum Tensile Strength were recorded. The results of the data are recorded below and shown in FIG. 54.
Step 3. Steps 1 and 2 repeated for 0.1 wt % Diluted Pyrene-SWNT-ML-Polypropylene Composites of Example FF3 and 1.0 wt % Diluted Pyrene-SWNT-ML-Polypropylene Composites of Example FF3.
   Young's modulus and tensile strength data as measured from tensile testing experiments for Pyrene SWNT-ML-PP composites of Example FF3 injection molded dogbones

| | Young's | Tensile |
|---|---|---|
| Sample | Modulus (MPa) | Strength (MPa) |
| 0.01 wt % Pyrene SWNT-ML-PP | 559 ± 26 | 33.9 ± 0.8 |
| 0.1 wt % Pyrene SWNT-ML-PP | 607 ± 53 | 34.9 ± 0.3 |
| 1.0 wt % Pyrene SWNT-ML-PP | 655 ± 31 | 37.3 ± 0.3 |

### Variations to the Above Protocol:

Other SWNT-ML composites using different polymer matrices, SWNT-ML formulations, and SWNT-ML concentrations can be used to injection mold samples, provided the polymer matrix is a thermoplastic.

### Example FF21. Preparation of Epoxy—Diamino SWNT-ML Composites by Attaching the U-Shape” First Before MINT Formation

In this example, we will describe an alternative method to making epoxy-SWNT-ML composites to the method described in Example FF12. In this method the U-shape is attached to the epoxy resin monomer, and then the SWNTs are added and the ring is closed before adding the epoxy hardener. The following describes the procedure to make a 0.1 wt % Diamino SWNT-ML composite using poly(propylene glycol) bis(2-aminopropyl ether) with molecular weight 400 g/mol as a hardener.
Step 1. 15.0 g diglycidyl ether of bisphenol A (DGEBA, D.E.R. 332, Sigma-Aldrich), monomer is heated in an oven to −80° C. to reduce the monomer viscosity and the desired amount is weighed in a glass beaker.
Step 2. DGEBA was heated to 100° C. and placed under vacuum for 2 hr to remove any trace amount of water.
Step 3. 13 mg of “Diamino U-Shape of Example GG12a” was dissolved in about 5 mL chloroform and 5-10 drops of triethylamine. This mixture was then mixed with the DGEBA.
Step 4. The mixture was heated to 140° C., and the solvent was removed under vacuum for 2 hr using a solvent trap.
Step 5. Mixture was placed under Argon and mixed at 140° C. overnight with magnetic stirrer.
Step 6. Next day, temperature reduced to 60° C.
Step 7. 24.28 mg of as-purchased carbon nanotubes (Tuball, OCSiAl) were added to the mixture: The ratio of Ushape to SWNTs was 0.495 μmol Ushape/mg SWNT.
Step 8. Mixture was shear mixed for 2 hr at 8000 rpm using an IKA T 25 digital ULTRA-TURRAX with S 25 N-18 G mixer.
Step 9. Mixture was mixed with magnetic stirrer overnight at 80° C.
Step 10. Next day, mixture was heated to 140° C. under vacuum for 2 hr Step 11. 5 mg of Grubb's catalyst (2 mol Ushape/1 mol Grubb's Catalyst) was dissolved in ˜5 mL chloroform and added to the mixture.
Step 12. Mixture mixed at 80° C. with magnetic stirrer for 3 days.
Step 13. Mixture heated to 140° C. under vacuum for 2 hr.
Step 14. Mixture cooled to 60° C.
Step 15. 9.25 g of hardener, Poly(propylene glycol) bis(2-aminopropyl ether) (MW: 400 g/mol, Sigma-Aldrich, also known as Jeffamine D-400) was added to the DGEBA-SWNT-ML mixture (1.05 mol Jeffamine D-400: 2 mol DGEBA) This mixture was then mixed by hand for approximately 1 min.
Step 16. Mixture was poured into a 70 mm×70 mm square stainless steel mold of 2 mm thickness between two sheets of fiber reinforced Teflon and two 125 mm×125 mm×2 mm stainless steel. The mold was placed in a hot press Atlas™ Series Heated Platens with the 4000 Series High Stability Temperature Controller with Atlas™ Manual 15 Ton (15 T) Hydraulic Press, from Specac, Ltd at 80° C. for 2 hr at 5 tons of pressure.
Step 17. Temperature of press was increased to 140° C. for 8 hr
Step 18. Temperature of press was increased to 200° C. for 8 hr, resulting in 0.1 wt % Diamino SWNT-ML Ushape-First Epoxy-D400 Composite of Example FF21.
Step 19. The cured epoxy rectangles were then cut into dogbone shapes (see FIG. 42.) using a high-velocity water jet cutter. These samples are measured on a tensile tester per Example FF5. The resulting tensile moduli are reported in the table below, showing slight improvement in tensile strength over the neat epoxy.
Step 20. A neat control sample was made by repeating steps 1-19, while skipping steps 3-13, producing neat Epoxy-D400 Composite of Example FF21.

| | Tensile | Tensile |
|---|---|---|
| | Modulus (GPa) | Strength (MPa) |
| Neat Epoxy-D400 of | 2.48 ± 0.14 | 53.1 ± 2.7 |
| Example FF21 | | |
| 0.1 wt % Diamino SWNT- | 2.48 ± 0.17 | 57.2 ± 1.6 |
| ML Ushape-First Epoxy- | | |
| D400 Composite of | | |
| Example FF21 | | |

### Variations to the Above Protocol:

Different epoxy monomers can be used in place of DGEBA in step 1.
The Diamino Ushape added in step 3 could be replaced with any other Ushape that can react with the epoxide groups in the DGEBA monomer.
The amount of Ushape in step 3 and amount of CNTs added in step 7 can be increase or decrease depending on the desired concentration. Additionally, the ratio of μmol Ushape/mg CNT can be adjusted to optimize properties.
In step 8, the mixing speed and time can be increased or decreased
In step 11, the ratio of Grubb's catalyst to Ushape can also be adjusted
In step 15, different epoxy crosslinkers can be used to see how different epoxy crosslinkers affect the composite.
In steps 16-19, the curing steps can also be adjusted to see how different curing processes affect the composite properties.

### Example FF22. Preparation of Epoxy-D400—Diamino SWNT-ML Composites by Shear Mixing Method

In this example, we will describe an alternative method to making epoxy-SWNT-ML composites to the method described in Example FF12. In this method, diamino SWNT-ML “MINTs” are mixed at higher temperature to attempt to fully react the functional diamino groups to the epoxy monomer.
Step 1. Separately, diamino-boc MINTs of Example GG7a were heated to 225 C for 2 hr to remove the boc protection group. Removal of the boc group was verified using TGA in air, resulting in deprotected diamino SWNT-ML's with functionalization of ˜20%. These deprotected diamino SWNT-ML are here by referred to as diamino MINTs of Example FF22.
Step 2. Diglycidyl ether of bisphenol A (DGEBA, D.E.R. 332, Sigma-Aldrich), monomer is heated in an oven to −80° C. to reduce the monomer viscosity and 15.0 g is weighed in a glass round bottom flask.
Step 3. DGEBA is heated to 100° C. under vacuum for 2 hr to remove any water that may be present. Then, temperature was reduced to 60° C.
Step 4. 30.43 mg of “diamino MINTs of Example FF22” (20% functionalization) was placed in the dried DGEBA.
Step 5. Mixture was shear mixed for 2 hr at 8000 rpm using an IKA T 25 digital ULTRA-TURRAX with S 25 N-18 G mixer.
Step 6. Mixture was then mixed at 140° C. overnight under argon with magnetic stirrer.
Step 7. The next day, mixture was placed under vacuum at 140° C. for 2 hr
Step 8. Mixture temperature reduced to 60° C.
Step 9. 9.25 g of hardener, Poly(propylene glycol) bis(2-aminopropyl ether) (MW: 400 g/mol, Sigma-Aldrich, also known as Jeffamine D-400) was added to the DGEBA-SWNT-ML mixture (1.05 mol Jeffamine D-400: 2 mol DGEBA) This mixture was then mixed by hand for approximately 1 min.
Step 10. Mixture was poured into a 70 mm×70 mm square stainless steel mold of 2 mm thickness between two sheets of fiber reinforced Teflon and two 125 mm×125 mm×2 mm stainless steel. The mold was placed in a hot press Atlas™ Series Heated Platens with the 4000 Series High Stability Temperature Controller with Atlas™ Manual 15 Ton (15 T) Hydraulic Press, from Specac, Ltd at 80° C. for 2 hr at 5 tons of pressure.
Step 11. Temperature of press was increased to 140° C. for 8 hr
Step 12. Temperature of press was increased to 200° C. for 8 hr, resulting in 0.1 wt % Diamino SWNT-ML Shear Mix Epoxy-D400 Composite of Example FF22.
Step 13. The cured epoxy rectangles were then cut into dogbone shapes (see FIG. 42.) using a high-velocity water jet cutter. These samples are measured on a tensile tester per Example FF5. The resulting tensile moduli are reported in the table below, showing slight improvement in tensile strength over the neat epoxy (Neat Epoxy-D400 of Example FF21).

| | Tensile | Tensile |
|---|---|---|
| | Modulus (GPa) | Strength (MPa) |
| Neat Epoxy-D400 of | 2.48 ± 0.14 | 53.1 ± 2.7 |
| Example FF21 | | |
| 0.1 wt % Diamino SWNT- | 2.55 ± 0.05 | 57.2 ± 1.2 |
| ML Shear Mix Epoxy- | | |
| D400 Composite of | | |
| Example FF21 | | |

### Variations to the Above Protocol:

Different epoxy monomers can be used in place of DGEBA in step 2.
Diamino MINTs of Example FF22 added in step 4 could be replaced with any other SWNT-ML that can react with the epoxide groups in the DGEBA monomer.
The amount of SWNT-ML's added in step 4 can be increase or decrease depending on the desired concentration.
In step 5, the mixing speed and time can be increased or decreased
In step 6, the temperature and mixing time of the SWNT-ML's can be increased or decreased
In step 9, different epoxy crosslinkers can be used to see how different epoxy crosslinkers affect the composite.
In steps 10-12, the curing steps can also be adjusted to see how different curing processes affect the composite properties.

### Example GG1. Synthesis of Mono- and Di-Alkylated Pyrene

This example describes the synthesis of pyrene derivatives, compounds (GG1c, GG1b), which are used as recognition motifs towards SWNTs and have terminal alkene functionalities that can be used in derivatives structures to react closing around a SWNT.

The synthesis consists of three reaction steps, as depicted in (FIG. 55). The synthesis is similar to the one described in Chem. Commun. 2015, 51, 5421, DOI: 10.1039/C40008970G.

### Example GG1a. Synthesis of 2, 7-diBpinpyrene (GG1a)

Step 1: Commercial Pyrene (4.0 g, 19.8 mmol, 1 equiv), bis(pinacolato)diboron (11.1 g, 43.6 mmol, 2.2 equiv) and dmbpy (106 mg, 0.396 mmol, 0.02 equiv) were added to the flask.
Step 2: three vacuum-Ar cycles were done.
Step 3: Anhydrous Cyclohexane (32.9 ml, 1.66 mL/mmol) was added.
Step 4: [Ir(OMe)COD]₂ (131 mg, 0.198 mmol, 0.01 equiv) was added.
Step 5: the mixture was refluxed (80° C.) for 16 h under argon.
Step 6: After the reaction had finished, the crude was filtered on silica-celite and washed with DCM.
Step 7: The solution was evaporated in vacuum.
Step 8: The brown solid was purified by washing with a little cold acetone and a white solid was obtained (8.45 g, 94%). This product was called “2, 7-diBpinpyrene of Example GG1a” (Compound GG1a).

As an alternative, flash column chromatography with silica gel can be applied, using as eluents Hex/DCM to 6:4.

With cyclohexane, the reaction is slower but cleaner than THF. This alternative helps avoiding formation of the TriBpin-pyrene.

### Example GG1b. Synthesis of 2,7-dihydroxipyrene (GG1b)

Step 1: pure 2,7-diBpinpyrene (2 g, 4.4 mmol, 1 equiv) and NaOH (1 g, 26.4 mmol, 6 equiv) were dissolved in a mixture solvents THF/H₂O (10:1) (200 mL, 45.5 mL/mmol).
Step 2: H₂O₂ (2.7 mL, 30 w/w, 26.4 mmol, 6 equiv) was added dropwise to this solution.
Step 3: This mixture was stirred at room temperature for 4 h.
Step 4: When the reaction had finished, HCl (1 M, to pH acid) was added into the reaction.
Step 5: the mixture was stirred at room temperature for one hour.
Step 6: THF was removed under reduced pressure.
Step 7: A light brown solid was formed which was isolated by filtration
Step 8: A brown solid was obtained with 86% Yield. The brown solid was called “2,7-dihydroxipyrene of Example GG1b” (Compound GG1b).

### Alternative of Purification:

In Step 6: the crude may be extracted with Et₂O (×3).
In Step 7: The organic phase may be dried with anhydride MgSO₄.
In Step 8: the solvent may be evaporated in vacuum to obtain dark solid.
In Step 9: This solid may be re-dissolved in minimum volume of Et₂O and the resulting product may be precipitated by addition of hexane (200 mL/mmol Bpin).

### Example GG1c. Synthesis of Monoalkylaed Pyrene (GG1c) and Dialkylated Pyrene (GG1d)

Step 1: pure 2,7-dihydroxipyrene (1.65 g, 7.04 mmol, 1 equiv) and Cs₂CO₃ (1.15 g, 3.52 mmol, 0.5 equiv) were introduced into a 25 mL seal tube/schlenk flask.
Step 2: The system was flashed with argon.
Step 3: anhydrous DMSO (13.8 mL, 1.96 mL/mmoL) was added.
Step 4: The mixture was vigorously stirred until most of the reagents were dissolved, i.e about 3 hours at 40° C. (The color changed from brown to yellow-brown).
Step 5: Then, 11-Bromoundecene (1.75 mL, 7.04 mmol, 1 equiv) was added into the reaction.
Step 6: The reaction mixture was stirred at 66° C. overnight.
Step 7: the reaction mixture was cooled to room temperature.
Step 8: the crude was filtered and the dialkylated pyrene was isolated
Step 9: The dialkylated pyrene was washed with cold acetone and hexane. The desired product was obtained as a cream solid (12-26%). The product was termed “Dialkylated pyrene of Example GG1c” (Compound GG1d).
Step 10: water (50 ml/g dihydroxy) was added to the liquid phase until the liquid starts to become turbid because the monoalkylated pyrene begins to precipitate.
Step 11: The monoalkylated pyrene was isolated by filtration.
Step 12: The desired product was obtained as a light Brown solid (32-42%). The product was termed “Monoalkylated pyrene of Example GG1c” (Compound GG1c).

The correct structure of the finals products GG1c and GG1d were verified by mass spectrometry and nuclear magnetic resonance (¹H, ¹³C and HSQC).

In Alternative for the work-up:
In Step 8: Instead add HCl (1 M, to pH acid) to neutralize and stir 1 hr, then add water.
In Step 9: Instead extract with EtOAc (3×).
In Step 10: Instead wash the organic phase with brine, and dry over anhydrous MgSO₄.
In Step 11: Remove solvent under reduced pressure.
In Step 12: Instead subject the crude product to flash column chromatography: with silica gel and as eluents Hex/EtOAc from 99:1 to 6:4.
In Step 13: Then, the desired product will be obtained as a light Brown solid (yield 26-36%).

A possible purification method for mono/di mixtures could be recrystallization with acetone.

### Example GG2. Synthesis of Diamino-Boc U-Shape

In this example, we describe the synthesis of compound (GG2f) which is a linear molecule comprising two recognition motifs towards SWNTs with two terminal alkene functionalities that can react to convert the linear molecule into a closed ring structure around a SWNT. The recognition motifs employed are cores of pyrene (compound GG1c) which were described above. This structure contains two urethane groups for hydrogen bonding or, in its unprotected form, two amine groups for covalent bonding that can interact with different polymers to prepare composites.

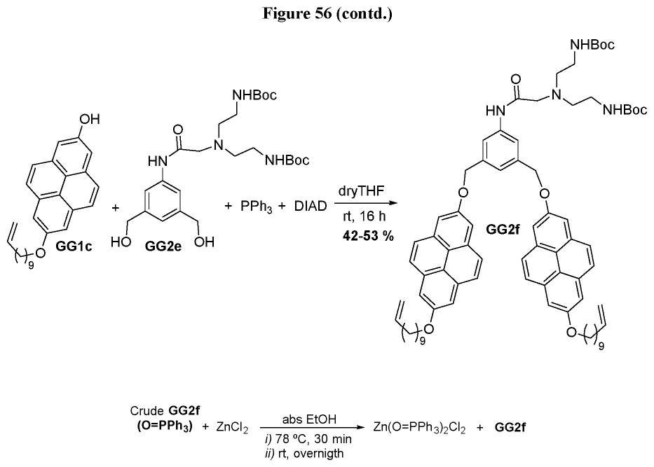

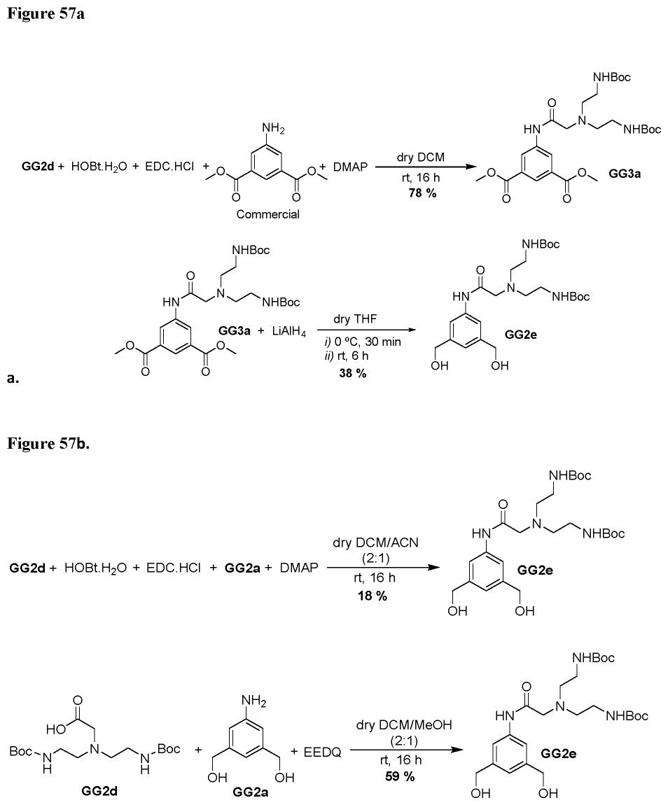

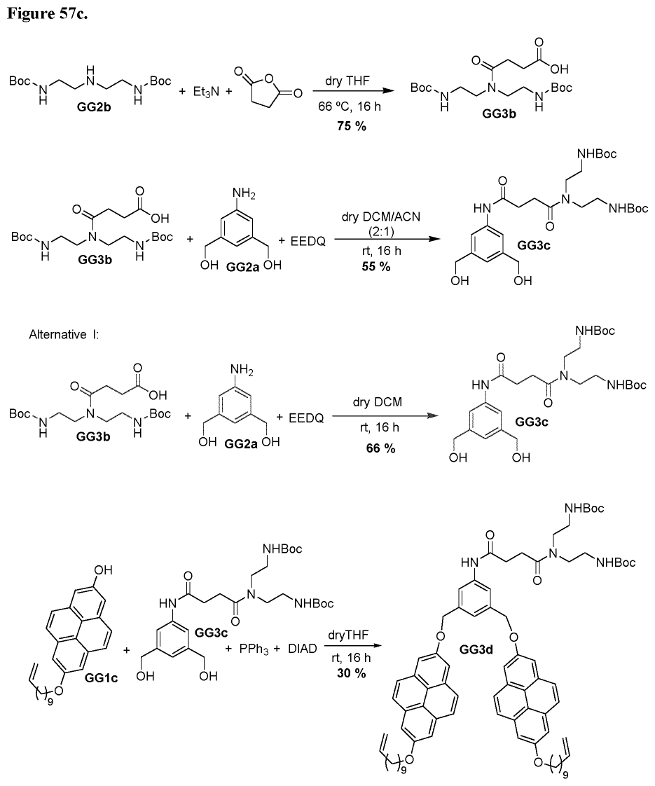

The synthesis consists of 7 reaction steps, as depicted in (FIG. 56). Second and Third reactions were described in Bioorg. and Medicinal Chem. Lett., 2016, 26 (17), 4318-4321. The fourth reaction can be found in Inorganica Chimica Acta 2010, 363, 1796-1804.

### Example GG2a. Synthesis of (5-amino-1, 3-phenylene)dimethanol GG2a

Step 1: 5-aminoisophathalic acid dimethyl ester (1 equiv) in dry THF (5 mL/mmol) was slowly added into a THF (2.5 mL/mmol) slurry of LiAlH₄ (3 equiv) at 0° C. with vigorous stirring.
Step 2: After stirring at 0° C. for 30 minutes, the mixture was allowed to room temperature for 6 hours.
Step 3: it was cooled at 0° C., ethyl ether was then added into the grey mixture under vigorous stirring to quench excess LiAlH₄.
Step 4: H₂O (1 mL/g LiAlH₄) was slowly added to hydrolyze the alumina salt. A color change from grey to green and then yellow were observed.
Step 5: 15% NaOH (1 mL/g LiAlH₄) was added
Step 6: H₂O (3 mL/g LiAlH₄) was added
Step 7: the mixture was warmed to room temperature and stirred for 1 hr.
Step 8: The liquid phase was dried over anhydrous MgSO₄
Step 9: the mixture was stirred for 15 min and filtered to remove salts.
Step 10: Solvent was removed under reduced pressure
Step 11: the desired product “(5-amino-1, 3-phenylene)dimethanol of Example GG2a” (compound GG2a) was obtained as yellow solid with 96% Yield.

### Example GG2b. Synthesis of Imidazole-Boc

Step 1: (Boc)₂O (1 equiv) was added over the imidazole (1.1 equiv) solution in dry DCM (0.36 mL/mmol).
Step 2: The reaction mixture was stirred at room temperature for 2 hours.
Step 3: Then, the crude was washed with water.
Step 4: The organic phase was dried over anhydrous Na₂SO₄
Step 5: The solvent was removed under reduced pressure
Step 6: imidazole-Boc was obtained as white solid, with 99% yield.

### Synthesis of Di-Boc-Diethylenetriamine GG2b

Step 7: Diethylenetriamine (1 equiv) was added over the imidazole-Boc (2 equiv) solution in dry toluene (0.98 mL/mmol).
Step 8: The crude was stirred at (60-65) ° C. for 3 hours.
Step 9: The solvent was removed under reduced pressure.
Step 10: water was added and the crude was extracted with DCM (3×).
Step 11: The organic phase was dried over anhydrous Na₂SO₄.
Step 12: DCM was removed in vacuum to give the desired product “Di-Boc-Diethylenetriamine of Example GG2b” (Compound GG2b) as brown sirup. Yield: 94%

### Example GG2c. Synthesis of Intermediate GG2c

Step 1: A solution of compound GG1b (1 equiv) and K₂CO₃ (0.63 equiv) in 3 ml/mmol of THF-H₂O (25:1) was treated with a solution of Benzyl bromoacetate (1.45 equiv) in 1.5 ml/mmol of THF-H₂O (25:1).
Step 2: the reaction mixture was stirred at rt for 12 h.
Step 3: The solution was concentrated to 5 ml by rotary evaporation.
Step 4: the product was purified by silica gel chromatography column.
Step 5: hexane-ethyl acetate (98:2) was used until all Benzyl bromoacetate was removed.
Step 6: The product was then eluted with 100% ethyl acetate.
Step 7: All solvent was removed by rotary evaporation left the desired product (Compound GG2c) as colorless sirup. Yield (86%).

### Example GG2d. Synthesis of Carboxylic Acid Intermediate GG2d

Step 1: Compound GG2c (1 equiv) was dissolved in dry MeOH (7.8 mL/mmol) under N₂ atmosphere.
Step 2: Pd/C (15% w/w) was added carefully.
Step 3: H₂ gas was carefully introduced into the system.
Step 4: The mixture was stirred at room temperature for 12 h under H₂.
Step 5: The crude was filtered through Silica.
Step 6: which was washed with methanol/CHCl₃.
Step 7: The solvent was removed by rotary evaporation to yield an off-white solid.
Step 8: The solid was dissolved in a small volume of methanol and was crystallized by addition of diethyl ether.
Step 9: The white solid obtained was washed with diethyl ether and air dried to give the Carboxylic acid (Compound GG2d) with 70-89% yield.

### Example GG2e. Synthesis of Diamino-Boc Spacer GG2e

Step 1: Carboxylic acid GG2d (209 mg, 0.578 mmol, 1 equiv) and (5-amino-1, 3-phenylene)dimethanol GG2a (93 mg, 0.607 mmol, 1.05 equiv) were suspended in anhydrous DCM/CH₃CN (2:1) (11.2 ml/mmol acid) under Ar atmosphere.
Step 2: EEDQ (143 mg, 0.578 mmol, 1 equiv) was added into the mixture
Step 3: The reaction was stirred at room temperature overnight.
Step 4: The solvent was evaporated in vacuum.
Step 5: The crude product was purification by column chromatography (DCM/MeOH as eluent, from 98/2 to 96/4).
Step 6: The desired product “Diamino-Boc spacer” (Compound GG2e) was obtained with (220 mg) 76% yield as white sirup.

### Example GG2f. Synthesis of Diamino-Boc U-Shape GG2f

Step 1: DIAD (1.02 g, 5.04 mmol, 2.12 equiv) was slowly added to a stirred solution of Compound GG2e (1.17 g, 2.35 mmol, 1 equiv), monoalkylated pyrene GG1c (1.96 g, 5.04 mmol, 2.15 equiv) and Ph₃P (1.27 g, 4.84 mmol, 2.06 equiv) in dry THF (12 mL, 5 mL/mmol) at 0° C.
Step 2: the mixture was left stirring at 0° C. for 30 min.
Step 3: Then, the reaction was warmed at room temperature and left stirring overnight.

Step 4: THF was removed under reduced pressure.
Step 5: Et₂O (25 mL/mmol) and NaOH 10% (50 mL/mmol) were added.
Step 6: The mixture was stirred at room temperature for 1 hr.
Step 7: the aqueous phase was extracted three times with Et₂O (25 mL/mmol).
Step 8: the organic phase was washed with water and then with brine.
Step 9: The organic phase was dried with Na₂SO₄ anh.
Step 10: the solvent was evaporated in vacuum.
Step 11: The brown crude was recrystallized with diethyl ether/Hexane.
Step 12: A cream solid obtained was washed with a little amount of cool diethyl ether and air dried to give the desired product with 40-53% yield. This cream solid was called “Diamino-Boc U-Shape of Example GG2f” (Compound GG2f).

### Example GG2 g. Reaction with ZnCl₂

This reaction step is used as an alternative to help remove triphenylphosphine oxide when Step 11 does not work well. This method was described in J. Org. chemistry 2017, 82, 9931-9936.
Step 13: Compound GG2f crude was suspended in absolute EtOH (2.78 mL/mmol O=PPh₃) at refluxing.
Step 14: Ar was burbled for 30 min.
Step 15: The solution of ZnCl₂ in Warm abs EtOH (1.38 mL/mmol O=PPh₃) was added.
Step 16: Then, the reaction was warmed at rt and left stirring overnight.
Step 17: A cream precipitate was separated by filtration
Step 18: A cream solid obtained was washed with cool EtOH and water and air dried to give the desired Diamino-Boc U-Shape (Compound GG2f) with 36% yield.

The structure of the final product GG2f was corroborated by mass spectrometry and nuclear magnetic resonance (¹H, ¹³C and HSQC).

### Example GG3. Several Alternatives for Diamino-Boc U-Shape Synthesis

These examples describes different routes to synthesize the Diamino-Boc spacer of Example GG2e (Compound GG2e) employing two different approaches and the synthesis of a new Diamino-Boc U-Shape GG3c similar to “Diamino-Boc U-Shape of Example GG2e” using succinic anhydride. See FIG. 57.

### Example GG3a: Another Synthetic Route to Synthesis of Diamino-Boc Spacer GG2e

In this example is described an alternative synthesis in which the Diamino-Boc spacer GG3a is first formed and then the ester groups are reduced to give the desired Diamino-Boc spacer (Compound GG2e).

### Synthesis of Diamino-Boc Spacer GG3a

Step 1: Compound GG2d (227 mg, 0.63 mmol, 1 equiv.), HOBt (188 mg, 1.4 mmol, 2.2 equiv.) and EDC (266 mg, 1.4 mmol, 2.2 equiv.) was dissolved in dichloromethane (10 mL, 15.9 mL/mmol) and cooled to 0° C.
Step 2: dimethyl 5-aminoisophthalate (144 mg, 0.69 mmol, 1.1 equiv.) and 4-dimethylaminopyridine (462 mg, 3.8 mmol, 6 equiv.) were added.
Step 3: The reaction mixture was warmed to room temperature by stirring overnight.
Step 4: The reaction was extracted with HCl 0.5 M
Step 5: The crude obtained was purified by column chromatography in CH₂Cl₂/MeOH (95:5) to afford 263 mg of the diamino-Boc spacer (compound GG3a) as a white solid with 78% Yield.

### Synthesis of Diamino-Boc Spacer GG2e from Diamine-Boc Spacer GG3a

Step 6: To a solution of compound GG3a (133 mg, 0.24 mmol, 1 equiv.) in THF (10 mL, 41.7 mL/mmol) at −78° C. was added dropwise LiBH₄ (2M in THF, 0.5 mL, 1.0 mmol, 4.2 equiv.).
Step 7: The reaction mixture was stirred at −78° C. for 10 min
Step 8: The reaction mixture was stirred at room temperature overnight.
Step 9: After this time, excess reactants were consumed by the addition of saturated NH₄Cl.
Step 10: The organic phase was extracted with CH₂Cl₂.
Step 11: The combined organic phases were washed with brine, dried and concentrated under vacuum.
Step 12: The crude obtained was purified by column chromatography using a CH₂Cl₂/MeOH (9:1) mixture as eluent to afford 45 mg of the desired Diamine-Boc (compound GG2e) as a white solid with 28% of yield.

### Example GG3b: Different Amidation Conditions to Obtain Diamino-Boc Spacer GG2e

### Synthesis Alternative I of Diamino-Boc Spacer GG2e

The synthesis step from 1 to 5 of Example GG3a were repeated; except that the starting material in the step 2 dimethyl 5-aminoisophthalate was replaced by (5-amino-1, 3-phenylene)dimethanol (Compound GG2a). The resulting compound GG2e was obtained with 28% yield.

### Synthesis Alternative II of Diamino-Boc Spacer GG2e

To produce compound GG2e, the protocol of Example GG2 was repeated, except that in Step 1 of Example GG2e the solvent mixture was changed from DCM/ACN to DCM/MeOH. The diamino-Boc spacer (compound GG2e) was isolated in 59% yield.

### Example GG3c: Synthesis of a Similar Diamino-Boc U-Shape Using Succinic Anhydride

In this section we present a new synthesis to prepare a Diamino-Boc_SCC U-shape similar to “Diamino-Boc U-Shape GG2f of Example GG2”. In this case, succinic anhydride is used to introduce the acid functionalization in one step from the Di-Boc-Diethylenetriamine (Compound GG2b), eliminating the hydrogenolysis reaction of Example GG2d.

### Synthesis of Carboxylic Acid GG3b

Step 1: To a solution of Di-Boc-Diethylenetriamine GG2d (217 mg, 0.715 mmol, 1 equiv.) in dry THF (3.6 mL, 5 mL/mmol) was added Et₃N (116 μL, 0.834 mmol, 1.16 equiv).
Step 2: The mixture was left stirring at room temperature for 30 min.
Step 3: Succinic anhydride (71.6 mg, 0.715 mmol, 1 equiv) was added.
Step 4: The reaction mixture was refluxed overnight.
Step 5: THF was removed by rotavapor.
Step 6: A saturated NH₄Cl solution (5.3 mL/mmol) was added to the crude.
Step 7: The aqueous phase was extracted three times with EtOAc (6.3 mL/mmol).
Step 8: The organic phase was dried under MgSO₄ anhydride.
Step 9: The carboxylic acid (Compound GG3b) was obtained as brown sirup in 75-96% yield.

### Synthesis of Diamino-Boc_SCC Spacer GG3c

Step 1: Carboxylic acid GG3b (1 equiv) and (5-amino-1, 3-phenylene)dimethanol GG2a (1.05 equiv) were suspended in anhydrous DCM/CH₃CN (2:1) (11.2 ml/mmol acid) under Ar atmosphere.
Step 2: EEDQ (1 equiv) was added into the mixture Step 3: the reaction was stirred at room temperature overnight.
Step 4: After, the solvent was evaporated in vacuum.
Step 5: The crude product was purification by column chromatography (Hex/EtOAc as eluent, from 4/6 to 2/8).
Step 6: The desired product called “Diamino-Boc_SCC spacer of Example GG3c” (Compound GG3c) was obtained with 55% yield as light brown sirup.

### Alternative Synthesis of Diamino-Boc_SCC Spacer GG3c

To produce compound GG3c named “Diamino-Boc_SCC spacer of Example GG3c”, the protocol of Example GG3c (Synthesis of a similar Diamino-Boc U-Shape using succinic anhydride) was repeated, except that in Step 1 of Synthesis of Diamino-Boc_SCC spacer GG3c of Example GG3c, the solvent mixture was changed from DCM/ACN to only DCM (10.2 ml/mmol acid) and in Step 5 Chloroform/MeOH (95:5) was used as eluent to purify GG3c. The diamino-Boc_SCC spacer (compound GG3c) was isolated in 66% yield.

### Synthesis of Diamino-Boc_SCC U-Shape GG3d

Step 1: DIAD (510 mg, 2.52 mmol, 2.12 equiv) was slowly added to a stirred solution of Compound GG3c (641 mg, 1.19 mmol, 1 equiv), monoalkylated pyrene GG1c (994 mg, 2.56 mmol, 2.15 equiv) and Ph₃P (643 mg, 2.45 mmol, 2.06 equiv) in dry THF (6 mL, 5 mL/mmol) at 0° C.
Step 2: the mixture was left stirring at 0° C. for 30 min.
Step 3: Then, the reaction was heated at room temperature and left stirring overnight.
Step 4: THF was removed under reduced pressure.
Step 5: The brown crude was recrystallized with diethyl ether.
Step 6: A cream-colored solid obtained was washed with a small amount of cold diethyl ether and air-dried to give 456 mg of the desired product in 30% yield. This cream solid was called “Diamino-Boc_SCC U-Shape of Example GG3c” (Compound GG3d).

The correct structure of the final products GG3c was verified by mass spectrometry and nuclear magnetic resonance (¹H, ¹³C, HSQC and HMBC).

### Example GG4. Synthesis of Pyridine U-Shape GG4a

In this case, we describe the synthesis of compound (GG4a) which is a linear molecule comprising two recognition motifs towards SWNTs with two terminal alkene functionalities that can react to convert the linear molecule into a closed ring structure around a SWNT. The recognition motifs employed are cores of pyrene (GG1c) which were described above. This structure contains a nitrogen atom in the aromatic ring of the spacer, generating possible modifications in the interaction between the aromatic ring and SWNTs since it is known that pyridine scaffolds can help in the dispersion of SWNTs. Moreover, the nitrogen atom can generate additional interaction through hydrogen bonds with different polymers in the preparation of the composites.

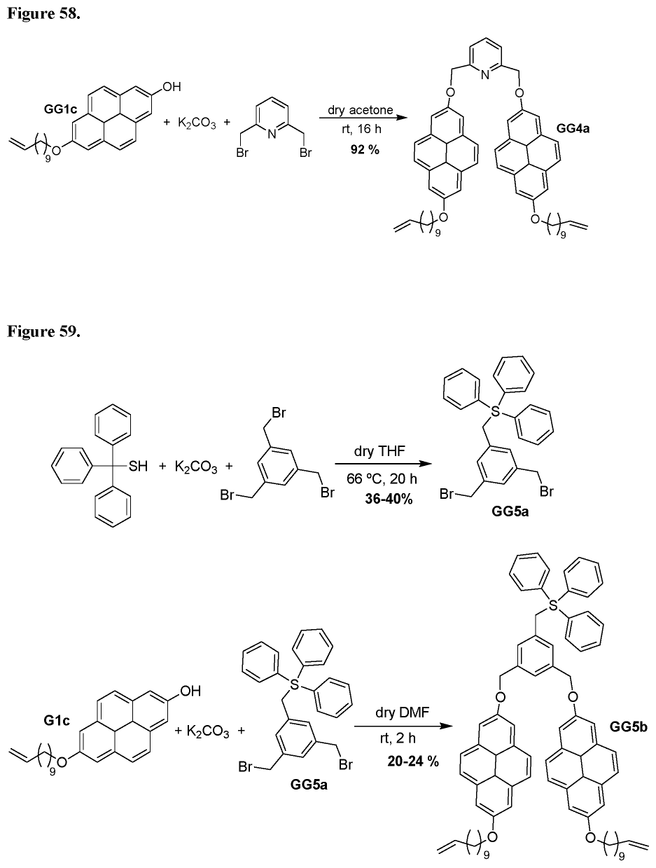

The synthesis is a single reaction, as shown in FIG. 58.

### Synthesis of Pyridine U-Shape GG4a

Step 1: monoalquilated (GG1c) (3.2 g, 8.30 mmol, 2.2 equiv) and K₂CO₃ (5.2 g, 37.7 mmol, 10 equiv) were dissolved in dry acetone (47 mL, 12.5 mL/mmol) Step 2: The reaction mixture was stirred at 38° C. for 40 min under argon.
Step 3: 2,6-Bromomethylpyridine (1 g, 3.77 mmol, 1 equiv) was added.
Step 4: The reaction was left stirring at 56° C. overnight.
Step 5: A cream solid was appeared.
Step 6: The cream solid was isolated by filtration.
Step 7: The cream solid was washed with cool acetone and water.
Step 8: The cream solid was dried under vacuum, obtaining 3.03 g of desired Product was called “pyridine U-Shape of Example GG4” (Compound GG4a) with a 92% of yield.

The correct structure of the finals products GG4a was verified by mass spectrometry and nuclear magnetic resonance (¹H, ¹³C and HSQC).

### Example GG5. Synthesis of Thiol U-Shape GG5c

In this case, we describe the synthesis of compound (GG5c) which is a linear molecule comprising two recognition motifs towards SWNTs with two terminal alkene functionalities that can react to convert the linear molecule into a closed ring structure around a SWNT. The recognition motifs employed are cores of pyrene (GG1c) which were described above. The thiol group contained in this structure is a soft nucleophile like the amine group, and can interact with different electrophilic appendages within the polymers to form covalent bonds with them (such as chlorine moieties in PVC polymer).

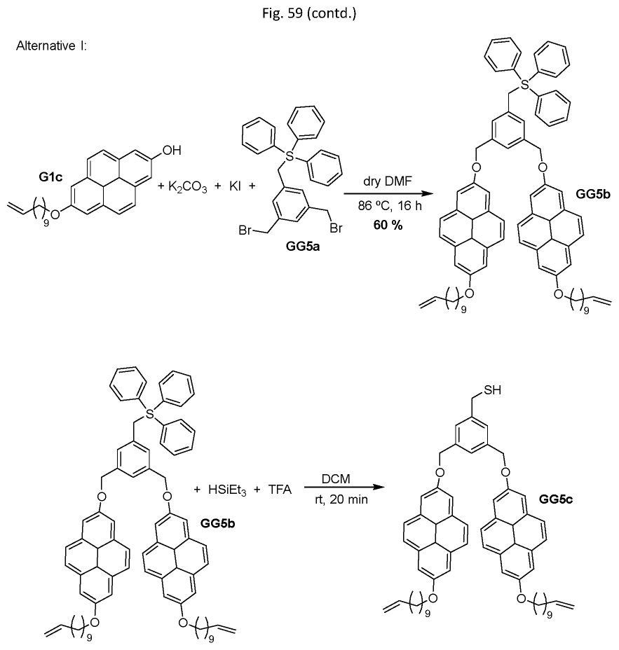

This example consists of 3 reaction steps as shown in FIG. 59. The first reaction was published in Eur. J. Org. Chem. 2011, 4823-4833.

### Example GG5a. Synthesis of (3,5-bis(bromomethyl)benzyl)triphenyl-γ4-sulfane GG5a

Step 1: 1,3,5-tris(bromomethyl)benzene (1 g, 2.8 mmol, 1 equiv) and Triphenylmethanethiol (775 mg, 2.8 mmol, 1 equiv) were dissolved in dry THF (8 mL, 2.86 mL/mmol) under an atmosphere of argon.
Step 2: K₂CO₃ (581 mg, 4.2 mmol, 1.5 equiv) was added.
Step 3: The reaction mixture was heated at reflux for 20 hours.
Step 4: Water was added.
Step 5: The mixture was extracted with ether.
Step 6: The combine layer were washed with brine.
Step 7: The organic phase was dried over MgSO₄.
Step 8: The solvent was evaporated to dryness.
Step 9: the crude was subjected to flash column chromatography: with silica gel and as eluents Hex/DCM 95/5.
Step 10: The desired product (Compound GG5a) was obtained as a white solid (550 mg, 36% yield).

As an alternative to the column chromatography (Step 9):
Step 9: the crude was subjected to flash column chromatography: with silica gel and as eluents Hex/DCM/Tol 95/5/0.5.
Step 10: The desired product (Compound GG5a) was obtained as a white solid (619 mg, 40% yield).

### Example GG5b. Synthesis of Triphenyl-Thioether U-Shape GG5b

Step 1: monoalquilated (GG1c) (91 mg, 0.235 mmol, 2.2 equiv), KI (1.8 mg, 0.0107 mmol, 0.1 equiv) and K₂CO₃ (119 mg, 0.856 mmol, 8 equiv) were dissolved in dry aDMF (1 mL, 7.7 mL/mmol) under argon.
Step 2: The reaction mixture was stirred at 38° C. for 40 min.
Step 3: (3,5-bis(bromomethyl)benzyl)triphenyl-γ4-sulfane GG5a (59 mg, 0.107 mmol, 1 equiv) was added.
Step 4: The reaction was left stirring at room temperature for 2 h.
Step 5: Water was added until turbidity.
Step 6: The brown solid was isolated by filtration.
Step 7: Product was purified by column chromatography with silica gel and as eluent Hex/EtOAc from 95/5 to 8/2.
Step 8: 25 mg of the desired product was called “Trt-Thiol U-Shape of Example GG5” (Compound GG5b) was obtained as a cream solid in 20% yield.

### Alternative Synthesis of Triphenyl-Thioether U-Shape GG5b

To produce “Trt-Thiol U-Shape of Example GG5b” (compound GG5b), the protocol of Example GG5b was repeated, except that in Step 1 of Example GG5b the amount of KI (0.2 equiv) and K₂CO₃ (3 equiv) were changed, in Step 4 of Example GG5b The reaction was left stirring at 82° C. overnight and in Step 7 of Example GG5b the purify method was changed from column chromatography to recrystallization with ether. The Trt-Thiol U-Shape (compound GG5b) was isolated in 60% yield.

The structure of the final product GG5b was corroborated by mass spectrometry and nuclear magnetic resonance (¹H, ¹³C and HSQC).

### Example GG5c. Synthesis of Thiol U-Shape GG5c

This reaction has not yet been carried out, but was describe in Eur. J. Org. Chem. 2011, 4823-4833 with a good yield (72-77%) and previously in Chem. Commun., 2008, 3438-3440. Our protocol is presented below.
Step 1: Compound GG5b (1.0 equiv.) and triethylsilane (1.5 equiv.) were dissolved in dry CH₂Cl₂ (71.4 mL/mmol).
Step 2: Trifluoroacetic acid (2.86 mL/mmol) was added dropwise at 0° C.
Step 3: The reaction mixture was stirred for 20 min at room temperature.
Step 4: The reaction was quenched by the addition of a saturated aqueous solution of sodium hydrogen carbonate.
Step 5: After completion of the gas formation, the phases were separate.
Step 6: the aqueous phase was extracted with CH₂Cl₂.
Step 7: The combined organic fractions were dried over magnesium sulfate, filtered and concentrated to dryness.
Step 8: The crude was purified by column chromatography (silica gel; hexane/CH₂Cl₂, 2:1).
Step 9: The desired product was obtained with 72-77% yield. This product was called “Thiol U-Shape of Example GG5” (Compound GG5c).

### Example GG6. Synthesis of Amide U-Shape GG6d

We describe the synthesis of compound (GG6d) which is a linear molecule comprising two recognition motifs towards SWNTs with two terminal alkene functionalities that can react to convert the linear molecule into a closed ring structure around a SWNT. The recognition motifs employed are cores of pyrene (GG1c) which were described above. The main change in the structure is the presence of two amide groups and a greater separation between the recognition motifs and the spacer. These amide groups are proton acceptors and donors, which can generate hydrogen bonds with the polymers.

To obtain the Amide U-Shape GG6d was employed two synthetic routes. The first is explained below and the second will be described later.

### Example GG6a

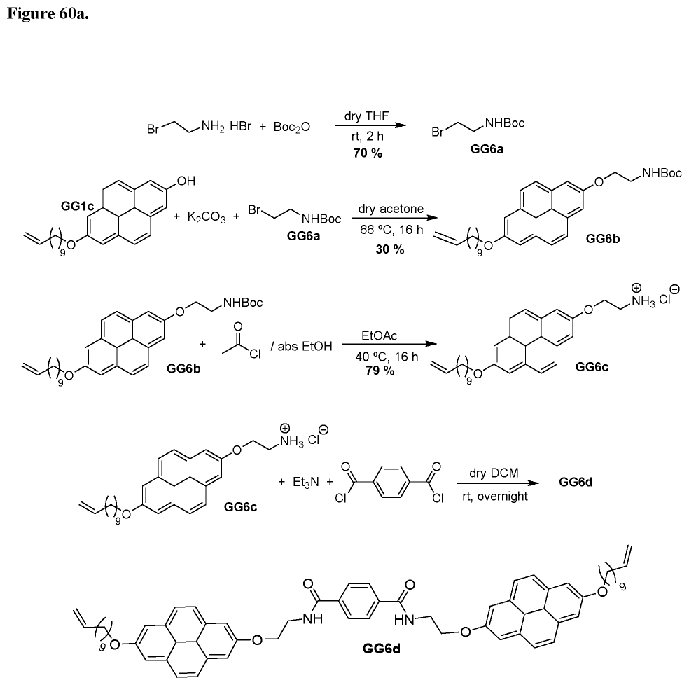

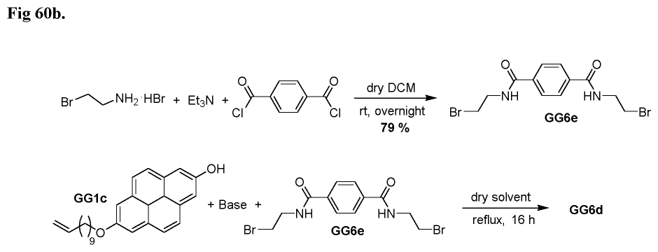

The first route in this example consists of 4 reaction steps, which can be seen in FIG. 60, section a.

### Example GG6a1: Synthesis of Tert-butyl (2-bromoethyl) carbamate GG6a

Step 1: 2-Bromoethylamine hydrobromide (500 mg, 2.44 mmol, 1.0 equiv.) and saturated NaHCO₃ solution (0.3 mL, 0.18 mL/mmol) were suspended in dry THF (0.9 mL, 0.36 mL/mmol).
Step 2: Boc anhydride (0.56 mL, 2.44 mmol, 1 equiv) was added dropwise at 0° C.
Step 3: The reaction mixture was stirred at room temperature for 2 h.
Step 4: The reaction was quenched by the addition of water.
Step 5: the aqueous phase was extracted with CH₂C12 three times.
Step 6: The combined organic fractions were dried over magnesium sulfate, filtered and concentrated to dryness.
Step 7: 380 mg of tert-butyl (2-bromoethyl) carbamate GG6a was obtained as brown sirup (70% Yield).

An Alternative protocol changing the base can be used:
Step 1: Et₃N (0.25 equiv.).
Step 2: Boc anhydride (1.01 equiv.) was added dropwise at 0° C.
Step 3: The reaction mixture was stirred at room temperature overnight.
Step 7: tert-butyl (2-bromoethyl) carbamate GG6a was obtained as brown sirup (quantitative Yield).

### Example GG6a2: Synthesis of Core Intermediate GG6b

Step 1: monoalquilated (GG1c) (81 mg, 0.208 mmol, 1 equiv) and K₂CO₃ (115 mg, 0.833 mmol, 4 equiv) were dissolved in dry acetone (2.6 mL, 12.5 mL/mmol).
Step 2: The reaction mixture was stirred at 38° C. for 3 hours under argon.
Step 3: Tert-butyl (2-bromoethyl)-carbamate GG6a (140 mg, 0.625, 3 equiv) was added dissolve in dry acetone.
Step 4: The reaction was left stirring at 56° C. overnight.
Step 5: A yellow solid was isolated by filtration and washed with cool acetone.
Step 6: The yellow solid was dried under vacuum, obtaining 35 mg of desired intermediate GG6b with a 30% of yield.

### Alternative Synthesis of Core Intermediate GG6b

To produce compound GG6b, the protocol of Example GG6a2 was repeated, except that in Step 1 of Example GG6a2 KI (0.1 equiv) was added and the amount of K₂CO₃ was changed from 4 equiv. to 3 equiv., in step 2 of Example GG6a2 the reaction was heated at 50° C., in Step 4 of Example GG6a2 The reaction was left stirring at 60° C. overnight and in Step 6 of Example GG6a2 the purify method was realized by chromatography column using Hex/EtAOc/Tol (9.5/0.5/0.5) as eluent obtain 65% of yield.

### Example GG6a3: Synthesis of Unprotected-Amine Intermediate GG6c

Step 1: To a solution of amine-Boc GG6b (63 mg, 0.1086 mmol, 1 equiv) in EtOAc (12.7 mL, 50 mL/mmol), acetyl chloride (77 μL, 1.086 mmol, 10 equiv) in abs EtOH (0.1 M) was added dropwise at 0° C.
Step 2: The reaction mixture was stirred at 40° C. overnight.
Step 3: A white solid was appeared and isolated by filtration.
Step 4: The white solid was washed with CHCl₃ and dried under vacuum.
Step 6: obtaining 40 mg of the desired intermediate GG6c, unprotected amine, in 79% yield.

### Example GG6a54: Synthesis of Amide U-Shape GG6d

This reaction has not yet been carried out; it will be performed under conditions similar to the synthesis of the Amide spacer (Compound GG6e) described in detail below.
Step 1: The amine GG6c (2.2 equiv) and Et₃N (2.2 equiv) in dry DCM (1.82 mL/mmol) were stirred at 0° C. into a round bottom flask.
Step 2: Terephthaloyl Chloride (1 equiv) dissolve in dry DCM (0.78 mL/mmol) was added dropwise at 0° C.
Step 3: the reaction mixture was allowed to warm to room temperature.
Step 4: the reaction was stirred overnight at room temperature.
Step 5: the solvent was removed under reduced pressure.
Step 6: the solid was washed with water and a little EtOH.
Step 7: The pure solid was termed “Amide U-Shape of Example GG6a” (Compound GG6d).

Such as commented previously, to obtain the desired Amide U-shape GG6d, we have employed two synthetic routes. The first one had been explained above and the other one will be described below.

### Example GG6b

The second approach is two reaction steps (in FIG. 60 as well, section b).

### Example GG6b1: Synthesis of Amide-Spacer GG6e

Step 1: 2-Bromoethylamine hydrobromide (2.5 g, 12.3 mmol, 2.5 equiv.) and Et₃N (2.47 mL, 12.3 mmol, 2.5 equiv) in dry DCM (9.9 mL, 1.82 mL/mmol) were stirred at 0° C. into a round bottom flask.
Step 2: Terephthaloyl Chloride (1 g, 4.93 mmol, 1 equiv) dissolve in dry DCM (2.9 mL, 0.78 mL/mmol) was added dropwise at 0° C.
Step 3: the reaction mixture was allowed to warm to room temperature.
Step 4: the reaction was stirred overnight at room temperature.
Step 5: the solvent was removed under reduced pressure.
Step 6: the white solid was washed with water and a little EtOH.
Step 7: 1.28 g of Amide-spacer GG6e was obtained with 79% of yield.

### Example GG6b2: Synthesis of Amide U-Shape GG6d Via a SNu (Another Route)

This step of the reaction has not worked; several dry solvents such as acetone, THF, DMF, DMSO with different bases (K₂CO₃, Cs₂CO₃, NaOH, ^{t}BuOLi, ^{t}BuONa . . . among others) have been used. Either condition has generated the “Amide U-Shape of Example GG6a” (Compound GG6d).

### Examples GG7. Preparation of Mints

In this example, several procedures are described for the preparation of MINTs, which are molecular interlocked around SWCNTs via ring-closing metathesis using the second-generation Grubbs catalyst. For this purpose, different linear molecules U-shape were used to due to present of two recognition motifs towards SWNTs with two terminal alkene functionalities in their structure that can react to convert the linear molecule into a ring-closed structure around a SWNT. The recognition motifs used in this example are cores of pyrene (GG1c, GG1d).

### Example GG7a: Wet Method

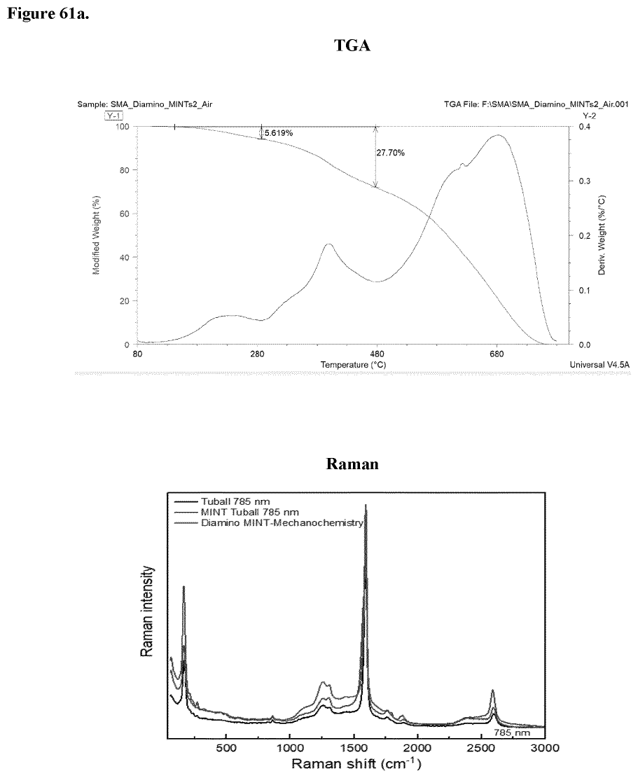

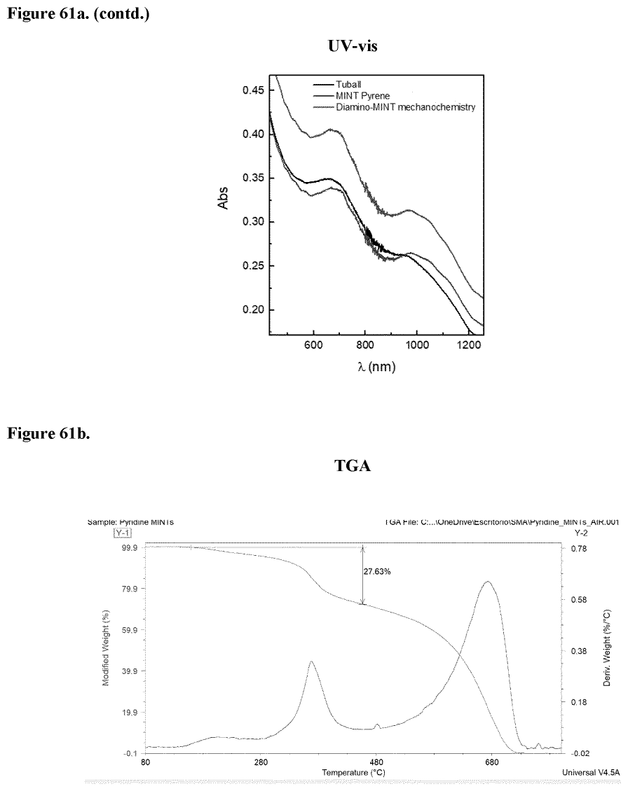

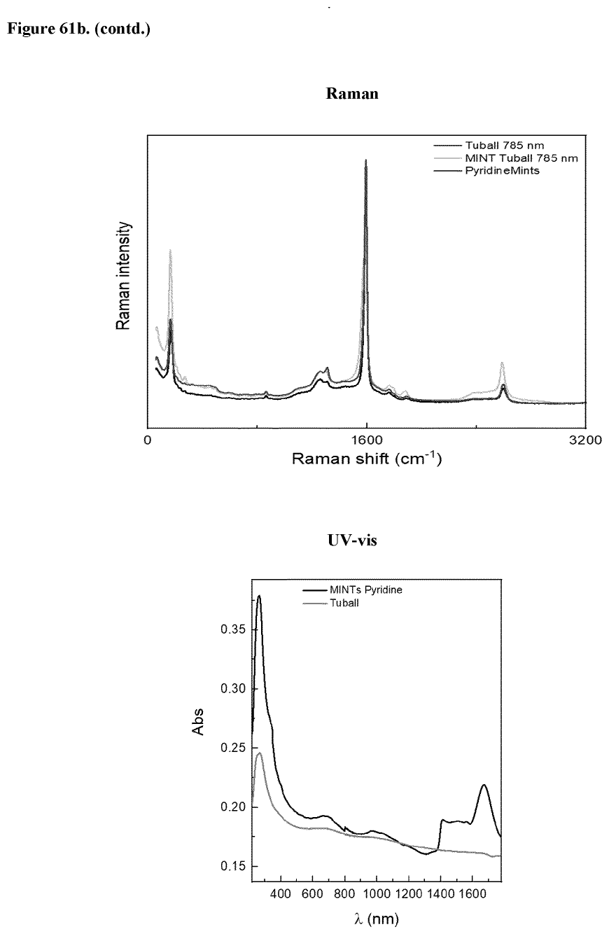

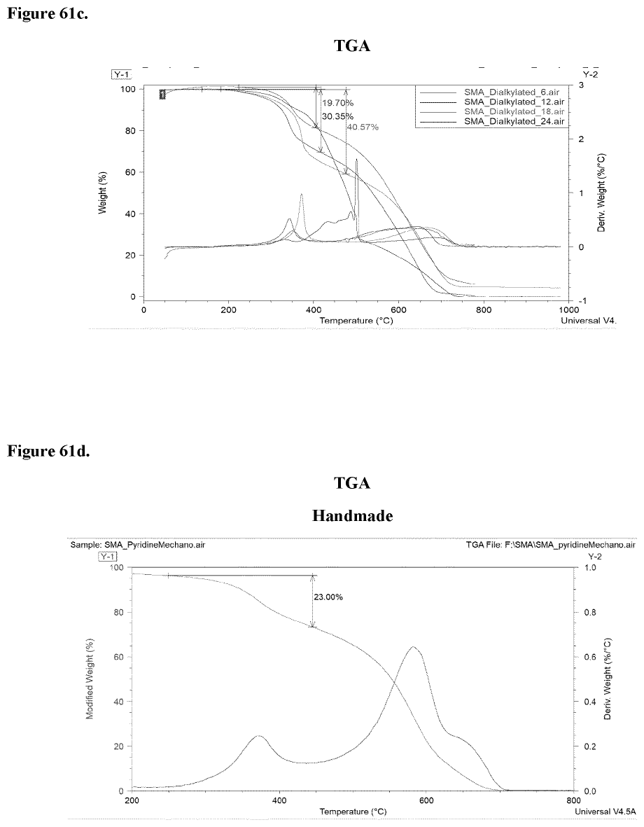

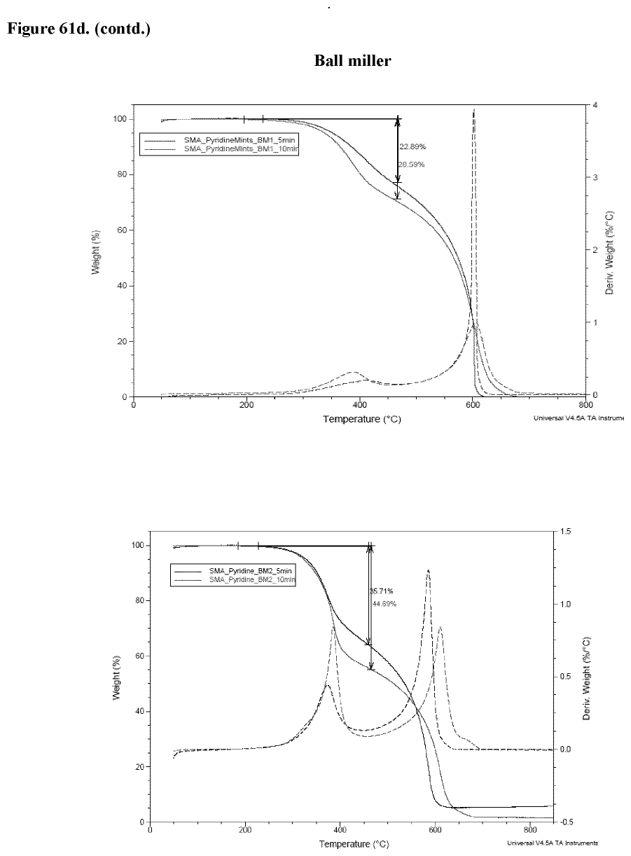

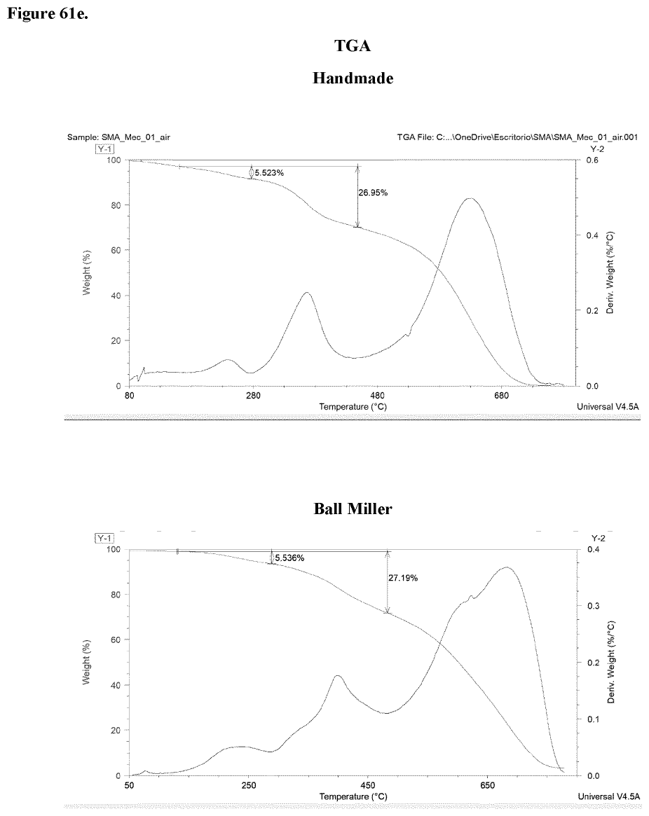

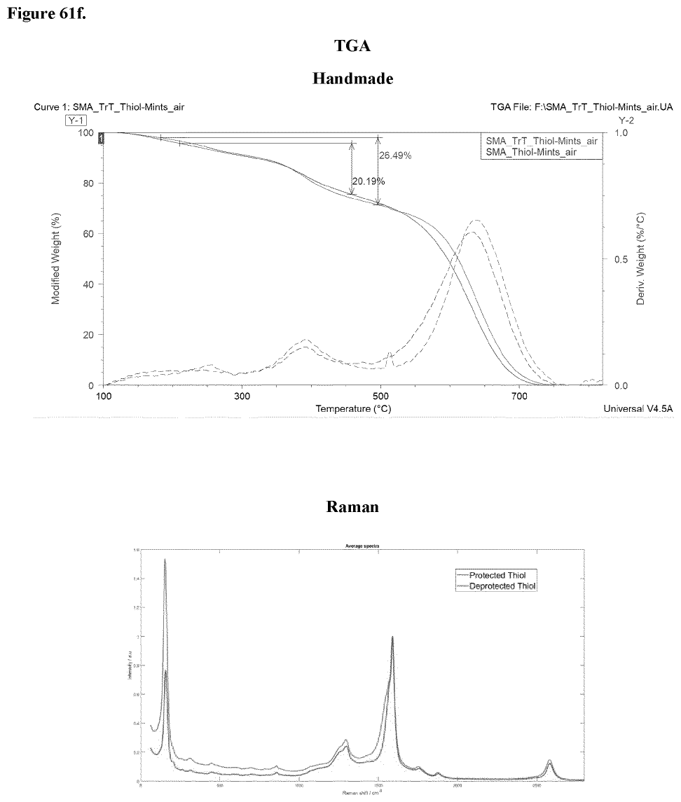

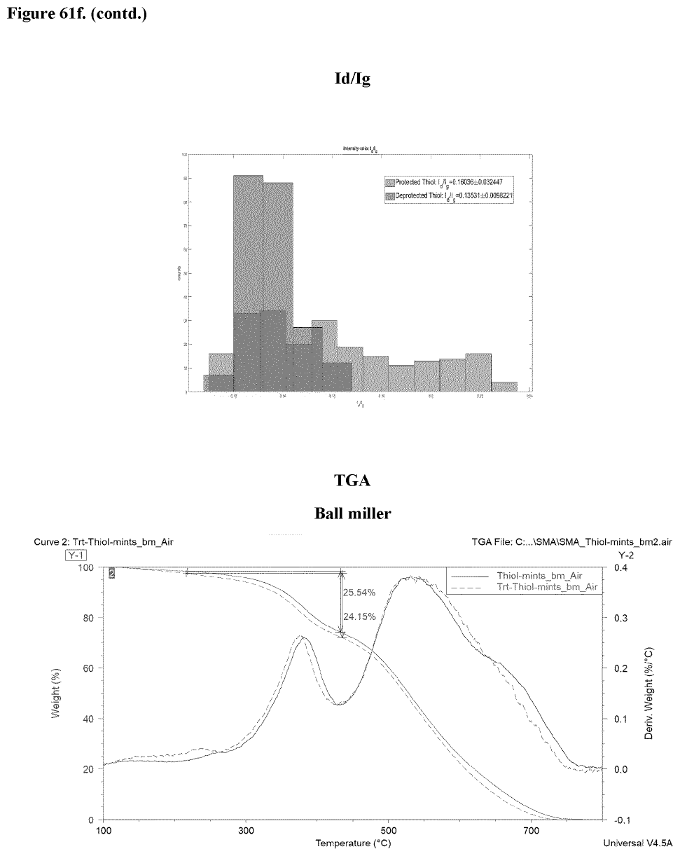

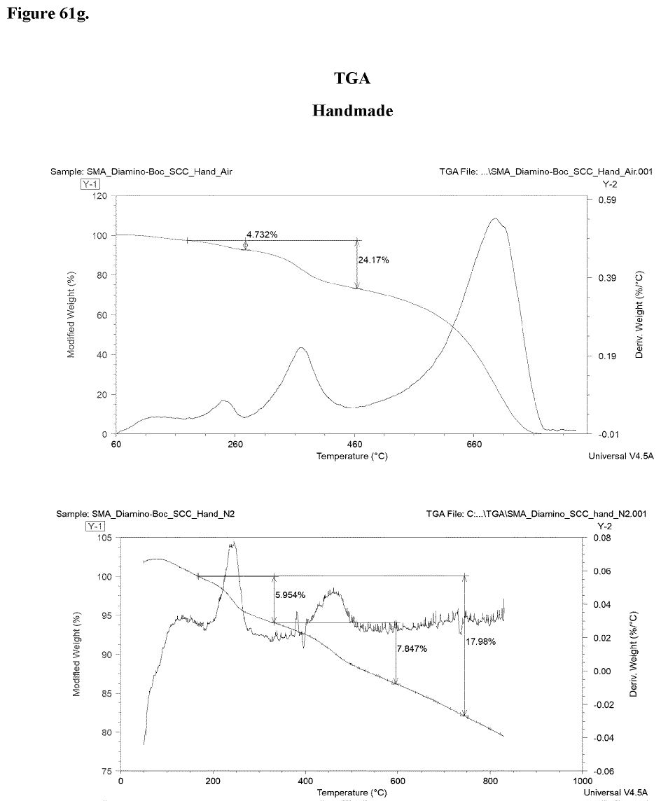

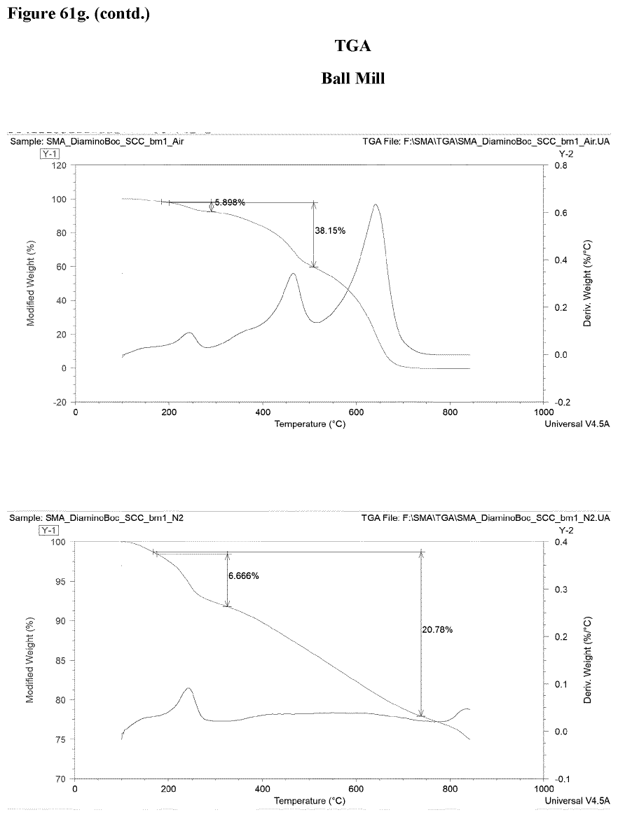

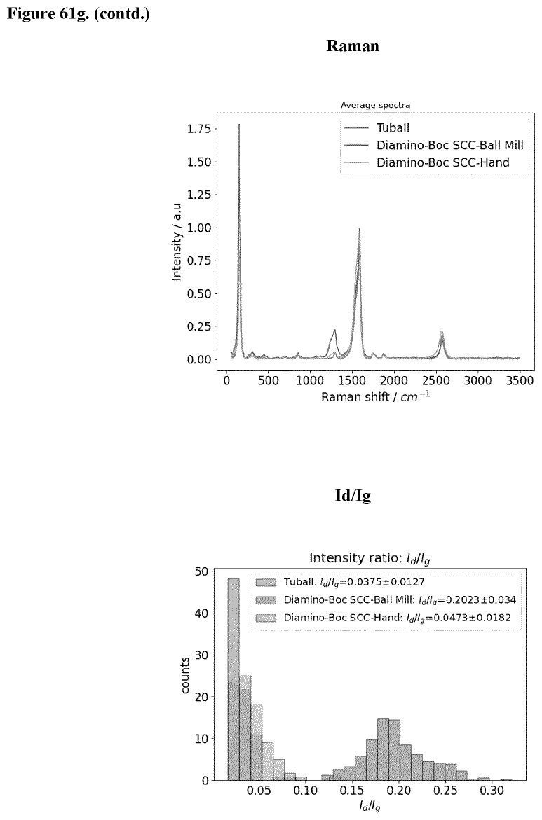

The mentioned protocol below was used for “Diamino-Boc U-Shape of Example GG2f”, “Pyridine U-Shape of Example GG4” and “Dialkylated-pyrene of Example GG1c”.
Step 1: In a round bottom flask containing 1000 mL of TCE (1 mL per mg CNTs), SWNTs (Tuballs de OCSIAl)(1 g) were added.
Step 2: The SWNTs were dispersed by bath sonication at 20° C. for 15 min
Step 3: The U-shape (1 g, 1 mg/l mg CNTsl) was added
Step 4: The suspension was bubbled with argon/N₂ for 20 minutes
Step 5: 2^{nd} gen. Grubbs catalyst (1 equiv/U-Shape) was added and the suspension was stirred for 72 h at room temperature.
Step 6: After this time, the reaction mixture was filtered through a PTFE membrane of 0.2 μm pore size.
Step 7: The filter cake was collected and was re-dispersed in 250 mL dichloromethane in a round-bottom flask by bath sonication for 10 min.
Step 8: The sample was filtered again through a PTFE membrane of 0.2 μm pore size.
Step 9: Steps 5 and 6 were repeated two times
Step 10: Approximately 50 mL Et₂O was added to the filter cake.
Step 11: The MINTs were collected in a vial and dried in oven at 135° C. overnight.
Step 12: The Mints from Diamine-Boc U-shape GG2f were called “Diamine-Boc Mints of Example GG7a” (Compound GG7a1) with 27.7% functionalization measured in air-Tga (FIG. 61) and from Pyridine U-shape GG2f were termed “Pyridine Mints of Example GG7a” (Compound GG7b1) with 27.6% functionalization measured in air-Tga (FIG. 61).

When “Dialkylated-pyrene of Example GG1c” (Compound GG1d) was employed like U-Shape to make Mints, this protocol was followed with little modifications. In the Step 3: Dialkylated-pyrene GG1d was added in 6, 12, 18, 24 and 200 mol/mg SWNTs and in Step 5: the amount of Grubbs catalyst was 0.5 equiv/dialkylated-pyrene. Thus, five several mints were prepared with different amounts of “Dialkylated-pyrene of Example GG1c” (Compound GG1d), as depicted in the following table

| | | | |
|---|---|---|---|
| Dialkylated GG1c | Grubbs^{b} | TGA^{b} | Mints |

| μmol/mg NTs | mmol | mmol | % Func. | Called |
|---|---|---|---|---|
| 6 | 0.6 | 0.3 | 20 | GG7c1 |
| 12 | 1.2 | 0.6 | 30 | GG7c2 |
| 18 | 1.8 | 1.2 | 40 | GG7c3 |
| 24 | 2.4 | 1.8 | — | GG7c4 |
| 200 | 20 | 10 | — | GG7c5 |

^{a}All Dialkylated-Mints GG7c were prepared with 100 mL of TCE and 100 mg of SWNTs;
^{b}0.5 equiv of Grubbs with respect to Dialylated GG1c.
^{b}In FIG. 61, c.

### Example GG7b: Mechanochemical Method

These methods use the mechanical energy generated in a ball mill or by hand in a mortar to disperse the CNTs, binds the U-shape molecule to the CNTs and makes the ring-closing metathesis.
Step 1: In a 20 mL-size stainless steel ball mill reactor, SWNTs (150 mg), U-shape (150 mg, 1 mg/l mg NTs) and 2^{nd} gen. Grubbs catalyst (0.5 mol %) were added.
Step 2: The reactor was charged with five stainless steel balls.
Step 3: The powders were milled for 10 min at 500 rpm in an air atmosphere.
Step 4: After this time, the reactor content was recovered. Dichloromethane was added and the reaction mixture was filtered through a PTFE membrane of 0.2 μm pore size.
Step 5: The filter cake was collected and was re-dispersed in dichloromethane in a round-bottom flask by bath sonication for 10 min.
Step 6: The sample was filtered again through a PTFE membrane of 0.2 μm pore size.
Step 7: Steps 5 and 6 were repeated
Step 8: Et₂O was added to the filter cake.
Step 9: The MINTs were collected in a vial and dried in oven at 135° C. for 3 hours.

The above protocol was used for GG2f, GG3d, GG4a and GG5b products. In the case of GG4a, step 3 was also carried out in 5 min. On the other hand, step 1 was modified by using GG4a (0.48 mol/mg Tuball) and Grubbs catalyst (0.05 mol %) for 5 and 10 min in step 3. In the order hand for GG5b and GG3d products, in step 1 was modified by using GG5b/GG3d (0.48 mol/mg Tuball) and Grubbs catalyst (0.1 mol %), in step 5, GG5b/GG3d were not sonicated but directly washed several times with DCM and in step 9 the mints were dried at 80° C. overnight.

Steps 2 and 3 can be performed by hand in an agate mortar for 30 min and the other steps are the same. In summary, five different batches of GG4a were prepared as shown in the following tables.

| | Pyridine | | Time | TGA^{d} | Mints |
|---|---|---|---|---|---|
| Method | U-Shape | Grubbs^{c} | (min) | (% Funt.) | Called |
| By hand | 1^{a} | 0.5 | 30 | 23 | GG7b2 |
| Ball Miller | 0.48^{b} | 0.05 | 5 | 23 | GG7b3 |
| Ball Miller | 0.48^{b} | 0.05 | 10 | 28.5 | GG7b4 |
| Ball Miller | 1^{a} | 0.5 | 5 | 36 | GG7b5 |
| Ball Miller | 1^{a} | 0.5 | 10 | 45 | GG7b6 |

^{a}In all the case 1 equiv of tuball (1 w/w mg/mg NT);
^{b}0.48 μmol/mg NT;
^{c}equiv of Grubbs with respect to Pyridine U-Shape GG4a.
^{d}In FIG. 61, d.

And two batches of GG2f, as shown in the tables below

| | Diamino- | | | | |
|---|---|---|---|---|---|
| | Boc U- | | Time | TGA^{c} | Mints |
| Method | Shape^{a} | Grubbs^{b} | (min) | (% Funt.) | Called |
| By hand | 1 | 1 | 30 | 27 | GG7a2 |
| Ball Miller | 1 | 1 | 10 | 27 | GG7a3 |

^{a}In all the case 1 equiv of tuball (1 w/w mg/mg NT);
^{b}1 equiv of Grubbs with respect to Diamino-Boc U-Shape GG2f.
^{c}In FIG. 61, e.

And two batches of GG3d, as shown in the tables below

| | Diamino- | | | | |
|---|---|---|---|---|---|
| | Boc U- | | Time | TGA^{b} | Mints |
| Method | Shape^{a} | Grubbs | (min) | (% Funt.) | Called |
| By hand | 1 | 0.5 | 30 | 24.2 | GG7f1 |
| Ball Miller | 1 | 0.1 | 10 | 42.9 | GG7f2 |

^{a}In all the case 0.48 μmol GG3d/mg Tuball;.
^{b}In FIG. 61, e (in Air).

And two batches of GG5b, as shown in the tables below

| | Trt-Thiol | | Time | TGA^{c} | Mints |
|---|---|---|---|---|---|
| Method | U-Shape | Grubbs^{b} | (min) | (% Funt.) | Called |
| By hand | 0.48^{a} | 0.1 | 30 | 26.5 | GG7d1 |
| Ball Miller | 0.48^{a} | 0.1 | 10 | 25.5 | GG7d2 |

^{a}0.48 μmol/mg NT,
^{b}0.1 equiv of Grubbs with respect to Trt-Thiol U-Shape GG5b.
^{c}In FIG. 61, f

### Example GG7c: Desprotection of Trt-Thiol-Mints (GG7d)

Step 1: Trt-Thiol-Mints GG7d (450 mg, 1 equiv) and HSiEt₃ (95 μL, 1.5 equiv) in dry DCM (8.1 mL, 20.5 mL/mmol) were stirred at room temperature into a round bottom flask.
Step 2: TFA (325 μL, 0.82 mL/mmol) was added dropwise.
Step 3: The reaction was left stirring at room temperature for 2 hours.
Step 4: Unprotected Thiol-Mints GG7e were isolated by filtration through a PTFE membrane of 0.2 μm pore size.
Step 5: they were washed several times with DCM and finally with ether.
Step 6: Thiol-Mints GG7e were dried in the oven at 80 C overnight.

How to check that the reaction is gone;
Step 7: the washes was removed under reduced pressure.
Step 8: White solid was appeared.
Step 9: TrtH was showed by H-nmr.

The two batches of GG7e, as shown in the tables below

| | Trt-Thiol- | TGA^{a} | Thiol-Mints | Tga^{a} |
|---|---|---|---|---|
| Method | Mints | (% Funt.) | Unprotected | (% Funt.) |
| By hand | GG7d1 | 26.5 | GG7e1 | 20.2 |
| Ball Miller | GG7d2 | 25.5 | GG7e2 | 24 |

^{a}In FIG. 61, f.

### Examples GG8. PMMA Composite Via Solvent Mixing

In this section, PMMA composites were prepared for 0.1% filler for the five batches of “Pyridine Mints of Example GG7b” and 1% for the four batches of “Dialkylated-Mints of Example GG7a” and commercial PMMA via solvent mixing. (similar to Example BB3: Composites comprising commercial PMMA and SWNT-ML complexes prepared).
Step 1: The Mints were dispersed in toluene by stirring at room temperature for 24 hours.
Step 2: PMMA was added and the reaction mixture was heated at 60° C. for another 24 hours.
Step 3: The crude was poured into a Teflon petri dish.
Step 4: It was allowed to dry in the oven at 80° C. overnight.

| | Total | | | | | |
|---|---|---|---|---|---|---|
| | weight | Polimer | Filler | TGA | Mints | |
| Batch | (g) | (g) | % | Funt. | (mg) | Composite |
| GG7c2 | 10.13 | 9.992 | 1 | 0.2 | 128 | GG8a1 |
| GG7c3 | 10.15 | 10.005 | 1 | 0.3 | 145 | GG8a2 |
| GG7c4 | 8 | 7.866 | 1 | 0.4 | 133 | GG8a3 |
| GG7c5 | 11 | 10.725 | 1 | 0.6 | 275 | GG8a4 |

In the table immediately above the data of the 1% “Dialkilated-Mint_PMMA composites” of Example GG8 is shown. In this case, “Dialkylated-Mints of Example GG7a” (Compound GG7c) were used.

The next table shows that the amount of “Pyridine-Mints of Example GG7b” and PMMA to prepared 0.1% “Pyridine-Mints_PMMA composites” which were also named GG8b:

| | Total | | | | | |
|---|---|---|---|---|---|---|
| | weight | Polimer | Filler | TGA | Mints | Composite |
| Batch | (g) | (g) | % | Funt. | (mg) | Called |
| GG7b2 | 6 | 5.992 | 0.1 | 0.23 | 7.79 | GG8b1 |
| GG7b3 | 6 | 5.992 | 0.1 | 0.23 | 7.79 | GG8b2 |
| GG7b4 | 6 | 5.994 | 0.1 | 0.285 | 7.716 | GG8b3 |
| GG7b5 | 6 | 5.99 | 0.1 | 0.36 | 9.37 | GG8b4 |
| GG7b6 | 6 | 5.989 | 0.1 | 0.45 | 10.9 | GG8b5 |

### Examples GG9. Preparation of Composites in the Shape of Dogbones

The PMMA composites of Example GG8 were molded in shape of dogbones with the same protocol of Example BB2: Protocol for preparation of SWNT-ML/polymer composites, in the shape of “dog bones” or rectangles.

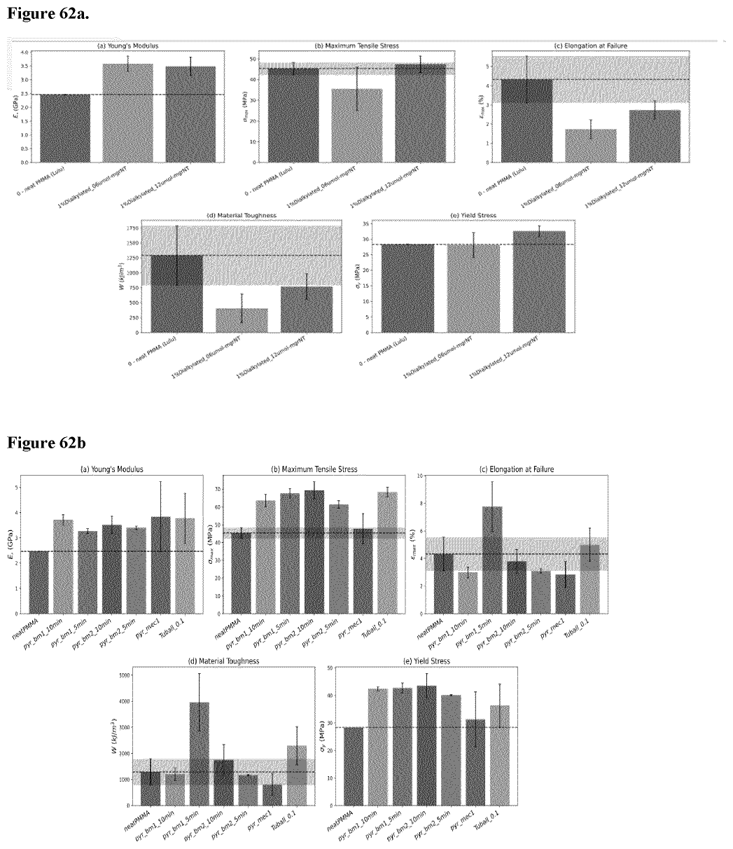

Mechanical characterization of “Composite GG8b of Example GG8” was conducted by tensile test measurements. Summary of Young's modulus data and their respective calculated load transfer values is shown in the table below (you can see the graphic in FIG. 62, section b).

| | | | Young's | Load |
|---|---|---|---|---|
| | Filler | TGA | modulus | transfer |
| Composite | % | Funt. | (MPa) | % |
| neat PMMA | — | — | 2464.41 | — |
| Tuball-PMMA | 0.1 | — | 3782.97 | 1228.9 |
| GG8b1 | 0.1 | 23 | 3836.04 | 1278.4 |
| GG8b2 | 0.1 | 23 | 3269.24 | 750.61 |
| GG8b3 | 0.1 | 28.5 | 3717 | 1167.5 |
| GG8b4 | 0.1 | 36 | 3399.08 | 871.5 |
| GG8b5 | 0.1 | 45 | 3512.89 | 977.5 |

All PMMA-composite at 0.1% filler loading exhibit higher Young's modulus than the neat PMMA polymer and only the GG8b1 composite is higher than pristine SWNNT. All graphs of these measurements are depicted in FIG. 61.

### Example GG10. Synthesis of Pyrene-1,6-dicalbaldehyde

This example describes the synthesis of a pyrene derivative with two aldehyde groups in position 1 and 6 in the pyrene core, the compound (GG10a), which is used as a monomer in the synthesis of polyimide polymers providing recognition motifs towards SWNTs that they can help to better disperse them within the polymer.

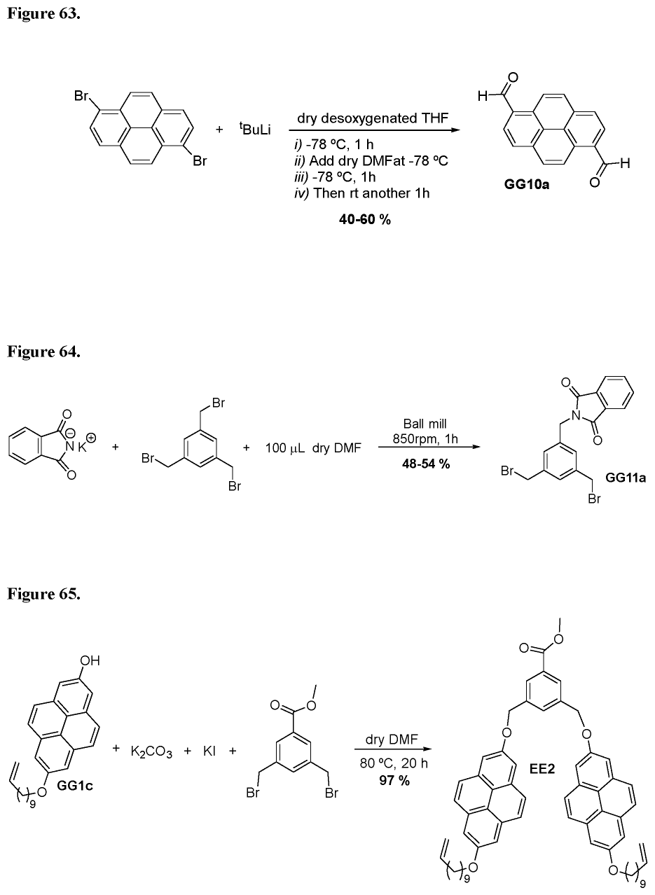

The synthesis consists of one reaction step, as shown in (FIG. 63). The synthesis is similar to that described in New J. Chem., 2023, 47, 1388-1400.

### Example GG10a. Synthesis of Pyrene-1,6-dicalbaldehyde (GG10a)

Step 1: commercial 1, 6-dibromopyrene (1 g, 2.8 mmol, 1 equiv) was suspended in dry deoxygenated THF (25 mL, 9 mL/mmol) under an argon atmosphere.
Step 2: to a solution of tert-butyllithium in hexane (7.4 mL, 1.7 M, 4.5 equiv) was added dropwise at 78° C.
Step 3: The reaction mixture was stirred at 78° C. for 1 hour.
Step 4: After that, to the orange solution was added dropwise dry DMF (2.2 mL, 10 equiv) at 78° C. and the solution turned yellow.
Step 5: The solution was stirred at 78° C. for 1 hour, and then at room temperature for another hour.
Step 6: H₂O (23.3 mL, 8.3 mmol) was added.
Step 7: The yellow solid formed was collected by filtration, washed with H₂O (14 mL, 5 mmol), methanol (14 mL, 5 mmol), and hot toluene (14 mL, 5 mmol).
Step 8: The yellow solid obtained was purified by column chromatography using a CHCl₃/Hex (9:1) mixture as eluent to afford 350 mg of the desired compound GG10a as a mustard-colored solid with 48% of yield. This product was called “Pyrene-1,6-dicalbaldehyde of Example GG10a” (Compound GG10a).

The correct structure of the finals products GG10a was verified by nuclear magnetic resonance (¹H) and compared with data from the literature.

### Example GG11. Another Method to Synthesis of “Phthalimide Spacer of Example EE1B” Via Mechanochemistry

This example describes how the use of a ball mill to prepare the phthalimide-spacer of Example EE1B can decrease reaction time and increase yield, as shown in (FIG. 64).

### Example GG11a. Synthesis of Phthalimide Spacer (GG11a) Via Mechanochemistry

Step 1: commercial phthalimide potassium (50 mg, 0.27 mmol, 1 equiv) and 1, 3, 5-tribromoethylbenzene were putted into reactor of 20 mL, with 5 ball of 0=10 mm.
Step 2: 100 μL of dry DMF was added.
Step 3: The reactor was closed immediately.
Step 4: 6 cycles of 850 rpm of 10 min with break of 15 min (in total 1 hour in 850 rpm).
Step 5: The yellow pasted was extracted with DCM and Washed with water.
Step 6: the organic phase was dried over anhydrous MgSO₄.
Step 7: The yellow solid obtained was purified by column chromatography using a Hex/EtAcO (8:2) mixture as eluent to afford 55-62 mg of the desired compound GG11a as a yellow pale solid with 48-54% of yield. This product was called “Phthalimide spacer of Example EE1B” (Compound GG11a).

This method was carried out with 1 and 2 equiv of the halide, as described in the following table:

| | Phthalimide | | |
|---|---|---|---|
| Entry | potassium | 1,3,5-tribromomethylbenzene | mg/yield |
| A | 50 mg/1 equiv | 193 mg/2 equiv | 62 mg/54% |
| B | 50 mg/1 equiv | 96/1 equiv | 55 mg/48% |

### Example GG12: Another Method to Synthesize Ester U-Shape (EE2) in Anhydrous Conditions (FIG. 65)

Step 1: monopyrene (GG1c) (265 mg, 0.68 mmol, 2.2 equiv), activated K₂CO₃ (189 mg, 1.37 mmol, 4.4 equiv) and KI (catalyst amount) were dispersed in dry DMF (6 mL, 19.3 mL/mmol) under inert conditions.
Step 2: The reaction mixture was stirred at 40° C. for 3 hours.
Step 3: Then, commercial ester-spacer (100 mg, 0.31 mmol, 1 equiv) was added.
Step 4: The reaction mixture was left stirring at 80-82° C. for 20 hours.
Step 5: The mixture was cooled at 0° C.
Step 6: light brown solid appeared in the process and was isolated by filtration.
Step 5: obtaining about 281 mg of the desired compound EE2 as a light brown solid in 97% yield. This product was called “Ester U-Shape of Example EE2” (Compound EE2).

The correct structure of the finals products EE2 was verified by HR-MS and nuclear magnetic resonance (¹H, ¹³C, HSQC and HMBC).

### Example GG13. Deprotection Reaction of “Diamino-Boc U-Shape of Example GG2f”

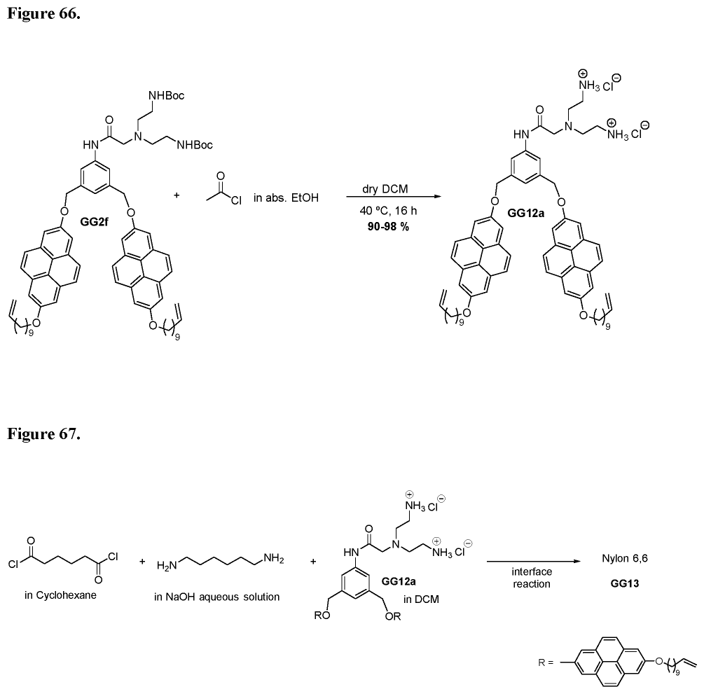

This example describes the synthesis of Diamino U-Shape, the compound (GG12a), with two free amine groups, which is used as a monomer in the synthesis of different polymers (such as epoxy, Nylon, polyurethane, among others) in such a way that the U-Shape is present in the backbone of the covalently attached polymer. The synthesis consists of one reaction step, as shown in (FIG. 66).

### Example GG13a. Synthesis of Diamino U-Shape (GG12a)

Step 1: Diamino-Boc U-Shape (GG2f) (1 g, 0.81 mmol, 1 equiv) was dissolved in dry DCM (8.1 mL, 10 mL/mmol) under inert conditions.
Step 2: to a solution of acetyl chloride (500 μL, 7.05 mmol, 8.7 equiv) in absolute ethanol (20.3 mL, 25 mL/mmol) was added carefully at 0° C.
Step 3: The reaction mixture was stirred at 40° C. overnight.
Step 4: Cream solid appeared in the process and was isolated by filtration.
Step 5: obtaining about 877 mg of the desired compound GG12a as a light brown solid in 98% yield. This product was called “Diamino U-Shape of Example GG12a” (Compound GG12a).

The correct structure of the finals products GG12a was verified by HR-MS and nuclear magnetic resonance (¹H, ¹³C, HSQC and HMBC).

### Example GG14. Synthesis of Nylon 6,6 Using Diamino U-Shape GG12a as the Diamine Monomer

This example describes the synthesis of Nylon 6,6 at the laboratory level using Diamino U-Shape (GG12a) in different amounts as monomer, since it has two free amino groups, which can react with adipoyl chloride in such a way that the U-Shape is present in the backbone of covalently bonded Nylon.

The synthesis consists of one reaction step, as shown in (FIG. 67).

### Example GG14a. Synthesis of Nylon-6,6 with Diamino U-Shape (GG13)

Step 1: NaOH (1.8 equiv) was dissolved (2 mL/mmol) in distilled water in a labeled beaker.
Step 2: Hexamethylenediamine (HMDA) was added to basic solution and was dissolved.
Step 3: Diamino U-Shape (0%, 0.01% and 0.05%) was added dissolved in DCM.
Step 4: Adipoyl chloride (1 equiv) was dissolved in cyclohexane (3.6 mL/mmol) in a second labeled beaker.
Step 5: slowly pour adipoyl chloride solution onto the top of the beaker containing the HMDA.
Step 6: Did not mix or stir. A film formed at the interface between the two solutions.
Step 7: With a pair of tweezers was taken the edge of the film and began to wind nylon in the form of a thread.
Step 8: They are collected in the following table:

| Adipoyl | | | Diamino U-Shape | | Called |
|---|---|---|---|---|---|
| chloride | HMDA | | (GG12a) | NaOH | Nylon |
| 1 eq | 1.8 | eq | — | 1.8 eq | GG13a |
| 1 eq | 0.98 | eq | 0.02 eq | 1.8 eq | GG13b |
| 1 eq | 0.95 | eq | 0.05 eq | 1.8 eq | GG13c |

### Example HH1. Alternative Method for the Synthesis of ROMP Polymer-Coated Carbon Nanotubes

In this example, the preparation of polymer-coated nanotubes is described. The procedure consists of a first nanotube individualization step, where a nanotube/polyUshape complex is generated and a second step, where the Ushapes of the polyUshape polymer are closed around the nanotubes in a ring-closing metathesis reaction. Due to the size of the SWNTs (diameters ranging from 1.2 to 1.7 nm) and the polyUshape molecules, two Ushapes react to form one macrocycle that encloses the SWNT. In the nanotube/polyUshape complex, two polyUshape molecules are required in order to wrap an entire SWNT section.
Step 1: To a vial, ROMP-U-shape (compound A6, 18 mg, 7.5·10⁻⁴ mmol) and SWNTs (Tuball SWNTs 01RW03, 1.2 mg) were added.
Step 2: Toluene (15 mL) was added to the vial.
Step 3: The mixture was sonicated in a bath sonicator for 3 h.
Step 4: The vial content was distributed in Eppendorfs and centrifuged at 18600 g for 15 min.
Step 5: The supernatant was recovered. The supernatant obtained was called “supramolecular ROMP polymer-coated SWNTs of Example HH1”
Step 6: The supernatant obtained was bubbled with N₂ for 20 min.
Step 7: Grubbs 2^{nd} generation catalyst (2.1 mg, 0.5 equiv/U-shape unit) was added.
Step 8: The mixture was left without stirring overnight.

The final mixture obtained was called “ROMP polymer-coated SWNTs of Example HH1”

### Variations on the Abovementioned Protocol:

In step 2, instead of toluene, different solvents can be employed for the formation of supramolecular ROMP-U-shape-SWNT complexes such as DMF, CHCl₃ or THF.

In step 4, instead of 18600 g, higher or lower centrifugation speeds can be used if appropriate time of centrifugation is used.

In step 7, Grubbs 2^{nd} generation catalyst can be employed in smaller or higher concentrations such as e.g. between 0.01 and 1 equivalents (relative to molar concentration of Ushapes of the polyUshape).

### Example HH2. Removal of Grubbs 2^{nd} Generation Catalyst and ROMP-U-Shape from Preparations of Coated Nanotubes

In this example, different procedures for the removal of uncomplexed and/or non-ring-closed ROMP-polymer and Grubbs 2^{nd} generation catalyst in SWNT-ROMP polymer composites is described.

### Example HH2, A. Cleaning by Filtration

Step 1: The final product obtained in Example HH1, “ROMP polymer-coated SWNTs of Example HH1” was poured into a round bottom flask containing 100 mL toluene.
Step 2: The mixture was homogenised by brief sonication (2 min in a bath sonicator).
Step 3: The sample was filtered through a PTFE membrane of 0.2 μm pore size.
Step 4: The composite was collected from the filter and was re-dispersed in 100 mL toluene in a round-bottom flask by bath sonication for 3 min.
Step 5: The sample was filtered again through a PTFE membrane of 0.2 μm pore size.
Step 6: Steps 4 and 5 were repeated until the residual washes obtained were completely colorless.
Step 7: Steps 4 and 5 were repeated using CH₂Cl₂ as solvent.
Step 8: Some Et₂O was added to the filter cake.
Step 9: The composite was collected in a vial and dried overnight at room temperature.

The final composite was called “Filtered ROMP polymer-coated SWNT of Example HH2, A”

### Example HH2, B. Cleaning by Toluene Precipitation and Centrifugation

Step 1: The final product obtained in Example HH1, “ROMP polymer-coated SWNTs of Example HH1” was centrifuged in a vial at 998 g for 15 min.
Step 2: The supernatant obtained was removed carefully.
Step 3: Toluene was added to the precipitate and the vial was hand-shaken for one minute.
Step 4: The mixture was centrifuged again at 998 g for 10 min.
Step 5: Steps 3 and 4 were repeated until the supernatant obtained was completely colorless.
Step 6: The supernatant was removed and the precipitate obtained was called “Wet toluene-precipitated ROMP polymer-coated SWNTs of Example HH2, B”

### Step 7: The precipitate obtained was dried overnight in an oven at 120° C.

The final composite was termed “Toluene-precipitated ROMP polymer-coated SWNTs of Example HH2, B”

### Example HH2, C. Cleaning by Dialysis

Step 1: The final product obtained in Example HH1, called “ROMP polymer-coated SWNTs of Example HH1” was transferred to a dialysis tubing cellulose membrane
Step 2: The closed cellulose tube was introduced in a 1 L beaker containing 500 mL toluene.
Step 3: A magnetic stirrer was added and the mixture was slowly stirred for 3 days. Every day, the toluene contained in the beaker was replaced with clean toluene.
Step 4: The cellulose tube was opened and the content was filtered through a PTFE membrane of 0.2 μm pore size.
Step 6: The precipitate obtained was dried overnight in an oven at 120° C.

The final composite was termed “Dialyzed ROMP polymer-coated SWNTs of Example HH2, C”

### Example HH2, D. Cleaning by Dialysis not Involving Filtering

This example is a variation of Example HH2, C.
Step 1: The final product obtained in Example HH1, called “ROMP polymer-coated SWNTs of Example HH1” was transferred to a dialysis tubing cellulose membrane
Step 2: The closed cellulose tube was introduced in a 1 L beaker containing 500 mL toluene.
Step 3: A magnetic stirrer was added and the mixture was slowly stirred for 3 days. Every day, the toluene contained in the beaker was replaced with clean toluene.
Step 4: The cellulose tube was opened and the content was poured in a round-bottom flask.
Step 6: The solvent was evaporated in air or using a rotary evaporator.

The final composite was termed “Dialyzed ROMP polymer-coated SWNTs of Example HH2, D”

### Example HH2, E. Cleaning by Extraction

Step 1: To the final product obtained in Example HH1 a solution of mercaptonicotinic acid (MNA) was added (1.2 equiv. with respect to Grubbs catalyst). MNA serves as both a ruthenium scavenger and catalyst deactivator.
Step 2: The mixture obtained in Step 1 was stirred for 15 min.
Step 3: The organic phase was washed four times with NaHCO₃ and MNA.
Step 4: After the washes, the organic solvent was evaporated under reduced pressure.

The final composite was termed “Extracted ROMP polymer-coated SWNTs of Example HH2, E”

### Example HH2, F. Cleaning by Precipitation and Solvent Removal

Step 1: To the final product obtained in Example HH1 methanol was added (aprox. 2 mL) in order to precipitate the final product.
Step 2: The solvent was carefully poured and discarded.
Step 3: THF (15 mL) was added in order to dissolve the residual ROMP-U-shape and Grubbs 2^{nd} generation catalyst.
Step 4: The mixture was hand-shaked, left for five minutes to precipitate and the upper solvent containing the ROMP-U-shape and Grubbs was carefully poured and discarded.
Step 5: Steps 3 and 4 were repeated until the upper solvent obtained was completely colorless.
Step 6: The product obtained was dried in air.

The final composite was termed “Methanol-precipitated ROMP polymer-coated SWNTs of Example HH2, G”

### Example HH2, H. Cleaning by Filtration that does not Involve Sonication

Step 1: The final product obtained in Example HH1, “ROMP polymer-coated SWNTs of Example HH1” was poured into a PTFE membrane of 0.2 μm pore size.
Step 2: Toluene was added in order to remove the remaining ROMP-U-shape and Grubbs 2^{nd} generation catalyst. The addition was stopped when no color could be observed in the residual toluene.
Step 3: The filter cake was collected in a vial and dried overnight at room temperature.

The final composite was called “Filtered ROMP polymer-coated SWNT of Example HH2, H”

### Example HH3. A Dogbone Made from Shear Mixed PS/0.1% SWNT

In this example, coated SWNT is added to PS as reinforcing agent.
Step 1: To 12 g polystyrene was added 150 mL of a freshly prepared “ROMP polymer-coated SWNTs of Example HH1” comprising 12 mg SWNT.
Step 2: The sample was poured into a 250 mL beaker and was stirred with an overhead stirrer for 2 h at 9000 rpm.
Step 3: The mixture was further stirred at 2000 rpm for 2 h. During this time, part of the toluene was evaporated.
Step 4: The wet composite obtained was poured in a glass petri dish and solvent was eliminated by heating the sample in an oven at 120° C. overnight.
Step 5: The composite obtained was hot pressed at 175° C. and a 2 mm-thick plate was prepared.
Step 6: Dogbones were cut from the plate using a waterjet cutter. The obtained samples were called “0.1% SWNT/PS composite of Example HH3”.

### Variations on the Abovementioned Protocol:

In step 1, the quantity of the freshly prepared “ROMP polymer-coated SWNTs of Example HH1” added was increased in order to increase the SWNT content in the final composite. 12 g polystyrene were mixed with 1.5 L of a freshly prepared “ROMP polymer-coated SWNTs of Example HH1”, and Steps 1-6 were otherwise performed as described above, to obtain “1% SWNT/PS composite of Example HH3”.

### Example HH4. A Dogbone Made from Shear Mixed 0.1% SWNT/PMMA Composite

Step 1: 12 g PMMA were dissolved in 1 L CHCl₃.
Step 2: 150 mL of a freshly prepared “ROMP polymer-coated SWNTs of Example HH1” were added to the dissolved PMMA (the final SWNT in the composite is 0.1%).
Step 3: The sample was stirred with an overhead stirrer for 2 h at 9000 rpm.
Step 4: The mixture was further stirred at 2000 rpm for 2 h. During this time, part of the toluene/CHCl₃ mixture was evaporated.
Step 5: The wet composite obtained was poured in a glass petri dish and solvent was eliminated by heating the sample in an oven at 120° C. overnight.
Step 6: The composite obtained is hot pressed at 160° C. and a 2 mm-thick plate is prepared.
Step 7: Dogbones were cut from the plate using a waterjet cutter. The obtained dog bone samples were called “PMMA reinforced with SWNT-ROMP polymer composite having a 0.1% SWNT content from Example HH4”.

Tensile strength and Reduced Modulus was finally determined and showed improvement relative to neat polymer.

### Example HH5. A Dogbone Made from Shear Mixed 0.1% SWNT/PVC

In this example, SWNT-ROMP polymer composite is added to PVC as reinforcing agent.
Step 1: 12 g PVC were dissolved in 1 LTHF
Step 2: 150 mL of a freshly prepared “dispersed SWNT-ROMP polymer composite of Example HH1” were added to the dissolved PVC (the final SWNT in the composite is 0.1%).
Step 3: The sample was stirred with an overhead stirrer for 2 h at 9000 rpm.
Step 4: The mixture was further stirred at 2000 rpm for 2 h. During this time, part of the toluene/THF mixture was evaporated.
Step 5: The wet composite obtained was poured in a glass petri dish and solvent was eliminated by heating the sample in an oven at 120° C. overnight.
Step 6: The composite obtained was hot pressed at 150° C. and a 2 mm-thick plate is prepared.
Step 7: Dogbones were cut from the plate using a waterjet cutter. The obtained samples were called “PVC reinforced with SWNT-ROMP polymer composite having a 0.1% SWNT content from Example HH5”.

Tensile strength and Reduced Modulus was finally determined and showed improvement relative to neat polymer.

### Example HH6. Mechanochemical polyMINT Synthesis

The method makes use of the mechanical energy generated in a ball mill to disperse the CNTs, and/or bind the ROMP polymer to SWNTs, and/or mediate the ring-closing metathesis.
Step 1: In a 20 mL-size stainless steel ball mill reactor, SWNTs (250 mg), ROMP-U-shape (compound A3, 205 mg, ratio SWNT/ROMP-U-shape 1:0.82) and Grubbs 2^{nd} gen. catalyst (7.6 mg, 5 mol %) were added.
Step 2: The reactor was charged with five 10 mm diameter stainless steel balls.
Step 3: The powders were ball milled for 10 min at 500 rpm in an air atmosphere.
Step 4: After this time, the reactor content was recovered. THF was added and the reaction mixture was filtered through a PTFE membrane of 0.2 μm pore size.
Step 5: The filter cake was collected and was re-dispersed in 100 mL THF in a round-bottom flask by bath sonication for 3 min.
Step 6: The sample was filtered again through a PTFE membrane of 0.2 μm pore size.
Step 7: Steps 5 and 6 were repeated until the residual washes obtained were relatively colorless.
Step 8: Steps 5 and 6 were repeated using CH₂Cl₂ as solvent.
Step 9: Approximately 20 mL Et₂O was added to the filter cake.
Step 10: The ROMP polymer-coated SWNTs were collected in a vial and dried overnight at room temperature.

The powder obtained was called “Mechanochemical ROMP polymer-coated SWNTs of Example HH6”

### Example HH7. Large-Scale Solution Synthesis of ROMP Polymer-Coated Carbon Nanotubes

This example is a variation of Example HH1. Here, the preparation of polymer-coated nanotubes in high amounts is described. The procedure consists of a first nanotube individualization step, where a nanotube/polyUshape complex is generated and a second step, where the Ushapes of the polyUshape polymer are closed around the nanotubes in a ring-closing metathesis reaction.
Step 1: To a round-bottom flask, ROMP-U-shape (compound A3, 15 g, 0.63 mmol) and SWNTs (1 g) were added.
Step 2: Toluene (1 L) was added to the flask.
Step 3: The mixture was sonicated in a bath sonicator for 3 h.
Step 4: The flask content was distributed in conical centrifuged tubes and centrifuged at 8000 g for 30 min.
Step 5: The supernatant was recovered.
Step 6: The supernatant obtained was bubbled with N₂ for 20 min.
Step 7: Grubbs 2^{nd} generation catalyst (1.75 g, 0.5 equiv/U-shape unit) was added.
Step 8: The mixture was left without stirring overnight.

The final mixture obtained was called “ROMP polymer-coated SWNTs of Example HH7”

### Variations on the Abovementioned Protocol:

In step 4, higher or lower centrifugation speeds and longer or shorter times can be used in order to increase the final concentration of ROMP polymer-coated SWNTs. Reducing the centrifugation times and speeds may lead to an increase in SWNTs that have not been completely individualized.

### Example HH8. Method for the Synthesis of ROMP Polymer-Coated Carbon Nanotubes Having Free Terminal Double Bonds

In this example, the preparation of polymer-coated nanotubes containing free terminal double bonds is described. The procedure consists of a first nanotube individualization step, where a nanotube/polyUshape complex is generated and a second step, where the Ushapes of the polyUshape polymer are closed around the nanotubes in a ring-closing metathesis reaction.

The difference with Example HH1 is that a terminating agent is added in the ring-closing metathesis step in order to avoid the reaction of all double bonds.
Step 1: To a vial, ROMP-U-shape (compound A3, 18 mg, 7.5-10¹ mmol) and SWNTs (1.2 mg) were added.
Step 2: Toluene (15 mL) is added to the vial.
Step 3: The mixture is sonicated in a bath sonicator for 3 h.
Step 4: The vial content is distributed in Eppendorfs and centrifuged at 18600 g for 15 min.
Step 5: The supernatant is recovered.
Step 6: The supernatant obtained is bubbled with N₂ for 20 min.
Step 7: Grubbs 2^{nd} generation catalyst (2.1 mg, 0.5 equiv/U-shape unit) is added.
Step 8: The mixture was left without stirring for 15 min.
Step 9: Ethyl vinyl ether (0.1 mL) is added in order to deactivate the ROMP catalyst. The mixture obtained is called “ROMP polymer-coated SWNTs solution containing free terminal double bonds of Example HH8”.
Step 10: Methanol is added in order to precipitate the formed product.
Step 11: The mixture is centrifuged at 998 g for 10 min.
Step 12: Toluene is added to the precipitate and the vial is hand-shaken for one minute.
Step 13: The mixture is centrifuged again at 998 g for 10 min.
Step 14: Steps 12 and 13 are repeated until the supernatant obtained is completely colourless.
Step 15: The supernatant is removed and the precipitate is recovered.
Step 16: The precipitate obtained is dried overnight in an oven at 120° C.

The dried powder obtained is called “Cleaned ROMP polymer-coated SWNTs containing free terminal double bonds of Example HH8”

### Variations on the Abovementioned Protocol:

In step 9, a different terminating agent may be employed such as di(ethylene glycol) vinyl ether.

Instead of steps 10-16 a different cleaning protocol may be employed such as

### Example HH9. In Situ Polymerization of Polystyrene (PS) in the Presence of ROMP Polymer-Coated Carbon Nanotubes Having Free Terminal Double Bonds

In this example, the preparation of composites containing PS covalently attached to ROMP-polymer coated carbon nanotubes is described. The free radical polymerization takes place in the “ROMP polymer-coated SWNTs solution containing free terminal double bonds of Example HH8”. During the PS polymerization, the free terminal double bonds in the ROMP polymer-coated SWNTs react forming a crosslinked structure where PS grafts from the ROMP polymer-coated SWNTs.

Styrene, abbreviated Sty (Mw=104.15 g/mol, Sigma-Aldrich), is used as monomer. 2,2-Azobis(2-methylpropionitrile), abbreviated AlBN (Mw=164.21 g/mol, Sigma-Aldrich), is used as free radical initiator.

The starting point in this example is an 1000× up-scaled version of “ROMP polymer-coated SWNTs solution containing free terminal double bonds of Example HH8”. Such up-scaling may be done by e.g., performing an appropriate number of parallel experiments identical to the one that generated “ROMP polymer-coated SWNTs solution containing free terminal double bonds of Example HH8”, or doing all reactions at higher volumes but same concentrations.
Step 1: 12 g of Sty is added to the 1000× up-scaled “ROMP polymer-coated SWNTs solution containing free terminal double bonds of Example HH8” and the mixture is stirred for 30 min.
Step 2: 200 mg of AlBN are added to the mixture. The temperature is set at 65° C.
Step 3: The mixture is stirred at 65° C. under N₂ for 20 h.
Step 4: After polymerization, the final composite is precipitated by adding 200 mL isopropanol.
Step 5: The composite is filtered on a cellulose filter, washed with isopropanol and dried.

The composite obtained is called “PS/ROMP-polymer coated carbon nanotubes of Example HH9”.

### Variations on the Abovementioned Protocol:

In step 1, different monomers, suitable for radical polymerization might be employed such as methyl methacrylate or styrene.

### Example HH10. Preparation of a Polycarbonate (PC) Composite Reinforced with Aligned ROMP Polymer-Coated SWNTs

In this example, the preparation of composites containing PC/ROMP-polymer coated carbon nanotubes is described. Here, no covalent bonds are formed between PC and ROMP polymer-coated SWNTs. For the composite preparation, first, a solution of ROMP polymer-coated SWNTs in DMF is prepared. Then, the PC is dissolved in the DMF solution at the desired concentration and the mixture is electrospun in order to obtain polycarbonate (PC) fibers reinforced with aligned ROMP polymer-coated SWNTs.

In this example, the starting solution is obtained from the repetition of steps 1 to 8 from Example HH1 but in step 2 instead of toluene, DMF is added.
Step 1: To 15 mL of “ROMP polymer-coated SWNTs of Example HH1”, PC is added (1.2 g)
Step 2: The solution obtained in Step 1 is stirred at room temperature until the PC is completely dissolved.
Step 3: The solution is transferred to a syringe and pumped at 1 mL/h with a voltage of 14 kV and constant temperature and humidity.
Step 4: The solution is electrospun over a rotating drum collector and the PC fibers formed are deposited onto the collector.

The polymeric fibers obtained are called “Polycarbonate (PC) fibers reinforced with aligned ROMP polymer-coated SWNTs of Example HH10”

### Example HH11. Synthesis of a ROMP-U-Shape Derivative Containing Less U-Shape Units

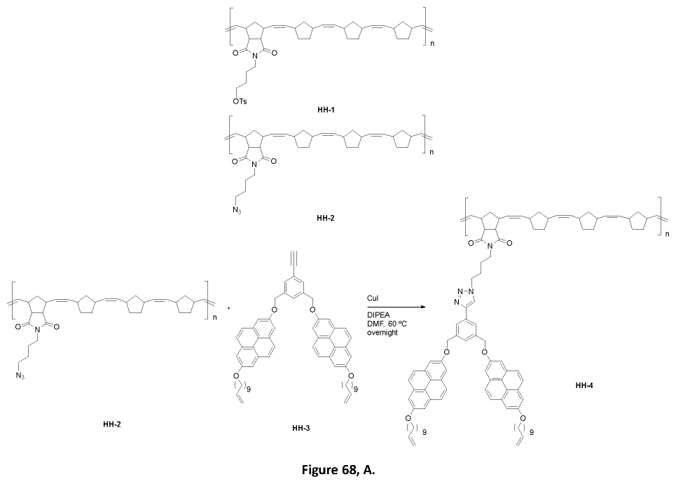

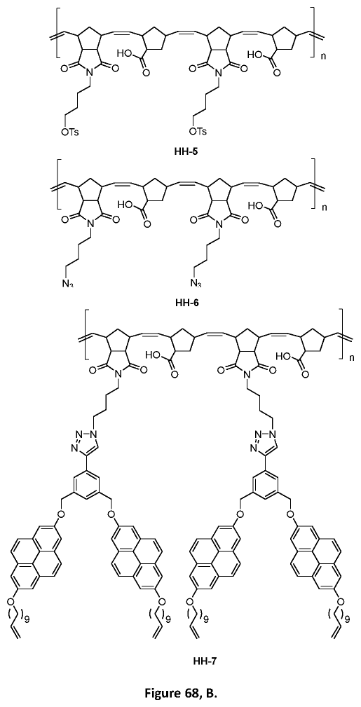

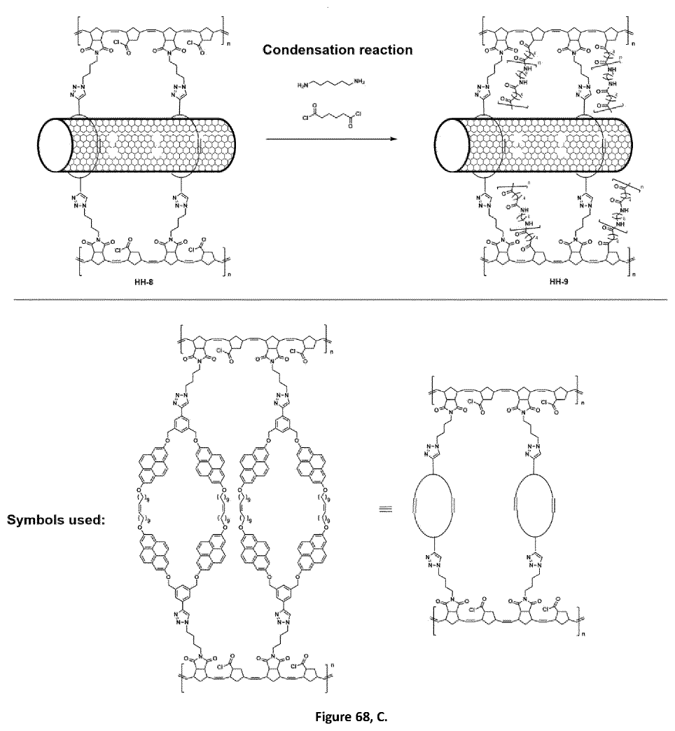

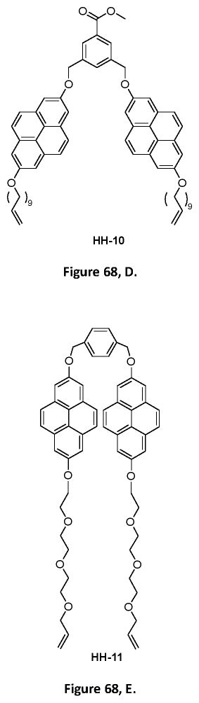

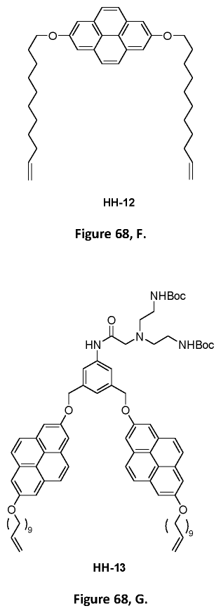

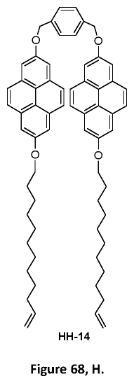

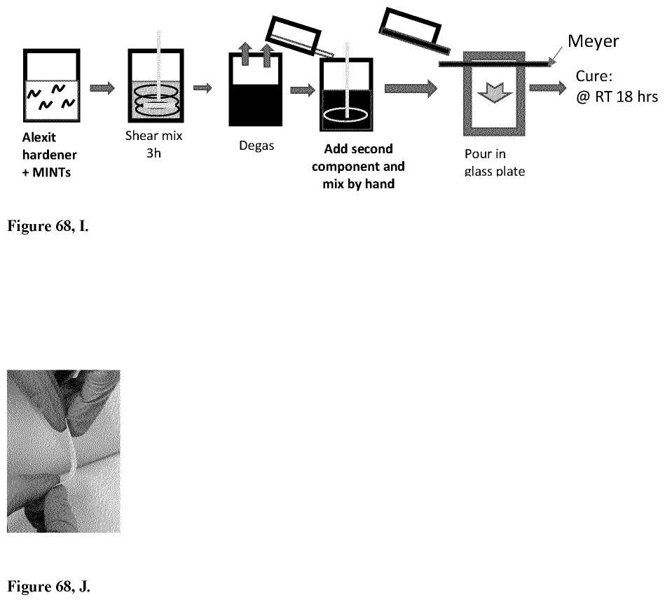

This example is a variation of Examples A1. Here, norbornene is copolymerized with N-(4-Tosylatebutyl)]-cis-5-norbornene-exo-2,3-dicarboximide in the Ring-Opening-Metathesis-Polymerization (ROMP).
Step 1: In a round-bottom flask, pre-dried in an oven at 120° C. for 1 h, N-(4-Tosylatebutyl)]-cis-5-norbornene-exo-2,3-dicarboximide (93.5 mg, 0.25 mmol, 1 equiv.) and 2-norbornene (CAS: 498-66-8, 70.6 mg, 0.75 mmol, 4 equiv.) are introduced and solubilized in dry dichloromethane (2.5 mL) under Argon.
Step 2: In a second round-bottom flask, pre-dried in an oven at 120° C. for 1 h, Grubbs-III (3rd generation, 50.6 mg, 0.057 mmol) catalyst was solubilized in dry dichloromethane (1 mL), under Argon.
Step 3: Then, the solution obtained in step 2 is added quickly (in 2-3 seconds) to the solution of step 1 under vigorous stirring and Argon atmosphere.
Step 4: The solution of step 3 is stirred for 3 h and ethyl vinyl ether (1.7 mL) is added in order to quench the reaction.
Step 5: The resultant polymer solution is dried under reduced pressure using a rotary evaporator with the bath at 35° C.
Step 6: The polymer is solubilized in dichloromethane (1 mL) and added with a 1 mL syringe quickly in diethyl ether (200 mL) under vigorous stirring. The clean polymer precipitates in the solution. This procedure was repeated twice.
Step 7: The precipitate is dried in vacuo and termed “ROMP-OTs derivate of Example HH11” (Compound HH-1, depicted in FIG. 68, A).
Step 8: In a round bottom 15 mL flask, pre-dried in an oven at 120° C., “ROMP-OTs derivate of Example HH11” (Compound HH-1, 100 mg) is added and solubilized in dry DMF (4 mL).
Step 9: The solution is deoxygenated with Argon for 20 min.
Step 10: NaN₃ (25 mg, 0.38 mmol) is added under Argon.
Step 11: The reaction is stirred for 12 h at 80° C. under argon atmosphere.
Step 12: NaCl in deionized water (5 mL) is added. DMF is partially removed under reduced pressure.
Step 13: The precipitate obtained is isolated by filtration and washed with water to give “ROMP-N₃ derivate of Example HH11” (Compound HH-2, depicted in FIG. 68, A).
Step 14: In a dry round bottom flask, pre-dried in an oven at 120° C. for 1 h, alkyne U-shape (Compound HH-3, 400 mg, 0.45 mmol) in deoxygenated and dry DMF (15 mL) is introduced together with “ROMP-N₃ derivate of Example HH11” (Compound HH-2, 100 mg).
Step 15: N,N-diisopropylethylamine (DIPEA) (0.06 mL, 0.36 mmol) and CuI (69 mg, 0.36 mmol) are added in the solution and the mixture is stirred at 60° C. overnight.
Step 16: Next day, CH₂Cl₂ (20 mL) and saturated NaCl deionized water (15 mL) are added together with aq. NH₃ (2 mL).
Step 17: The crude mixture is left for 15 min under vigorous stirring.
Step 18: The organic phase is washed three times with deionized water, dried with Na₂SO₄ and the organic solvent is removed by rotary evaporation.
Step 19: The solid obtained is solubilized in a small amount of CH₂Cl₂ and added quickly using a syringe into diethyl ether. The precipitate formed is collected by paper filtration and dried under vacuum. The final product is termed “ROMP-U-shape derivate of Example HH11” (Compound HH-4, depicted in FIG. 68, A).

### Variations on the Abovementioned Protocol:

In step 1, different ratios N-(4-Tosylatebutyl)]-cis-5-norbornene-exo-2,3-dicarboximide: 2-norbornene may be employed in order to synthesize ROMP-U-shape derivatives having more or less U-shape units.

### Example HH12. Solution Synthesis of ROMP Polymer-Coated Carbon Nanotubes Having Less U-Shape Units

This example is a variation of Example HH7. Here, polymer-coated nanotubes are prepared using the ROMP-U-shape derivative synthesized in Example HH11. In this example, the anchor points between ROMP-U-shape derivative and SWNTs are fewer since the ROMP-U-shape derivative has less U-shape units per polymer chain.
Step 1: To a round-bottom flask, “ROMP-U-shape derivate of Example HH11” (Compound HH-4, 15 g) and SWNTs (1 g) are added.
Step 2: Toluene (1 L) is added to the flask.
Step 3: The mixture is sonicated in a bath sonicator for 3 h.
Step 4: The flask content is distributed in conical centrifuged tubes and centrifuged at 998 g for 30 min.
Step 5: The supernatant is recovered.
Step 6: The supernatant obtained is bubbled with N₂ for 20 min.
Step 7: Grubbs 2^{nd} generation catalyst (0.44 g, 0.5 equiv/U-shape unit) is added.
Step 8: The mixture is left without stirring overnight.

The final mixture obtained is called “ROMP polymer derivative-coated SWNTs of Example HH12”

### Variations on the Abovementioned Protocol:

Optionally, the removal of uncomplexed and/or non-ring-closed ROMP-polymer derivative and Grubbs 2^{nd} generation catalyst in SWNT-ROMP polymer composites may be performed by following one or various of the cleaning procedures described in Example HH2, A to Example HH2, F.

### Example HH13. Synthesis of a ROMP-U-Shape Derivative Containing Free Acid Groups

In this example, a ROMP-U-shape derivative containing free acid groups is prepared. The acid groups may be later transformed into acid chloride groups and employed in the reaction with different monomers in order to graft polymers from the ROMP-U-shape structure (i.e., reaction with hexamethylenediamine for the synthesis of nylon).
Step 1: In a round-bottom flask, pre-dried in an oven at 120° C. for 1 h, N-(4-Tosylatebutyl)]-cis-5-norbornene-exo-2,3-dicarboximide (187 mg, 0.5 mmol, 1 equiv.) and 5-Norbornene-2-carboxylic acid (CAS: 120-74-1, 61 μL, 0.5 mmol, 1 equiv.) are introduced and solubilized in dry dichloromethane (2.5 mL) under Argon.
Step 2: In a second round-bottom flask, pre-dried in an oven at 120° C. for 1 h, Grubbs-III (3rd generation, 50.6 mg, 0.057 mmol) catalyst was solubilized in dry dichloromethane (1 mL), under Argon.
Step 3: Then, the solution obtained in step 2 is added quickly (in 2-3 seconds) to the solution of step 1 under vigorous stirring and Argon atmosphere.
Step 4: The solution of step 3 is stirred for 3 h and ethyl vinyl ether (1.7 mL) is added in order to quench the reaction.
Step 5: The resultant polymer solution is dried under reduced pressure using a rotary evaporator with the bath at 35° C.
Step 6: The polymer is solubilized in dichloromethane (1 mL) and added with a 1 mL syringe quickly in diethyl ether (200 mL) under vigorous stirring. The clean polymer precipitates in the solution. This procedure was repeated twice.
Step 7: The precipitate is dried in vacuo and termed “ROMP-OTs-acid derivate of Example HH13” (Compound HH-5, depicted in FIG. 68, B).
Step 8: In a round bottom 15 mL flask, pre-dried in an oven at 120° C., “ROMP-OTs-acid derivate of Example HH13” (Compound HH-5, 100 mg) is added and solubilized in dry DMF (4 mL).
Step 9: The solution is deoxygenated with Argon for 20 min.
Step 10: NaN₃ (50 mg, 0.76 mmol) is added under Argon.
Step 11: The reaction is stirred for 12 h at 80° C. under argon atmosphere.
Step 12: NaCl in deionized water (5 mL) is added. DMF is partially removed under reduced pressure.
Step 13: The precipitate obtained is isolated by filtration and washed with water to give “ROMP-N₃-acid derivate of Example HH13” (Compound HH-6, depicted in FIG. 68, B).
Step 14: In a dry round bottom flask, pre-dried in an oven at 120° C. for 1 h, alkyne U-shape (compound J8, 808 mg, 0.90 mmol) in deoxygenated and dry DMF (15 mL) is introduced together with “ROMP-N₃-acid derivate of Example HH13” (Compound HH-6, 100 mg).
Step 15: N,N-diisopropylethylamine (DIPEA) (0.15 mL, 0.90 mmol) and CuI (173 mg, 0.90 mmol) are added in the solution and the mixture is stirred at 60° C. overnight.
Step 16: Next day, CH₂Cl₂ (20 mL) and saturated NaCl deionized water (15 mL) are added together with aq. NH₃ (2 mL).
Step 17: The crude mixture is left for 15 min under vigorous stirring.
Step 18: The organic phase is washed three times with deionized water, dried with Na₂SO₄ and the organic solvent is removed by rotary evaporation.
Step 19: The solid obtained is solubilized in a small amount of CH₂Cl₂ and added quickly using a syringe into diethyl ether. The precipitate formed is collected by paper filtration and dried under vacuum. The final product is termed “ROMP-U-shape-acid derivate of Example HH13” (Compound HH-7, depicted in FIG. 68, B).

### Example HH14. Solution Synthesis of ROMP Polymer-Coated Carbon Nanotubes Having Free Terminal Acid Groups

This is a variation of Example HH12. In this case, instead of the “ROMP-U-shape derivate of Example HH11”, the “ROMP-U-shape-acid derivate of Example HH13” is employed in the preparation of ROMP polymer-coated carbon nanotubes. The free acid terminal groups present in the as-prepared ROMP polymer-coated carbon nanotubes will be employed as starting monomers in the polymerization of polymers (i.e., nylon).
Steps 1 to 8 from Example 12 are followed but in Step 1, instead of “ROMP-U-shape derivate of Example HH11”, “ROMP-U-shape-acid derivate of Example HH13” (Compound HH-7, 15 g) is added. In Step 7, the amount of Grubbs 2^{nd} generation catalyst added is determined by the quantity of U-shape units present in the ROMP-U-shape-acid derivative, in this example, 0.44 g are added (0.5 equiv/U-shape unit).

The final mixture obtained is called “ROMP polymer-coated SWNTs having free terminal acid groups of Example HH14”

### Variations on the Abovementioned Protocol:

Optionally, the removal of uncomplexed and/or non-ring-closed ROMP-polymer derivative and Grubbs 2^{nd} generation catalyst in SWNT-ROMP polymer composites may be performed by following one or various of the cleaning procedures described in Example HH2, A to Example HH2, F. i.e.:
Step 9: The final product obtained in Step 8, “ROMP polymer-coated SWNTs having free terminal acid groups of Example HH14” is centrifuged at 998 g for 30 min.
Step 10: The supernatant obtained is removed carefully.
Step 11: Toluene is added to the precipitate and the vial is hand-shaken for one minute.
Step 12: The mixture is centrifuged again at 998 g for 30 min.
Step 13: Steps 10 and 11 are repeated until the supernatant obtained is completely colorless.
Step 14: The supernatant is removed
Step 15: The precipitate obtained is dried overnight in an oven at 120° C.

The final composite is termed “Toluene-precipitated ROMP polymer-coated SWNTs having free terminal acid groups of Example HH14”

### Example HH15. Preparation of ROMP Polymer-Coated Carbon Nanotubes Having Free Terminal Acyl Chloride Groups

In this example, the terminal acid groups in the “Toluene-precipitated ROMP polymer-coated SWNTs having free terminal acid groups of Example HH14” are transformed into acyl chloride groups.
Step 1: 1 g “Toluene-precipitated ROMP polymer-coated SWNTs having free terminal acid groups of Example HH14” are added to a round-bottom flask.
Step 2: 10 mL SOCl₂ (thionyl chloride) are added to the flask.
Step 3: The mixture is stirred at 70° C. during 24 h under a nitrogen atmosphere.
Step 4: After this time, the unreacted SOCl₂ is eliminated by evaporation in a rotary evaporator.

The product obtained is termed “ROMP polymer-coated SWNTs having free terminal acyl chloride groups of Example HH15” (Compound HH-8, depicted in FIG. 68, C).

### Example HH16. In Situ Polymerization of Nylon in the Presence of ROMP Polymer-Coated Carbon Nanotubes Having Free Terminal Acyl Chloride Groups

In this example, nylon 6,6 is polymerized from the free terminal acyl chloride groups present in the “ROMP polymer-coated SWNTs having free terminal acyl chloride groups of Example HH15”. The synthesis involves the condensation between hexamethylenediamine, adipoyl chloride and the acyl groups in the ROMP polymer-coated SWNTs.
Step 1: Hexamethylenediamine (300 mg) and NaOH (100 mg) are dissolved in 5 mL distilled water.
Step 2: “ROMP polymer-coated SWNTs having free terminal acyl chloride groups of Example HH15” (Compound HH-8, 7.7 mg) and adipoyl chloride (0.37 mL) are dispersed in hexane (5 mL) using bath sonication (15 min).
Step 3: The solution obtained in step 2 is slowly poured onto the solution obtained in step 1. The hexamethylenediamine, adipoyl chloride and the acyl chloride groups present in the ROMP polymer-coated SWNTs polymerize in the interphase water/hexane.
Step 4: The fibre formed is winded onto a glass rod.
Step 5: The fibre is rinsed with water and dried in air.

The obtained composite is termed “Nylon 6,6 reinforced with ROMP polymer-coated SWNTs of Example HH16” (Compound HH-9, depicted in FIG. 68, C).

### Example HH17. Mechanochemical Synthesis of Nanotube-ML Complexes Using a Mortar

In this example, a general procedure for the mechanochemical synthesis of nanotube-ML complexes using a mortar (e.g., agate or porcelain mortar) is described. The precursor-ML binds first to the nanotube and its two ends are reacted to form a closed ring around the nanotube. The nanotube is a single-wall carbon nanotube (SWNT), the precursor-ML is a linear molecule and the mechanical ligand (ML) is a covalently closed ring structure.
Step 1. SWNTs (100 mg), ester precursor-ML (Compound HH-10 (depicted in FIG. 68, D), 42 mg, 0.48 μmol/mg NT) and Grubbs 2^{nd} generation catalyst (20 mg, 0.5 equiv./pyrene precursor-ML) were added to an agate mortar.
Step 2. The mixture was hand-grinded for 30 min. During this time, the heterogeneous mixture became a fine black powder as a consequence of the ring-closing metathesis taking place.
Step 3. After this time, the powder was recovered using a spatula. The resulting product, SWNTs with covalently closed ring structures around them and with low moisture content was termed “Mechanochemical SWNT-ML of Example 0”.
Step 4. Optionally, the residual Grubbs catalyst was removed by washing the final “Mechanochemical SWNT-ML of Example 0” powder with dichloromethane. The cleaned product was recovered by filtering through a 0.2 μm-pore size polytetrafluoroethylene (PTFE) membrane.

The resulting product, cleaned SWNTs with covalently closed ring structures around them and with low moisture content was termed “Washed mechanochemical SWNT-ML of Example HH17”.

### Example HH18. Mechanochemical Synthesis of Nanotube-ML Complexes Using a Ball Mill

This example is a modification of Example HH17. This example describes de synthesis of nanotube-ML complexes using a planetary ball mill. As in Example HH17, the precursor-ML is a linear molecule composed of two recognition motifs towards SWNTs and two terminal alkene functionalities that are reacted in a ring-closing metathesis forming a closed ring around the SWNT. See FIG. 68, E.
Step 1. SWNTs (1.5 g), ethylene glycol pyrene precursor-ML (Compound HH-11, 659 mg, 0.48 μmol/mg NT) and Grubbs 2^{nd} generation catalyst (31 mg, 0.05 equiv./pyrene precursor-ML) were added to a 45 mL stainless steel planetary ball mill reactor.
Step 2. The reactor was filled with 5 stainless steel 15 mm diameter grinding balls.
Step 3. The reactor was placed in the planetary ball mill and the reaction was carried out for 10 min at 500 rpm.
Step 4. After this time, the reactor was carefully opened and the powder obtained was recovered with a spatula.

The resulting product, SWNTs with covalently closed ring structures around them and with low moisture content was termed “Mechanochemical SWNT-ML of Example HH18”.
Step 5. Optionally, the residual Grubbs catalyst was removed by washing the final “Mechanochemical SWNT-ML of Example HH18” powder with dichloromethane. The cleaned product was recovered by filtering through a 0.2 μm-pore size polytetrafluoroethylene (PTFE) membrane.

The resulting product, cleaned SWNTs with covalently closed ring structures around them and with low moisture content was termed “Washed mechanochemical SWNT-ML of Example HH18”.

### Example HH19. Sequential Mechanochemical Synthesis of Nanotube-ML Complexes Using a Ball Mill

This example is a modification of Example HH17. This example describes de synthesis of nanotube-ML complexes using a planetary ball mill. In this example, a first homogenization step is performed before the addition of Grubbs 2^{nd} gen. catalyst.
Step 1. SWNTs (1.5 g) and dialkylated pyrene precursor-ML (Compound HH-12 (depicted in FIG. 68, F), 689 mg, 0.48 μmol/mg NT) and added to a 45 mL stainless steel planetary ball mill reactor.
Step 2. The reactor was filled with 5 stainless steel 15 mm diameter grinding balls.
Step 3. The reactor was placed in the planetary ball mill and the mixing was carried out for 2 min at 500 rpm.
Step 4. The reactor was carefully opened and Grubbs 2^{nd} generation catalyst (31 mg, 0.05 equiv./pyrene precursor-ML) was added.
Step 5. The reactor was placed in the planetary ball mill and the reaction was carried out for 10 min at 500 rpm.
Step 6. After this time, the reactor was carefully opened and the powder obtained was recovered with a spatula.

The resulting product, SWNTs with covalently closed ring structures around them and with low moisture content was termed “Mechanochemical SWNT-ML of Example HH19”.
Step 7. Optionally, the residual Grubbs catalyst was removed by washing the final “Mechanochemical SWNT-ML of Example HH18” powder with dichloromethane. The cleaned product was recovered by filtering through a 0.2 μm-pore size polytetrafluoroethylene (PTFE) membrane.

The resulting product, cleaned SWNTs with covalently closed ring structures around them and with low moisture content was termed “Washed mechanochemical SWNT-ML of Example HH19”.

### Example HH20. Flow Mechanochemical Synthesis of Nanotube-ML Complexes

This is a modification of Example 17. In this example, mechanochemistry is employed to produce nanotube-ML complexes but the synthesis is scaled-up from batch milling experiments to continuous processing using extrusion. Here, the precursor-ML binds to the nanotube and both shear and compressive forces trigger the olefin ring-closing metathesis reaction that produces nanotube-ML complexes. The equipment employed is an extruder carrying two solid twin-screw volumetric feeders (1 and 2), each equipped with an agitator. See FIG. 68, G.
Step 1: A 1:0.4 w/w mixture of Tuball SWNTs (from OCSiAl; diameters ranging from 1.3-2.3 nm) and diamino precursor-ML (Compound HH-13, depicted in FIG. 68, G) is charged to the solid feeder 1, that is connected to the first part of the extruder at a rate of 200 g/h.
Step 2: The mixture is homogenized inside the extruder barrel at a screw speed of 55 rpm and room temperature.
Step 3: Grubbs 2^{nd} generation catalyst (1:0.4:0.02 w/w/w SWNTs/amino precursor-ML/Grubbs) is added through feeder 2 at a rate of 2.9 g/h.
Step 4: The mixture is homogenized inside the extruder barrel at a screw speed of 55 rpm and room temperature. During this step, the ring-closing metathesis takes place inside the barrel.
Step 5: The mixture is isolated at the end of the barrel in the form of powder. The powder obtained is called “Flow chemistry SWNT-ML-diamino of Example HH20”.

This methodology can be modified as follows:
If the residual Grubbs 2^{nd} generation catalyst wants to be removed, step 6 can be added:
Step 6: The powder obtained in Step 5, Flow chemistry SWNT-ML-diamino of Example HH20, is added to a 0.2 μm-pore size polytetrafluoroethylene (PTFE) membrane and CH₂Cl₂ is added. The residual Grubbs 2^{nd} generation catalyst is able to cross the membrane while the purified SWNT-ML-diamino remains in the PTFE membrane. The powder obtained is recovered and termed “Washed flow chemistry SWNT-ML-diamino of Example HH20”.

### Example HH21. Protocol for the Flow Production of PP-SWNT-ML Composites

This example is a variation of Example 19. In this case, the extruder is equipped with three solid twin-screw volumetric feeders. In the first part of the extruder the nanotube-ML are produced through mechanochemistry. In the second part of the extruder, the produced SWNT-ML contained inside the extruder are mixed with polypropylene that is added through the third feeder.
Step 1: A 1:0.4 w/w mixture of Tuball SWNTs (from OCSiAl; diameters ranging from 1.3-2.3 nm) and pyrene precursor-ML (Compound HH-14, depicted in FIG. 68, H) is charged to the solid feeder 1, that is connected to the first part of the extruder at a rate of 20 g/h.
Step 2: The mixture is homogenized inside the extruder barrel at a screw speed of 55 rpm and room temperature.
Step 3: Grubbs 2^{nd} generation catalyst (1:0.4:0.02 w/w/w SWNTs/precursor-ML/Grubbs) is added through feeder 2 at a rate of 0.3 g/h.
Step 4: The mixture is homogenized inside the extruder barrel at a screw speed of 55 rpm and room temperature. During this step, the ring-closing metathesis takes place inside the barrel.
Step 5: Polypropylene pellets (LyondellBasell, Moplen HP400R) (99:1 w/w Polypropylene/SWNTs) are added through feeder 3 at a rate of 1386 g/h.
Step 6: The temperature of the barrel is heated to 210° C.
Step 7: After mixing, the material is obtained at the extruder in the form of a single strand.
Step 8: The obtained strand is cooled down and pelletized giving “PP-SWNT-ML pellets of Example HH21”

This methodology can be modified as follows:
In step 5, the quantity of polypropylene can be modified to produce composites with different SWNT content.
In step 5, a different thermoplastic can be added instead of polypropylene (e.g., PVC, polystyrene or acrylonitrile butadiene styrene (ABS))
The pellets obtained can be reintroduced in the extruder as many times as desired, e.g., 1, 2, 3, 4, 5, 6, 7 or more times.

### Example HH22. Mechanochemical Preparation of LDPE Composites Reinforced with SWNT-ML

This example describes the simultaneous preparation of SWNT-ML and LDPE composites. The SWNT-ML forming reaction and the homogenization between LDPE and SWNT-ML are performed in a planetary ball mill. The LDPE present in the reaction medium during the ring-closing reaction to form SWNT-ML prevents the SWNTs to adhere to each other. No covalent bond is formed during the process between LDPE and SWNT-ML.
Step 1. SWNTs (0.25 g), pyrene precursor-ML (Compound HH-14, 108 mg, 0.48 μmol/mg NT) and Grubbs 2^{nd} generation catalyst (5 mg, 0.05 equiv./pyrene precursor-ML) were added to a 20 mL stainless steel planetary ball mill reactor.
Step 2. LDPE (10 g) was fed into the reactor.
Step 3. The reactor was filled with 5 stainless steel 15 mm diameter grinding balls.
Step 4. The reactor was placed in the planetary ball mill and the reaction was carried out for 10 min at 500 rpm.
Step 5. After this time, the reactor was carefully opened and the powder obtained was recovered with a spatula.

The resulting product, LDPE composite containing a 2.5% SWNT-ML was termed “LDPE/SWNT composite of Example HH22”.
Step 6. The composite obtained in step 5 (“LDPE composite reinforced with SWNT-ML of Example HH21”) was subjected to injection molding at 180° C. and introduced in a mould having several plastic-cap shapes.

The resulting product, SWNT-ML reinforced LDPE plastic-caps for use in pipes protection is termed “SWNT-ML reinforced LDPE plastic-caps of Example HH22”.

### Example II1. Commercial Thermoset Polyurethane (ALEXIT® BladeRep LEP 9) Composites with Diamino-Boc MINTs

In this example a nanocomposite diamino-boc MINTs and commercial thermoset polyurethane is produced through in situ polymerization.

ALEXIT® BladeRep LEP 9 is two-component, solvent free polyurethane. In the most viscous component (here called Component 1, or hardener), the MINTs are dispersed for subsequent application of the polyurethane paint on the surface to be protected. Then at a later stage Component 2 is added. See FIG. 68, I.

The composite of ALEXIT® BladeRep LEP 9 and diamino-boc MINTs was produced following these steps:
Step 1: 57.7 mg and 289.9 mg, respectively, of diamino-boc MINTs of Example GG7, were added to each of two different 15 g batches of hardener, to make a 0.1% wt composite and a 0.5% wt. composites, respectively.
Step 2: Each of the two batches were mixed in a high-speed shear mixer for 3 hours at 10,000 RPM.
Step 3: The gases generated by the shear mixer were removed in the vacuum oven at 50° C. for one hour. To help make this process more effective, the mixture was transferred to a one-liter beaker in order to make the degassing surface larger.
Step 4: 30 g of Component 2 was added and mixed by hand until a homogeneous gray color is obtained. The resulting two materials are called “0.1% CNT/Polyurethane coating of Example II1” and “0.5% CNT/Polyurethane coating of Example II1”
Step 5: The material was applied to anti-adherent coated glass plates by a Meyer bar instrument.
Step 6: The material was allowed to cure for 18 hours. Films of an approximate thickness of 100 μm were obtained.

The films were tested for mechanical characteristics using the Instron instrument. The Young's Modulus are shown in the table immediately below.

| | YM (GPa) |
|---|---|
| 0.1% CNT/Polyurethane | 3.73 ± 0.2 |
| 0.5% CNT/Polyurethane | 5.46 ± 0.2 |

### Example II2. Thermoplastic Polyurethane (TPU) Composites with Diamino-Boc MINTs by In Situ Polymerization

In this example a nanocomposite of diboc MINTs and thermoplastic polyurethane is produced through in situ polymerization.

Polypropylene glycol, abbreviated as PPG and with a molecular weight of 2000 g/mol, Methylene diphenyl diisocyanate, abbreviated as MDI and 1,4-butanediol abbreviated as BDO were used to form the polymeric matrix. See FIG. 68, J.

The composite of TPU and MINTs was produced by the following these steps:
Step 1: PPG and BDO were placed in a flask under vacuum to stir at 100 RPM while heating to 80° C. to eliminate traces of moisture that may have alcohols.
Step 2: 4 g of MDI and 21.6 mg of “diamino-boc MINTs of Example GG7” were placed in a mortar and ground for 20 minutes to achieve a first dispersion in the monomer.
Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.
Step 4: The prepolymer was degassed for 1 hrs at 80° C. with a vacuum pump connected to the flask for 0.5 h at 100° C.
Step 5: The BDO was mixed with the prepolymer and the mixture was poured into the teflon mold. The resulting material was named “Thermoplastic polyurethane/diaminoboc MINTs of Example II2”.
Step 6: The material was cured for 18 hours in the vacuum oven.

The procedure described in this example was applied to the generation of a number of TPU composites with different MINTs, as described in the following examples.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/Polyurethane | 2.74 ± 0.45 | 1.15 ± 0.3 | 2715.3 ± 1000 |

These values cannot be compared with the composites described in the following examples because the PPG used is older and therefore the properties are worse due to the moisture in the sample that is difficult to remove despite step 1.

### Example II3. Thermoplastic Polyurethane (TPU) Composites with Diamino MINTs by In Situ Polymerization

In this example a nanocomposite of diamino MINTs and thermoplastic polyurethane is produced through in situ polymerization.

For this the “diamino-boc MINTs of Example GG7” were deprotected from the boc to free two secondary amines (explained in the first step) PPG with a molecular weight of 2000 g/mol, MDI and BDO were used to form the polymeric matrix.

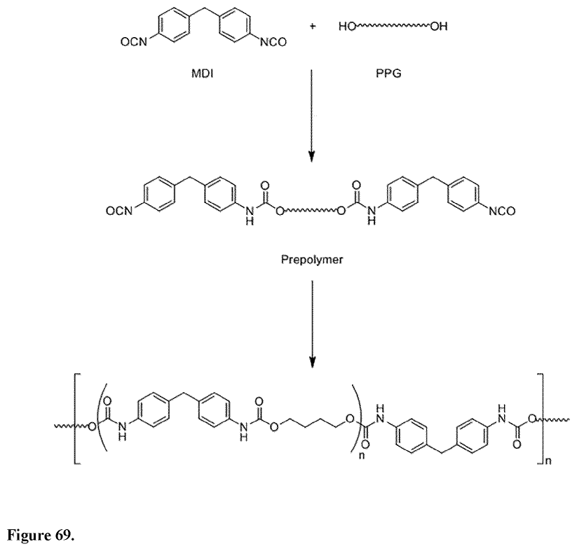

See FIG. 69.

The composite of TPU and MINTs was produced by the following these steps:
Step 1: “Diamino-boc MINTs of Example GG7” were deprotected in the furnace at 220° C. overnight, to obtain diamino MINTs.
Step 2: PPG and BDO were placed in a flask under vacuum to stir at 100 RPM while heating to 80° C. to eliminate traces of moisture that may have alcohols.
Step 3: 4 g of MDI and 20.81 mg of diamino MINTs were placed in a mortar and ground for 20 minutes to achieve a first dispersion in the monomer.
Step 4: 12 grams of the PPG and the mixture of Step 3 were added in a round bottom flask and purged with N2 for 5 minutes. The reaction was then started by heating the flask at 80° C. under stirring at 350 RPM for 20 hrs to form the prepolymer.
Step 5: The prepolymer was degassed for 1 hrs at 80° C. with a vacuum pump connected to the flask for 0.5 h at 100° C.
Step 6: The BDO was mixed with the prepolymer and the mixture was poured into the teflon mold. The resulting material was named “Thermoplastic polyurethane/diamino MINTs of Example II3”.
Step 7: The material was cured for 18 hours in the vacuum oven.

### Example II4. Thermoplastic Polyurethane (TPU) Composites with Amino MINTs MINTs by In Situ Polymerization

In this example a nanocomposite of amino MINTs and thermoplastic polyurethane is produced through in situ polymerization.

For this the amine of the macrocycle of “Phtalimide MINTs of Example EE9B” was deprotected as explained in example EE10.

PPG with a molecular weight of 2000 g/mol, MDI and BDO were used to form the polymeric matrix.

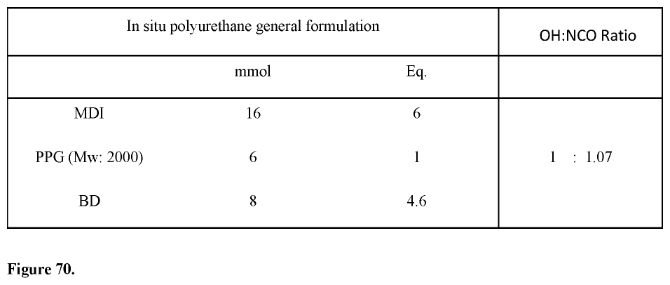

See FIG. 70.

The composite of TPU and MINTs was produced by the following these steps:
Step 1: PPG and BDO were placed in a flask under vacuum to stir at 100 RPM while heating to 80° C. to eliminate traces of moisture that may have alcohols.
Step 2: 4 g of MDI and 21.8 mg of “Methylamine MINTs of Example EE10” were placed in a mortar and ground for 20 minutes to achieve a first dispersion in the monomer.
Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.
Step 4: The prepolymer was degassed for 1 hrs at 80° C. with a vacuum pump connected to the flask for 0.5 h at 100° C.
Step 5: The BDO was mixed with the prepolymer and the mixture was poured into the teflon mold. The resulting material was named “Thermoplastic polyurethane/amino MINTs of Example II4”.
Step 10: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/ | 6.6 ± 0.5 | 3.14 ± 0.46 | 4758.6718 ± 1114 |
| Polyurethane | | | |

### Example II5. Thermoplastic Polyurethane (TPU) Composites with Methylalcohol MINTs by In Situ Polymerization

In this example a nanocomposite of methylalcohol MINTs and thermoplastic polyurethane is produced through in situ polymerization.

PPG with a molecular weight of 2000 g/mol, MDI and BDO were used to form the polymeric matrix.

The composite of TPU and MINTs was produced by the following these steps:
Step 1: PPG and BDO were placed in a flask under vacuum to stir at 100 RPM while heating to 80° C. to eliminate traces of moisture that may have alcohols.
Step 2: 4 g of MDI and 22.3 mg of “Methylalcohol MINTs of Example EE9B” were placed in a mortar and ground for 20 minutes to achieve a first dispersion in the monomer.
Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.
Step 4: The prepolymer was degassed for 1 hrs at 80° C. with a vacuum pump connected to the flask for 0.5 h at 100° C.
Step 5: The BDO was mixed with the prepolymer and the mixture was poured into the teflon mold. The resulting material was named “Thermoplastic polyurethane/methylalcohol MINTs of Example II5”.
Step 6: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/Polyurethane | 4.17 ± 0.54 | 2.6 ± 0.3 | 5180 ± 2457 |

### Example II6. Thermoplastic Polyurethane (TPU) Composites with MDI (OMe) MINTs by In Situ Polymerization

In this example a nanocomposite of MDI (OMe) MINTs and thermoplastic polyurethane is produced through in situ polymerization.

PPG with a molecular weight of 2000 g/mol, MDI and BDO were used to form the polymeric matrix.

The composite of TPU and MINTs was produced by the following these steps:
Step 1: PPG and BDO were placed in a flask under vacuum to stir at 100 RPM while heating to 80° C. to eliminate traces of moisture that may have alcohols.
Step 2: 4 g of MDI and 25.8 mg of ““MDI(OMe)MINTs of Example EE13” were placed in a mortar and ground for 20 minutes to achieve a first dispersion in the monomer.
Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.
Step 4: The prepolymer was degassed for 1 hrs at 80° C. with a vacuum pump connected to the flask for 0.5 h at 100° C.
Step 5: The BDO was mixed with the prepolymer and the mixture was poured into the teflon mold. The resulting material was named “Thermoplastic polyurethane/MDI(OMe) MINTs of Example II6”.
Step 6: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/Polyurethane | 6.06 ± 0.2 | 3.67 ± 0.3 | 11100 ± 1709 |

### Example II7. Thermoplastic Polyurethane (TPU) Composites with MDI (NCO) MINTs by In Situ Polymerization

In this example a nanocomposite of MDI (NCO) MINTs and thermoplastic polyurethane is produced through in situ polymerization.

PPG with a molecular weight of 2000 g/mol, MDI and BDO were used to form the polymeric matrix.

The composite of TPU and MINTs was produced by the following these steps:
Step 1: PPG and BDO were placed in a flask under vacuum to stir at 100 RPM while heating to 80° C. to eliminate traces of moisture that may have alcohols.
Step 2: 4 g of MDI and 26 mg of ““MDI(OMe)MINTs of Example EE12” were placed in a mortar and ground for 20 minutes to achieve a first dispersion in the monomer.
Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.
Step 4: The prepolymer was degassed for 1 hrs at 80° C. with a vacuum pump connected to the flask for 0.5 h at 100° C.
Step 5: The BDO was mixed with the prepolymer and the mixture was poured into the teflon mold. The resulting material was named “Thermoplastic polyurethane/MDI(NCO) MINTs of Example II7”.
Step 6: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

### Example II8. Composites of 1% Thiol MINTs and PVC Through Covalent Bonds Between MINT and Polymer (Solvent Method)

In this example a composite with 1% deprotected thiol MINTs of example GG7c grafted to PVC is synthesized from a nucleophilic substitution in commercial PVC.

Low molecular PVC from sigma Aldrich, K₂CO₃ and hand made thiol MINTs were used.

The composite of PVC and thiol MINTs was produced by following these steps:
Step 1: 2 grams of PVC, 25.9 mg of thiol MINTs, 20 mg of dry K2CO3, and 25 mL of cyclohexanone were added in a flask and the mixture was purged with argon for 10 min.
Step 2: The reaction was heated to 50 degrees and leave for 72 h with magnetic stirring and argon atmosphere.
Step 3: 1.5 mL of Step 2 solution was centrifuged for 90 minutes to see if the reaction had worked. A totally black suspension was observed which may indicate that the dissolved polymer is bound to the MINTs.
Step 4: The solid was precipitated in water and washed with methanol to remove K₂CO₃.
Step 5: The solid of Step 4 was dried at 80° C. for 18 hours while it in the vacuum oven. The resulting material was named “solvent method PVC/1% thiol MINTs of Example II8”.
Step 6: The resulting material of Step 6 was treated in the hot press to obtain films that were later cut in the shape of dog bones to measure in the Instron and in the DMA.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) |
|---|---|---|
| 1% CNT/PVC | 2862.4275 ± 131 | 46.72 ± 1.33 |

### Example II9. Composites of 1% Hand Made Thiol MINTs and PVC Through Covalent Bonds Between MINT-Polymer (Mechanochemical Method)

In this example a composite with 1% deprotected thiol MINTs of example GG7d1 grafted to PVC is synthesized from a nucleophilic substitution in commercial PVC.

Low molecular PVC from sigma Aldrich, K₂CO₃ and thiol MINTs (hand made, ball milled) were used.

The composite of PVC and thiol MINTs was produced by following these steps:
Step 1: 1 grams of PVC, 12.8 mg of thiol MINT and 10 mg of dry K₂CO₃ were added in ball mill 45 mL reactor with 5 balls of 10 mm diameter.
Step 2: 9 cycles of 500 RPMs were applied.
Step 3: Step 2 solid was washed and filtered with H₂O to eliminate K₂CO₃
Step 5: The resulting materials of Step 3 was treated in the hot press to obtain films that were later cut to measure in DMA.

| | YM (GPa) | TS (MPa) |
|---|---|---|
| 0.1% CNT/PVC | 2.7 ± 0.073 | 61.06 ± 1.98 |

### Example II10. In Situ Synthesis of a Polyimine Based Covalent Adaptable Network (CAN) with 0.1% Wt. Diamino MINTs

The polyimine-based CAN was prepared from linear monomer terephthaldehyde (dialdehyde), diethylene triamine (diamine), and the cross-linker tris(2-aminoethyl) amine (triamine).

Polyimine film was synthesized by following these steps:
Step 1: 4.44 g TPA and 1.02 g DETA and diamino MINTs were dissolved in 80 mL ethanol.
Step 2: After the mixture became homogeneous, a solution of 2.26 g TREN in 20 mL of ethanol was added to Step 1 solution.
Step 3: Step 2 solution was transferred to teflon container.
Step 4: The solvent was then allowed to evaporate in a fume hood under ambient conditions to form a polymer film. The resulting material was named “polyimine/1% diamino MINTs of Example II10”
Step 5: The resulting film of Step 4 was further cured by the hot pressing at 75° C. for 2 h, then at 85° C. for 2 h, and, finally, at 105° C. for 2 h. This film was cut in dog bone shape to measure in Instron and DMA.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) |
|---|---|---|
| 0.1% CNT/Polyimine | 2166.05 ± 247 | 54.99 ± 6.6 |

### Example II11. In Situ Mechanochemical Synthesis of a Polyimine Based Covalent Adaptable Network (CAN)

The polyimine-based CAN was prepared from linear monomer terephthaldehyde (dialdehyde), diethylene triamine (diamine), and the cross-linker tris(2-aminoethyl) amine (triamine).

Polyimine film was synthesized by following these steps:
Step 1: 1 g of Terephthaldehyde was added to a 20 mL ball mill reactor and mixed for 10 minutes at 250 RPM with 5 stainless steel balls of 10 mm.
Step 2: 0.229 g of Diethylenetriamine and 0.508 g of Tris(2-aminoethyl)amine were added to the ball mill reactor from step 1 and mixed for 10 minutes.
Step 3: The mil ball reactor from step 2 was opened and with a spatula the paste generated inside the reactor was removed, detaching it from the walls and chopping it for better mixing and it was put back into the ball mill to mix it for 20 minutes at 250 RPMs.
Step 5: The homogeneous paste is taken out of the reactor to put it inside the hot press between Teflon films for its curing.
Step 6: The resulting material is cured for 1 hour at 75° C., 1 hour at 85° C. and 3 hours at 105° C. in the hot press.

| | YM (MPa) | TS (MPa) |
|---|---|---|
| Ball mill Polyimine | 1.81 ± 0.03 | 33.73 ± 6.77 |

### Example II12. In Situ Mechanochemical Synthesis of a Polyimine Based Covalent Adaptable Network (CAN) with Covalently Attached 1% Wt. Diamino MINTs

The polyimine-based CAN was prepared from linear monomer terephthaldehyde (dialdehyde), diethylene triamine (diamine), and the cross-linker tris(2-aminoethyl) amine (triamine).

The fundamental idea in this example is to covalently bind the MINTs to the cross-linked structure of the polymer and for this the “diamino-boc MINTs of Example GG7a3” were deprotected from the boc to free the two secondary amines.

Polyimine composite film was synthesized by following these steps:
Step 1: “Diamino-boc MINTs of Example GG7a3” were deprotected in the furnace at 220° C. overnight, to obtain diamino MINTs.
Step 2: 1 g of Terephthaldehyde and diamino MINTs of step 1 were added to a 20 mL ball mill reactor and mixed for 10 minutes at 250 RPM with 5 stainless steel balls of 10 mm.
Step 3: 0.229 g of Diethylenetriamine and 0.508 g of Tris(2-aminoethyl)amine were added to the ball mill reactor from step 1 and mixed for 10 minutes.
Step 4: The mil ball reactor from step 2 was opened and with a spatula the paste generated inside the reactor was removed, detaching it from the walls and chopping it for better mixing and it was put back into the mil ball to mix it for 20 minutes at 250 RPMs.
Step 5: The homogeneous paste is taken out of the reactor to put it inside the hot press between Teflon films for its curing.
Step 6: The resulting material is cured for 1 hour at 75° C., 1 hour at 85° C. and 3 hours at 105° C. in the hot press.

| | YM (MPa) | TS (MPa) |
|---|---|---|
| Ball mill Polyimine + 1% SWNTs | 3.21 ± 0.2 | 68.32 ± 6.7 |

Note: This example can also be done with the chemically deprotected diamino boc MINTs as described in example II14

| | YM (MPa) | TS (MPa) |
|---|---|---|
| Ball mill Polyimine + 1% SWNTs | 3.18 ± 0.24 | 73.65 ± 3.49 |

### Example II13. In Situ Mechanochemical Synthesis of a Polyimine Based Covalent Adaptable Network (CAN) with Sccdiamino MINTs

The polyimine-based CAN was prepared from linear monomer terephthaldehyde (dialdehyde), diethylene triamine (diamine), and the cross-linker tris(2-aminoethyl) amine (triamine).

The fundamental idea in this example is to covalently bind the MINTs to the cross-linked structure of the polymer and for this the “diamino-boc scc MINTs of Example GG7f1” were deprotected from the boc to free two secondary amines (explained in the first step)

Polyimine composite film was synthesized by following these steps:
Step 1: “Diamino-boc MINTs of Example GG77f1” were deprotected in the furnace at 220° C. overnight, to obtain diamino MINTs.
Step 2: 1 g of Terephthaldehyde and diamino MINTs of step 1 were added to a 20 mL ball mill reactor and mixed for 10 minutes at 250 RPM with 5 stainless steel balls of 10 mm.
Step 3: 0.229 g of Diethylenetriamine and 0.508 g of Tris(2-aminoethyl)amine were added to the ball mill reactor from step 1 and mixed for 10 minutes.
Step 4: The mil ball reactor from step 2 was opened and with a spatula the paste generated inside the reactor was removed, detaching it from the walls and chopping it for better mixing and it was put back into the mil ball to mix it for 20 minutes at 250 RPMs.
Step 5: The homogeneous paste is taken out of the reactor to put it inside the hot press between Teflon films for its curing.
Step 6: The resulting material is cured for 1 hour at 75° C., 1 hour at 85° C. and 3 hours at 105° C. in the hot press.

| | YM (GPa) | TS (MPa) |
|---|---|---|
| Ball mill Polyimine + 1% SWNTs | 3.6 ± 0.25 | 69.15 ± 1.57 |

### Example II14. Chemical Deprotection of Diamino-Boc MINTs and Diamino-Boc Scc MINTs

This example describes the synthesis of Diamino MINTs via chemical deprotection of diamino-boc MINTs (GG7a) or diamino-boc scc MINTs (GG7f) obtaining two free amine groups.

Deprotection is performed by following these steps
Step 1: Diamino-Boc MINT (GG7a or GG7f) (200 mg) was dissolved in dry DCM (2 mL) under inert conditions.
Step 2: To a solution of acetyl chloride (0.1 mL) in absolute ethanol (3 mL) was added carefully at 0° C.
Step 3: The reaction mixture was stirred at 40° C. overnight.
Step 4: Black solid was isolated by filtration and dried

The washings were analyzed by NMR to detect the presence of boc. The black solid was measured in the TGA to see the reduction in functionalization due to the loss of boc.

### Example II15. Carbon Fiber (CF) Polyimine Composite with 1% Wt. Diamino MINTs

The polyimine-based CAN was prepared from linear monomer terephthaldehyde (dialdehyde), diethylene triamine (diamine), and the cross-linker tris(2-aminoethyl) amine (triamine).

The idea is to make a composite with a carbon fiber sheet, curing it between two polyimine films to obtain a resistant material.

Polyimine and CF composite film was synthesized by following these steps:
Step 1: “Diamino-boc MINTs of Example GG7a3” were deprotected in the furnace at 220° C. overnight, to obtain diamino MINTs.
Step 2: 4.4 g of Terephthaldehyde and 0.0994 g diamino MINTs of step 1 were added to a 45 mL ball mill reactor and mixed for 10 minutes at 250 RPM with 5 stainless steel balls of 20 mm.
Step 3: 1.02 g of Diethylenetriamine and 2.26 g of Tris(2-aminoethyl)amine were added to the ball mill reactor from step 1 and mixed for 10 minutes.
Step 4: The mil ball reactor from step 2 was opened and with a spatula the paste generated inside the reactor was removed, detaching it from the walls and chopping it for better mixing and it was put back into the mil ball to mix it for 20 minutes at 250 RPMs.
Step 5: The homogeneous paste is taken out of the reactor and divided into two portions of approximately the same weight.
Step 6: Each of this paste-like material was hot-pressed using thin (0.1-0-2 mm) square-shaped molds (70 mm×70 for) 20 minutes.
Step 7: Using the same mold, a sheet of CF was fixed on the mold with adhesive tape and a sandwich was made with the two prefilms obtained in the previous step.
Step 8: The resulting material was cured for 1 hour at 75° C., 1 hour at 85° C. and 3 hours at 105° C. in the hot press.

| | YM (GPa) | TS (MPa) |
|---|---|---|
| Ball mill Polyimine + 1% SWNTs + 16% CF | 20.3 ± 0.8 | 241.65 ± 11 |

### Example II16. Carbon Fiber (CF) Polyimine Composite

The polyimine-based CAN was prepared from linear monomer terephthaldehyde (dialdehyde), diethylene triamine (diamine), and the cross-linker tris(2-aminoethyl) amine (triamine).

The idea is to make a composite with a carbon fiber sheet, curing it between two polyimine films to obtain a resistant material.

Polyimine and CF composite film was synthesized by following these steps:
Step 1: “Diamino-boc MINTs of Example GG7a3” were deprotected in the furnace at 220° C. overnight, to obtain diamino MINTs.
Step 2: 4.4 g of Terephthaldehyde and 0.0994 g diamino MINTs of step 1 were added to a 45 mL ball mill reactor and mixed for 10 minutes at 250 RPM with 5 stainless steel balls of 20 mm.
Step 3: 1.02 g of Diethylenetriamine and 2.26 g of Tris(2-aminoethyl)amine were added to the ball mill reactor from step 1 and mixed for 10 minutes.
Step 4: The mil ball reactor from step 2 was opened and with a spatula the paste generated inside the reactor was removed, detaching it from the walls and chopping it for better mixing and it was put back into the mil ball to mix it for 20 minutes at 250 RPMs.
Step 5: The homogeneous paste is taken out of the reactor and divided into two equal parts as to their weight.
Step 6: Each of this paste-like material was hot-pressed using thin (0.1-0-2 mm) square-shaped molds (70 mm×70 for) 20 minutes.
Step 7: Using the same mold, a sheet of CF was fixed on the mold with adhesive tape and a sandwich was made with the two prefilms obtained in the previous step.
Step 8: The resulting material was cured for 1 hour at 75° C., 1 hour at 85° C. and 3 hours at 105° C. in the hot press.

| | YM (GPa) | TS (MPa) |
|---|---|---|
| Ball mill Polyimine + 16% CF | 12.24 ± 0.48 | 139.87 ± 33 |

### Example JJ21. Different Sequences of Events Leading to Polymer Composites

The different sequences of events leading to polymer-nanotube composites, described at the general level in Example 0, are exemplified using ring-opening metathesis polymerization (ROMP), to form the ROMP polymer. Thus, Sequence 1 and Sequence 3, C are exemplified using ROMP polymer in Example JJ21, A. Sequence 2 is exemplified using ROMP polymer in Examples A1-A32. Sequence 4 is enabled in Example JJ28-A.

In Example JJ21, B, the different sequences of events are further exemplified using PVC, PP, PE, PU, polyamide, PS, and epoxy for the coating of nanotubes.

### Example JJ21, A. Different Sequences of Events Leading to ROMP Polymer-Carbon Nanotube Composite Materials

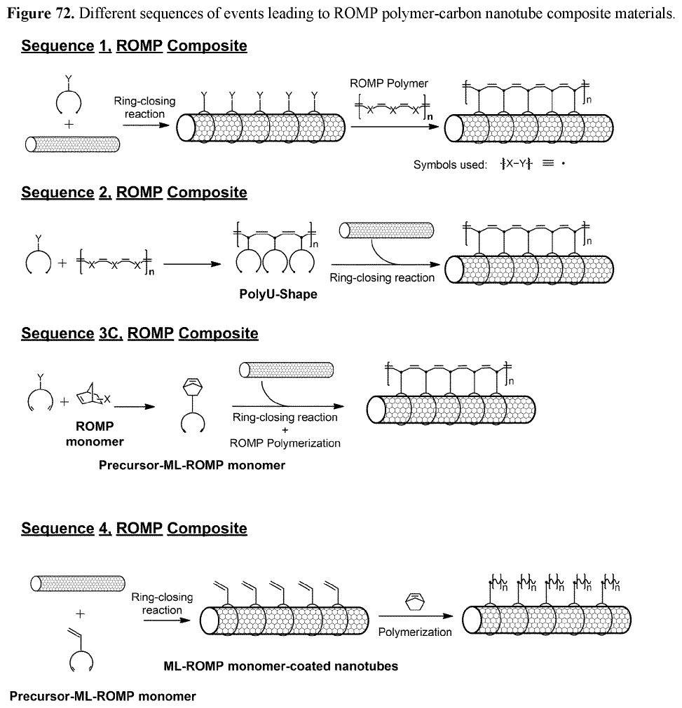

Three different sequences of events (Sequence 1, 2, and 3C) leading to carbon nanotube-ROMP polymer composite, also called ROMP polymer-coated carbon nanotubes, are depicted in FIG. 72:
Sequence 1 is exemplified using the ROMP polymer and involves first mixing of nanotubes and Ushapes (precursor-MLs) carrying reactive groups (Y). A ring-closing reaction is performed and then a pre-formed ROMP polymer carrying reactive groups (X) is added, and upon formation of XY bonds a ROMP polymer-coated nanotube is formed:
Step 1: First, an appropriate amount of carbon nanotubes is dispersed in tetrachloroethane (TCE, 1 mL/mg nanotube) through bath sonication (10 min).
Step 2: To this dispersion, the precursor-ML carrying a reactive group Y (e.g. an alkyne) and two terminal alkene functionalities is added.
Step 3: The mixture is bubbled with nitrogen for 20 min.
Step 4: Grubbs catalyst 2^{nd} generation (1 equiv. with respect to the precursor-ML) is added.
Step 5: The mixture is stirred at room temperature under inert atmosphere for 72 h allowing the precursor-ML to bind to a SWNT and form a macrocycle around it through ring-closing metathesis.
Step 6: After this time, the suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the unreacted precursor-ML and Grubbs 2^{nd} generation catalyst have been removed. The product is dried at 100° C. for 1 h to produce “Nanotubes-ML-Y of Example JJ21, A, sequence 1”.
Step 7: In a flask pre-dried in an oven at 120° C. for 1 h, the obtained “Nanotubes-ML-Y of Example JJ21, A, sequence 1” are dispersed in dry tetrachloroethane (1 mL/mg nanotube) employing bath sonication (10 min).
Step 8: To this mixture, a ROMP polymer carrying terminal reactive groups X (e.g. azide groups) previously dissolved in dry TCE is added.
Step 9: N,N-diisopropylethylamine (DIPEA) is added to the solution.
Step 10: Copper iodide (CuI) is added.
Step 11: The solution mixture is stirred at 60° C. for 12 hours, and optionally sonicated 1-5 times of each 5-10 minutes.
Step 12: After this time, dichloromethane and saturated sodium chloride (NaCl) deionized water solutions are added to the solution mixture resulting from step 11.
Step 13: Then, the addition of aqueous ammonia (NH₃) solution (25%) follows and the mixture is left under vigorous stirring for 15 min.
Step 14: The suspension is then filtered through a 0.2 μm-pore size polytetrafluoroethylene (PTFE) membrane and the filter cake is washed with water. The solid obtained is removed from the filter and washed with water employing 5 min sonication. This cleaning procedure is repeated three times, until the filtration solvent is colourless, indicating that the unreacted ROMP polymer, DIPEA and CuI have been removed. The product is dried at 150° C. for 1 h to produce “ROMP polymer-coated nanotubes of Example JJ21, A, sequence 1”.
Sequence 2 is exemplified using the ROMP polymer and involves first the linking of Ushapes (precursor-MLs) to a preformed ROMP polymer, to form a poly-Ushape (multiple precursor-MLs covalently linked together), and then addition of nanotubes, to allow ring-closing on the nanotube, to form the ROMP polymer-coated nanotube. Examples A1-A32 describes the practical enablement of the Sequence 2 approach, as well as its analysis.
Sequence 3C is exemplified using the ROMP polymer and involves first mixing of Ushape carrying a reactive group (Y) with a ROMP monomer carrying a reactive group (X), leading to the reaction of reactive groups (X) and (Y), to form a compound that comprises both a Ushape and a monomer for polymer formation. Then nanotubes are added, to allow simultaneous ring-closing around the nanotube and ROMP polymer formation from the ROMP monomers, to yield ROMP polymer-coated nanotubes. In this set-up, both the ring-closing reaction and polymer formation is a Grubb's 2^{nd} generation catalyst-catalysed reaction that forms double bonds, wherefore polymer formation and ring-closing happens simultaneously, i.e. in one common step. Thus, the protocol is as follows:
Step 1: In a flask pre-dried in an oven at 120° C. for 1 h, a precursor carrying a reactive group Y (e.g. terminal alkyne) is dissolved in dry dimethylformamide (DMF) and a norbornene carrying a terminal reactive group X (e.g. an azide group) dissolved in dry DMF is added.
Step 2: N,N-diisopropylethylamine (DIPEA) is added to the solution.
Step 3: Copper iodide (CuI) is added.
Step 4: The solution mixture is stirred at 60° C. for 12 hours.
Step 5: After this time, dichloromethane and saturated sodium chloride (NaCl) deionized water solutions are added to the solution mixture resulting from step 4.
Step 6: Then, the addition of aqueous ammonia (NH₃) solution (25%) follows and the mixture is left under vigorous stirring for 15 min.
Step 7: Using a separatory funnel, the organic phase is extracted and washed three times with deionized water.
Step 8: The solvent is eliminated under reduced pressure to give the “precursor-ML-ROMP monomer”.
Step 9: In a flask pre-dried in an oven at 120° C. for 1 h, an appropriate amount of carbon nanotubes are dispersed in dry tetrachloroethane (1 mL/mg nanotube) employing bath sonication (10 min).
Step 10: To this mixture, the “precursor-ML-ROMP monomer” obtained in step 9 previously dissolved in dry TCE is added.
Step 11: The mixture is bubbled with nitrogen for 20 min.
Step 12: Grubbs catalyst (2^{nd} or 3^{rd} generation, 1.05 equiv. with respect to the precursor-ML-ROMP monomer) is added.
Step 13: The mixture is stirred at room temperature under inert atmosphere for 72 h with regular pulses of sonication allowing the precursor-ML-ROMP monomer to form a macrocycle around it through ring-closing metathesis and polymerize through ring-opening metathesis polymerization.
Step 14: After this time, the suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the unreacted precursor-ML-ROMP monomer and Grubbs catalyst have been removed. The product is dried at 100° C. for 1 h to produce “ROMP polymer-coated nanotubes of Example JJ21, A, sequence 3C”.
Sequence 4 is exemplified using the ROMP polymer and involves first forming the SWNT-ML where the ML carries a polymerization termination functionality. The growing polymer is added and it attaches to the rings through the polymerization termination functionality, such as a single terminal double bond. The final result is a nanotube with rings around it, where the rings are each attached to different polymer chains. Thus, the protocol is as follows:
Step 1: In a flask pre-dried in an oven at 120° C. for 1 h, an appropriate amount of carbon nanotubes are dispersed in dry tetrachloroethane (1 mL/mg nanotube) employing bath sonication (10 min).
Step 2: To this mixture, a “precursor-ML-ROMP polymer terminator” dissolved in dry TCE is added.
Step 3: The mixture is bubbled with nitrogen for 20 min.
Step 4: Grubbs catalyst (2^{nd} or 3^{rd} generation, 1.05 equiv. with respect to the precursor-ML-ROMP terminator) is added.
Step 5: The mixture is stirred at room temperature under inert atmosphere for 72 h with regular sonication allowing the precursor-ML-ROMP terminator to form a macrocycle around the nanotube through ring-closing metathesis.
Step 6: After this time, the suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the unreacted precursor-ML-ROMP monomer and Grubbs 2^{nd} generation catalyst have been removed. The product is dried at 100° C. for 1 h to obtain “ROMP polymer-coated nanotubes of Example JJ21, A, sequence 4”.
Step 7: In a flask pre-dried in an oven at 120° C. for 1 h, the obtained “ROMP polymer-coated nanotubes of Example JJ21, A, sequence 4” are dispersed in dry tetrachloroethane (1 mL/mg nanotube) employing bath sonication (10 min).
Step 8: To this mixture, a solution of norbornene monomer in dry TCE is added.
Step 9: Ethyl vinyl ether is added in order to quench the reaction.
Step 10: The resultant suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the Grubbs 3^{rd} generation catalyst has been removed.
Step 11: The product is dried at 100° C. for 1 h to produce “ROMP polymer-coated nanotubes of Example JJ21, A, sequence 4”.

Other substituted or unsubstituted 4-membered (e.g. cyclobutene), 5-membered (e.g. cyclopentene), 6-membered (e.g. cyclohexene), 7-membered (e.g. cycloheptene), 8-membered (e.g. cis-cyclooctene (COE) or cis,cis-1,5-cyclooctadiene) and polymembered (e.g. cyclotetradeca-1,8-diene) cyclic hydrocarbons can be used as well as bi- and tri-cyclic unsaturated rings such as dicyclopentadiene (DCPD) in place of the norbornene employed in Step 8, under the same or similar reaction conditions, to provide similar polymer-coated nanotubes. Also, different ruthenium, molybdenum and tungsten-based ROMP catalysts can be employed (e.g. RuCl₃/HCl in combination with a promoting agent such as EtOH or PhOH, Schrock catalyst).

### Example JJ21, B. Different Sequences of Events Leading to Various Polymer-Coated Nanotubes

The six different sequences of events (Sequences 1, 2, 3A, 3B, 3C, and 4) leading to composites, described in Example 0 and depicted in FIG. 71 is in the following exemplified for various polymers and polymerisation reactions, various kind of fillers, various types of ring-closing reactions and various types of polymer-linking reactions.

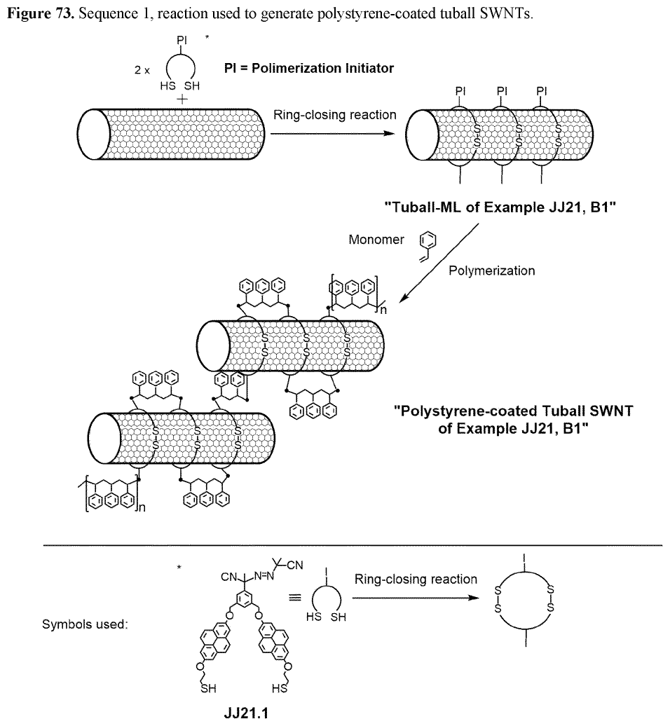

These processes are depicted in FIGS. 73 to 78.

Example JJ21, B1: Sequence 4B, reaction is here used to generate polystyrene-coated Tuball SWNTs (from OCSiAl). In this example, we use Sequence 4B of Example 0 (see FIG. 71), involving a ML carrying a polymerization initiator, to obtain polystyrene-coated Tuball SWNTs. See FIG. 73.
Step 1: 1 g Tuball SWNTs (from OCSiAl; diameters ranging from 1.3-2.3 nm) are dispersed in dry dimethylformamide (DMF, 1 L, 1 g/L SWNTs/DMF) by sonication in a bath sonicator (10 mins).
Step 2: The dispersion is degassed with N₂ for 30 mins.
Step 3: To this dispersion, a precursor-ML (JJ21.1) (carrying two pyrenes, terminal thiol groups and an AlBN-like polymerization initiator (abbreviated “PI” or “I” in FIG. 73) (600 mg, 0.7 mmol), triethylamine (TEA, 4.0 equiv. with respect to compound (JJ21.1)) and iodine (0.55 equiv. with respect to compound (JJ21.1)) are added.
Step 4: The mixture is stirred at room temperature for 72 h under inert atmosphere, allowing two precursor-MLs to bind to one SWNT and react to generate two disulfide-bonds, thereby forming a ring structure around a SWNT, resulting in the SWNT-ML complex. Thus, the ring-structure (the ML) is generated by the fusion of two precursor-MLs, thereby forming a circular structure with a diameter large enough to reach around the Tuball tubes with diameters of ˜1.3 nm. For nanotubes of diameter larger than 1.3 nm three or four or more precursor-MLs may react to form rings that are large enough to reach around the nanotube.
Step 5: The suspension is filtered through a 0.2 μm-pore size polytetrafluoroethylene (PTFE) membrane. The solid obtained is removed from the filter and washed with DMF employing 10 min sonication, and filtered again. This cleaning procedure is repeated three times, until the filtration solvent is colourless, indicating that the unreacted precursor-ML, triethylamine and iodine have been removed. A final wash with acetone, dichloromethane and Et₂O is performed and the product is dried at 100° C. for 15 min.

The resulting product is termed “Tuball-ML of Example JJ21, B1”.
Step 6: 1 g “Tuball-ML of Example JJ21, 1” is dispersed in toluene (1 L, 1 g/L) by sonication in a bath sonicator (10 mins.).
Step 7: To this dispersion, an appropriate amount of styrene (such as 1 mM, 10 mM, or 100 mM) is added.
Step 8: The suspension is incubated at 50-70° C. for 6 h or irradiated with 350 nm light for 45 min. to form polystyrene attached to the Tuball-ML of Example JJ21, 1 through reaction with the AlBN-like polymerization initiator.
Step 9: Optionally, an appropriate concentration of a chain-terminating agent such as cupferron is added.
Step 10: The final suspensions are poured into methanol under stirring, to obtain polystyrene-coated Tuball SWNT. The polystyrene-coated Tuball SWNT are filtered off and dried at 50° C. The obtained product is called “Polystyrene-coated Tuball SWNT of Example JJ21, B1”.

If longer or shorter polymers, or polymers of different kinds are desired, these may be obtained by changing the conditions in specific steps, as follows.
If in step 7 propylene, ethylene, or vinylchloride is added instead of styrene, then polypropylene, polyethylene or polyvinylchloride, respectively, will be formed instead of polystyrene.
If in step 9 a chain terminator is added the polymers will become shorter; the earlier the chain terminator is added, and the larger the amount of chain terminator that is added, the shorter the polymers will become.
If in step 9 a chain terminator is not added, the polymer may terminate via: a) consumption of all monomer units, b) combination of the radical in a polymer chain with a radical from another polymer attached to another macrocycle attached to the same nanotube, or c) combination of the radical in a polymer chain with a radical from a polymer attached to another macrocycle on a different nanotube. See FIG. 73.
If in step 3 the amount of precursor-ML (carrying a polymerization initiator) added is changed, the average length of the polymers will change. Thus, the average length of the polymer can be controlled to give polymers of approximately 10, 100, 1.000, 10.000, or 100.000 units, by varying the amount of precursor-ML added. A smaller number of MLs (and thus a smaller number of polymerization initiators) results in longer polymers.
If in step 7 the concentration of monomer is changed, the average polymer length may change. Thus, a higher monomer concentration in step 7 may lead to longer polymers; lower concentration of monomer may result in shorter polymers.
If in step 8 the polymerization temperature is changed, the polymerization rate will change and therefore the average length of the polymers may change.

Example JJ21, B2: Sequence 2, reaction used to generate polyamide-coated SWNTs. In this example, we use sequence 2 from Example 0 (see FIG. 71) to obtain polyamide-coated SWNTs generated by the attachment of a preformed poly-Ushape around the nanotube to form rings. See FIG. 73.
Step 1: Poly(alanine-alanine-hydroxyproline) (500 mg, 0.05 mmol, aprox. MW=10.000) is dissolved in dry dimethylformamide (DMF, 75 mL). To this solution, K₂CO₃ (262 mg, 3.8 mmol) and a catalytic amount of KI is added.
Step 2: The precursor-ML (compound JJ21.2, carrying two naphthalenediimide units and a terminal OTs group) (2.0 g, 1.9 mmol) dissolved in dry DMF (75 mL) is added.
Step 3: The solution is stirred at 80° C. overnight.
Step 4: After this time, the crude reaction is poured into ice-cold 1 M HCl and filtrated. The filtered product is washed with MeOH and Et₂O to afford the corresponding polyU-Shape (compound JJ21.3).
Step 5: 1 g SWNTs is dispersed in tetrachloroethane (TCE, 1 L, 1 g/L SWNTs/TCE) by sonication in a bath sonicator (10 mins).
Step 6: The dispersion is degassed with N₂ for 30 mins.
Step 7: To this dispersion, the polyU-shape JJ21.3 (500 mg, 0.01 mmol) and Grubbs 2^{nd} generation catalyst (314 mg, 0.37 mmol) are added.
Step 8: The mixture is stirred under N₂ at room temperature for 72 h, optionally with regular sonication.
Step 9: After this time, the suspension is filtered through a 0.2 μm-pore size polytetrafluoroethylene (PTFE) membrane. The solid obtained is removed from the filter and washed with TCE and dichloromethane employing 10 min sonication, and filtered again. This cleaning procedure is repeated three times, until the filtration solvent is nearly colourless. A final wash with Et₂O is performed and the product is dried at 100° C. for 15 min. The product is termed “Polyamide-coated SWNTs of Example JJ21, B2”. Polyamides of different kinds can be employed by changing the conditions in specific steps, as follows.
   In step 1, any polyamide amino acid derivative, capable of reacting with the OTs group of JJ21.3, can be added instead of Poly(alanine-alanine-hydroxyproline) (e.g. poly(phenylalanine-leucine-hydroxyproline)).
   A precursor-ML with a different recognition motif for CNT (e.g. pyrene, anthraquinone, extended tetrathiafulvalene) may be used.
   If in step 2 the amount of precursor-ML is reduced the corresponding polyU-Shape may have less precursor-MLs per unit and therefore the final polyamide-coated SWNTs may have fewer mechanical bonds between polymer and SWNT.
   In step 5 a different nanotube may be employed (e.g. boron nitride nanotubes or metallic nanotubes).

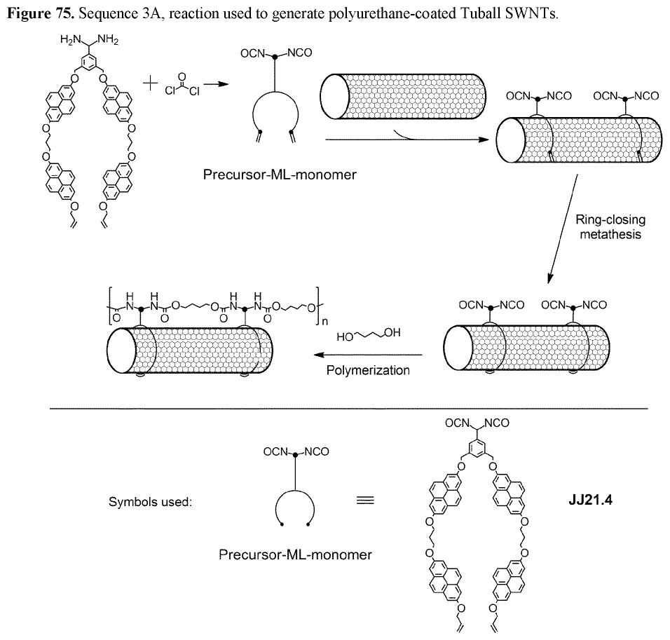

Example JJ21, B3: Sequence 3A, reaction used to generate polyurethane-coated Tuball SWNTs: In this example, we use sequence 3A from Example 0 (see FIG. 71) to obtain polyurethane-coated Tuball SWNTs, generated by first the adsorption of a preformed Ushape-monomer molecule to the Tuball SWNTs, second the closing of the Ushapes to form rings and third the final polymerization of the monomer units. See FIG. 75.
Step 1: 1 g Tuball SWNTs (diameters ranging from 1.3-2.3 nm) are dispersed in tetrachloroethane (TCE, 1 L, 1 g/L SWNTs/TCE) by sonication in a bath sonicator (10 mins).
Step 2: To this dispersion, the Ushape-monomer JJ21.4 (905 mg, 0.7 mmol) is added.
Step 3: The dispersion is degassed with N₂ for 30 mins.
Step 4: Then, Grubbs 2nd generation catalyst (594 mg, 0.7 mmol) is added.
Step 5: The mixture is stirred under N₂ at room temperature for 72 h, optionally with regular pulses of sonication, to mediate formation of a ring-structure around the nanotube from the fusion of 1, 2, 3, 4, 5 or more precursor-MLs.
Step 6: After this time, the suspension is filtered through a 0.2 μm-pore size polytetrafluoroethylene (PTFE) membrane. The solid obtained is removed from the filter and washed with TCE and dichloromethane employing 10 min sonication, and filtered again. This cleaning procedure is repeated three times, until the filtration solvent is nearly colourless. A final wash with Et₂O is performed and the product is dried in air for three days to afford the Tuball-ML-monomer.
Step 7: 1 g Tuball-ML-monomer is dispersed in anhydrous chlorobenzene (500 mL, 2 g/L SWNTs/chlorobenzene) by sonication in a bath sonicator (10 mins).
Step 8: Butanediol (1 equiv. with respect to the ML-monomer) is added to the mixture.
Step 9: Optionally, dibutyltin dilaurate (DBTDL, catalyst, 0.03 wt %) is added to the mixture.
Step 10: The flask is fitted with stirrer, thermometer, reflux condenser with drying tube and nitrogen inlet.
Step 11: The air is removed and replaced for nitrogen, and optionally sonication performed regularly.
Step 12: The mixture is heated carefully at 95° C. under a slow stream of nitrogen.
Step 13: The reaction is stirred for several hours until no —NCO signals are observed in infrared spectroscopy.
Step 14: After cooling, the polyurethane-coated tuball SWNTs are isolated by vacuum filtration. The product is called “Polyurethane-coated nanotubes of Example JJ21-B3”.

This methodology can be modified as follows.
In step 7, different solvents can be employed (e.g: N-methyl-2-pyrrolidone (NMP), dimethylformamide (DMF) and mixtures of NMP with DMF, toluene, and ethyl acetate).
In step 8, different diols, triols (e.g. natural castor oil) and polyols can be added, therefore obtaining different final polyurethanes. Some examples are polybutadiene diols for the obtention of elastomers, polyester polyols (e.g. polyethylene adipate) or polyether polyols (e.g. polyethylene glycol).
In step 9, different catalysts can be added (e.g. DABCO) or the reaction can proceed in the absence of catalyst.

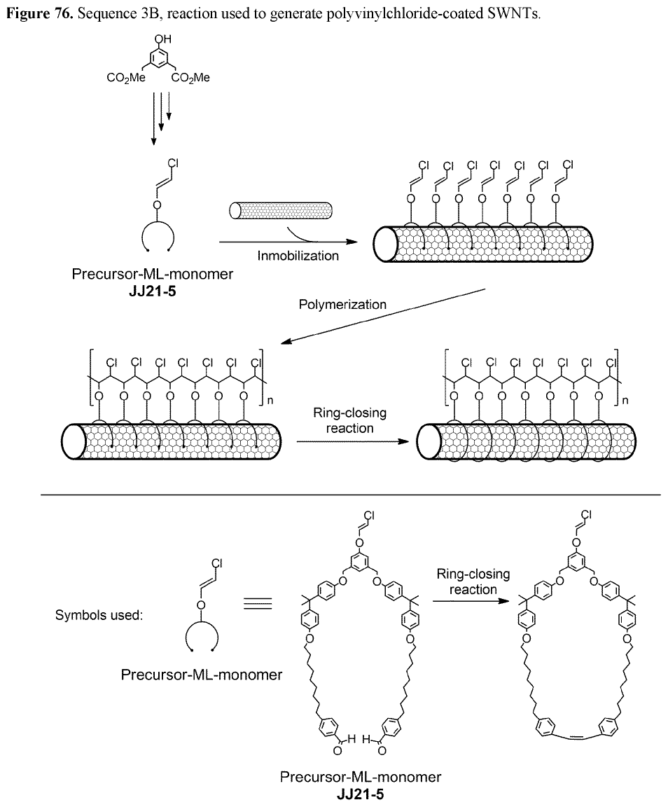

Example JJ21, B4: Sequence 3B, reaction used to generate polyvinylchloride-coated boron nitride nanotubes: In this example, we use sequence 3B from Example 0 to obtain polyvinylchloride-coated boron nitride nanotubes generated by first the adsorption of a preformed Ushape-monomer molecule to the boron nitride nanotubes, second the polymerization of the monomer units while immobilized on the nanotube and third the closing of the Ushapes to form rings. See FIG. 76.
Step 1: 1 g boron nitride nanotubes (BNNTs) are dispersed in tetrahydrofurane (THF, 1 L, 1 g/L BNNTs/THF) by 10 minutes sonication in a bath sonicator.
Step 2: To this dispersion, a precursor-ML-monomer (JJ21.5, 1 g, 0.9 mmol) is added.
Step 3: The dispersion is degassed with N₂ for 30 mins.
Step 4: The suspension is left stirring for a few hours.
Step 5: An initiator, such as azobis(isobutyronitrile) (0.015-0.1% with respect to the precursor-ML-monomer) is added to the mixture.
Step 6: Reaction is stirred at 60° C. for 3 h, with optional pulses of sonication.
Step 7: The residual vinyl chloride monomers and initiator are removed under vacuum employing a rotary evaporator.
Step 8: The obtained solid is redispersed in THF employing a bath sonicator (10 mins).
Step 9: The dispersion is degassed with N₂ for 30 mins.
Step 10: TiCl₄ (1.5 equiv. with respect to the precursor-ML-monomer JJ21.5) is added and the mixture cooled down to −10° C.
Step 11: To this dispersion, a suspension of zinc powder (2 equiv. with respect to TiCl₄) in THF is added.
Step 12: The reaction is stirred for 2 h at 0° C. and a 10% solution of potassium carbonate is added.
Step 13: After this time, the suspension is filtered through a 0.2 μm-pore size polytetrafluoroethylene (PTFE) membrane. The solid obtained is removed from the filter and washed with THF employing 10 min sonication, and filtered again. This cleaning procedure is repeated three times, until the filtration solvent is nearly colourless. A final wash with Et₂O is performed and the product is dried in air for three days to afford the polyvinylchloride-coated boron nitride nanotubes. The final product is called “PVC-coated SWNTs of Example JJ21-B4”.

This methodology can be modified as follows.
In step 5, different initiators can be employed (e.g: t-butyl peroctoate, diisopropyl peroxydicarbonate or dibenzoyl peroxide).
The double bond formed upon ring-closing can be reduced to a single bond by e.g. hydrogenation.

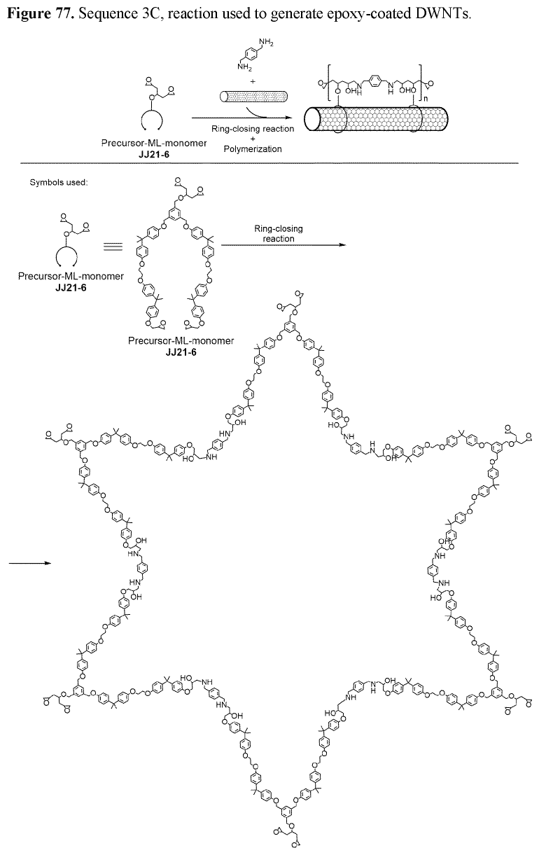

Example JJ21, B5: Sequence 3C, reaction used to generate epoxy-coated DWNTs: In this example, we use sequence 3C from Example 0 (see FIG. 71) to obtain epoxy-coated double-walled carbon nanotubes. For this, first a U-shape (mechanical ligand) carrying two epoxy moieties is mixed with the nanotubes and second the ring-closing around the nanotube and epoxy polymer formation is simultaneously performed. In this set-up, both the ring-closing reaction and polymer formation are triggered by the addition of an amine (curing agent) that 50 acts as crosslinker. Ring formation involves the covalent linkage of several Ushapes, e.g. 3, 4, 5, 6, 7, or 8 Ushapes, in order to reach around the DWNT. See FIG. 77.
Step 1: 1 g double-wall carbon nanotubes (DWNTs) with approximate diameter of approximately 5 nm is dispersed in dimethylformamide (DMF, 1 L, 1 g/L DWNTs/DMF) by sonication in a bath sonicator (10 mins).
Step 2: To this dispersion, the precursor-ML-monomer (JJ21.6, 1 g, 0.7 mmol) is added.
Step 3: The dispersion is degassed with N₂ for 30 mins.
Step 4: A curing agent, such as p-xylylenediamine (95 mg, 0.7 mmol) is added to the mixture.
Step 5: Reaction is stirred at 50° C. for 16 h, optionally with regular pulses of sonication.
Step 6: After this time, the suspension is filtered through a 0.2 μm-pore size polytetrafluoroethylene (PTFE) membrane. The solid obtained is removed from the filter and washed with DMF employing 10 min sonication, and filtered again. This cleaning procedure is repeated three times, until the filtration solvent is nearly colourless. A final wash with Et₂O is performed and the product is dried in an oven at 150° C. for 2 h to afford the epoxy-coated double-wall carbon nanotubes. The product is called “Epoxy-coated DWNTs of Example JJ21, B5”.

This methodology can be modified as follows.
In step 4, different curing agents can be employed (e.g: aliphatic polyamines such as diehylenetriamine and isophoronediamine or aromatic amines such as diaminodiphenylmethane).
In step 5, depending on the curing agent employed, the reaction temperature can be varied from less than room temperature to more than 200° C.

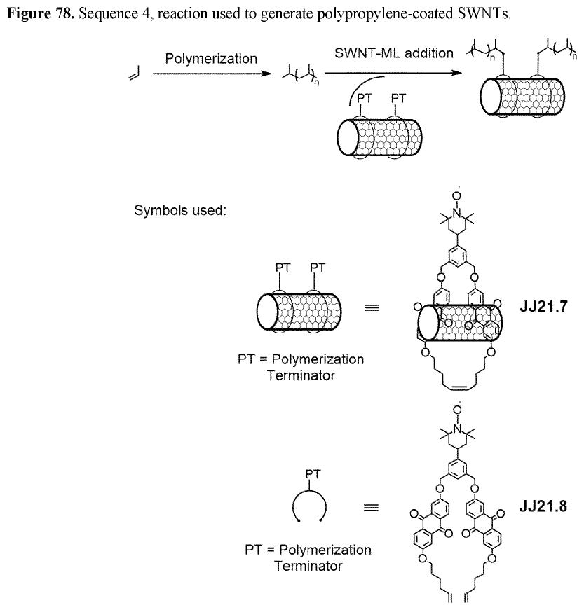

Example JJ21, B6: Sequence 4A, reaction used to generate polypropylene-coated SWNTs: In this example, we use sequence 4A from Example 0 to obtain polypropylene-coated SWNTs. Polypropylene is generated in suspension and the SWNT-ML carrying a polymerization terminator fragment is added when the length of the polymer is adequate. See FIG. 78.
Step 1: A 250 mL flask equipped with a mixing blade, a gas inlet and a thermometer is flushed with argon.
Step 2: 90 ml of highly dried toluene are added through the thermometer inlet.
Step 3: 5 ml of a 10% methylalumoxane (MAO) solution are added followed by 5 mL of a solution of rac-ethylene-bis(4,4,5,5′,6,6′,7,7-tetrahydro-1,1′-indenyl)zirconium dichloride (CAS Number 100163-29-9).
Step 4: The setup is evacuated until the vapor pressure of toluene is reached.
Step 5: Dry propylene is passed until normal pressure.
Step 6: The mixture is stirred for 1 h.
Step 7: 100 mL of a JJ21.7 (SWNT-ML-Polymerization Terminator)-dispersion in toluene (1 g/L JJ21.7/Toluene) is added though the thermometer inlet. (JJ21.7 is synthesised by reacting the precursor-ML JJ21.8 and SWNT, following steps 1-6 of Example JJ21, B3, where JJ21.4 has been replaced by JJ21.8 but all other conditions are kept the same).
Step 8: The mixture is stirred for 30 min.
Step 9: 10 mL ethanol is slowly added.
Step 10: The crude is added over ethanol.
Step 11: The MAO and zirconium residues are removed by the addition of 10% HCl solution and 1 h stirring.
Step 12: The polypropylene-coated SWNTs are obtained through filtration over a Buchner funnel, washing with ethanol and drying in vacuum at 50° C. The final product is called “Polypropylene-coated SWNTs of Example JJ21, B6”

### Modifications to this Example

By adding ethylene instead of propylene in Step 5, polyethylene may be generated 50 instead in this step. The final product of step 12 is then called “Polyethylene-coated SWNTs of Example JJ21, B6”.

### Example KK1. Two Steps Hand-Made Mortar Method

### Preparation of MINTs

Step 1: In an Agatha mortar, SWNTs (Tuball from OCSiAl, 1 g), “Pyrene U-shape_Example AA1” (0.48 mmol, 1 eq), and 2^{nd} gen. Grubbs catalyst (0.07 mmol, 0.5 eq, purchased from BLD) were added.
Step 2: 15 minutes hand-made mortar reaction was made.
Step 3: After this time, an aliquot of 0.5 g was separated (JJ1a).
Step 4: The hand-made mortar reaction was continued for the next 15 min with the remaining 0.5 g of sample (JJ1b).
Step 5: The mortar content was recovered. To the aliquot, chloromethane (50 mL) was added, and the reaction mixture was filtered through a 47 mm diameter PTFE membrane of 0.2 μm pore size.
Step 6: The filter cake was collected and re-dispersed in 100 mL dichloromethane in a round-bottom flask by bath sonication for 15 seconds.
Step 7: The sample was filtered again through a 47 mm diameter PTFE membrane of 0.2 μm pore size.
Step 8: Steps 5 and 6 were repeated three times.
Step 9: Approximately 50 mL Et₂O was added to the filter cake.
Step 10: The coated tubes were collected in a vial and dried under a vacuum overnight at room temperature. The product (compound JJ1a) was termed “Pyrene MINT_Example KK1a”.
Step 11: Steps 5-10 were repeated for sample JJ1b. The product (compound JJ1b) was termed “Pyrene MINT_Example KK1b”.

The above-mentioned protocol “Example KK1. Two steps hand-made mortar method” was performed using in step 1 compound “Pyrene U-Shape of the Example AA1” (also termed compound AA1) The product “Pyrene MINT_Example KK1a” and “Pyrene MINT_Example KK1b” were analyzed by TGA. The degree of functionalization (the ratio organic material/SWNT) was determined to be 23% and 27% subsequently.

### Example KK2. Mechanochemical Method

The method made use of the mechanical energy generated in a ball mill to disperse the SWNTs, and/or bind the U-Shape molecule to SWNTs, and/or mediate the ring-closing metathesis.
Step 1: In an 80 mL-size stainless steel ball mill reactor, SWNTs (Tuball from OCSiAl, 2.5 g), “Ester U-shape_Example AA3” (0.72 mmol, 1 eq) and 2^{nd} gen. Grubbs catalyst (0.07 mmol, 0.1 eq, purchased from BLD) were added.
Step 2: The reactor was charged with five 15 mm diameter stainless steel balls.
Step 3: The powders were milled for 10 min at 150 rpm in an air atmosphere.
Step 4: After this time, the reactor content was recovered. Dichloromethane (50 mL) was added, and the reaction mixture was filtered through a 47 mm diameter PTFE membrane of 0.2 μm pore size.
Step 5: The filter cake was collected and was re-dispersed in 100 mL dichloromethane in a round-bottom flask by bath sonication for 15 seconds.
Step 6: The sample was filtered again through a 47 mm diameter PTFE membrane of 0.2 μm pore size.
Step 7: Steps 5 and 6 were repeated three times.
Step 8: Approximately 50 mL Et₂O was added to the filter cake.
Step 9: The coated tubes were collected in a vial and dried under vacuum overnight at room temperature. The product (compound AA16) was termed “Ester MINT_Example KK2”.
   The above-mentioned protocol “Example KK2. Mechanochemical method” was performed using in step 1 compound “Ester U-Shape of the Example AA3” (also termed compound AA3) or “Acid U-Shape of the Example AA2” (also termed compound AA2), to produce the products listed immediately below.

The product “Ester MINT_Example KK2”, (also termed compound JJ2) was prepared using the protocol “Example KK2. Mechanochemical method”. The product “Ester MINT_Example KK2” was analysed by TGA. The degree of functionalization (the ratio organic material/(organic material+SWNT)) was determined to be 20%.

The product “Acid MINT_Example KK3”, (also termed compound JJ3) was prepared using the protocol “Example KK2. Mechanochemical method”, and in step 1 using “Acid U-Shape of the Example AA4” (also termed compound AA4), instead of “Ester U-Shape_Example AA3” (also termed compound AA3). The product “Acid MINT_Example KK3” was analyzed by TGA. The degree of functionalization (the ratio organic material/SWNT) was determined to be 20%.

### Preparation of COMPOSITES

### Example KK4. 50k PS-NH₂+Ester MINT 1:1 Equivalent

Step 1: In a 45 mL-size stainless steel ball mill reactor, 0.35 g of 50k PS—NH2 (polystyrene amino terminated, purchased from Polymer Source, MW=50,000 g/mol (1 eq) and 0.03 g of compound “Ester MINT_Example KK2” (also termed compound JJ2) were added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “50k PS—NH₂ ester MINT_1:1_Example KK4”, (compound JJ4).

Dog bones made from the product “50k PS—NH₂ ester MINT_1:1_Example KK4” (by hot press) were too difficult to extract from the stainless molds, and they were not analysed any further.

### Example KK5. 125k PS-NH₂+Ester MINT 1:1 Equivalent

Step 1: In a 45 mL-size stainless steel ball mill reactor, 0.35 g of 125k_PS-NH₂ (polystyrene amino terminated, purchased from Polymer Source, MW=125,000 g/mol (1 eq) and 0.012 g of compound “Ester MINT_Example KK2” (also termed compound JJ2) were added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “125k PS—NH₂ ester MINT_1:1_Example KK5”, (compound JJ5).

### Example KK6. 50k PS—NH₂ Neat

Step 1: In a 45 mL-size stainless steel ball mill reactor, 0.35 g of 50k_PS-NH2 (polystyrene amino terminated, purchased from Polymer Source, MW=50,000 g/mol was added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “50k PS—NH₂ neat_Example KK6”, (compound JJ6).

Dog bones for specimens obtained in “50k PS—NH₂ neat_Example KK6” were too difficult to extract from the stainless molds, and they were not measured.

### Example KK7. 125k PS—NH₂ Neat

Step 1: In a 45 mL-size stainless steel ball mill reactor, 0.35 g of 125k_PS-NH₂ (polystyrene amino terminated, purchased from Polymer Source, MW=125,000 g/mol) was added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “125k PS—NH₂ neat_Example KK7”, (compound JJ7).

Dog bones for specimens obtained in “125k PS—NH₂ neat_Example KK7” were too difficult to extract from the stainless mold, and they were not measured.

### Example KK8. 50k PS-NH₂+Ester MINT 0.1% SWNTs

Step 1: In a 45 mL-size stainless steel ball mill reactor, 0.35 g of 50k_PS-NH₂ (polystyrene amino terminated, purchased from Polymer Source, MW=125,000 g/mol 1 eq) and 0.00035 g of compound “Ester MINT_Example KK2” (also termed compound JJ2) were added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “50k PS—NH₂ ester MINT_0.1%_Example KK8”, (compound JJ8).

Dog bones for specimens obtained in “50k PS—NH₂ ester MINT_0.1%_Example KK8” were too difficult to extract from the stainless mold, and they were not measured.

### Example KK9. 125k PS-NH₂+Ester MINT 0.1% SWNTs

Step 1: In a 45 mL-size stainless steel ball mill reactor, 0.35 g of 125k_PS-NH₂ (polystyrene amino terminated, purchased from Polymer Source, MW=125,000 g/mol 1 eq) and 0.00035 g of compound “Ester MINT_Example KK2” (also termed compound JJ2) were added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “125k PS—NH₂ ester MINT_0.1%_Example KK9”, (compound JJ9).

Dog bones for specimens obtained in “125k PS—NH₂ ester MINT_0.1%_Example KK9” were too difficult to extract from the stainless mold, and they were not measured.

### Example KK10. 50k PS-NH₂+Ester MINT 0.8% SWNTs

Step 1: In a 45 mL-size stainless steel ball mill reactor, 0.1 g of 50k_PS-NH₂ (polystyrene amino terminated, purchased from Polymer Source, MW=50,000 g/mol 1 eq) and 0.01 g of compound “Ester MINT_Example KK2” (also termed compound JJ2) were added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “50k PS—NH₂ ester MINT_0.8%_Example KK10”, (compound JJ10).

Dog bones for specimens obtained in “50k PS—NH₂ ester MINT_0.8%_Example KK10” were too difficult to extract from the stainless mold, and they were not measured.

### Example KK11. 125k PS-NH₂+Ester MINT 0.8% SWNTs

Step 1: In a 45 mL-size stainless steel ball mill reactor, 0.1 g of 125k_PS-NH₂ (polystyrene amino terminated, purchased from Polymer Source, MW=125,000 g/mol 1 eq) and 0.01 g of compound “Ester MINT_Example KK2” (also termed compound JJ2) were added.
Step 2. The reactor was charged with five 15 mm diameter stainless steel balls.
Step 3: The powder was milled for 10 min at 500 rpm in an air atmosphere.
Step 4: After this time, the reactor content was recovered and dried at 200° C. for 2 h.
Step 6: The resulting product was termed “125k PS—NH₂ ester MINT_0.8%_Example KK11”, (compound JJ11).

Dog bones for specimens obtained in “125k PS—NH₂ ester MINT_0.8%_Example KK11” were too difficult to extract from the stainless mold, and they were not measured.

### Example KK12. 921k PS—NH₂ Neat

Step 1: 2 g of 921k_PS-NH₂ (polystyrene amino terminated, purchased from Polymer Source, MW=921,000 g/mol) was dissolved in 200 ml of CHCl₃.
Step 2: The solution was poured into a teflon dish to evaporate and prepare a film of polymer.
Step 3: The resulting product was termed “921k PS—NH₂ neat_Example KK12”, (compound JJ12).

### Example KK13. 921k PS—NH₂ U-Shape 0.2% SWNTs

Step 1: In a round bottom flask, 0.003 g (1 eq) of compound “Acid U-Shape of the Example AA4” (also termed compound AA4) was dissolved in 1 ml of DCM under nitrogen flow on the magnetic stirrer.
Step 2. 3 μl of oxalyl chloride (TCI, 6 eq) was added.
Step 3: 3 drops of DMF were added. The reaction was carried out for 1.5 h at room temperature.
Step 4: The solvent was evaporated on a rotating evaporator.
Step 5: To the flask with a dried acid chloride 3.0 g (1 eq) of 921k_PS-NH₂ (polystyrene amino terminated, purchased from Polymer Source, MW=921,000 g/mol) was added. All was dissolved in 100 ml of DCM.
Step 6: The mixture was left for stirring at room temperature overnight.
Step 7: The solvent was evaporated on the rotating evaporator.
Step 8: In a 45 mL-size stainless steel ball mill reactor, the PS-u-shape and 5.6 mg of SWNTs, 50 and 0.0002 g of 2^{nd} gen. Grubbs catalysts (0.00027 mmol, 0.1 eq, BLD) were added.
Step 9: The reactor was charged with five 15 mm diameter stainless steel balls.
Step 10: The powder was milled for 10 min at 500 rpm in an air atmosphere.
Step 11: The resulting product was termed “921k PS—NH₂ u-shape_0.2%_Example KK13”, (compound JJ13).

### Example KK14. 907k PS—NH₂ Neat

Step 1: 1 g of 907k_PS-NH₂ (polystyrene amino terminated, purchased from Polymer Source, MW=907,000 g/mol) was dissolved in 80 ml of CHCl₃.
Step 2: The solution was poured into a teflon dish to evaporate and prepare a film of polymer.
Step 3: The resulting product was termed “907k PS—NH₂ neat_Example KK14”, (compound JJ14).

### Example KK15. 907k PS—NH₂+0.46% SWNTs

Step 1: In a 45 mL-size stainless steel ball mill reactor, 0.13 g of 907k_PS-NH₂ (polystyrene amino terminated, purchased from Polymer Source, MW=907,000 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0063 g SWNTs (Tuball from OCSiAl) was added.
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂+0.48%_Example KK15”, (compound JJ15).

### Example KK16. 907k PS—NH₂ u-Shape 0.23% SWNTs

Step 1: In a round bottom flask, 0.0023 g (1 eq) of compound “Acid U-Shape of the Example AA4” (also termed compound AA4) was dissolved in 1 ml of DCM under nitrogen flow on the magnetic stirrer.
Step 2. 1.7 μl of oxalyl chloride (TCI, 6 eq) was added.
Step 3: 3 drops of DMF were added. The reaction was carried out for 1.5 h at room temperature.
Step 4: The solvent was evaporated on a rotating evaporator.
Step 5: To the flask with a dried acid chloride 2.1 g (1 eq) of 907k_PS-NH₂ (polystyrene amino terminated, purchased from Polymer Source, MW=907,000 g/mol) was added. All was dissolved in 80 ml of DCM.
Step 6: The mixture was left for stirring at room temperature overnight.
Step 7: The solvent was evaporated on the rotating evaporator.
Step 8: The crude was divided into two equal samples.
Step 9: In a 45 mL-size stainless steel ball mill reactor, the 1.023 g of PS-u-shape, 2.35 mg of SWNTs, and 0.00001 g of 2^{nd} gen. Grubbs catalysts (0.000113 mmol, 0.1 eq, BLD) were added.
Step 10: The reactor was charged with five 15 mm diameter stainless steel balls.
Step 11: The powder was milled for 10 min at 500 rpm in an air atmosphere.
Step 12: The resulting product was termed “907k PS—NH₂ u-shape_0.2%_Example KK16a”, (compound JJ16a).
Step 13: 1.022 g of remaining PS-u-shape, 2.35 mg of SWNTs, and 0.00001 g of 2^{nd} gen. Grubbs catalysts (0.000113 mmol, 0.1 eq, BLD) were transferred to the mortar.
Step 14: The reaction was carried out for 30 minutes.
Step 15: 0.5 ml of toluene was added and the reaction was carried out for another 20 minutes.
Step 16: The resulting product was termed “907k PS—NH₂ u-shape_0.2%_Example KK16b”, (compound JJ16b).

### Example KK17. 907k PS—NH₂ u-Shape 0.46% SWNTs

Step 1: In a round bottom flask, 0.0042 g (2 eq) of compound “Acid U-Shape of the Example AA4” (also termed compound AA4) was dissolved in 2 ml of DCM under nitrogen flow on the magnetic stirrer.
Step 2. 2.3 μl of oxalyl chloride (TCI, 12 eq) was added.
Step 3: 6 drops of DMF were added. The reaction was carried out for 1.5 h at room temperature.
Step 4: The solvent was evaporated on a rotating evaporator.
Step 5: To the flask with a dried acid chloride 2.1 g (1 eq) of 907k_PS-NH₂ (polystyrene amino terminated, purchased from Polymer Source, MW=907,000 g/mol) was added. All was dissolved in 80 ml of DCM.
Step 6: The mixture was left for stirring at room temperature overnight.
Step 7: The solvent was evaporated on the rotating evaporator.
Step 8: The crude was divided into two equal samples.
Step 9: In a 45 mL-size stainless steel ball mill reactor, the 1.023 g of PS-u-shape (0.00113 mmol), 4.7 mg of SWNTs, and 0.0001 g of 2^{nd} gen. Grubbs catalysts (0.000226 mmol, 0.2 eq, BLD) were added.
Step 10: The reactor was charged with five 15 mm diameter stainless steel balls.
Step 11: The powder was milled for 10 min at 500 rpm in an air atmosphere.
Step 12: The resulting product was termed “907k PS—NH₂ u-shape_0.46%_Example KK17a”, (compound JJ16a).
Step 13: 1.036 g of remaining PS-u-shape, 4.8 mg of SWNTs, and 0.0002 g of 2^{nd} gen. Grubbs catalysts (0.000226 mmol, 0.2 eq, BLD) were transferred to the mortar.
Step 14: 0.5 ml of toluene was added.
Step 15: The reaction was carried out for 30 minutes.
Step 16: The crude was dried at 120° C. for 2 h.
Step 16: The resulting product was termed “907k PS—NH₂ u-shape_0.46%_Example KK17b”, (compound JJ16b).

### Example KK18. 907k PS-NH₂+Acid MINT 0.8% SWNTs

Step 1: In a 45 mL-size stainless steel ball mill reactor, 0.13 g of 907k_PS-NH₂ (polystyrene amino terminated, purchased from Polymer Source, MW=907,000 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0129 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS-NH₂+Acid MINT 0.8%_Example KK18”, (compound JJ18).

### Example KK19. 907k PS-NH₂+Acid MINT 0.46% SWNTs

Step 1: In a 45 mL-size stainless steel ball mill reactor, 0.13 g of 907k_PS-NH₂ (polystyrene amino terminated, purchased from Polymer Source, MW=907,000 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0079 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS-NH₂+Acid MINT 0.46%_Example KK19”, (compound JJ19).

### Example KK20. 907k PS-NH₂+Ester MINT 0.46% SWNTs

Step 1: In a 45 mL-size stainless steel ball mill reactor, 0.13 g of 907k_PS-NH₂ (polystyrene amino terminated, purchased from Polymer Source, MW=907,000 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0079 g of compound “Ester MINT_Example KK2” (also termed compound JJ2).
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂ Ester MINT 0.46%_Example KK20”, (compound JJ19).

### Example KK21. 907k PS—NH₂ u-Shape 0.46% SWNTs Dry

Step 1: In a round bottom flask, 0.0042 g (2 eq) of compound “Acid U-Shape of the Example AA4” (also termed compound AA4) was dissolved in 2 ml of DCM under nitrogen flow on the magnetic stirrer.
Step 2. 2.3 μl of oxalyl chloride (TCI, 12 eq) was added.
Step 3: 6 drops of DMF were added. The reaction was carried out for 1.5 h at room temperature.
Step 4: The solvent was evaporated on a rotating evaporator.
Step 5: To the flask with a dried acid chloride 2.1 g (1 eq) of 907k_PS-NH₂ (polystyrene amino terminated, purchased from Polymer Source, MW=907,000 g/mol) was added. All was dissolved in 80 ml of DCM.
Step 6: The mixture was left for stirring at room temperature overnight.
Step 7: The solvent was evaporated on the rotating evaporator.
Step 8: The crude was dried at 125° C. for 2 h.
Step 9: The dried PS—u-shape was divided into two equal samples.
Step 10: In a 45 mL-size stainless steel ball mill reactor, the 1.023 g of PS-u-shape (0.00113 mmol) was added.
Step 11: The reactor was charged with five 15 mm diameter stainless steel balls.
Step 12: The powder was milled for 30 min at 500 rpm in an air atmosphere.
Step 13: 5.0 mg of SWNTs, and 0.0002 g of 2^{nd} gen. Grubbs catalysts (0.000226 mmol, 0.2 eq, BLD) were added to the polymer.
Step 14: The powder was milled for 10 min at 150 rpm in an air atmosphere.
Step 15: The resulting product was termed “907k PS—NH₂ u-shape_0.46% dry_Example KK21”, (compound JJ21).

These examples present composites obtained by combining 907k PS—NH₂ with small amounts of 6.5k PS—NH₂.

### Example KK22. 907k PS—NH₂+0.05% 6.5k PS—NH₂ Acid MINT 0.52% SWNTs

Step 1: In a 45 mL-size stainless steel ball mill reactor, 1.2993 g of 907k_PS-NH₂ (polystyrene amino terminated, purchased from Polymer Source, MW=907,000 g/mol) and 0.0007 g of 6.5k_PS-NH₂ (polystyrene amino terminated, purchased from Polymer Source, MW=6,500 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0084 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂+0.05% 6.5k PS—NH₂ Acid MINT 0.52%_Example KK22”, (compound JJ22).

### Example KK23. 907k PS—NH₂+0.75% 6.5k PS—NH₂ Acid MINT 1.0% SWNTs

Step 1: In a 45 mL-size stainless steel ball mill reactor, 1.2902 g of 907k_PS-NH₂ (polystyrene amino terminated, purchased from Polymer Source, MW=907,000 g/mol) and 0.00975 g of 6.5k_PS-NH₂ (polystyrene amino terminated, purchased from Polymer Source, MW=6,500 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0161 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂+0.75% 6.5k PS—NH₂ Acid MINT 1.0%_Example KK23”, (compound JJ23).

### Example KK24. 907k PS—NH₂+2.0% 6.5k PS—NH₂ Acid MINT 1.8% SWNTs

Step 1: In a 45 mL-size stainless steel ball mill reactor, 1.274 g of 907k_PS-NH₂ (polystyrene amino terminated, purchased from Polymer Source, MW=907,000 g/mol) and 0.026 g of 6.5k_PS-NH₂ (polystyrene amino terminated, purchased from Polymer Source, MW=6,500 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0298 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂+2.0% 6.5k PS—NH₂ Acid MINT 1.8%_Example KK24”, (compound JJ24).

### Example KK25. 907k PS—NH₂+5.0% 6.5k PS—NH₂ Acid MINT 3.7% SWNTs

Step 1: In a 45 mL-size stainless steel ball mill reactor, 1.235 g of 907k_PS-NH₂ (polystyrene amino terminated, purchased from Polymer Source, MW=907,000 g/mol) and 0.065 g of 6.5k_PS-NH₂ (polystyrene amino terminated, purchased from Polymer Source, MW=6,500 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0622 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂+5.0% 6.5k PS—NH₂ Acid MINT 3.7%_Example KK25”, (compound JJ25).

### Example KK26. 907k PS—NH₂+5.0% 6.5k PS—NH₂ Acid MINT 1.88% SWNTs

Step 1: In a 45 mL-size stainless steel ball mill reactor, 1.235 g of 907k_PS-NH₂ (polystyrene amino terminated, purchased from Polymer Source, MW=907,000 g/mol) and 0.065 g of 6.5k_PS-NH₂ (polystyrene amino terminated, purchased from Polymer Source, MW=6,500 g/mol) was added.
Step 2. The reactor was charged with five 15 mm diameter stainless steel balls.
Step 3: The powder was milled for 30 min at 500 rpm in an air atmosphere.
Step 4: To the polystyrene was added 0.0313 g of compound “Acid MINT_Example KK3” (also termed compound JJ3).
Step 5: The powder was milled for 10 min at 150 rpm in an air atmosphere.
Step 6: After this time, the reactor content was recovered and dried at 200° C. for 2 h.
Step 7: The resulting product was termed “907k PS—NH₂+5.0% 6.5k PS—NH₂ Acid MINT 1.85%_Example KK26”, (compound JJ26).

### Dog Bones.

The preparation of dog bone-shape tensile testing specimens were made following the protocol described in “Example FF4”. This protocol was used for the composites obtained in examples from “Example KK12” to “Example KK26”.

For Tensile tests, an Instron 34-TM tensile testing machine was used with a 10 kN load cell, following the procedure described in “Example FF5”.

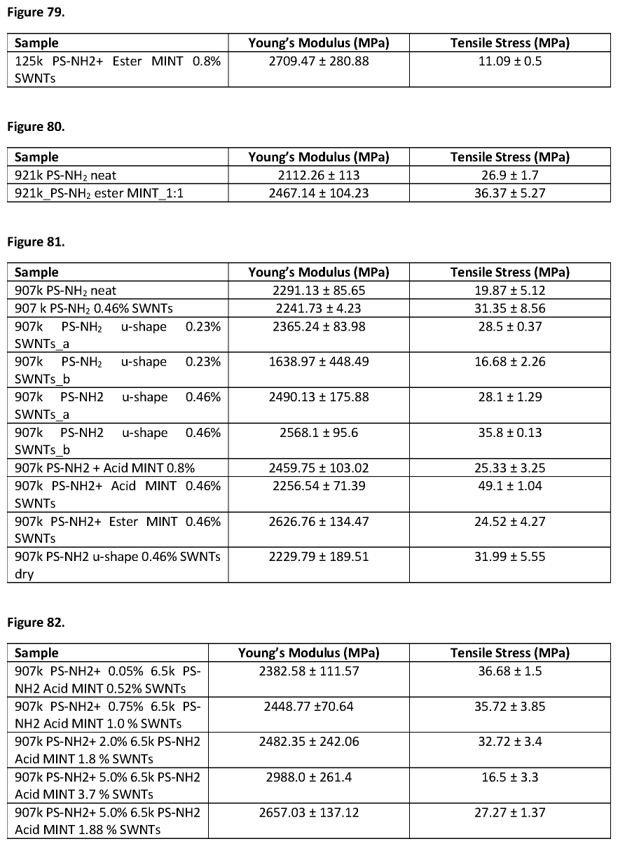

Results obtained in a tensile test involving compound JJ11 are shown in FIG. 79.

Results obtained in a tensile test involving compounds JJ12 to JJ13 are shown in FIG. 80.

Results obtained in a tensile test involving compounds JJ14 to JJ21 are shown in FIG. 81.

Results obtained in a tensile test involving compounds JJ22 to JJ26 are shown in FIG. 82.

For compound JJ5, was obtained only one dog bone, and for this reason the result is not included.

### Example TT 1. Preparation of a Mixture of Coated Carbon Nanotubes

A mixture of coated nanotubes is prepared, by combining 10 g of each of the following preparations of coated nanotubes in a glass flask (the name of each of the coated tube preparations are listed hereunder), and mixing to allow even distribution in the flask of the various coated tubes. The preparations of coated tubes that are mixed are: “Pyrene MINT of Example AA11a”, “Pyrene MINT of Example AA11b”, “Alkene MINT of Example AA11b”, “Ester MINT of Example AA11b”, “Acid MINT of Example AA11b”, “Fluorenone MINT of Example AA11b”, “Chain MINT of Example AA11b”, “Glycol MINT of Example AA11b”, “Fully glycol MINT of Example AA11b”, “DER MINT of Example AA11b”, “Methyl alcohol MINT of Example AA11b”, “Pyrene MINT of Example AA11c”, “5k PS—NH₂ ester MINT_1:1 of Example AA12a”, “3,530k_PS-NH₂ ester MINT_1:1 of Example AA12a”, “Prep A: 28% pyrene MINT of Example BB1”, “Prep C: 28% Pyridine MINT of Example BB1”, and “Prep F: 25% amine MINT of Example EE1”.

The resulting mixture is called “Mix of coated tubes of Example TT 1”.

### Example TT 2. Preparation of Polyethylene-Carbon Nanotube Composite Fibers

In this example it is described how fibers are made from polyethylene-CNT composite granulates, by performing the following steps:
Step 1: To each of 5 flasks, 100 g polyethylene granulate is added.
Step 2: The following amounts of “Mix of coated tubes of Example TT 1” is added to the flasks:
Flask 1: 0.01 g (final coated CNT concentration in the final composite fiber: 0.01 wt/wt %)
Flask 2: 0.1 g (final coated CNT concentration in the final composite fiber: 0, 1 wt/wt %)
Flask 3: 1 g (final coated CNT concentration in the final composite fiber: 1 wt/wt %)
Flask 4: 10 g (final coated CNT concentration in the final composite fiber: 10 wt/wt %)
Flask 5: 20 g (final coated CNT concentration in the final composite fiber: 20 wt/wt %)
Step 3: For each flask a specific composite granulate may be made by filling the entire content of the flask into a thermo-regulated casing at a desired temperature, where a homogeneous formulate is created by a Z-blade kneader-extruder.
Step 4: The homogeneous formulate may then be mixed further in a temperature-controlled barrel with a rotating twin-screw. The temperature of the formulate is above the melting temperature of the polyethylene to ensure a well-dispersed polyethylene-CNT melt.
Step 5: The melted polyethylene-CNT material may then be pressed by the screw movement through a die with a small hole to create an extruded polyethylene-CNT fiber that is then led through a water bath to cool the polyethylene-CNT fiber. The cooled fiber is then led through a cutter, which creates granulates of the desired size.
Step 6: The granulates are then fed to a feed hopper and into a temperature-controlled barrel with a rotating screw. The temperature of the granulate is then heated to above the melting temperature and the melt is transferred to a metering pump which delivers the molten polyethylene-CNT material into a spinning chamber at a very controlled speed, then the polyethylene-CNT material is pushed into a die with capillary holes of any shape and passes through them to form filaments. The filaments are passed through a cooling chamber after which a take-up device is used to draw filaments and turn them into smaller diameters. Depending on the desired level of diameter, desired shape, desired CNT orientation and desired properties of the polyethylene itself, several drawing steps may be carried out.

The 5 resulting fibers are called, respectively,
“0.01% CNT-PE fiber of Example TT 2”,
“0.1% CNT-PE fiber of Example TT 2”,
“1% CNT-PE fiber of Example TT 2”,
“10% CNT-PE fiber of Example TT 2”,
“20% CNT-PE fiber of Example TT 2”.

Besides the above example of melt spinning to manufacture the fiber several other methods may be utilized depending on the polymer material applied; including, but not limited to, solution spinning (dry or wet), gel spinning, liquid crystal spinning, dispersion spinning, reaction spinning, electrospinning, extrusion, pultrusion, injection molding and rotational molding.

### Example TT 3. Preparation of Various Composite Fibers Comprising CNT

In this example, fibers are made comprising various types of polymers and various amounts of CNT.

For each of the following 7 thermoplastic polymers—polystyrene (PS), polyurethane (PU), polyvinyl chloride (PVC), polyamide 6,6 (PA), polypropylene (PP), polylactic acid (PLA), and polyetheretherketone (PEEK)—5 different fibers are made using the protocol of Example TT 2**, where the 100 g of polyethylene in Step 1 has been replaced with 100 g of the appropriate polymer, and therefore comprises in the final fiber 0.01% CNT, 0.1% CNT, 1% CNT, 10% CNT, and 20% CNT, respectively.

This result in the formation of the following 35 composite fibers:
“0.01% CNT-PS fiber of Example TT 3”,
“0.1% CNT-PS fiber of Example TT 3”,
“1% CNT-PS fiber of Example TT 3”,
“10% CNT-PS fiber of Example TT 3”,
“20% CNT-PS fiber of Example TT 3”.
“0.01% CNT-PU fiber of Example TT 3”,
“0.1% CNT-PU fiber of Example TT 3”,
“1% CNT-PU fiber of Example TT 3”,
“10% CNT-PU fiber of Example TT 3”,
“20% CNT-PU fiber of Example TT 3”.
“0.01% CNT-PVC fiber of Example TT 3”,
“0.1% CNT-PVC fiber of Example TT 3,
“10% CNT-PVC fiber of Example TT 3”,
“20% CNT-PVC fiber of Example TT 3”.
“0.01% CNT-PA fiber of Example TT 3”,
“0.1% CNT-PA fiber of Example TT 3”,
“1% CNT-PA fiber of Example TT 3”,
“10% CNT-PA fiber of Example TT 3”,
“20% CNT-PA fiber of Example TT 3”.
“0.01% CNT-PP fiber of Example TT 3”,
“0.1% CNT-PP fiber of Example TT 3”,
“1% CNT-PP fiber of Example TT 3”,
“10% CNT-PP fiber of Example TT 3”,
“20% CNT-PP fiber of Example TT 3”.
“0.01% CNT-PLA fiber of Example TT 3”,
“0.1% CNT-PLA fiber of Example TT 3”,
“1% CNT-PLA fiber of Example TT 3”,
“10% CNT-PLA fiber of Example TT 3”,
“20% CNT-PLA fiber of Example TT 3”.
“0.01% CNT-PEEK fiber of Example TT 3”,
“0.1% CNT-PEEK fiber of Example TT 3”,
“1% CNT-PEEK fiber of Example TT 3”,
“10% CNT-PEEK fiber of Example TT 3”,
“20% CNT-PEEK fiber of Example TT 3”.

### Example TT 4**. Preparation of Polyethylene-Carbon Nanotube Multiple Layered Composite Fibers

In this example it is described how multiple layered fibers are made from polyethylene-CNT composite granulates, by performing the following steps 1 to 5 in Example TT 2. Resulting in granulates with 5 different amounts of CNT.
Step 1: A separate extruder is used for each granulate composition to feed two or more melted granulate compositions in varying amount to the mold by co-extrusion. The thickness of each layer may be different or the same.
Step 2: Prepare co-extrusion
Extruder 1: Granulates of made of “0.01% CNT-PE fiber of Example TT 4”,
Extruder 2: Granulates of made of “0.1% CNT-PE fiber of Example TT 4”,
Extruder 3: Granulates of made of “1% CNT-PE fiber of Example TT 4”,
Extruder 4: Granulates of made of “10% CNT-PE fiber of Example TT 4”,
Extruder 5: Granulates of made of “20% CNT-PE fiber of Example TT 4”,
Step 3: Forming multiple layered composite fibers (layer 1, layer 2, layer 3, . . . )
Co-extrusion 1: 50% of Extruder 1 and 50% of Extruder 2
Co-extrusion 2: 25% of Extruder 1, 25% of Extruder 2, 25% of Extruder 3 and 25% of Extruder 4.
Co-extrusion 3: 40% of Extruder 2, 40% of Extruder 4 and 20% of Extruder 5
Co-extrusion 4: 20% of Extruder 1, 20% of Extruder 2, 20% of Extruder 3, 20% of Extruder 4 and 20% of Extruder 5.

Co-extrusion 5: 20% of Extruder 1, 35% of Extruder 2, 15% of Extruder 1, 30% of Extruder 4.

The resulting fibers are called, respectively,
“CoEx1 CNT-PE fiber of Example TT 4”,
“CoEx2 CNT-PE fiber of Example TT 4”,
“CoEx3 CNT-PE fiber of Example TT 4”,
“CoEx4 CNT-PE fiber of Example TT 4”,
“CoEx5 CNT-PE fiber of Example TT 4”.

Besides the above example of co-extrusion to manufacture the multi-layered fiber several other methods may be utilized depending on the desired shape, thickness and polymer material applied; including, but not limited to extrusion, pultrusion, injection molding, rotational molding and hot pressing.

### Example TT 5. Preparation of Various Composite Multiple Layered Fibers Comprising CNT

In this example, fibers are made comprising various types of multilayered polymers and various amounts of CNT.

For each of the following 7 thermoplastic polymers—polystyrene (PS), polyurethane (PU), polyvinyl chloride (PVC), polyamide 6,6 (PA), polypropylene (PP), polylactic acid (PLA), and polyetheretherketone (PEEK)—5 different fibers granulates are made using the protocol of Example TT 4**, where the 100 g of polyethylene in Step 1 has been replaced with 100 g of the appropriate polymer, and therefore comprises in the final fiber granulate 0.01% CNT, 0.1% CNT, 1% CNT, 10% CNT, and 20% CNT, respectively.

This result in the formation of the following 35 multilayered composite fibers:
“CoEx1 CNT-PS fiber of Example TT 5”,
“CoEx2 CNT-PS fiber of Example TT 5”,
“CoEx3 CNT-PS fiber of Example TT 5”,
“CoEx4 CNT-PS fiber of Example TT 5”,
“CoEx5 CNT-PS fiber of Example TT 5”.
“CoEx1 CNT-PU fiber of Example TT 5”,
“CoEx2 CNT-PU fiber of Example TT 5”,
“CoEx3 CNT-PU fiber of Example TT 5”,
“CoEx4 CNT-PU fiber of Example TT 5”,
“CoEx5 CNT-PU fiber of Example TT 5”.
“CoEx1 CNT-PVC fiber of Example TT 5”,
“CoEx2 CNT-PVC fiber of Example TT 5”,
“CoEx3 CNT-PVC fiber of Example TT 5”,
“CoEx4 CNT-PVC fiber of Example TT 5”,
“CoEx5 CNT-PVC fiber of Example TT 5”.
“CoEx1 CNT-PA fiber of Example TT 5”,
“CoEx2 CNT-PA fiber of Example TT 5”,
“CoEx3 CNT-PA fiber of Example TT 5”,
“CoEx4 CNT-PA fiber of Example TT 5”,
“CoEx5 CNT-PA fiber of Example TT 5”.
“CoEx1% CNT-PP fiber of Example TT 5”,
“CoEx2 CNT-PP fiber of Example TT 5”,
“CoEx3 CNT-PP fiber of Example TT 5”,
“CoEx4 CNT-PP fiber of Example TT 5”,
“CoEx5 CNT-PP fiber of Example TT 5”.
“CoEx1 CNT-PLA fiber of Example TT 5”,
“CoEx2 CNT-PLA fiber of Example TT 5”,
“CoEx3 CNT-PLA fiber of Example TT 5”,
“CoEx4 CNT-PLA fiber of Example TT 5”,
“CoEx5 CNT-PLA fiber of Example TT 5”.
“CoEx1 CNT-PEEK fiber of Example TT 5”,
“CoEx2 CNT-PEEK fiber of Example TT 5”,
“CoEx3 CNT-PEEK fiber of Example TT 5”,
“CoEx4 CNT-PEEK fiber of Example TT 5”,
“CoEx5 CNT-PEEK fiber of Example TT 5”.

Co-extruded fibers may also be made by creating multilayers of several different polymers with varying CNT content, thicknesses and melting temperatures.

### Example TT 6**. Production of Cables with High Tensile Strength

A cable of high tensile strength is produced by assembling 1000 individual fibers into a cable. This is done separately for each of the 80 fibers produced in Example TT 2**, Example TT 3, Example TT 4 and Example TT 5, to produce 80 different cables.
Step 1: Unwind 1000 fibers from a fiber bobbin and assemble the fibers in any arrangement, for example but not limited to, a twill weave or direct roving bundle.
Step 2: Optionally, heating the cable at a temperature of 20 degrees higher than the melting temperature of the outer polymer of the cable to assemble the individual fibers into a solid cable.
Step 3: The cable is heated up below the melting temperature and subsequently drawn to produce a higher alignment of polymer chain and CNTs.

The cable may also be produced by assembling a mix of the 80 fibers produced in Example TT 2**, Example TT 3, Example TT 4 and Example TT 5 to reach desired properties. The cable may be produced with any given number of individual fibers, for example but not limited to, 100 fibers, 10000 fibers, 100000 fibers.

### Example TT 7**. Production of Sheets where CNTs are Unidirectional

Here, sheets comprising polymer-CNT composite material where the CNTs are fully unidirectionally (UD) aligned. This is done separately for each of the 80 fibers produced in Example TT 2, Example TT 3, Example Torben 4 and Example “Torben 5**, to produce 80 different sheets.

Thus, for each of the 80 fibers of Example TT 2**, Example Torben 3**, Example Torben 4** and Example TT 5**, the following steps are performed:
Step 1. A sheet of dimensions e.g. 1000 mm wide and 1 mm thick may be manufactured by feeding and spreading evenly out the necessary quantity of polymer-CNT fibers on to a wide rotating roll.
Step 2. The material may then be fed in between two heated calendar rolls with a predetermined distance and a predetermined pressure. The sheet is then cooled and wrapped onto a coil or cut into predetermined lengths.

The resulting 80 sheets all comprise unidirectional CNTs. The sheets can be any dimension and UD sheets may also be formed by filament winding and fiber placement techniques.

### Example TT 8**. Production of Composites of Nanotube Fiber Weaves and Fabrics

Here, more fibers of the same type are assembled into rovings or yarns. In this example we use rovings. This is done separately for each of the 80 fibers produced in Example TT 2**, Example Torben 3**, Example Torben 4** and Example TT 5**, to produce 80 different rovings containing the same fiber. Each roving is termed a structural entity (SE).

Thus, for one of the 80 SEs the following steps are performed:
Step 1. Set up the rovings in a creel system feeding the weave or stitching machine according to a desired weave and/or fabric configuration.
Step 2. A weave or fabric of dimensions e.g. 2500 mm wide and 0.5 mm thick may be manufactured.
Step 2. The weave or fabric may be unidirectional or consist of an assembly of the same SEs in several directions.
Step 3: One or more layers of weaves or fabrics are laid up and impregnated with a resin of the same polymer as used for the fibers or alternatively a resin of a different polymer.

The resulting composite laminates may be made by impregnating the weave or fabric by wet lamination, resin transfer molding, vacuum assisted resin transfer moulding, pre-pregs, or any other method capable of impregnating a weave or fabric with resin. The resin used for impregnation may also contain carbon nanotubes to provide further reinforcement.

### Example TT 9**. Production of Hybrid Composites of Nanotube Fiber Weaves and Fabrics

Here, weaves and fabrics are produced using one or more SEs from Example TT 8** in combination to form a hybrid composite consisting of one or more SEs. Further, two or more SEs may be commingled on a composite fiber level to form a new SE consisting in a mix of SEs.

Thus, for one or more of the SEs the following steps are performed:
Step 1. Set up the rovings in a creel system feeding the weave or stitching machine according to a desired weave or fabric configuration.
Step 2. A weave or fabric of dimensions e.g. 2500 mm wide and 0.5 mm thick may be manufactured.
Step 2. The weave or fabric may be unidirectional or consist of an assembly of one or more SEs in several directions.
Step 3: One or more layers of weaves or fabrics are laid up and impregnated with a resin of the same polymer as used for one or more of the SEs or alternatively a resin of a different polymer.

The resulting composite laminates may be made by impregnating the weave or fabric by wet lamination, resin transfer molding, vacuum assisted resin transfer moulding, pre-pregging, or any other method capable of impregnating a weave or fabric with resin. The resin used for impregnation may also contain carbon nanotubes to provide further reinforcement.

### Example TT 10**. Production of a Carbon Composite with Interleaving Nanotube Fibers Layers

The fabrics or weaves in Example TT 8** and Example TT 9** are interleaved between solid laminates of carbon fiber composite to provide means for bonding the solid laminates together. The weaves or fabrics are made permeable such that resin can be impregnated. The content of CNT in the composite fibers is such that the solid carbon laminates become electrically connected to each other; avoiding electrical sparks and delamination between carbon laminates during e.g. lightning strike events.
Step 1. A solid carbon fiber laminate is laid up followed by either a dry or resin impregnated weave or fabric on which another solid carbon fiber laminate is laid. This sequence may be repeated, see FIG. 89.
Step 2. The resulting composite laminate assembly may be made by impregnating the weave or fabric by wet lamination, resin transfer molding, vacuum assisted resin transfer moulding, pre-pregging, or any other method capable of impregnating a weave or fabric with resin. The resin used for impregnation may also contain carbon nanotubes to provide further reinforcement or electrical conductivity.

The solid carbon laminate may also be semi-cured, and the carbon laminate may be replaced with other solid or semi-cured laminates e.g. glass fiber laminates. In another procedure it may also be possible to layup carbon in a dry state and co-impregnate with the nanotube composite fibers.

1. A method for preparing a composite material, said method comprising:
a) Provide a SE1;
b) Provide a precursor-ML;
c) Optionally, provide a catalyst;
to generate a SE1-ML structure;
wherein steps a) to c) may be performed in any order and wherein energy may optionally be provided in any of steps a) to c).

2. The method according to claim 1, further comprising:
d) Provide a SE2
To generate a SE1-ML-SE2 structure:
Wherein steps a) to d) may be performed in any order and wherein energy may optionally be provided in any of steps a) to d).

3. The method according to claim 2, the method comprising:
i) Provide a precursor-ML;
ii) Provide a SE1, to form a SE1-precursor ML complex;
iii) The precursor-ML is turned into a ML, mechanically bound to the SE1, optionally by the addition of catalyst and/or reagent(s);
iv) Provide a SE2 and covalently or non-covalently link it to the ML, optionally by the addition of catalyst and/or reagent(s);
to form a SE1-ML-SE2 structure.

4. The method according to claim 2, the method comprising:
i) Provide a precursor-ML;
ii) Provide a SE2, and attach one or more precursor-ML to SE2;
iii) Provide a SE1, and allow complexation to form a SE1-precursor-ML-SE2 complex;
iv) Convert the precursor-ML to a ML, mechanically bound to SE1;
to form a SE1-ML-SE2 complex.

5. The method according to claim 2, the method comprising:
i) Provide a precursor-ML and a portion of SE2, and associate or react said two components to form a precursor-ML-portion of SE2 structure;
ii) Provide a SE1 and allow SE1-precursor-ML complex formation;
iii) Turn the precursor-ML into a ML, to form a SE1-ML-portion of SE2 structure;
iv) Allow reaction of the portions of SE2 with each other;
to form a SE1-ML-SE2 structure.

6. The method according to claim 2, the method comprising:
i) Provide a precursor-ML and a portion of SE2, and associate or react said two components to form a precursor-ML-portion of SE2 structure;
ii) Provide a SE1 and allow SE1-precursor-ML-portion of SE2 complex formation;
iii) Allow reaction between portions of SE2, attached to precursor-MLs, to form the SE1-precursor-ML-SE2 structure;
iv) Convert the precursor-ML into a ML;
to form a SE1-ML-SE2 complex.

7. The method according to claim 2, the method comprising:
i) Provide a precursor-ML and a portion of SE2, and associate or react said two components to form a precursor-ML-portion of SE2 structure;
ii) Provide a SE1 and allow SE1-precursor-ML-portion of SE2 complex formation;
iii) Allow conversion of the precursor-ML to a ML and formation of a SE2 from portions of SE2;
to form a SE1-ML-SE2 complex.

8. The method according to claim 2, the method comprising:
i) Provide a SE1, a precursor-ML carrying a polymerization terminator (PT), and optionally a catalyst capable of mediating the conversion of precursor-ML into ML, and a monomer, leading to formation of the SE1-ML complex, where the ML carries a polymerization terminator (PT).
ii) Optionally, provide a catalyst;
iii) Polymerization proceeds to form a polymer in solution;
iv) The growing polymer eventually terminates its polymerization on the polymerization terminator, thereby forming a SE1-ML-SE2 structure in which one ML is attached to one polymer.

9. The method according to claim 2, the method comprising:
i) Provide a SE1, a precursor-ML carrying a first reactive group, and optionally a catalyst capable of mediating the conversion of precursor-ML into ML, and monomers, leading to formation of the SE1-ML complex, where the ML carries the first reactive group.
ii) Optionally, provide a catalyst;
iii) Polymerization proceeds to form a polymer in solution, where the polymer carries a second reactive group capable of reacting with the first reactive group;
iv) Optionally, provide a catalyst and/or reagent(s);
v) The second reactive group of the polymer is brought to react with the first reactive group of the ML;
to form a SE1-ML-SE2 structure.

10. The method according to any one of the preceding claims, the method further comprising an additional step of dissociating the SE1-ML complex into a SE1 and a ML;
to obtain a composite material comprising ML, non-ML-complexed SE1 and, if applicable, SE2 and wherein energy may optionally be provided in said dissociation step.

11. The method according to any one of the preceding claims, wherein energy may be provided by mechanical methods, cavitation methods, turbulent flow methods, or combinations thereof.

12. The method according to claim 11, wherein mechanical methods comprise ball milling, paint shaker milling, ball collision-milling, bead milling/sand milling, cone-milling, high shear batch dispersion, thin-film spin mixing, and rotor-milling.

13. The method according to claim 11, wherein cavitation methods comprise bath sonication and probe sonication.

14. The method according to claim 11, wherein turbulent flow methods comprises high pressure jet-milling.

15. The method according to any one of the preceding claims, wherein SE1 is selected from the group consisting of nanotube, a carbon nanotube, a multi-wall nanotube, a multi-wall carbon nanotube, a single-wall nanotube, a single-wall carbon nanotube, graphene, a carbon fibre, a carbon nanofibre, a carbon nanothread, nanowire, a ceramic material, a fullerene, graphane, graphene oxide, graphite, graphyne, a COOH-functionalized carbon nanotube, a OH-functionalized carbon nanotube, an NH2-functionalized carbon nanotube, an SH-functionalized carbon nanotube, COOH-functionalized graphene, NH2-functionalized graphene, OH-functionalized graphene, thiol-functionalized graphene, a glass fibre, preferably selected from nanotube, a carbon nanotube, a single-wall carbon nanotube, graphene, and graphene oxide.

16. The method according to any one of the preceding claims, wherein precursor-ML is selected from the group consisting of a chemical structure comprising one or two or more chemical moieties with affinity for the SE1, such as a Ushape or another chemical entity comprising at least one ligand moiety with affinity for the SE1.

17. The method according to any one of the preceding claims, wherein SE2 is selected from the group consisting of polyester, polyamide, polyurethane, polystyrene, polymethyl methacrylate, polyacrylate, polyacrylonitrile.
